(19) United States
(12) Patent Application Publication
(10) Pub. No.: US 2009/0248463 A1
(43) Pub. Date: Oct. 1, 2009

(54) Managing Consistent Interfaces For Trading Business Objects Across Heterogeneous Systems

(76) Inventors: Emmanuel Piochon, Saint-Lambert (CA); Frank Stephan, Bad Schoenborn (DE); Markus Urbanek, Dortmund (DE); Stefan Edelmann, St. Ingbert (DE); Juergen Pinkow, Wiesloch (DE)

Correspondence Address: FISH & RICHARDSON, P.C., PO BOX 1022, MINNEAPOLIS, MN, 55440-1022, US

(21) Appl. No.: 12/060,054

(22) Filed: Mar. 31, 2008

(51) Int. Cl. G06Q 40/00; G06Q 30/00

(52) U.S. Cl. 705/7; 705/36 R; 705/26

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to an analytical view of trading order, a trade price specification contract, and/or a trading order business object.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, software handles the analytical representation of a trading order and its structure. The software comprises computer readable instructions embodied on tangible media, wherein upon execution the software executes in a landscape of computer systems providing message-based services. The software invokes an analytical view of trading order business object. The business object is a logically centralized, semantically disjointed object for an analytical representation of a trading order and its structure. The business object comprises data logically organized as an analytical view of trading order root node, a sales organization party subordinate node, a purchasing organization party subordinate node, a purchasing group party subordinate node, a trading channel subordinate node and an item subordinate node. The item node contains a product subordinate node, an inbound delivery reference subordinate node, an outbound delivery reference subordinate node, a goods movement reference subordinate node, a supplier invoice reference subordinate node, a customer invoice reference subordinate node and a total values subordinate node. The inbound delivery reference node contains a content and subordinate node and a ship from location subordinate node. The outbound delivery reference node contains a content subordinate node and a ship to location subordinate node. The goods movement reference node contains a content subordinate node, a ship from location subordinate node and a ship to location subordinate node. The supplier invoice reference node contains a content subordinate node. The customer invoice reference node contains a content subordinate node and a ship to location subordinate node. The software initiates transmission of a message to a heterogeneous second application, executing in the environment of computer systems providing message-based services, based on the data in the analytical view of trading order business object. The message comprises an analytical view of trading order message entity, a message header package, and an analytical view of trading order package.

In a second aspect, software handles the analytical representation of a trading order and its structure. The software comprises computer readable instructions embodied on tangible media, wherein upon execution the software executes in a landscape of computer systems providing message-based services. The software initiates transmission of a message to a heterogeneous second application, executing in the environment of computer systems providing message-based services, based on data in an analytical view of trading order business object invoked by the second application. The business object is a logically centralized, semantically disjointed object for an analytical representation of a trading order and its structure. The business object comprises data logically organized as an analytical view of trading order root node, a sales organization party subordinate node, a purchasing organization party subordinate node, a purchasing group party subordinate node, a trading channel subordinate node and an item subordinate node. The item node contains a product subordinate node, an inbound delivery reference subordinate node, an outbound delivery reference subordinate node, a goods movement reference subordinate node, a supplier invoice reference subordinate node, a customer invoice reference subordinate node and a total values subordinate node. The inbound delivery reference node contains a content and subordinate node and a ship from location subordinate node. The outbound delivery reference node contains a content subordinate node and a ship to location subordinate node. The goods movement reference node contains a content subordinate node, a ship from location subordinate node and a ship to location subordinate node. The supplier invoice reference node contains a content subordinate node. The customer invoice reference node contains a content subordinate node and a ship to location subordinate node. The message comprises an analytical view of trading order message entity, a message header package, and an analytical view of trading order package. The software receives a second message from the second application. The second message is associated with the invoked analytical view of trading order business object and is in response to the first message.

In a third aspect, a distributed system operates in a landscape of computer systems providing message-based services. The system processes business objects involving an analytical representation of a trading order and its structure. The system comprises memory and a graphical user interface remote from the memory. The memory stores a business object repository storing a plurality of business objects. Each business object is a logically centralized, semantically disjointed object of a particular business object type. At least one of the business objects is for an analytical representation of a trading order and its structure. The business object comprises data logically organized as an analytical view of trading order root node, a sales organization party subordinate node, a purchasing organization party subordinate node, a purchasing group party subordinate node, a trading channel subordinate node and an item subordinate node. The item node contains a product subordinate node, an inbound delivery reference subordinate node, an outbound delivery reference subordinate node, a goods movement reference subordinate node, a supplier invoice reference subordinate node, a customer invoice reference subordinate node and a total values subordinate node. The inbound delivery reference node contains a content and subordinate node and a ship from location subordinate node. The outbound delivery reference node contains a content subordinate node and a ship to location subordinate node. The goods movement reference node contains a content subordinate node, a ship from location subordinate node and a ship to location subordinate node. The supplier invoice reference node contains a content subordinate node. The customer invoice reference node contains a content subordinate node and a ship to location subordinate node. The graphical user interface presents data associated with an invoked instance of the analytical view of trading order business object, the interface comprising computer readable instructions embodied on tangible media.

In a fourth aspect, software provides the interfaces that are used in a Business-To-Business process to exchange special price agreements between a manufacturer and a distributor. The software comprises computer readable instructions embodied on tangible media, wherein upon execution the software executes in a landscape of computer systems providing message-based services. The software invokes a trade price specification contract business object. The business object is a logically centralized, semantically disjointed object for interfaces that are used in a Business-To-Business process to exchange special price agreements between a manufacturer and a distributor. The business object comprises data logically organized as a trade price specification contract root node, a condition subordinate node, a party subordinate node and a payment terms subordinate node. The condition node contains a condition price specification subordinate node. The payment terms node contains an exchange rate subordinate node and a cash discount terms subordinate node. The software initiates transmission of a message to a heterogeneous second application, executing in the environment of computer systems providing message-based services, based on the data in the trade price specification contract business object. The message comprises a trade price specification contract request entity, a message header, a trade price specification contract package, and a payment terms package.

In a fifth aspect, software provides interfaces that are used in a Business-To-Business process to exchange special price agreements between a manufacturer and a distributor. The software comprises computer readable instructions embodied on tangible media, wherein upon execution the software executes in a landscape of computer systems providing message-based services. The software initiates transmission of a message to a heterogeneous second application, executing in the environment of computer systems providing message-based services, based on data in a trade price specification contract business object invoked by the second application. The business object is a logically centralized, semantically disjointed object for interfaces that are used in a Business-To-Business process to exchange special price agreements between a manufacturer and a distributor. The business object comprises data logically organized as a trade price specification contract root node, a condition subordinate node, a party subordinate node and a payment terms subordinate node. The condition node contains a condition price specification subordinate node. The payment terms node contains an exchange rate subordinate node and a cash discount terms subordinate node. The message comprises a trade price specification contract request entity, a message header, a trade price specification contract package, and a payment terms package. The software receives a second message from the second application. The second message is associated with the invoked trade price specification contract business object and is in response to the first message.

In a sixth aspect, a distributed system operates in a landscape of computer systems providing message-based services. The system processes business objects involving interfaces that are used in a Business-To-Business process to exchange special price agreements between a manufacturer and a distributor. The system comprises memory and a graphical user interface remote from the memory. The memory stores a business object repository storing a plurality of business objects. Each business object is a logically centralized, semantically disjointed object of a particular business object type. At least one of the business objects is for interfaces that are used in a Business-To-Business process to exchange special price agreements between a manufacturer and a distributor and comprises data logically organized as a trade price specification contract root node, a condition subordinate node, a party subordinate node and a payment terms subordinate node. The condition node contains a condition price specification subordinate node. The payment terms node contains an exchange rate subordinate node and a cash discount terms subordinate node. The graphical user interface presents data associated with an invoked instance of the trade price specification contract business object, the interface comprising computer readable instructions embodied on tangible media.

In a seventh aspect, software provides the interfaces for an ordering party to trade with contractors, where a sales area receives the order and becomes responsible for fulfilling the contract. The software comprises computer readable instructions embodied on tangible media, wherein upon execution the software executes in a landscape of computer systems providing message-based services. The software invokes a trading order business object. The business object is a request from an ordering party to trade with contractors where a sales area receives the order and becomes responsible for fulfilling the contract. The business object comprises data logically organized as a trading order root node, a buyer party subordinate node, a product recipient party subordinate node, a bill to party subordinate node, a payer party subordinate node, a seller subordinate node, a payee party subordinate node, a responsible employee party subordinate node, a sales organization party subordinate node, a purchasing organization party subordinate node, a purchasing group party subordinate node, a bill from party subordinate node, a trading channel subordinate node, a sales subordinate node, a purchasing subordinate node, a text collection subordinate node, an expense subordinate node and an item subordinate node. The sales node contains, a delivery terms subordinate node, a cash discount terms subordinate node, a pricing terms subordinate node and a taxation terms subordinate node. The purchasing node contains a delivery terms subordinate node, a cash discount terms subordinate node and a pricing terms subordinate node. The item node contains a product recipient party subordinate node, a bill to party subordinate node, a payer party subordinate node, a seller subordinate node, a payee party subordinate node, a responsible employee party subordinate node, a bill from party subordinate node, a product subordinate node, a location subordinate node, a sales subordinate node, a purchasing subordinate node, a business transaction document reference subordinate node, a trading order reference subordinate node and a text collection subordinate node. The the sales node contains a schedule line subordinate node, a delivery terms subordinate node, a transportation network subordinate node, a transport mode subordinate node, a cash discount terms subordinate node, a pricing terms subordinate node, a total values subordinate node, a scheduling zone subordinate node and a transportation event subordinate node. The purchasing node contains a schedule line subordinate node, a delivery terms subordinate node, a transportation network subordinate node, a transport mode subordinate node, a cash discount terms subordinate node, a pricing terms subordinate node, a total values subordinate node, a scheduling zone subordinate node and a transportation event subordinate node. The software initiates transmission of a message to a heterogeneous second application, executing in the environment of computer systems providing message-based services, based on the data in the trading order business object. The message comprises a trading order request message entity, a message header package and a trading order package.

In an eighth aspect, software provides the interfaces an ordering party to trade with contractors, where a sales area receives the order and becomes responsible for fulfilling the contract. The software comprises computer readable instructions embodied on tangible media, wherein upon execution the software executes in a landscape of computer systems providing message-based services. The software initiates transmission of a message to a heterogeneous second application, executing in the environment of computer systems providing message-based services, based on data in a trading order business object invoked by the second application. The business object is a request from an ordering party to trade with contractors where a sales area receives the order and becomes responsible for fulfilling the contract. The business object comprises data logically organized as a trading order root node, a buyer party subordinate node, a product recipient party subordinate node, a bill to party subordinate node, a payer party subordinate node, a seller subordinate node, a payee party subordinate node, a responsible employee party subordinate node, a sales organization party subordinate node, a purchasing organization party subordinate node, a purchasing group party subordinate node, a bill from party subordinate node, a trading channel subordinate node, a sales subordinate node, a purchasing subordinate node, a text collection subordinate node, an expense subordinate node and an item subordinate node. The sales node contains, a delivery terms subordinate node, a cash discount terms subordinate node, a pricing terms subordinate node and a taxation terms subordinate node. The purchasing node contains a delivery terms subordinate node, a cash discount terms subordinate node and a pricing terms subordinate node. The item node contains a product recipient party subordinate node, a bill to party subordinate node, a payer party subordinate node, a seller subordinate node, a payee party subordinate node, a responsible employee party subordinate node, a bill from party subordinate node, a product subordinate node, a location subordinate node, a sales subordinate node, a purchasing subordinate node, a business transaction document reference subordinate node, a trading order reference subordinate node and a text collection subordinate node. The the sales node contains a schedule line subordinate node, a delivery terms subordinate node, a transportation network subordinate node, a transport mode subordinate node, a cash discount terms subordinate node, a pricing terms subordinate node, a total values subordinate node, a scheduling zone subordinate node and a transportation event subordinate node. The purchasing node contains a schedule line subordinate node, a delivery terms subordinate node, a transportation network subordinate node, a transport mode subordinate node, a cash discount terms subordinate node, a pricing terms subordinate node, a total values subordinate node, a scheduling zone subordinate node and a transportation event subordinate node. The message comprises a trading order request message entity, a message header package and a trading order package. The software receives a second message from the second application. The second message is associated with the invoked trading order business object and is in response to the first message.

In a ninth aspect, a distributed system operates in a landscape of computer systems providing message-based services. The system processes business objects involving an ordering party to trade with contractors, where a sales area receives the order and becomes responsible for fulfilling the contract. The system comprises memory and a graphical user interface remote from the memory. The memory stores a business object repository storing a plurality of business objects. Each business object is a logically centralized, semantically disjointed object of a particular business object type. At least one of the business objects is a request from an ordering party to trade with contractors where a sales area receives the order and becomes responsible for fulfilling the contract. The business object comprises data logically organized as a trading order root node, a buyer party subordinate node, a product recipient party subordinate node, a bill to party subordinate node, a payer party subordinate node, a seller subordinate node, a payee party subordinate node, a responsible employee party subordinate node, a sales organization party subordinate node, a purchasing organization party subordinate node, a purchasing group party subordinate node, a bill from party subordinate node, a trading channel subordinate node, a sales subordinate node, a purchasing subordinate node, a text collection subordinate node, an expense subordinate node and an item subordinate node. The sales node contains, a delivery terms subordinate node, a cash discount terms subordinate node, a pricing terms subordinate node and a taxation terms subordinate node. The purchasing node contains a delivery terms subordinate node, a cash discount terms subordinate node and a pricing terms subordinate node. The item node contains a product recipient party subordinate node, a bill to party subordinate node, a payer party subordinate node, a seller subordinate node, a payee party subordinate node, a responsible employee party subordinate node, a bill from party subordinate node, a product subordinate node, a location subordinate node, a sales subordinate node, a purchasing subordinate node, a business transaction document reference subordinate node, a trading order reference subordinate node and a text collection subordinate node. The the sales node contains a schedule line subordinate node, a delivery terms subordinate node, a transportation network subordinate node, a transport mode subordinate node, a cash discount terms subordinate node, a pricing terms subordinate node, a total values subordinate node, a scheduling zone subordinate node and a transportation event subordinate node. The purchasing node contains a schedule line subordinate node, a delivery terms subordinate node, a transportation network subordinate node, a transport mode subordinate node, a cash discount terms subordinate node, a pricing terms subordinate node, a total values subordinate node, a scheduling zone subordinate node and a transportation event subordinate node. The graphical user interface presents data associated with an invoked instance of the trading order business object, the interface comprising computer readable instructions embodied on tangible media.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIG. 32 shows an exemplary AnalyticalViewOfTradingOrder Message Choreography.

FIGS. 33-1 through 33-4 show an exemplary AnalyticalViewOfTradingOrderERPNotificationMessage Message Data Type.

FIGS. 34-1 through 34-38 show an exemplary AnalyticalViewOfTradingOrderMessage Element Structure.

FIGS. 35-1 through 35-29 show an exemplary AnalyticalViewOfTradingOrderERPNotificationMessage Element Structure.

FIGS. 36-1 through 36-4 show an exemplary TradePriceSpecificationContract Object Model.

FIG. 37 shows an exemplary TradePriceSpecificationContract Message Choreography.

FIGS. 38-1 through 38-4 show an exemplary TradePriceSpecificationContractRequestMessage Message Data Type.

FIG. 39 shows an exemplary TradePriceSpecificationContractCancelRequestMessage Message Data Type.

FIG. 40 shows an exemplary TradePriceSpecificationContractConfirmationMessage Message Data Type.

FIGS. 41-1 through 41-11 show an exemplary TradePriceSpecificationContractRequest Element Structure.

FIG. 42 shows an exemplary TradePriceSpecificationContractCancelRequest Element Structure.

FIGS. 43-1 through 43-3 show an exemplary TradePriceSpecificationContractConfirmation Element Structure.

FIG. 44 shows an exemplary TradingOrder Message Choreography.

FIGS. 45-1 through 45-8 show an exemplary TradingOrderRequestMessage Message Data Type.

FIG. 46 shows an exemplary TradingOrderReleaseRequestMessage Message Data Type.

FIG. 47 shows an exemplary TradingOrderCancelRequestMessage Message Data Type.

FIG. 48 shows an exemplary TradingOrderConfirmationMessage Message Data Type.

FIG. 49 shows an exemplary TradingOrderByIDQueryMessage_sync Message Data Type.

FIGS. 50-1 through 50-8 show an exemplary TradingOrderByIDResponseMessage_sync Message Data Type.

FIG. 51 shows an exemplary TradingOrderSimpleByElementsQueryMessage_sync Message Data Type.

FIG. 52 shows an exemplary TradingOrderSimpleByElementsResponseMessage_sync Message Data Type.

FIGS. 53-1 through 53-8 show an exemplary TradingOrderERPNotificationMessage Message Data Type.

FIG. 54 shows an exemplary TradingOrderERPReleasedNotificationMessage Message Data Type.

FIG. 55 shows an exemplary TradingOrderERPCancelledNotificationMessage Message Data Type.

FIGS. 56-1 through 56-8 show an exemplary TradingOrderERPUpdateRequestMessage_sync Message Data Type.

FIGS. 57-1 through 57-8 show an exemplary TradingOrderERPUpdateConfirmationMessage_sync Message Data Type.

FIGS. 58-1 through 58-53 show an exemplary TradingOrderMessage Element Structure.

FIGS. 59-1 through 59-46 show an exemplary TradingOrderRequestMessage Element Structure.

FIG. 60 shows an exemplary TradingOrderCancelRequestMessage Element Structure.

FIG. 61 shows an exemplary TradingOrderReleaseRequestMessage Element Structure.

FIGS. 62-1 through 62-2 show an exemplary TradingOrderConfirmationMessage Element Structure.

FIG. 63 shows an exemplary TradingOrderByIDQueryMessage_sync Element Structure.

FIGS. 64-1 through 64-42 show an exemplary TradingOrderByIDResponseMessage Element Structure.

FIGS. 65-1 through 65-3 show an exemplary TradingOrderSimpleByElementsQueryMessage_sync Element Structure.

FIGS. 66-1 through 66-2 show an exemplary TradingOrderSimpleByElementsResponseMessage_sync Element Structure.

FIGS. 67-1 through 67-48 show an exemplary TradingOrderERPNotificationMessage Element Structure.

FIG. 68 shows an exemplary TradingOrderERPReleasedNotificationMessage Element Structure.

FIG. 69 shows an exemplary TradingOrderERPCancelledNotificationMessage Element Structure.

FIGS. 70-1 through 70-45 show an exemplary TradingOrderERPUpdateRequestMessage_sync Element Structure.

FIGS. 71-1 through 71-42 show an exemplary TradingOrderERPUpdateConfirmationMessage_sync Element Structure.

### DETAILED DESCRIPTION

A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

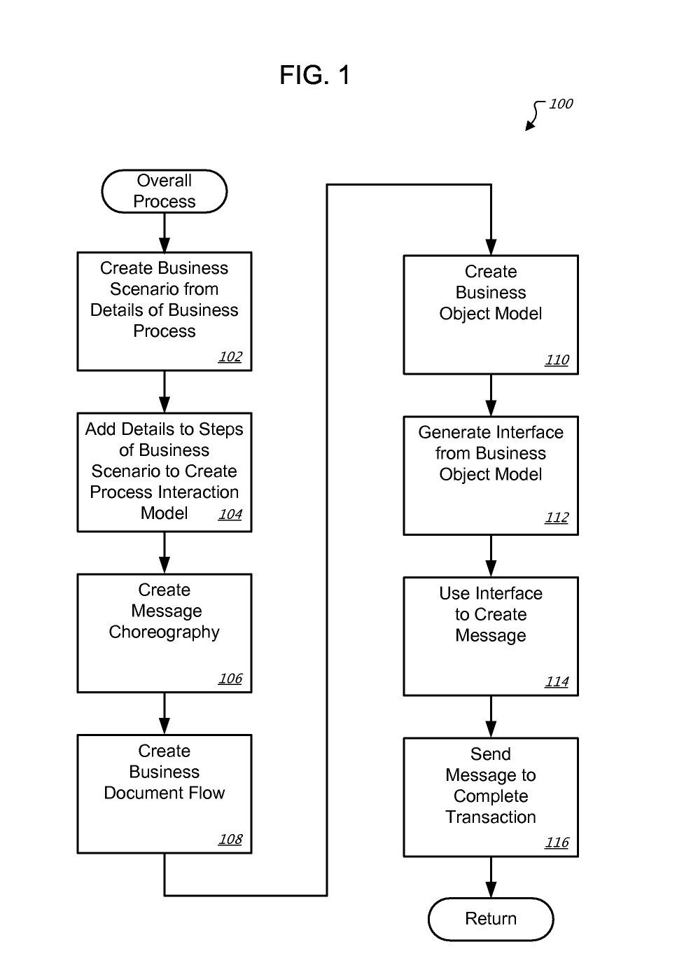

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

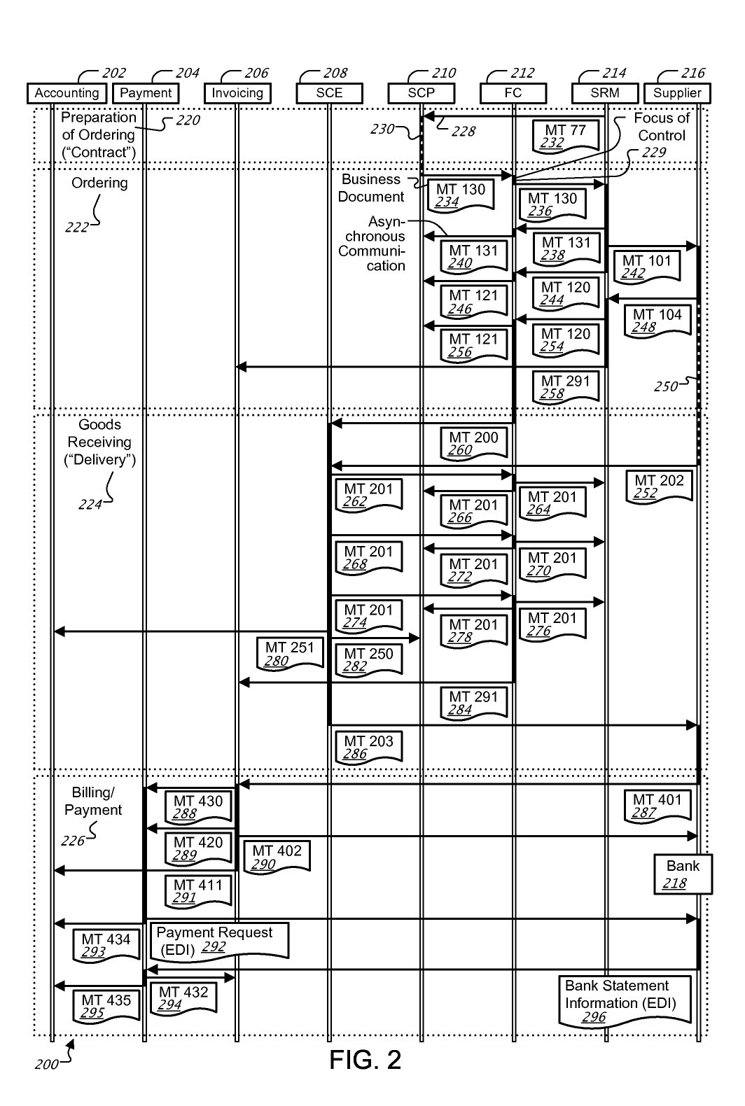

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

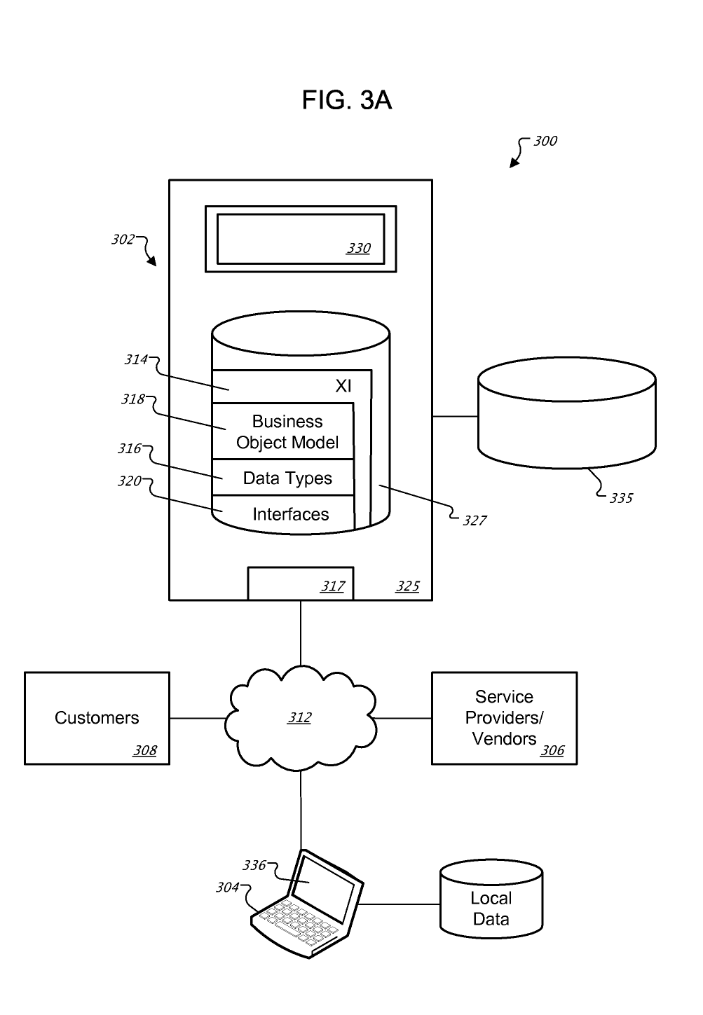

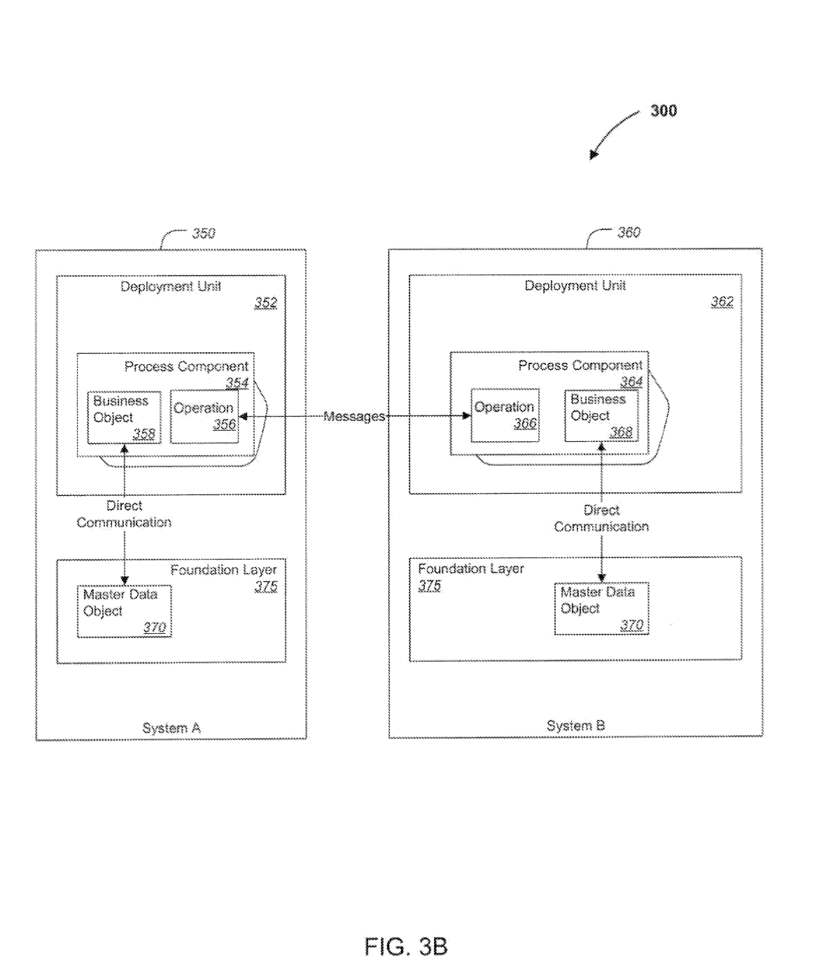

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

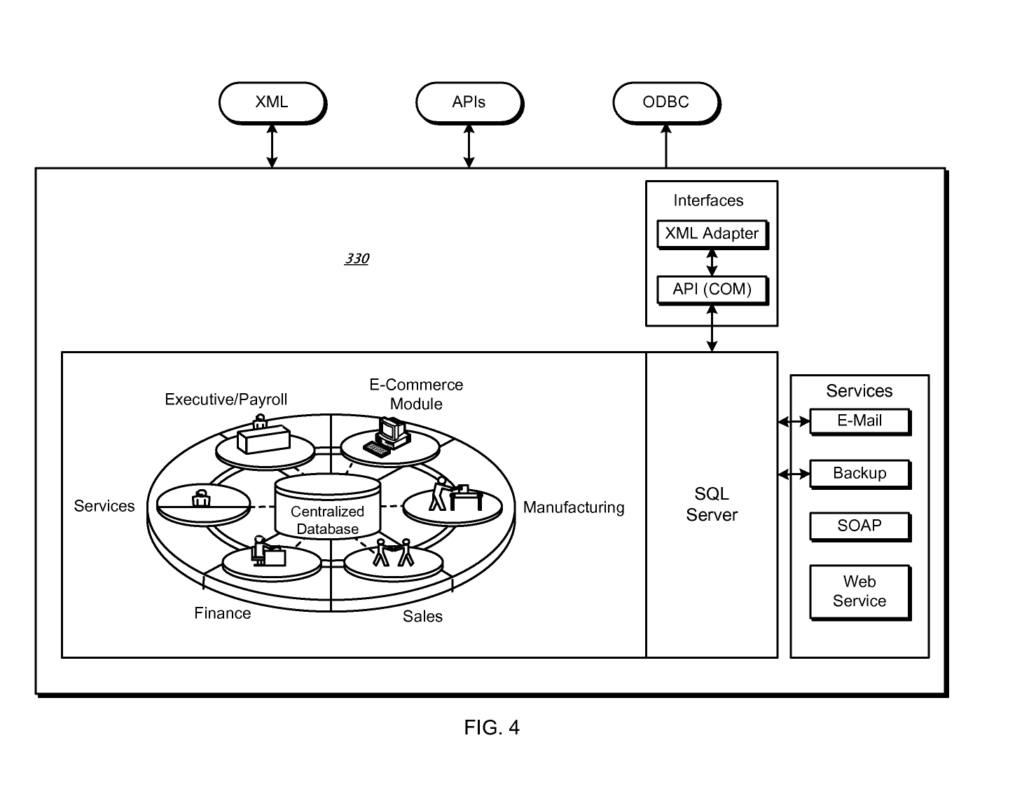

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

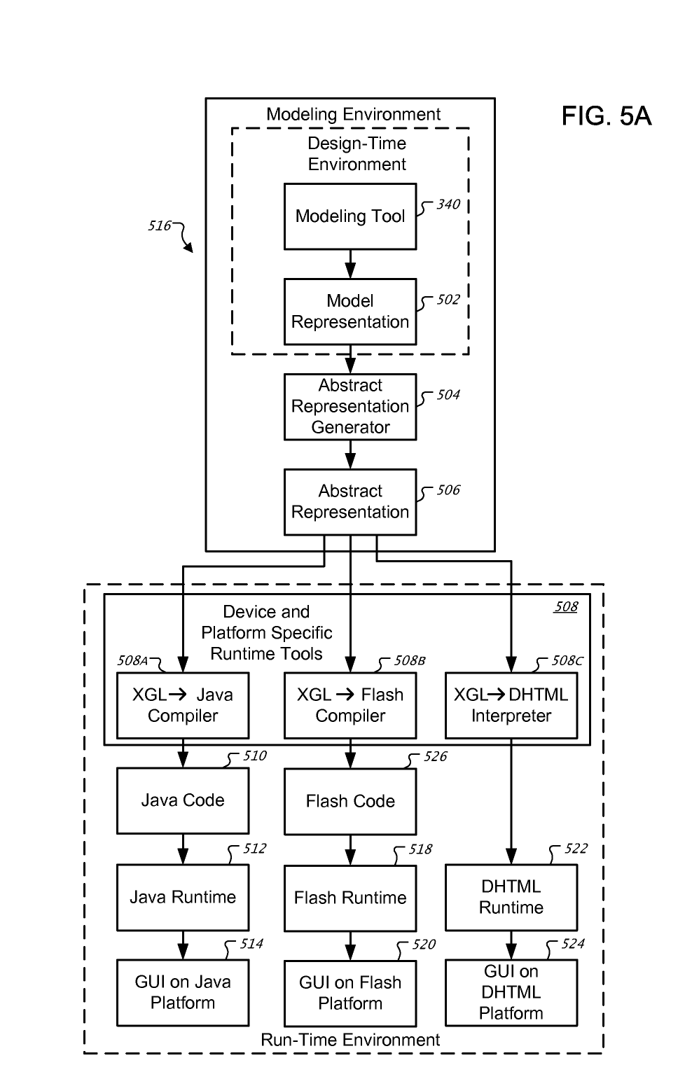

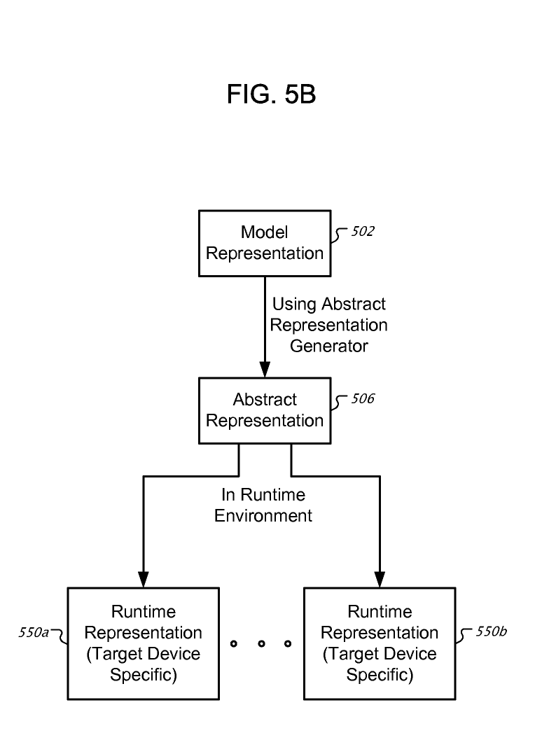

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device- dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

(a) Message Categories

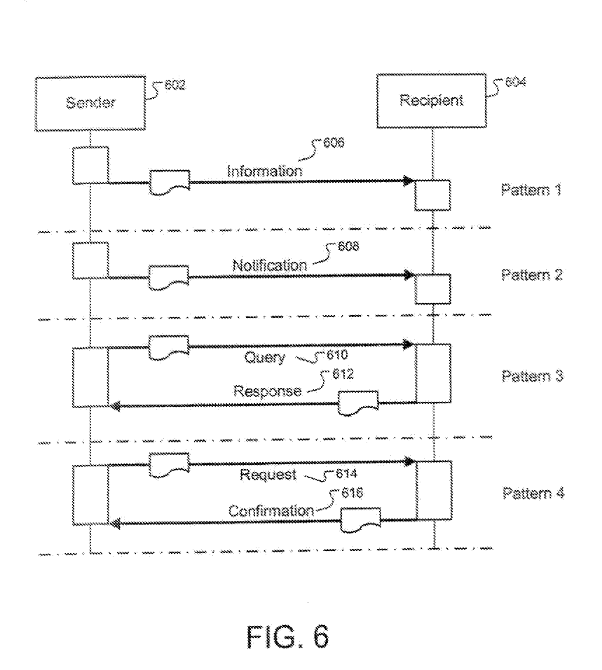

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(i) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(ii) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(iii) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(iv) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(v) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(vi) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

(b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

(a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

(b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

(c) Packages

Packages group the entities in the business object model and the resulting interfaces into groups of semantically associated information. Packages also may include “sub”-packages, i.e., the packages may be nested.

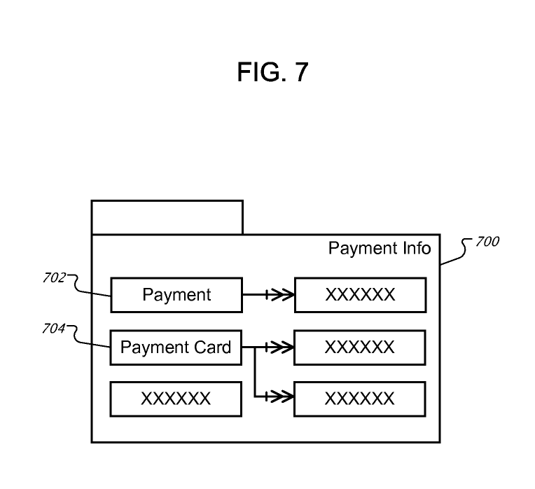

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

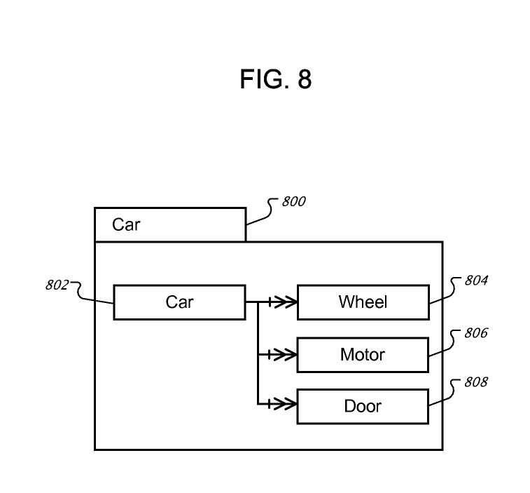

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

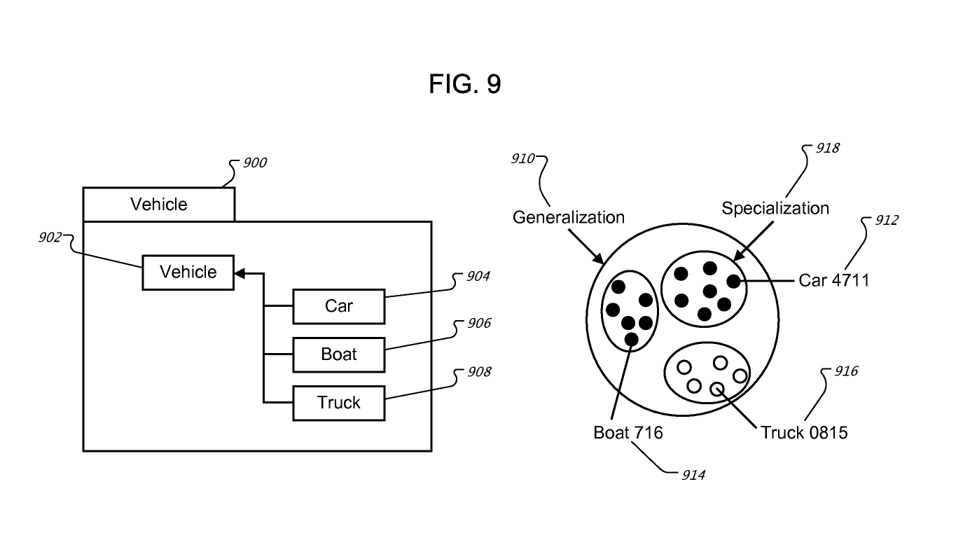

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

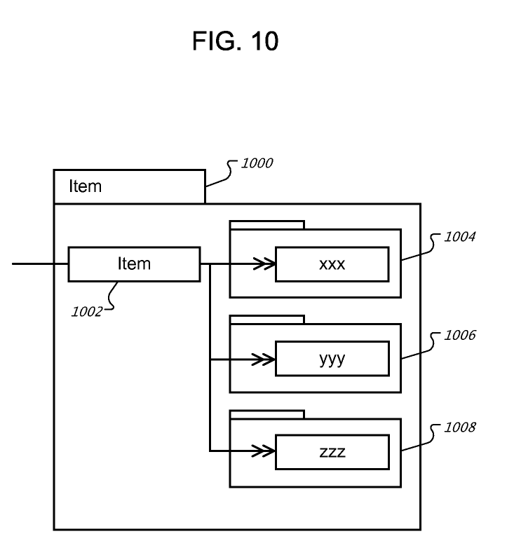

Packages also may be used to represent hierarchy levels. For example, as depicted in FIG. 10, the Item Package 1000 includes Item 1002 with subitem xxx 1004, subitem yyy 1006, and subitem zzz 1008.

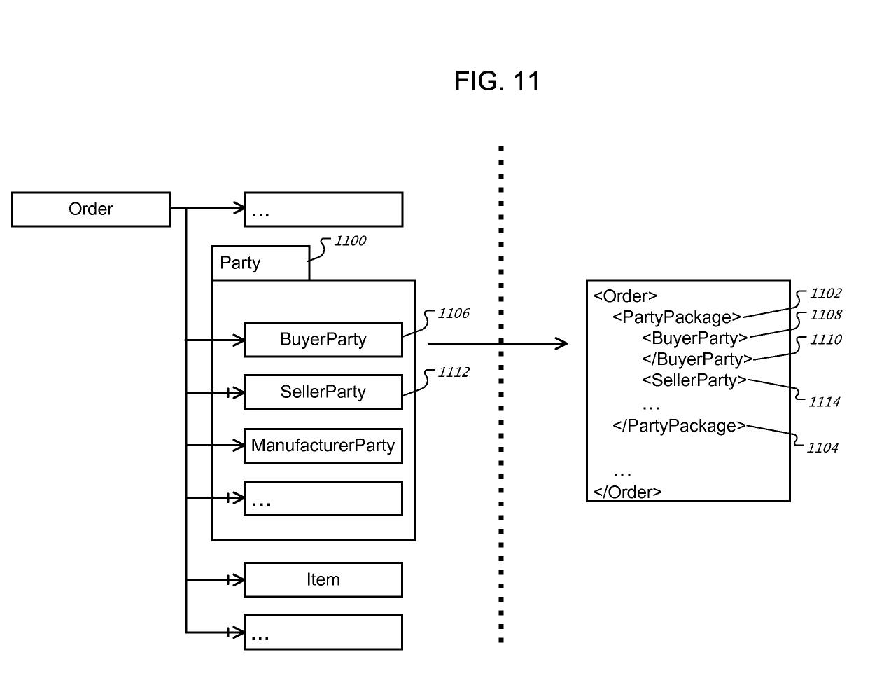

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

(d) Relationships

Relationships describe the interdependencies of the entities in the business object model, and are thus an integral part of the business object model.

(i) Cardinality of Relationships

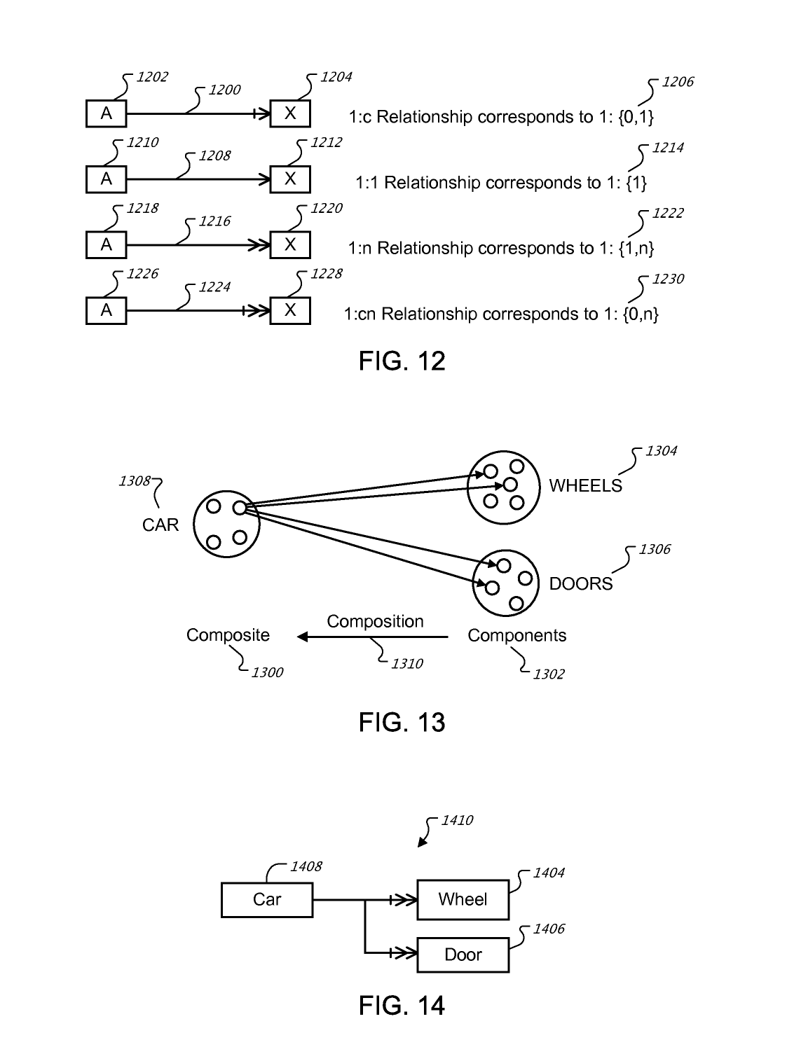

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(ii) Types of Relationships

### a. Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

### b. Aggregation

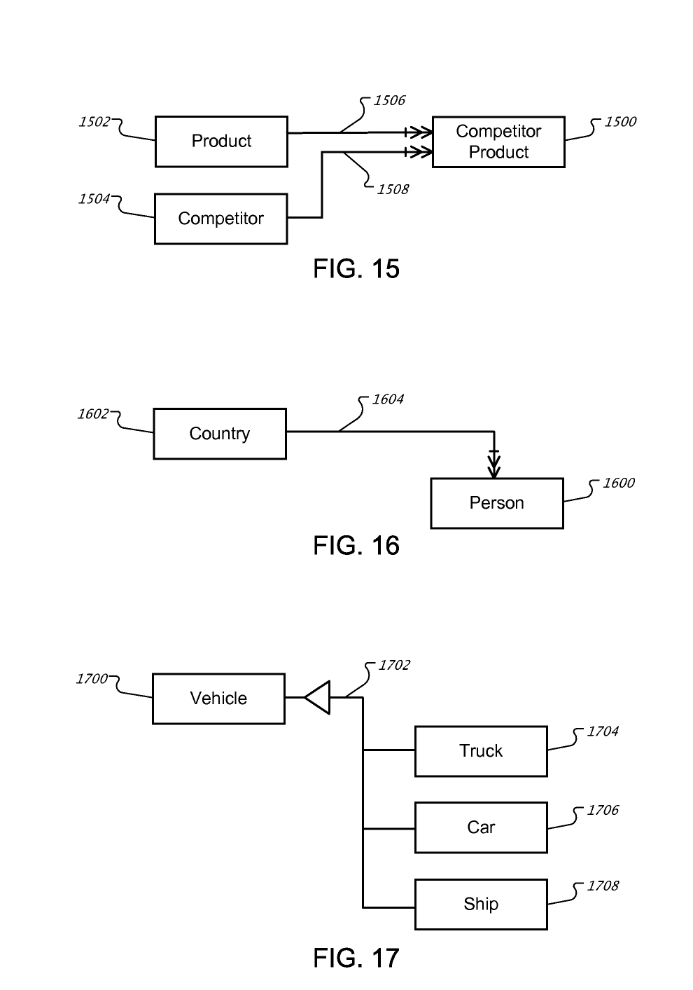

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

### c. Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(iii) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

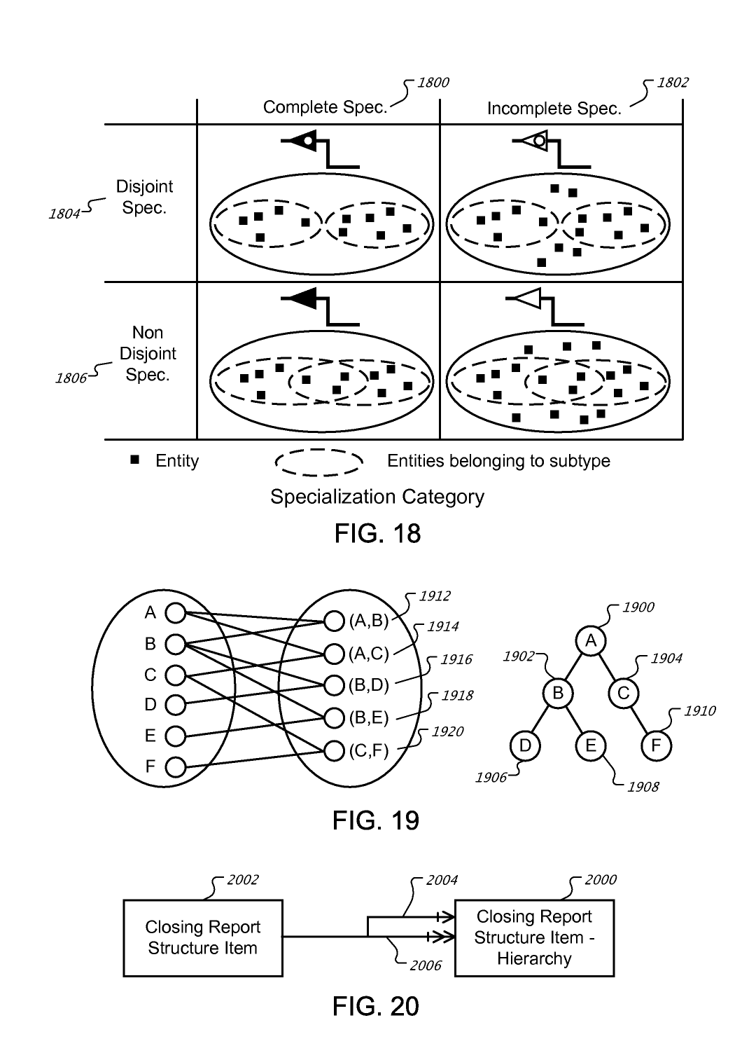

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

(e) Structural Patterns

(i) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(ii) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

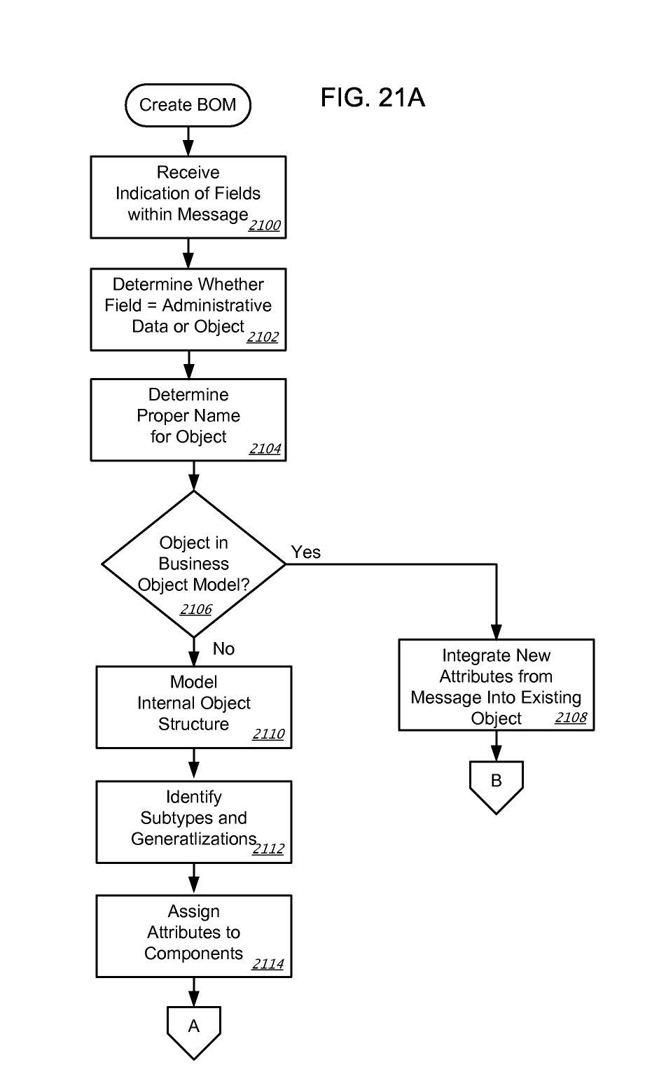

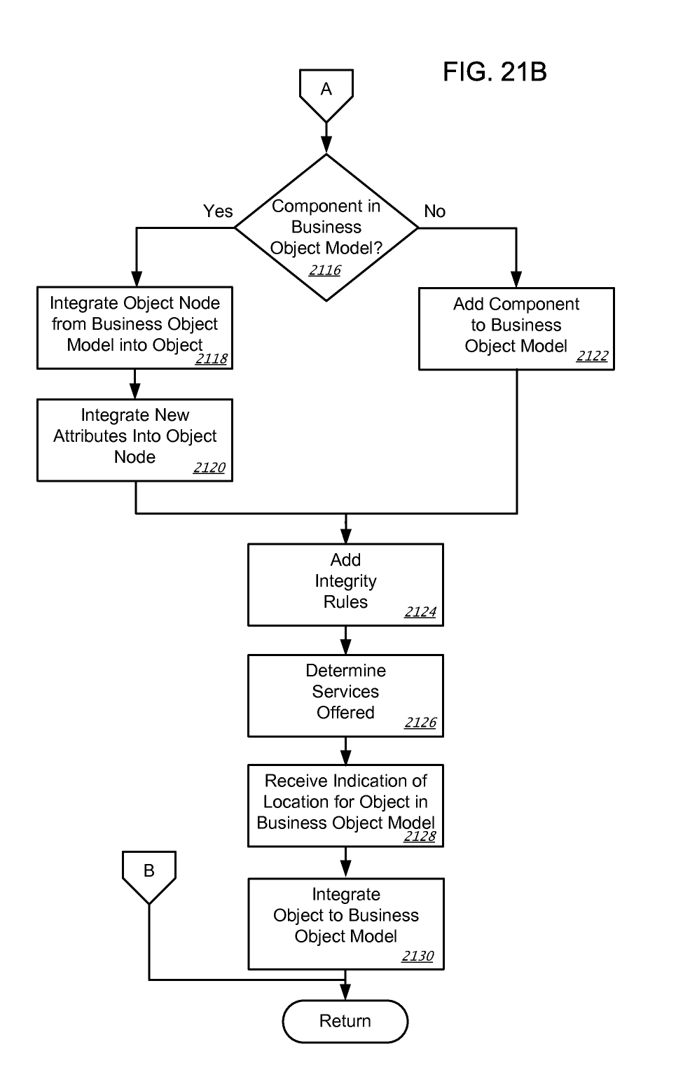

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Purchase | | |
| AdditionalID | Order | | |
| PostingDate | | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | Delivery- | |
| DeliveryPriority | | Terms | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase | |
| ParentItemID | | Order Item | |
| HierarchyType | | | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscount | | | 0 . . . 1 |
| | Terms | | | |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | Confirmation | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder Request | | | |
| | | PurchaseOrder Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation Description | | | 0 . . . 1 |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase | | | | 1 |
| Order | | | | |
| | ID | | | 1 |
| | SellerID | | | 0 . . . 1 |
| | BuyerPosting | | | 0 . . . 1 |
| | DateTime | | | |
| | BuyerLast | | | 0 . . . 1 |
| | ChangeDate | | | |
| | Time | | | |
| | SellerPosting | | | 0 . . . 1 |
| | DateTime | | | |
| | SellerLast | | | 0 . . . 1 |
| | ChangeDate | | | |
| | Time | | | |
| | Acceptance | | | 0 . . . 1 |
| | StatusCode | | | |
| | Note | | | 0 . . . 1 |
| | ItemList | | | 0 . . . 1 |
| | Complete | | | |
| | Transmission | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product | | | 0 . . . 1 |
| | RecipientParty | | | |
| | VendorParty | | | 0 . . . 1 |
| | Manufacturer | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

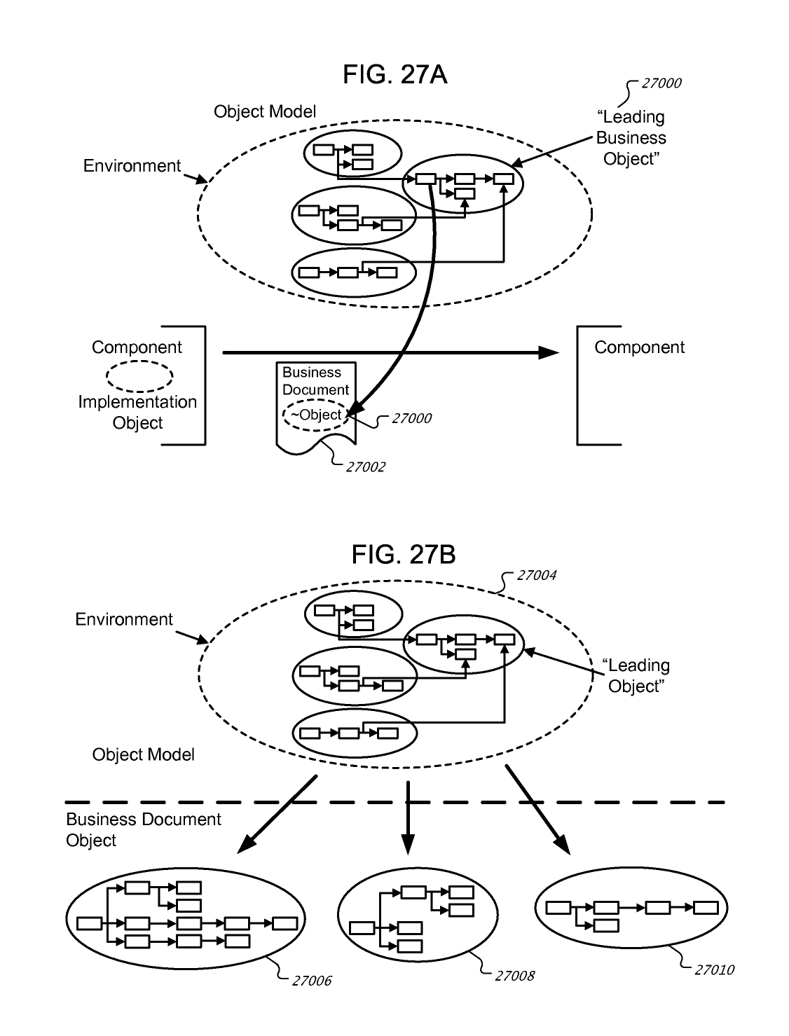

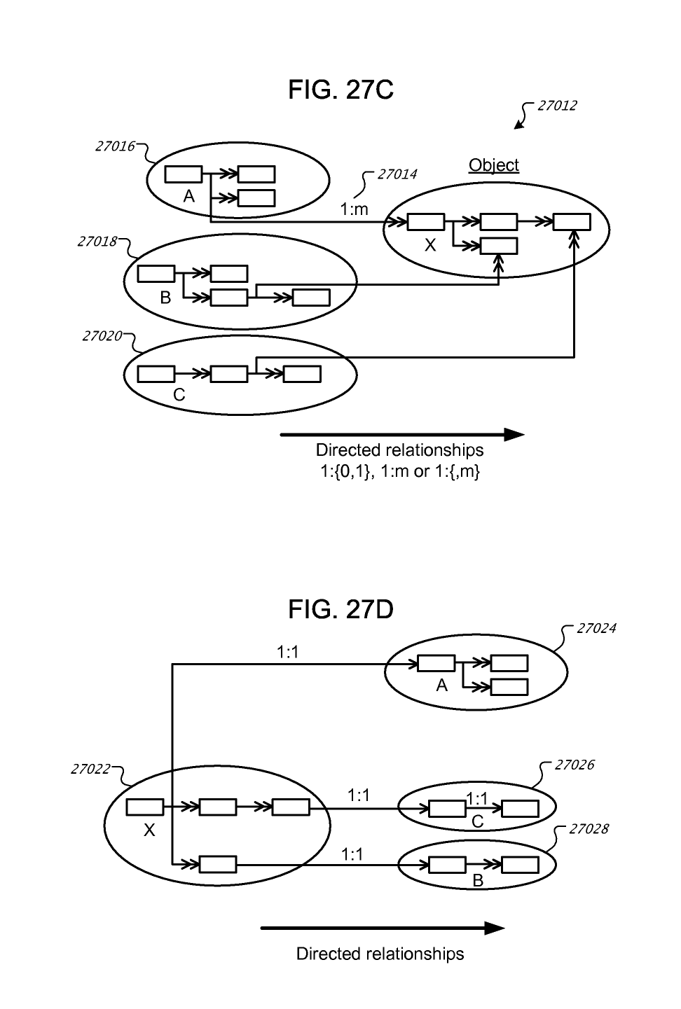

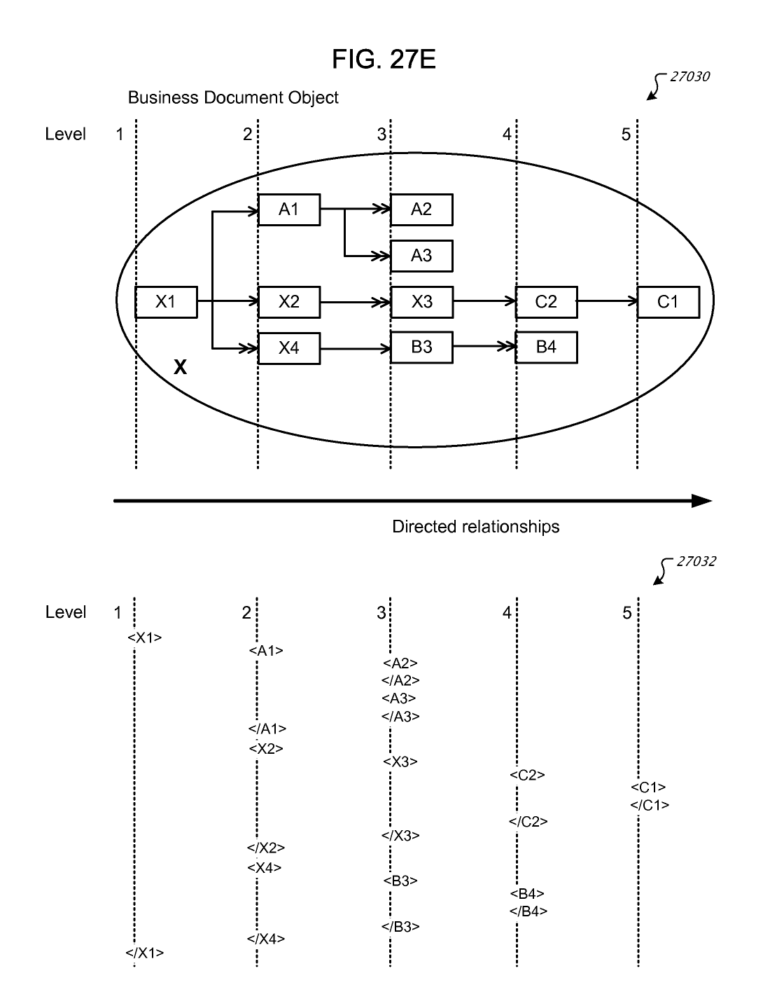

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process:
A business document object always refers to a leading business document object and is derived from this object.
The name of the root entity in the business document entity is the name of the business object or the name of a specialization of the business object or the name of a service specific view onto the business object.
The nodes and elements of the business object that are relevant (according to the semantics of the associated message type) are contained as entities and elements in the business document object.
The name of a business document entity is predefined by the name of the corresponding business object node. The name of the superordinate entity is not repeated in the name of the business document entity. The “full” semantic name results from the concatenation of the entity names along the hierarchical structure of the business document object.
The structure of the business document object is, except for deviations due to hierarchization, the same as the structure of the business object.
The cardinalities of the business document object nodes and elements are adopted identically or more restrictively to the business document object.
An object from which the leading business object is dependent can be adopted to the business document object. For this arrangement, the relationship is inverted, and the object (or its parts, respectively) are hierarchically subordinated in the business document object.
Nodes in the business object representing generalized business information can be adopted as explicit entities to the business document object (generally speaking, multiply TypeCodes out). When this adoption occurs, the entities are named according to their more specific semantic (name of TypeCode becomes prefix).
   Party nodes of the business object are modeled as explicit entities for each party role in the business document object. These nodes are given the name <Prefix><Party Role>Party, for example, BuyerParty, ItemBuyerParty.
   BTDReference nodes are modeled as separate entities for each reference type in the business document object. These nodes are given the name <Qualifier><BO><Node>Reference, for example SalesOrderReference, OriginSalesOrderReference, SalesOrderItemReference.
   A product node in the business object comprises all of the information on the Product, ProductCategory, and Batch. This information is modeled in the business document object as explicit entities for Product, ProductCategory, and Batch.
Entities which are connected by a 1:1 relationship as a result of hierarchization can be combined to a single entity, if they are semantically equivalent. Such a combination can often occurs if a node in the business document object that results from an assignment node is removed because it does not have any elements.
The message type structure is typed with data types.
   Elements are typed by GDTs according to their business objects.
   Aggregated levels are typed with message type specific data types (Intermediate Data Types), with their names being built according to the corresponding paths in the message type structure.
   The whole message type structured is typed by a message data type with its name being built according to the root entity with the suffix “Message”.
For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

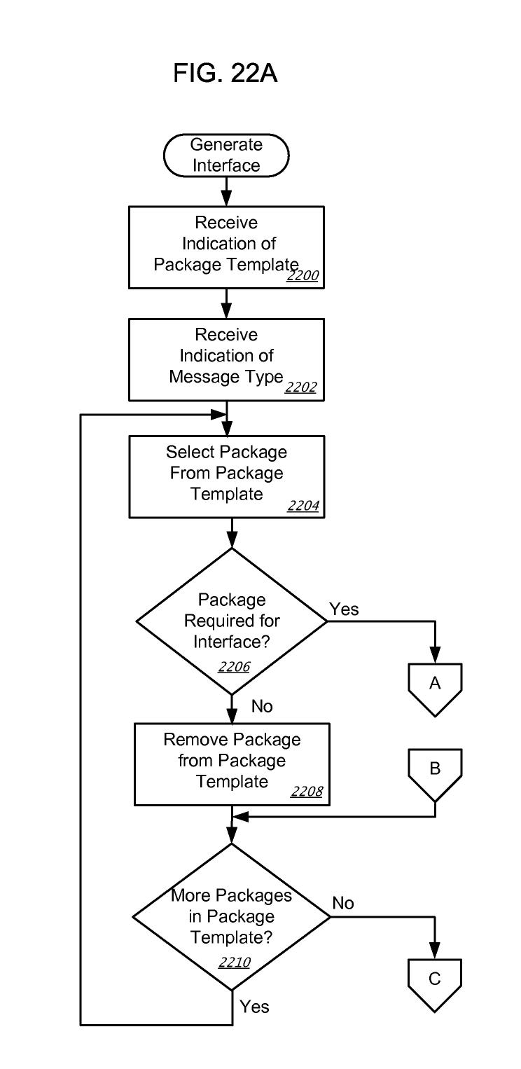

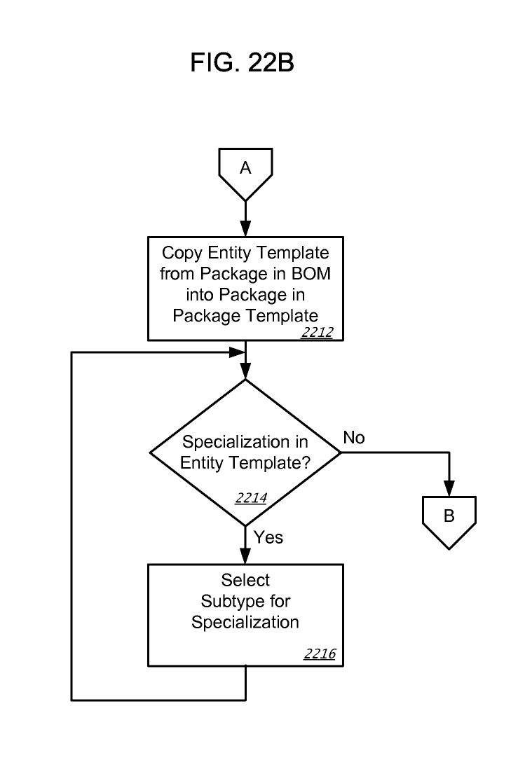

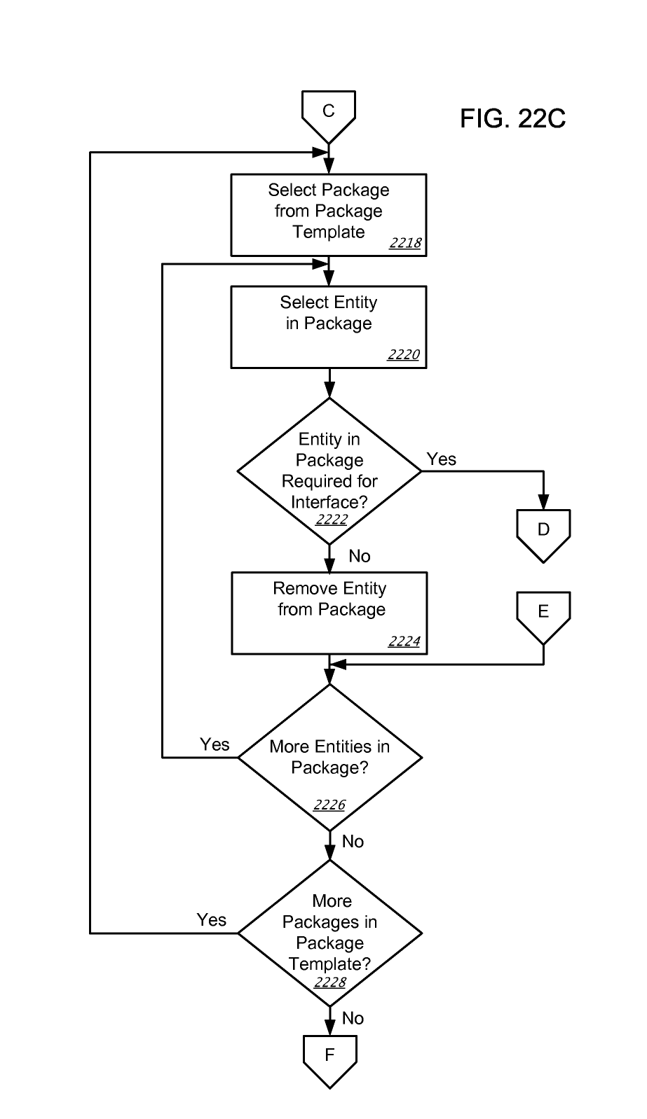

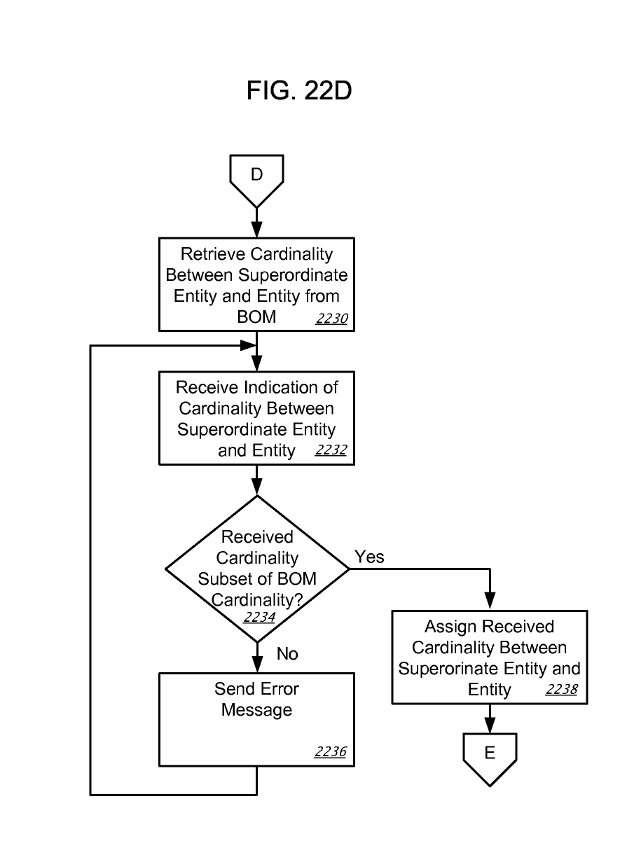

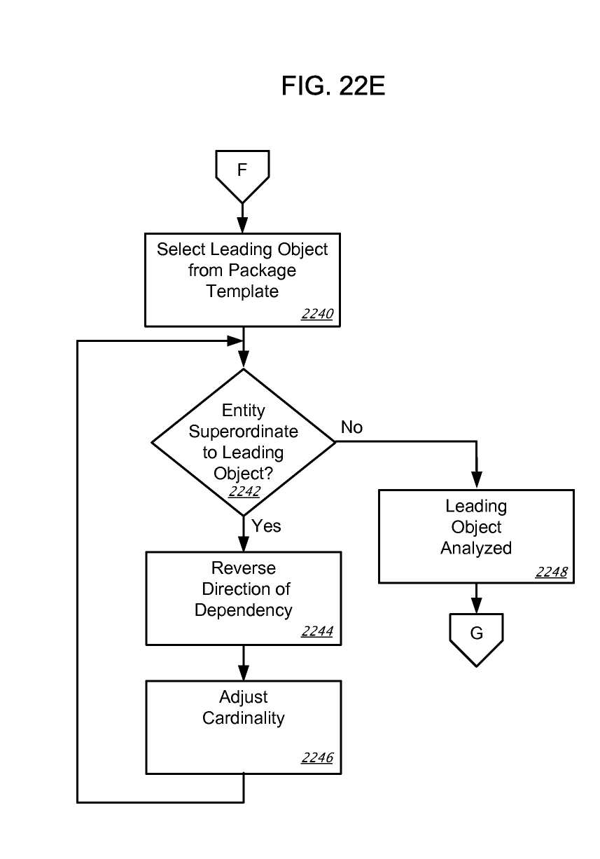

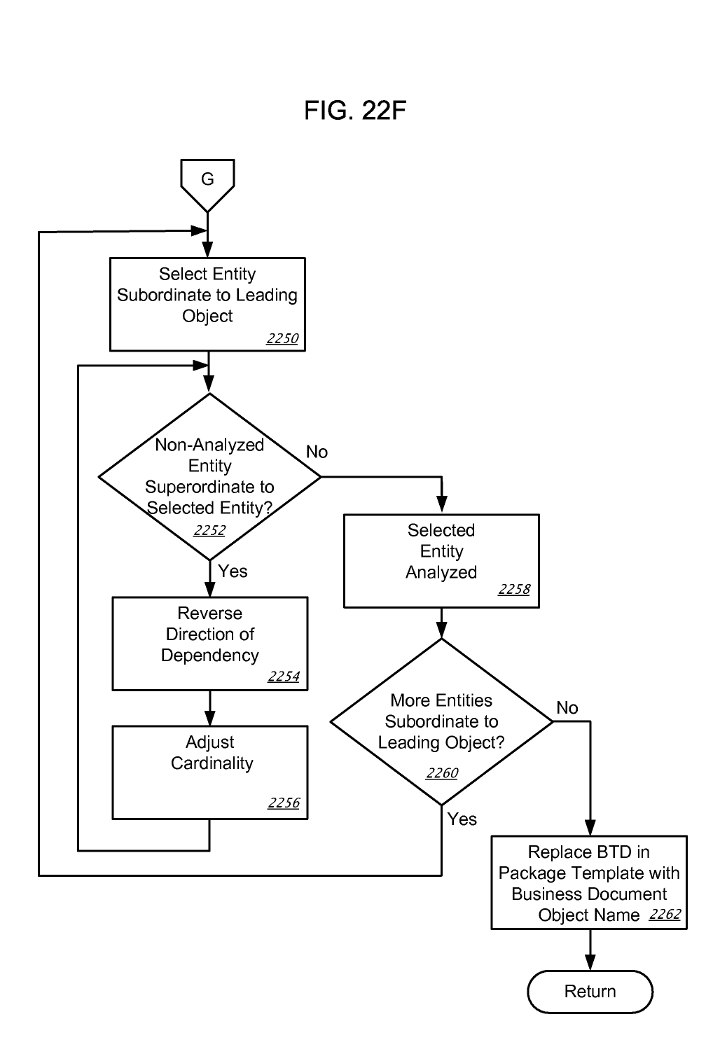

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

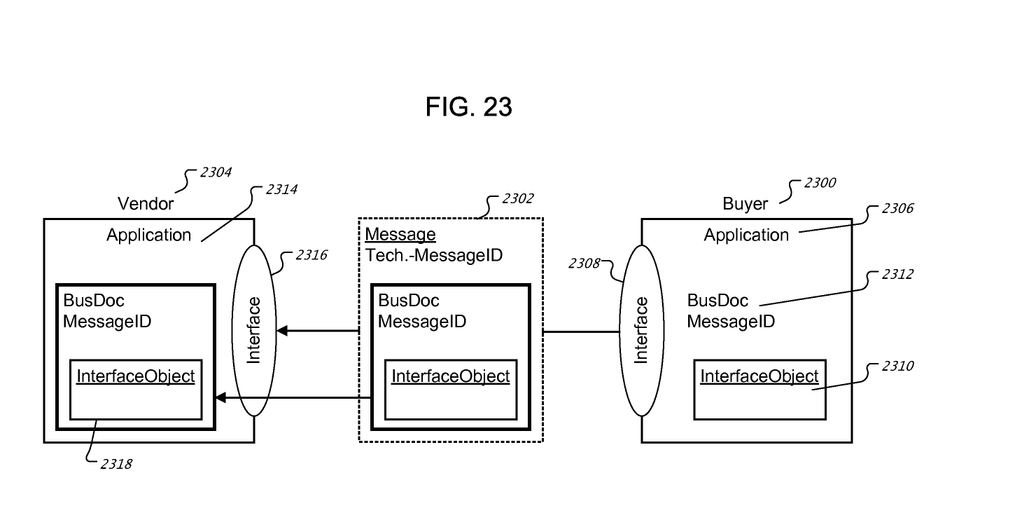

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

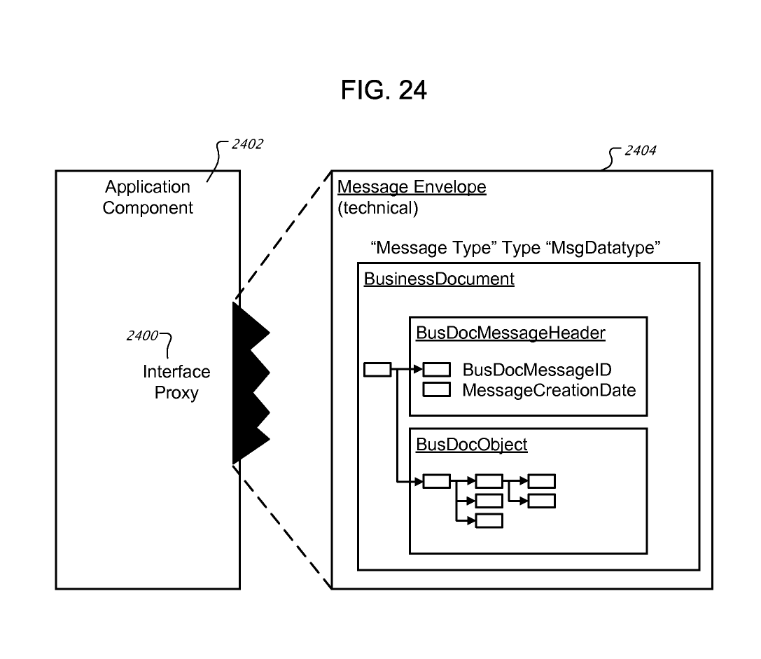

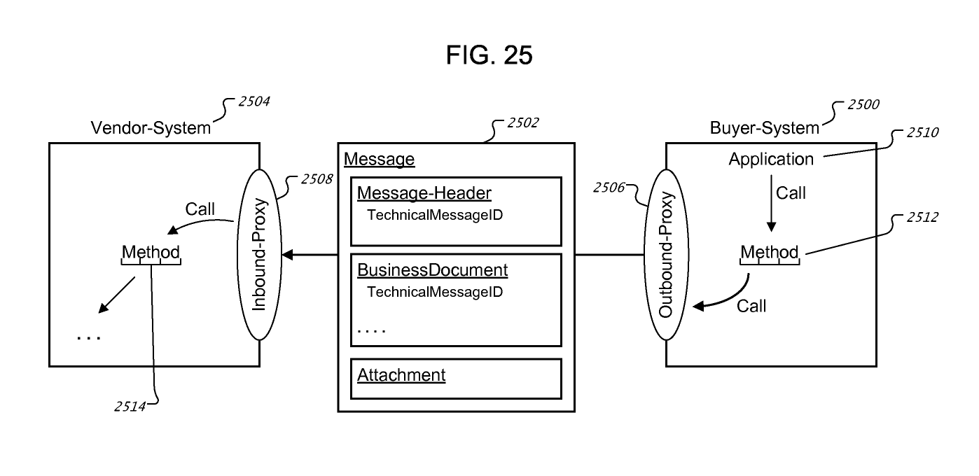

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

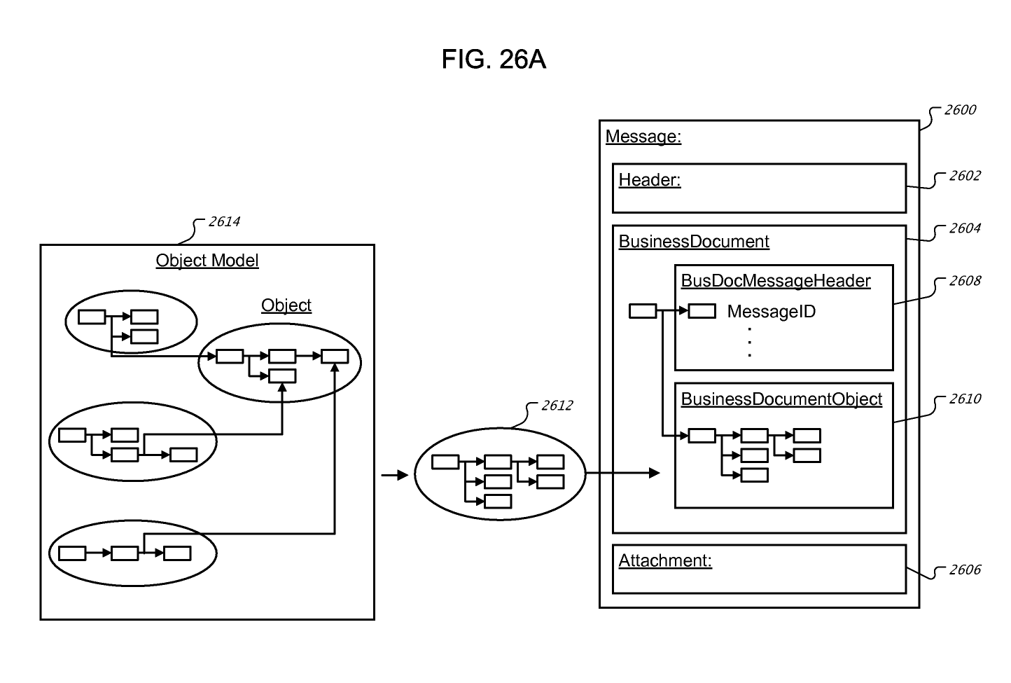

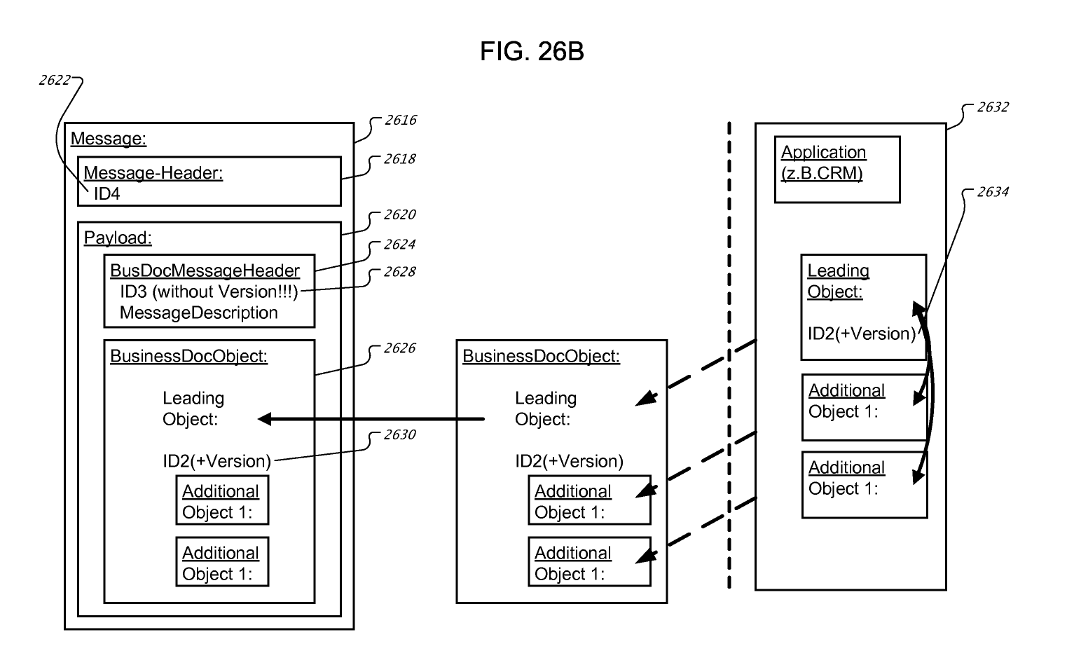

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

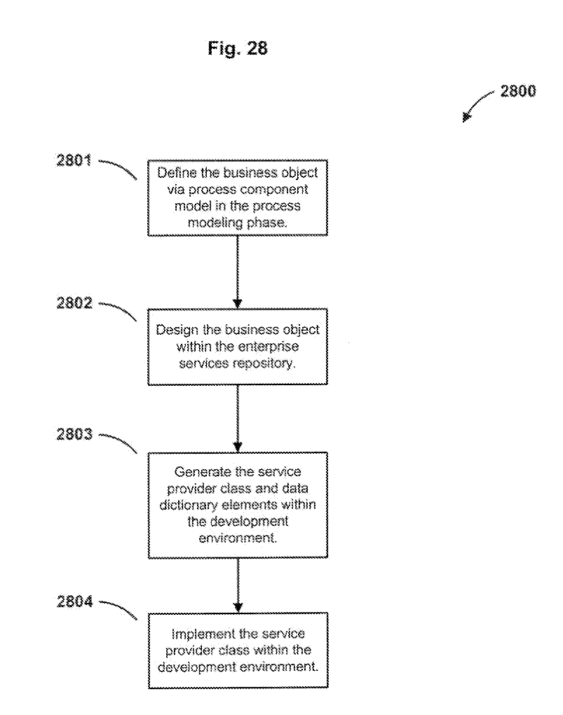

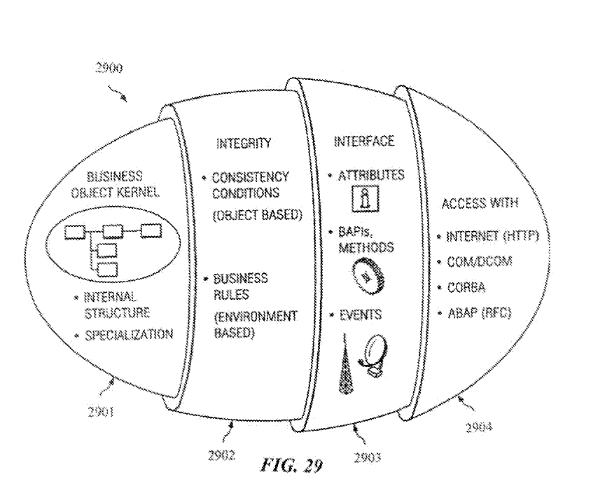

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

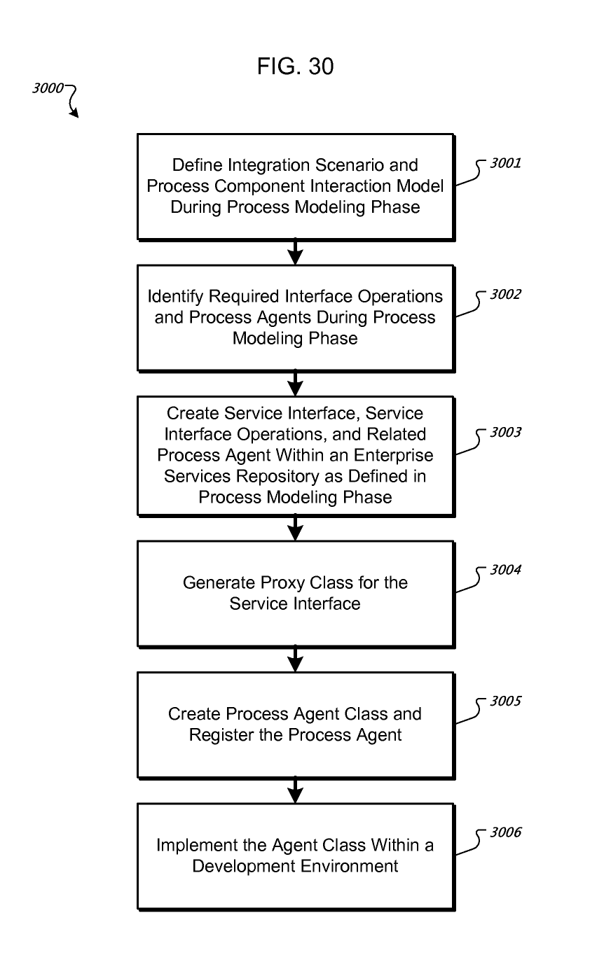

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

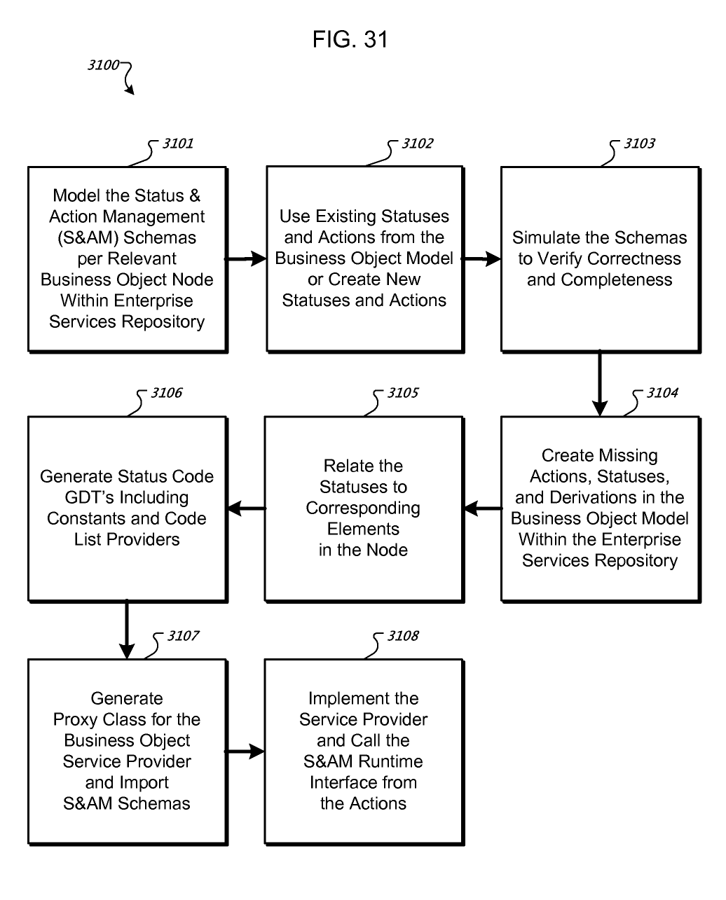

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

### AnalyticalViewOfTradingOrder Interfaces

An AnalyticalViewOfTradingOrder is an analytical representation of a Trading Order and its structure. The Analytical View Of Trading Order enables analysis of the market-to-market-evaluation of the trading order as well as of its products. The AnalyticalViewOfTradingOrder recognizes changes in Logistics, for example, changes in quantities, values and deadlines. The Analytical View of Trading Order contains the analysis-relevant elements and characteristics of a Trading Order and its underlying documents.

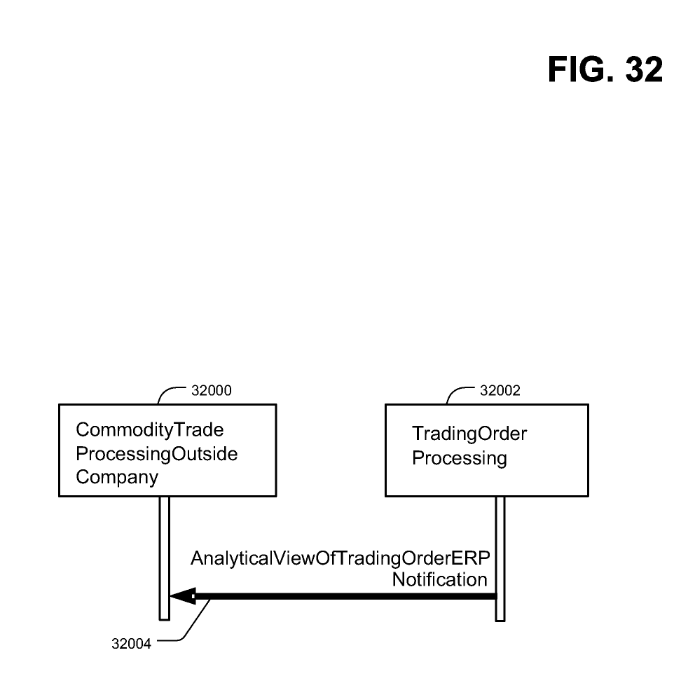

The message choreography of FIG. 32 describes a possible logical sequence of messages that can be used to realize an AnalyticalViewOfTradingOrder business scenario.

A “TradingOrderProcessing” system 32002 can send a notification regarding an analytical view of trading order for enterprise resource planning (ERP) using an AnalyticalViewOfTradingOrderERPNotification message 32004 as shown, for example, in FIG. 32. The message 32004 can be received by a “CommodityTradeProcessingOutsideCompany” system 32000 as shown, for example, in FIG. 32.

The AnalyticalViewOfTradingOrder interface performs an AnalyticalViewOfTradingOrderERPNotification_Out operation.

The AnalyticalViewOfTradingOrderERPNotification is a notification from the TradingOrderProcessing for an AnalyticalViewOfTradingOrder when an underlying document of the Trading Order is processed. The AnalyticalViewOfTradingOrderERPNotification_Out operation is used to publish the analytical information of the Trading Order. The AnalyticalViewOfTradingOrderERPNotification_Out operation includes an AnalyticalViewOfTradingOrderERPNotification message type. The structure of the AnalyticalViewOfTradingOrderERPNotification message type is specified by an AnalyticalViewOfTradingOrderERPNotificationMessage message data type.

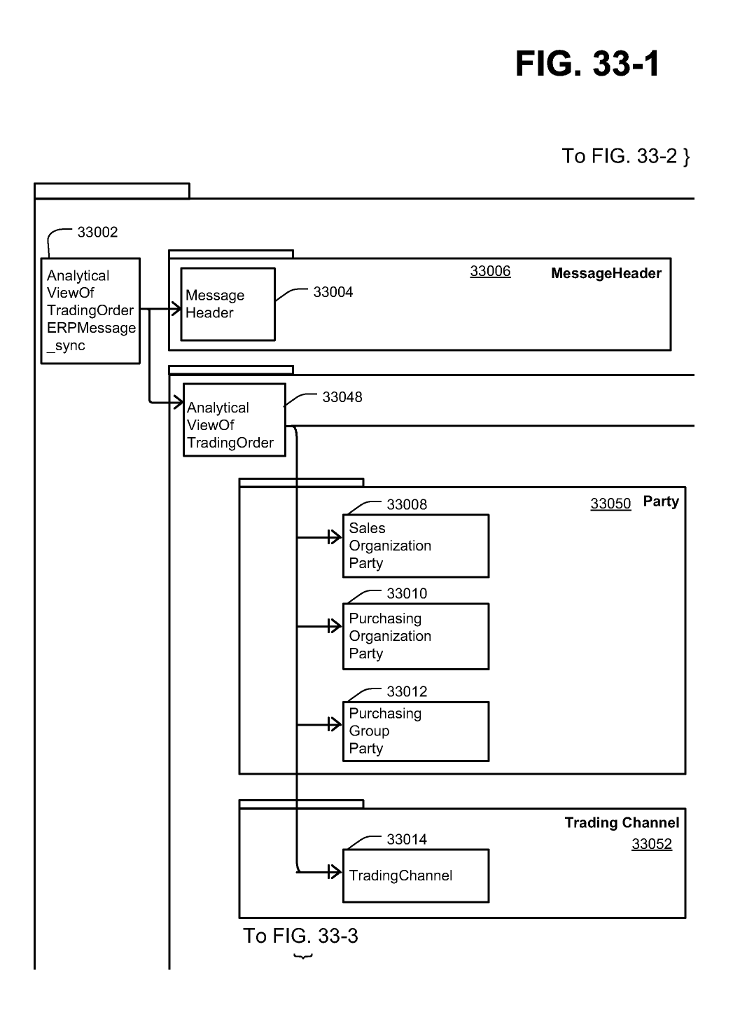

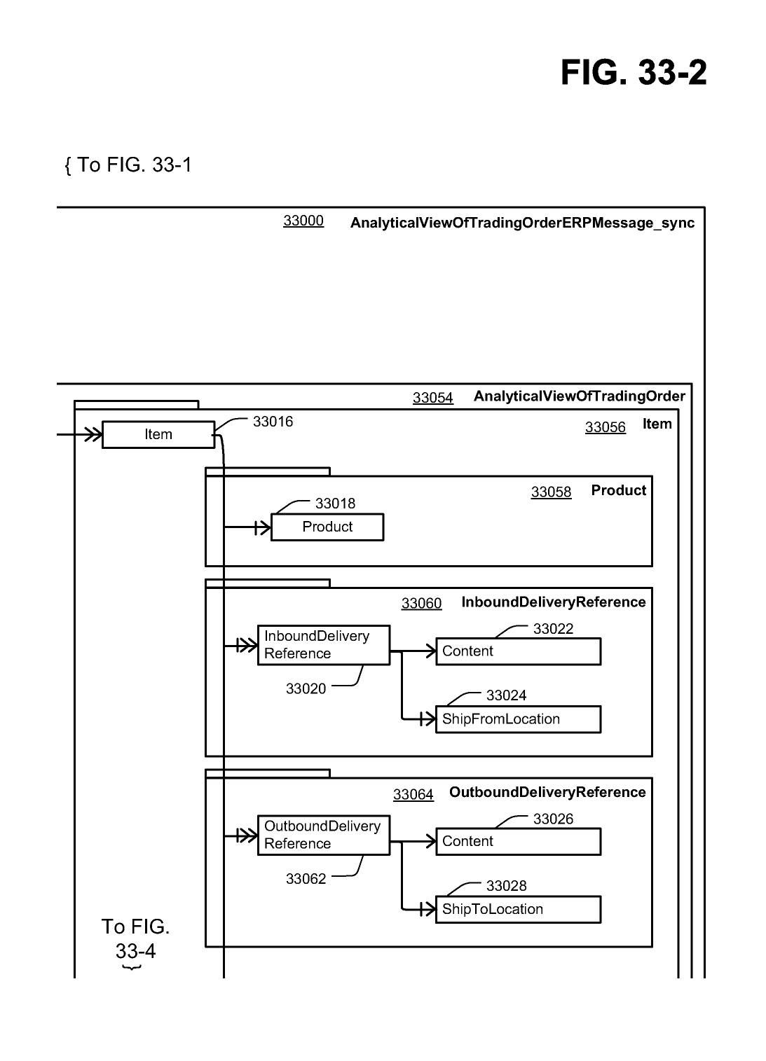

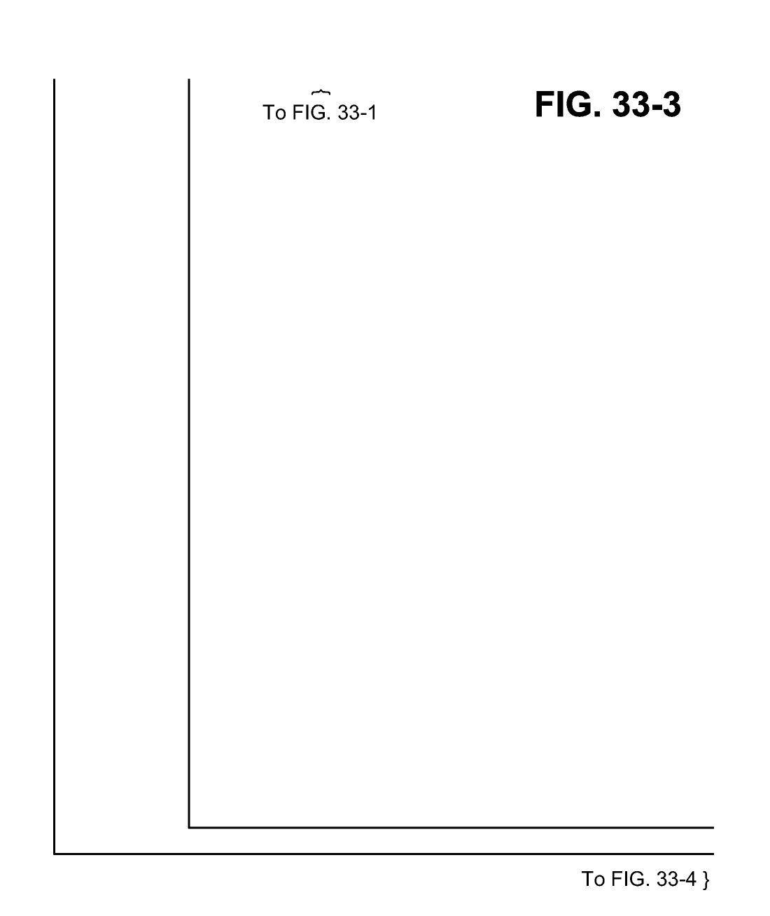

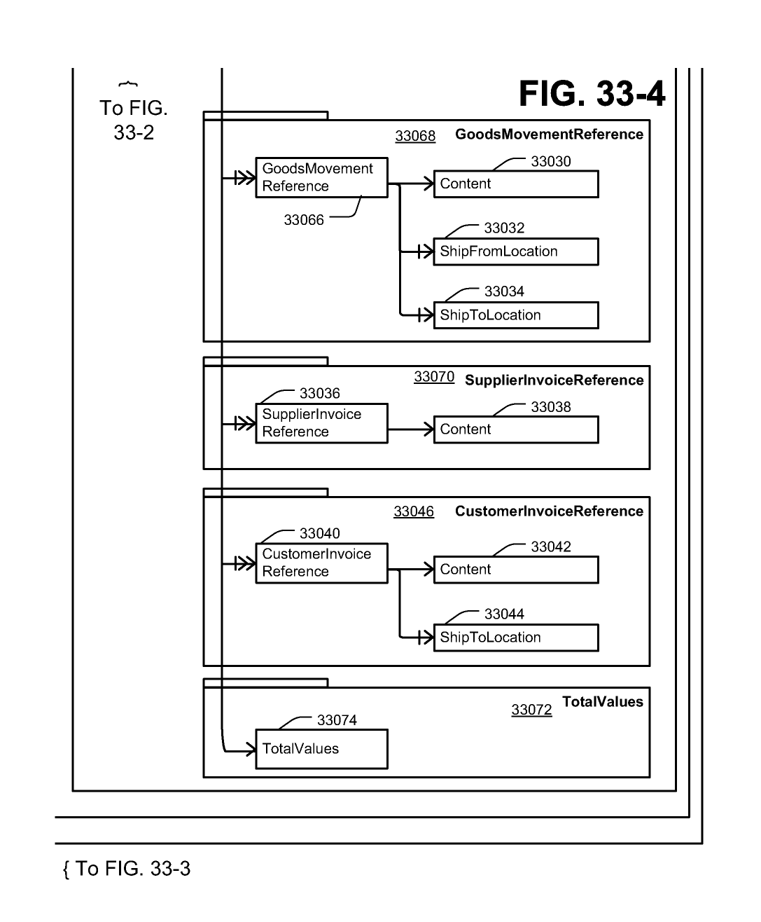

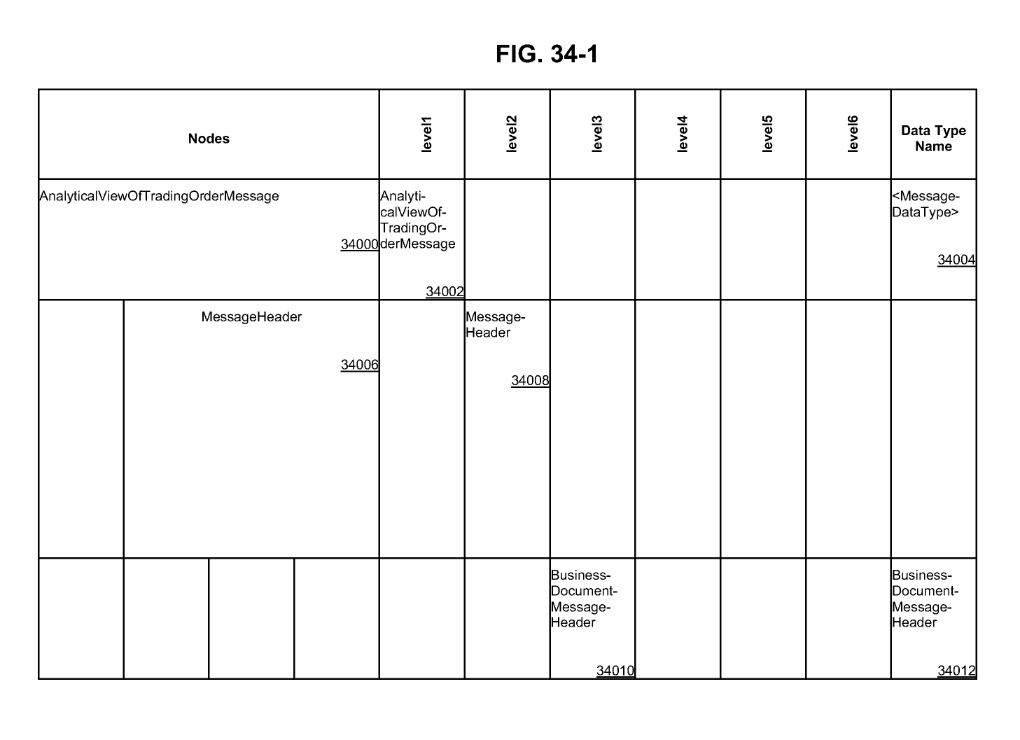

FIGS. 33-1 through 33-4 illustrate one example logical configuration of AnalyticalViewOfTradingOrderERPMessage message 33000. Specifically, this figure depicts the arrangement and hierarchy of various components such as one or more levels of packages, entities, and datatypes, shown here as 33000 through 33074. As described above, packages may be used to represent hierarchy levels. Entities are discrete business elements that are used during a business transaction. Data types are used to type object entities and interfaces with a structure. For example, AnalyticalViewOfTradingOrderERPMessage message 33000 includes, among other things, AnalyticalViewOfTradingOrder 33054. Accordingly, heterogeneous applications may communicate using this consistent message configured as such.

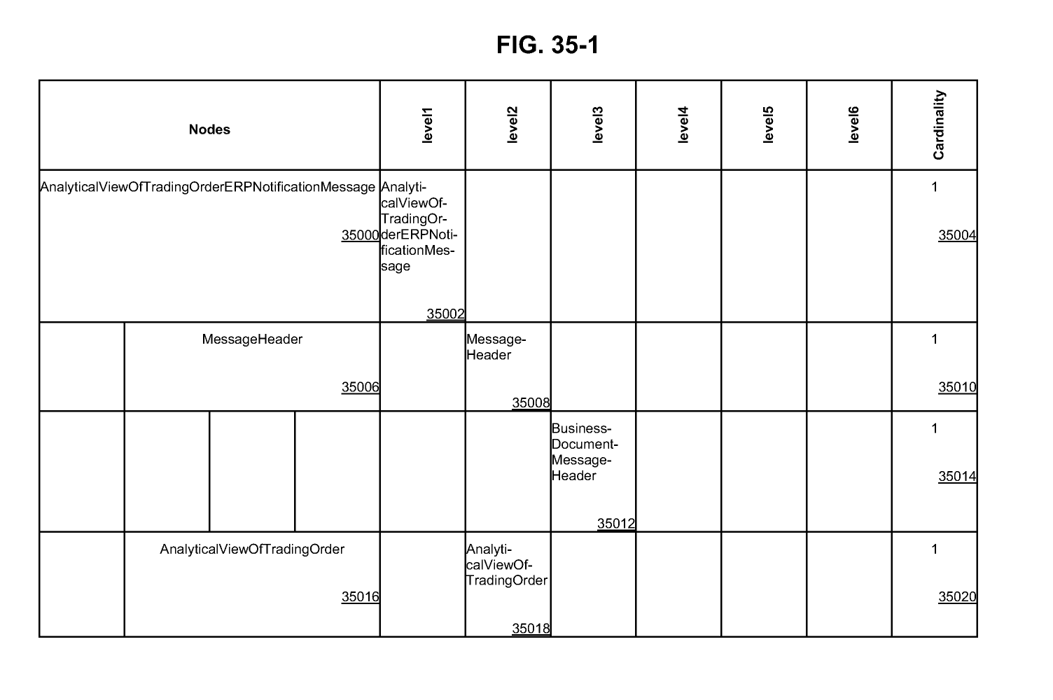

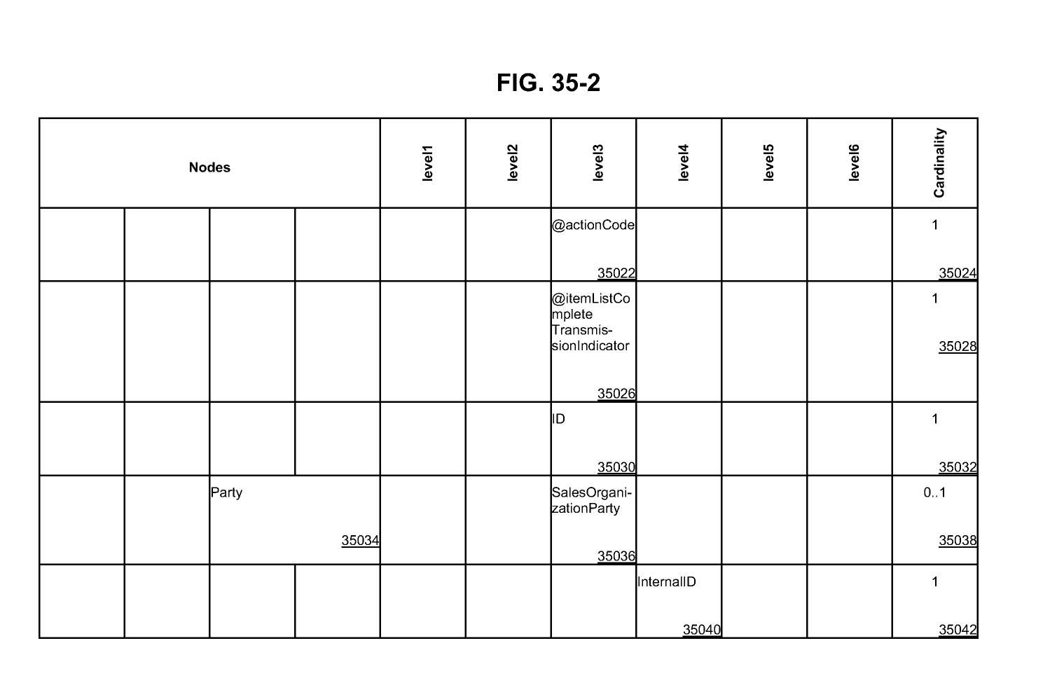

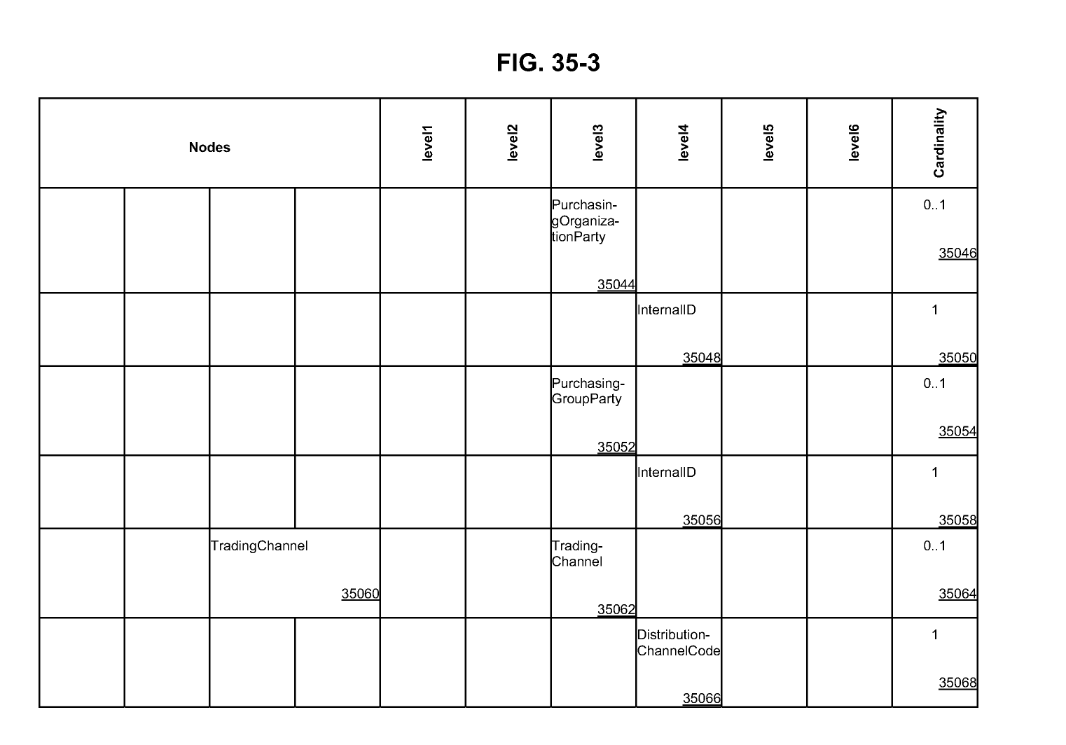

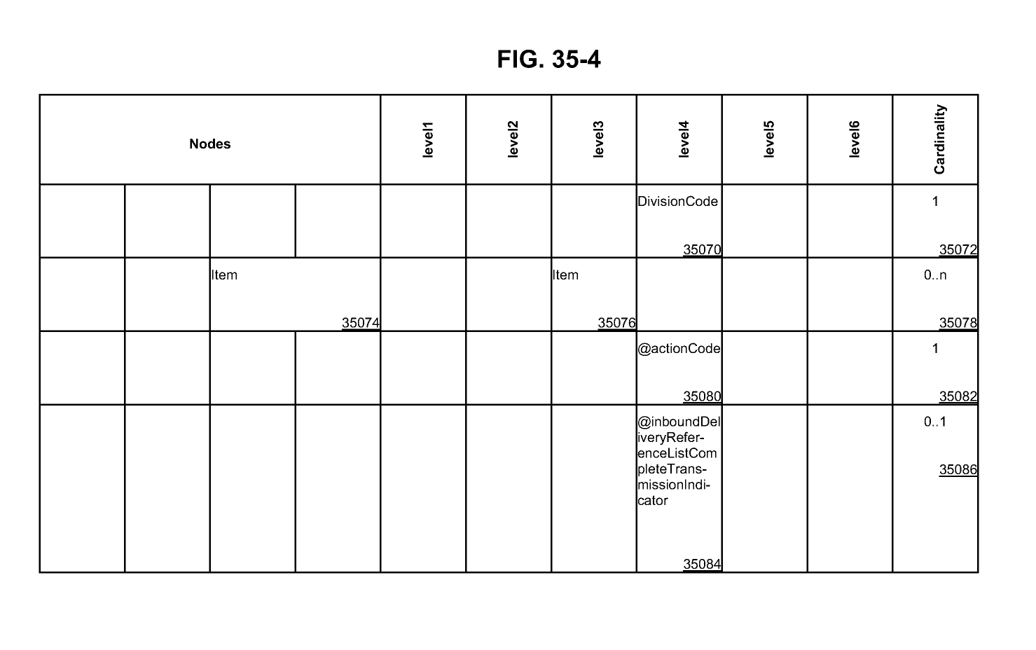

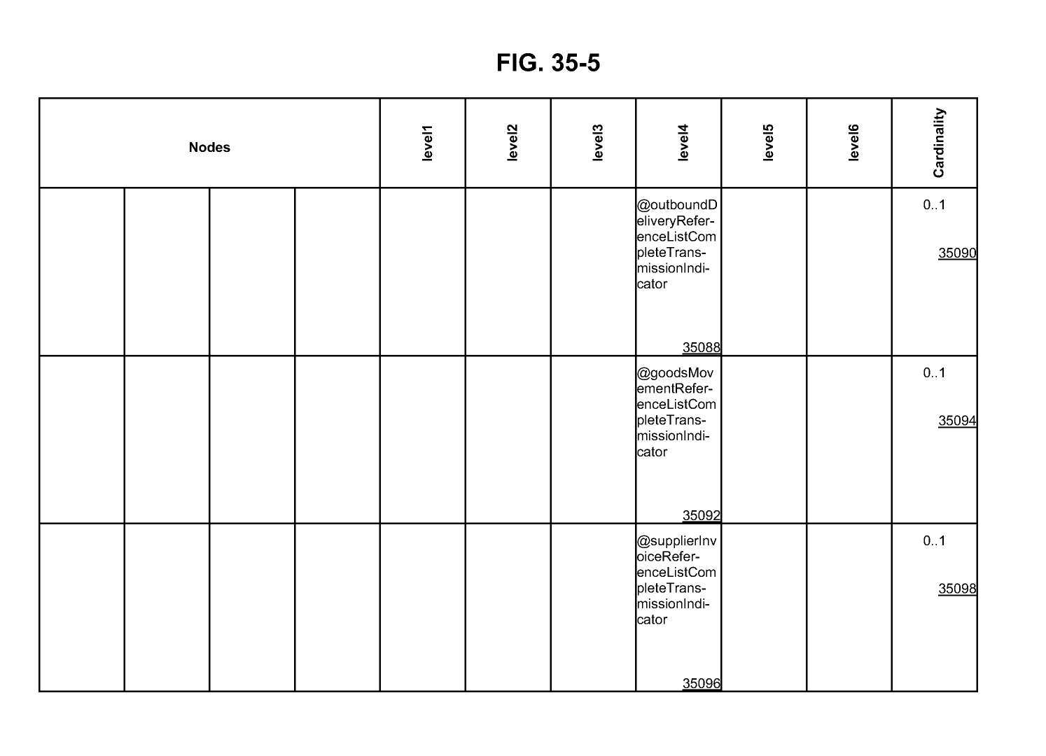

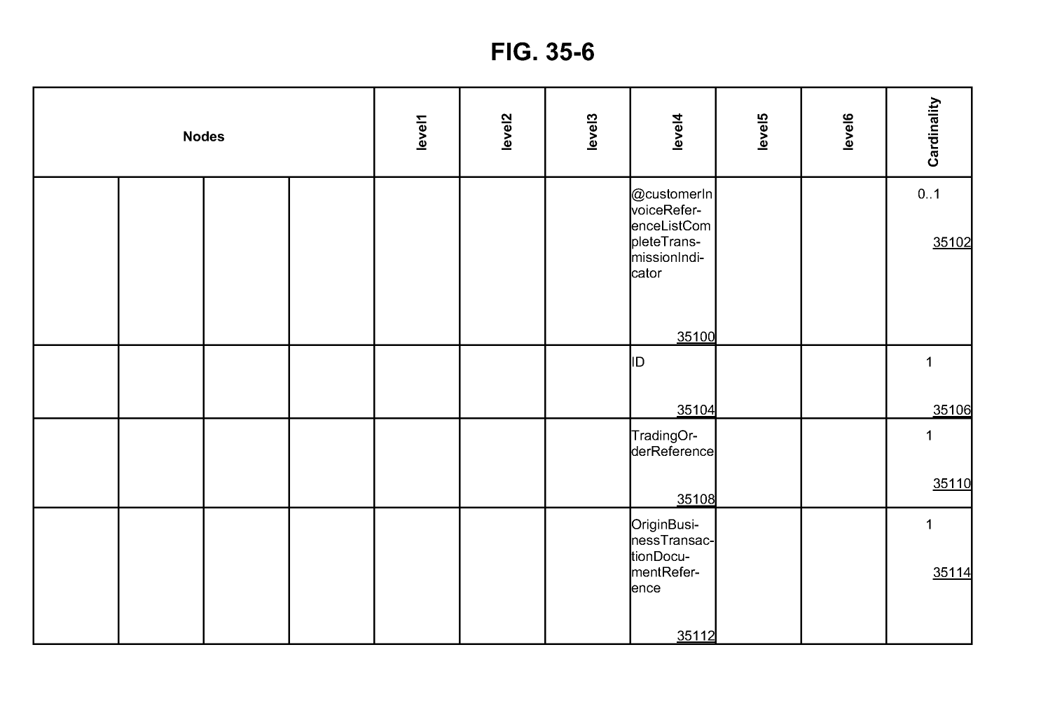

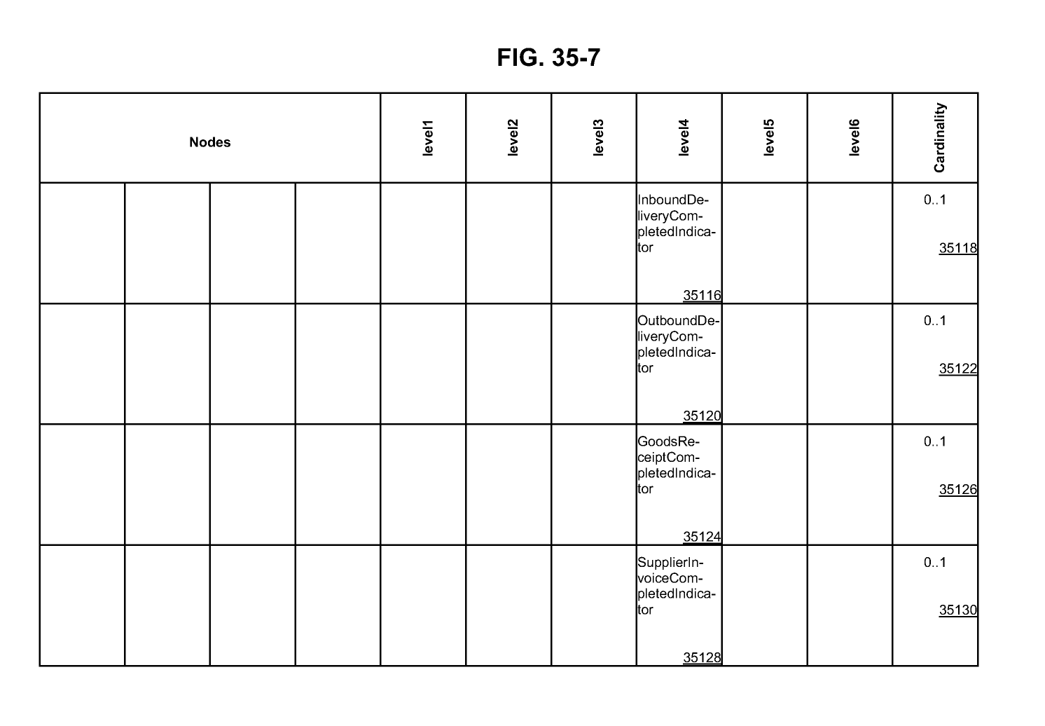

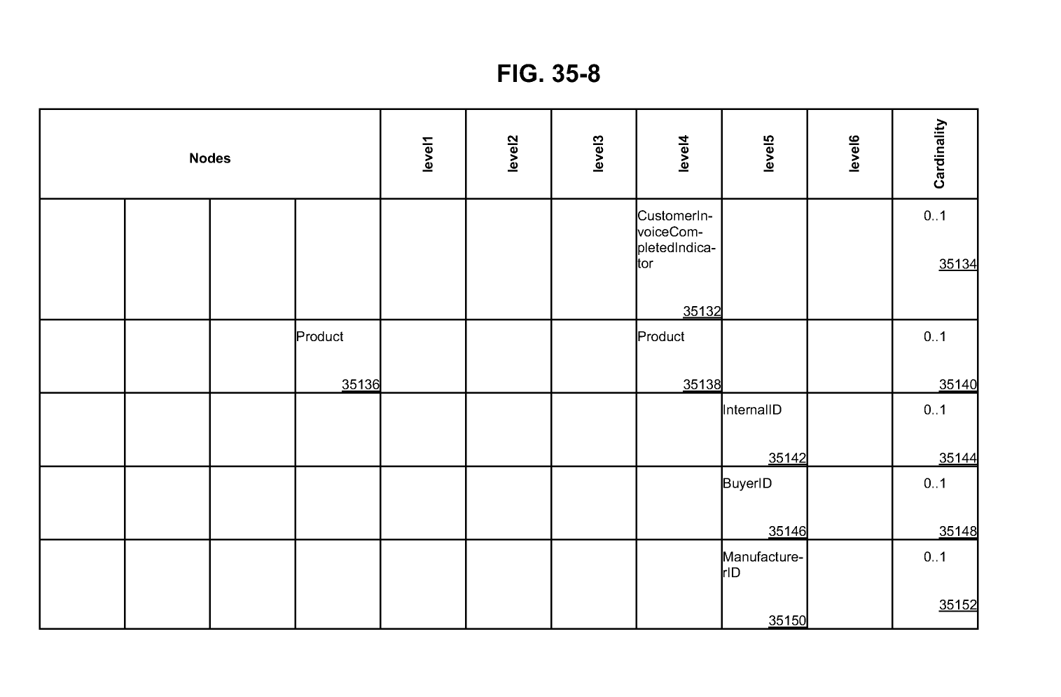

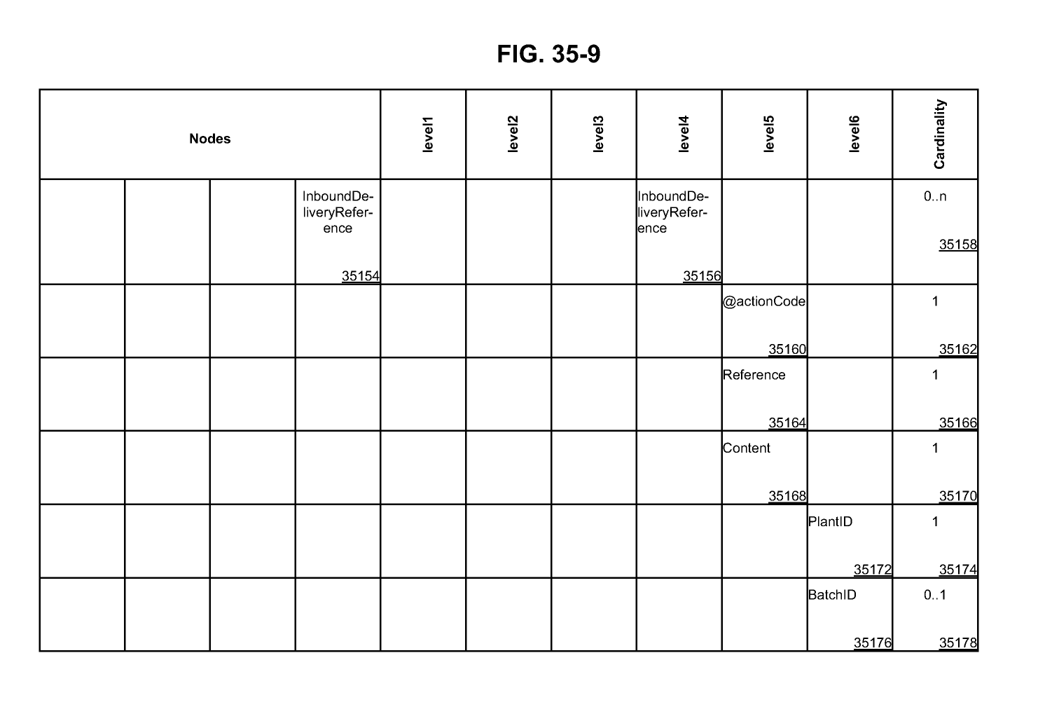

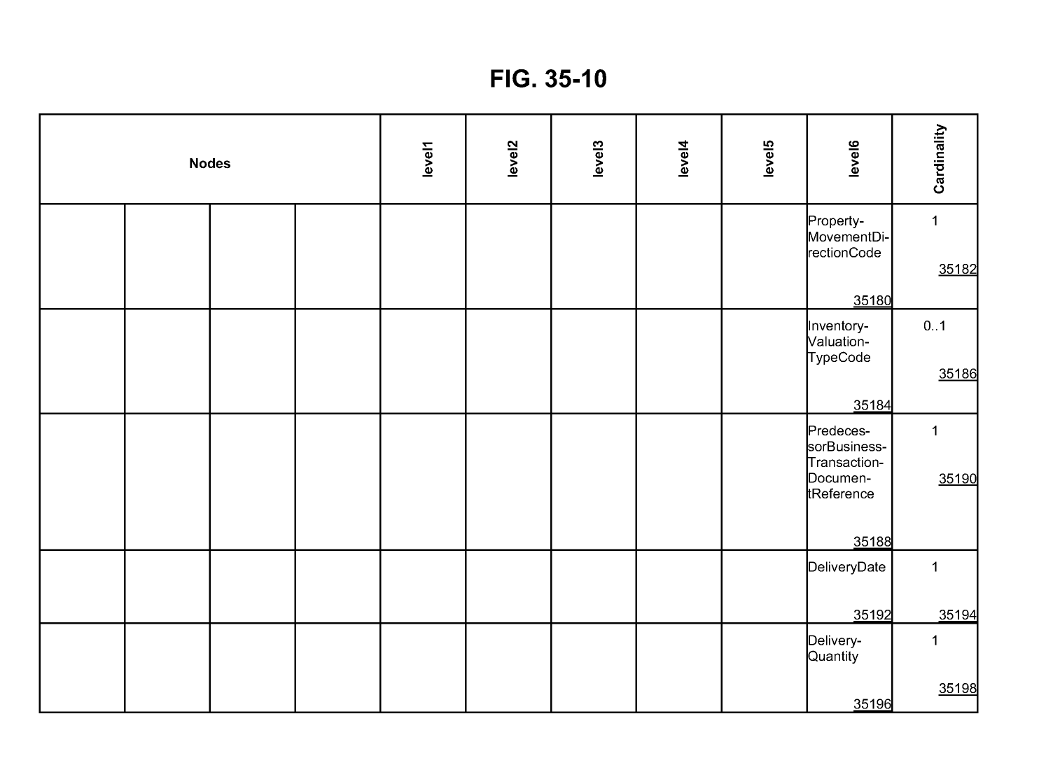

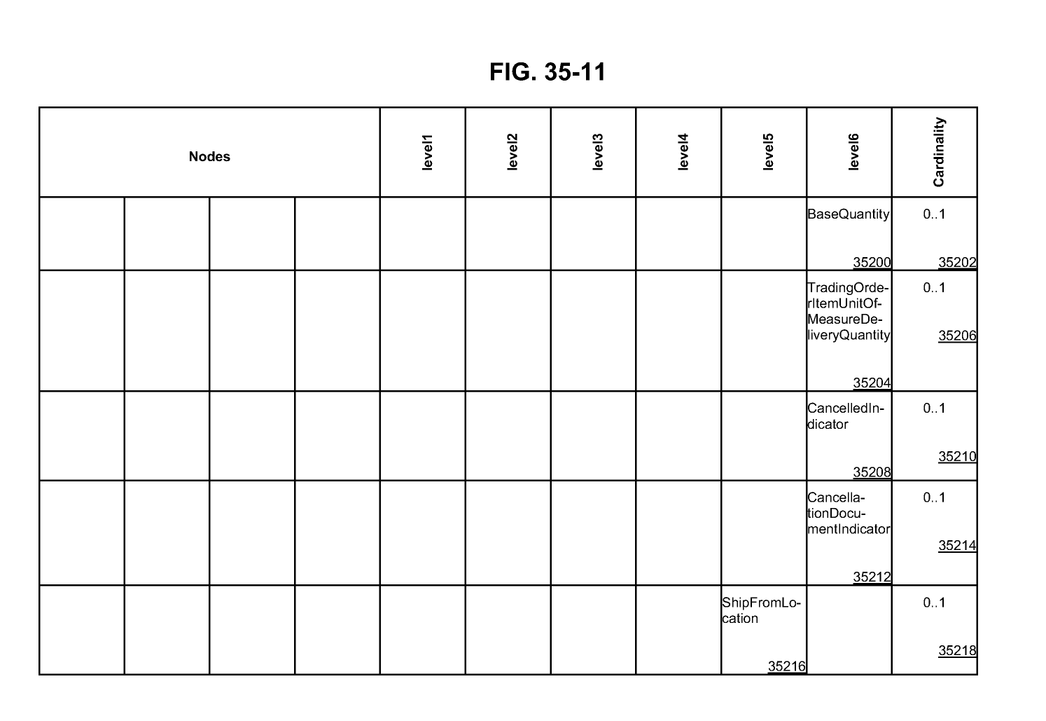

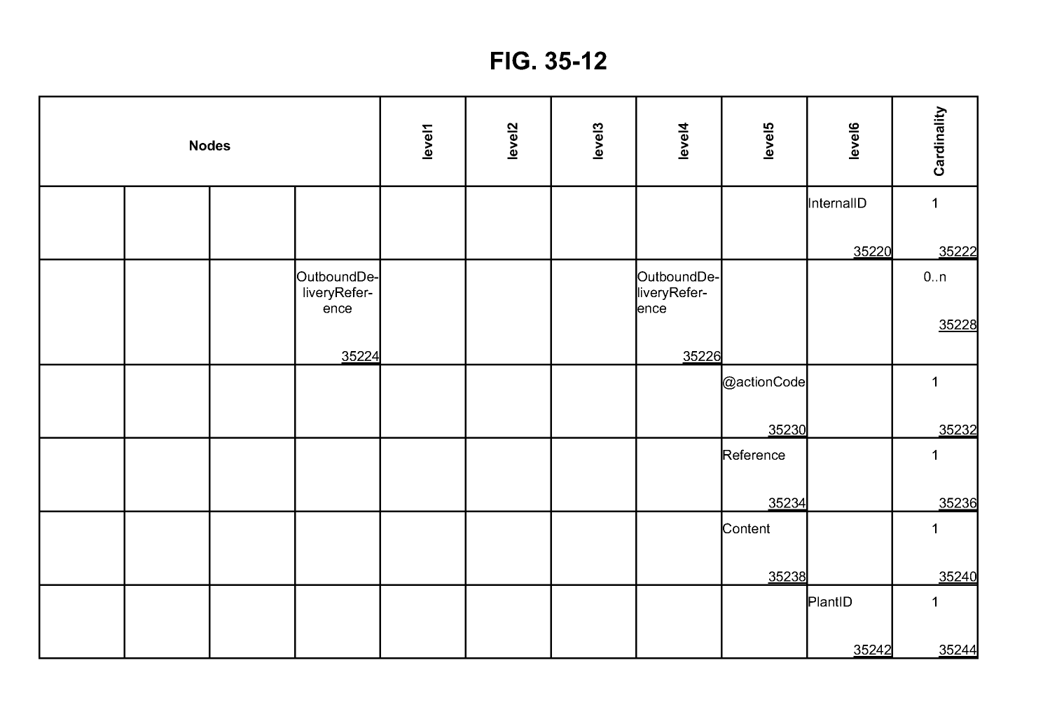

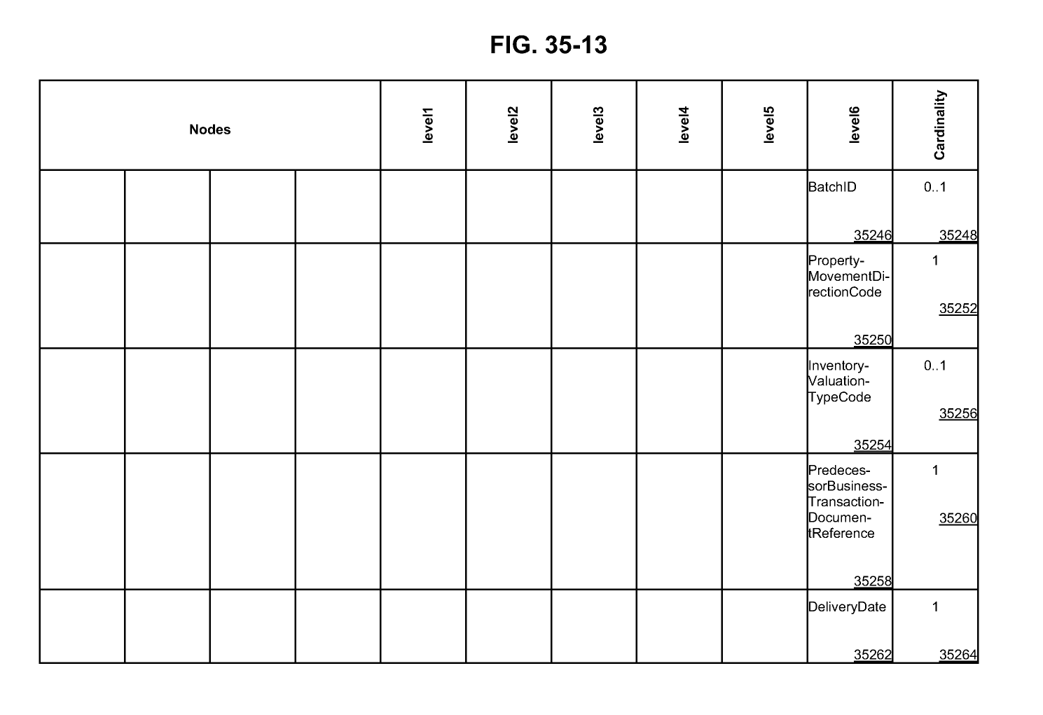

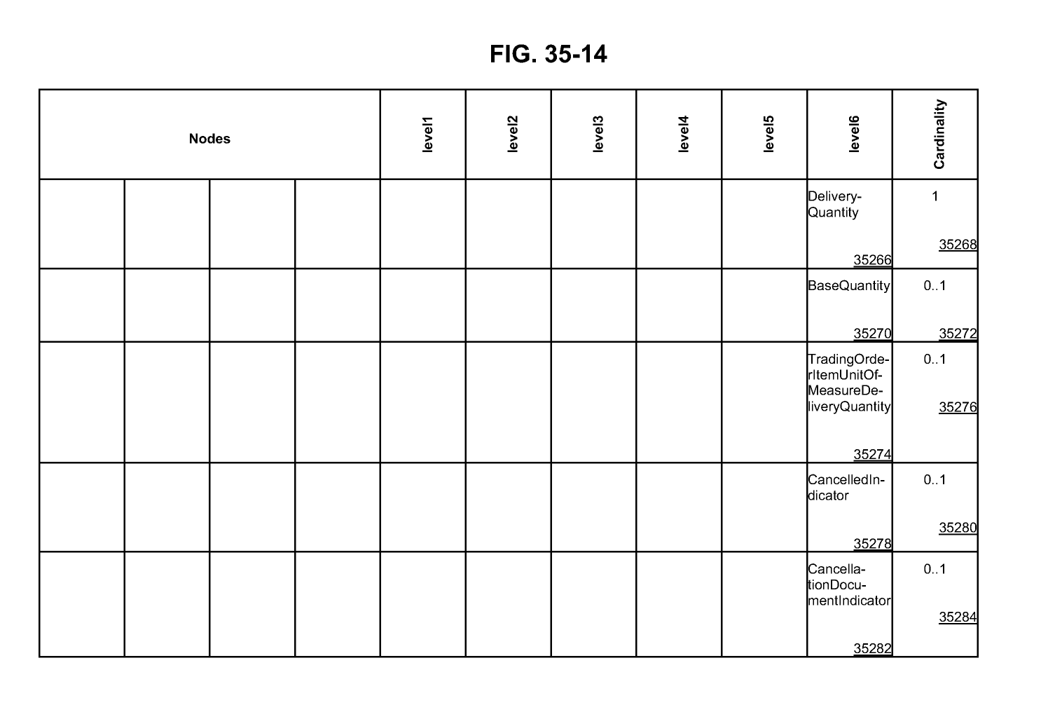

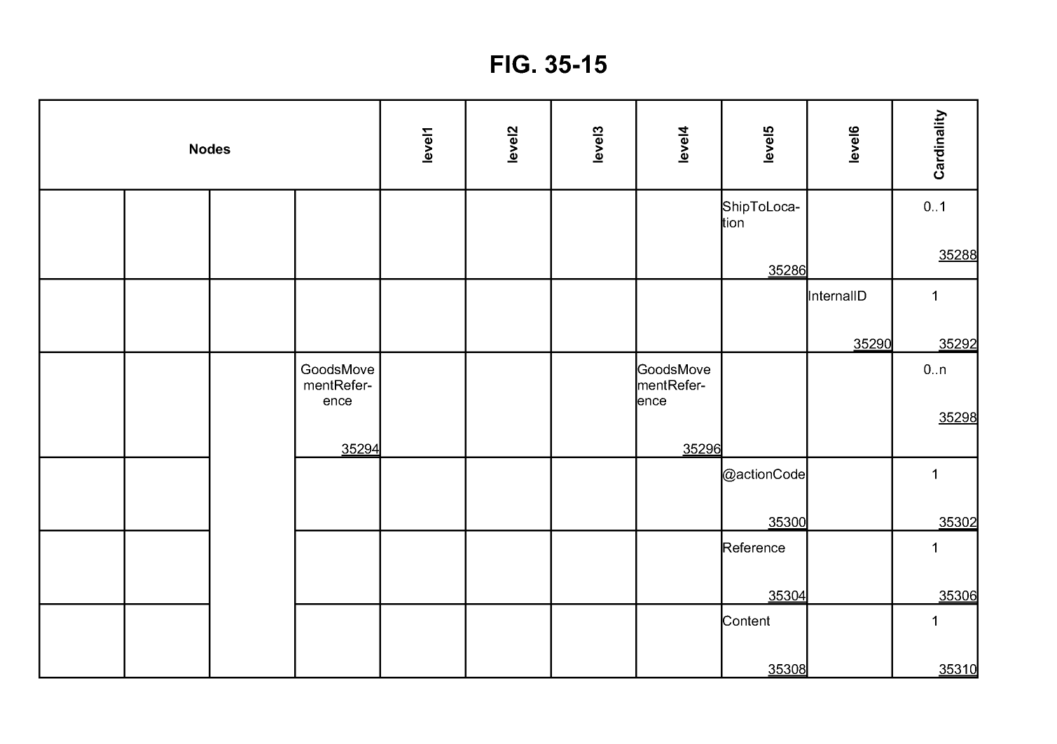

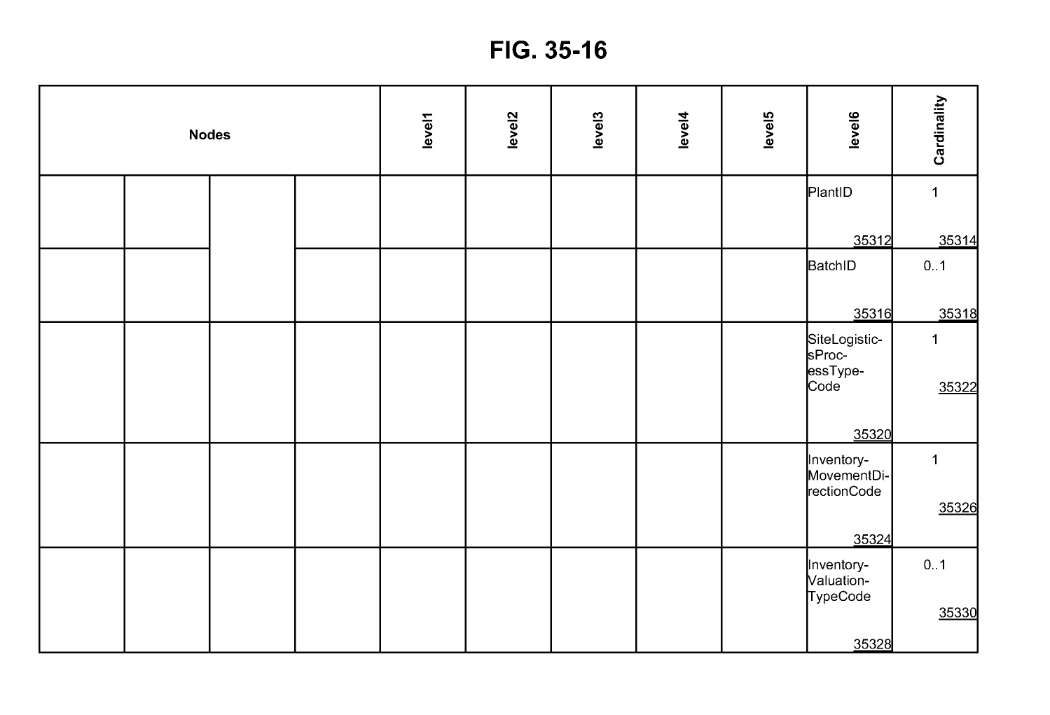

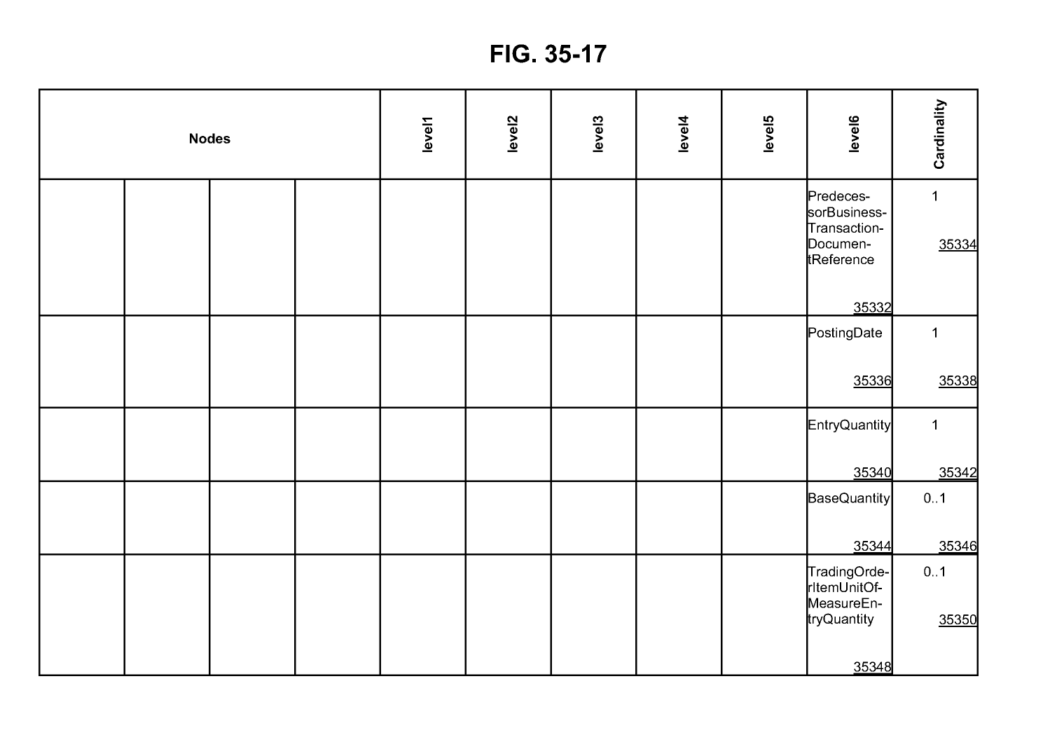

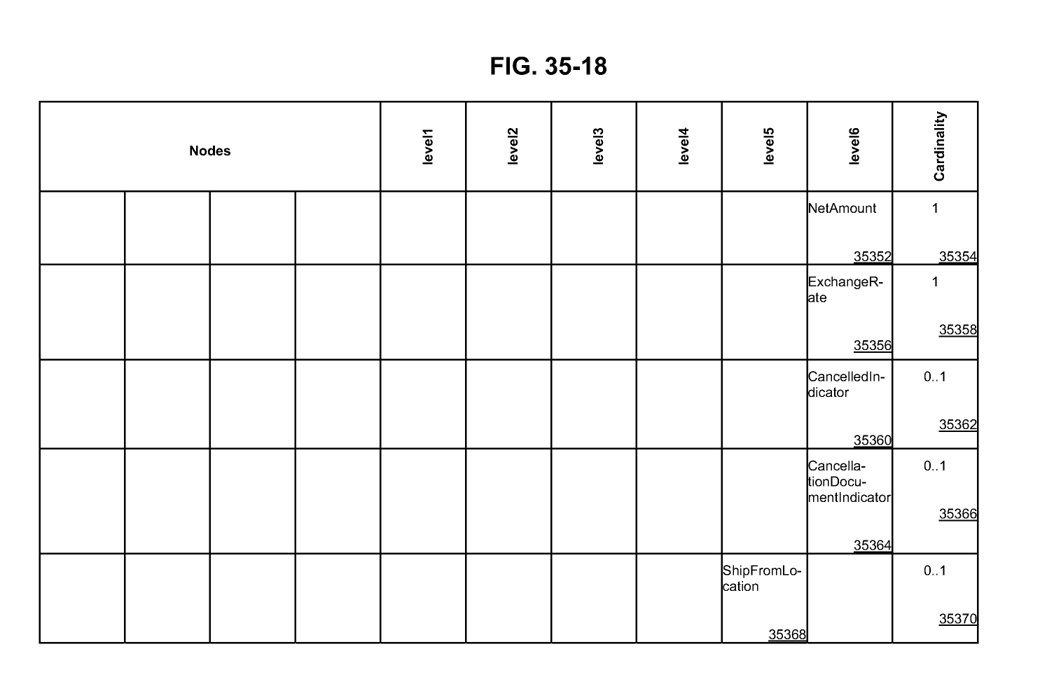

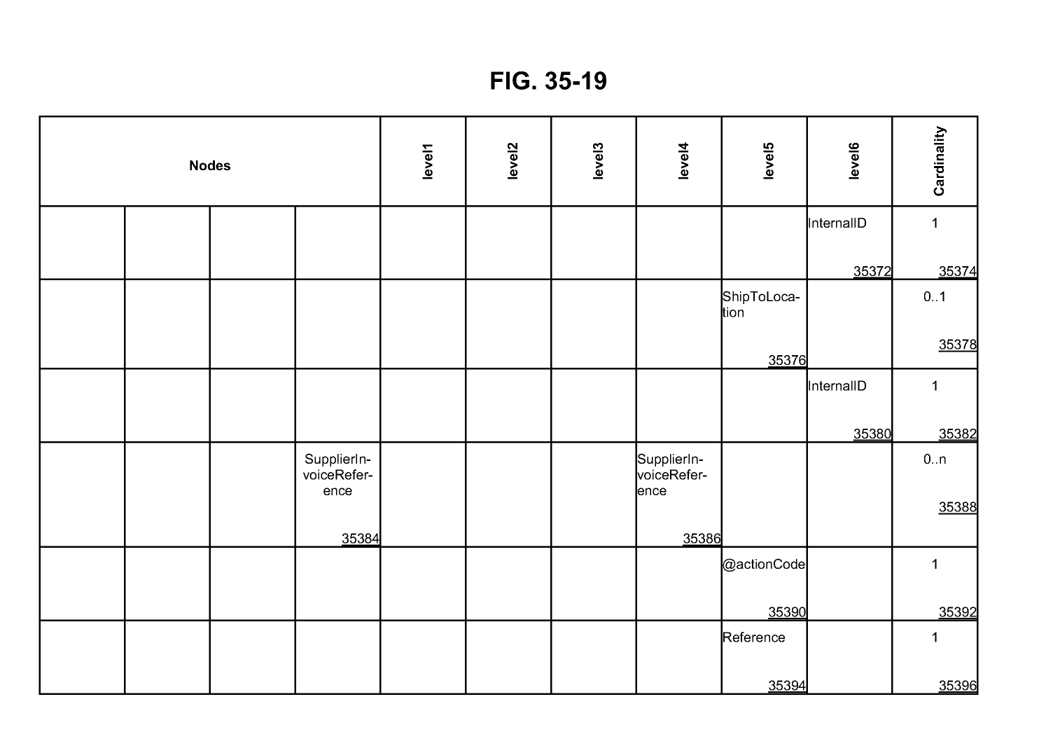

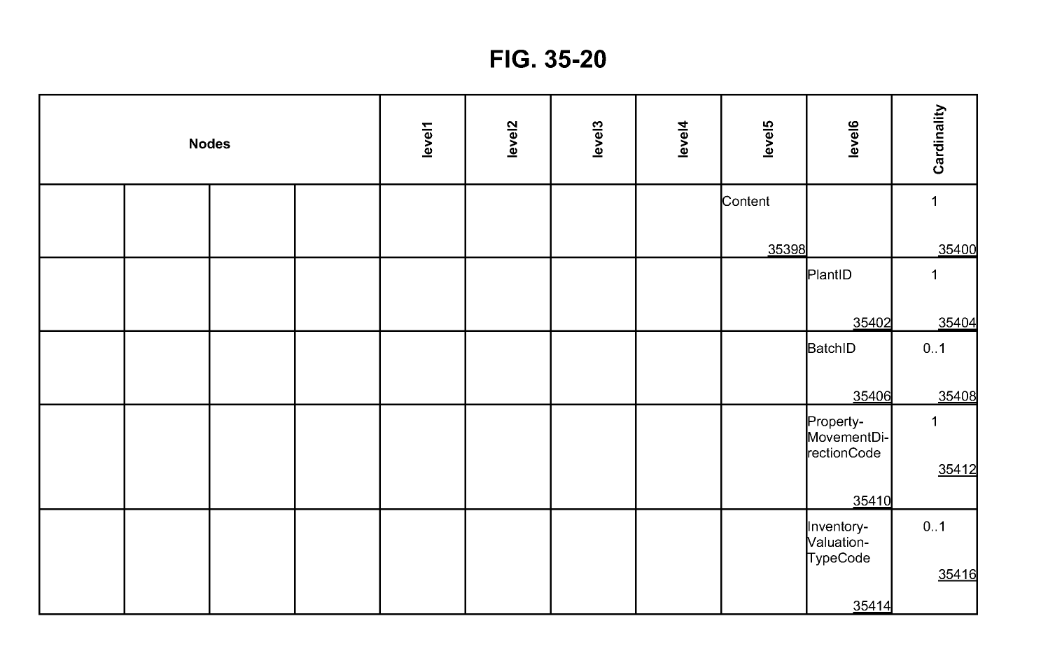

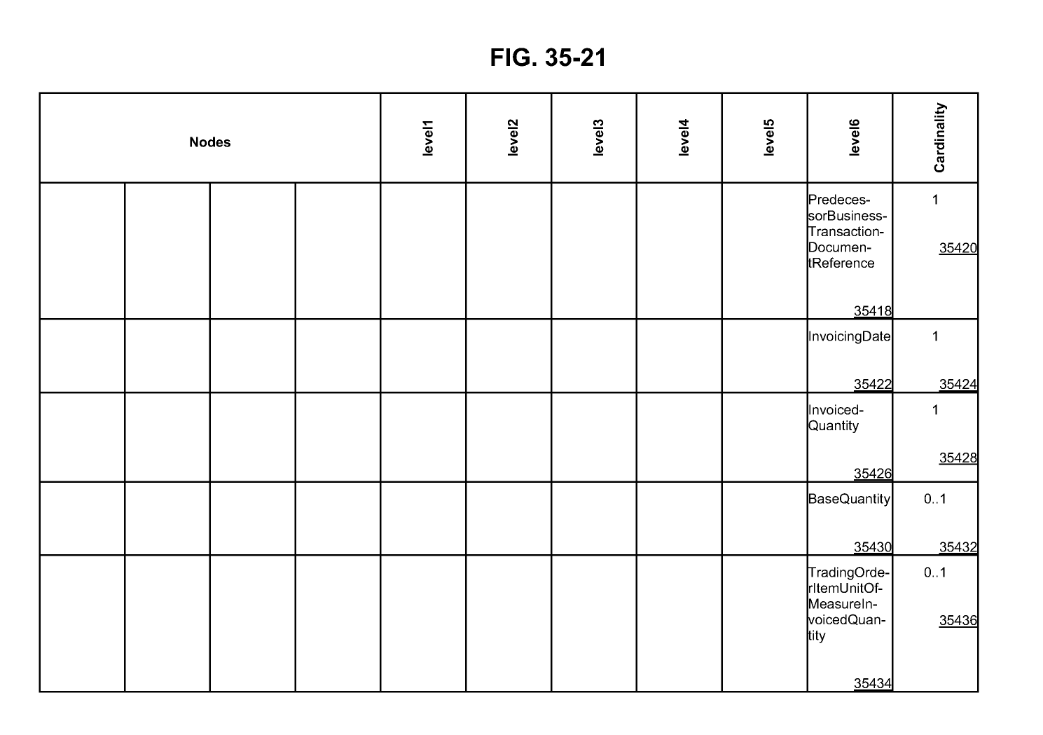

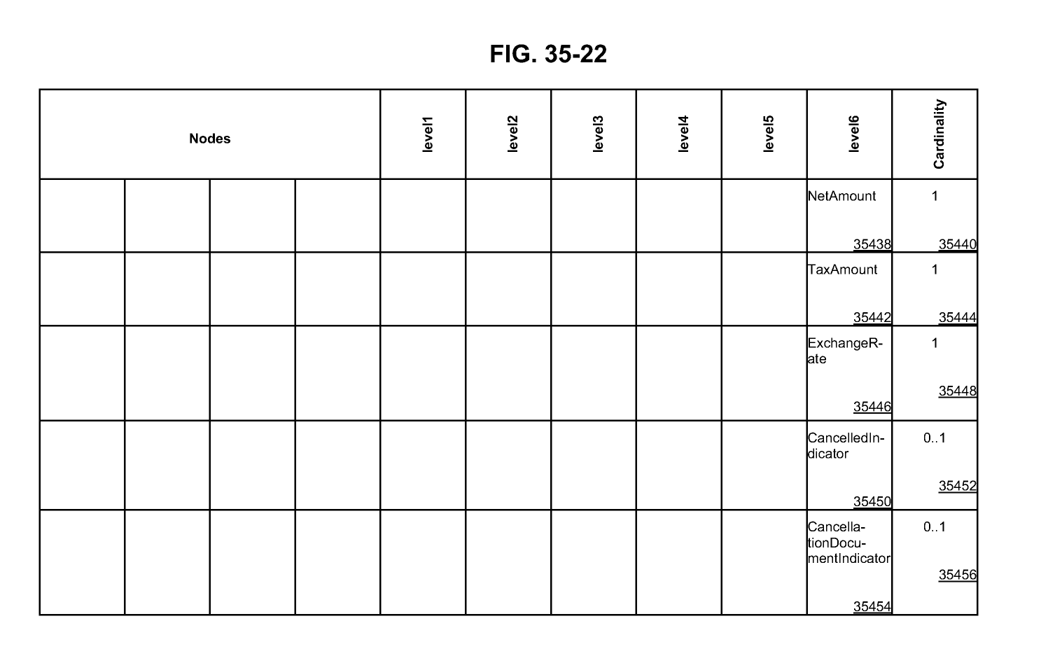

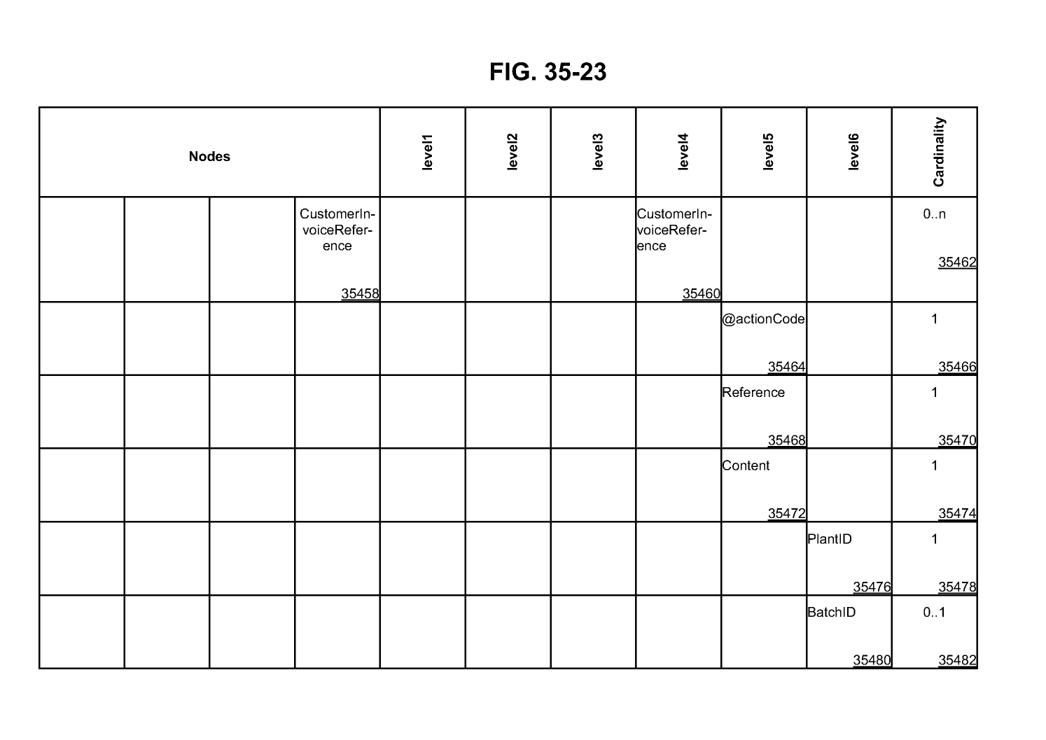

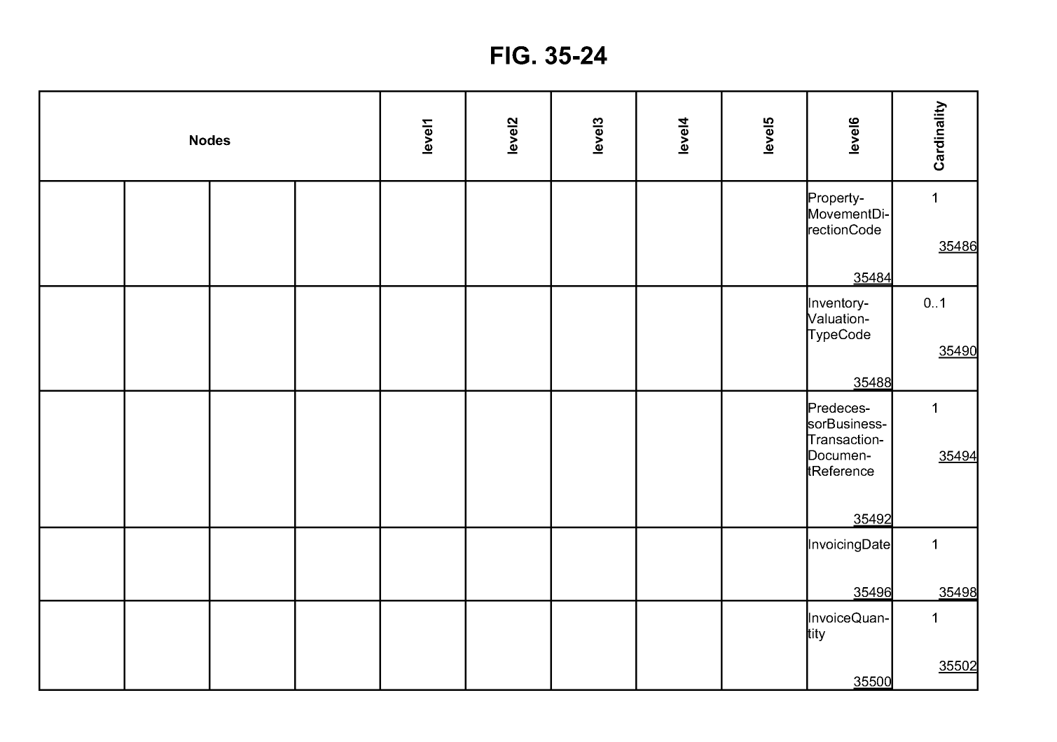

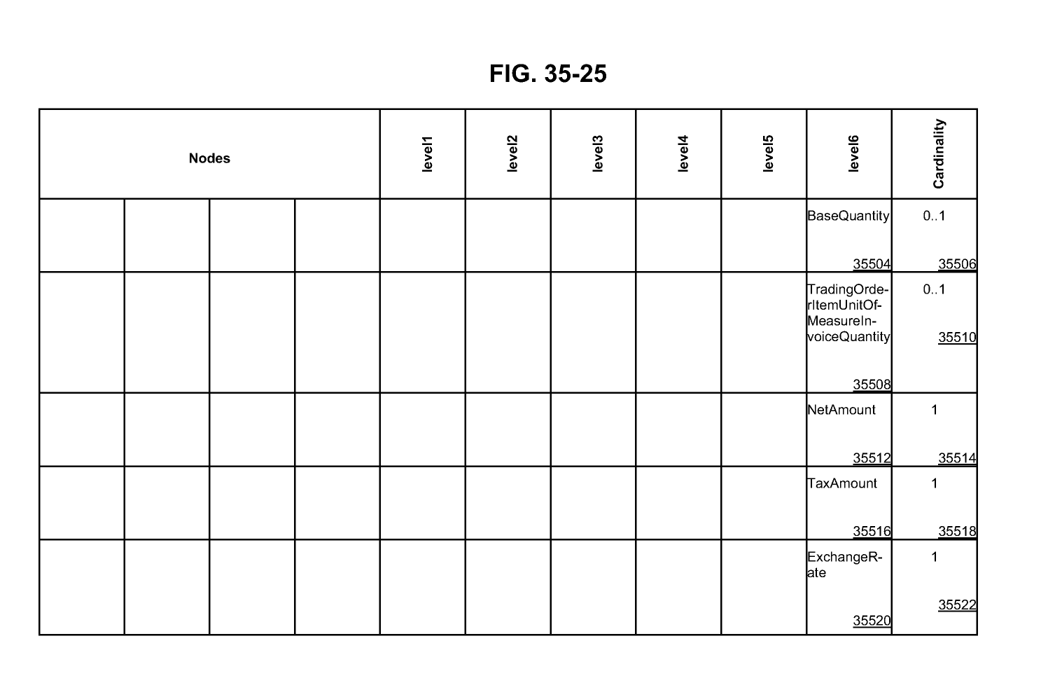

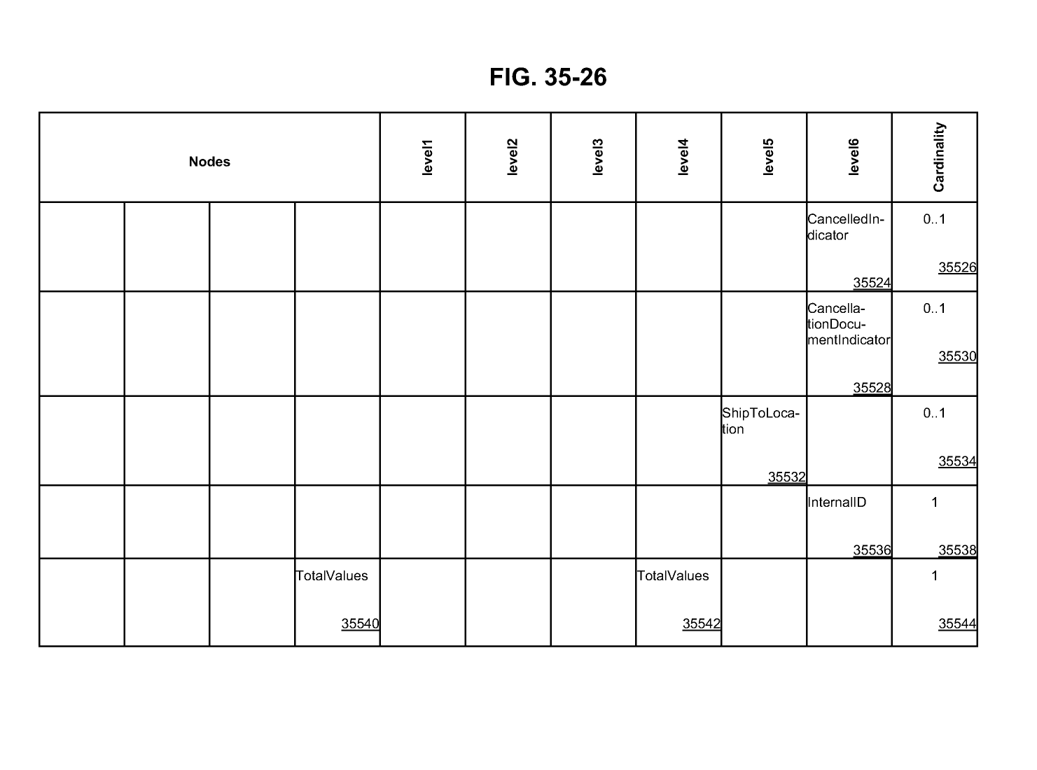

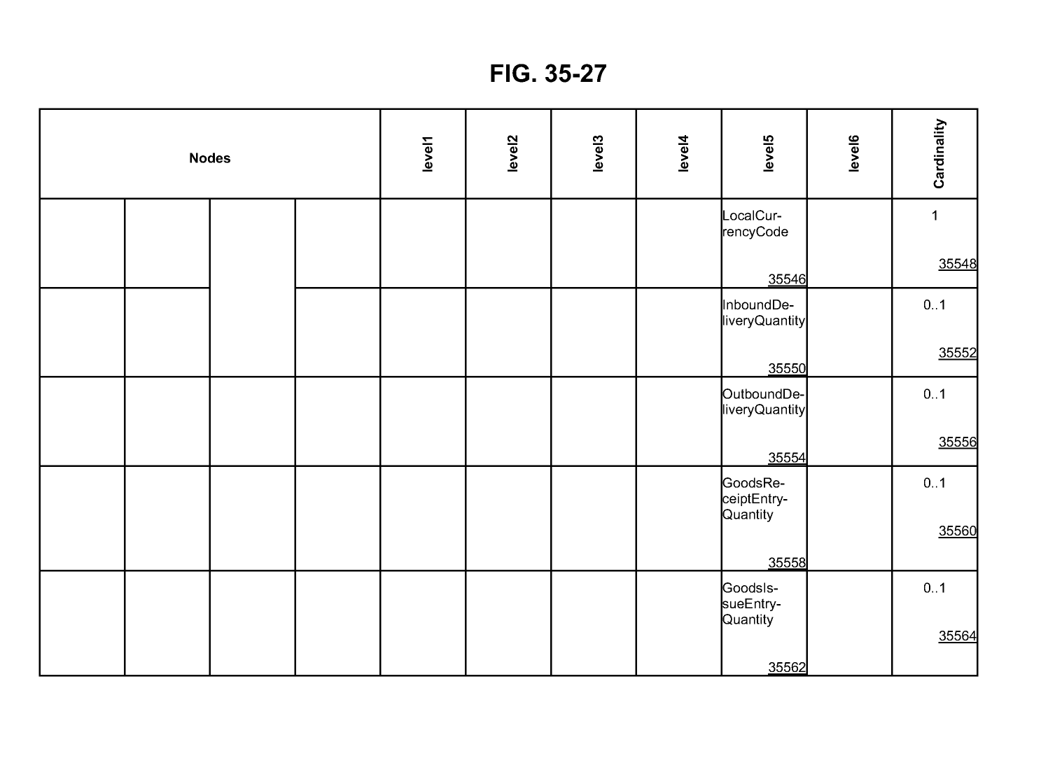

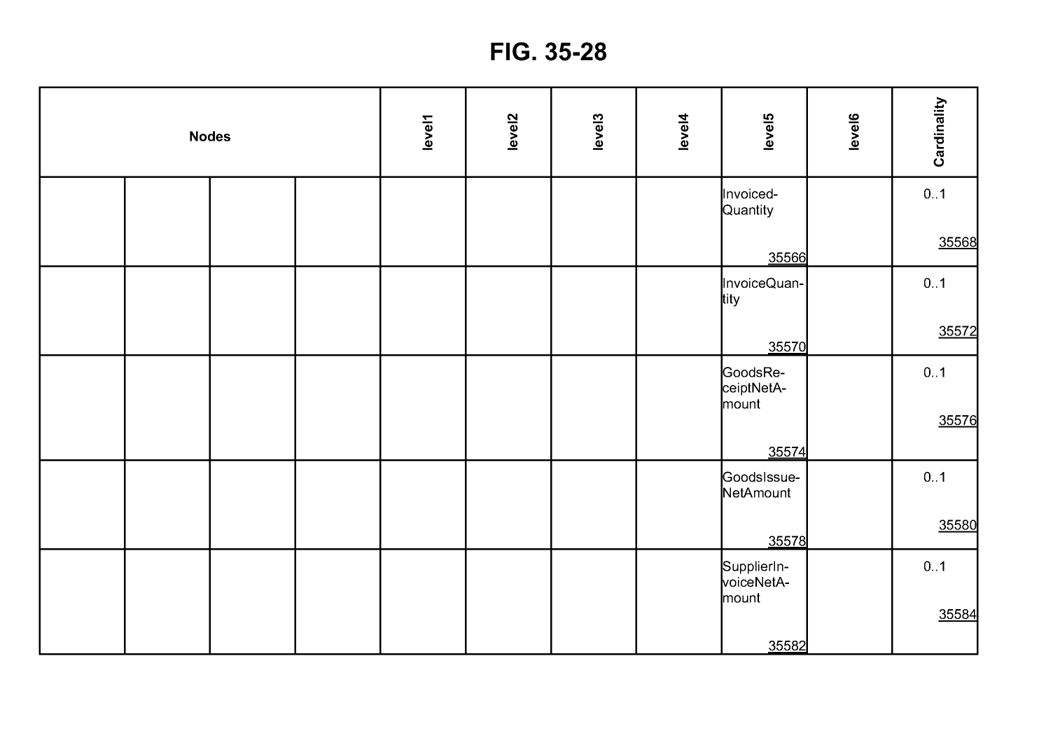

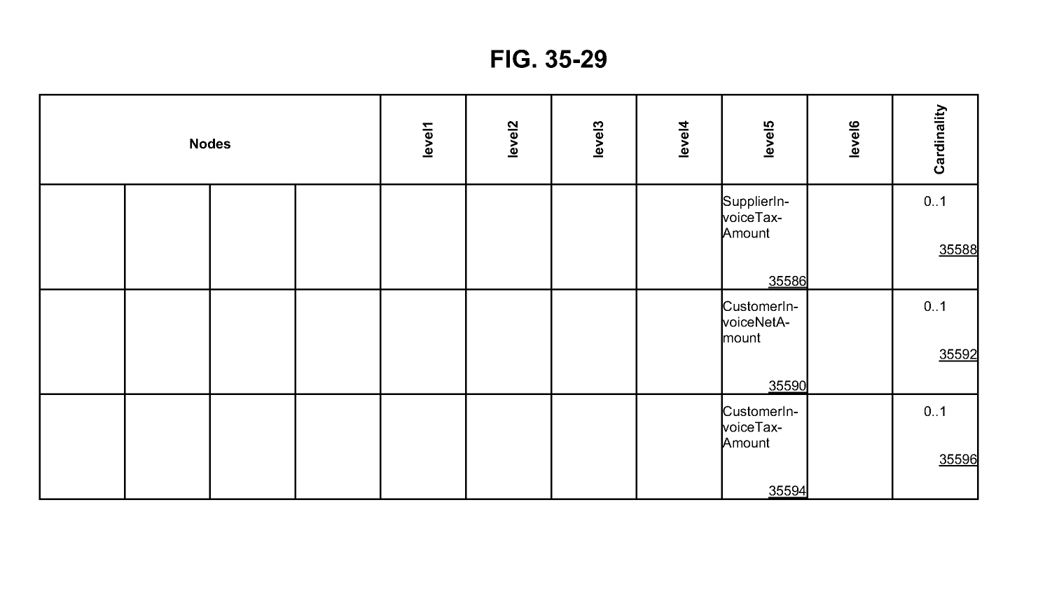

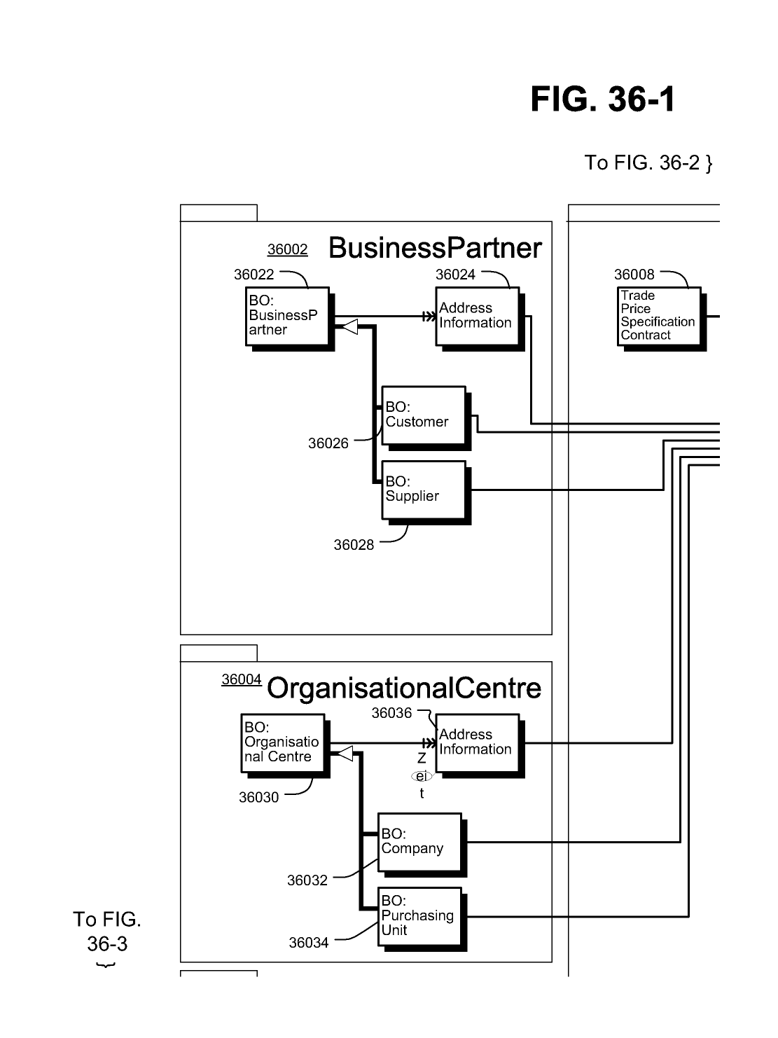

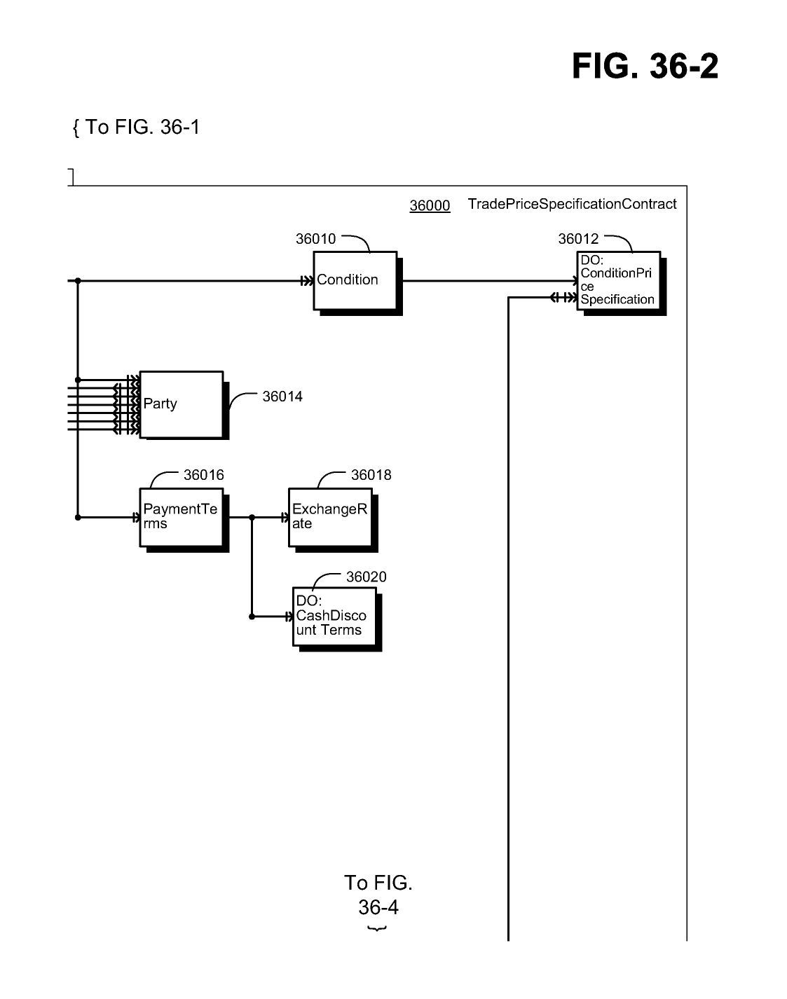

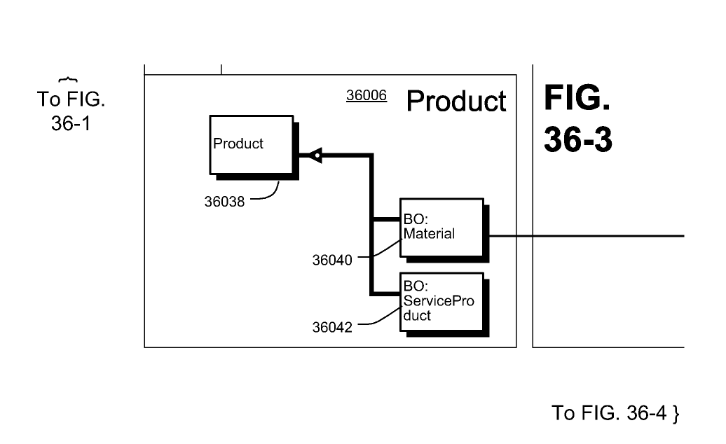

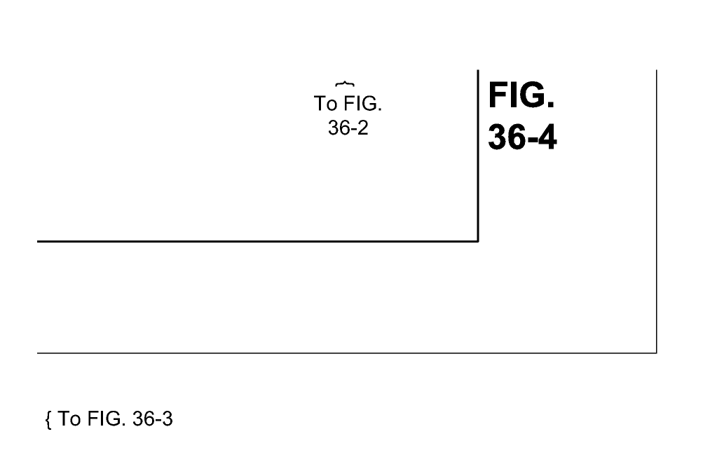

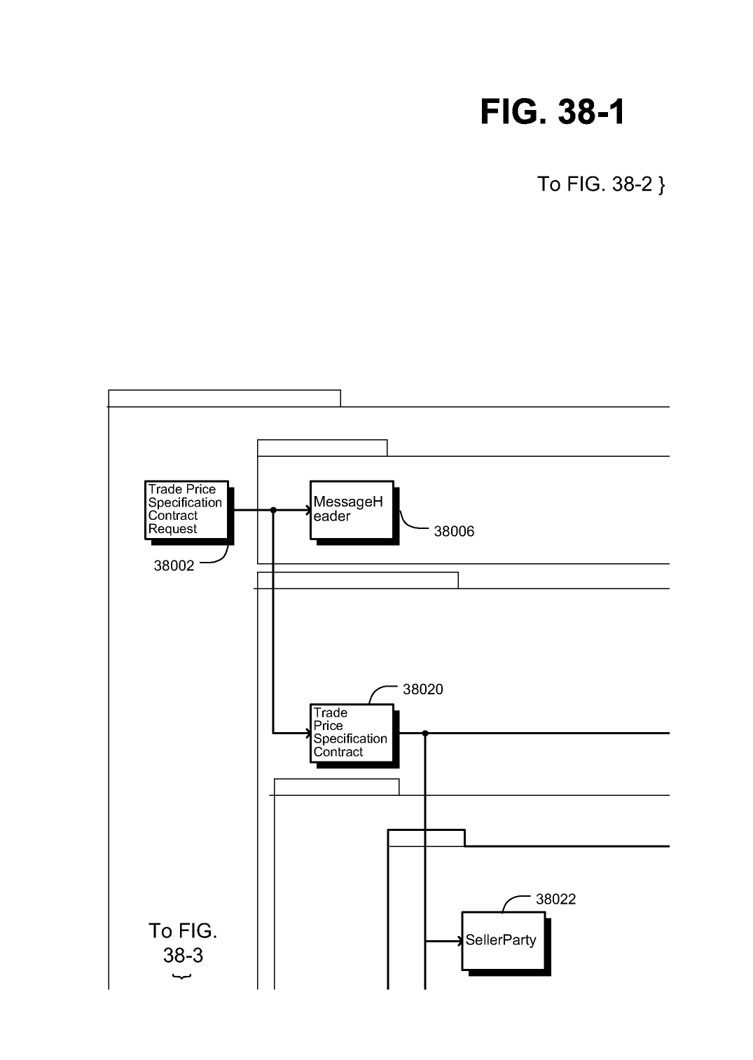

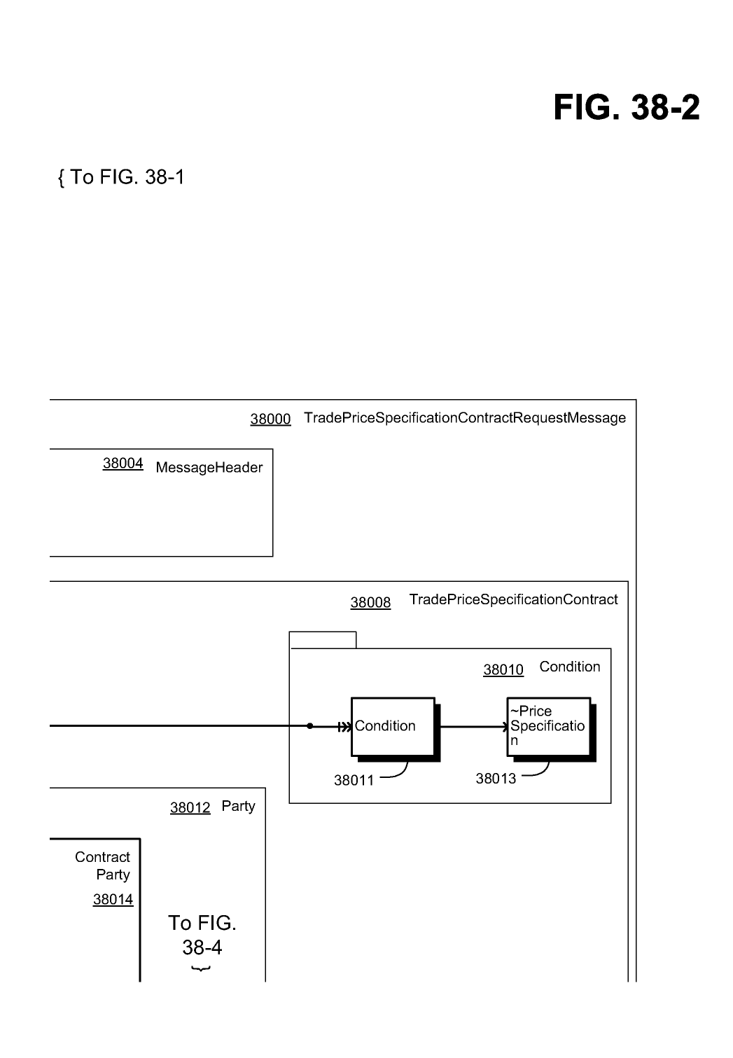

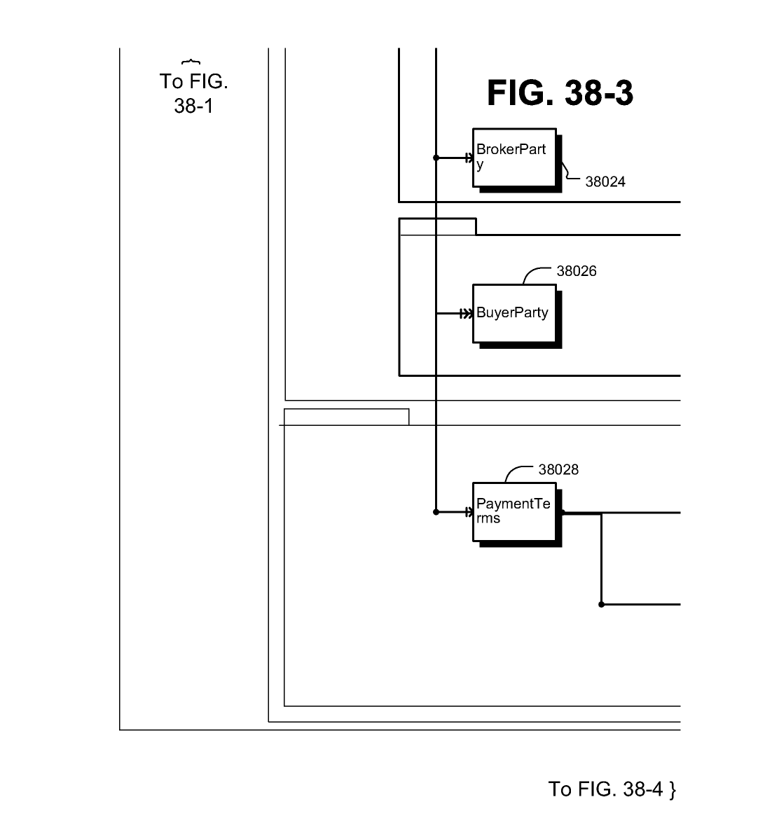

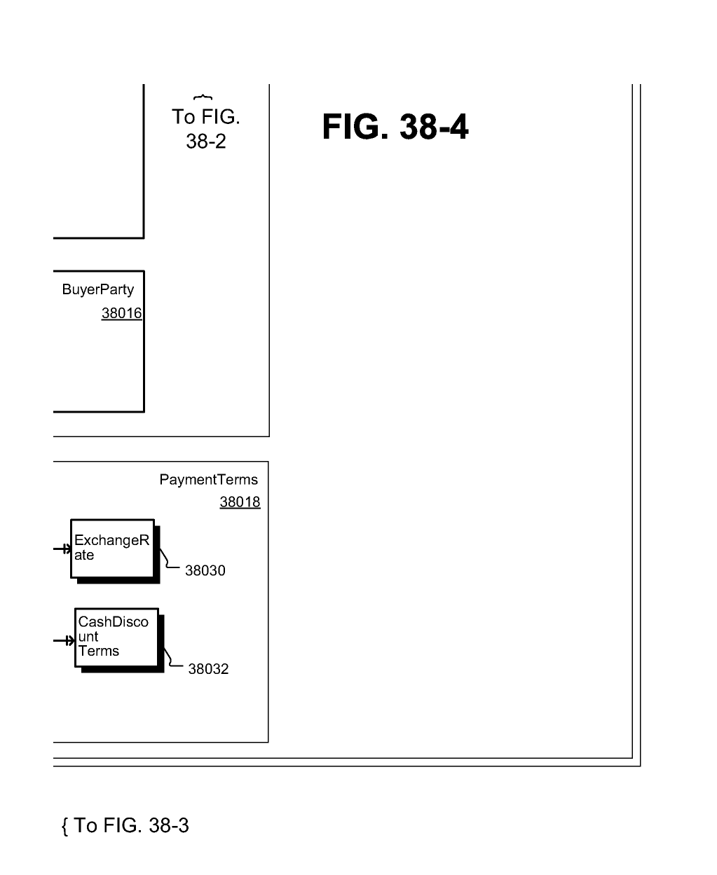

FIGS. 34-1 through 34-38 show an AnalyticalViewOfTradingOrderMessage 34000 package. The AnalyticalViewOfTradingOrderMessage 34000 package is a <MessageDataType> 34004 data type. The AnalyticalViewOfTradingOrderMessage 34000 package includes an AnalyticalViewOfTradingOrderMessage 34002 entity. The AnalyticalViewOfTradingOrderMessage 34000 package includes various packages, namely a MessageHeader 34006 and an AnalyticalViewOfTradingOrder 34014.

The MessageHeader 34006 package includes a MessageHeader 34008 entity. The MessageHeader groups business information from the perspective of the sending application, such as: information to identify the business document in a message, information about the sender, and (possibly) information about the recipient. The MessageHeader 34008 entity includes a BusinessDocumentMessageHeader 34010 attribute.

The BusinessDocumentMessageHeader 34010 attribute is a BusinessDocumentMessageHeader 34012 data type. The following elements of the GDT are used: SenderParty and RecipientParty.

The AnalyticalViewOfTradingOrder 34014 package includes an AnalyticalViewOfTradingOrder 34016 entity. The AnalyticalViewOfTradingOrder 34014 package includes various packages, namely a Party 34030, a TradingChannel 34050 and an Item 34062.

The EvaluationViewOfTradingOrder package groups together the EvaluationViewOfTradingOrder and its packages. The EvaluationViewOfTradingOrder package has the EvaluationViewOfTradingOrder as root node. The AnalyticalViewOfTradingOrder 34016 entity includes various attributes, namely a @actionCode 34018, a @itemListCompleteTransmissionIndicator 34022 and an ID 34026.

The @actionCode 34018 attribute is an ActionCode 34020 data type. The ActionCode is a coded representation of an instruction telling how to process the AnalyticalViewTradingOrder.

The @itemListCompleteTransmissionIndicator 34022 attribute is an Indicator 34024 data type. The itemListCompleteTransmissionIndicator indicates whether all items are transmitted or not.

The ID 34026 attribute is an AnalyticalViewOfTradingOrderID 34028 data type. The AnalyticalViewOfTradingOrderID is a unique identifier for an AnalyticalViewOfTradingOrder.

The Party 34030 package includes various entities, namely a SalesOrganizationParty 34032, a PurchasingOrganizationParty 34038 and a PurchasingGroupParty 34044. A SalesOrganizationParty is an Organization that is responsible for selling goods. The SalesOrganizationParty 34032 entity includes an InternalID 34034 attribute. The InternalID 34034 attribute is a PartyInternalID 34036 data type. The InternalID is a unique identifier for the party that is responsible for selling goods. The PurchasingOrganizationParty is an organizational unit within logistics that subdivides the enterprise according to the requirements of purchasing. The PurchasingOrganizationParty 34038 entity includes an InternalID 34040 attribute.

The InternalID 34040 attribute is a PartyInternalID 34042 data type. The InternalID is a unique identifier of a purchasing organization. The PurchasingGroupParty is an organizational unit within logistics that subdivides the enterprise from the viewpoint of purchasing according to the responsibilities for the procurement of products, and is the point of contact for the suppliers. The PurchasingGroupParty 34044 entity includes an InternalID 34046 attribute. The InternalID 34046 attribute is a PartyInternalID 34048 data type. The InternaID is the unique identifier of a purchasing group. The TradingChannel 34050 package includes a TradingChannel 34052 entity.

The TradingChannel defines the unit which is responsible for trading goods and services in detail. The TradingChannel 34052 entity includes various attributes, namely a DistributionChannelCode 34054 and a DivisionCode 34058. The DistributionChannelCode 34054 attribute is a DistributionChannelCode 34056 data type. The DivisionChannelCode is an encoded representation of a distribution channel via which the goods or services are made available to the customer. The DivisionCode 34058 attribute is a DivisionCode 34060 data type. The DivisionCode is an encoded representation of a division that defines the responsibility for sales or profit for saleable materials or services.

The Item 34062 package includes an Item 34064 entity. The Item 34062 package includes various packages, namely a Product 34122, an InboundDeliveryReference 34138, an OutboundDeliveryReference 34202, a GoodsMovementReference 34266, a SupplierInvoiceReference 34348, a CustomerInvoiceReference 34418 and a TotalValues 34494. The Item is identifying and administrative information of a product in an EvaluationViewOfTradingOrder which includes all the data that applies to the item. The Item 34064 entity includes various attributes, namely a @actionCode 34066, a @inboundDeliveryReferenceListCompleteTransmissionIndicator 34070, a @outboundDeliveryReferenceListCompleteTransmissionIndicator 34074, a @goodsMovementReferenceListCompleteTransmissionIndicator 34078, a @supplierInvoiceReferenceListCompleteTransmissionIndicator 34082, a @customerInvoiceReferenceListCompleteTransmissionIndicator 34086, an ID 34090, a TradingOrderReference 34094, an OriginBusinessTransactionDocumentReference 34098, an InboundDeliveryCompletedIndicator 34102, an OutboundDeliveryCompletedIndicator 34106, a GoodsReceiptCompletedIndicator 34110, a SupplierInvoiceCompletedIndicator 34114 and a CustomerInvoiceCompletedIndicator 34118. The @actionCode 34066 attribute is an ActionCode 34068 data type. The ActionCode is a coded representation of an instruction describing how to process the EvaluationViewTradingOrderItem.

The @inboundDeliveryReferenceListCompleteTransmissionIndicator 34070 attribute is an Indicator 34072 data type. The inboundDeliveryReferenceListCompleteTransmissionIndicator indicates whether all Inbound Delivery References have been transmitted or not. The @outboundDeliveryReferenceListCompleteTransmissionIndicator 34074 attribute is an Indicator 34076 data type. The outboundDeliveryReferenceListCompleteTransmissionIndicator indicates whether all Outbound Delivery References have been transmitted or not.

The @goodsMovementReferenceListCompleteTransmissionIndicator 34078 attribute is an Indicator 34080 data type. The goodsMovementReferenceListCompleteTransmissionIndicator indicates whether all Goods Movement References have been transmitted or not.

The @supplierInvoiceReferenceListCompleteTransmissionIndicator 34082 attribute is an Indicator 34084 data type. The supplierInvoiceReferenceListCompleteTransmissionIndicator indicates whether all Supplier Invoice References have been transmitted or not.

The @customerInvoiceReferenceListCompleteTransmissionIndicator 34086 attribute is an Indicator 34088 data type. The customerInvoiceReferenceListCompleteTransmissionIndicator indicates whether all Customer Invoice References have been transmitted or not.

The ID 34090 attribute is an AnalyticalViewOfTradingOrderItemID 34092 data type. The AnalyticalViewOfTradingOrderItemID is an identifier of an item within an analytical view of trading order. The TradingOrderReference 34094 attribute is a BusinessTransactionDocumentReference 34096 data type. The TradingOrderReference is a reference to a Trading Order Item. The OriginBusinessTransactionDocumentReference 34098 attribute is a BusinessTransactionDocumentReference 34100 data type. The OriginBusinessTransactionDocumentReference is a reference to an origin business transaction document. The InboundDeliveryCompletedIndicator 34102 attribute is an Indicator 34104 data type. The InboundDeliveryCompletedIndicator is information about whether an inbound delivery is completed in a business sense or not.

The OutboundDeliveryCompletedIndicator 34106 attribute is an Indicator 34108 data type. The OutboundDeliveryCompletedIndicator is information about whether an outbound delivery is completed in a business sense or not. The GoodsReceiptCompletedIndicator 34110 attribute is an Indicator 34112 data type. The GoodsReceiptCompletedIndicator is information about whether a goods receipt is completed in a business sense or not. The SupplierInvoiceCompletedIndicator 34114 attribute is an Indicator 34116 data type. The SupplierInvoiceCompletedIndicator is information about whether a supplier invoice is completed in a business sense or not. The CustomerInvoiceCompletedIndicator 34118 attribute is an Indicator 34120 data type. The CustomerInvoiceCompletedIndicator is information about whether a customer invoice is completed in a business sense or not.

The Product 34122 package includes a Product 34124 entity. The Product is the identification, description and classification of the product of an Item. The Product 34124 entity includes various attributes, namely an InternalID 34126, a BuyerID 34130 and a ManufacturerID 34134. The InternalID 34126 attribute is a ProductInternalID 34128 data type. The InternalID is a proprietary identifier for an ordered product. The BuyerID 34130 attribute is a ProductPartyID 34132 data type. The BuyerID is an identifier for a product assigned by the buyer. The ManufacturerID 34134 attribute is a ProductPartyID 34136 data type. The ManufacturerID is an identifier for an ordered product assigned by the manufacturer. The InboundDeliveryReference 34138 package includes an InboundDeliveryReference 34140 entity.

The InboundDeliveryReference package groups a reference to an inbound delivery with data which belongs to the inbound delivery. The InboundDeliveryReference 34140 entity includes various attributes, namely a @actionCode 34142 and a Reference 34146. The InboundDeliveryReference 34140 entity includes various subordinate entities, namely a Content 34150 and a ShipFromLocation 34196. The @actionCode 34142 attribute is an ActionCode 34144 data type. The ActionCode is a coded representation of an instruction describing how to process an InboundDeliveryContent. The Reference 34146 attribute is a BusinessTransactionDocumentReference 34148 data type. The Reference is a reference to an Inbound Delivery Item.

The Content includes information about an Inbound Delivery Item. The Content 34150 entity includes various attributes, namely a PlantID 34152, a BatchID 34156, a PropertyMovementDirectionCode 34160, an InventoryValuationTypeCode 34164, a PredecessorBusinessTransactionDocumentReference 34168, a DeliveryDate 34172, a DeliveryQuantity 34176, a BaseQuantity 34180, a TradingOrderItemUnitOfMeasureDeliveryQuantity 34184, a CancelledIndicator 34188 and a CancellationDocumentIndicator 34192. The PlantID 34152 attribute is a PlantID 34154 data type. The PlantID is an identifier of a plant. The BatchID 34156 attribute is a BatchID 34158 data type. The BatchID is a unique identifier for a batch in the context of a material number.

The PropertyMovementDirectionCode 34160 attribute is a PropertyMovementDirectionCode 34162 data type. The PropertyMovementDirectionCode is a coded representation of a direction of movement of a property (e.g.; increase, decrease). The InventoryValuationTypeCode 34164 attribute is an InventoryValuationTypeCode 34166 data type. The InventoryValuationTypeCode is a coded representation of a valuation type of a material stock.

The PredecessorBusinessTransactionDocumentReference 34168 attribute is a BusinessTransactionDocumentReference 34170 data type. The PredecessorBusinessTransactionDocumentReference is a unique reference to a predecessor business document item. The DeliveryDate 34172 attribute is a Date 34174 data type. The DeliveryDate is the date at which a delivery takes place.

The DeliveryQuantity 34176 attribute is a Quantity 34178 data type. The DeliveryQuantity is a quantity which is physically arranged in an InboundDelivery. The BaseQuantity 34180 attribute is a Quantity 34182 data type. The BaseQuantity is a quantity that is defined as a base of another quantity or amount. The TradingOrderItemUnitOfMeasureDeliveryQuantity 34184 attribute is a Quantity 34186 data type. The TradingOrderItemUnitOfMeasureDeliveryQuantity is a quantity which is physically arranged in an InboundDelivery in the unit of measure of the trading order item.

The CancelledIndicator 34188 attribute is an Indicator 34190 data type. The CancelledIndicator is an indication whether an inbound delivery item was cancelled or revoked for business management reasons. The CancellationDocumentIndicator 34192 attribute is an Indicator 34194 data type. The CancellationDocumentIndicator specifies whether or not a document is a cancellation document.

The ShipFromLocation is a location from which goods or services are shipped. The ShipFromLocation 34196 entity includes an InternalID 34198 attribute. The InternalID 34198 attribute is a LocationInternalID 34200 data type. The InternalID is a unique identifier for a location. The OutboundDeliveryReference 34202 package includes an OutboundDeliveryReference 34204 entity. The OutboundDeliveryReference package groups a reference to an outbound delivery with data which belongs to the outbound delivery. The OutboundDeliveryReference 34204 entity includes various attributes, namely a @actionCode 34206 and a Reference 34210. The OutboundDeliveryReference 34204 entity includes various subordinate entities, namely a Content 34214 and a ShipToLocation 34260.

The @actionCode 34206 attribute is an ActionCode 34208 data type. The ActionCode is a coded representation of an instruction describing how to process an OutboundDeliveryContent. The Reference 34210 attribute is a BusinessTransactionDocumentReference 34212 data type. The Reference is a reference to an Outbound Delivery Item. The Content includes information of the Outbound Delivery Item. The Content 34214 entity includes various attributes, namely a PlantID 34216, a BatchID 34220, a PropertyMovementDirectionCode 34224, an InventoryValuationTypeCode 34228, a PredecessorBusinessTransactionDocumentReference 34232, a DeliveryDate 34236, a DeliveryQuantity 34240, a BaseQuantity 34244, a TradingOrderItemUnitOfMeasureDeliveryQuantity 34248, a CancelledIndicator 34252 and a CancellationDocumentIndicator 34256.

The PlantID 34216 attribute is a PlantID 34218 data type. The PlantID is the identifier of a plant. The BatchID 34220 attribute is a BatchID 34222 data type. The BatchID is a unique identifier for a batch in the context of a material number. The PropertyMovementDirectionCode 34224 attribute is a PropertyMovementDirectionCode 34226 data type. The PropertyMovementDirectionCode is a coded representation of a direction of movement of a property (e.g., increase, decrease). The InventoryValuationTypeCode 34228 attribute is an InventoryValuationTypeCode 34230 data type. The InventoryValuationTypeCode is a coded representation of a valuation type of a material stock. The PredecessorBusinessTransactionDocumentReference 34232 attribute is a BusinessTransactionDocumentReference 34234 data type. The PredecessorBusinessTransactionDocumentReference is a unique reference to a predecessor business document item.

The DeliveryDate 34236 attribute is a Date 34238 data type. The DeliveryDate is the date at which a delivery takes place. The DeliveryQuantity 34240 attribute is a Quantity 34242 data type. The DeliveryQuantity is a quantity which is physically arranged in an OutboundDelivery. The BaseQuantity 34244 attribute is a Quantity 34246 data type. The BaseQuantity is a quantity that is defined as a base of another quantity or amount.

The TradingOrderItemUnitOfMeasureDeliveryQuantity 34248 attribute is a Quantity 34250 data type. The TradingOrderItemUnitOfMeasureDeliveryQuantity is a quantity which is physically arranged in an OutboundDelivery in the unit of measure of the trading order item. The CancelledIndicator 34252 attribute is an Indicator 34254 data type. The CancelledIndicator is an indication whether an outbound delivery item was cancelled or revoked for business management reasons.

The CancellationDocumentIndicator 34256 attribute is an Indicator 34258 data type. The CancellationDocumentIndicator specifies whether or not a document is a cancellation document. The ShipToLocation is a location to which goods or services are shipped. The ShipToLocation 34260 entity includes an InternalID 34262 attribute. The InternalID 34262 attribute is a LocationInternalID 34264 data type. The InternalID is a unique identifier for the location. The GoodsMovementReference 34266 package includes a GoodsMovementReference 34268 entity.

The GoodsMovementReference package groups a reference to a goods movement with data which belongs to the goods movement. The GoodsMovementReference 34268 entity includes various attributes, namely a @actionCode 34270 and a Reference 34274. The GoodsMovementReference 34268 entity includes various subordinate entities, namely a Content 34278, a ShipFromLocation 34336 and a ShipToLocation 34342.

The @actionCode 34270 attribute is an ActionCode 34272 data type. The ActionCode is a coded representation of an instruction describing how to process a GoodsMovementContent. The Reference 34274 attribute is a BusinessTransactionDocumentReference 34276 data type. The Reference is a reference to a Goods Movement Item. The Content includes information of the Goods Movement Item. The Content 34278 entity includes various attributes, namely a PlantID 34280, a BatchID 34284, a SiteLogisticsProcessTypeCode 34288, an InventoryMovementDirectionCode 34292, an InventoryValuationTypeCode 34296, a PredecessorBusinessTransactionDocumentReference 34300, a PostingDate 34304, an EntryQuantity 34308, a BaseQuantity 34312, a TradingOrderItemUnitOfMeasureEntryQuantity 34316, a NetAmount 34320, an ExchangeRate 34324, a CancelledIndicator 34328 and a CancellationDocumentIndicator 34332.

The PlantID 34280 attribute is a PlantID 34282 data type. The PlantID is the identifier of a plant. The BatchID 34284 attribute is a BatchID 34286 data type. The BatchID is a unique identifier for a batch in the context of a material number. The SiteLogisticsProcessTypeCode 34288 attribute is a SiteLogisticsProcessTypeCode 34290 data type. The SiteLogisticsProcessTypeCode is a coded representation of the type of site logistics process. The InventoryMovementDirectionCode 34292 attribute is an InventoryMovementDirectionCode 34294 data type. The InventoryMovementDirectionCode is a coded representation of a direction of an inventory movement (e.g., receipt, issue).

The InventoryValuationTypeCode 34296 attribute is an InventoryValuationTypeCode 34298 data type. The InventoryValuationTypeCode is a coded representation of a valuation type of a material stock. The PredecessorBusinessTransactionDocumentReference 34300 attribute is a BusinessTransactionDocumentReference 34302 data type. The PredecessorBusinessTransactionDocumentReference is a unique reference to a predecessor business document item.

The PostingDate 34304 attribute is a Date 34306 data type. The PostingDate is a date at which an accounting document in Financial Accounting becomes effective and the period balances of the concerned accounts change. The PostingDate specifies in which financial period a goods movement is posted. The EntryQuantity 34308 attribute is a Quantity 34310 data type. The EntryQuantity is a quantity of an entry in goods movement as it was originally entered. The BaseQuantity 34312 attribute is a Quantity 34314 data type. The BaseQuantity is a quantity that is defined as a base of another quantity or amount. The TradingOrderItemUnitOfMeasureEntryQuantity 34316 attribute is a Quantity 34318 data type. The EntryQuantity is a quantity of an entry in an object as it was originally entered in a unit of measure of the trading order item.

The NetAmount 34320 attribute is an Amount 34322 data type. The NetAmount is a net amount. The ExchangeRate 34324 attribute is an ExchangeRate 34326 data type. The ExchangeRate is a representation of an exchange rate between two currencies: the currency of the GoodsMovement Item and the local currency. The CancelledIndicator 34328 attribute is an Indicator 34330 data type. The CancelledIndicator is an indication whether a goods movement item was cancelled or revoked for business management reasons.

The CancellationDocumentIndicator 34332 attribute is an Indicator 34334 data type. The CancellationDocumentIndicator specifies whether or not a document is a cancellation document. The ShipFromLocation is a location from which goods or services are shipped. The ShipFromLocation 34336 entity includes an InternalID 34338 attribute. The InternalID 34338 attribute is a LocationInternalID 34340 data type. The InternalID is a unique identifier for a location. The ShipToLocation is a location to which goods or services are shipped. The ShipToLocation 34342 entity includes an InternalID 34344 attribute.

The InternalID 34344 attribute is a LocationInternalID 34346 data type. The InternalID is a unique identifier for the location. The SupplierInvoiceReference 34348 package includes a SupplierInvoiceReference 34350 entity. The SupplierInvoiceReference package groups a reference to a supplier invoice with data which belongs to the supplier invoice. The SupplierInvoiceReference 34350 entity includes various attributes, namely a @actionCode 34352 and a Reference 34356. The SupplierInvoiceReference 34350 entity includes a Content 34360 subordinate entity. The @actionCode 34352 attribute is an ActionCode 34354 data type. The ActionCode is a coded representation of an instruction describing how to process SupplierInvoiceContent. The Reference 34356 attribute is a BusinessTransactionDocumentReference 34358 data type. The Reference is a reference to a Supplier Invoice Item.

The Content includes information of the Supplier Invoice Item. The Content 34360 entity includes various attributes, namely a PlantID 34362, a BatchID 34366, a PropertyMovementDirectionCode 34370, an InventoryValuationTypeCode 34374, a PredecessorBusinessTransactionDocumentReference 34378, an InvoicingDate 34382, an InvoicedQuantity 34386, a BaseQuantity 34390, a TradingOrderItemUnitOfMeasureInvoicedQuantity 34394, a NetAmount 34398, a TaxAmount 34402, an ExchangeRate 34406, a CancelledIndicator 34410 and a CancellationDocumentIndicator 34414. The PlantID 34362 attribute is a PlantID 34364 data type. The PlantID is an identifier of a plant. The BatchID 34366 attribute is a BatchID 34368 data type. The BatchID is a unique identifier for a batch in the context of a material number. The PropertyMovementDirectionCode 34370 attribute is a PropertyMovementDirectionCode 34372 data type. The PropertyMovementDirectionCode is a coded representation of a direction of movement of a property (e.g.; increase, decrease).

The InventoryValuationTypeCode 34374 attribute is an InventoryValuationTypeCode 34376 data type. The InventoryValuationTypeCode is a coded representation of a valuation type of a material stock. The PredecessorBusinessTransactionDocumentReference 34378 attribute is a BusinessTransactionDocumentReference 34380 data type. The PredecessorBusinessTransactionDocumentReference is a unique reference to a predecessor business document item. The InvoicingDate 34382 attribute is a Date 34384 data type. The InvoicingDate is a date at which the process of issuing invoices is supposed to be started. The InvoicedQuantity 34386 attribute is a Quantity 34388 data type. The InvoicedQuantity is a quantity of a Supplier Invoice Item. The BaseQuantity 34390 attribute is a Quantity 34392 data type. The BaseQuantity is a quantity that is defined as a base of another quantity or amount. The TradingOrderItemUnitOfMeasureInvoicedQuantity 34394 attribute is a Quantity 34396 data type. The TradingOrderItemUnitOfMeasureInvoicedQuantity is a quantity of a Supplier Invoice Item in the unit of measure of the trading order item. The NetAmount 34398 attribute is an Amount 34400 data type. The NetAmount is a net amount. The TaxAmount 34402 attribute is an Amount 34404 data type. The TaxAmount is an amount of a tax. The ExchangeRate 34406 attribute is an ExchangeRate 34408 data type. The ExchangeRate is a representation of an exchange rate between two currencies: the currency of the Supplier Invoice Item and the local currency.

The CancelledIndicator 34410 attribute is an Indicator 34412 data type. The CancelledIndicator is an indication whether a supplier invoice item was cancelled or revoked for business management reasons. The CancellationDocumentIndicator 34414 attribute is an Indicator 34416 data type. The CancellationDocumentIndicator specifies whether or not a document is a cancellation document. The CustomerInvoiceReference 34418 package includes a CustomerInvoiceReference 34420 entity. The CustomerInvoiceReference Package groups a reference to a customer invoice with data which belongs to the customer invoice. The CustomerInvoiceReference 34420 entity includes various attributes, namely a @actionCode 34422 and a Reference 34426. The CustomerInvoiceReference 34420 entity includes various subordinate entities, namely a Content 34430 and a ShipToLocation 34488.

The @actionCode 34422 attribute is an ActionCode 34424 data type. The ActionCode is a coded representation of an instruction describing how to process the CustomerInvoiceContent. The Reference 34426 attribute is a BusinessTransactionDocumentReference 34428 data type. The Reference is a reference to a Customer Invoice Item. The Content includes information of a Customer Invoice Item. The Content 34430 entity includes various attributes, namely a PlantID 34432, a BatchID 34436, a PropertyMovementDirectionCode 34440, an InventoryValuationTypeCode 34444, a PredecessorBusinessTransactionDocumentReference 34448, an InvoicingDate 34452, an InvoiceQuantity 34456, a BaseQuantity 34460, a TradingOrderItemUnitOfMeasureInvoiceQuantity 34464, a NetAmount 34468, a TaxAmount 34472, an ExchangeRate 34476, a CancelledIndicator 34480 and a CancellationDocumentIndicator 34484.

The PlantID 34432 attribute is a PlantID 34434 data type. The PlantID is an identifier of a plant. The BatchID 34436 attribute is a BatchID 34438 data type. The BatchID is a unique identifier for a batch in the context of a material number. The PropertyMovementDirectionCode 34440 attribute is a PropertyMovementDirectionCode 34442 data type. The PropertyMovementDirectionCode is a coded representation of the direction of movement of a property (e.g.; increase, decrease). The InventoryValuationTypeCode 34444 attribute is an InventoryValuationTypeCode 34446 data type. The InventoryValuationTypeCode is a coded representation of a valuation type of a material stock.

The PredecessorBusinessTransactionDocumentReference 34448 attribute is a BusinessTransactionDocumentReference 34450 data type. The PredecessorBusinessTransactionDocumentReference is a unique reference to a predecessor business document item. The InvoicingDate 34452 attribute is a Date 34454 data type. The InvoicingDate is a date at which the process of issuing invoices is supposed to be started. The InvoiceQuantity 34456 attribute is a Quantity 34458 data type. The InvoiceQuantity is a quantity of product to be billed. The BaseQuantity 34460 attribute is a Quantity 34462 data type. The BaseQuantity is a quantity that is defined as a base of another quantity or amount. The TradingOrderItemUnitOfMeasureInvoiceQuantity 34464 attribute is a Quantity 34466 data type. The TradingOrderItemUnitOfMeasureInvoiceQuantity is a quantity of product to be billed in the unit of measure of the trading order item. The NetAmount 34468 attribute is an Amount 34470 data type. The NetAmount is a net amount. The TaxAmount 34472 attribute is an Amount 34474 data type. The TaxAmount is an amount of a tax. The ExchangeRate 34476 attribute is an ExchangeRate 34478 data type. The ExchangeRate is a representation of an exchange rate between two currencies: the currency of the Customer Invoice Item and the local currency.

The CancelledIndicator 34480 attribute is an Indicator 34482 data type. The CancelledIndicator is an indication whether a customer invoice item was cancelled or revoked for business management reasons. The CancellationDocumentIndicator 34484 attribute is an Indicator 34486 data type. The CancellationDocumentIndicator specifies whether or not a document is a cancellation document. The ShipToLocation is a location to which goods or services are shipped. The ShipToLocation 34488 entity includes an InternalID 34490 attribute.

The InternalID 34490 attribute is a LocationInternalID 34492 data type. The InternalID is a unique identifier for the location. The TotalValues 34494 package includes a TotalValues 34496 entity. The TotalValues are cumulated total values that occur in an EvaluationViewOfTradingOrder, such as cumulated quantities of the inbound deliveries or outbound deliveries. The TotalValues 34496 entity includes various attributes, namely a LocalCurrencyCode 34498, an InboundDeliveryQuantity 34502, an OutboundDeliveryQuantity 34506, a GoodsReceiptEntryQuantity 34510, a GoodsIssueEntryQuantity 34514, an InvoicedQuantity 34518, an InvoiceQuantity 34522, a GoodsReceiptNetAmount 34526, a GoodsIssueNetAmount 34530, a SupplierInvoiceNetAmount 34534, a SupplierInvoiceTaxAmount 34538, a CustomerInvoiceNetAmount 34542 and a CustomerInvoiceTaxAmount 34546.

The LocalCurrencyCode 34498 attribute is a CurrencyCode 34500 data type. The LocalCurrencyCode is a code of a local currency of a company. The local currency is the national currency in which local books are kept. The InboundDeliveryQuantity 34502 attribute is a Quantity 34504 data type. The InboundDeliveryQuantity is a total quantity which is physically arranged in the InboundDeliveries. The OutboundDeliveryQuantity 34506 attribute is a Quantity 34508 data type. The OutboundDeliveryQuantity is a total quantity which is physically arranged in the OutboundDeliveries.

The GoodsReceiptEntryQuantity 34510 attribute is a Quantity 34512 data type. The GoodsReceiptEntryQuantity is a total entry quantity of the goods receipt items. The GoodsIssueEntryQuantity 34514 attribute is a Quantity 34516 data type. The GoodsIssueEntryQuantity is a total entry quantity of goods issue items. The InvoicedQuantity 34518 attribute is a Quantity 34520 data type. The InvoicedQuantity is a total quantity of a Supplier Invoice item. The InvoiceQuantity 34522 attribute is a Quantity 34524 data type. The InvoiceQuantity is a total quantity of product to be billed.

The GoodsReceiptNetAmount 34526 attribute is an Amount 34528 data type. The GoodsReceiptNetAmount is a total net amount of goods receipts. The GoodsIssueNetAmount 34530 attribute is an Amount 34532 data type. The GoodsIssueNetAmount is a total net amount of goods issues. The SupplierInvoiceNetAmount 34534 attribute is an Amount 34536 data type. The SupplierInvoiceNetAmount is a total net amount of supplier invoices.

The SupplierInvoiceTaxAmount 34538 attribute is an Amount 34540 data type. The SupplierInvoiceTaxAmount is a total tax amount of supplier invoices. The CustomerInvoiceNetAmount 34542 attribute is an Amount 34544 data type. The CustomerInvoiceNetAmount is a total net amount of the customer invoices. The CustomerInvoiceTaxAmount 34546 attribute is an Amount 34548 data type. The CustomerInvoiceTaxAmount is a total tax amount of customer invoices.

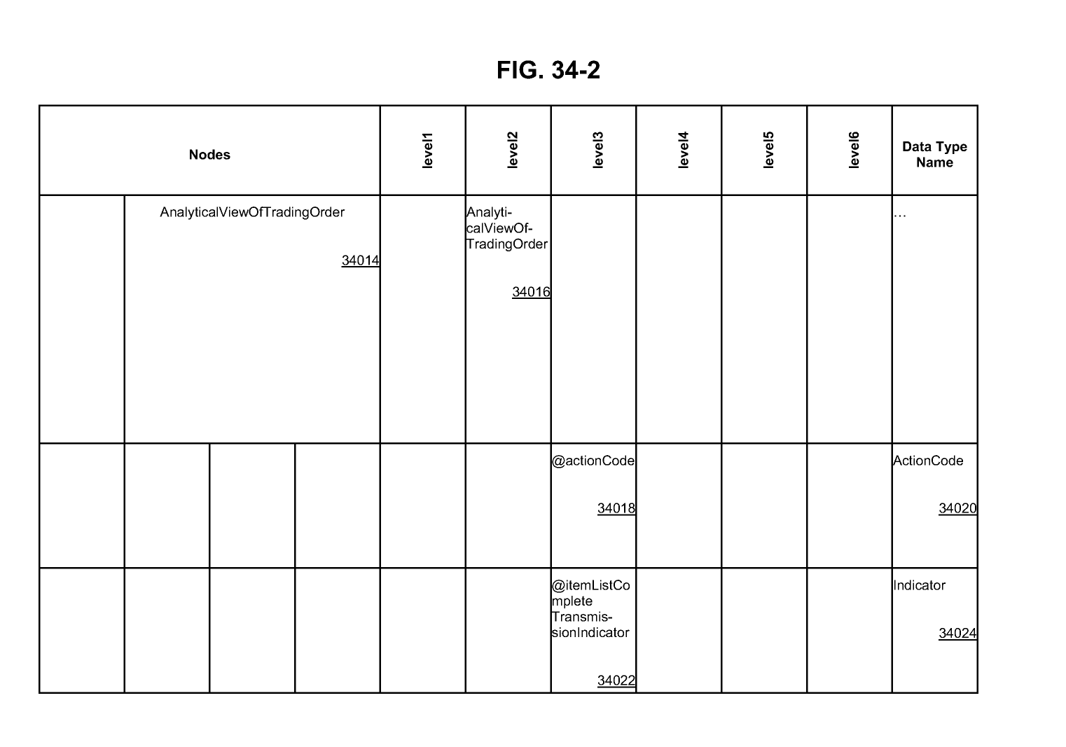

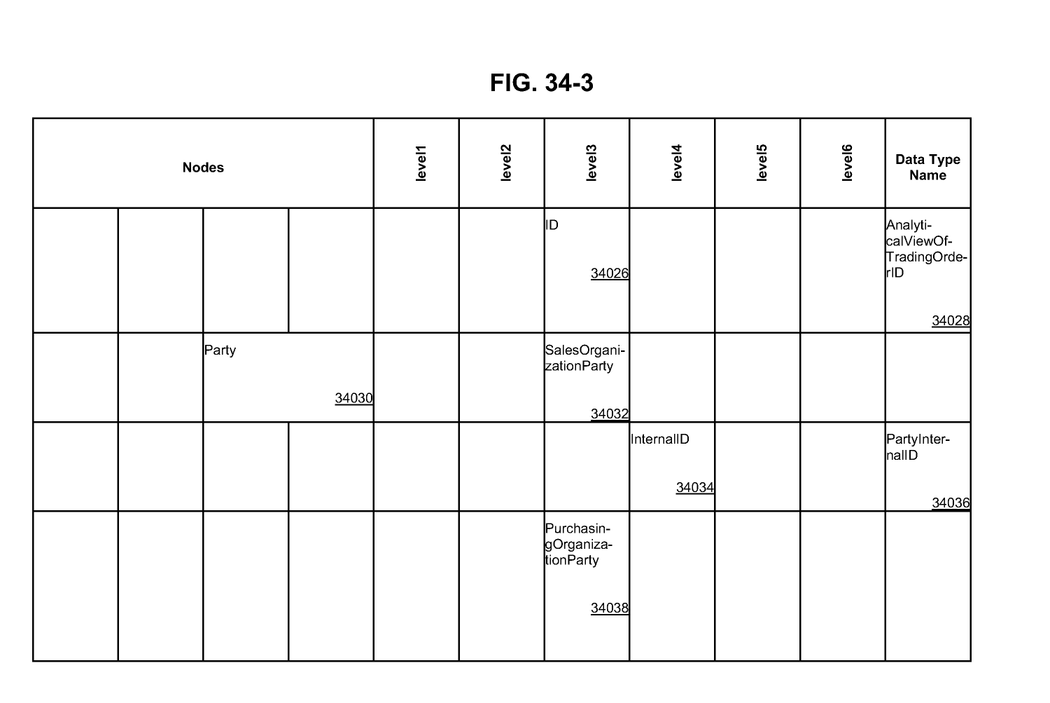

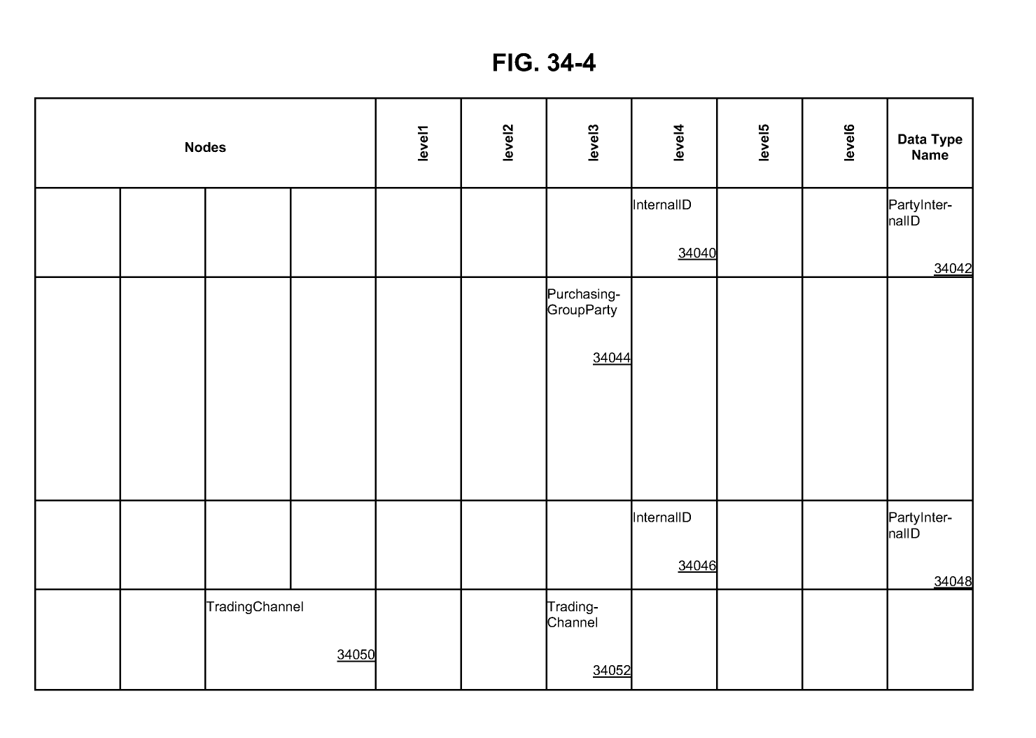

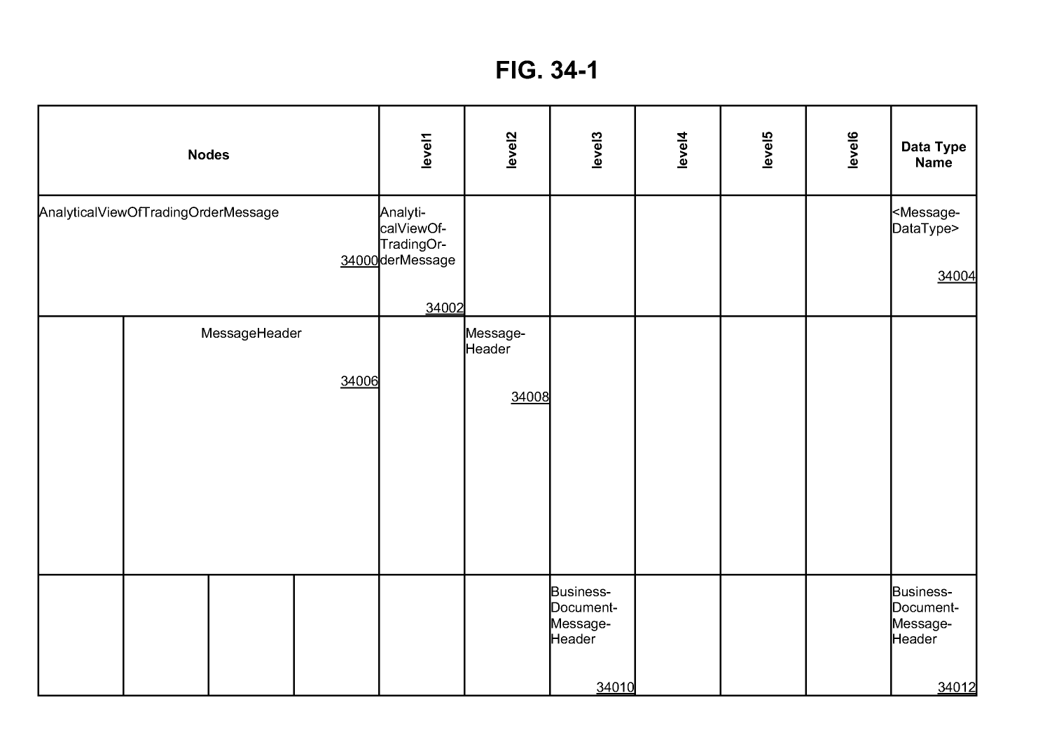

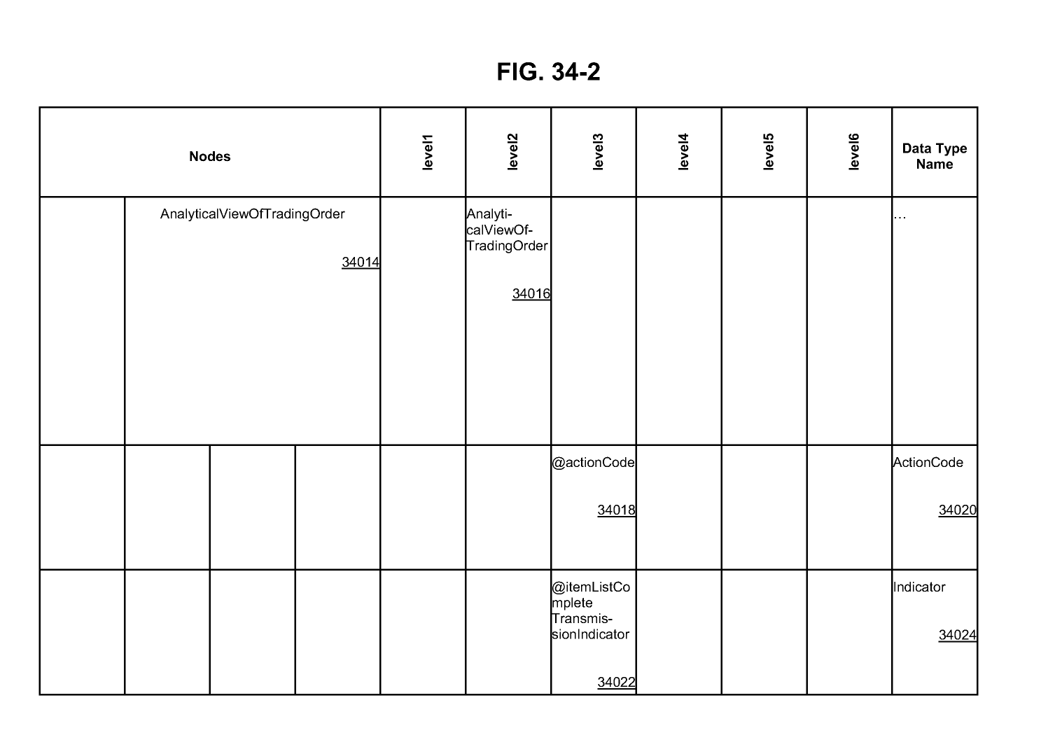

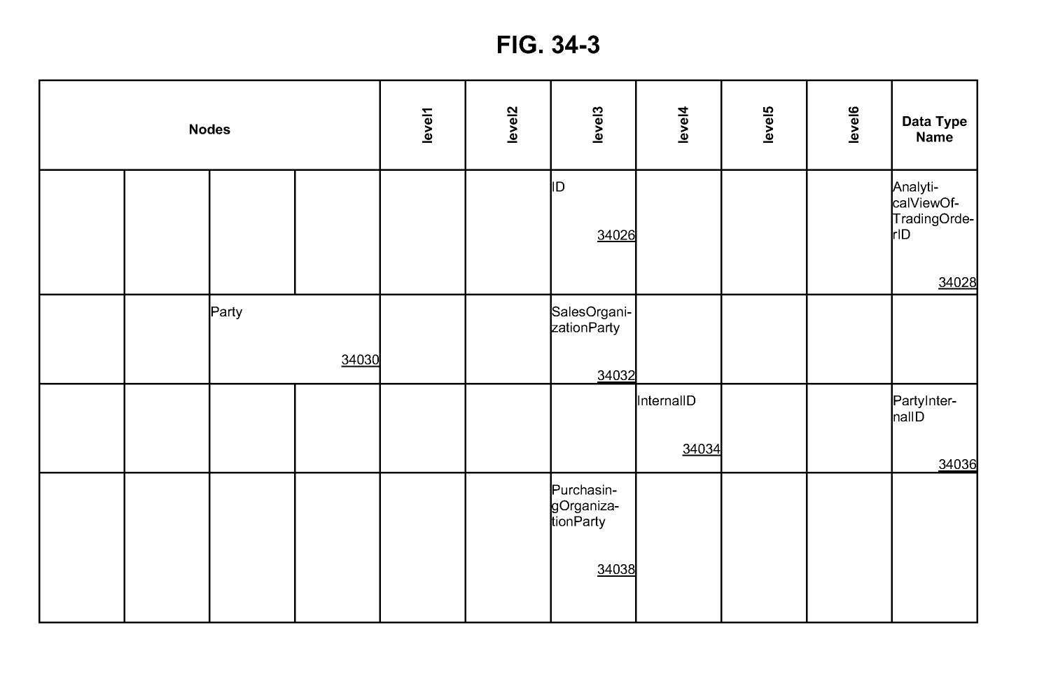

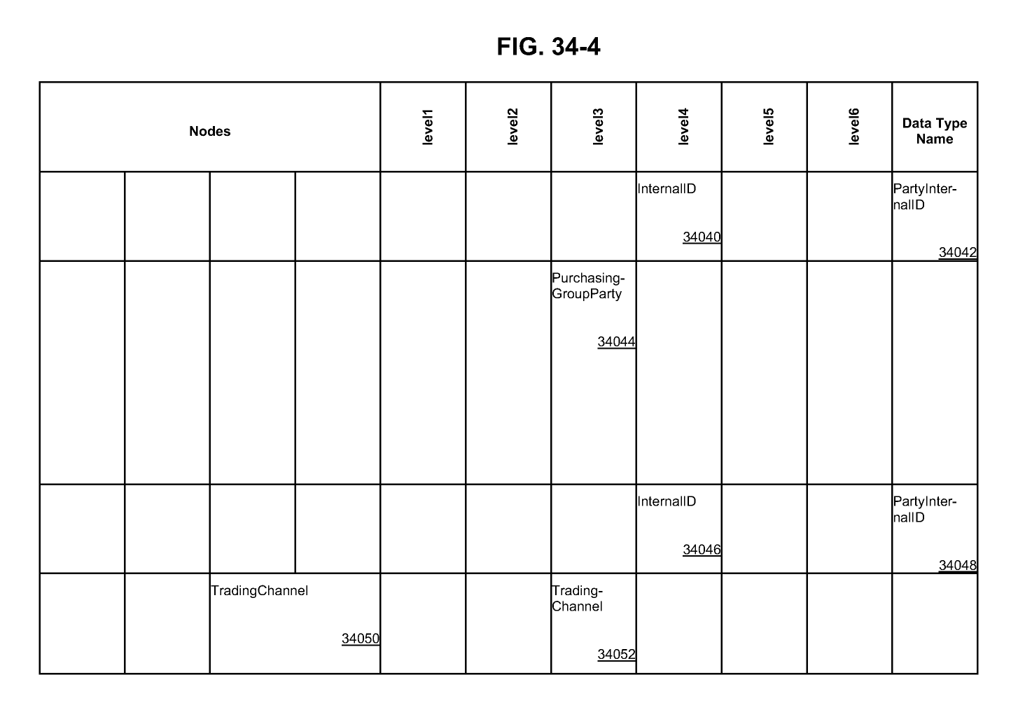

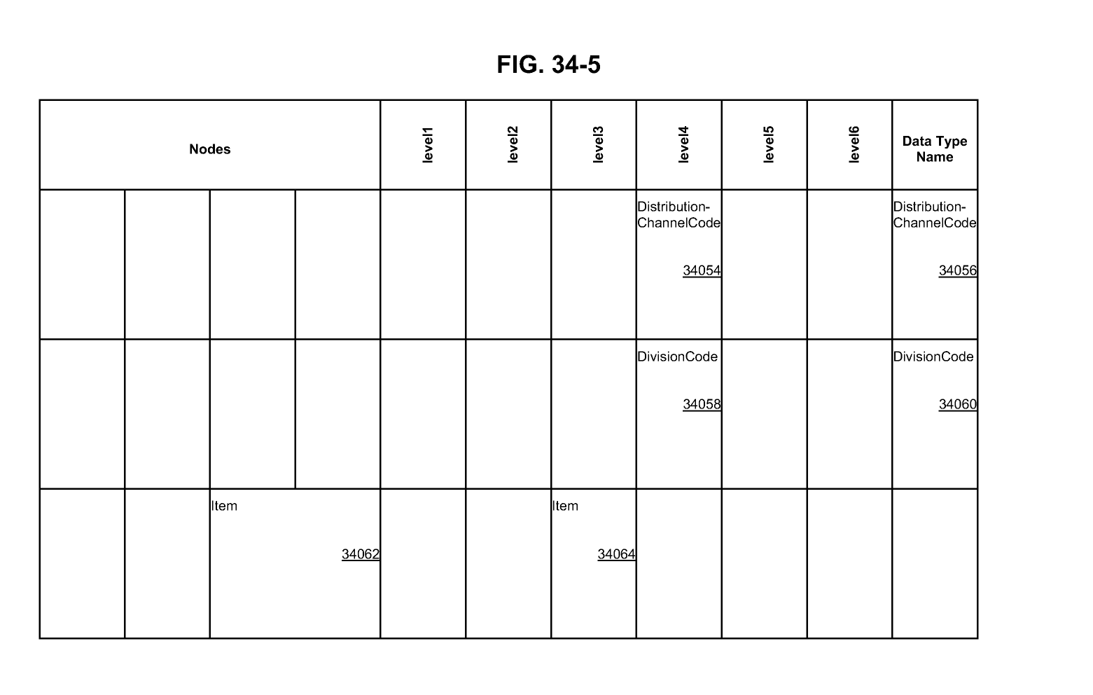

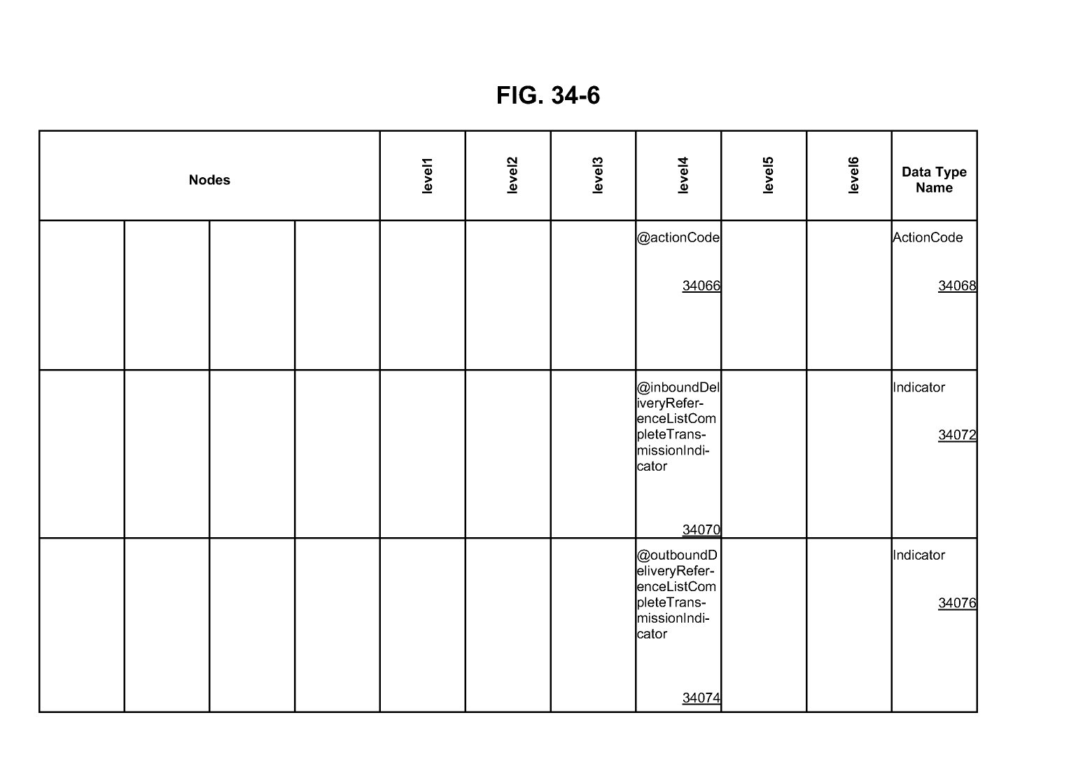

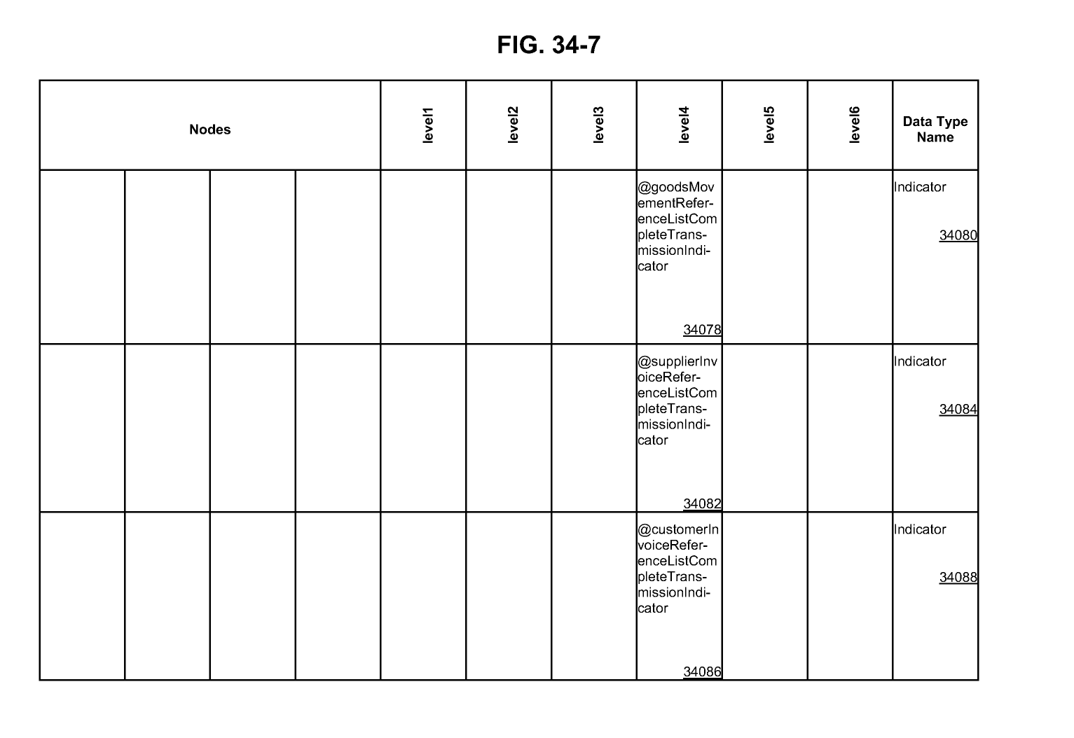

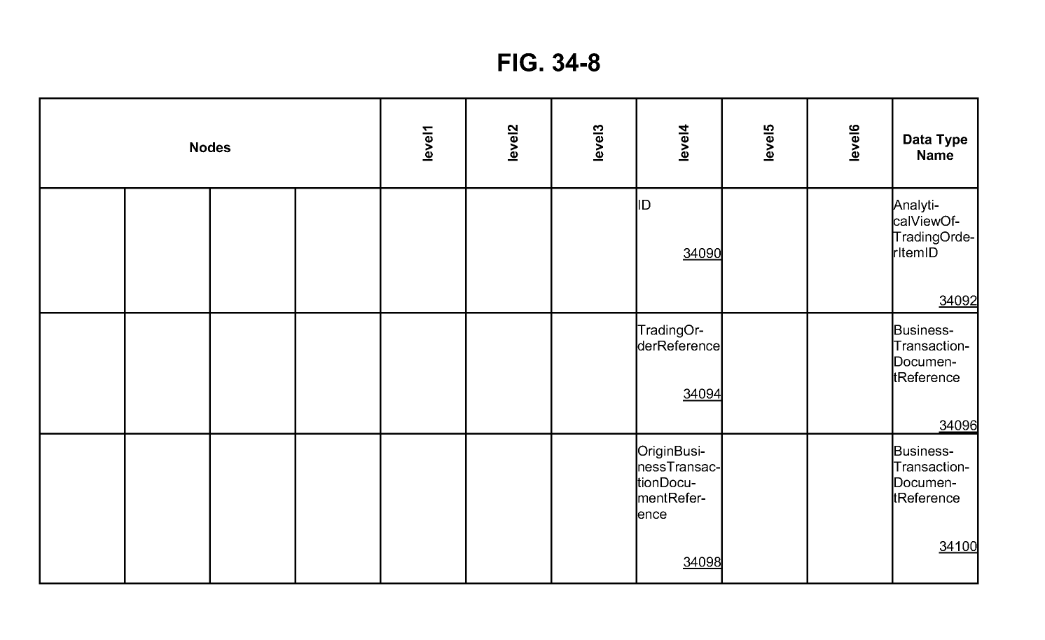

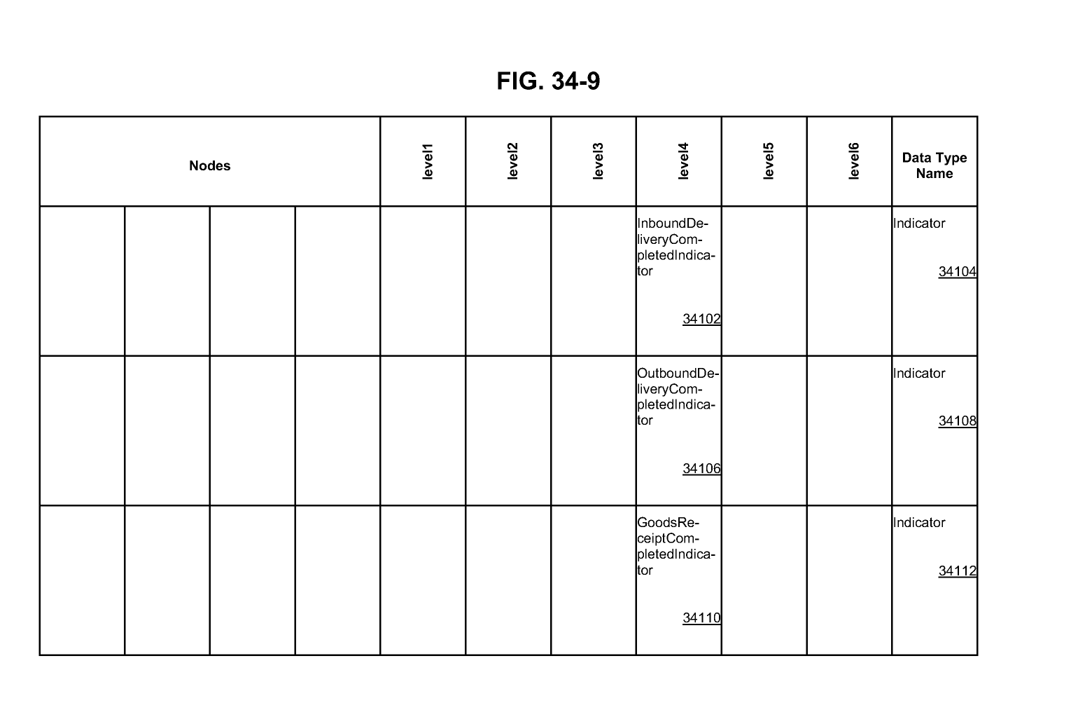

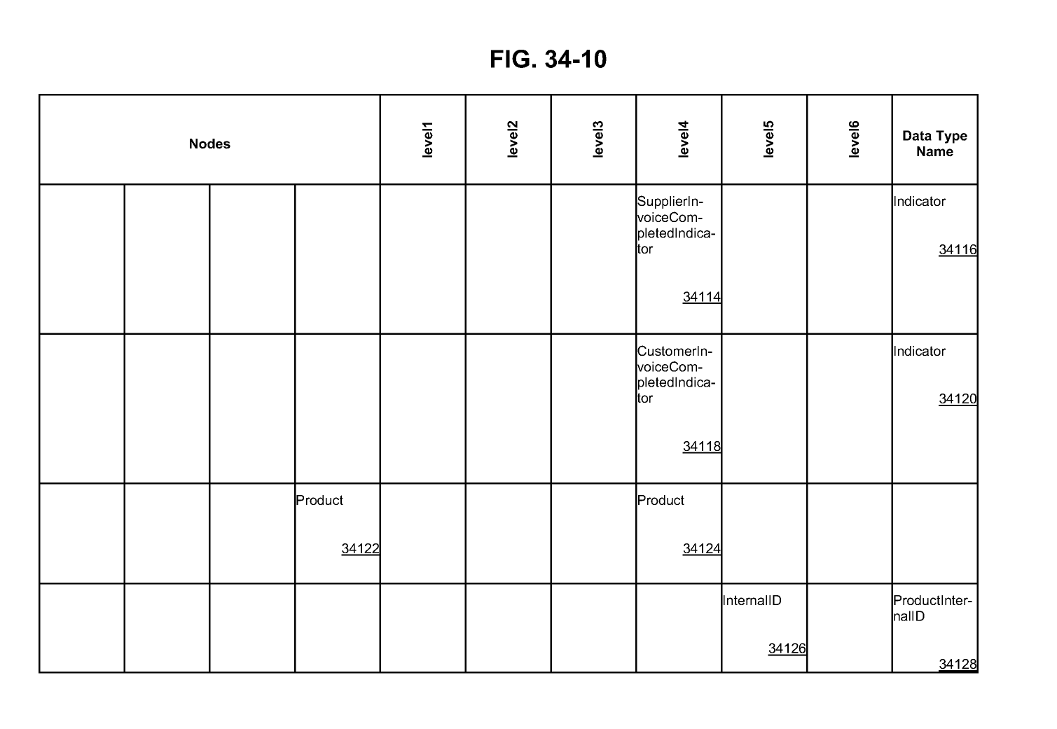

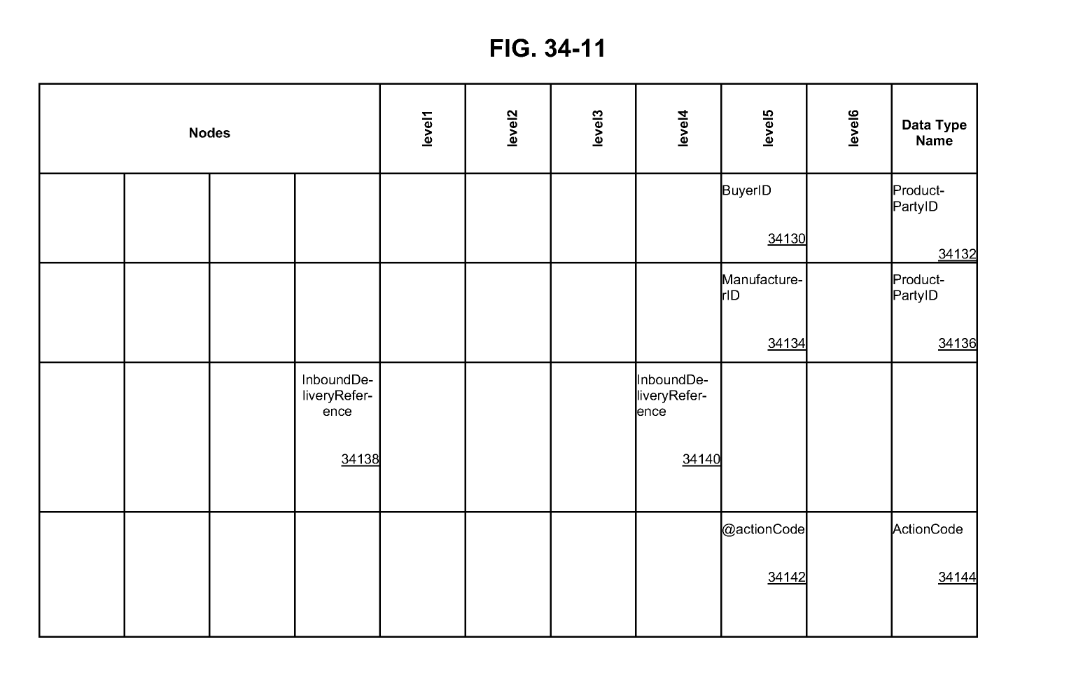

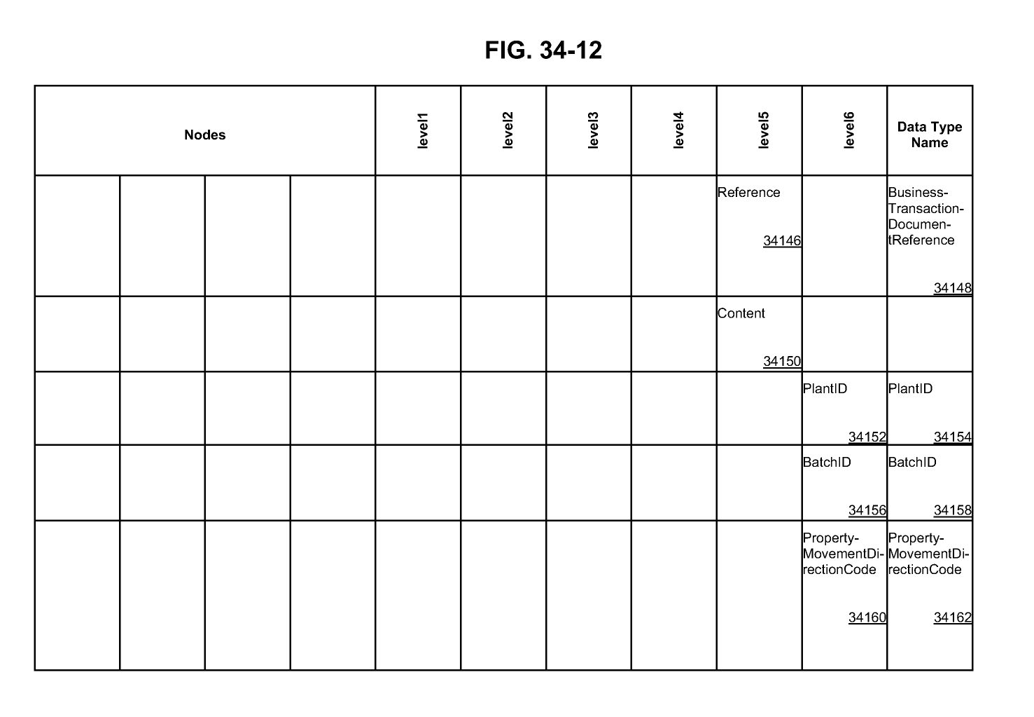

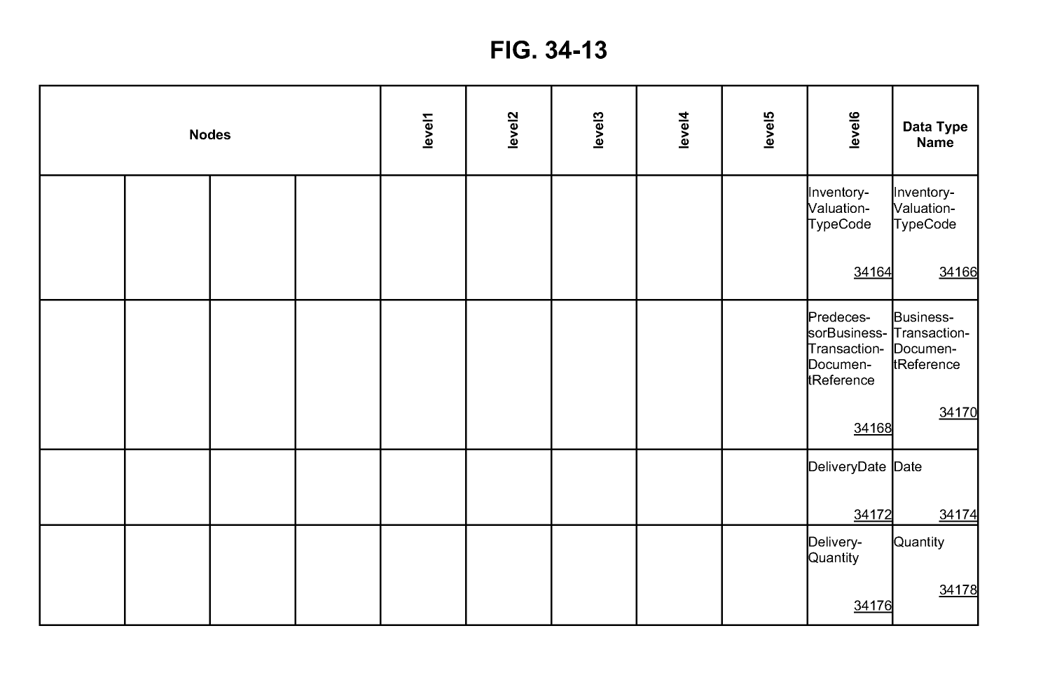

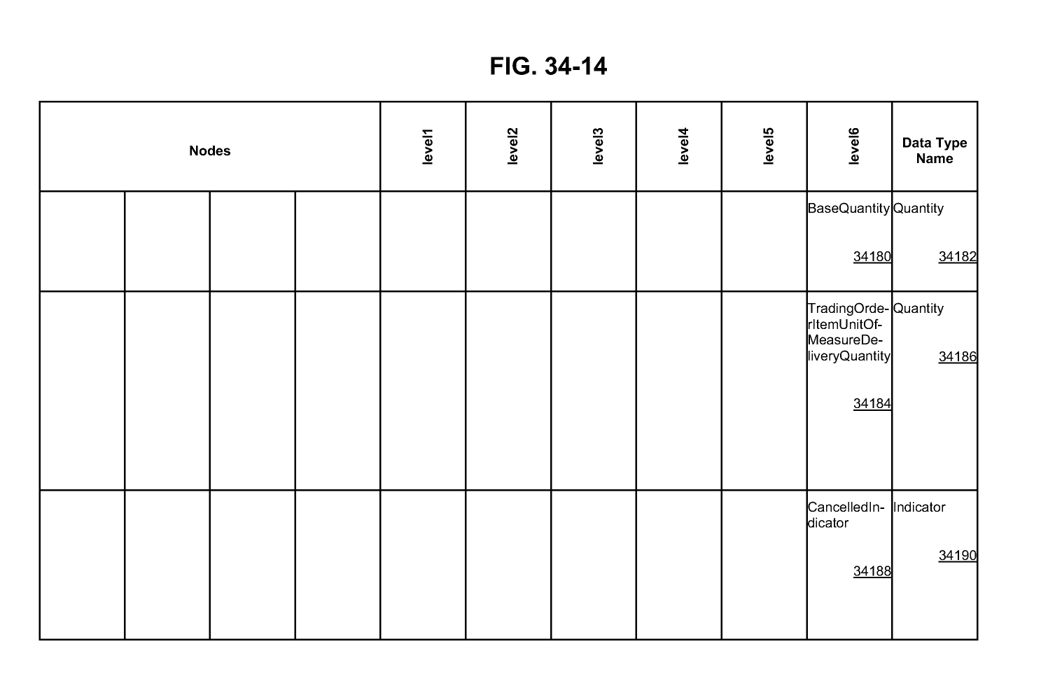

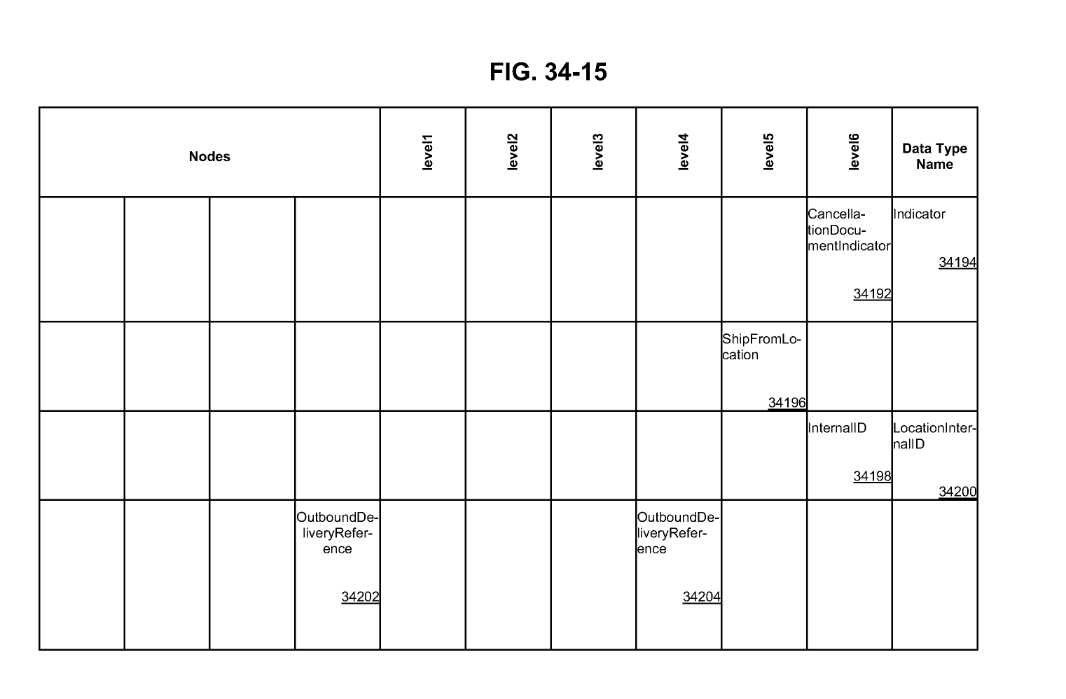

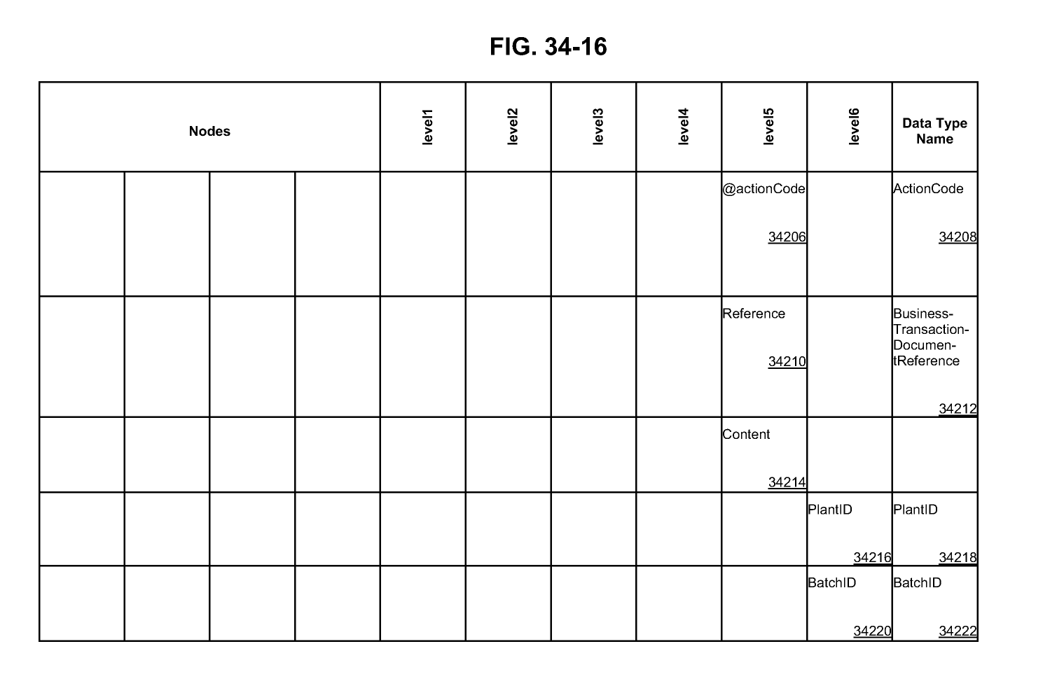

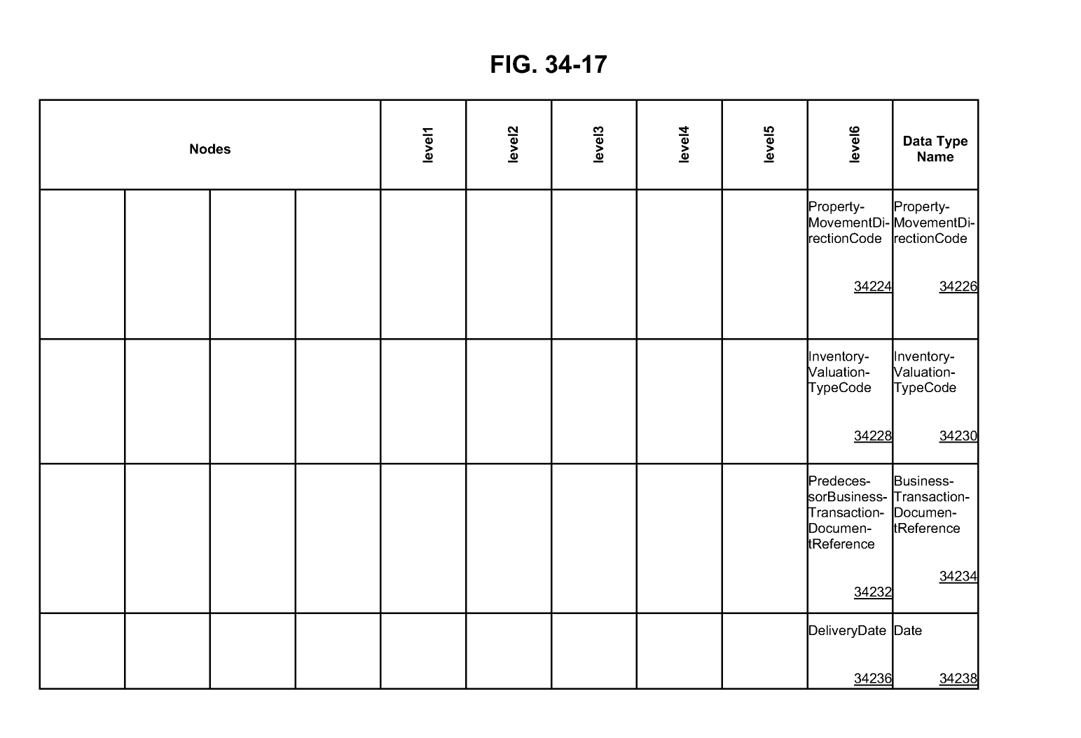

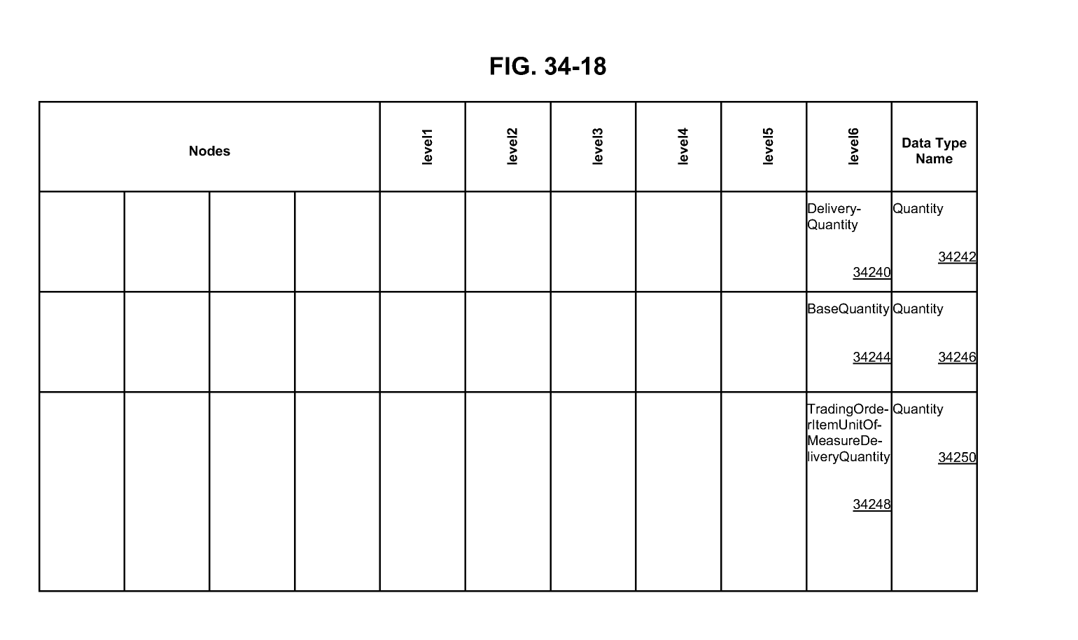

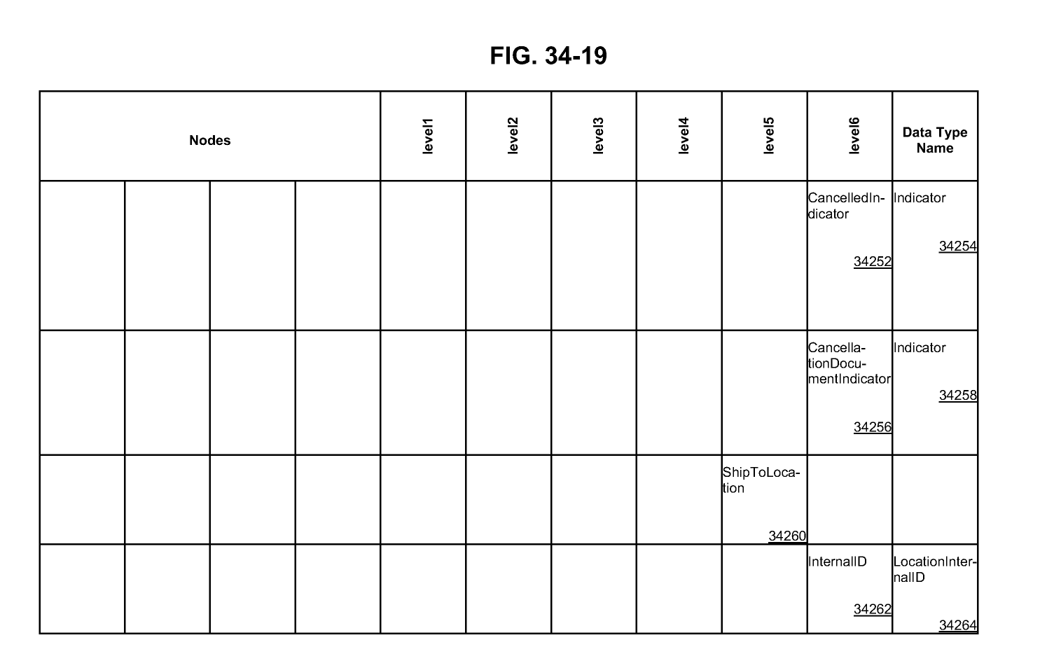

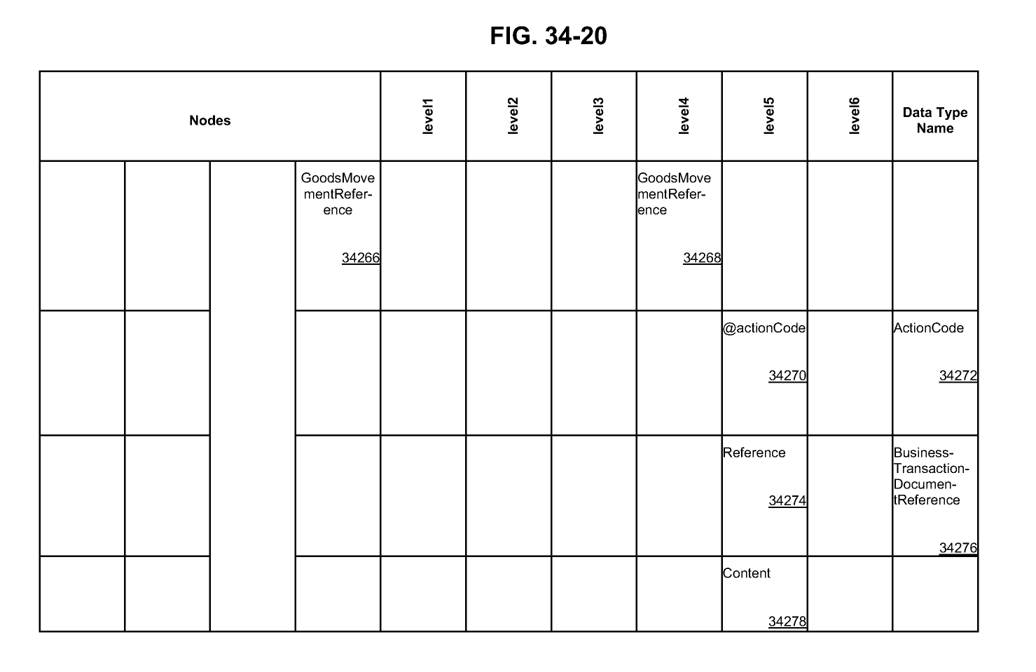

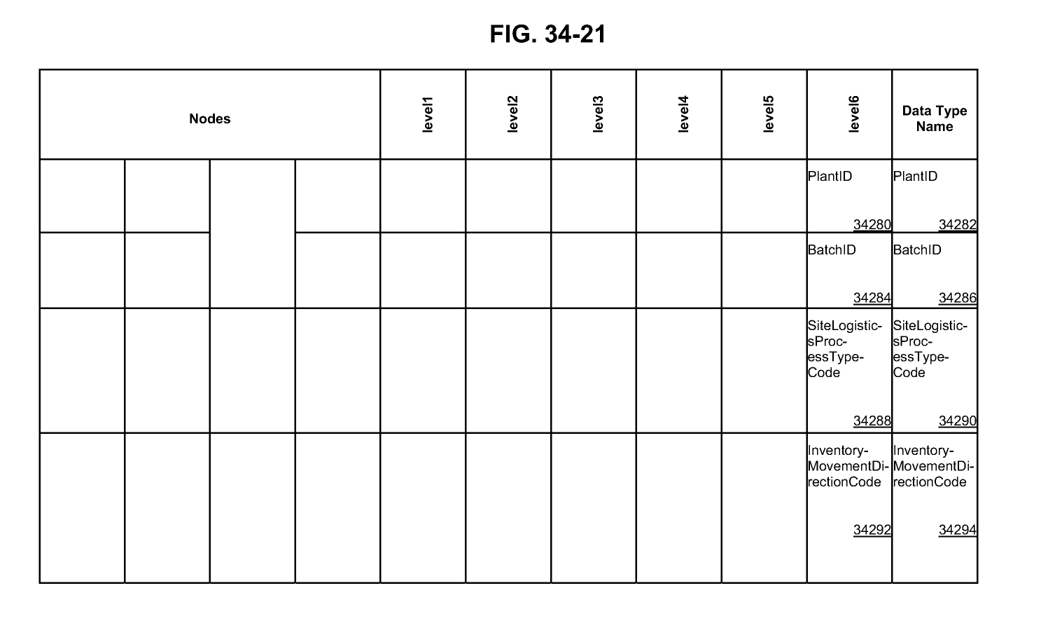

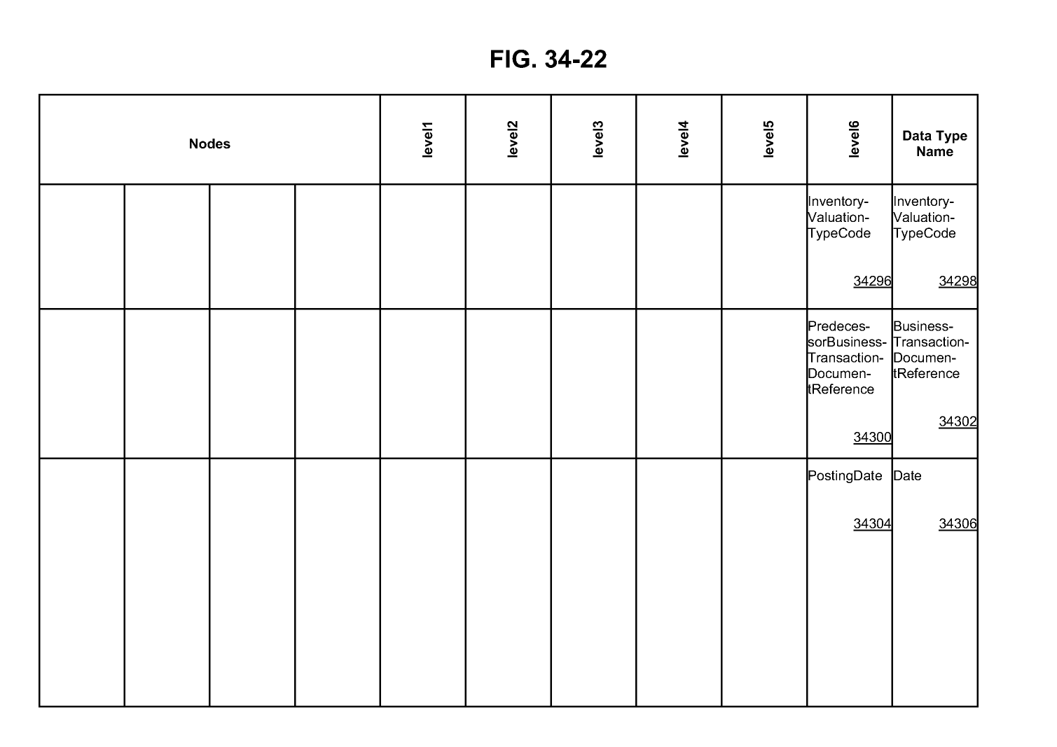

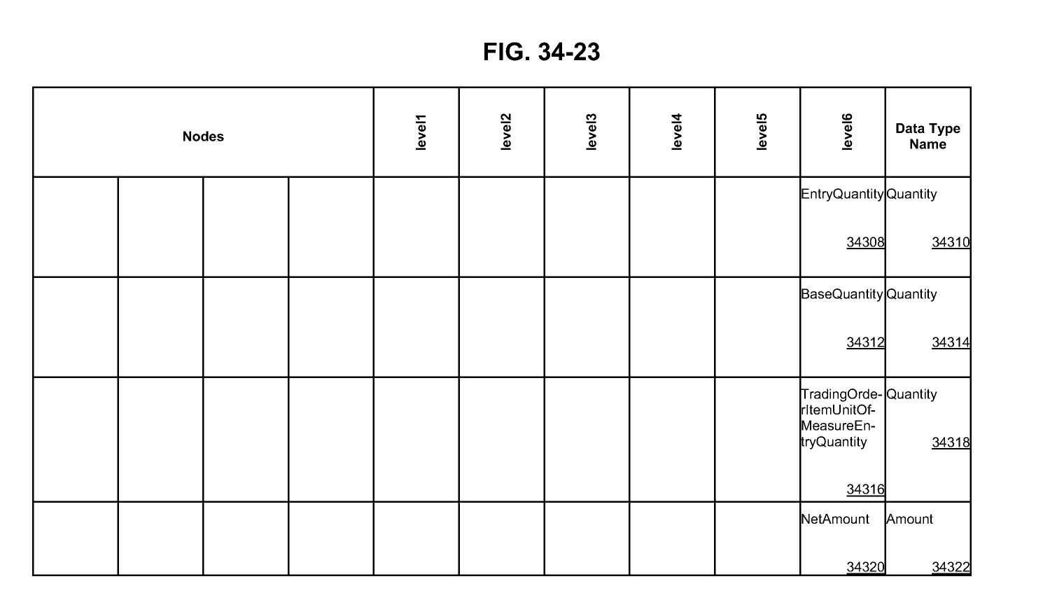

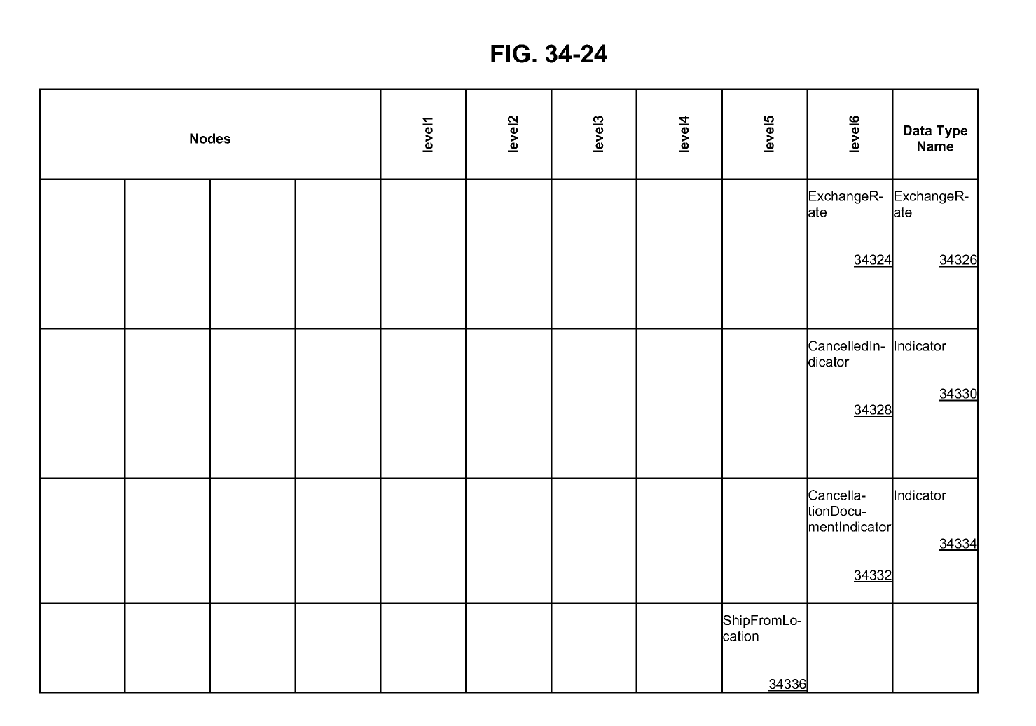

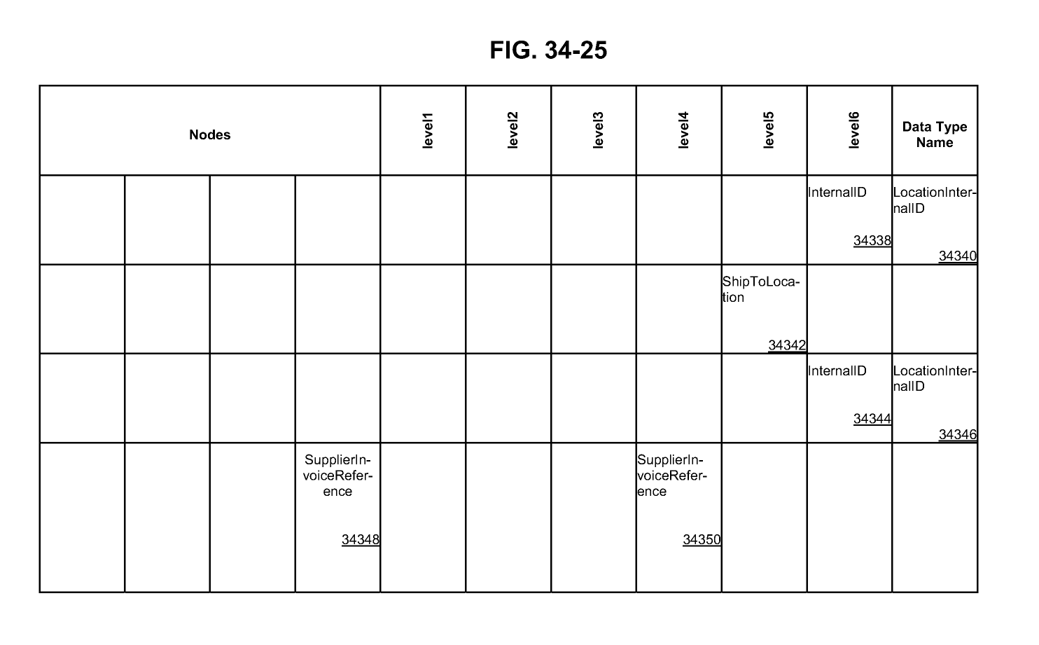

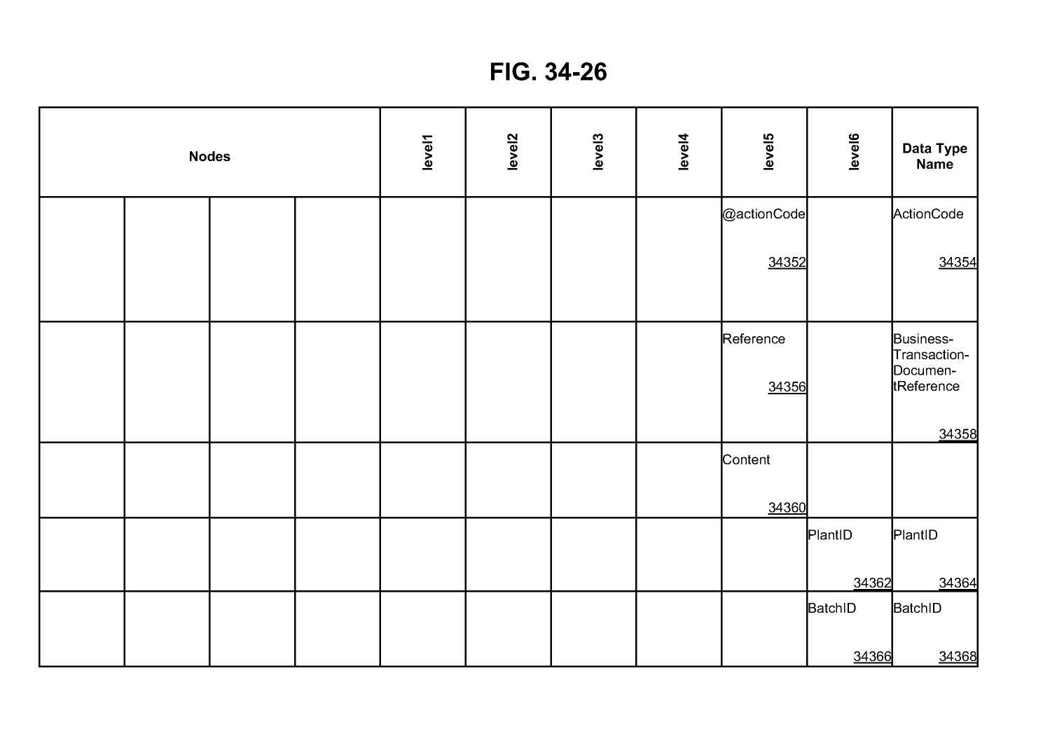

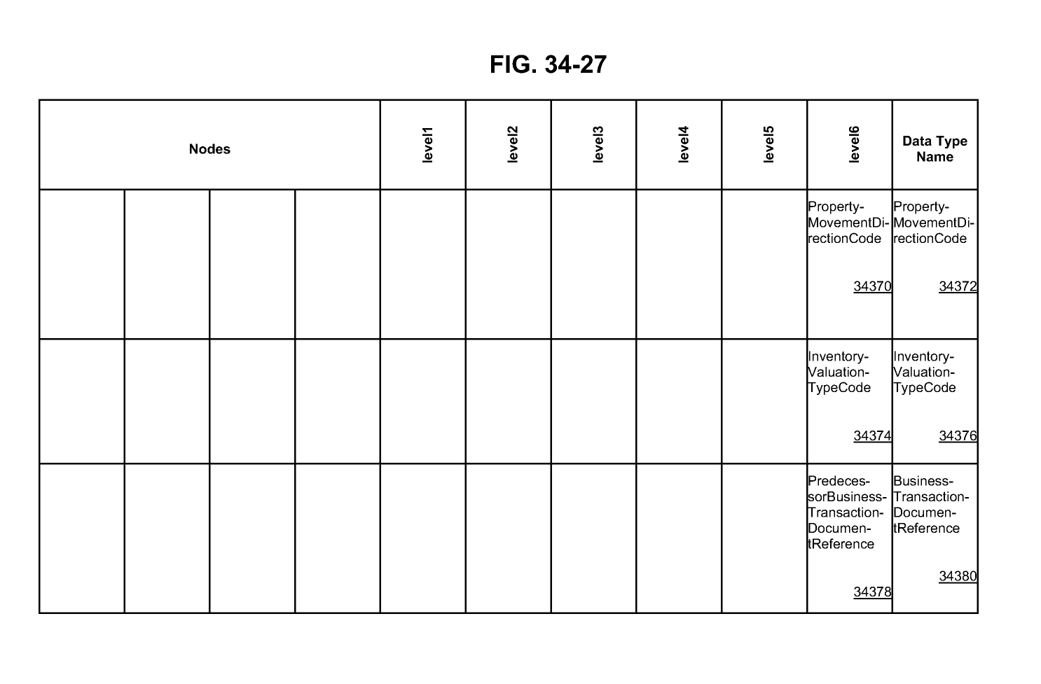

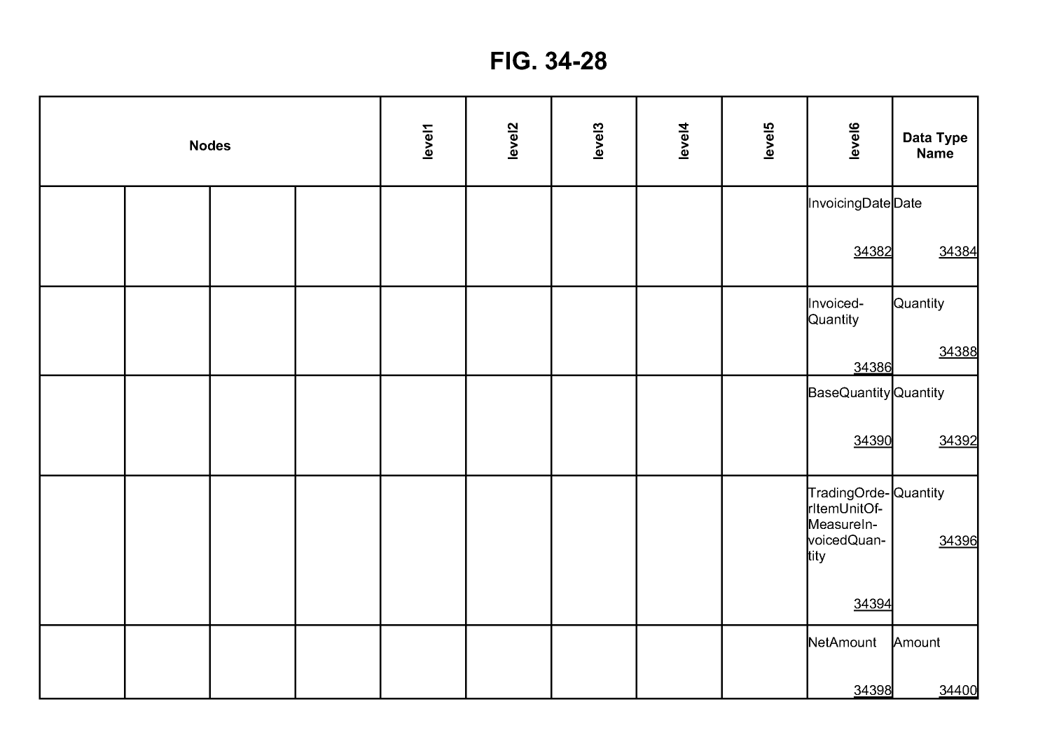

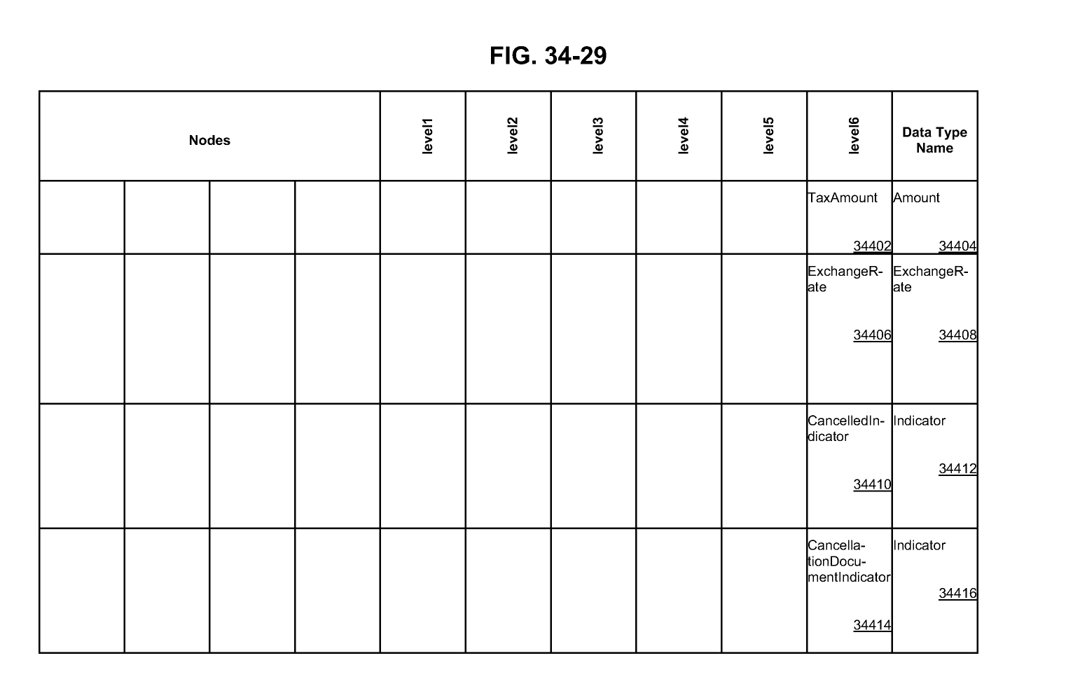

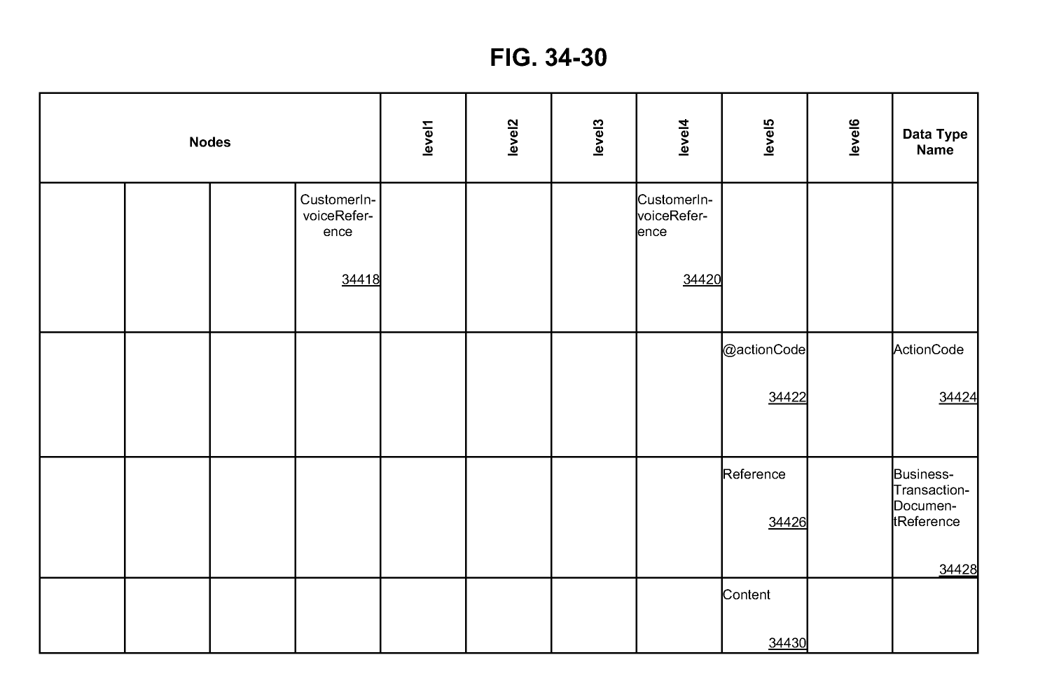

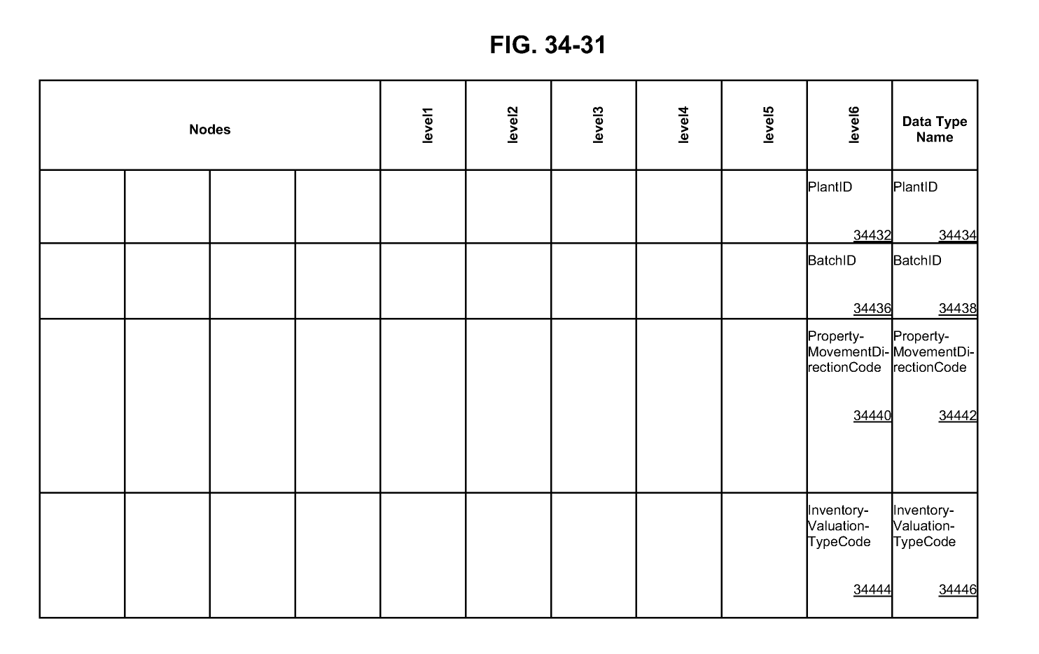

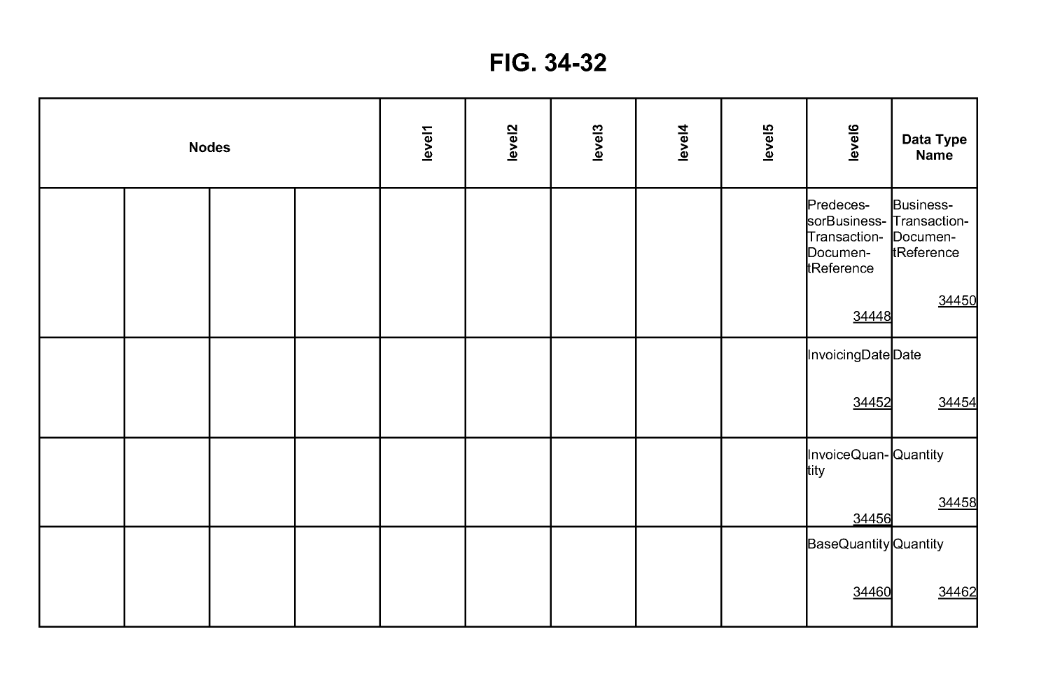

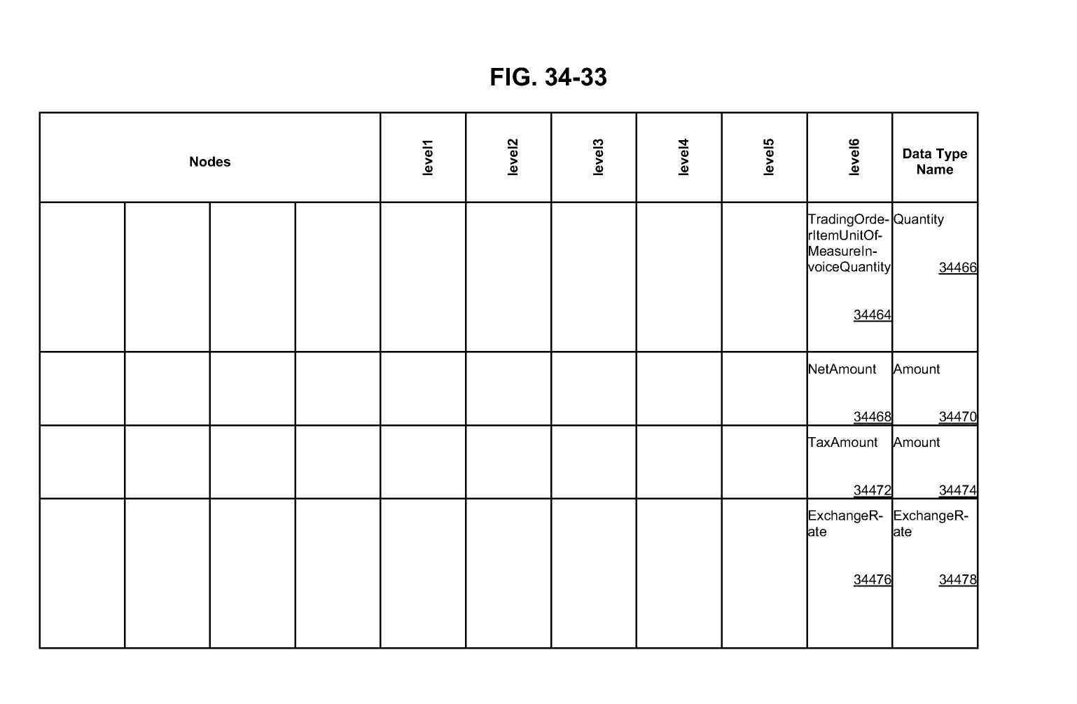

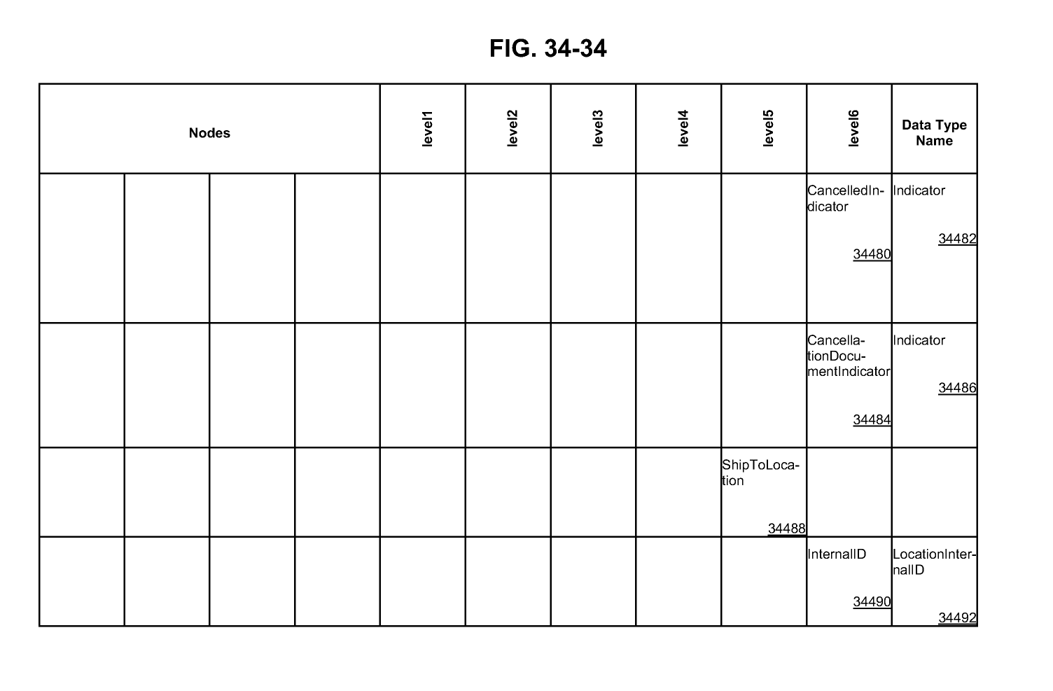

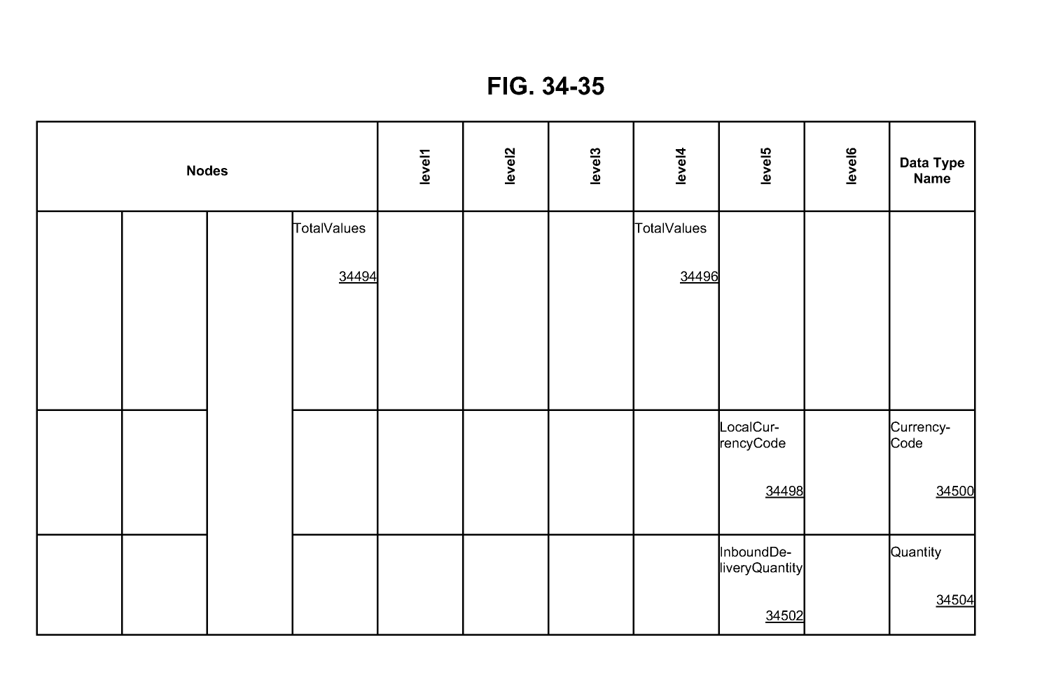

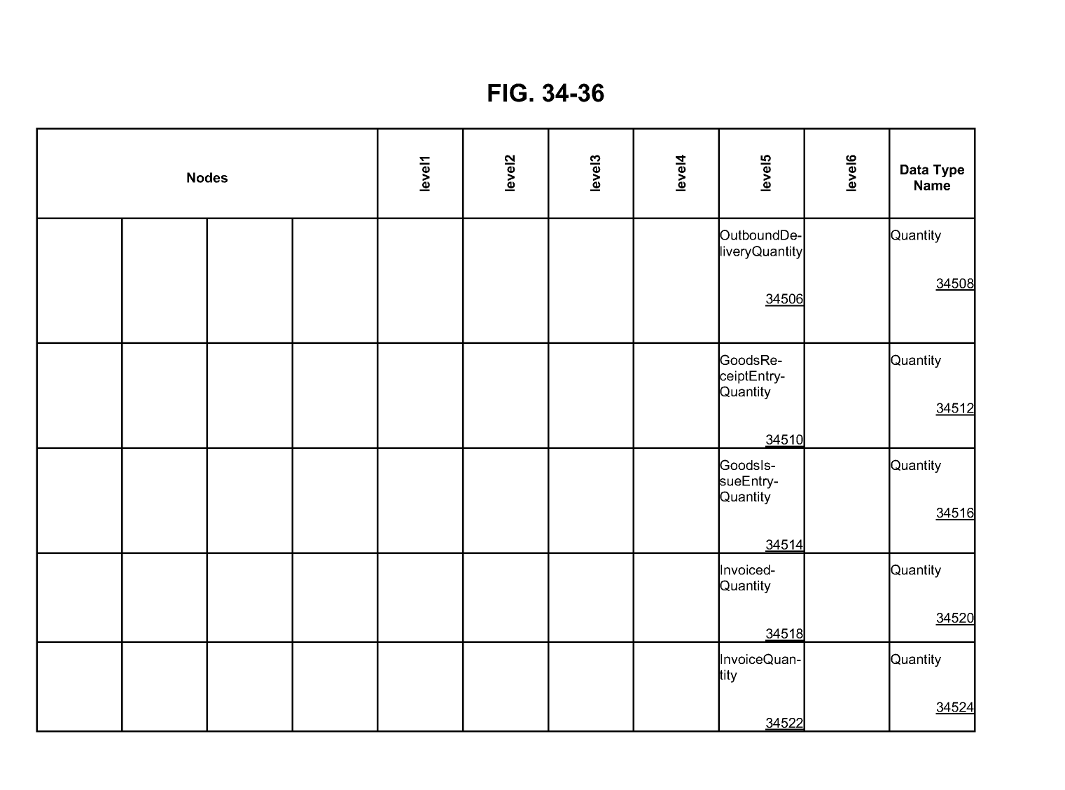

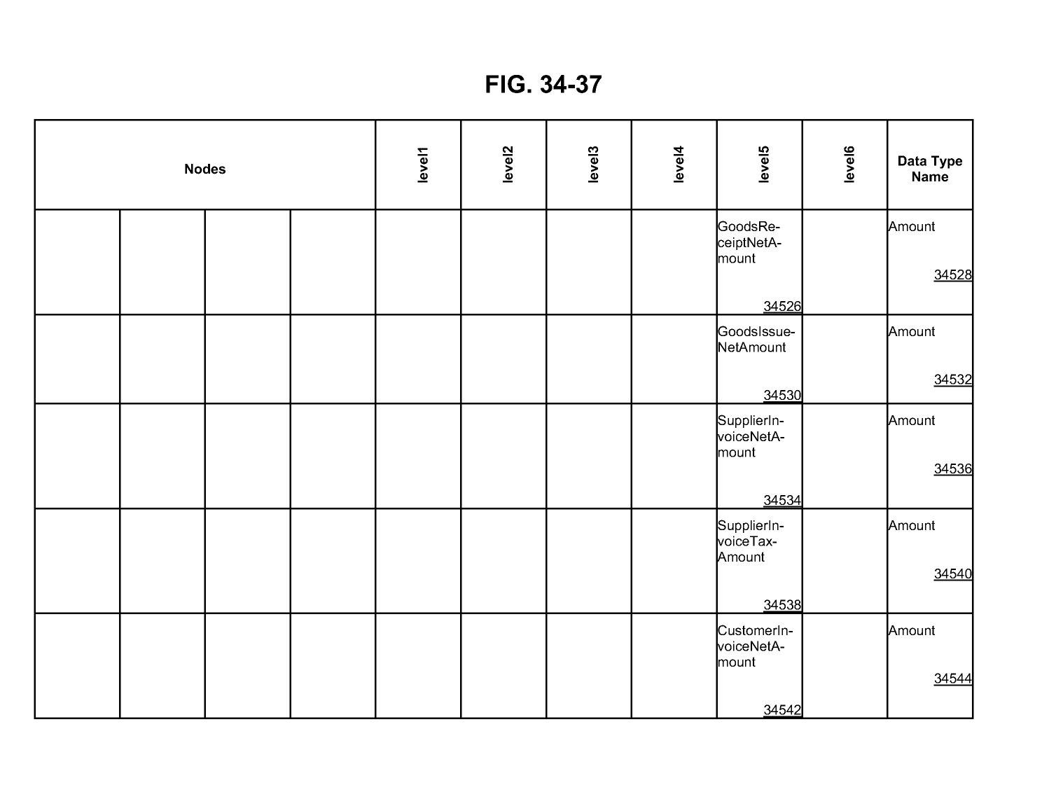

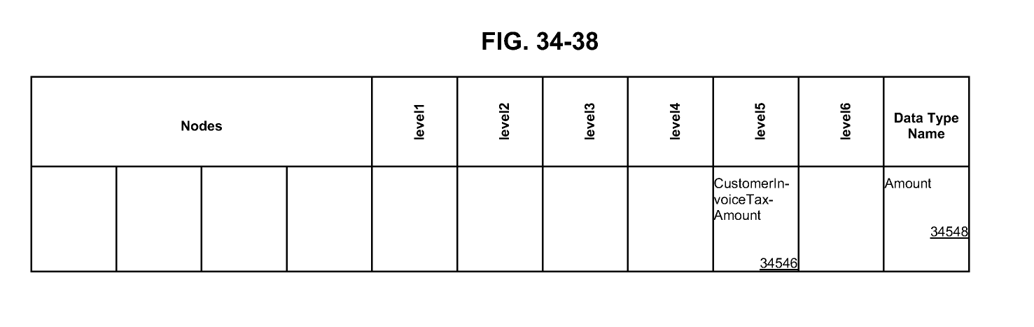

FIGS. 35-1 through 35-29 illustrate one example logical configuration of an AnalyticalViewOfTradingOrderERPNotificationMessage 35000 element structure. Specifically, these figures depict the arrangement and hierarchy of various components such as one or more levels of packages, entities, and datatypes, shown here as 35000 through GDT. As described above, packages may be used to represent hierarchy levels. Entities are discrete business elements that are used during a business transaction. Data types are used to type object entities and interfaces with a structure. For example, the AnalyticalViewOfTradingOrderERPNotificationMessage 35000 includes, among other things, an AnalyticalViewOfTradingOrderERPNotificationMessage 35002. Accordingly, heterogeneous applications may communicate using this consistent message configured as such. The data types of the various packages, entities, and attributes are described with respect to FIG. 34.

### TradePriceSpecificationContract Interfaces

TradePriceSpecificationContract interfaces are interfaces that are used in a B2B (Business To Business) process to exchange special price agreements between a manufacturer (also referred to as a supplier below) and a distributor. Multiple message types exist for mapping a B2B price specification process, such as: 1) the message type TradePriceSpecificationContractRequest, which is sent from the manufacturer to the distributor, and is used to start a new price specification process or change an existing one; 2) the message type TradePriceSpecificationContractCancelRequest, which is sent from the manufacturer to the distributor, and is used to cancel a price specification contract; and 3) the message type TradePriceSpecificationContractConfirmation, which is sent from the distributor to the manufacturer, and is used to confirm either a TradePriceSpecificationContractRequest or a TradePriceSpecificationContractCancelRequest. These message types are based on the following structures: message data type TradePriceSpecificationContractMessage, message data type TradePriceSpecificationContractCancelMessage, and message data type TradePriceSpecificationContractConfirmationMessage.

FIGS. 36-1 through 36-4 illustrate an example TradePriceSpecificationContract business object model 36000. Specifically, this model depicts interactions among various components of the TradePriceSpecificationContract, as well as external components that interact with the TradePriceSpecificationContract (shown here as 36002 through 36006 and 36022 through 36042). The TradePriceSpecificationContract business object model 36000 includes elements 36008 through 36020. The elements 36008 through 36020 can be hierarchical, as depicted. For example, the TradePriceSpecificationContract entity 36008 hierarchically includes entities Condition 36020, Party 36014 and PaymentTerms 36016. Similarly, the entity PaymentTerms 36016 includes an entity ExchangeRate 36018 and a dependent object CaseDiscountTerms 36020. Some or all of the elements 36008 through 36020 can correspond to packages and/or entities in the message data types described below.

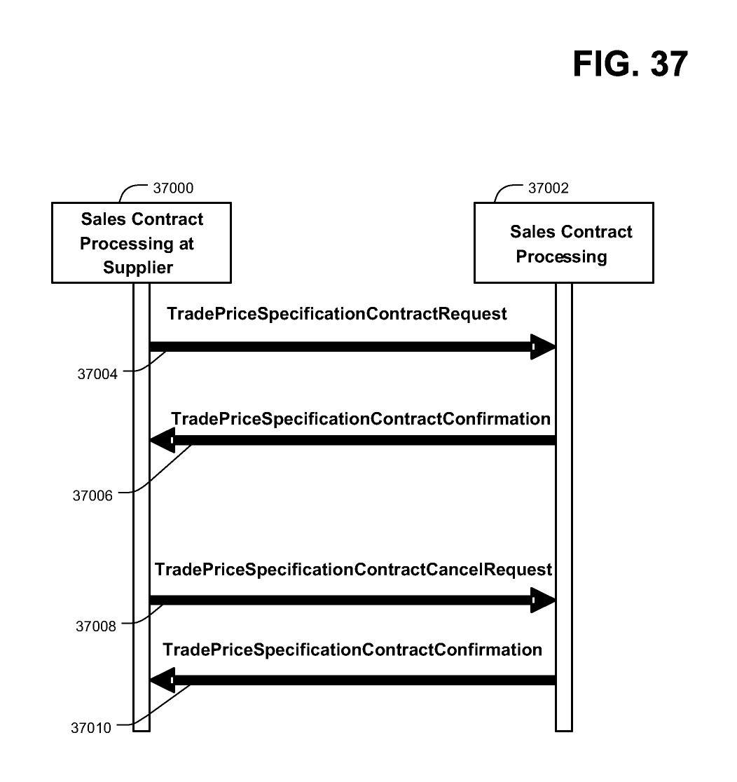

The message choreography of FIG. 37 describes a possible logical sequence of messages that can be used to realize a Trade Price Specification Contract business scenario. A “Sales Contract Processing at Supplier” system 37000 can request a Trade Price Specification Contract using a TradePriceSpecificationContractRequest message 37004 as shown, for example, in FIG. 37. A “Sales Contract Processing” system 37002 can confirm the request using a TradePriceSpecificationContractConfirmation message 37006 as shown, for example, in FIG. 37.

The “Sales Contract Processing at Supplier” system 37000 can cancel the request for a Trade Price Specification Contract using a request a Trade Price Specification Contract message 37008 as shown, for example, in FIG. 37. The “Sales Contract Processing” system 37002 can confirm the cancellation request using a TradePriceSpecificationContractConfirmation message 37010 as shown, for example, in FIG. 37.

A TradePriceSpecificationContractRequest is a request to create a condition contract or to change an existing contract. The structure of the message type TradePriceSpecificationContractRequest is specified by the message data type TradePriceSpecificationContractRequestMessage. A TradePriceSpecificationContractCancelRequest is a request to cancel a price specification contract sent by the supplier. The structure of the message type TradePriceSpecificationContractCancelRequest is specified by the message data type TradePriceSpecificationCancelRequestMessage. A TradePriceSpecificationContractConfirmation is a confirmation sent by the distributor to the manufacturer confirming that either a TradePriceSpecificationContractRequest or a TradePriceSpecificationContractCancelRequest has been processed. The structure of the message type TradePriceSpecificationContractConfirmation is specified by the message data type TradePriceSpecificationContractConfirmationMessage. The price specification contract messages can be implemented by the following message interfaces: Sales Contract Processing, TradePriceSpecificationContractRequest_In, TradePriceSpecificationContractCancelRequest_In, and TradePriceSpecificationContractConfirmation_Out.

FIGS. 38-1 to 38-4 illustrate one example logical configuration of TradePriceSpecificationContractRequestMessage message 38000. Specifically, these figures depict the arrangement and hierarchy of various components such as one or more levels of packages, entities, and datatypes, shown here as 38000 through 38032. As described above, packages may be used to represent hierarchy levels. Entities are discrete business elements that are used during a business transaction. Data types are used to type object entities and interfaces with a structure. For example, TradePriceSpecificationContractRequestMessage message 38000 includes, among other things, TradePriceSpecificationContract 38008. Accordingly, heterogeneous applications may communicate using this consistent message configured as such.

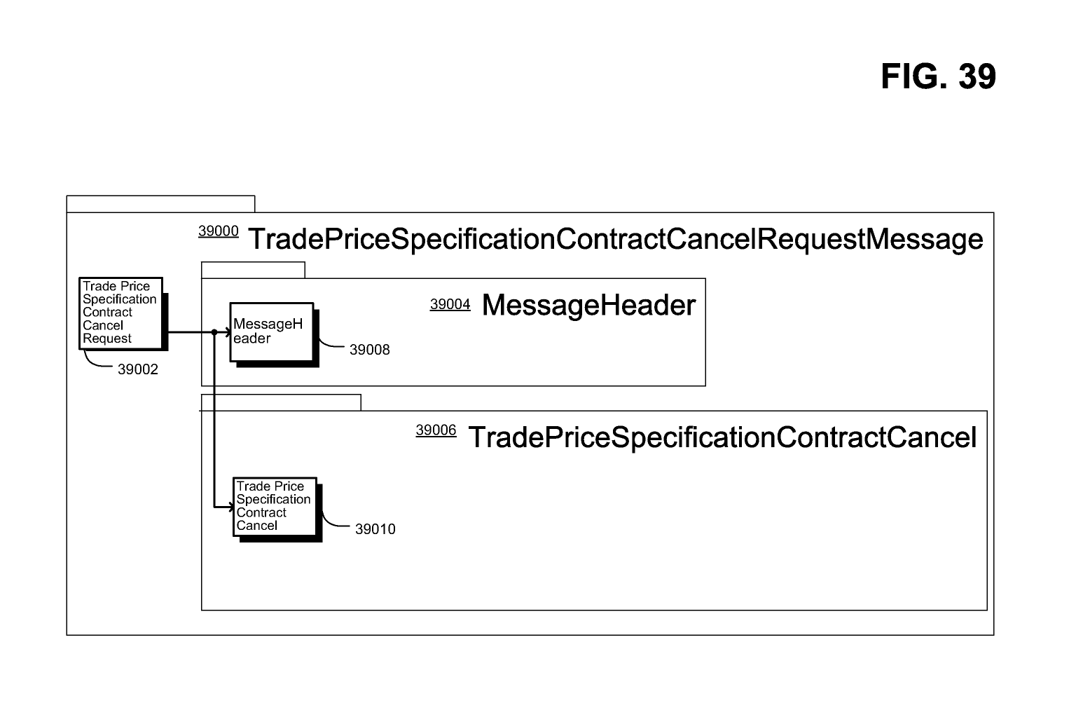

Additionally, FIG. 39 illustrates one example logical configuration of TradePriceSpecificationContractCancelRequestMessage message 39000. Specifically, these figures depict the arrangement and hierarchy of various components such as one or more levels of packages, entities, and datatypes, shown here as 39000 through 39010. As described above, packages may be used to represent hierarchy levels. Entities are discrete business elements that are used during a business transaction. Data types are used to type object entities and interfaces with a structure. For example, TradePriceSpecificationContractCancelRequestMessage message 39000 includes, among other things, TradePriceSpecificationContractCancel 39006. Accordingly, heterogeneous applications may communicate using this consistent message configured as such.

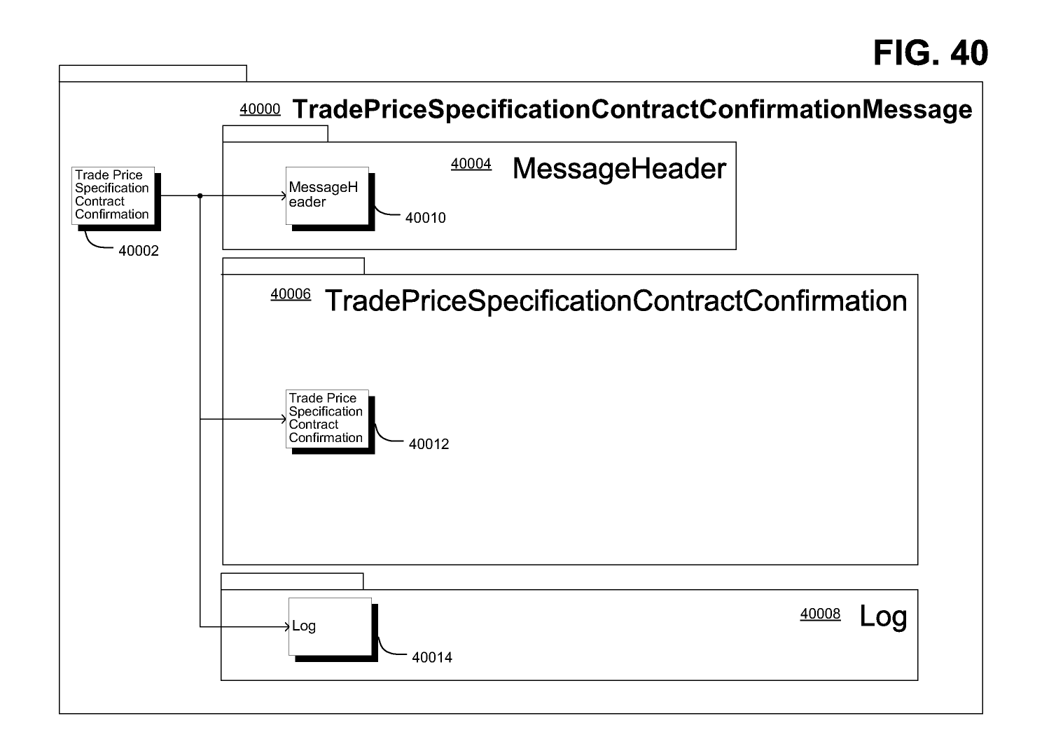

Additionally, FIG. 40 illustrates one example logical configuration of TradePriceSpecificationContractConfirmationMessage message 40000. Specifically, this figure depicts the arrangement and hierarchy of various components such as one or more levels of packages, entities, and datatypes, shown here as 40000 through 40014. As described above, packages may be used to represent hierarchy levels. Entities are discrete business elements that are used during a business transaction. Data types are used to type object entities and interfaces with a structure. For example, TradePriceSpecificationContractConfirmationMessage message 40000 includes, among other things, TradePriceSpecificationContractConfirmation 40006. Accordingly, heterogeneous applications may communicate using this consistent message configured as such.

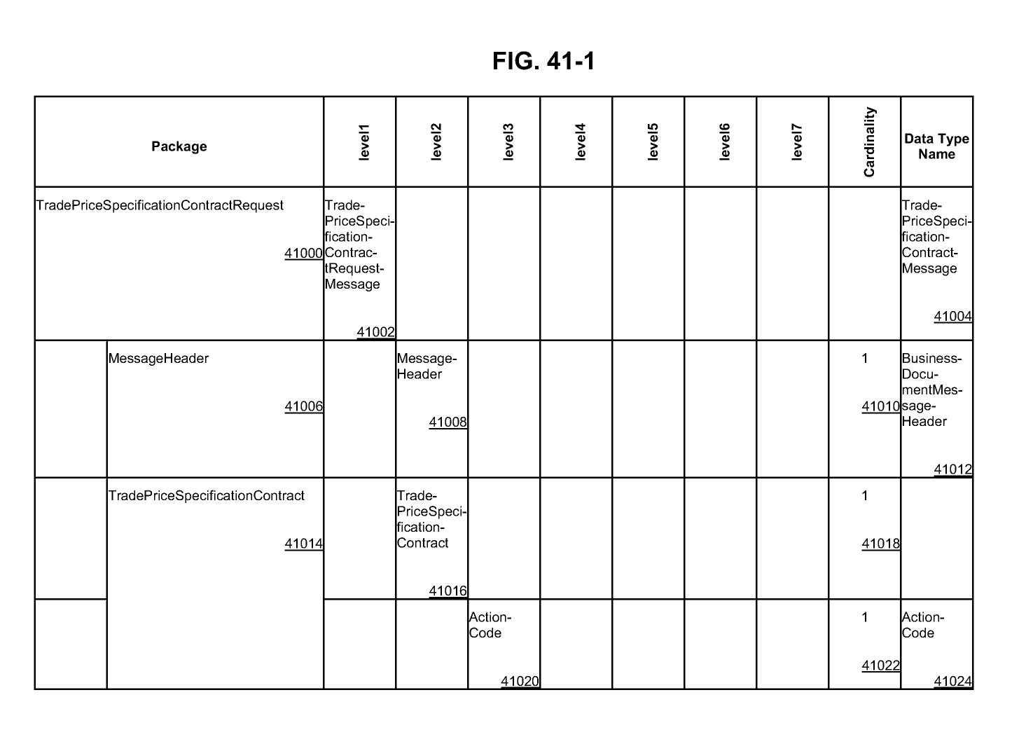

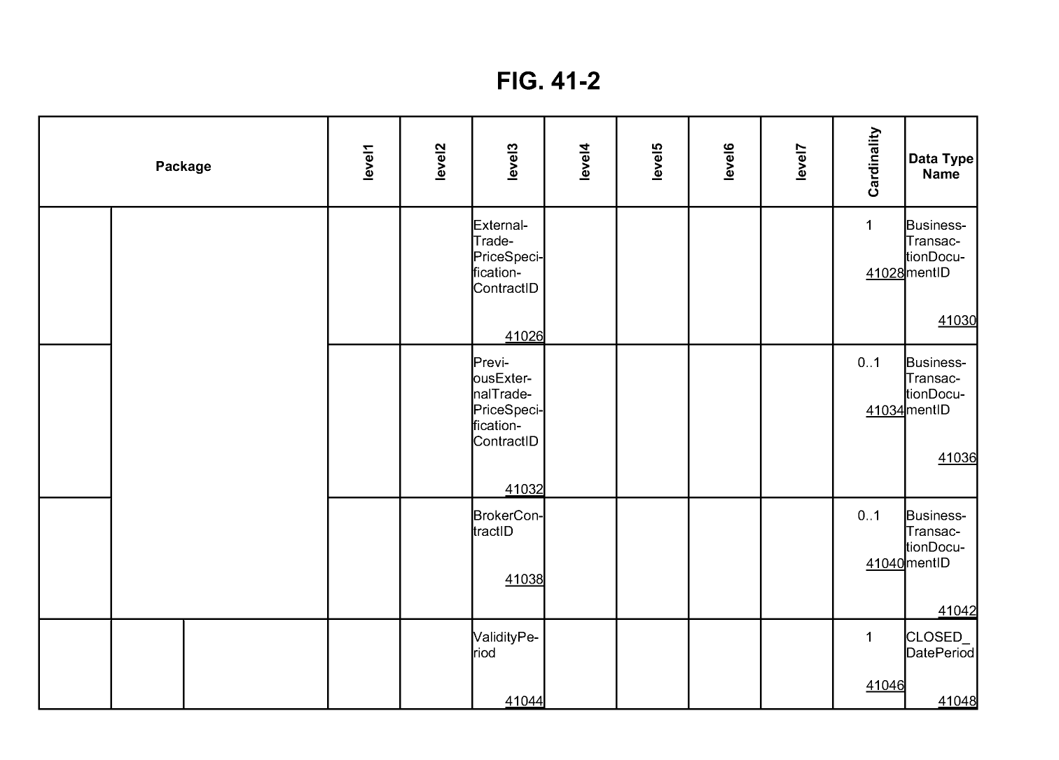

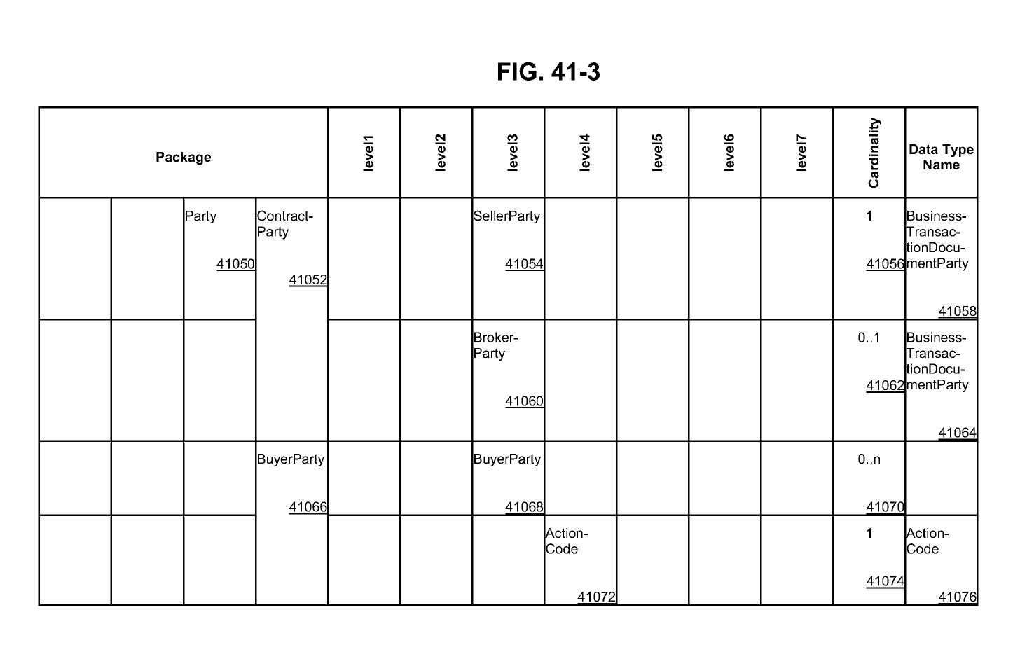

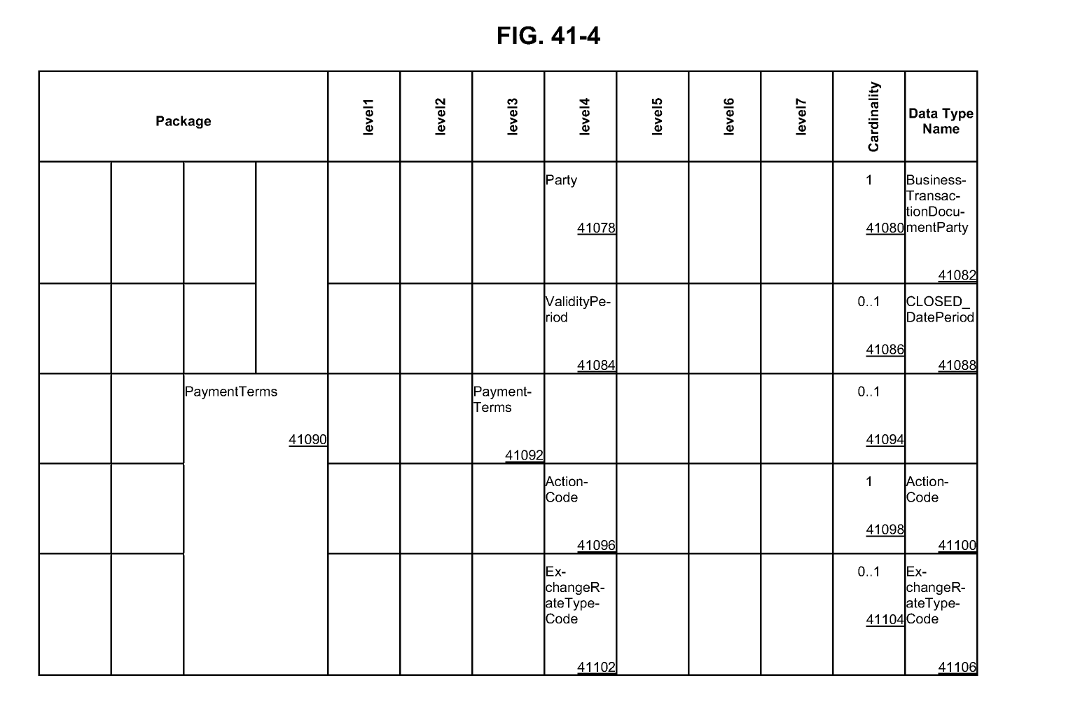

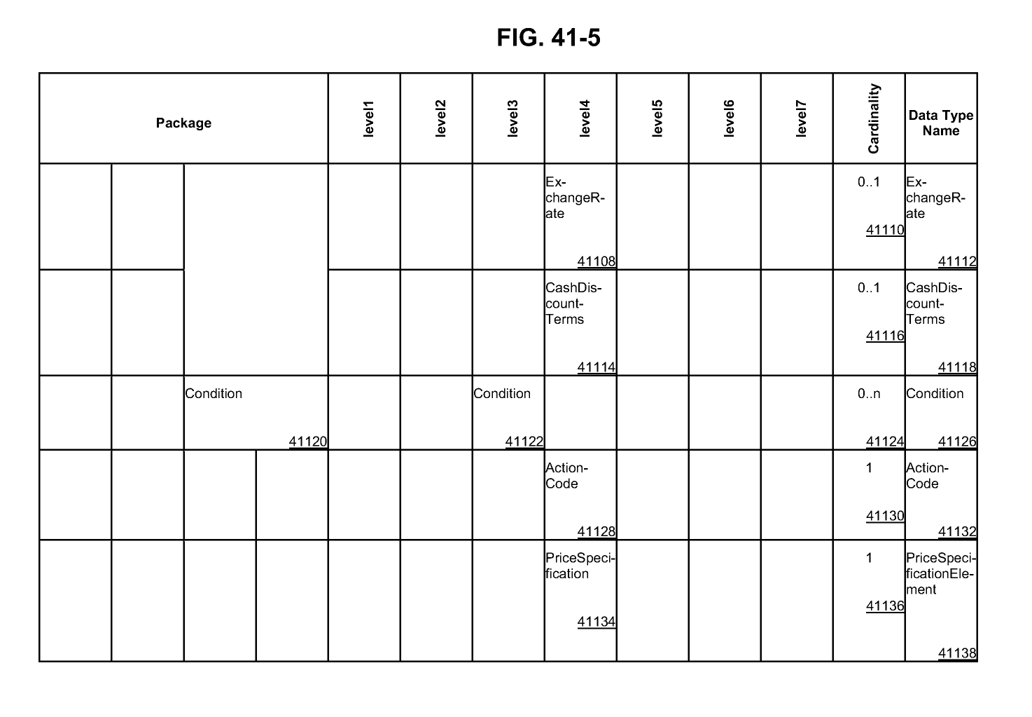

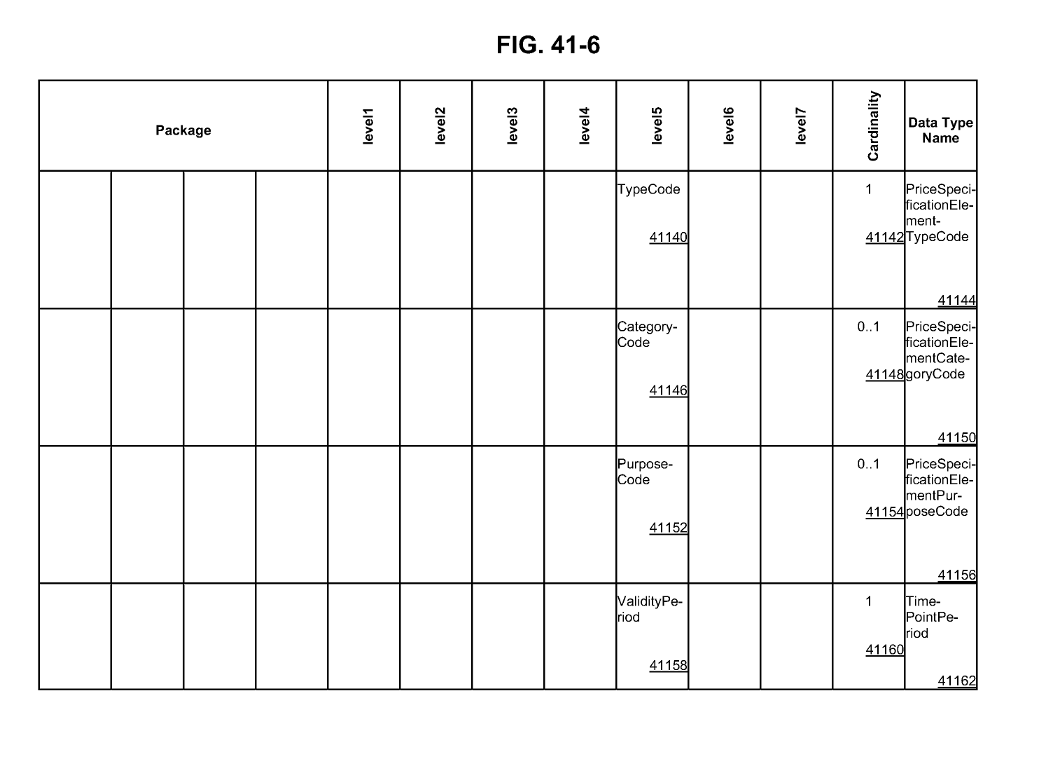

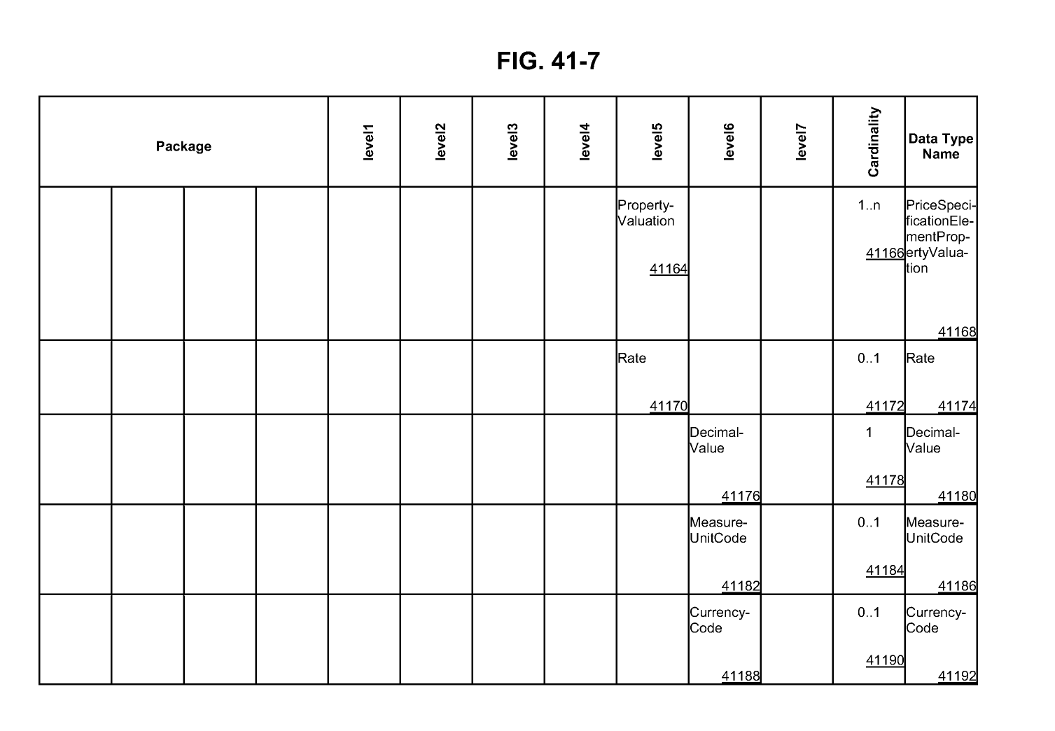

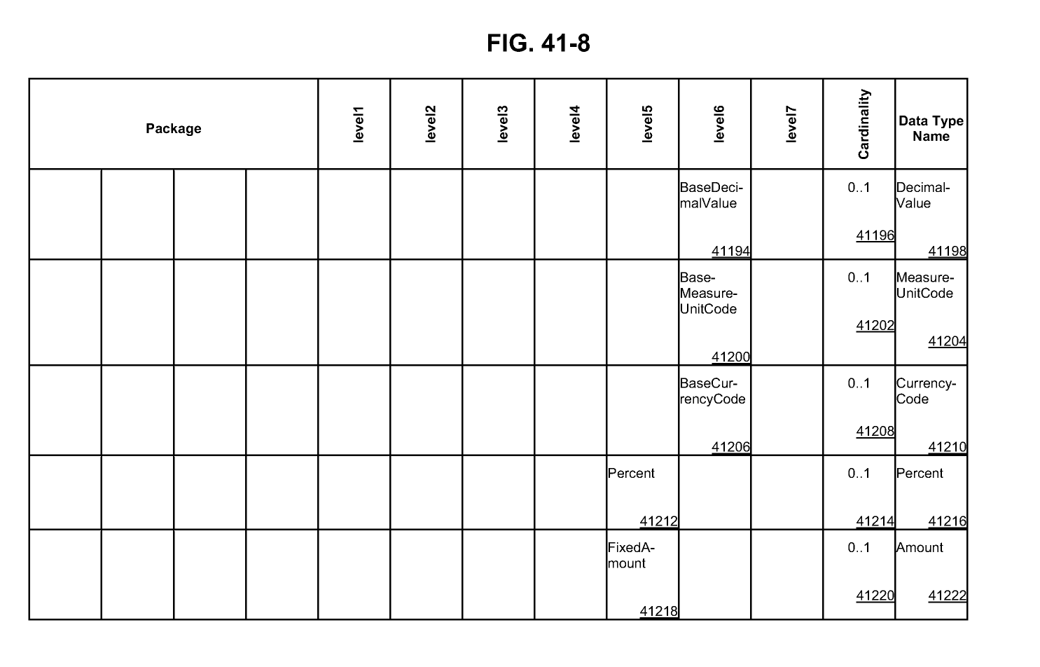

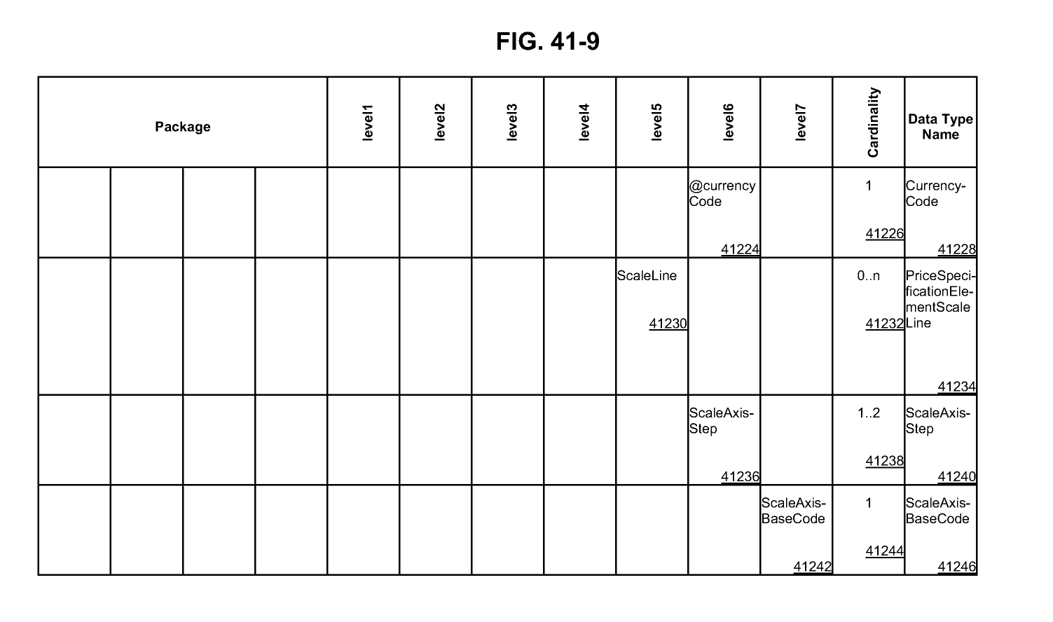

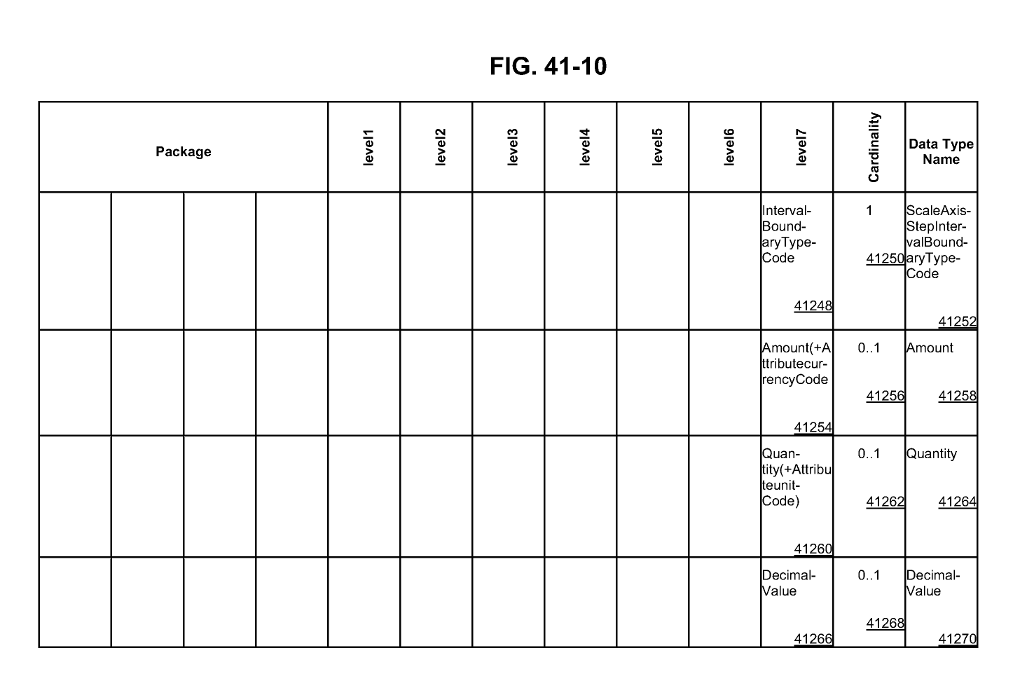

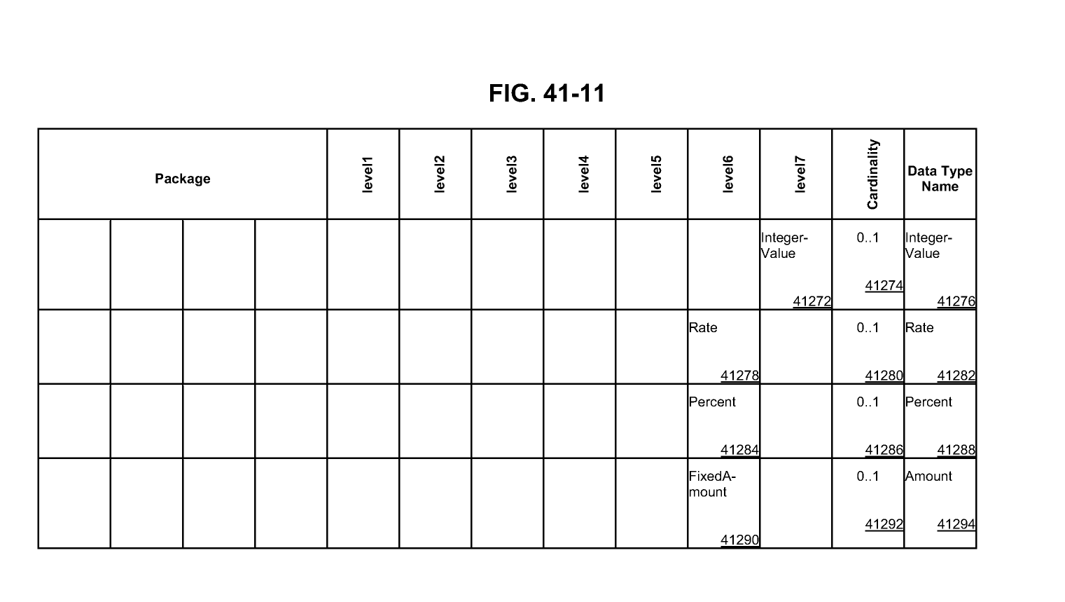

FIGS. 41-1 through 41-11 illustrate one example logical configuration of a TradePriceSpecificationContractRequest 41000 element structure. Specifically, these figures depict the arrangement and hierarchy of various components such as one or more levels of packages, entities, and datatypes, shown here as 41000 through 41294. As described above, packages may be used to represent hierarchy levels. Entities are discrete business elements that are used during a business transaction. Data types are used to type object entities and interfaces with a structure. For example, the TradePriceSpecificationContractRequest 41000 includes, among other things, a TradePriceSpecificationContractRequestMessage 41002. Accordingly, heterogeneous applications may communicate using this consistent message configured as such.

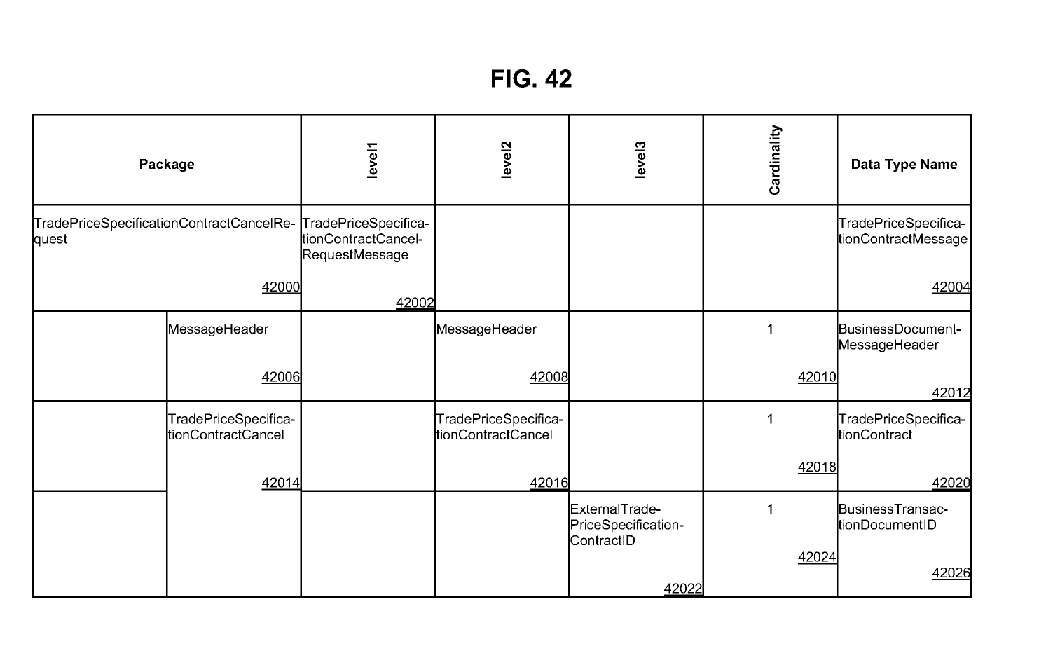

FIG. 42 illustrates one example logical configuration of a TradePriceSpecificationContractCancelRequest 42000 element structure. Specifically, this figure depicts the arrangement and hierarchy of various components such as one or more levels of packages, entities, and datatypes, shown here as 42000 through 42026. As described above, packages may be used to represent hierarchy levels. Entities are discrete business elements that are used during a business transaction. Data types are used to type object entities and interfaces with a structure. For example, the TradePriceSpecificationContractCancelRequest 42000 includes, among other things, a TradePriceSpecificationContractCancelRequestMessage 42002. Accordingly, heterogeneous applications may communicate using this consistent message configured as such.

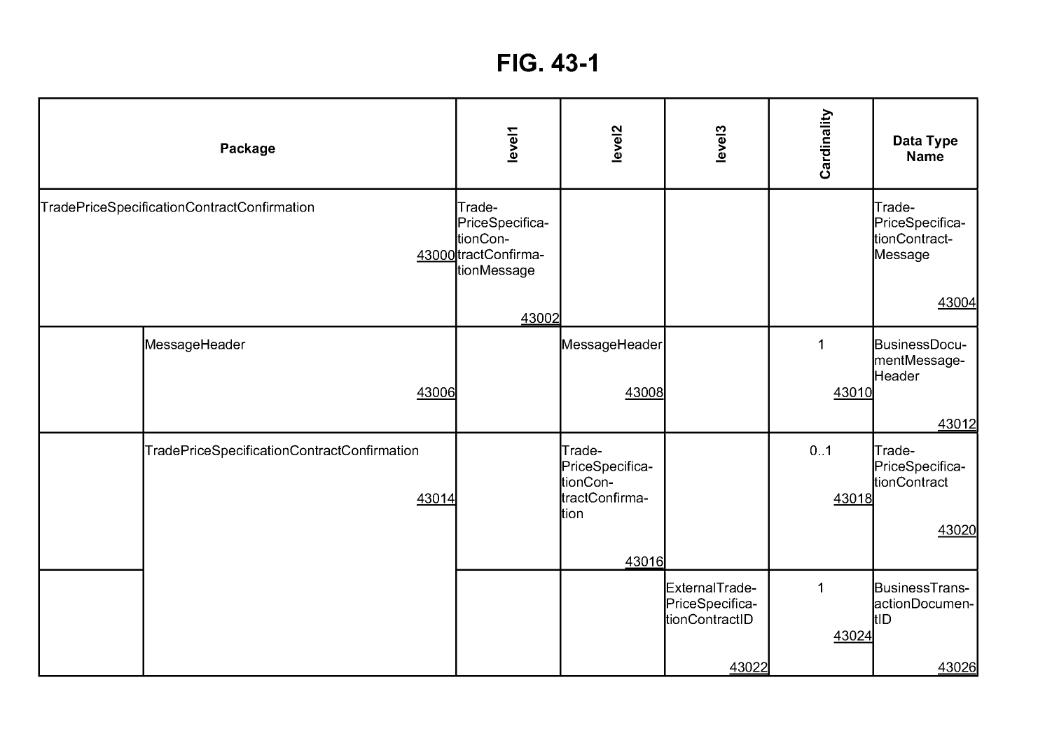

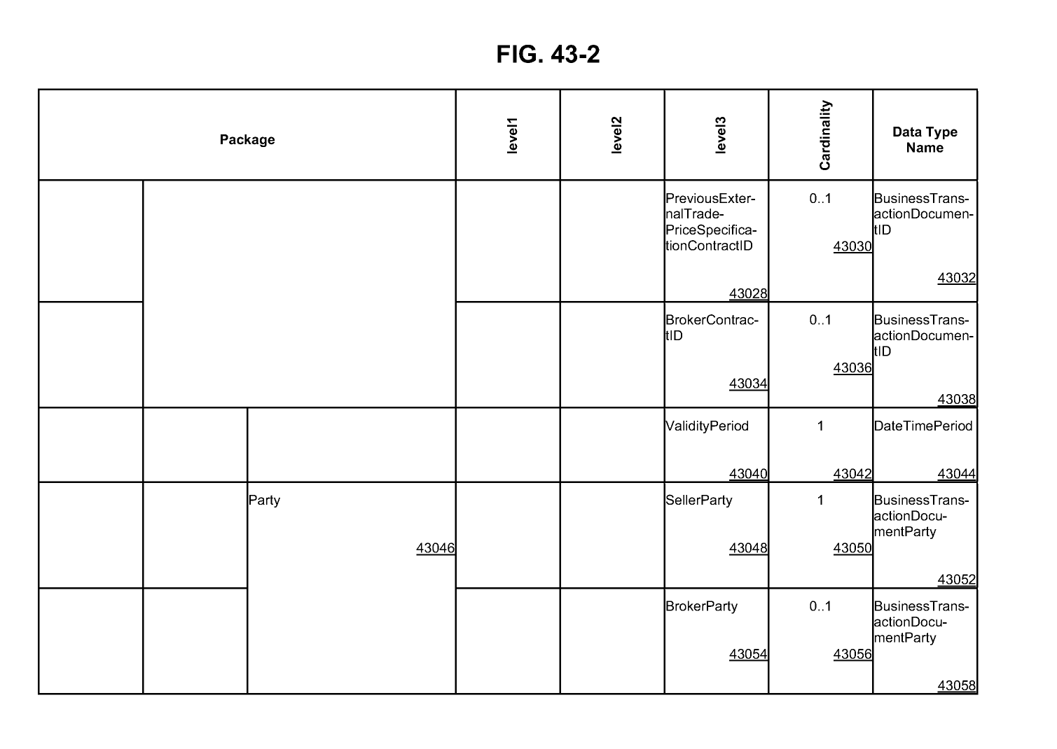

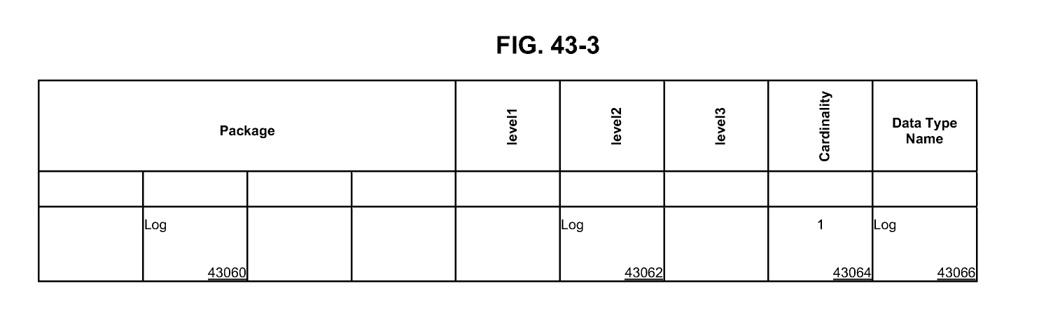

FIGS. 43-1 through 43-3 illustrate one example logical configuration of a TradePriceSpecificationContractConfirmation 43000 element structure. Specifically, these figures depict the arrangement and hierarchy of various components such as one or more levels of packages, entities, and datatypes, shown here as 43000 through 43066. As described above, packages may be used to represent hierarchy levels. Entities are discrete business elements that are used during a business transaction. Data types are used to type object entities and interfaces with a structure. For example, the TradePriceSpecificationContractConfirmation 43000 includes, among other things, a TradePriceSpecificationContractConfirmationMessage 43002. Accordingly, heterogeneous applications may communicate using this consistent message configured as such.

### Message Data Type TradePriceSpecificationContractRequestMessage

The message data type TradePriceSpecificationContractRequestMessage includes the TradePriceSpecificationContract included in the business document and the business information that is relevant for sending a business document in a message. It includes the MessageHeader package and TradePriceSpecificationContract package. A MessageHeader package groups the business information that is relevant for sending a business document in a message. It includes the MessageHeader entity. A MessageHeader groups business information from the perspective of the sending application, such as information to identify the business document in a message, information about the sender, and (possibly) information about the recipient. The MessageHeader includes the following entities: SenderParty and RecipientParty. MessageHeader is of type GDT:BusinessDocumentMessageHeader, whereby the following elements of the GDT are used: ID, ReferenceID, CreationDateTime, SenderParty, and RecipientParty. A SenderParty is the party responsible for sending a business document at a business application level. The SenderParty is of type GDT:BusinessDocumentMessageHeaderParty. A RecipientParty is the party responsible for receiving a business document at a business application level. The RecipientParty is of type GDT:BusinessDocumentMessageHeaderParty. The TradePriceSpecificationContract package groups the TradePriceSpecificationContract with its packages. TradePriceSpecificationContract includes the TradePriceSpecificationContract entity. TradePriceSpecificationContract includes the following packages: Party, PaymentTerms, and Condition.

A TradePriceSpecificationContract groups together the header information of the Trade Price Specification Contract. The TradePriceSpecificationContract is of type IDT:TradePriceSpecificationContract. The TradePriceSpecificationContract includes the following elements: ExternalTradePriceSpecificationContractID, which is the unique identifier specified by the vendor for the price specification contract and is of type GDT:BusinessTransactionDocumentID; PreviousExternalTradePriceSpecificationContractID, which is the ID of the former price specification contract before changes specified by the vendor and is of type GDT:BusinessTransactionDocumentID; BrokerContractID, which is the unique identifier specified by the buying group for the price specification contract and is of type GDT:BusinessTransactionDocumentID; and ValidityPeriod, which is a period that is defined by two points in time where the points in time can be expressed in calendar days. ValidityPeriod includes the start and the end time-point and is of type GDT:CLOSED_DatePeriod.

The Party package groups together all business parties involved in the TradePriceSpecificationContract. The Party package is subdivided into the following sub-packages: ContractParty and BuyerParty. The ContractParty package includes the following entities: SellerParty and BrokerParty. A SellerParty is a party that sells goods or services. The SellerParty is of type GDT:BusinessTransactionDocumentParty. The type SellerParty is used to represent the manufacturer involved in the contract. A BrokerParty is a party that is a facilitator in a business transaction. The BrokerParty is of type GDT:BusinessTransactionDocumentParty. The type BrokerParty is used to represent a third party that may be involved in the negotiation of the contract. A BuyerParty package groups together the information about a buyer eligible to the special price in the TradePriceSpecificationContract. It includes the BuyerParty entity. A BuyerParty is a party that buys goods or services. The BuyerParty is of type IDT:TradePriceSpecificationContractBuyerParty. The BuyerParty includes the BuyerParty and ValidityPeriod elements. A BuyerParty element is a party that buys goods or services. It is of type GDT:BusinessTransactionDocumentParty. ValidityPeriod is a period that is defined by two points in time. These points in time can be expressed in calendar days. ValidityPeriod includes the start and the end time-point. It is of type GDT:CLOSED_DatePeriod. The BuyerParty information is used to identify the eligible customer in the receiving system.

The PaymentTerms package groups together information for payment of a chargeback request. It includes the following entities: PaymentTerms, Exchange Rate, and Cash Discount Terms. The PaymentTerms package groups together information for payment of a chargeback request. The PaymentTerms is of type IDT:TradePriceSpecificationContractPaymentTerms. It includes the ActionCode and ExchangeRateTypeCode elements. The ActionCode is a coded representation of an instruction to the recipient of a message telling it how to process a transmitted element. It is of type GDT:ActionCode. An ExchangeRateTypeCode is a coded representation of the type of an exchange rate. It is of type GDT:ExchangeRateTypeCode. The ExchangeRate is the representation of an exchange rate between two currencies, i.e., the relationship in which one currency can be exchanged for another currency. The ExchangeRate is of type GDT:ExchangeRate. CashDiscountTerms are an agreement of cash discounts for a payment. The PaymentTerms is of type GDT:CashDiscountTerms.

A Condition package groups together the information about a special price made available through the TradePriceSpecificationContract. It includes the Condition and PriceSpecification entities. A Condition specifies that a good or service is available for a specific price or with a specific rebate. The Condition is of type IDT:TradePriceSpecificationContractCondition. Condition includes the ActionCode element. The ActionCode is a coded representation of an instruction to the recipient of a message telling it how to process a transmitted element. It is of type GDT:ActionCode. PriceSpecificationElement is the specification of a price, a discount, a surcharge, or a tax that depends on a combination of properties, and that is valid for a specific period of time. The PriceSpecification is of type GDT:PriceSpecificationElement. The condition can be specified as a fixed price for a given quantity, or as a rebate in percentage or as a price scale. For each step in the scale, a fixed price or a rebate can be given. A condition can be related to a single product or to a product group. The Product ID or the ProductGroup ID can be specified in the PropertyValuation structure. A price scale is a single Condition, but if the pricing is dependent on the validity period then each pricing period may have its own Condition.

### Message Data Type TradePriceSpecificationContractCancelRequestMessage

The message data type TradePriceSpecificationContractCancelMessage groups together the business information that is relevant for sending a business document in a message and the TradePriceSpecificationContractCancel object in the business document. It includes the following packages: BusinessDocumentMessageHeader and TradePriceSpecificationContractCancel.

Similar to the MessageHeader package in the TradePriceSpecificationContract, the TradePriceSpecificationContractCancel groups the information used to cancel a Trade Price Specification Contract. It includes the TradePriceSpecificationContractCancel entity. The TradePriceSpecificationContractCancel groups the header information of needed to cancel a Trade Price Specification Contract. The TradePriceSpecificationContractCancel is of type IDT:TradePriceSpecificationContractCancel. It includes the ExternalTradePriceSpecificationContractID element. This ID is the unique identifier specified by the vendor for the price specification contract. It is of type GDT :BusinessTransactionDocumentID.

### Message Data Type TradePriceSpecificationContractConfirmationMessage

The message data type TradePriceSpecificationContractConfirmationMessage includes the business information that is relevant for sending a business document in a message, the TradePriceSpecificationContractConfirmation included in the business document, and the information of the message log. It includes the MessageHeader, TradePriceSpecificationContract and Log packages. The TradePriceSpecificationContractConfirmation package groups the information used to identify a confirmed Trade Price Specification Contract. It has the TradePriceSpecificationContractConfirmation as a root node. It includes the TradePriceSpecificationContractConfirmation entity. A TradePriceSpecificationContractConfirmation groups together the header information of the Trade Price Specification Contract that is confirmed (e.g., IDs, ValidityPeriod). The TradePriceSpecificationContractConfirmation is of type IDT:TradePriceSpecificationContractConfirmation.

The TradePriceSpecificationContract includes the following elements: ExternalTradePriceSpecificationContractID, BrokerContractID, and ValidityPeriod. ExternalTradePriceSpecificationContractID is the unique identifier specified by the supplier for the price specification contract. and is of type GDT:BusinessTransactionDocumentID. PreviousExternalTradePriceSpecificationContractID is the ID of the former price specification contract before changes specified by the supplier and is of type GDT:BusinessTransactionDocumentID. BrokerContractID is the unique identifier specified by the buying group for the price specification contract and is of type GDT:BusinessTransactionDocumentID. ValidityPeriod is a period that is defined by two points in time. These points in time can be expressed in calendar days. ValidityPeriod includes a start and an end time-point. It is of type GDT:CLOSED_DatePeriod. A Log package groups the messages used for user interaction. It includes the Log entity. A log is a sequence of messages that result when an application executes a task. The entity Log is of type GDT: Log.

### TradingOrder Interfaces

A TradingOrder is in one aspect a request from an ordering party to trade (receive materials) with contractors (order recipients), where a sales area receives the order and becomes responsible for fulfilling the contract. In another aspect, a TradingOrder can also be a request or instruction from a purchasing organization to a vendor (external supplier) or a plant to deliver a certain quantity of material at a certain point in time. In addition a TradingOrder can also be a request which combines the selling as well as the buying view to support a typically Trade Scenario (Back to Back Scenario) where a trade organization becomes responsible for fulfilling the contract. A Commodity Management includes the activities of purchasing, selling, trading, logistic and financial planning and execution of Commodities. Commodities can include exchange-traded materials such as oil, wheat, aluminum and electricity. Companies who need a commodity management solution can include companies that handle commodities in procurement, companies selling commodities or companies trading commodities as such. Trading Order Processing can provide pure physical goods trading solutions, without the necessity for price risk management or to hedge pricing or market risk of the physical deal. ISV's can provide a best of breed risk management solution which can be incorporated in the Trading Order processing to close the gaps between the missing integration of physical and risk management. To provide a complete view on Commodity management, a solution that covers commodity financial derivatives and the underlying physical contracts and risk management as standard interface is needed to combine and share necessary data and information between different solutions.

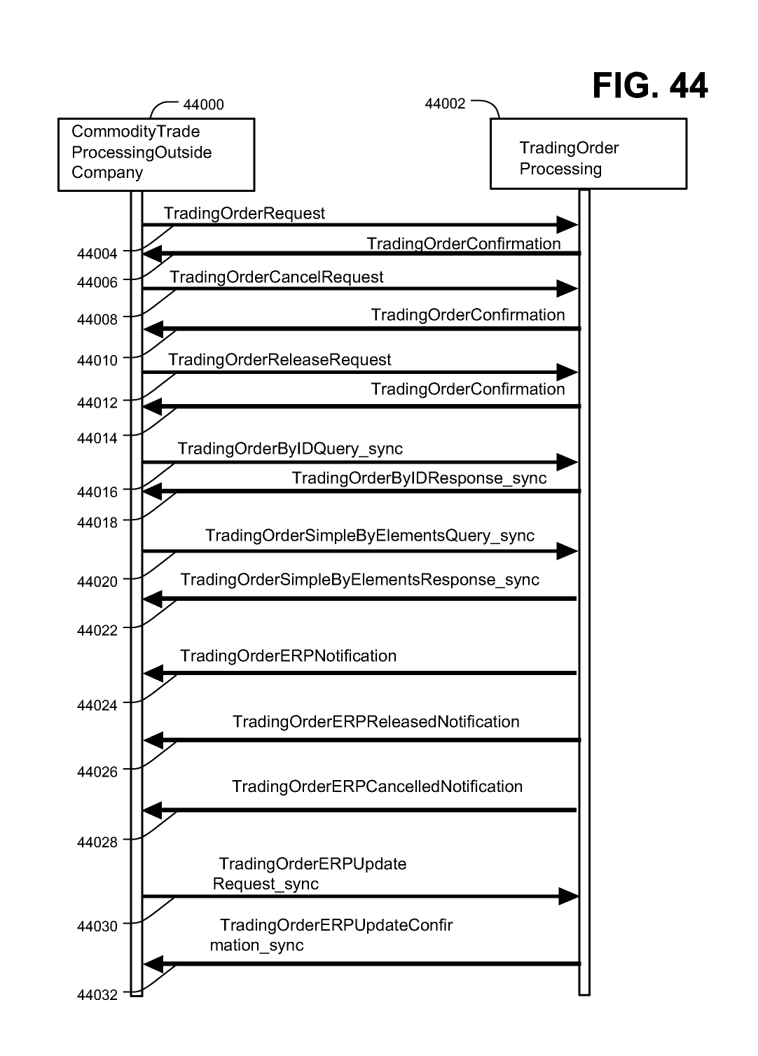

The message choreography of FIG. 44 describes a possible logical sequence of messages that can be used to realize a TradingOrder business scenario. A “CommodityTradeProcessingOutsideCompany” system 44000 can request a trading order using a TradingOrderRequest message 44004 as shown, for example, in FIG. 44. A “TradingOrderProcessing” system 44002 can confirm the request using a TradingOrderConfirmation message 44006 as shown, for example, in FIG. 44.

The “CommodityTradeProcessingOutsideCompany” system 44000 can cancel a trading order using a TradingOrderCancelRequest message 44008 as shown, for example, in FIG. 44. The “TradingOrderProcessing” system 44002 can confirm the request using a TradingOrderConfirmation message 44010 as shown, for example, in FIG. 44.

The “CommodityTradeProcessingOutsideCompany” system 44000 can release a trading order using a TradingOrderReleaseRequest message 44012 as shown, for example, in FIG. 44. The “TradingOrderProcessing” system 44002 can confirm the request using a TradingOrderConfirmation message 44014 as shown, for example, in FIG. 44.

The “CommodityTradeProcessingOutsideCompany” system 44000 can query a trading order by ID using a TradingOrderByIDQuery_sync message 44016 as shown, for example, in FIG. 44. The “TradingOrderProcessing” system 44002 can respond to the query using a TradingOrderByIDResponse_sync message 44018 as shown, for example, in FIG. 44.

The “CommodityTradeProcessingOutsideCompany” system 44000 can query a trading order by elements using a TradingOrderSimpleByElementsQuery_sync message 44020 as shown, for example, in FIG. 44. The “TradingOrderProcessing” system 44002 can respond to the query using a TradingOrderSimpleByElementsResponse_sync message 44022 as shown, for example, in FIG. 44.

The “CommodityTradeProcessingOutsideCompany” system 44000 can receive a trading order ERP notification from the “TradingOrderProcessing” system 44002 using a TradingOrderERPNotification message 44024 as shown, for example, in FIG. 44.

The “CommodityTradeProcessingOutsideCompany” system 44000 can receive a trading order ERP released notification from the “TradingOrderProcessing” system 44002 using a TradingOrderERPReleasedNotification message 44026 as shown, for example, in FIG. 44.

The “CommodityTradeProcessingOutsideCompany” system 44000 can receive a trading order ERP cancelled notification from the “TradingOrderProcessing” system 44002 using a TradingOrderERPCancelledNotification message 44028 as shown, for example, in FIG. 44.

The “CommodityTradeProcessingOutsideCompany” system 44000 can request a trading order ERP update using a TradingOrderERPUpdateRequest_sync message 44030 as shown, for example, in FIG. 44. The “TradingOrderProcessing” system 44002 can confirm the request using a TradingOrderERPUpdateConfirmation_sync message 44032 as shown, for example, in FIG. 44.

TradingOrder message types can include TradingOrderRequest, TradingOrderCancelRequest, TradingOrderReleaseRequest, TradingOrderConfirmation, TradingOrderByIDQuery_sync, TradingOrderByIDResponse_sync, TradingOrderSimpleByElementsQuery_sync, and TradingOrderSimpleByElementsResponse_sync. A TradingOrderRequest is a request sent from a CommodityTradeProcessingOutsideCompany to TradingOrderProcessing to create or change a trading order during a commodity trading process. Changing a trading order includes adding new items, changing existing items, and canceling items. The structure of the message type TradingOrderRequest can be specified by the message data type TradingOrderRequestMessage.

A TradingOrderCancelRequest is a request sent from a CommodityTradeProcessingOutsideCompany to TradingOrderProcessing to cancel the trading order. The structure of the message type TradingOrderCancelRequest can be specified by the message data type TradingOrderCancelRequestMessage. A TradingOrderReleaseRequest is a request sent from a CommodityTradeProcessingOutsideCompany to TradingOrderProcessing to release the trading order and create follow-up documents like sales order, purchase order, or both, in one step. The structure of the message type TradingOrderReleaseRequest can be specified by the message data type TradingOrderReleaseRequestMessage. A TradingOrderConfirmation is a confirmation to TradingOrderRequest or TradingOrderReleaseRequest or TradingOrderCancelRequest. The structure of the message type TradingOrderConfirmation can be specified by the message data type TradingOrderConfirmationMessage.

A TradingOrderByIDQuery_sync is an inquiry to the TradingOrderProcessing for a TradingOrder by the selection criteria TradingOrderID. The structure of the message type TradingOrderByIDQuery_sync can be specified by the message data type TradingOrderByIDQueryMessage_sync. A TradingOrderByIDResponse_sync is the response to TradingOrderByIDQuery. The structure of the message type TradingOrderByIDResponse_sync can be specified by the message data type TradingOrderByIDResponseMessage_sync. A TradingOrderSimpleByElementsQuery_sync is an inquiry to the TradingOrderProcessing to return TradingOrders fulfilling the selection TradingOrderSimpleSelectionByElements. The structure of the message type TradingOrderSimpleByElementsQuery_sync can be specified by the message data type TradingOrderSimpleByElementsQueryMessage_sync. A TradingOrderSimpleByElementsResponse_sync is the response to TradingOrderSimpleByElementsQuery_sync and includes basic data of TradingOrder. The structure of the message type TradingOrderSimpleByElementsResponse_sync can be specified by the message data type TradingOrderSimpleByElementsResponseMessage_sync.

The TradingOrder messages can be implemented by the following message interfaces: TradingOrderProcessing, TradingOrderRequest_In, TradingOrderReleaseRequest_In, TradingOrderCancelRequest_In, TradingOrderByIDQueryResponse_In, TradingOrderSimpleByElementsQueryResponse_In, and TradingOrderConfirmation_Out.

The TradingOrder interface performs various operations, namely a TradingOrderRequest_In, a TradingOrderCancelRequest_In, a TradingOrderReleaseRequest_In, a TradingOrderConfirmation_Out, a TradingOrderByIDQueryResponse_In, a TradingOrderSimpleByElementsQueryResponse_In, a TradingOrderNotification_Out, a TradingOrderReleasedNotification_Out, a TradingOrderCancelledNotification_Out and a TradingOrderERPUpdateRequestConfirmation_In.

The TradingOrderRequest is a request sent from a CommodityTradeProcessingOutsideCompany to TradingOrderProcessing to create or change a trading order during a commodity trading process. The TradingOrderRequest_In Operation can be used to create or change a trading order. This includes adding new items, changing existing items, and canceling items. The TradingOrderRequest_In operation includes a TradingOrderRequest message type. The structure of the TradingOrderRequest message type is specified by a TradingOrderRequestMessage message data type.

The TradingOrderCancelRequest is a request sent from a CommodityTradeProcessingOutsideCompany to TradingOrderProcessing to cancel the trading order. The TradingOrderCancelRequest_In Operation can be used to cancel a trading order. The TradingOrderCancelRequest_In operation includes a TradingOrderCancelRequest message type. The structure of the TradingOrderCancelRequest message type is specified by a TradingOrderCancelRequestMessage message data type.

The TradingOrderReleaseRequest is a request sent from a CommodityTradeProcessingOutsideCompany to TradingOrderProcessing to release the trading order and create follow-up documents like sales order, purchase order or both in one step. The TradingOrderReleaseRequest_In Operation can be used to release a trading order. The TradingOrderReleaseRequest_In operation includes a TradingOrderReleaseRequest message type. The structure of the TradingOrderReleaseRequest message type is specified by a TradingOrderReleaseRequestMessage message data type.

The TradingOrderConfirmation is a confirmation to TradingOrderRequest or TradingOrderReleaseRequest or TradingOrderCancelRequest. The TradingOrderConfirmation_Out Operation can be used to tell the result of each request to the requester after the requested execution. The TradingOrderConfirmation_Out operation includes a TradingOrderConfirmation message type. The structure of the TradingOrderConfirmation message type is specified by a TradingOrderConfirmationMessage message data type.

The TradingOrderByIDQuery_sync is an inquiry to the TradingOrderProcessing for a TradingOrder by the selection criteria TradingOrderID. A TradingOrderByIDResponse_sync is the response to TradingOrderByIDQuery. The TradingOrderByIDQueryResponse_In Operation can be used to get the data of a target Trading Order. The TradingOrderByIDQueryResponse_In operation includes various message types, namely a TradingOrderByIDQuery_sync and a TradingOrderByIDResponse_sync. The structure of the TradingOrderByIDQuery_sync message type is specified by a TradingOrderByIDQueryMessage_sync message data type. The structure of the TradingOrderByIDResponse_sync message type is specified by a TradingOrderByIDResponseMessage_sync message data type.

The TradingOrderSimpleByElementsQuery_sync is an inquiry to the TradingOrderProcessing to return TradingOrders fulfilling the selection TradingOrderSimpleSelectionByElements.A TradingOrderSimpleByElementsResponse_sync is the response to TradingOrderSimpleByElementsQuery_sync and contains basic data of TradingOrder. The TradingOrderSimpleByElementsQueryResponse_In Operation can be used to get the information of a target Trading Order. The TradingOrderSimpleByElementsQueryResponse_In operation includes various message types, namely a TradingOrderSimpleByElementsQuery_sync and a TradingOrderSimpleByElementsResponse_sync. The structure of the TradingOrderSimpleByElementsQuery_sync message type is specified by a TradingOrderSimpleByElementsQueryMessage_sync message data type. The structure of the TradingOrderSimpleByElementsResponse_sync message type is specified by a TradingOrderSimpleByElementsResponseMessage_sync message data type.

The TradingOrderERPNotification is a notification from the TradingOrderProcessing for a TradingOrder when the Trading Order is changed. The TradingOrderNotification_Out Operation can be used to notify changes of a target Trading Order. The TradingOrderNotification_Out operation includes a TradingOrderERPNotification message type. The structure of the TradingOrderERPNotification message type is specified by a TradingOrderERPNotificationMessage message data type.

The TradingOrderERPReleasedNotification is a notification from the TradingOrderProcessing for a TradingOrder when the Trading Order is released. The TradingOrderNotification_Out operation can be used to notify the release information of a target Trading Order. The TradingOrderReleasedNotification_Out operation includes a TradingOrderERPReleasedNotification message type. The structure of the TradingOrderERPReleasedNotification message type is specified by a TradingOrderERPReleasedNotificationMessage message data type.

The TradingOrderERPCancelledNotification is a notification from the TradingOrderProcessing for a TradingOrder when the Trading Order is cancelled. The TradingOrderCancelledNotification_Out operation can be used to notify the cancel information of a target Trading Order. The TradingOrderCancelledNotification_Out operation includes a TradingOrderERPCancelledNotification message type. The structure of the TradingOrderERPCancelledNotification message type is specified by a TradingOrderERPCancelledNotificationMessage message data type.

The TradingOrderUpdateRequest is a request sent from a CommodityTradeProcessingOutsideCompany to TradingOrderProcessing to update a TradingOrder during a commodity trading process. The TradingOrderERPUpdateRequestConfirmation_In Operation can be used to update a trading order, including adding new items, changing existing items, and canceling items. The TradingOrderUpdateConfirmation is a confirmation to TradingOrderUpdateRequest. The TradingOrderERPUpdateRequestConfirmation_In Operation can be used to tell the result of each update request to the requester after the requested execution. The TradingOrderERPUpdateRequestConfirmation_In operation includes various message types, namely a TradingOrderERPUpdateRequest_sync and a TradingOrderERPUpdateConfirmation_sync. The structure of the TradingOrderERPUpdateRequest_sync message type is specified by a TradingOrderERPUpdateRequestMessage_sync message data type. The structure of the TradingOrderERPUpdateConfirmation_sync message type is specified by a TradingOrderERPUpdateConfirmationMessage_sync message data type.

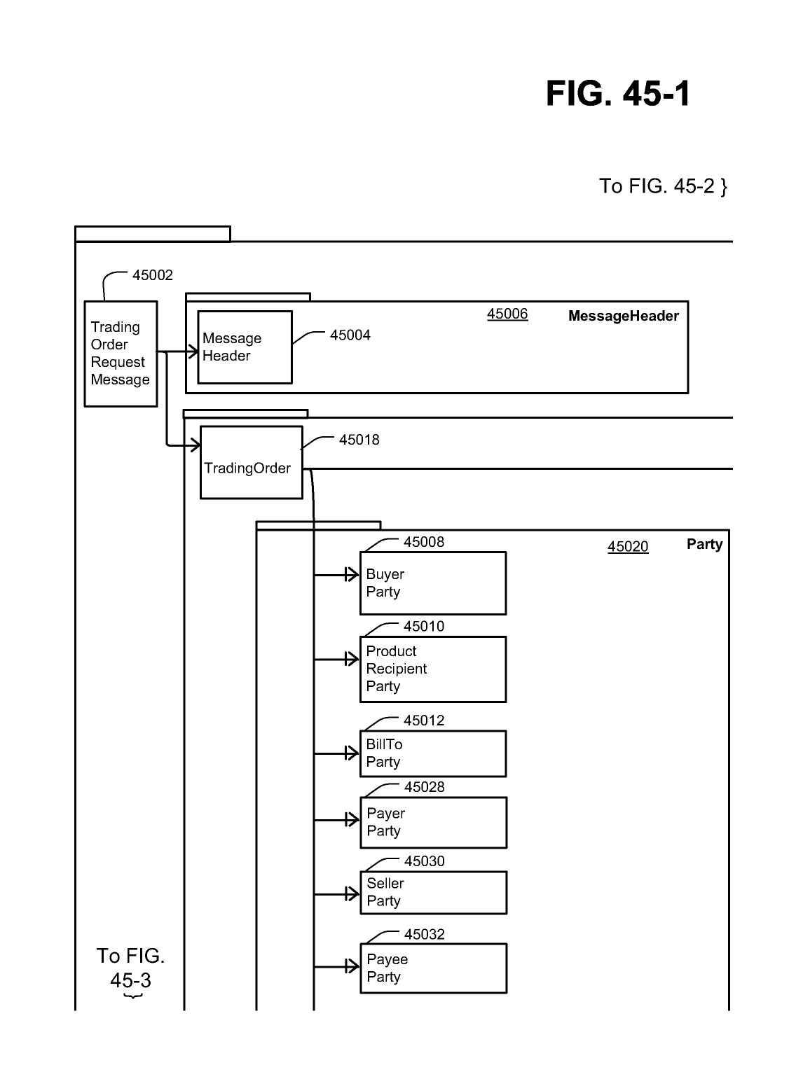

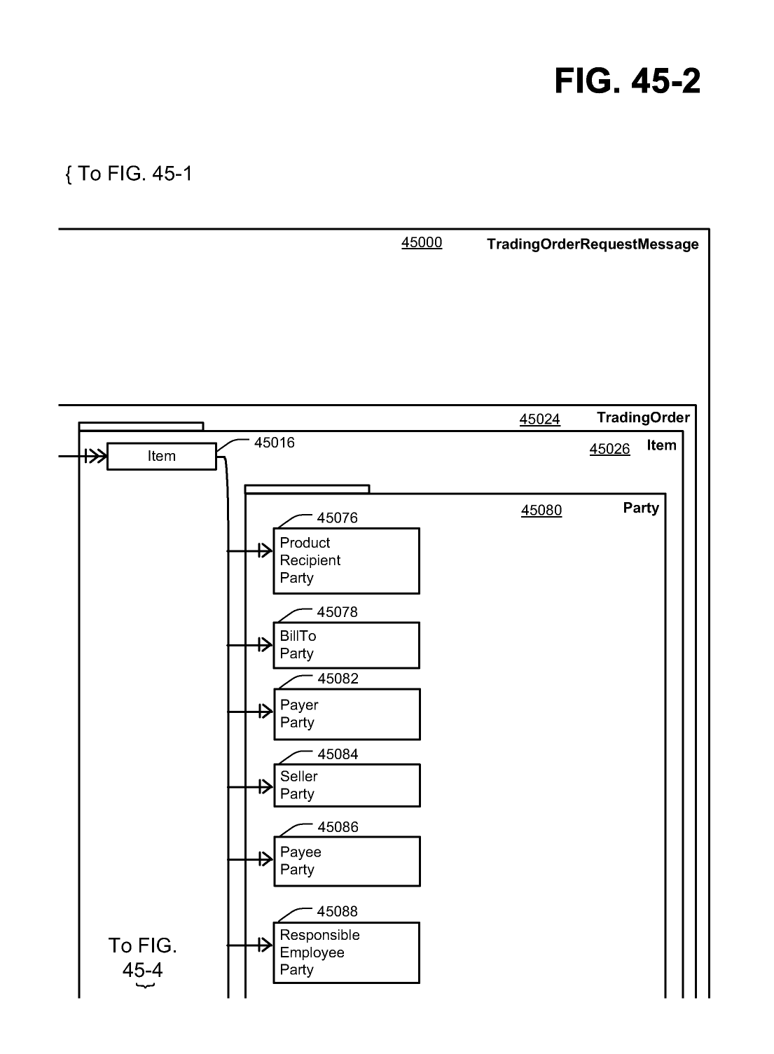

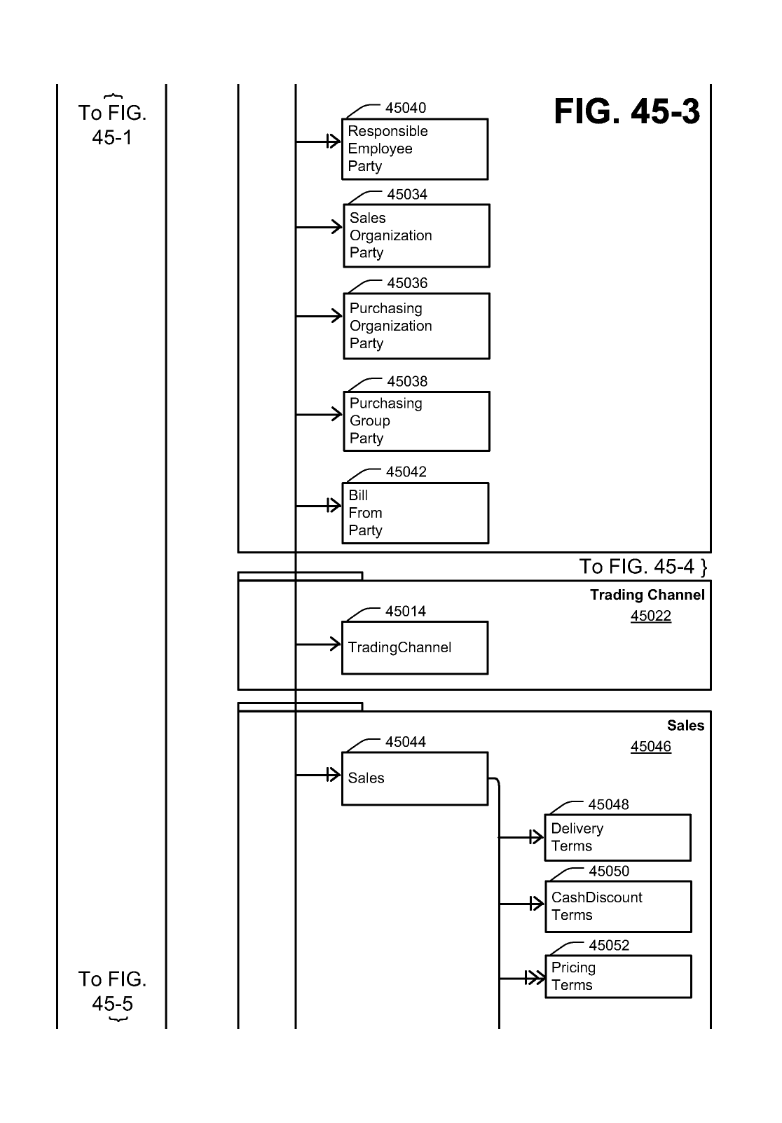

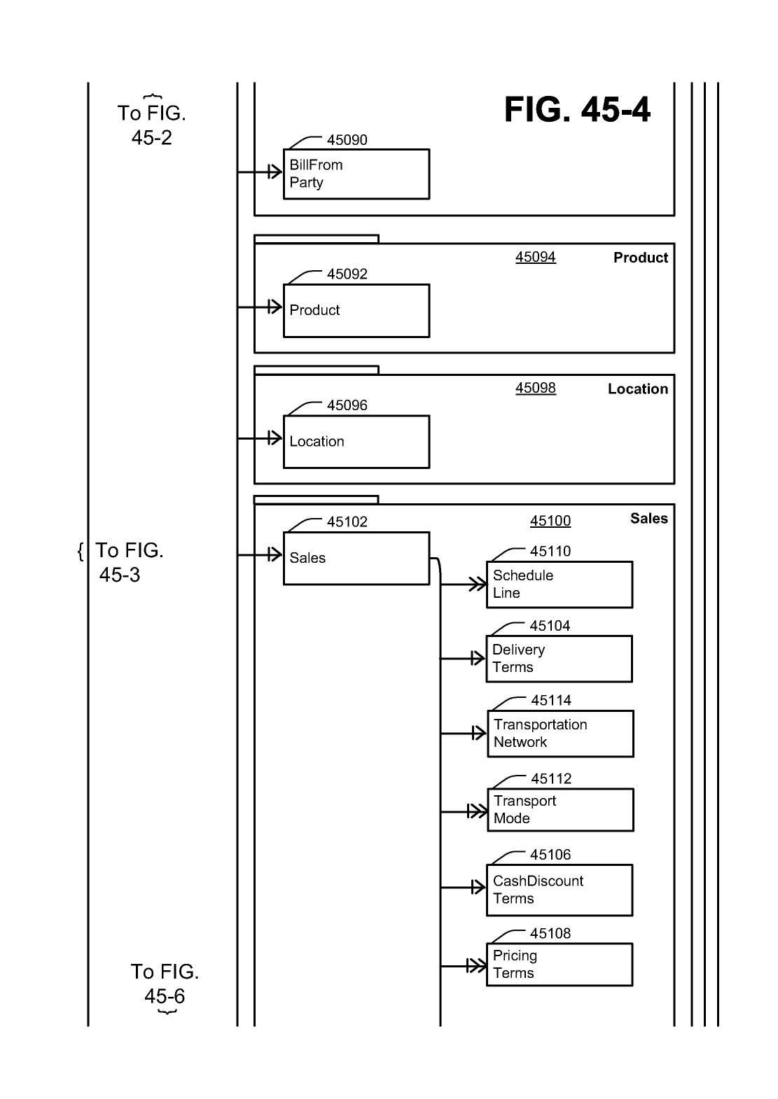

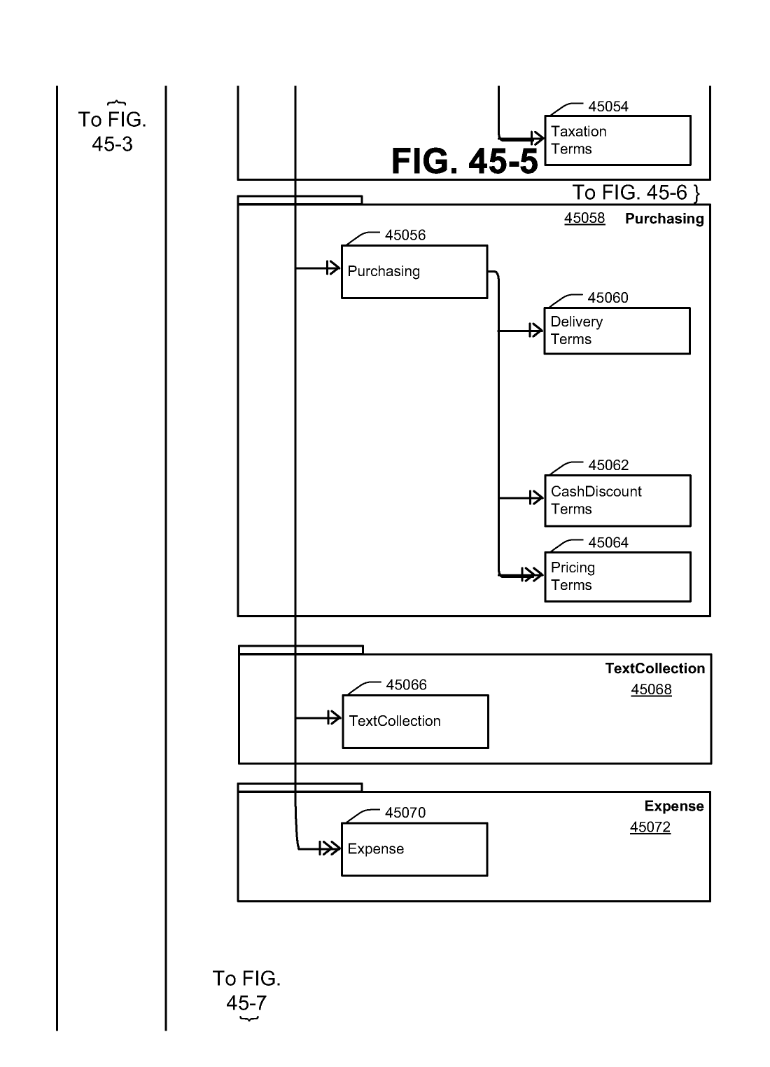

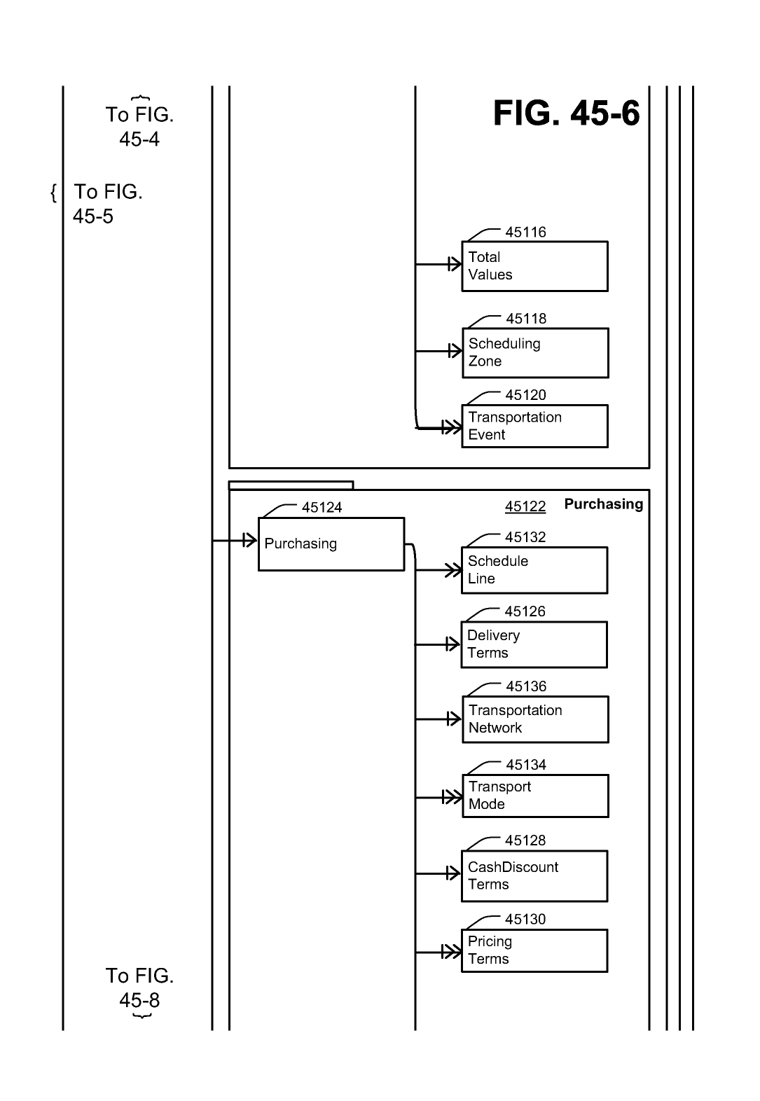

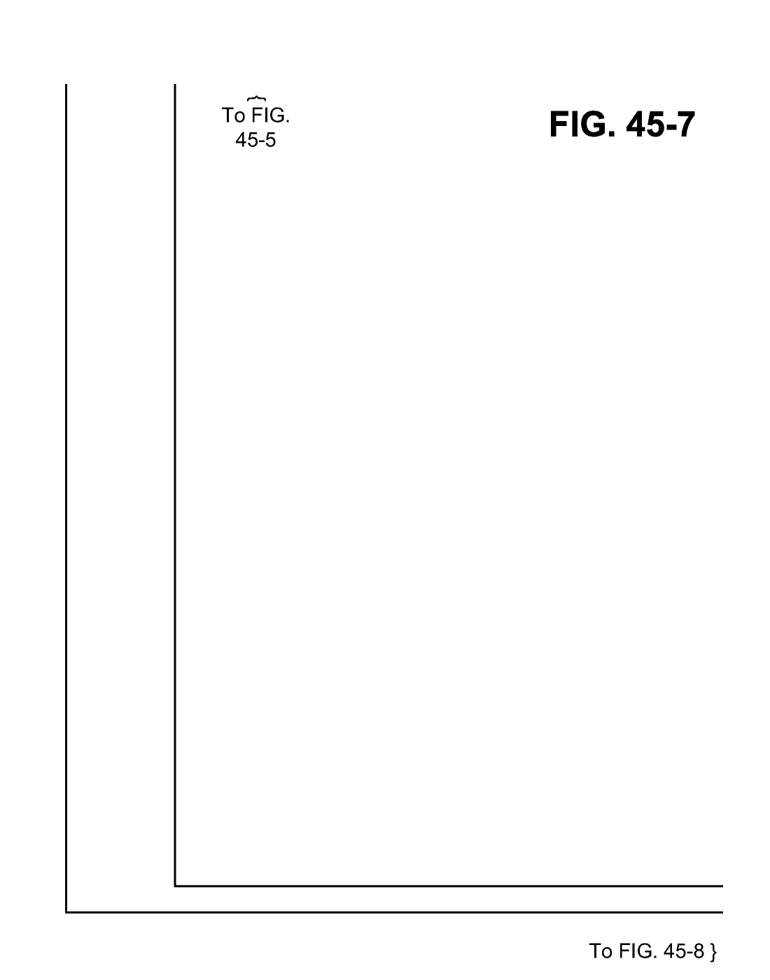

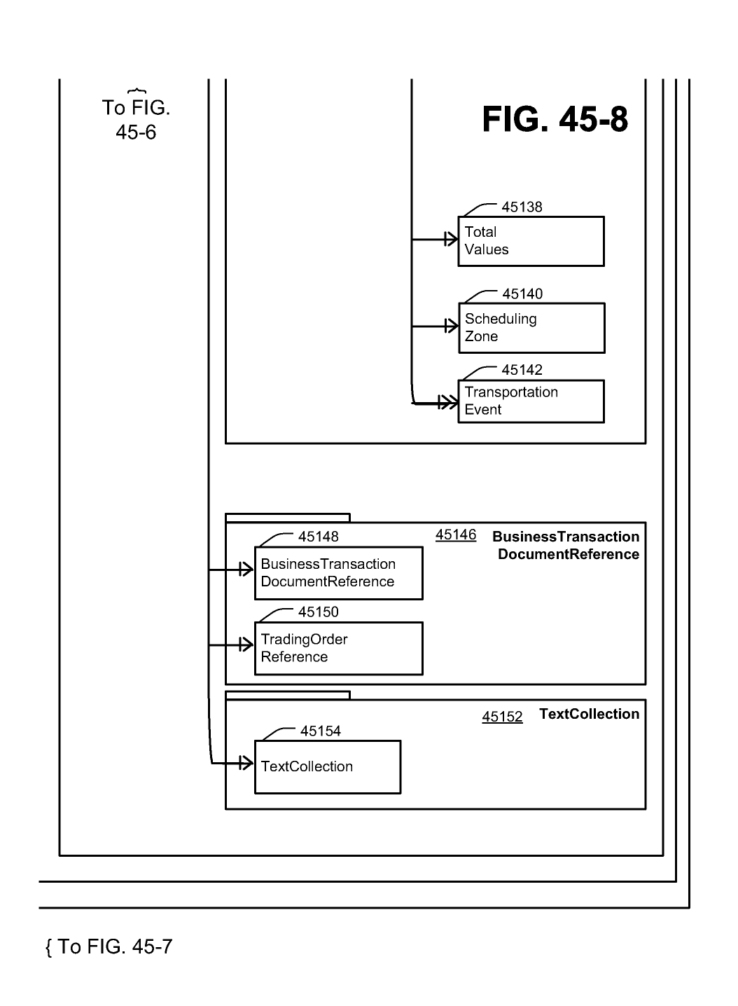

FIGS. 45-1 to 45-8 illustrate one example logical configuration of TradingOrderRequestMessage message 45000. Specifically, these figures depict the arrangement and hierarchy of various components such as one or more levels of packages, entities, and datatypes, shown here as 45000 through 45154. As described above, packages may be used to represent hierarchy levels. Entities are discrete business elements that are used during a business transaction. Data types are used to type object entities and interfaces with a structure. For example, TradingOrderRequestMessage message 45000 includes, among other things, TradingOrder 45024. Accordingly, heterogeneous applications may communicate using this consistent message configured as such.

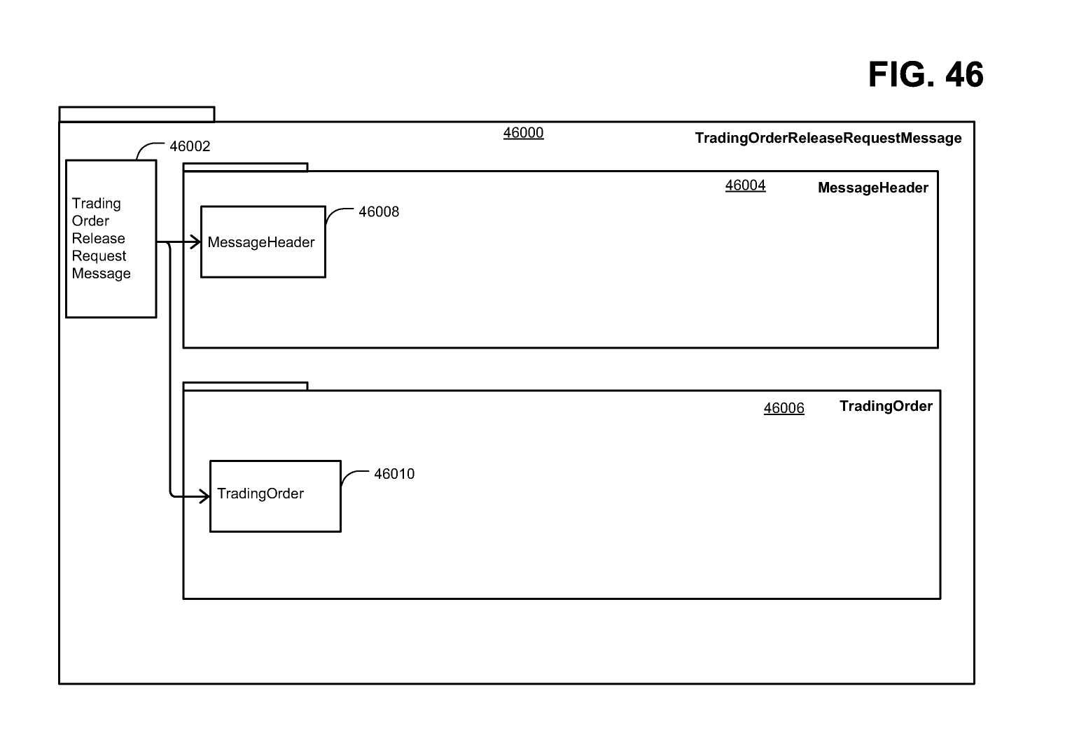

Additionally, FIG. 46 illustrates one example logical configuration of TradingOrderReleaseRequestMessage message 46000. Specifically, this figure depicts the arrangement and hierarchy of various components such as one or more levels of packages, entities, and datatypes, shown here as 46000 through 46010. As described above, packages may be used to represent hierarchy levels. Entities are discrete business elements that are used during a business transaction. Data types are used to type object entities and interfaces with a structure. For example, TradingOrderReleaseRequestMessage message 46000 includes, among other things, TradingOrder 46006. Accordingly, heterogeneous applications may communicate using this consistent message configured as such.

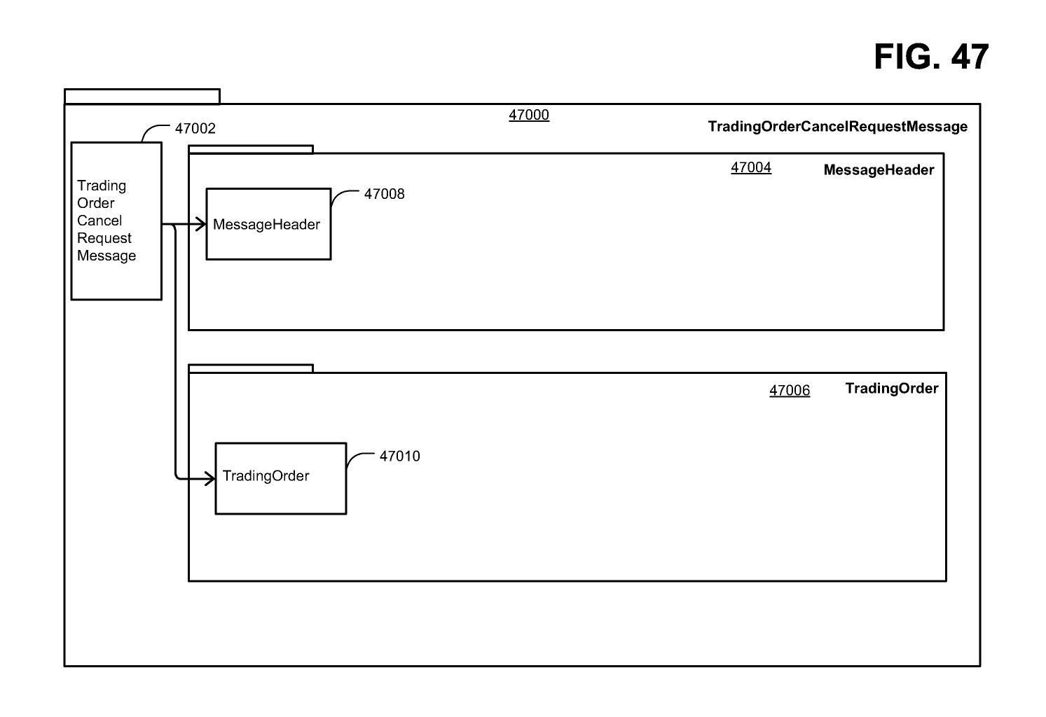

Additionally, FIG. 47 illustrates one example logical configuration of TradingOrderCancelRequestMessage message 47000. Specifically, this figure depicts the arrangement and hierarchy of various components such as one or more levels of packages, entities, and datatypes, shown here as 47000 through 47010. As described above, packages may be used to represent hierarchy levels. Entities are discrete business elements that are used during a business transaction. Data types are used to type object entities and interfaces with a structure. For example, TradingOrderCancelRequestMessage message 47000 includes, among other things, TradingOrder 47006. Accordingly, heterogeneous applications may communicate using this consistent message configured as such.

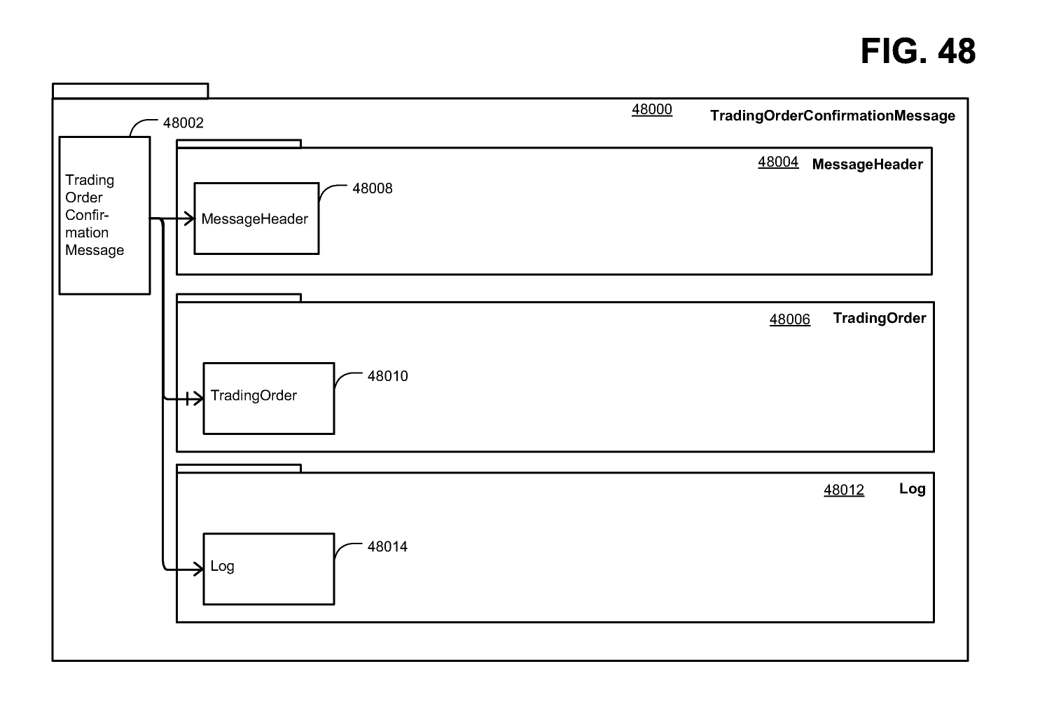

Additionally, FIG. 48 illustrates one example logical configuration of TradingOrderConfirmationMessage message 48000. Specifically, this figure depicts the arrangement and hierarchy of various components such as one or more levels of packages, entities, and datatypes, shown here as 48000 through 48014. As described above, packages may be used to represent hierarchy levels. Entities are discrete business elements that are used during a business transaction. Data types are used to type object entities and interfaces with a structure. For example, TradingOrderConfirmationMessage message 48000 includes, among other things, TradingOrder 48006. Accordingly, heterogeneous applications may communicate using this consistent message configured as such.

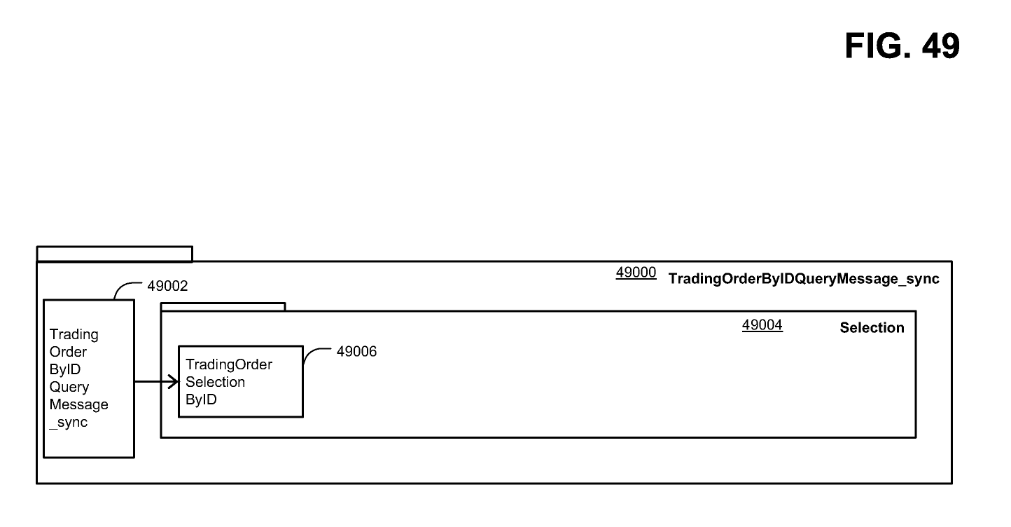

Additionally, FIG. 49 illustrates one example logical configuration of TradingOrderByIDQueryMessage message 49000. Specifically, this figure depicts the arrangement and hierarchy of various components such as one or more levels of packages, entities, and datatypes, shown here as 49000 through 49006. As described above, packages may be used to represent hierarchy levels. Entities are discrete business elements that are used during a business transaction. Data types are used to type object entities and interfaces with a structure. For example, TradingOrderByIDQueryMessage message 49000 includes, among other things, Selection 49004. Accordingly, heterogeneous applications may communicate using this consistent message configured as such.

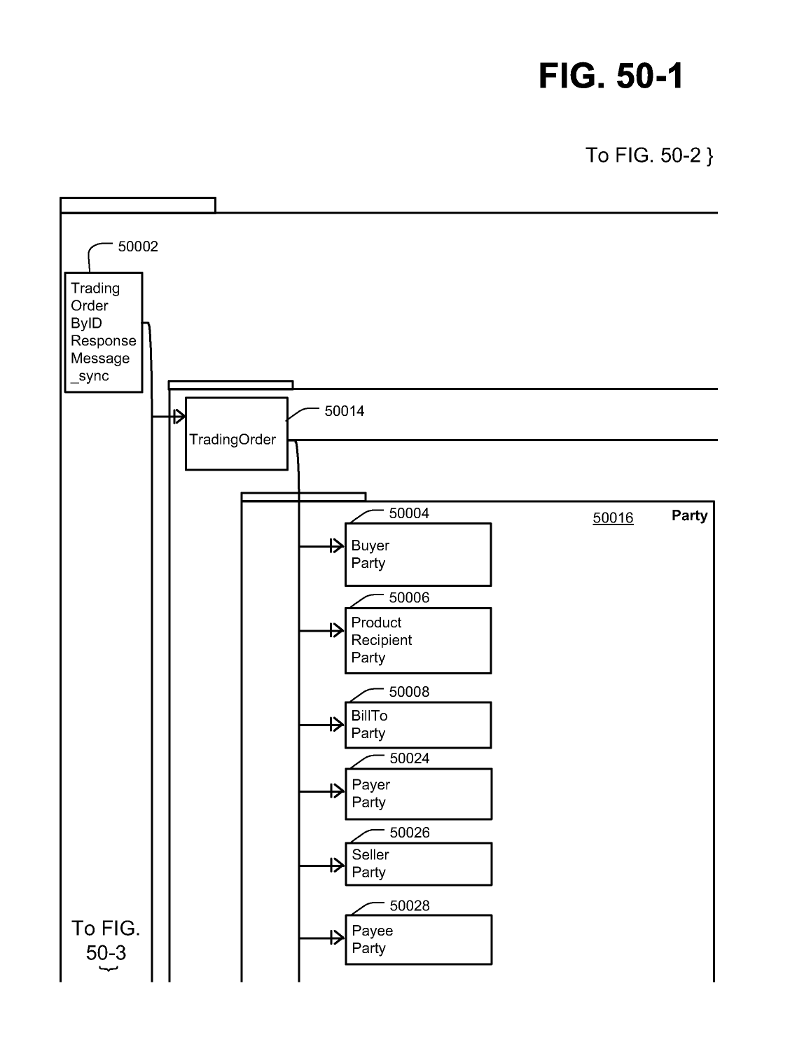

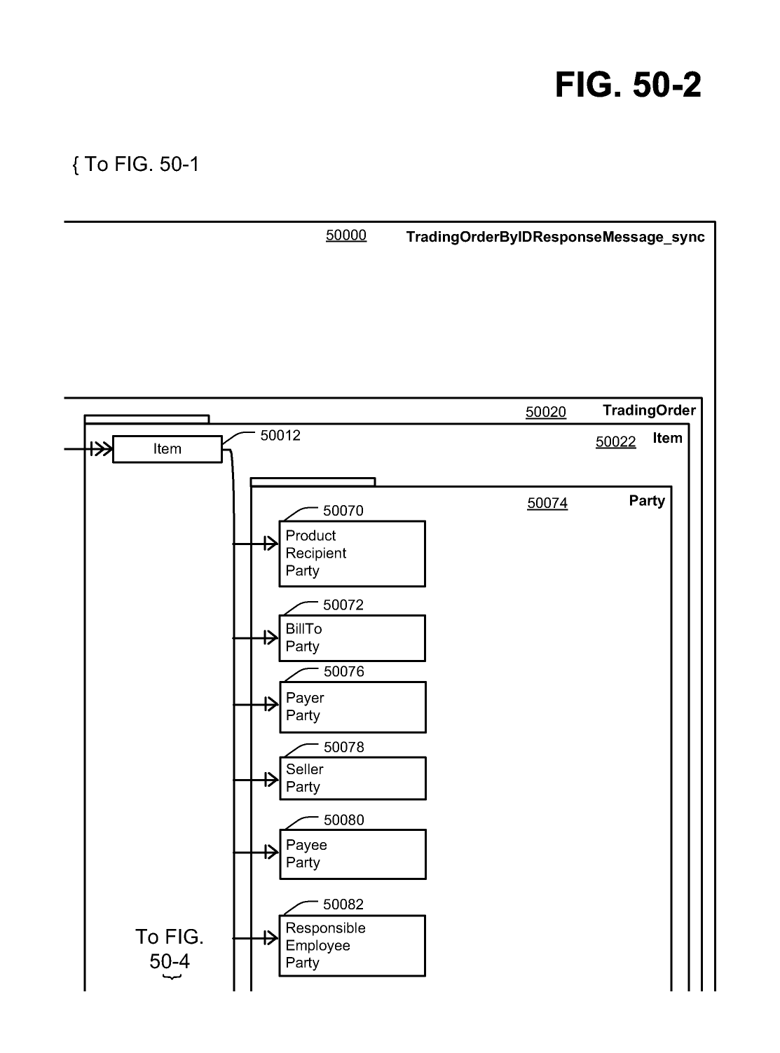

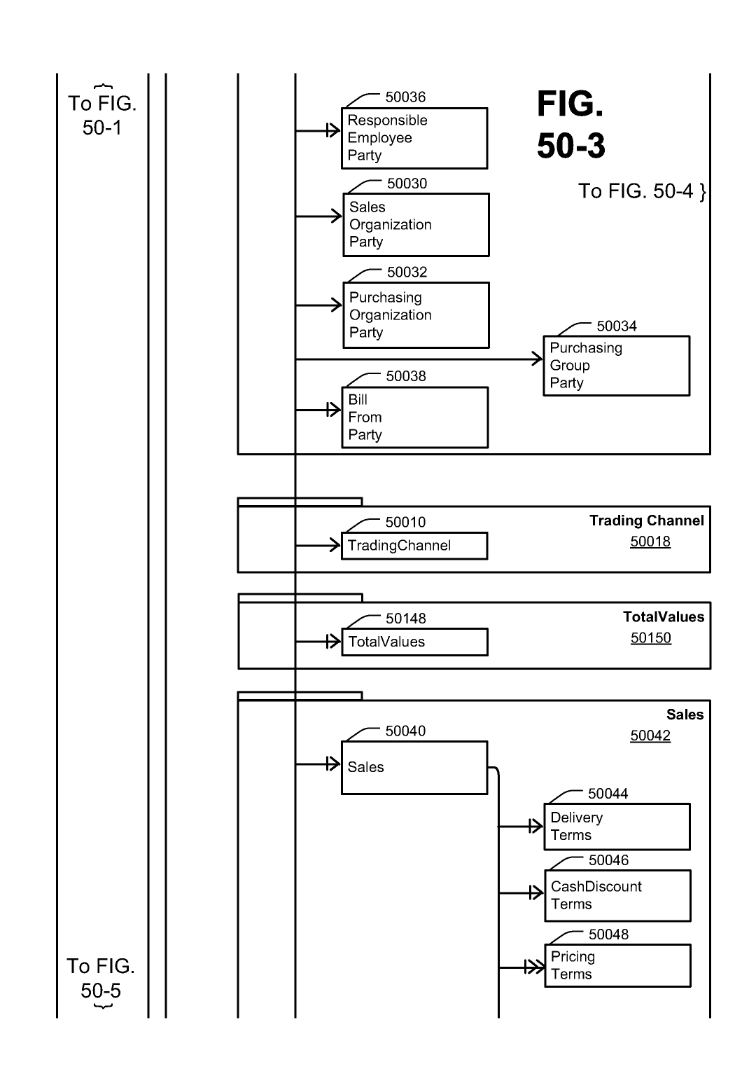

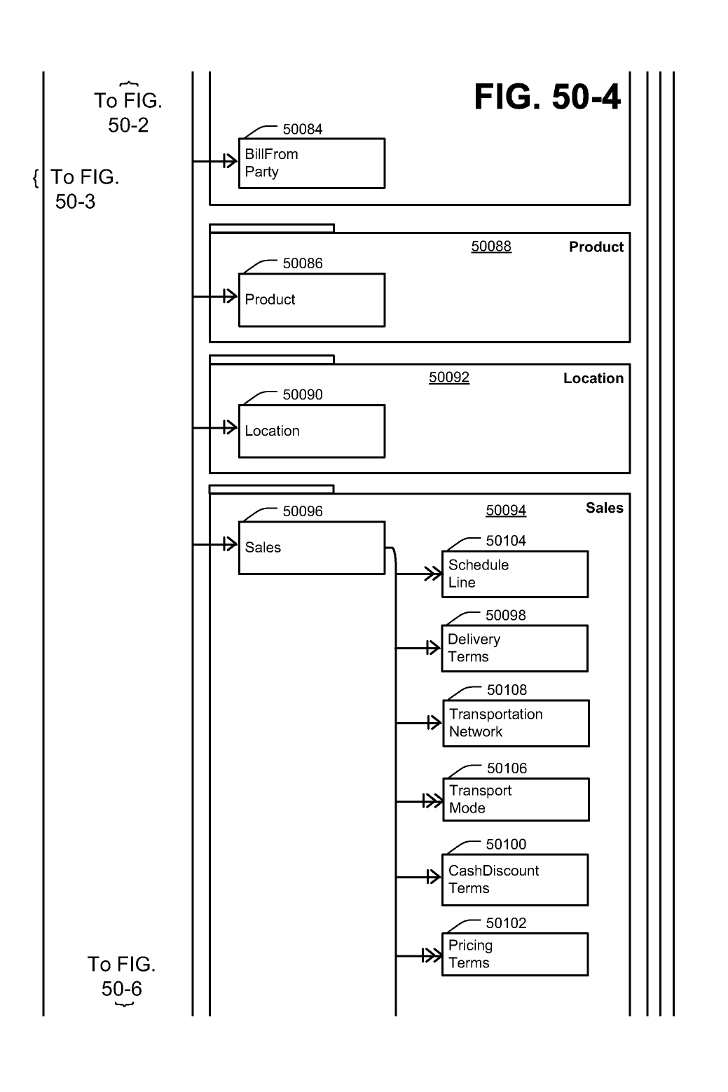

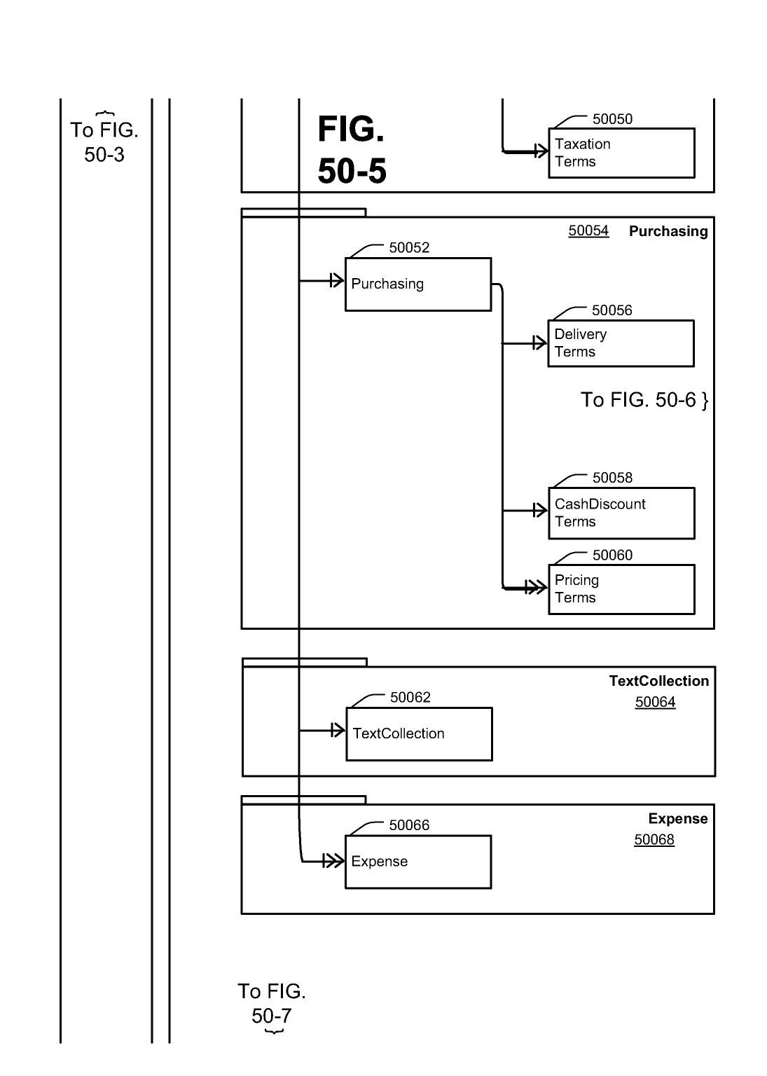

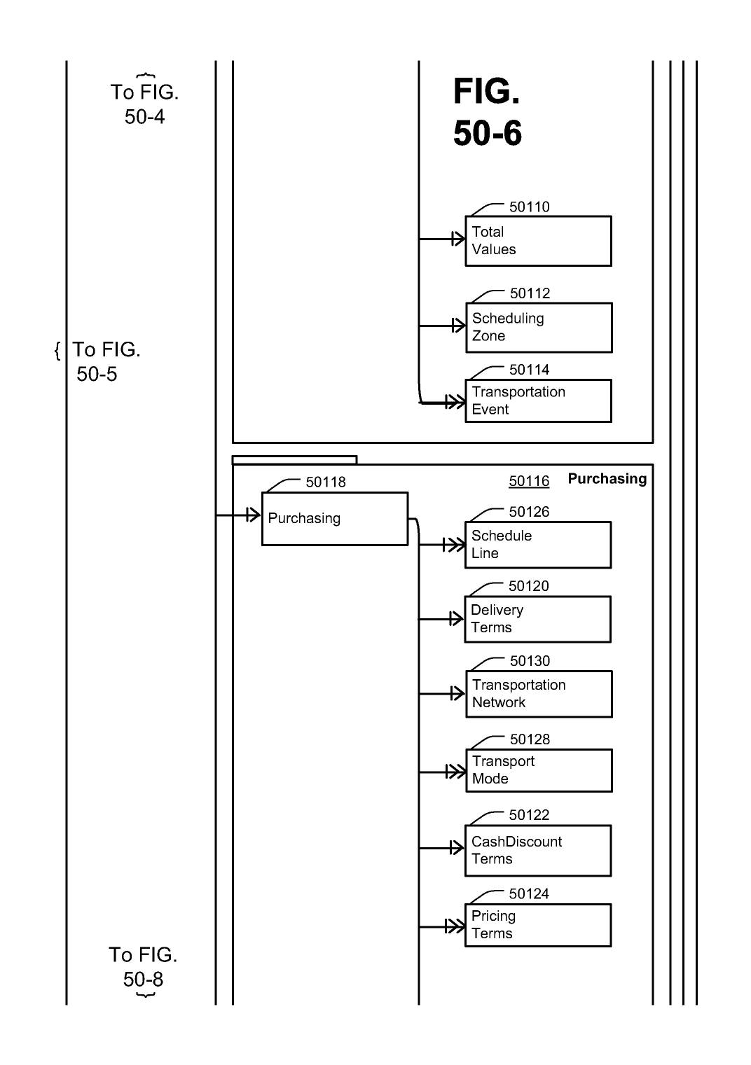

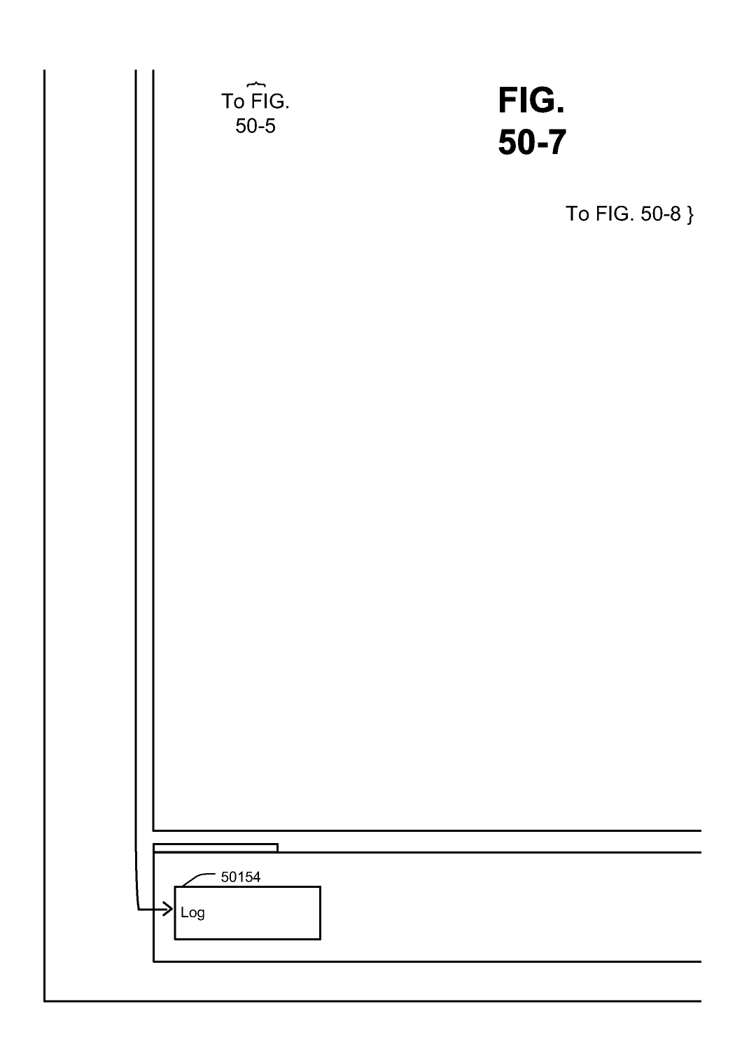

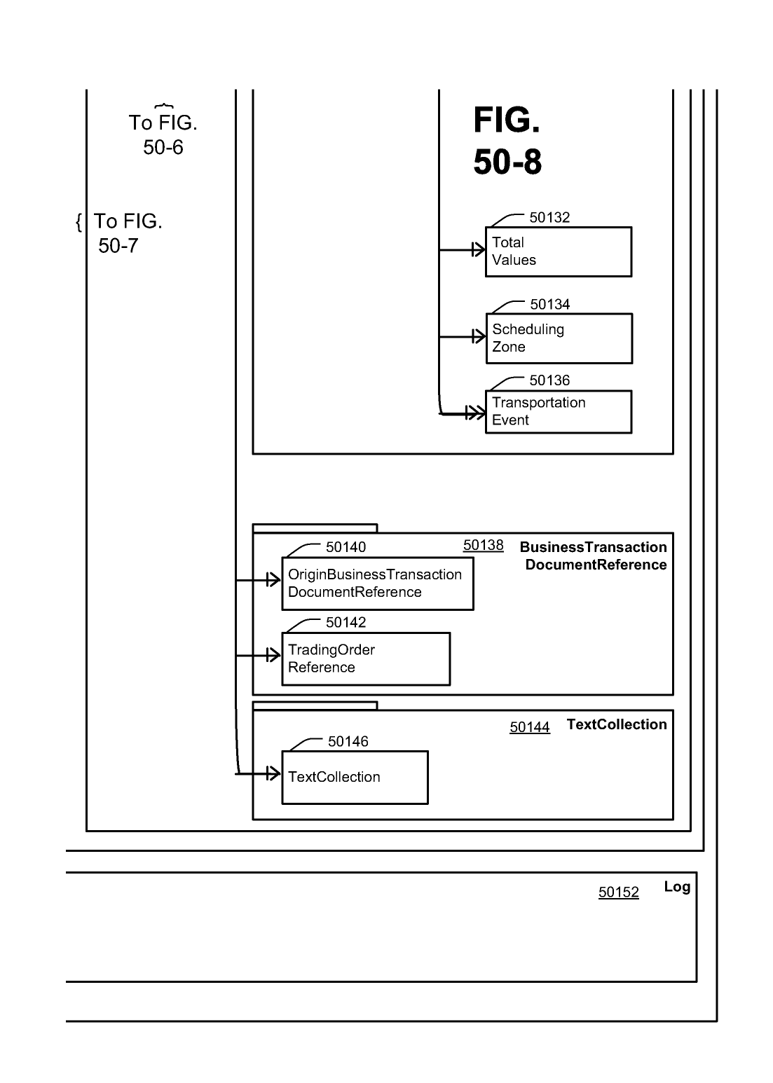

Additionally, FIGS. 50-1 to 50-8 illustrate one example logical configuration of TradingOrderByIDResponseMessage message 50000. Specifically, these figures depict the arrangement and hierarchy of various components such as one or more levels of packages, entities, and datatypes, shown here as 50000 through 50154. As described above, packages may be used to represent hierarchy levels. Entities are discrete business elements that are used during a business transaction. Data types are used to type object entities and interfaces with a structure. For example, TradingOrderByIDResponseMessage message 50000 includes, among other things, TradingOrder 50020. Accordingly, heterogeneous applications may communicate using this consistent message configured as such.

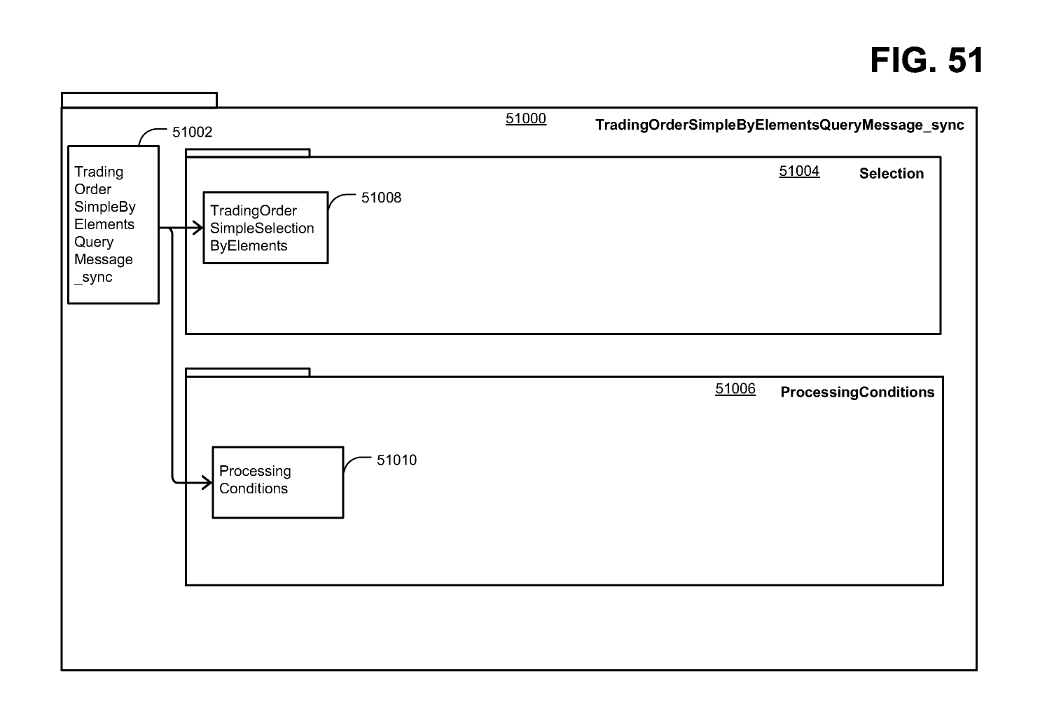

Additionally, FIG. 51 illustrates one example logical configuration of TradingOrderSimpleByElementsQueryMessage message 51000. Specifically, this figure depicts the arrangement and hierarchy of various components such as one or more levels of packages, entities, and datatypes, shown here as 51000 through 51010. As described above, packages may be used to represent hierarchy levels. Entities are discrete business elements that are used during a business transaction. Data types are used to type object entities and interfaces with a structure. For example, TradingOrderSimpleByElementsQueryMessage message 51000 includes, among other things, Selection 51004. Accordingly, heterogeneous applications may communicate using this consistent message configured as such.

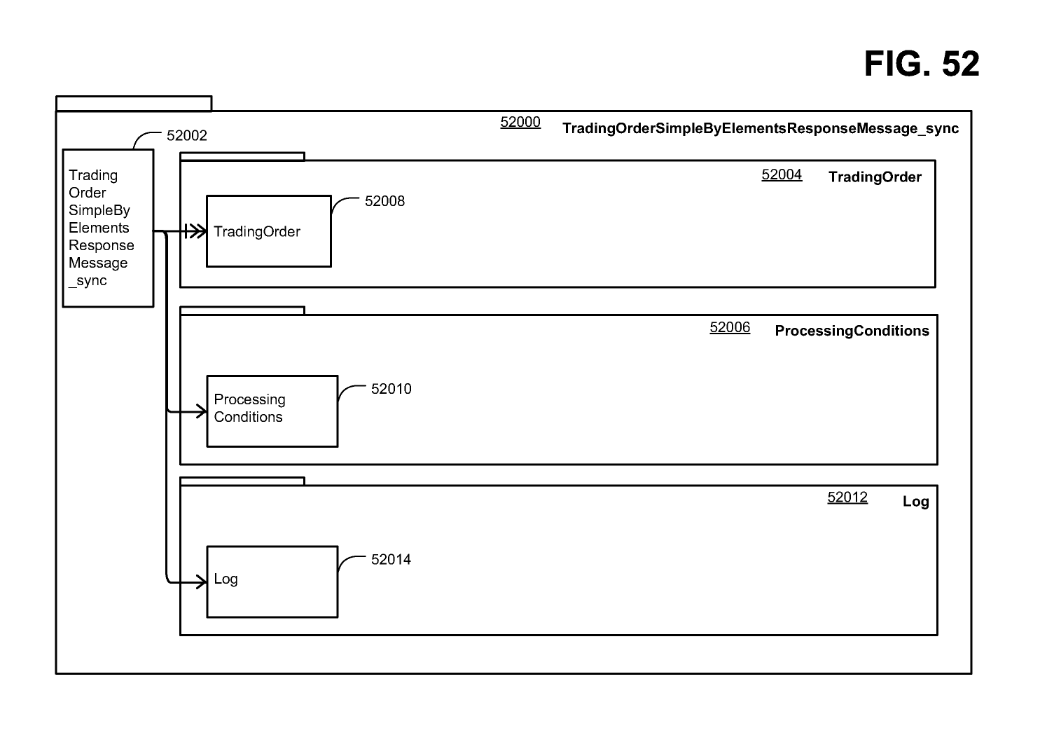

Additionally, FIG. 52 illustrates one example logical configuration of TradingOrderSimpleByElementsResponseMessage message 52000. Specifically, this figure depicts the arrangement and hierarchy of various components such as one or more levels of packages, entities, and datatypes, shown here as 52000 through 52014. As described above, packages may be used to represent hierarchy levels. Entities are discrete business elements that are used during a business transaction. Data types are used to type object entities and interfaces with a structure. For example, TradingOrderSimpleByElementsResponseMessage message 52000 includes, among other things, TradingOrder 52004. Accordingly, heterogeneous applications may communicate using this consistent message configured as such.

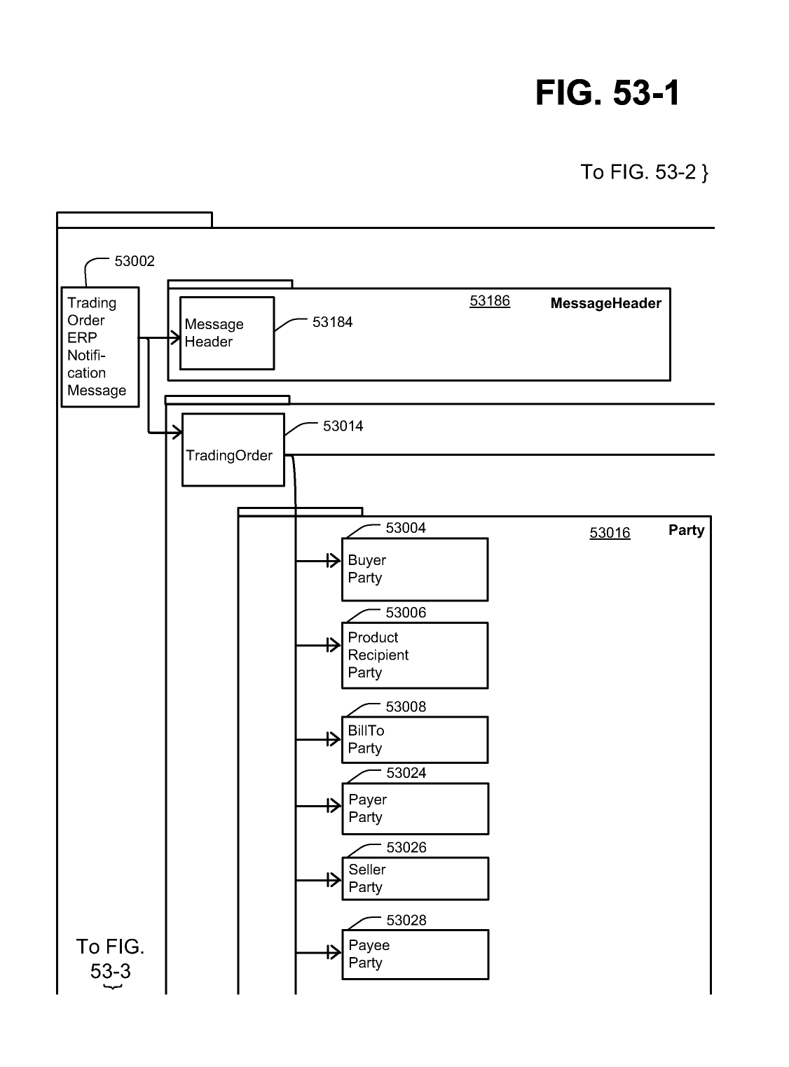

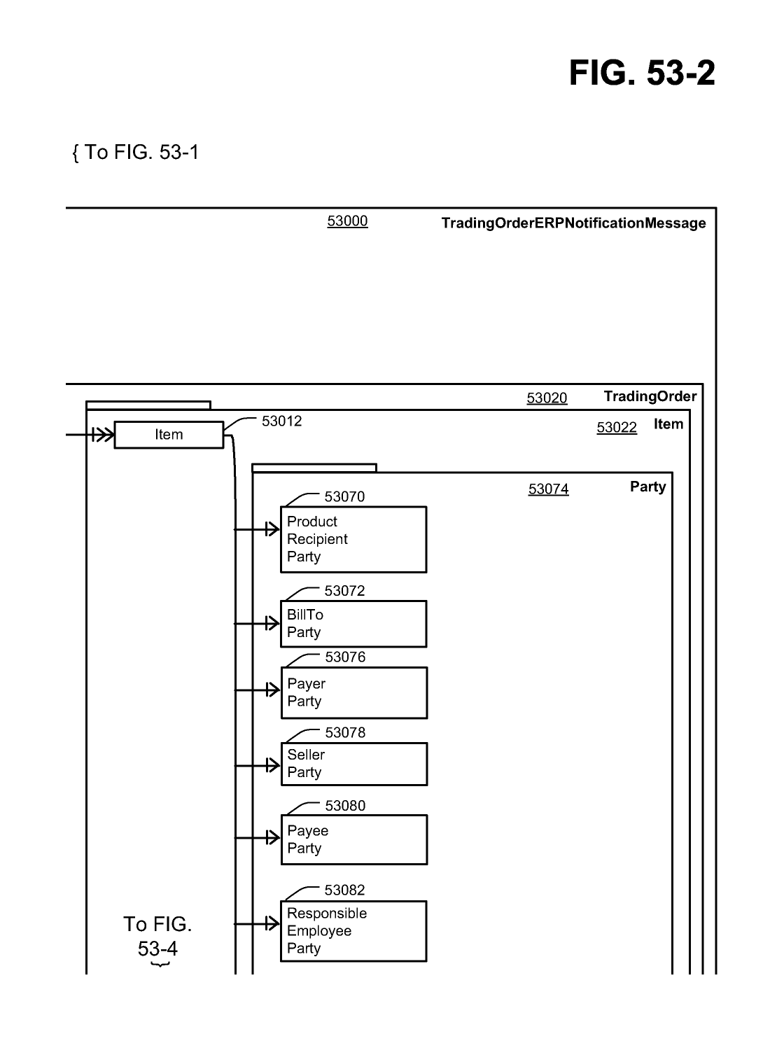

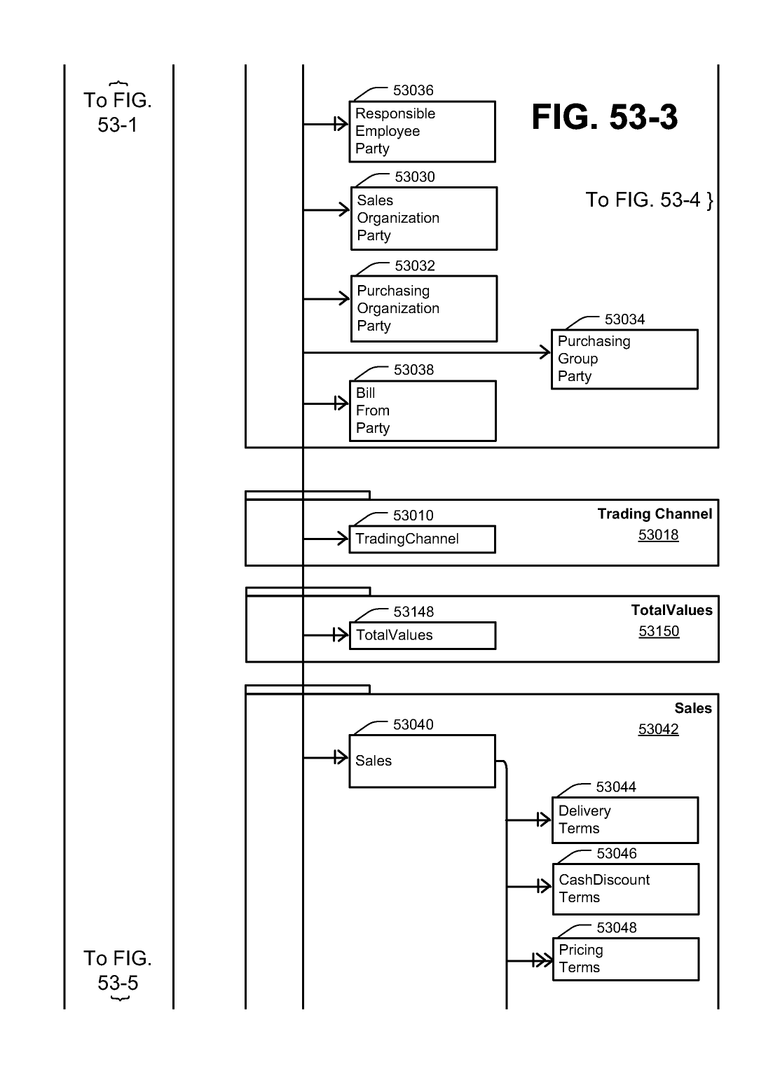

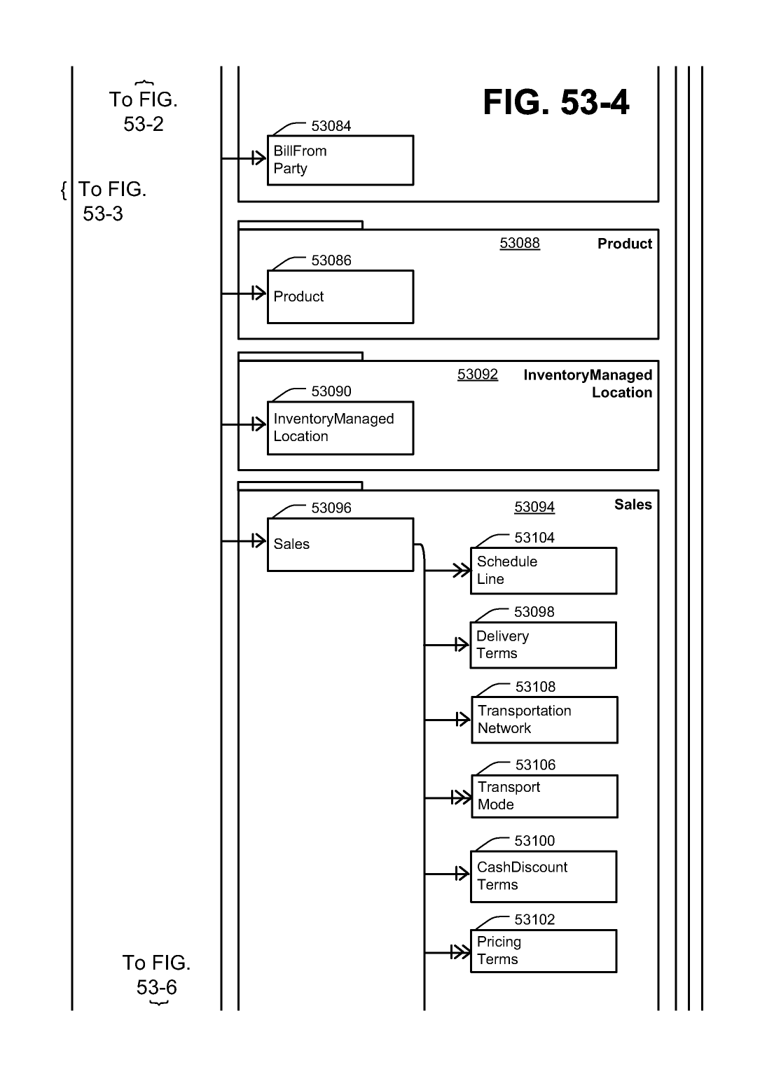

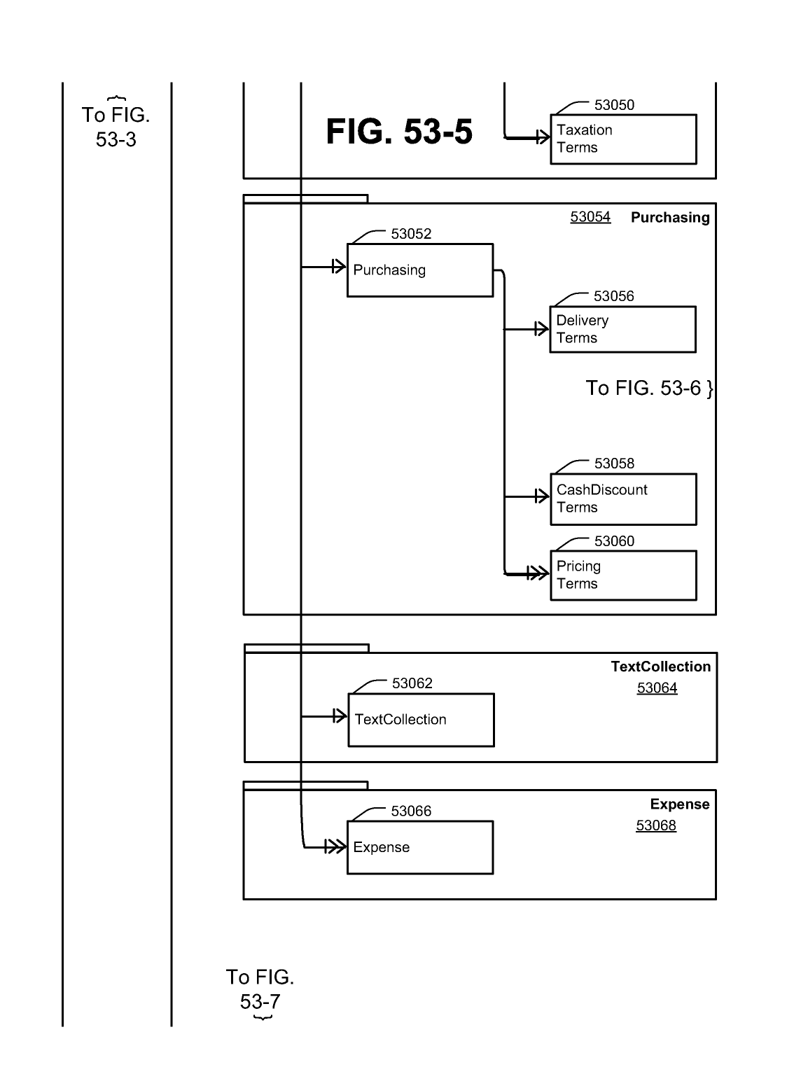

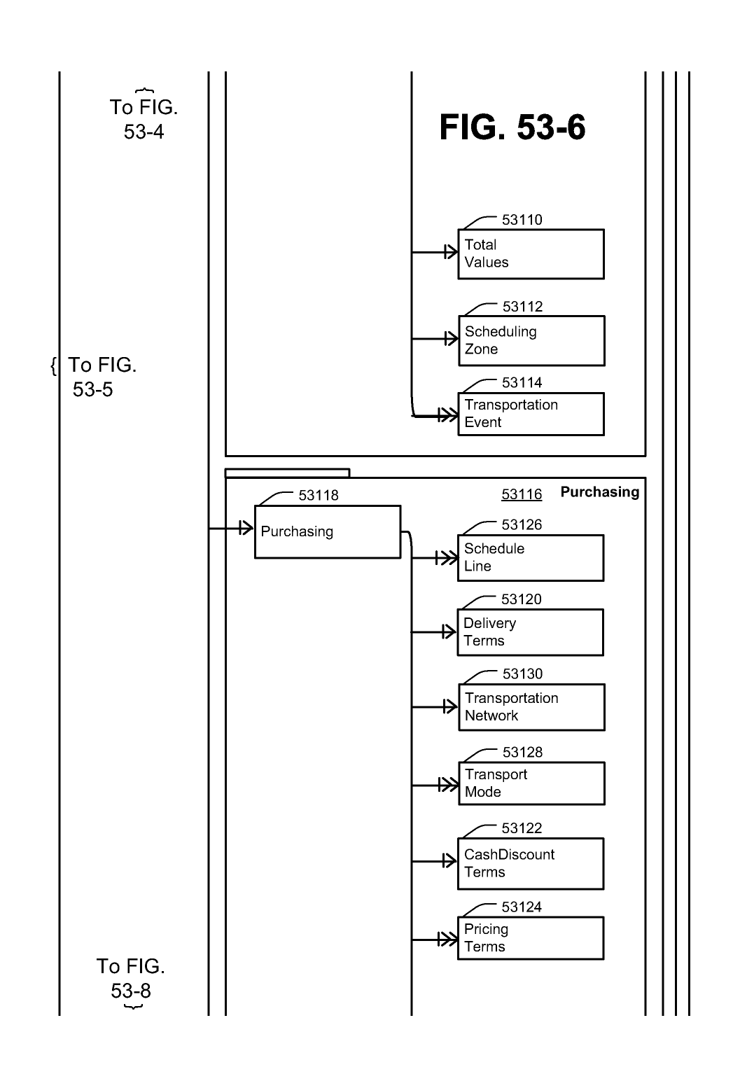

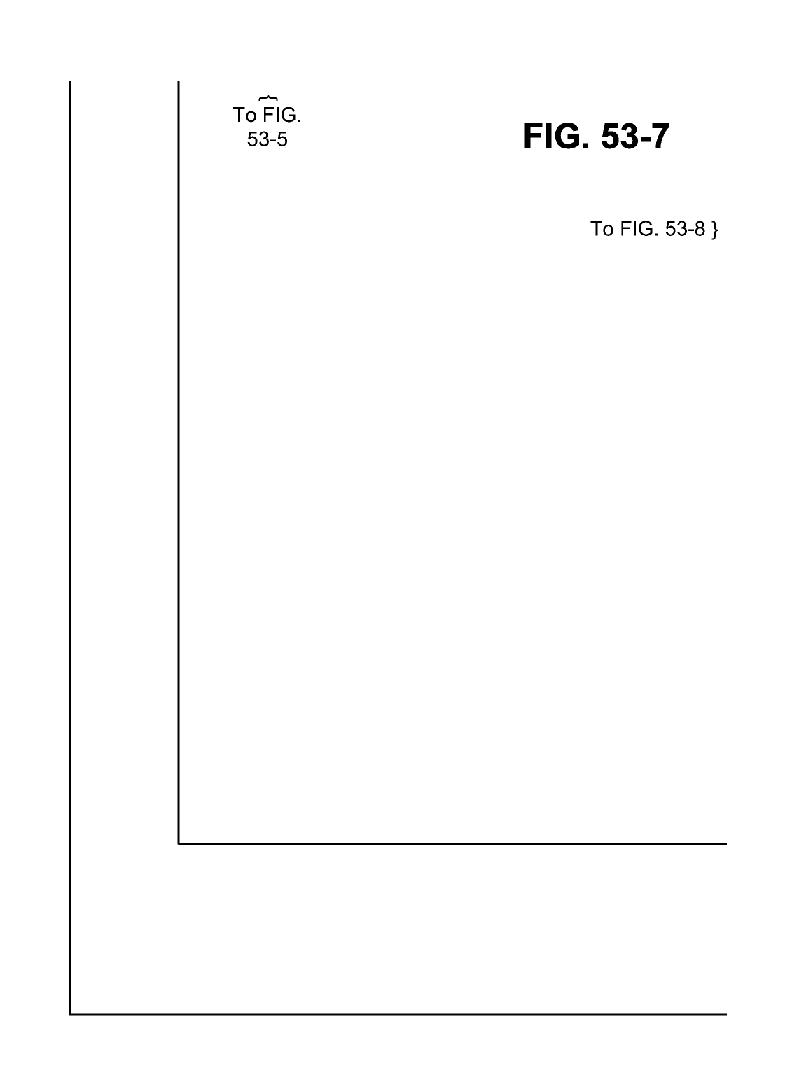

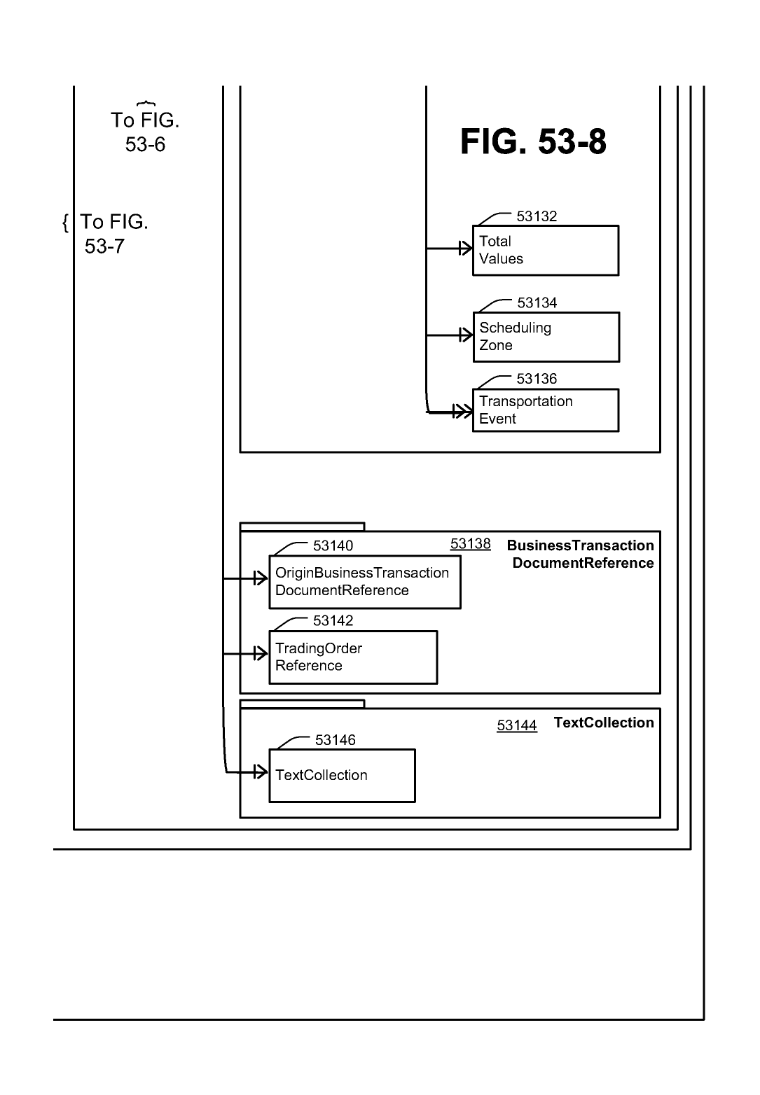

Additionally, FIGS. 53-1 to 53-8 illustrate one example logical configuration of TradingOrderERPNotificationMessage message 53000. Specifically, these figures depict the arrangement and hierarchy of various components such as one or more levels of packages, entities, and datatypes, shown here as 53000 through 53146. As described above, packages may be used to represent hierarchy levels. Entities are discrete business elements that are used during a business transaction. Data types are used to type object entities and interfaces with a structure. For example, TradingOrderERPNotificationMessage message 53000 includes, among other things, TradingOrder 53020. Accordingly, heterogeneous applications may communicate using this consistent message configured as such.

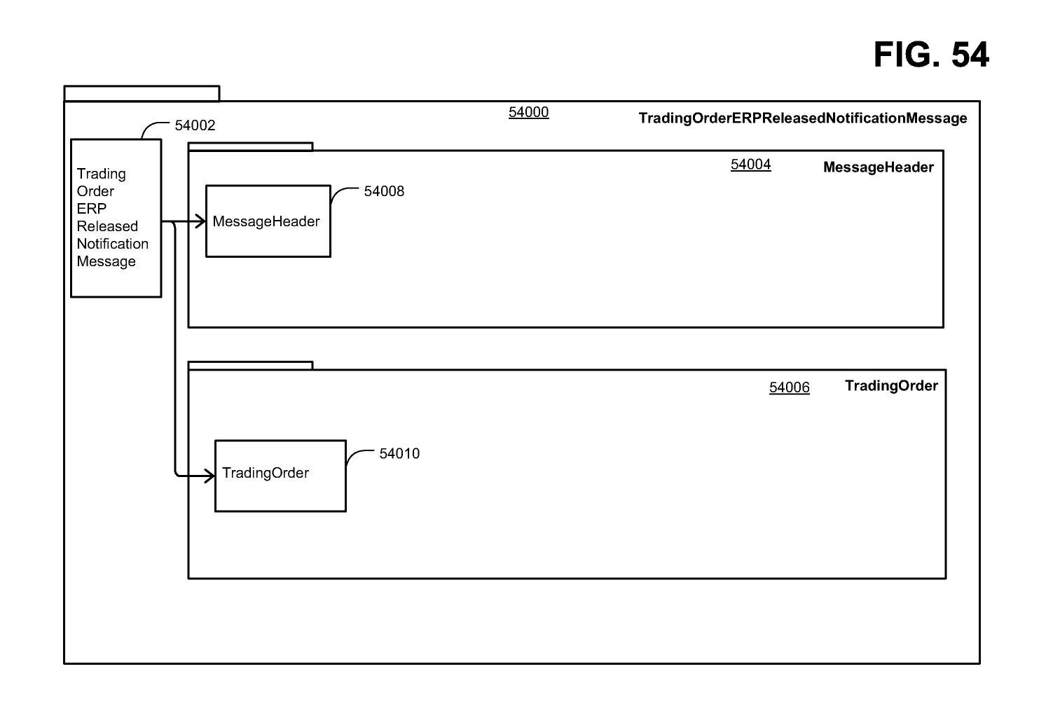

Additionally, FIG. 54 illustrates one example logical configuration of TradingOrderERPReleasedNotificationMessage message 54000. Specifically, this figure depicts the arrangement and hierarchy of various components such as one or more levels of packages, entities, and datatypes, shown here as 54000 through 54010. As described above, packages may be used to represent hierarchy levels. Entities are discrete business elements that are used during a business transaction. Data types are used to type object entities and interfaces with a structure. For example, TradingOrderERPReleasedNotificationMessage message 54000 includes, among other things, TradingOrder 54006. Accordingly, heterogeneous applications may communicate using this consistent message configured as such.

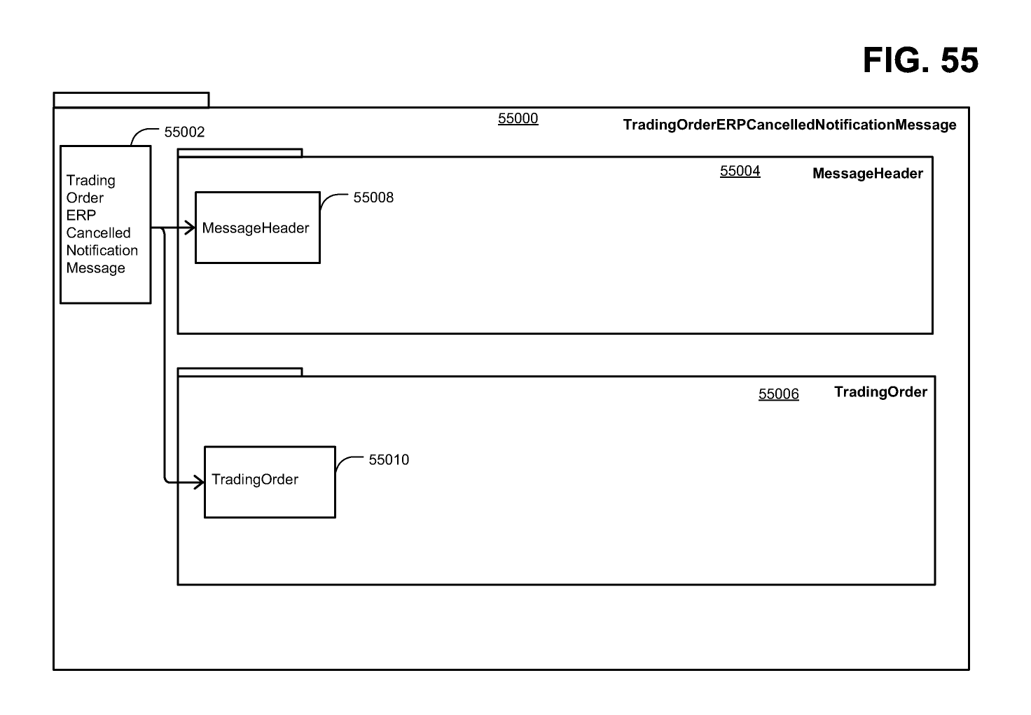

Additionally, FIG. 55 illustrates one example logical configuration of TradingOrderERPCancelledNotificationMessage message 55000. Specifically, this figure depicts the arrangement and hierarchy of various components such as one or more levels of packages, entities, and datatypes, shown here as 55000 through 55010. As described above, packages may be used to represent hierarchy levels. Entities are discrete business elements that are used during a business transaction. Data types are used to type object entities and interfaces with a structure. For example, TradingOrderERPCancelledNotificationMessage message 55000 includes, among other things, TradingOrder 55006. Accordingly, heterogeneous applications may communicate using this consistent message configured as such.

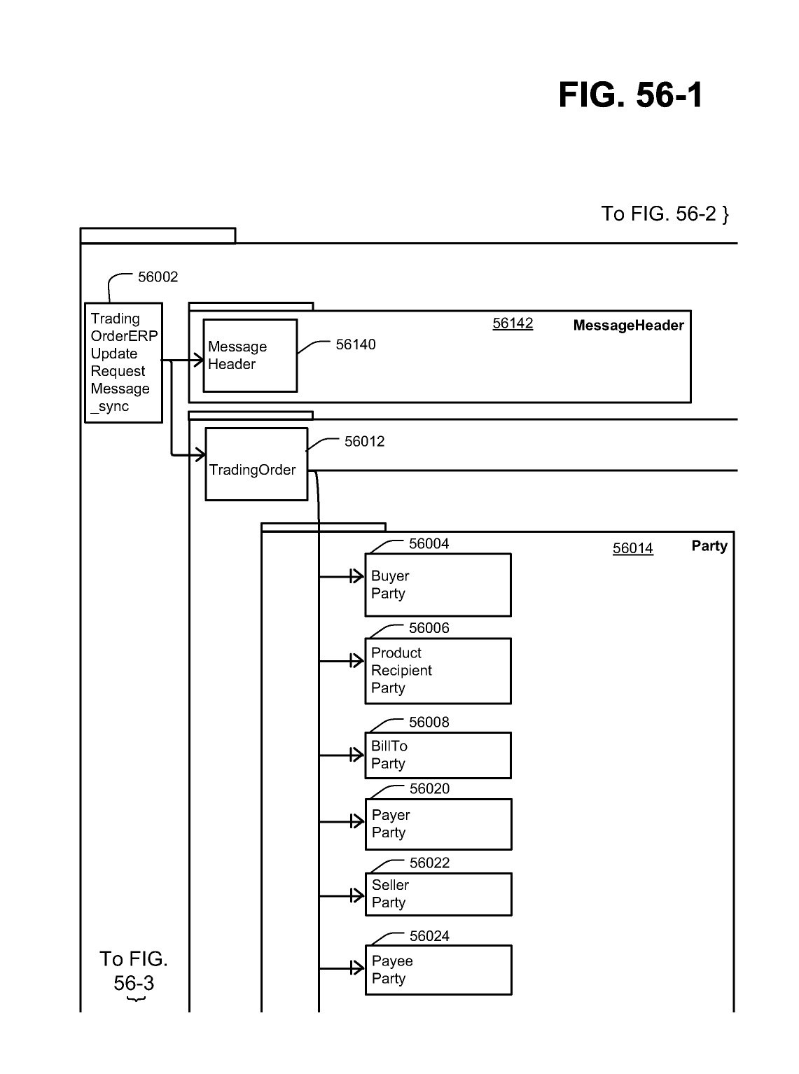

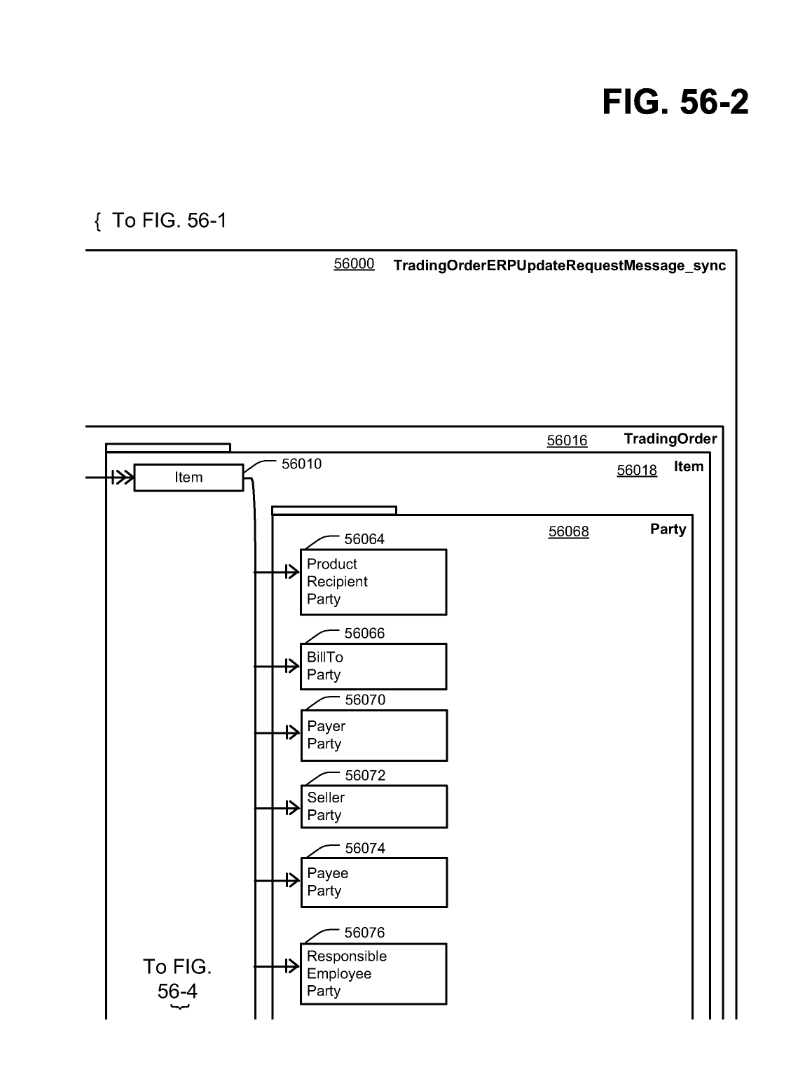

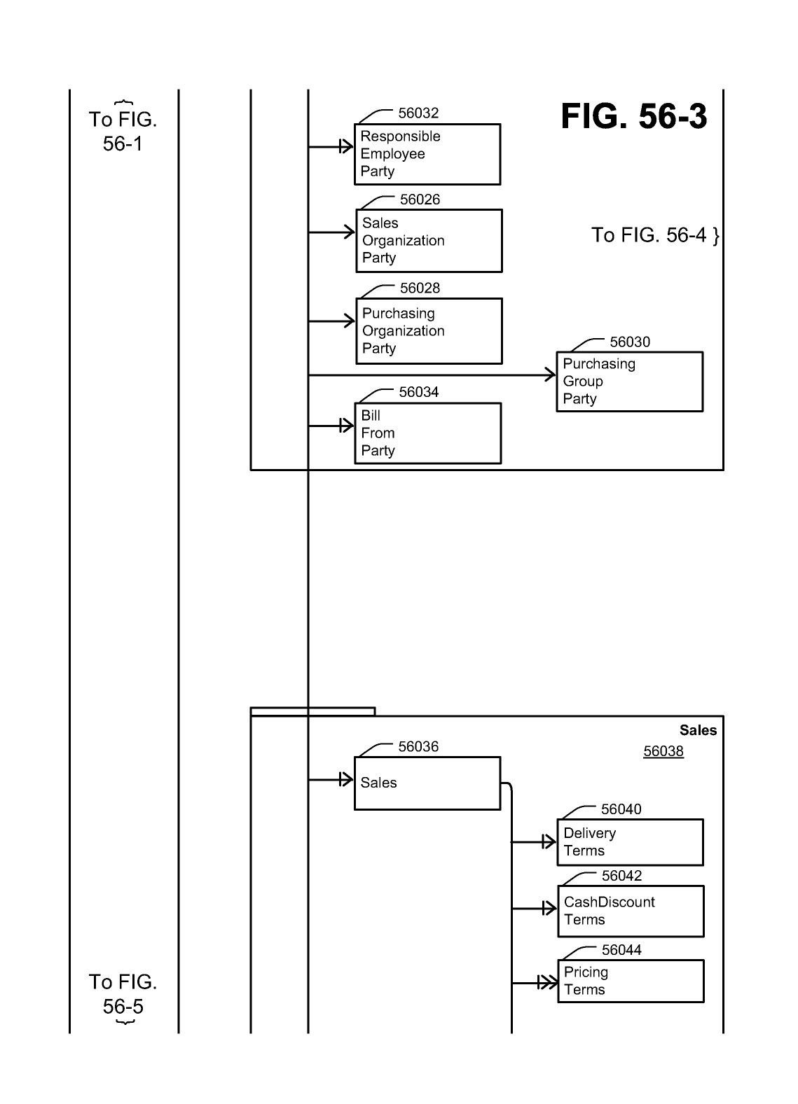

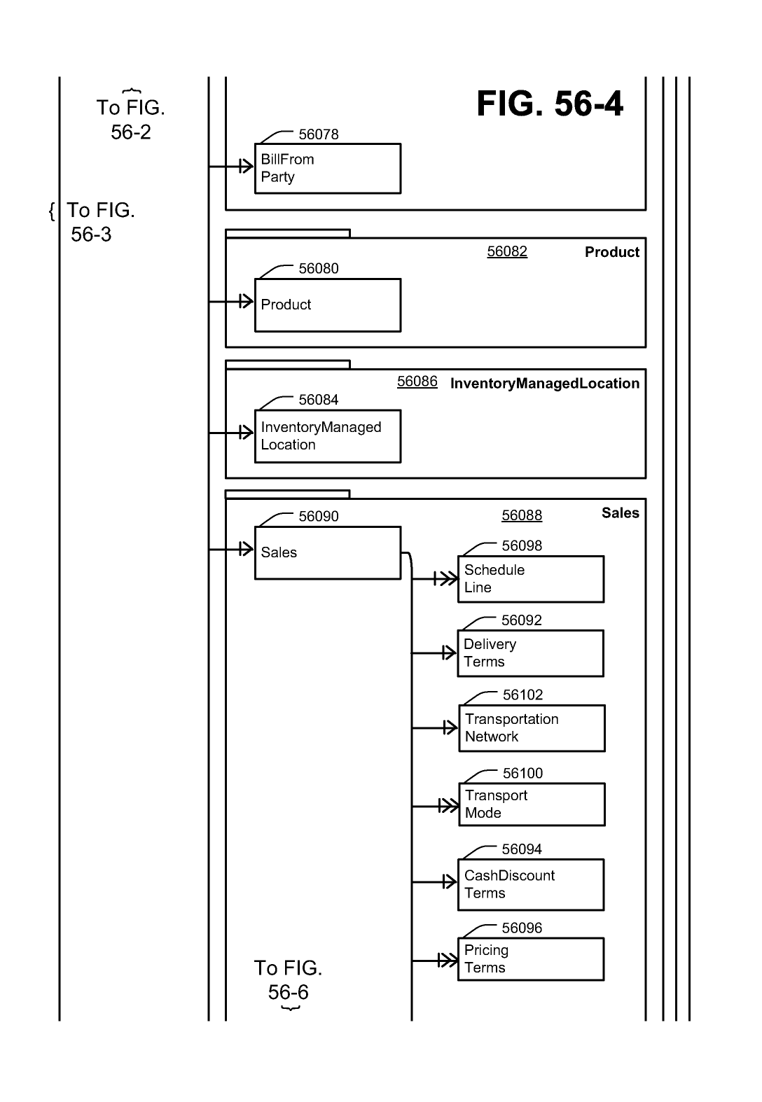

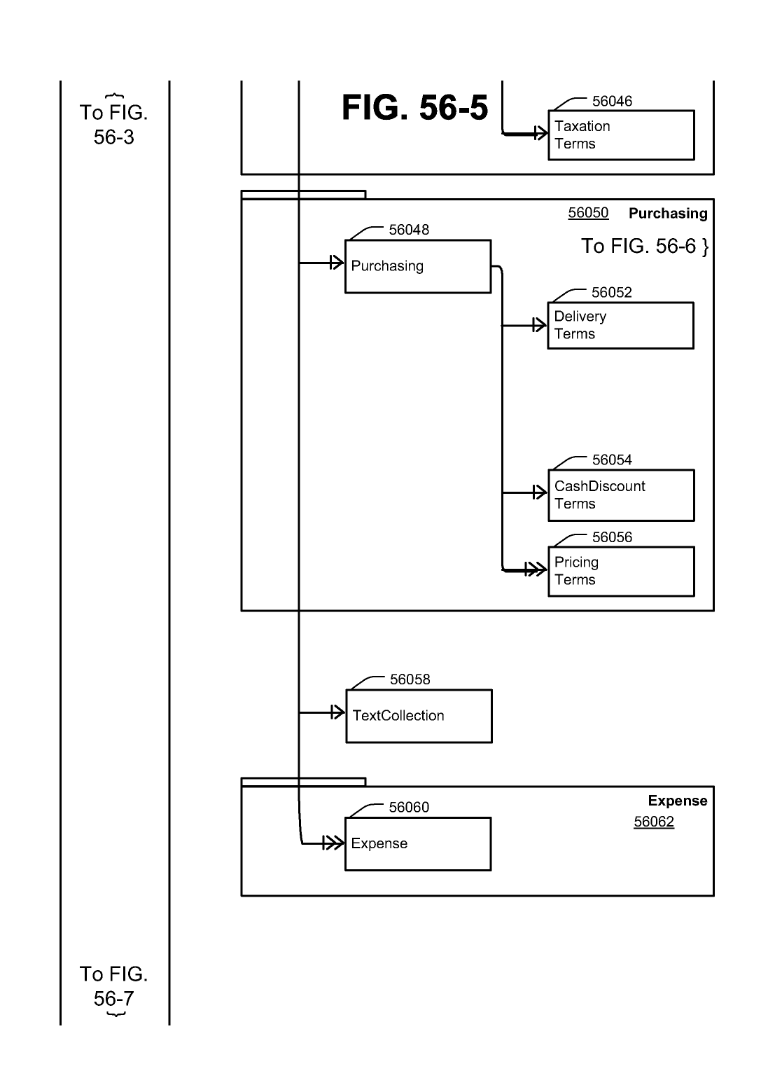

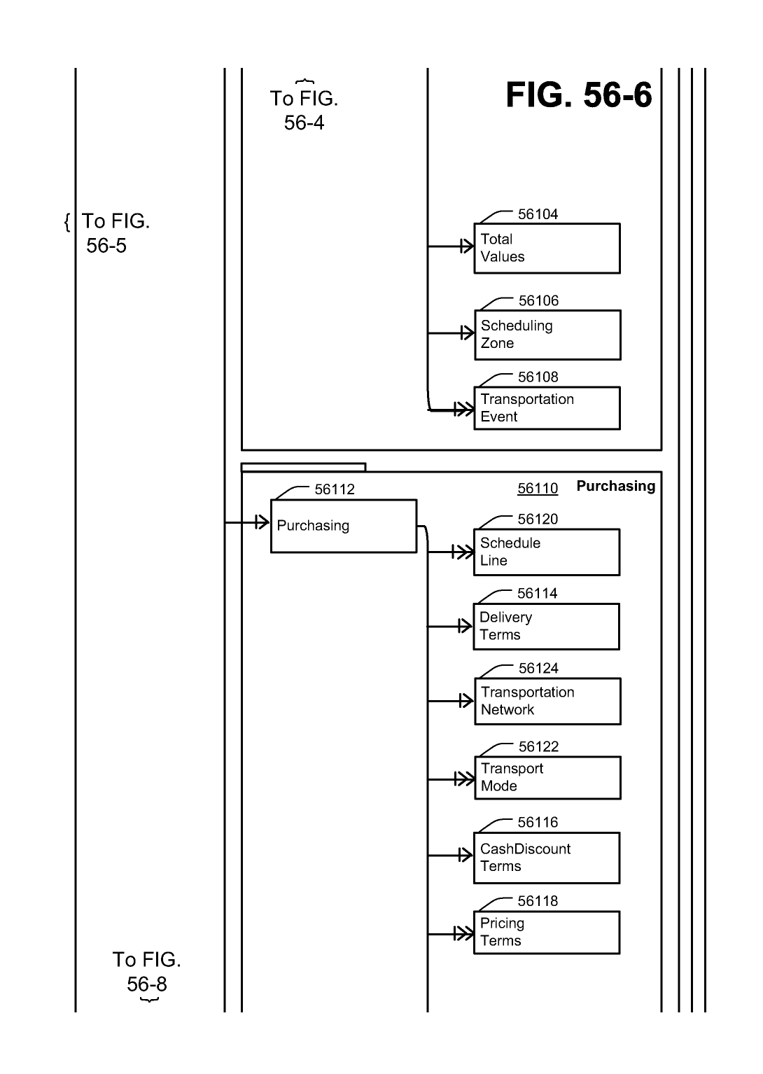

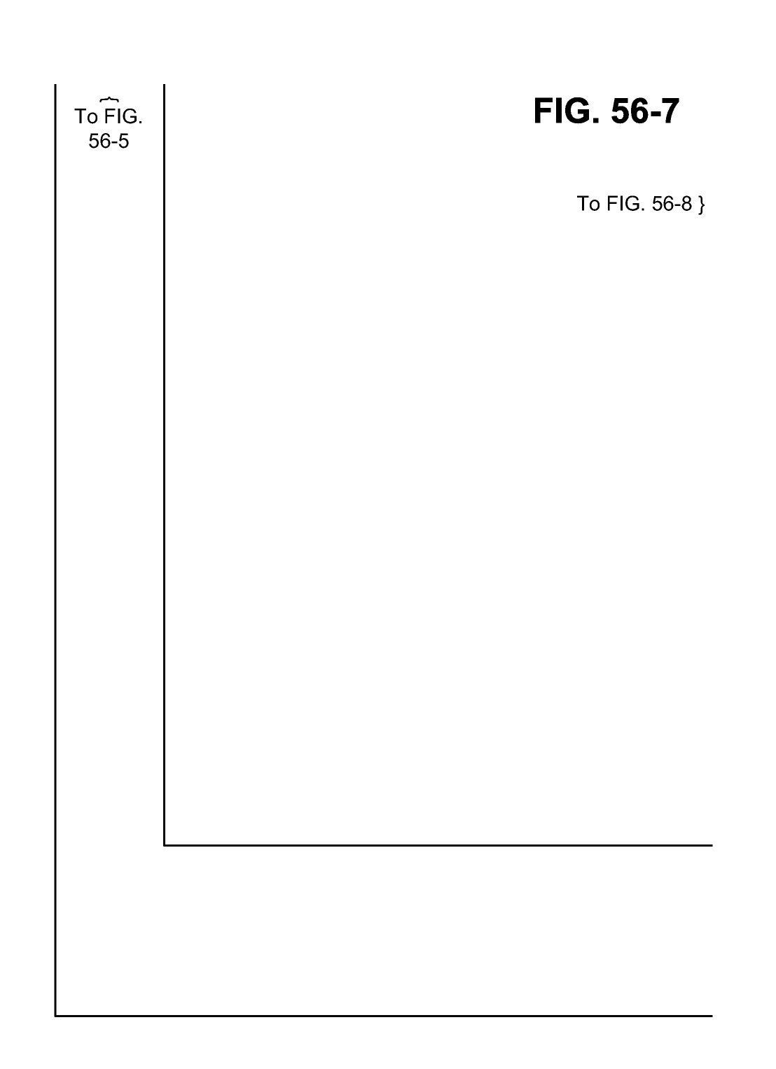

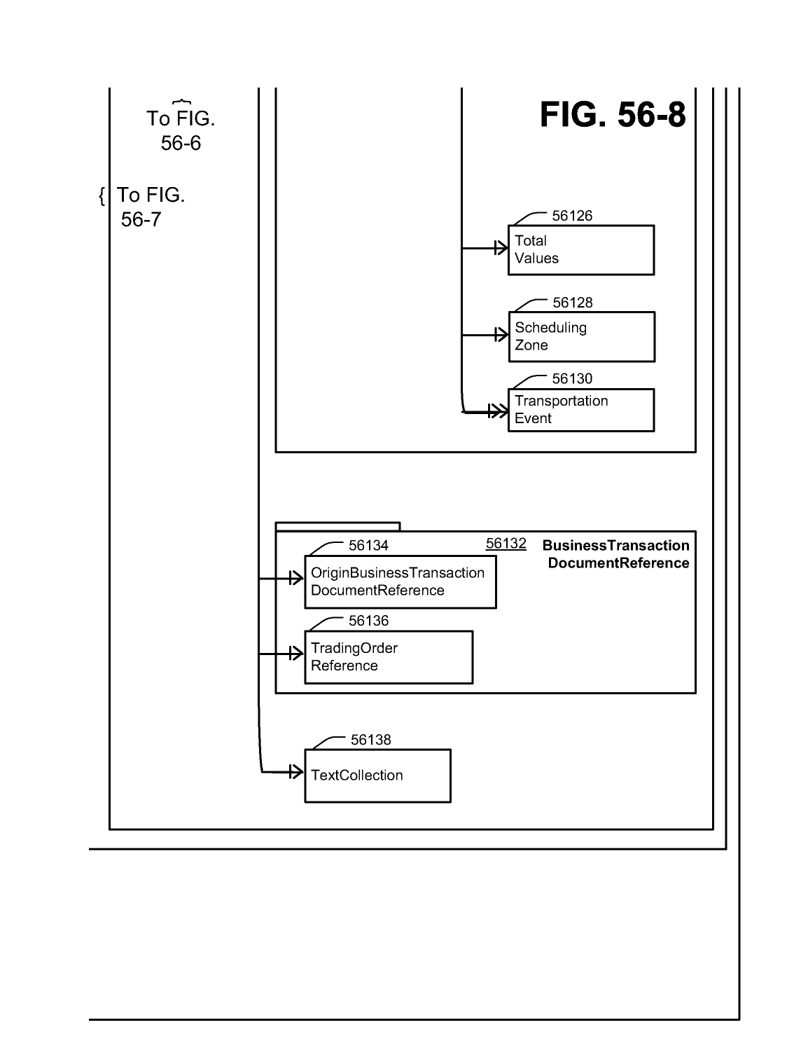

Additionally, FIGS. 56-1 to 56-8 illustrate one example logical configuration of TradingOrderERPUpdateRequestMessage message 56000. Specifically, these figures depict the arrangement and hierarchy of various components such as one or more levels of packages, entities, and datatypes, shown here as 56000 through 56138. As described above, packages may be used to represent hierarchy levels. Entities are discrete business elements that are used during a business transaction. Data types are used to type object entities and interfaces with a structure. For example, TradingOrderERPUpdateRequestMessage message 56000 includes, among other things, TradingOrder 56016. Accordingly, heterogeneous applications may communicate using this consistent message configured as such.

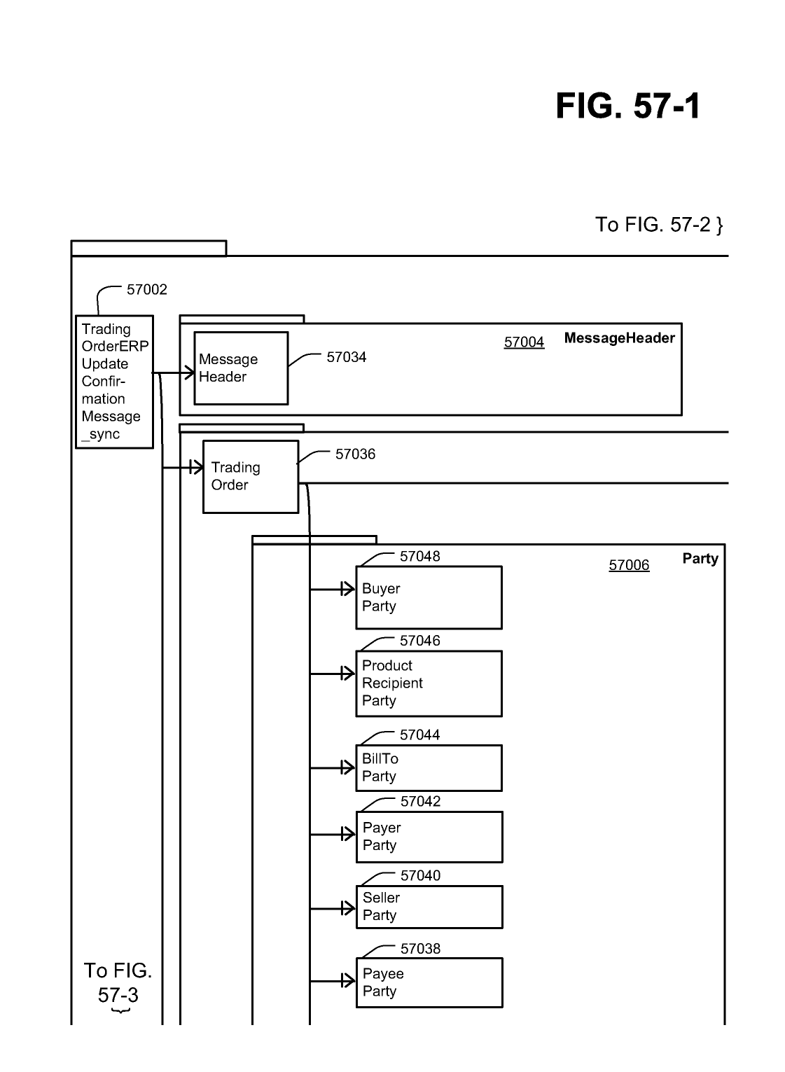

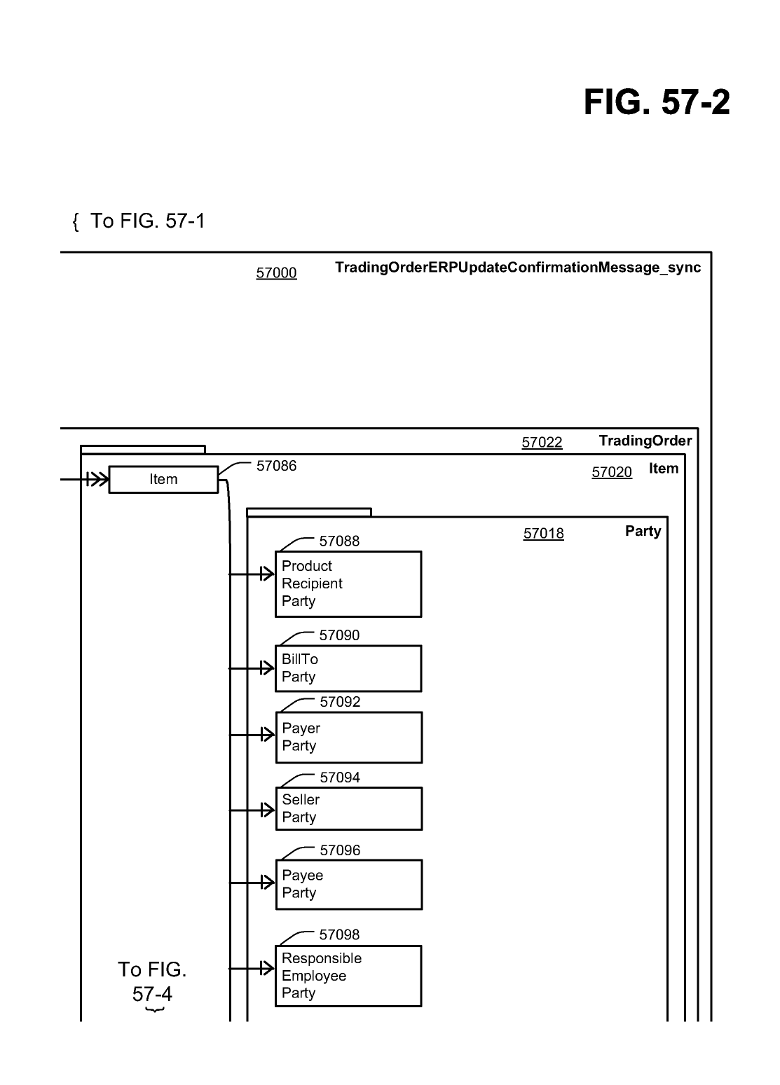

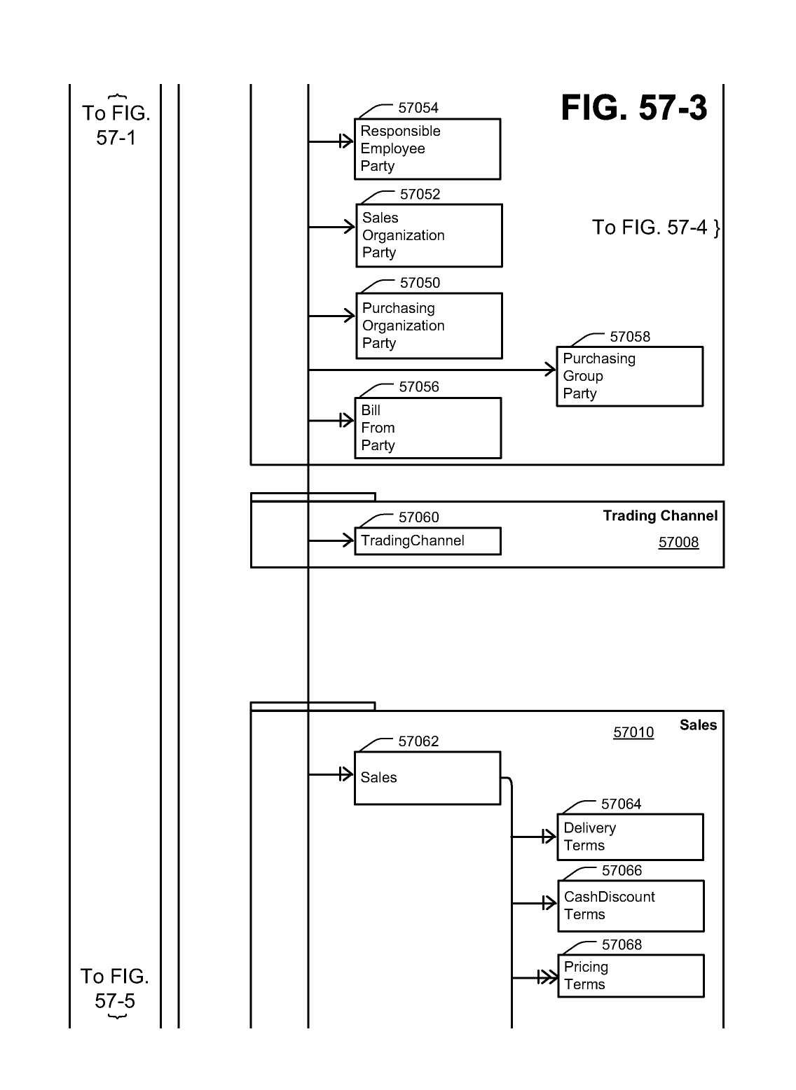

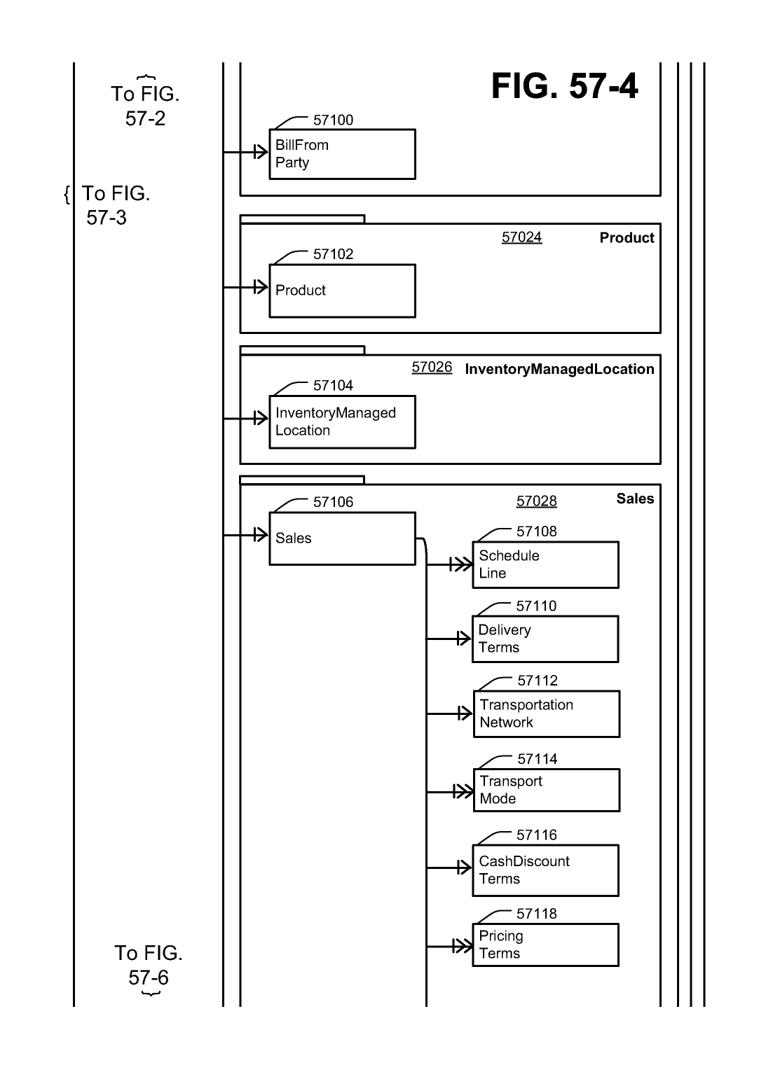

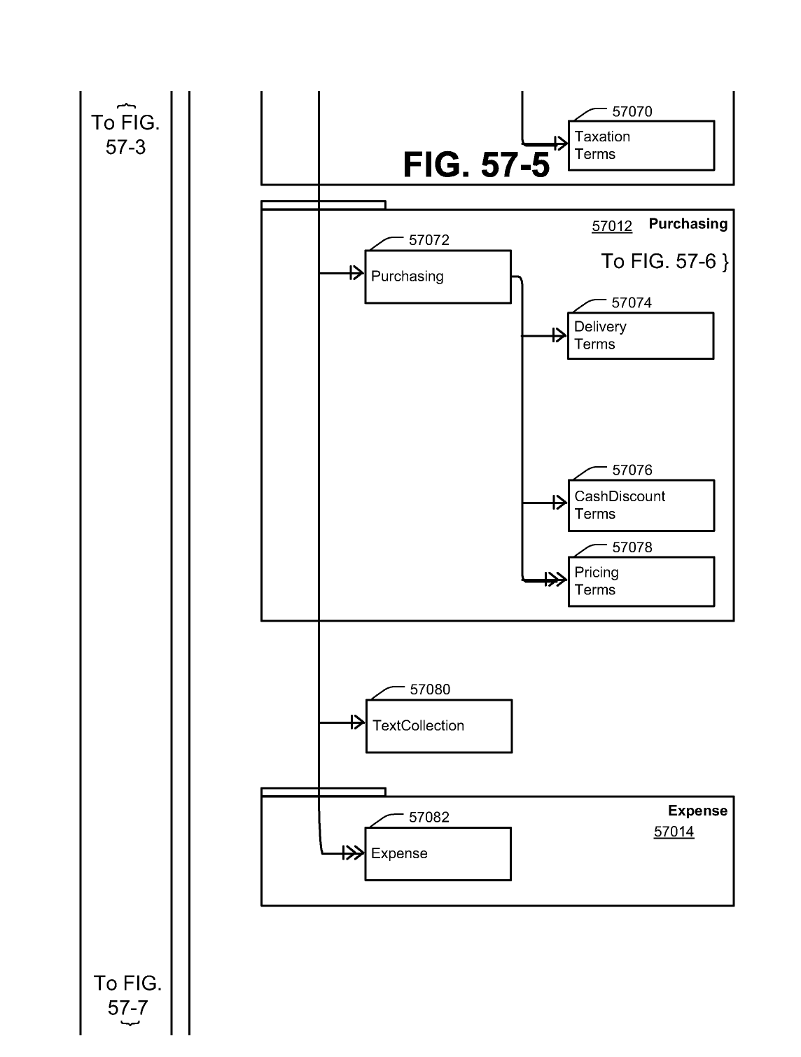

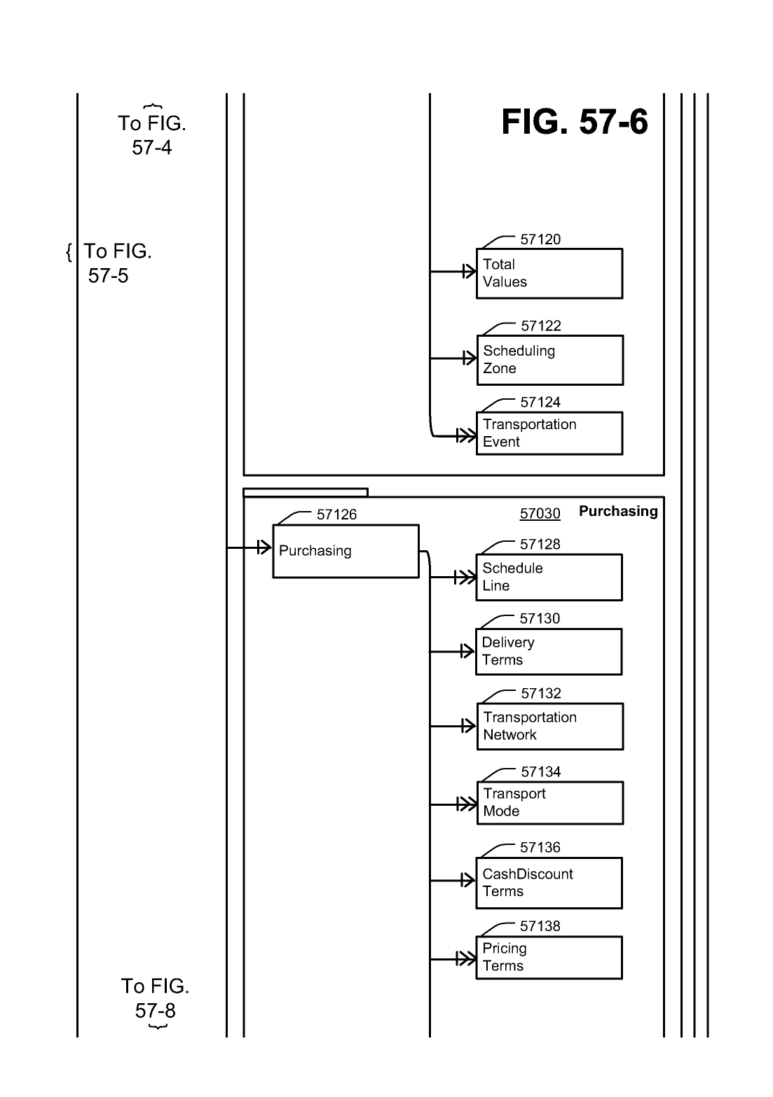

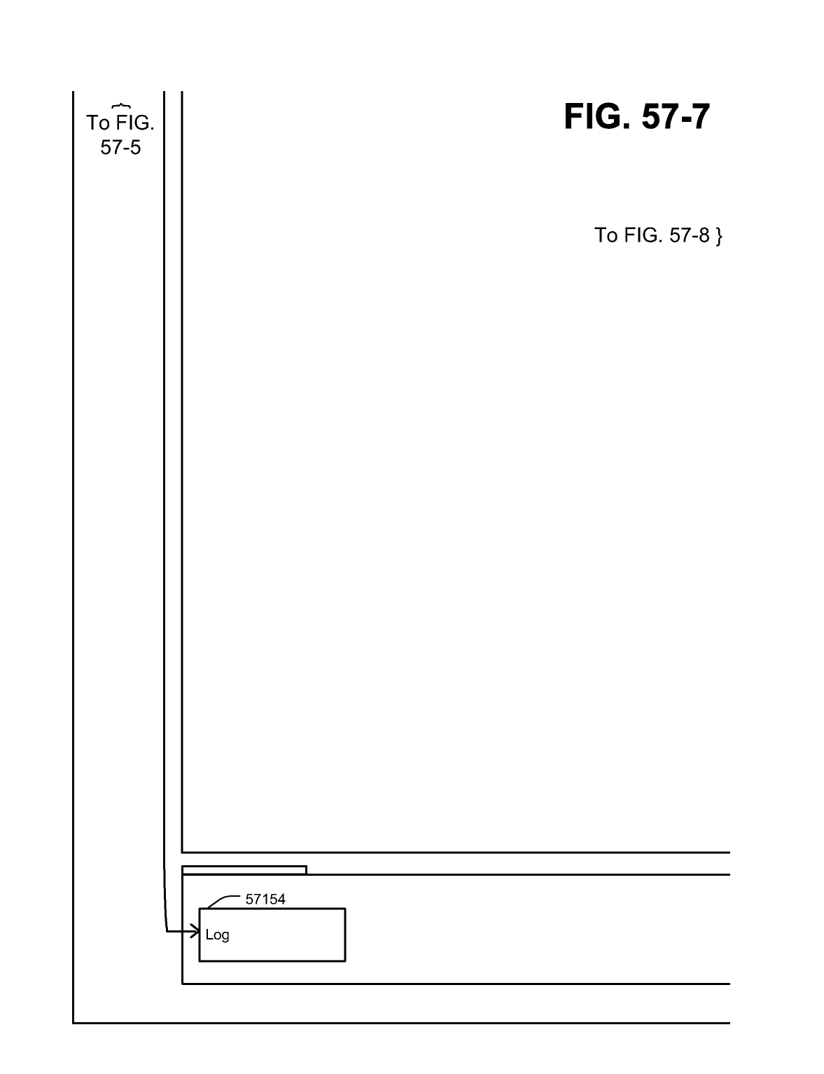

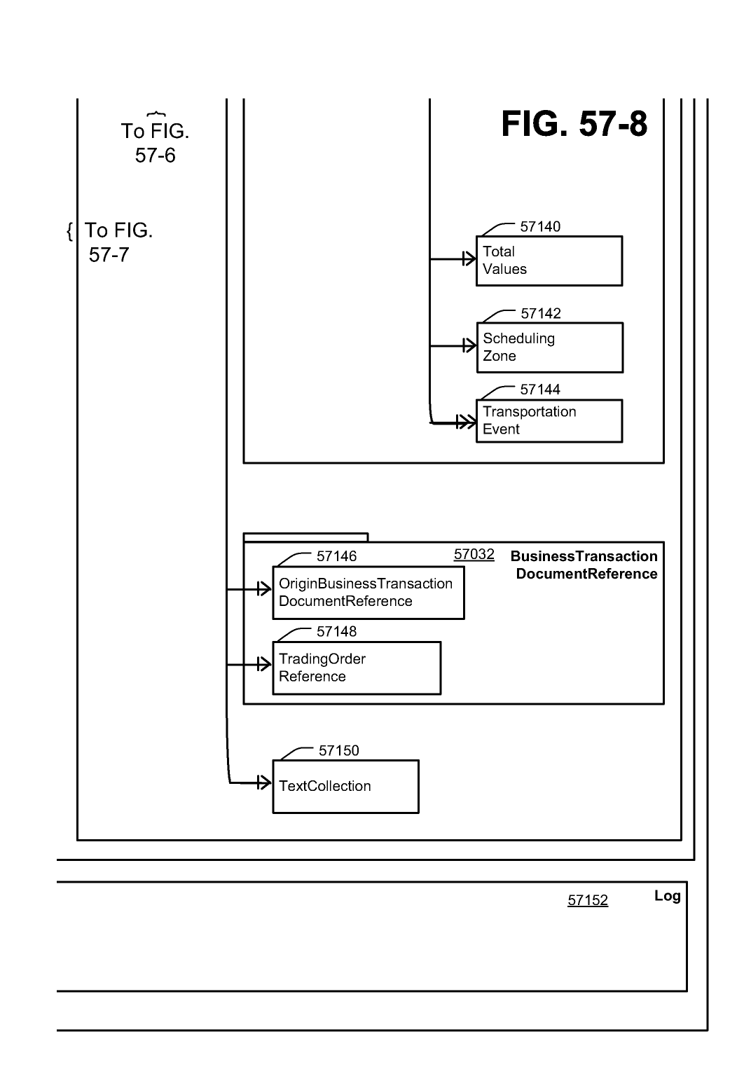

Additionally, FIGS. 57-1 to 57-8 illustrate one example logical configuration of TradingOrderERPUpdateConfirmationMessage message 57000. Specifically, these figures depict the arrangement and hierarchy of various components such as one or more levels of packages, entities, and datatypes, shown here as 57000 through 57154. As described above, packages may be used to represent hierarchy levels. Entities are discrete business elements that are used during a business transaction. Data types are used to type object entities and interfaces with a structure. For example, TradingOrderERPUpdateConfirmationMessage message 57000 includes, among other things, TradingOrder 57022. Accordingly, heterogeneous applications may communicate using this consistent message configured as such.

FIGS. 58-1 through 58-53 show a TradingOrderMessage 58000 package. The TradingOrderMessage 58000 package includes a TradingOrderMessage 58002 entity. The TradingOrderMessage 58000 package includes various packages, namely a MessageHeader 58004 package, a TradingOrder 58012 package, a Selection 58912 package, a Selection 58924 package, a ProcessingConditions 58952 package and a Log 58968 package.

The MessageHeader 58004 package includes a MessageHeader 58006 entity. The MessageHeader groups business information from the perspective of the sending application: This information can include information to identify the business document in a message, information about the sender and (possibly) information about the recipient. The MessageHeader 58006 entity includes a BusinessDocumentMessageHeader 58008 attribute.

The BusinessDocumentMessageHeader 58008 attribute is a BusinessDocumentMessageHeader 58010 data type. The BusinessDocumentMessageHeader can use the SenderParty and RecipientParty elements of the GDT are used. The TradingOrder 58012 package includes a TradingOrder 58014 entity. The TradingOrder 58012 package includes various packages, namely a Party 58064 package, a TradingChannel 58132 package, a TotalValues 58144 package, a Sales 58152 package, a Purchasing 58248 package, a TextCollection 58318 package, an Expense 58326 package and an Item 58362 package.

The TradingOrder package groups together the TradingOrder and its packages. The TradingOrder has the TradingOrder as root node. The TradingOrder 58014 entity includes various attributes, namely an ID 58016 attribute, an ExternalTradingOrderID 58020 attribute, a TypeCode 58024 attribute, a TradingProcessVariantTypeCode 58028 attribute, an ExchangeRateTypeCode 58032 attribute, a LifeCycleStatusCode 58036 attribute, an ExchangeRate 58040 attribute, a ValidityDate 58044 attribute, a ChangeStateID 58048 attribute, a @actionCode 58052 attribute, a @itemListCompleteTransmissionIndicator 58056 attribute and a @expenseListCompleteTransmissionIndicator 58060 attribute.

The ID 58016 attribute is a TradingOrderID 58018 data type. The ID is the unique identifier of the TradingOrder. The ExternalTradingOrderID 58020 attribute is a BusinessTransactionDocumentID 58022 data type. The ExternalTradingOrderID is the unique identifier given by the sending system for the TradingOrder. The TypeCode 58024 attribute is a TradingOrderTypeCode 58026 data type. The TypeCode is the encoded representation of a TradingOrder within a trading order processing. The TypeCode determines the price determination schema for calculating the purchasing and sales price and also affects which fields have to be maintained.

The TradingProcessVariantTypeCode 58028 attribute is a TradingProcessVariantTypeCode 58030 data type. The TradingProcessVariantTypeCode is the coded representation of a trading process variant type. The TradingProcessVariantTypeCode determines the character of a trading process variant. It represents a typical way of processing within a trading process component from a business point of view.

The ExchangeRateTypeCode 58032 attribute is an ExchangeRateTypeCode 58034 data type. The ExchangeRateTypeCode is the coded representation of the type of an exchange rate. The ExchangeRateTypeCode is related to the currency of the TradingOrder. The LifeCycleStatusCode 58036 attribute is a TradingOrderLifeCycleStatusCode 58038 data type. The LifeCycleStatusCode is the coded representation of the life cycle status of a TradingOrder.

The ExchangeRate 58040 attribute is an ExchangeRate 58042 data type. The ExchangeRate is the representation of an exchange rate between two currencies: the currency of the TradingOrder and the local currency. The ValidityDate 58044 attribute is a Date 58046 data type. The ValidityDate is the date at which a TradingOrder becomes effective from a business perspective. The ChangeStateID 58048 attribute is a ChangeStateID 58050 data type. The ChangeStateID is a unique Identifier for a change state. The ChangeStateID is essential that data are only changed by updating a set of data as it was retrieved. Since data may not be locked for update, concurrent changes may happen and invalidate the set of data retrieved before the change. Therefore, later updates can be rejected and the first update is accepted and persists (wins).

The @actionCode 58052 attribute is an ActionCode 58054 data type. The @itemListCompleteTransmissionIndicator 58056 attribute is an Indicator 58058 data type. The itemListCompleteTransmissionIndicator indicates whether all items of a TradingOrder are transmitted or not. The @expenseListCompleteTransmissionIndicator 58060 attribute is an Indicator 58062 data type. The expenseListCompleteTransmissionIndicator indicates whether all expenses of a TradingOrder are transmitted or not.

The Party 58064 package includes various entities, namely a BuyerParty 58066 entity, a ProductRecipientParty 58072 entity, a BillToParty 58078 entity, a PayerParty 58084 entity, a SellerParty 58090 entity, a PayeeParty 58096 entity, a ResponsibleEmployeeParty 58102 entity, a SalesOrganizationParty 58108 entity, a PurchasingOrganizationParty 58114 entity, a PurchasingGroupParty 58120 entity and a BillFromParty 58126 entity. The BuyerParty is a party that buys goods or services. The BuyerParty 58066 entity includes an InternalID 58068 attribute.

The InternalID 58068 attribute is a PartyInternalID 58070 data type. The PartyInternalID is a unique identifier for the party that buys goods or services. The ProductRecipientParty is a party to which goods are delivered or for whom services are provided. The ProductRecipientParty 58072 entity includes an InternalID 58074 attribute.

The InternalID 58074 attribute is a PartyInternalID 58076 data type. The PartyInternalID is a unique identifier for the party to which goods are delivered or for whom services are provided. The BillToParty is a party to which the invoice for goods or services is sent. The BillToParty 58078 entity includes an InternalID 58080 attribute. The InternalID 58080 attribute is a PartyInternalID 58082 data type. The PartyInternalID is a unique identifier for the party to which the invoice for goods or services is sent. The PayerParty is a party that pays for goods or services. The PayerParty 58084 entity includes an InternalID 58086 attribute.

The InternalID 58086 attribute is a PartyInternalID 58088 data type. The PartyInternalID is a unique identifier for the party that pays for goods or services. The SellerParty is a party that sells goods or services. The SellerParty 58090 entity includes an InternalID 58092 attribute. The InternalID 58092 attribute is a PartyInternalID 58094 data type. The PartyInternalID is a unique identifier for the party that sells goods or services. The PayeeParty is a party that receives payment for goods or services provided. The PayeeParty 58096 entity includes an InternalID 58098 attribute. The InternalID 58098 attribute is a PartyInternalID 58100 data type. The PartyInternalID is a unique identifier for the party that receives payment for goods or services.

The ResponsibleEmployeeParty is a party that is responsible for something. The party can be an internal or external employee. The ResponsibleEmployeeParty 58102 entity includes an InternalID 58104 attribute. The InternalID 58104 attribute is a PartyInternalID 58106 data type. The PartyInternalID is a unique identifier for the responsible employee. The SalesOrganizationParty is an Organization that is responsible for selling goods. The SalesOrganizationParty 58108 entity includes an InternalID 58110 attribute. The InternalID 58110 attribute is a PartyInternalID 58112 data type. The PartyInternalID is a unique identifier for the party that is responsible for selling goods.

The PurchasingOrganizationParty is an organizational unit within logistics that subdivides the enterprise according to the requirements of purchasing. The PurchasingOrganizationParty 58114 entity includes an InternalID 58116 attribute. The InternalID 58116 attribute is a PartyInternalID 58118 data type. The PartyInternalID is the unique identifier of a purchasing group.

The PurchasingGroupParty is an organizational unit within logistics that subdivides the enterprise from the viewpoint of purchasing according to the responsibilities for the procurement of products and is the point of contact for the suppliers. The PurchasingGroupParty 58120 entity includes an InternalID 58122 attribute. The InternalID 58122 attribute is a PartyInternalID 58124 data type. The PartyInternalID is the unique identifier of a purchasing group. The BillFromParty is a party which issues the invoice for goods or services. The BillFromParty 58126 entity includes an InternalID 58128 attribute.

The InternalID 58128 attribute is a PartyInternalID 58130 data type. The PartyInternalID is a unique identifier for the party which issues the invoice for goods or services. The TradingChannel 58132 package includes a TradingChannel 58134 entity. The TradingChannel defines the unit which is responsible for trading goods and services in detail. The TradingChannel 58134 entity includes various attributes, namely a DistributionChannelCode 58136 attribute and a DivisionCode 58140 attribute.

The DistributionChannelCode 58136 attribute is a DistributionChannelCode 58138 data type. The DistributionChannelCode is an encoded representation of a distribution channel via which the goods or services are made available to the customer. The DivisionCode 58140 attribute is a DivisionCode 58142 data type. The DivisionCode is an encoded representation of a division that defines the responsibility for sales or profit for saleable materials or services. The TotalValues 58144 package includes a TotalValues 58146 entity.

The TotalValues are the cumulated total values that occur in a TradingOrder item sales, for example, the total gross and net weight, volume, gross and net amount, tax amount, and freight costs. The TotalValues 58146 entity includes a NetAmount 58148 attribute. The NetAmount 58148 attribute is an Amount 58150 data type. The NetAmount is the total net amount of the TradingOrder. The Sales 58152 package includes a Sales 58154 entity. The Sales is the selling part of the TradingOrder. The Sales 58154 entity includes various attributes, namely a BuyerPurchaseOrderID 58156 attribute, a ProductRecipientPurchaseOrderID 58160 attribute, an ExchangeRateTypeCode 58164 attribute, a DeliveryBlockingReasonCode 58168 attribute, an InvoicingBlockingReasonCode 58172 attribute, an ExchangeRate 58176 attribute, a BuyerOrderingDate 58180 attribute, a ProductRecipientOrderingDate 58184 attribute, a DeliveryDate 58188 attribute and a @pricingTermsListCompleteTransmissionIndicator 58192 attribute. The Sales 58154 entity includes various subordinate entities, namely a DeliveryTerms 58196 entity, a CashDiscountTerms 58202 entity, a PricingTerms 58212 entity and a TaxationTerms 58234 entity.

The BuyerPurchaseOrderID 58156 attribute is a PurchaseOrderID 58158 data type. The BuyerPurchaseOrderID is the identifier of the purchase order used by the buyer. The ProductRecipientPurchaseOrderID 58160 attribute is a PurchaseOrderID 58162 data type. The ProductRecipientPurchaseOrderID is the identifier of the purchase order used by the product recipient. The ExchangeRateTypeCode 58164 attribute is an ExchangeRateTypeCode 58166 data type. The ExchangeRateTypeCode is the coded representation of the type of an exchange rate. It is related to the currency of the TradingOrder Sales. The DeliveryBlockingReasonCode 58168 attribute is a DeliveryBlockingReasonCode 58170 data type. The DeliveryBlockingReasonCode is the coded representation for the reason why a TradingOrder Sales is blocked for delivery. The InvoicingBlockingReasonCode 58172 attribute is an InvoicingBlockingReasonCode 58174 data type. The InvoicingBlockingReasonCode is the coded representation for the reason why a TradingOrder Sales is blocked for invoicing.

The ExchangeRate 58176 attribute is an ExchangeRate 58178 data type. The ExchangeRate is the representation of an exchange rate between two currencies: the currency of the TradingOrder Sales and the local currency. The BuyerOrderingDate 58180 attribute is a Date 58182 data type. The BuyerOrderingDate is the date when the buyer's purchase order was ordered. The ProductRecipientOrderingDate 58184 attribute is a Date 58186 data type. The ProductRecipientOrderingDate is the date when the product recipient's purchase order was ordered.

The DeliveryDate 58188 attribute is a Date 58190 data type. The Delivery Date is the date at which a delivery takes place. The @pricingTermsListCompleteTransmissionIndicator 58192 attribute is an Indicator 58194 data type. The pricingTermsListCompleteTransmissionIndicator indicates whether all PricingTerms of a TradingOrder sales are transmitted or not. The DeliveryTerms are conditions and agreements that are valid for executing the delivery of ordered materials. The DeliveryTerms 58196 entity includes an Incoterms 58198 attribute.

The Incoterms 58198 attribute is an Incoterms 58200 data type. The Incoterms are typical contract formulations for delivery conditions that correspond to the rules defined by the International Chamber of Commerce (ICC). The CashDiscountTerms is a set of control information which is relevant for payment in the TradingOrder sales document. The CashDiscountTerms 58202 entity includes various attributes, namely a Code 58204 attribute and a DueDate 58208 attribute. The Code 58204 attribute is a CashDiscountTermsCode 58206 data type. The Code is a coded representation of an agreement of cash discounts for a payment.

The DueDate 58208 attribute is a Date 58210 data type. The DueDate is the date on which the CashDiscountTerms related to the TradingOrder Sales becomes effective. The PricingTerms is the price information for the TradingOrder sales document. The PricingTerms 58212 entity includes various attributes, namely a CommodityObjectCalculationStatusCode 58214 attribute, a PriceComponent 58218 attribute, an EvaluationPeriodDataCompleteIndicator 58222 attribute, a ProvisionalCommodityTermAppliedIndicator 58226 attribute and a @actionCode 58230 attribute.

The CommodityObjectCalculationStatusCode 58214 attribute is a CalculationStatusCode 58216 data type. The CommodityObjectCalculationStatusCode is a coded representation of the calculation status of a commodity pricing object. The PriceComponent 58218 attribute is a PriceComponent 58220 data type. The PriceComponent is a component of the calculated price. The EvaluationPeriodDataCompleteIndicator 58222 attribute is an Indicator 58224 data type. The EvaluationPeriodDataCompleteIndicator indicates whether all data for period evaluation are taken into account or not.

The ProvisionalCommodityTermAppliedIndicator 58226 attribute is an Indicator 58228 data type. The ProvisionalCommodityTermAppliedIndicator indicates whether a provisional commodity term is applied during a period evaluation or not The @actionCode 58230 attribute is an ActionCode 58232 data type. The ActionCode is a coded representation of an instruction telling how to process the PricingTerms for a TradingOrder Sales. The TaxationTerms is the tax information for the TradingOrder sales document. The TaxationTerms 58234 entity includes various attributes, namely a DestinationCountryCode 58236 attribute, an OriginCountryCode 58240 attribute and a EuropeanCommunityVATTriangulationIndicator 58244 attribute.

The DestinationCountryCode 58236 attribute is a CountryCode 58238 data type. The DestinationCountryCode is a coded representation of the country which is the destination country for tax purposes. The OriginCountryCode 58240 attribute is a CountryCode 58242 data type. The OriginCountryCode is a coded representation of the country which is the origin country for tax purposes. The EuropeanCommunityVATTriangulationIndicator 58244 attribute is an Indicator 58246 data type. The EuropeanCommunityVATTriangulationIndicator indicates whether a delivery is an intracommunity triangulation according to the VAT law of a member state of the European Community.

The Purchasing 58248 package includes a Purchasing 58250 entity. The Purchasing is the buying part of the TradingOrder. The Purchasing 58250 entity includes various attributes, namely a SellerReferenceID 58252 attribute, an ExchangeRateTypeCode 58256 attribute, an ExchangeRate 58260 attribute, a Date 58264 attribute, a QuotationValidityStartDate 58268 attribute, a DeliveryDate 58272 attribute and a @pricingTermsListCompleteTransmissionIndicator 58276 attribute. The Purchasing 58250 entity includes various subordinate entities, namely a DeliveryTerms 58280 entity, a CashDiscountTerms 58286 entity and a PricingTerms 58296 entity.

The SellerReferenceID 58252 attribute is a BusinessTransactionDocumentID 58254 data type. The SellerReferenceID is the reference identifier of the seller. The ExchangeRateTypeCode 58256 attribute is an ExchangeRateTypeCode 58258 data type. The ExchangeRateTypeCode is the coded representation of the type of an exchange rate. It is related to the currency of the TradingOrder Purchasing. The ExchangeRate 58260 attribute is an ExchangeRate 58262 data type. The ExchangeRate is the representation of an exchange rate between two currencies: the currency of the TradingOrder Purchasing and the local currency.

The Date 58264 attribute is a Date 58266 data type. The Date is the date on which the purchasing document was created. The QuotationValidityStartDate 58268 attribute is a Date 58270 data type. The QuotationValidityStartDate is the date on which the seller submitted the quotation. The DeliveryDate 58272 attribute is a Date 58274 data type. The DeliveryDate is the date at which a delivery takes place. The @pricingTermsListCompleteTransmissionIndicator 58276 attribute is an Indicator 58278 data type. The pricingTermsListCompleteTransmissionIndicator indicates whether all PricingTerms of a TradingOrder Purchasing are transmitted or not.

The DeliveryTerms are the conditions and agreements that are valid for executing the delivery of ordered materials. The DeliveryTerms 58280 entity includes an Incoterms 58282 attribute. The Incoterms 58282 attribute is an Incoterms 58284 data type. The Incoterms are typical contract formulations for delivery conditions that correspond to the rules defined by the International Chamber of Commerce (ICC). The CashDiscountTerms is a set of control information which is relevant for payment in the TradingOrder purchasing document. The CashDiscountTerms 58286 entity includes various attributes, namely a Code 58288 attribute and a DueDate 58292 attribute.

The Code 58288 attribute is a CashDiscountTermsCode 58290 data type. The Code is a coded representation of an agreement of cash discounts for a payment. The DueDate 58292 attribute is a Date 58294 data type. The DueDate is the date on which the CashDiscountTerms related to the TradingOrder Purchasing becomes effective. The PricingTerms is the price information for the TradingOrder purchasing document. The PricingTerms 58296 entity includes various attributes, namely a CommodityObjectCalculationStatusCode 58298 attribute, a PriceComponent 58302 attribute, an EvaluationPeriodDataCompleteIndicator 58306 attribute, a ProvisionalCommodityTermAppliedIndicator 58310 attribute and a @actionCode 58314 attribute.

The CommodityObjectCalculationStatusCode 58298 attribute is a CalculationStatusCode 58300 data type. The CommodityObjectCalculationStatusCode is a coded representation of the calculation status of a commodity pricing object. The PriceComponent 58302 attribute is a PriceComponent 58304 data type. The PriceComponent is a component of the calculated price. The EvaluationPeriodDataCompleteIndicator 58306 attribute is an Indicator 58308 data type. The EvaluationPeriodDataCompleteIndicator indicates whether all data for period evaluation are taken into account or not.

The ProvisionalCommodityTermAppliedIndicator 58310 attribute is an Indicator 58312 data type. The ProvisionalCommodityTermAppliedIndicator indicates whether a provisional commodity term is applied during a period evaluation or not. The @actionCode 58314 attribute is an ActionCode 58316 data type. The ActionCode is a coded representation of an instruction telling how to process the PricingTerms for a TradingOrder Purchasing. The TextCollection 58318 package includes a TextCollection 58320 entity.

The TextCollection package groups together all the texts regarding the TradingOrder. The TextCollection 58320 entity includes a TextCollection 58322 attribute. The TextCollection 58322 attribute is a TextCollection 58324 data type. The TextCollection is a collection of all text descriptions linked to the TradingOrder. The Expense 58326 package includes an Expense 58328 entity.

The Expense is an expense information for the TradingOrder. The Expense 58328 entity includes various attributes, namely a BearerInternalID 58330 attribute, a TypeGroupCode 58334 attribute, a TypeCode 58338 attribute, an AccountTypeCode 58342 attribute, a PostingTypeCode 58346 attribute, a CashDiscountTermsCode 58350 attribute, a PriceSpecificationElement 58354 attribute and a @actionCode 58358 attribute. The BearerInternalID 58330 attribute is a PartyInternalID 58332 data type. The BearerInternalID is the unique identifier assigned to the bearer of the expense.

The TypeGroupCode 58334 attribute is a TradingOrderExpenseTypeGroupCode 58336 data type. The TypeGroupCode is used to group expense types. The TypeCode 58338 attribute is a TradingOrderExpenseTypeCode 58340 data type. The TypeCode is the coded representation of the expense type. Together with the accounting type and the posting type, the TypeCode controls vendor billing document type determination. The combination of vendor billing document type and expense type determines which condition is used as the planned expense condition.

The AccountTypeCode 58342 attribute is a TradingOrderExpenseAccountTypeCode 58344 data type. The AccountTypeCode controls the search for a vendor billing document type based on the posting key. It therefore controls whether a posting is made to a material account or a G/L account (in this case with a certain posting key). The PostingTypeCode 58346 attribute is a TradingOrderExpensePostingTypeCode 58348 data type. The PostingTypeCode controls whether it is a billing document type on the vendor side or customer side, and the type of posting (payables, receivables, purely statistical without financial accounting document) for the vendor billing document.

The CashDiscountTermsCode 58350 attribute is a CashDiscountTermsCode 58352 data type. The CashDiscountTermsCode a coded representation of an agreement of cash discounts for a payment. The PriceSpecificationElement 58354 attribute is a PriceSpecificationElement 58356 data type. The PriceSpecificationElement is a coded representation of an agreement of cash discounts for a payment.

The @actionCode 58358 attribute is an ActionCode 58360 data type. The ActionCode is a coded representation of an instruction telling how to process the expense. The Item 58362 package includes an Item 58364 entity. The Item 58362 package includes various packages, namely a Party 58386 package, a Product 58430 package, an InventoryManagedLocation 58450 package, a Sales 58458 package, a Purchasing 58676 package, a BusinessTransactionDocumentReference 58886 package and a TextCollection 58904 package.

The Item is the identifying and administrative information of a product in a TradingOrder which, in addition to the schedule lines, contains all the data that applies to the item, for example, the product information, the parties involved, the sales/delivery/Customer Invoicing-specific agreements, status and references. The Item 58364 entity includes various attributes, namely an ID 58366 attribute, a PlantID 58370 attribute, a ProcessingTypeCode 58374 attribute, a ClosureStatusCode 58378 attribute and a @actionCode 58382 attribute. The ID 58366 attribute is a TradingOrderItemID 58368 data type. The ID is the unique identifier for an item in the TradingOrder.

The PlantID 58370 attribute is a PlantID 58372 data type. The PlantID is the identifier of a plant. The ProcessingTypeCode 58374 attribute is a BusinessTransactionDocumentItemProcessingTypeCode 58376 data type. The ProcessingTypeCode is the coded representation of the way in which an item is processed.

The ClosureStatusCode 58378 attribute is a ClosureStatusCode 58380 data type. The ClosureStatusCode is a coded representation of a closure status. The @actionCode 58382 attribute is an ActionCode 58384 data type. The ActionCode is the coded representation of the actions used to create, change and delete items in a trading process at the message recipient.

The Party 58386 package includes various entities, namely a ProductRecipientParty 58388 entity, a BillToParty 58394 entity, a PayerParty 58400 entity, a SellerParty 58406 entity, a PayeeParty 58412 entity, a ResponsibleEmployeeParty 58418 entity and a BillFromParty 58424 entity. The ProductRecipientParty is a party to which goods are delivered or for whom services are provided. The ProductRecipientParty 58388 entity includes an InternalID 58390 attribute.

The InternalID 58390 attribute is a PartyInternalID 58392 data type. The PartyInternalID is a unique identifier for the party to which goods are delivered or for whom services are provided. The BillToParty is a party to which the invoice for goods or services is sent. The BillToParty 58394 entity includes an InternalID 58396 attribute.

The InternalID 58396 attribute is a PartyInternalID 58398 data type. The PartyInternalID is a unique identifier for the party to which the invoice for goods or services is sent. The PayerParty is a party that pays for goods or services. The PayerParty 58400 entity includes an InternalID 58402 attribute. The InternalID 58402 attribute is a PartyInternalID 58404 data type. The PartyInternalID is a unique identifier for the party that pays for goods or services. The SellerParty is a party that sells goods or services. The SellerParty 58406 entity includes an InternalID 58408 attribute.

The InternalID 58408 attribute is a PartyInternalID 58410 data type. The PartyInternalID is a unique identifier for the party that sells goods or services. The PayeeParty is a party that receives payment for goods or services provided. The PayeeParty 58412 entity includes an InternalID 58414 attribute.

The InternalID 58414 attribute is a PartyInternalID 58416 data type. The PartyInternalID is a unique identifier for the party that receives payment for goods or services. The ResponsibleEmployeeParty is a party that is responsible for something. The party can be an internal or external employee. The ResponsibleEmployeeParty 58418 entity includes an InternalID 58420 attribute.

The InternalID 58420 attribute is a PartyInternalID 58422 data type. The PartyInternalID is a unique identifier for the responsible employee. The BillFromParty is a party which issues the invoice for goods or services. The BillFromParty 58424 entity includes an InternalID 58426 attribute. The InternalID 58426 attribute is a PartyInternalID 58428 data type. The PartyInternalID is a unique identifier for the party which issues the invoice for goods or services.

The Product 58430 package includes a Product 58432 entity. The Product is the identification, description and classification of the product of an Item. The Product 58432 entity includes various attributes, namely an InternalID 58434 attribute, a BuyerID 58438 attribute, a ManufacturerID 58442 attribute and a BatchID 58446 attribute. The InternalID 58434 attribute is a ProductInternalID 58436 data type. The InternalID is a proprietary identifier for the product ordered by the TradingOrder Item.

The BuyerID 58438 attribute is a ProductPartyID 58440 data type. The SellerID is an identifier for a product assigned by the seller. The ManufacturerID 58442 attribute is a ProductPartyID 58444 data type. The ManufacturerID is an identifier for the ordered product assigned by the manufacturer. The BatchID 58446 attribute is a BatchID 58448 data type. The BatchID is a unique identifier in the context of a material number.

The InventoryManagedLocation 58450 package includes an InventoryManagedLocation 58452 entity. The InventoryManagedLocation is a location in which materials are stored. The InventoryManagedLocation 58452 entity includes an InternalID 58454 attribute. The InternalID 58454 attribute is a LocationInternalID 58456 data type. The LocationInternalID is a unique identifier for the location.

The Sales 58458 package includes a Sales 58460 entity. The Sales is the selling part of the item. The Sales 58460 entity includes various attributes, namely a BuyerPurchaseOrderID 58462 attribute, a ProductRecipientPurchaseOrderID 58466 attribute, a BuyerPurchaseOrderItemID 58470 attribute, a ProductRecipientPurchaseOrderItemID 58474 attribute, an InvoicingBlockingReasonCode 58478 attribute, a ProcessingStatusCode 58482 attribute, a BlockingStatusCode 58486 attribute, a CashDiscountDeductibleIndicator 58490 attribute, a PriceDeterminationDate 58494 attribute, a BuyerOrderingDate 58498 attribute, a ProductRecipientOrderingDate 58502 attribute, a DeliveryDate 58506 attribute, a @scheduleLineListCompleteTransmissionIndicator 58510 attribute, a @pricingTermsListCompleteTransmissionIndicator 58514 attribute, a @transportModeListCompleteTransmissionIndicator 58518 attribute and a @transportationEventListCompleteTransmissionIndicator 58522 attribute. The Sales 58460 entity includes various subordinate entities, namely a ScheduleLine 58526 entity, a DeliveryTerms 58544 entity, a TransportationNetwork 58558 entity, a TransportMode 58564 entity, a CashDiscountTerms 58574 entity, a PricingTerms 58584 entity, a TotalValues 58606 entity, a SchedulingZone 58628 entity and a TransportationEvent 58638 entity.

The BuyerPurchaseOrderID 58462 attribute is a BusinessTransactionDocumentID 58464 data type. The BuyerPurchaseOrderID is the identifier of the purchase order used by the buyer. The ProductRecipientPurchaseOrderID 58466 attribute is a BusinessTransactionDocumentID 58468 data type. The ProductRecipientPurchaseOrderID is the identifier of the purchase order used by the product recipient. The BuyerPurchaseOrderItemID 58470 attribute is a BusinessTransactionDocumentItemID 58472 data type. The BuyerPurchaseOrderItemID is the identifier of an item of the purchase order used by the buyer.

The ProductRecipientPurchaseOrderItemID 58474 attribute is a BusinessTransactionDocumentItemID 58476 data type. The ProductRecipientPurchaseOrderItemID is the identifier of an item of the purchase order used by the product recipient. The InvoicingBlockingReasonCode 58478 attribute is an InvoicingBlockingReasonCode 58480 data type. The InvoicingBlockingReasonCode is the coded representation for the reason why a TradingOrder Item Sales is blocked for invoicing.

The ProcessingStatusCode 58482 attribute is a ProcessingStatusCode 58484 data type. The ProcessingStatusCode is a coded representation of a processing status. The BlockingStatusCode 58486 attribute is a BlockingStatusCode 58488 data type. The BlockingStatusCode is a coded representation of a blocking status. The CashDiscountDeductibleIndicator 58490 attribute is an Indicator 58492 data type. The CashDiscountDeductibleIndicator is an indicator that indicates whether a cash discount can be deducted or not.

The PriceDeterminationDate 58494 attribute is a Date 58496 data type. The PriceDeterminationDate is the date at which the price of a product is determined. The BuyerOrderingDate 58498 attribute is a Date 58500 data type. The BuyerOrderingDate is the date when the buyer's purchase order was ordered. The ProductRecipientOrderingDate 58502 attribute is a Date 58504 data type. The ProductRecipientOrderingDate is the date when the product recipient's purchase order was ordered.

The DeliveryDate 58506 attribute is a Date 58508 data type. The Delivery Date is the date at which a delivery takes place. The @scheduleLineListCompleteTransmissionIndicator 58510 attribute is an Indicator 58512 data type. The scheduleLineListCompleteTransmissionIndicator indicates whether all schedule lines of an item sales are transmitted or not. The @pricingTermsListCompleteTransmissionIndicator 58514 attribute is an Indicator 58516 data type. The pricingTermsListCompleteTransmissionIndicator indicates whether all pricing terms of an item sales are transmitted or not.

The @transportModeListCompleteTransmissionIndicator 58518 attribute is an Indicator 58520 data type. The transportModeListCompleteTransmissionIndicator indicates whether all transport modes of an item sales are transmitted or not. The @transportationEventListCompleteTransmissionIndicator 58522 attribute is an Indicator 58524 data type. The transportationEventListCompleteTransmissionIndicator indicates whether all transportation events of an item sales are transmitted or not.

The ScheduleLine is an agreement that specifies when and in what quantity products of an item sales are requested or provided. The ScheduleLine 58526 entity includes various attributes, namely an ID 58528 attribute, a RequestedQuantity 58532 attribute, a DeliveryDate 58536 attribute and a @actionCode 58540 attribute. The ID 58528 attribute is a BusinessTransactionDocumentItemScheduleLineID 58530 data type. The ID is the unique identifier for a ScheduleLine in the TradingOrder item sales.

The RequestedQuantity 58532 attribute is a Quantity 58534 data type. The RequestedQuantity is the quantity that is requested for a ScheduleLine. The DeliveryDate 58536 attribute is a Date 58538 data type. The DeliveryDate is the date at which the delivery takes place. The @actionCode 58540 attribute is an ActionCode 58542 data type. The ActionCode is the coded representation of the actions used to create, change and delete schedule lines for an item sales in a trading process at the message recipient.

The DeliveryTerms are the item-specific conditions and agreements that are valid for executing the delivery of ordered material of the TradingOrder item sales. The DeliveryTerms 58544 entity includes various attributes, namely an Incoterms 58546 attribute, a QuantityTolerance 58550 attribute and a PartiaIDelivery 58554 attribute. The Incoterms 58546 attribute is an Incoterms 58548 data type. The Incoterms are typical contract formulations for delivery conditions that correspond to the rules defined by the International Chamber of Commerce (ICC).

The QuantityTolerance 58550 attribute is a QuantityTolerance 58552 data type. The QuantityTolerance is the tolerated difference between a requested and an actual quantity (e.g.; a delivery quantity) as a percentage. The PartiaIDelivery 58554 attribute is a PartiaIDelivery 58556 data type. The PartiaIDelivery is the maximum number of partial deliveries that may be carried out to deliver the ordered quantity of an item.

The TransportationNetwork is a single, in-transit stock-holding object used for inventory management purposes. The TransportationNetwork 58558 entity includes an ID 58560 attribute. The ID 58560 attribute is a TransportationNetworkID 58562 data type. The ID is the unique identifier of the transportation network. The TransportMode is the way in which product is shipped. The TransportMode 58564 entity includes various attributes, namely a Code 58566 attribute and a @actionCode 58570 attribute.

The Code 58566 attribute is a TransportModeCode 58568 data type. The Code is the encoded representation of the mode of transportation. The @actionCode 58570 attribute is an ActionCode 58572 data type. The ActionCode is the coded representation of the actions used to create, change and delete transport modes for an item sales in a trading process at the message recipient. The CashDiscountTerms is a set of control information which is relevant for payment in the TradingOrder item sales. The CashDiscountTerms 58574 entity includes various attributes, namely a Code 58576 attribute and a DueDate 58580 attribute.

The Code 58576 attribute is a CashDiscountTermsCode 58578 data type. The Code is a coded representation of an agreement of cash discounts for a payment. The DueDate 58580 attribute is a Date 58582 data type. The DueDate is the date on which the CashDiscountTerms related to the TradingOrder Item Sales becomes effective. The PricingTerms are the price information for the TradingOrder item sales. The PricingTerms 58584 entity includes various attributes, namely a CommodityObjectCalculationStatusCode 58586 attribute, a PriceComponent 58590 attribute, an EvaluationPeriodDataCompleteIndicator 58594 attribute, a ProvisionalCommodityTermAppliedIndicator 58598 attribute and a @actionCode 58602 attribute.

The CommodityObjectCalculationStatusCode 58586 attribute is a CalculationStatusCode 58588 data type. The CommodityObjectCalculationStatusCode is a coded representation of the calculation status of a commodity pricing object. The PriceComponent 58590 attribute is a PriceComponent 58592 data type. The PriceComponent is a component of the calculated price. The EvaluationPeriodDataCompleteIndicator 58594 attribute is an Indicator 58596 data type. The EvaluationPeriodDataCompleteIndicator indicates whether all data for period evaluation are taken into account or not.

The ProvisionalCommodityTermAppliedIndicator 58598 attribute is an Indicator 58600 data type. The ProvisionalCommodityTermAppliedIndicator indicates whether a provisional commodity term is applied during a period evaluation or not. The @actionCode 58602 attribute is an ActionCode 58604 data type. The ActionCode is the coded representation of the actions used to create, change and delete pricing terms for an item sales in a trading process at the message recipient. The TotalValues are the cumulated total values that occur in a TradingOrder item sales, for example, the total gross and net weight, volume, gross and net amount, tax amount, and freight costs. The TotalValues 58606 entity includes various attributes, namely a Quantity 58608 attribute, a NetPrice 58612 attribute, a GrossWeightMeasure 58616 attribute, a NetWeightMeasure 58620 attribute and a VolumeMeasure 58624 attribute.

The Quantity 58608 attribute is a Quantity 58610 data type. The Quantity is the total quantity of a product in a TradingOrder item sales. The NetPrice 58612 attribute is a Price 58614 data type. The NetPrice is the net price of a TradingOrder Item sales product referred to a base quantity. The GrossWeightMeasure 58616 attribute is a Measure 58618 data type. The GrossWeightMeasure is the gross weight of the product in an item of a TradingOrder sales.

The NetWeightMeasure 58620 attribute is a Measure 58622 data type. The NetWeightMeasure is the net weight of the product in an item of a TradingOrder sales. The VolumeMeasure 58624 attribute is a Measure 58626 data type. The VolumeMeasure is the volume of the product in an item of a TradingOrder sales. The SchedulingZone is a geographical place or zone used for scheduling of the TradingOrder sales item. The SchedulingZone 58628 entity includes various attributes, namely a LocationInternalID 58630 attribute and a TransportationZoneID 58634 attribute.

The LocationInternalID 58630 attribute is a LocationInternalID 58632 data type. The LocationInternalID is the unique identifier of the location into which or out of which the scheduling will take place. The TransportationZoneID 58634 attribute is a TransportationZoneID 58636 data type. The TransportationZoneID is the unique identifier of the transportation zone into which or out of which the scheduling will take place.

The TransportationEvent is an event planned to take place in the transportation process within the overall supply and trading process related to the sales item. The TransportationEvent 58638 entity includes various attributes, namely an OrdinalNumberValue 58640 attribute, a TypeCode 58644 attribute, a PriceRelevanceIndicator 58648 attribute, a LocationInternalID 58652 attribute, a PlannedStartDatePeriod 58656 attribute, a PlannedEndDatePeriod 58660 attribute, a DueDayNumberValue 58664 attribute, an InvertIndicator 58668 attribute and a @actionCode 58672 attribute. The OrdinalNumberValue 58640 attribute is an OrdinalNumberValue 58642 data type. The OrdinalNumberValue indicates the position of the transportation event in the list of transportation events related to the sales item.

The TypeCode 58644 attribute is a TransportationEventTypeCode 58646 data type. The TypeCode is the encoded representation of the type of a transportation event. The PriceRelevanceIndicator 58648 attribute is an Indicator 58650 data type. The PriceRelevanceIndicator is the indicator for a transportation event which is relevant for price calculation. The LocationInternalID 58652 attribute is a LocationInternalID 58654 data type. The LocationInternalID is the unique identifier of the location at which the transportation event will happen.

The PlannedStartDatePeriod 58656 attribute is an UPPEROPEN_DatePeriod 58658 data type. The PlannedStartDatePeriod is the period during which the transportation event is planned to start. The PlannedEndDatePeriod 58660 attribute is an UPPEROPEN_DatePeriod 58662 data type. The PlannedEndDatePeriod is the period during which the transportation event is planned to finish. The DueDayNumberValue 58664 attribute is a NumberValue 58666 data type. The DueDayNumberValue is the number of days before the scheduling date when the transportation event is due.

The InvertIndicator 58668 attribute is an Indicator 58670 data type. The InvertIndicator is the indicator that indicates whether the DueDayNumberValue has to be inverted or not. The @actionCode 58672 attribute is an ActionCode 58674 data type. The ActionCode is the coded representation of the actions used to create, change and delete transportation events for an item sales in a trading process at the message recipient. The Purchasing 58676 package includes a Purchasing 58678 entity.

The Purchasing is the buying part of the item. The Purchasing 58678 entity includes various attributes, namely a SellerReferenceID 58680 attribute, an ExchangeRateTypeCode 58684 attribute, a ProcessingStatusCode 58688 attribute, a BlockingStatusCode 58692 attribute, an ExchangeRate 58696 attribute, a CashDiscountDeductibleIndicator 58700 attribute, a PriceDeterminationDate 58704 attribute, a Date 58708 attribute, a QuotationValidityStartDate 58712 attribute, a DeliveryDate 58716 attribute, a @scheduleLineListCompleteTransmissionIndicator 58720 attribute, a @pricingTermsListCompleteTransmissionIndicator 58724 attribute, a @transportModeListCompleteTransmissionIndicator 58728 attribute and a @transportationEventListCompleteTransmissionIndicator 58732 attribute. The Purchasing 58678 entity includes various subordinate entities, namely a ScheduleLine 58736 entity, a DeliveryTerms 58754 entity, a TransportationNetwork 58764 entity, a TransportMode 58770 entity, a CashDiscountTerms 58780 entity, a PricingTerms 58794 entity, a TotalValues 58816 entity, a SchedulingZone 58838 entity and a TransportationEvent 58848 entity.

The SellerReferenceID 58680 attribute is a BusinessTransactionDocumentID 58682 data type. The SellerReferenceID is the reference identifier of the seller. The ExchangeRateTypeCode 58684 attribute is an ExchangeRateTypeCode 58686 data type. The ExchangeRateTypeCode is the coded representation of the type of an exchange rate. The ExchangeRateTypeCode is related to the currency of the TradingOrder Item Purchasing.

The ProcessingStatusCode 58688 attribute is a ProcessingStatusCode 58690 data type. The ProcessingStatusCode is a coded representation of a processing status. The BlockingStatusCode 58692 attribute is a BlockingStatusCode 58694 data type. The BlockingStatusCode is a coded representation of a blocking status. The ExchangeRate 58696 attribute is an ExchangeRate 58698 data type. The ExchangeRate is the representation of an exchange rate between two currencies: the currency of the TradingOrder Item Purchasing and the local currency.

The CashDiscountDeductibleIndicator 58700 attribute is an Indicator 58702 data type. The CashDiscountDeductibleIndicator is an indicator that indicates whether a cash discount can be deducted or not. The PriceDeterminationDate 58704 attribute is a Date 58706 data type. The PriceDeterminationDate is the date at which the price of a product is determined. The Date 58708 attribute is a Date 58710 data type. The Date is the date on which the purchasing document was created.

The QuotationValidityStartDate 58712 attribute is a Date 58714 data type. The QuotationValidityStartDate is the date on which the seller submitted the quotation. The DeliveryDate 58716 attribute is a Date 58718 data type. The DeliveryDate is the date at which a delivery takes place.

The @scheduleLineListCompleteTransmissionIndicator 58720 attribute is an Indicator 58722 data type. The scheduleLineListCompleteTransmissionIndicator indicates whether all schedule lines of an item purchasing are transmitted or not. The @pricingTermsListCompleteTransmissionIndicator 58724 attribute is an Indicator 58726 data type. The pricingTermsListCompleteTransmissionIndicator indicates whether all pricing terms of an item purchasing are transmitted or not.

The @transportModeListCompleteTransmissionIndicator 58728 attribute is an Indicator 58730 data type. The transportModeListCompleteTransmissionIndicator indicates whether all transport modes of an item purchase are transmitted or not. The @transportationEventListCompleteTransmissionIndicator 58732 attribute is an Indicator 58734 data type. The transportationEventListCompleteTransmissionIndicator indicates whether all transportation events of an item purchase are transmitted or not.

The ScheduleLine is an agreement that specifies when and in what quantity products of an item are used by the buyer for the TradingOrder item purchasing. The ScheduleLine 58736 entity includes various attributes, namely an ID 58738 attribute, a RequestedQuantity 58742 attribute, a DeliveryDate 58746 attribute and a @actionCode 58750 attribute. The ID 58738 attribute is a BusinessTransactionDocumentItemScheduleLineID 58740 data type. The ID is the unique identifier for a ScheduleLine in the TradingOrder item purchasing.

The RequestedQuantity 58742 attribute is a Quantity 58744 data type. The RequestedQuantity is the quantity that is requested for a ScheduleLine. The DeliveryDate 58746 attribute is a Date 58748 data type. The DeliveryDate is the date at which the delivery takes place. The @actionCode 58750 attribute is an ActionCode 58752 data type. The ActionCode is the coded representation of the actions used to create, change and delete schedule lines for an item purchasing in a trading process at the message recipient. The DeliveryTerms are the conditions and agreements that are valid for executing the delivery of ordered material of TradingOrder item purchasing. The DeliveryTerms 58754 entity includes various attributes, namely an Incoterms 58756 attribute and a QuantityTolerance 58760 attribute.

The Incoterms 58756 attribute is an Incoterms 58758 data type. The Incoterms are typical contract formulations for delivery conditions that correspond to the rules defined by the International Chamber of Commerce (ICC). The QuantityTolerance 58760 attribute is a QuantityTolerance 58762 data type. The QuantityTolerance is the tolerated difference between a requested and an actual quantity (e.g.; a delivery quantity) as a percentage. The TransportationNetwork is a single, in-transit stock-holding object used for inventory management purposes. The TransportationNetwork 58764 entity includes an ID 58766 attribute.

The ID 58766 attribute is a TransportationNetworkID 58768 data type. The ID is the unique identifier of the transportation Network. The TransportMode is the way in which product is shipped. The TransportMode 58770 entity includes various attributes, namely a Code 58772 attribute and a @actionCode 58776 attribute. The Code 58772 attribute is a TransportModeCode 58774 data type. The Code is the encoded representation of the mode of transportation.

The @actionCode 58776 attribute is an ActionCode 58778 data type. The ActionCode is the coded representation of the actions used to create, change and delete transport modes for an item purchasing in a trading process at the message recipient. The CashDiscountTerms is a set of control information which is relevant for payment in the TradingOrder item purchasing. The CashDiscountTerms 58780 entity includes various attributes, namely a Code 58782 attribute, a Code 58786 attribute and a DueDate 58790 attribute.

The Code 58782 attribute is a CashDiscountTermsCode 58784 data type. The Code is a coded representation of an agreement of cash discounts for a payment. The Code 58786 attribute is a CashDiscountTermsCode 58788 data type. The Code is a coded representation of an agreement of cash discounts for a payment. The DueDate 58790 attribute is a Date 58792 data type. The DueDate is the date on which the CashDiscountTerms related to the TradingOrder Item Purchasing becomes effective.

The PricingTerms is the price information for the TradingOrder item purchasing. The PricingTerms 58794 entity includes various attributes, namely a CommodityObjectCalculationStatusCode 58796 attribute, a PriceComponent 58800 attribute, an EvaluationPeriodDataCompleteIndicator 58804 attribute, a ProvisionalCommodityTermAppliedIndicator 58808 attribute and a @actionCode 58812 attribute. The CommodityObjectCalculationStatusCode 58796 attribute is a CalculationStatusCode 58798 data type. The CommodityObjectCalculationStatusCode is a coded representation of the calculation status of a commodity pricing object.

The PriceComponent 58800 attribute is a PriceComponent 58802 data type. The PriceComponent is a component of the calculated price. The EvaluationPeriodDataCompleteIndicator 58804 attribute is an Indicator 58806 data type. The EvaluationPeriodDataCompleteIndicator indicates whether all data for period evaluation are taken into account or not. The ProvisionalCommodityTermAppliedIndicator 58808 attribute is an Indicator 58810 data type. The ProvisionalCommodityTermAppliedIndicator indicates whether a provisional commodity term is applied during a period evaluation or not.

The @actionCode 58812 attribute is an ActionCode 58814 data type. The ActionCode is the coded representation of the actions used to create, change and delete pricing terms for an item purchasing in a trading process at the message recipient. The TotalValues are the cumulated total values that occur in a TradingOrder item purchasing, for example, the gross and net weight, volume, gross and net amount, tax amount, and freight costs. The TotalValues 58816 entity includes various attributes, namely a Quantity 58818 attribute, a NetPrice 58822 attribute, a GrossWeightMeasure 58826 attribute, a NetWeightMeasure 58830 attribute and a VolumeMeasure 58834 attribute.

The Quantity 58818 attribute is a Quantity 58820 data type. The Quantity is the total quantity of a product in a TradingOrder item purchasing. The NetPrice 58822 attribute is a Price 58824 data type. The NetPrice is the net price of a TradingOrder Item purchasing product referred to a base quantity. The GrossWeightMeasure 58826 attribute is a Measure 58828 data type. The GrossWeightMeasure is the gross weight of the product in an item of a TradingOrder purchasing. The NetWeightMeasure 58830 attribute is a Measure 58832 data type. The NetWeightMeasure is the net weight of the product in an item of a TradingOrder purchasing. The VolumeMeasure 58834 attribute is a Measure 58836 data type. The VolumeMeasure is the volume of the product in an item of a TradingOrder purchasing.

The SchedulingZone is a geographical place or zone used for scheduling of the TradingOrder purchasing item. The SchedulingZone 58838 entity includes various attributes, namely a LocationInternalID 58840 attribute and a TransportationZoneID 58844 attribute. The LocationInternalID 58840 attribute is a LocationInternalID 58842 data type. The LocationInternalID is the unique identifier of the location into which or out of which the scheduling will take place. The TransportationZoneID 58844 attribute is a TransportationZoneID 58846 data type. The TransportationZoneID is the unique identifier of the transportation zone into which or out of which the scheduling will take place.

The TransportationEvent is an event planned to take place in the transportation process within the overall supply and trading process related to the purchasing item. The TransportationEvent 58848 entity includes various attributes, namely an OrdinalNumberValue 58850 attribute, a TypeCode 58854 attribute, a PriceRelevanceIndicator 58858 attribute, a LocationInternalID 58862 attribute, a PlannedStartDatePeriod 58866 attribute, a PlannedEndDatePeriod 58870 attribute, a DueDayNumberValue 58874 attribute, an InvertIndicator 58878 attribute and a @actionCode 58882 attribute.

The OrdinalNumberValue 58850 attribute is an OrdinalNumberValue 58852 data type. The OrdinalNumberValue indicates the position of the transportation event in the list of transportation events related to the purchasing item. The TypeCode 58854 attribute is a TransportationEventTypeCode 58856 data type. The TypeCode is the encoded representation of the type of a transportation event. The PriceRelevanceIndicator 58858 attribute is an Indicator 58860 data type. The PriceRelevanceIndicator indicates a transportation event which is relevant for price calculation. The LocationInternalID 58862 attribute is a LocationInternalID 58864 data type. The LocationInternalID is the unique identifier of the location at which the transportation event will happen.

The PlannedStartDatePeriod 58866 attribute is an UPPEROPEN_DatePeriod 58868 data type. The PlannedStartDatePeriod is the period during which the transportation event is planned to start. The PlannedEndDatePeriod 58870 attribute is an UPPEROPEN_DatePeriod 58872 data type. The PlannedEndDatePeriod is the period during which the transportation event is planned to finish. The DueDayNumberValue 58874 attribute is a NumberValue 58876 data type. The DueDayNumberValue is the number of days before the scheduling date when the transportation event is due.

The InvertIndicator 58878 attribute is an Indicator 58880 data type. The InvertIndicator indicates whether the DueDayNumberValue has to be inverted or not. The @actionCode 58882 attribute is an ActionCode 58884 data type. The ActionCode is the coded representation of the actions used to create, change and delete transportation events for an item purchasing in a trading process at the message recipient. The BusinessTransactionDocumentReference 58886 package includes various entities, namely an OriginTradingOrderReference 58888 entity and a TradingOrderReference 58894 entity.

The BusinessTransactionDocumentReference package groups together all the references to business documents that are relevant for the item. The OriginTradingOrderReference 58888 entity includes an OriginBusinessTransactionDocumentReference 58890 attribute. The OriginBusinessTransactionDocumentReference 58890 attribute is a BusinessTransactionDocumentReference 58892 data type. The OriginBusinessTransactionDocumentReference is a reference to the origin business transaction document. The TradingOrderReference is a reference to a trading order. The TradingOrderReference 58894 entity includes various attributes, namely an ID 58896 attribute and an ItemID 58900 attribute.

The ID 58896 attribute is a TradingOrderID 58898 data type. The ID is the identifier of the referenced trading order. The ItemID 58900 attribute is a TradingOrderItemID 58902 data type. The ItemID is the identifier of the referenced trading order item. The TextCollection 58904 package includes a TextCollection 58906 entity. The TextCollection package groups together all the texts regarding the trading order item. The TextCollection 58906 entity includes a TextCollection 58908 attribute.

The TextCollection 58908 attribute is a TextCollection 58910 data type. The TextCollection is a collection of all text descriptions linked to the TradingOrder item. The Selection 58912 package includes a Selection 58914 entity. The Selection 58912 package includes a TradingOrderByIDQuery 58916 package. The Selection package contains the selection criteria for a TradingOrder. The TradingOrderByIDQuery 58916 package includes a TradingOrderByID 58918 entity.

The TradingOrderSelectionByID specifies the criteria to select a TradingOrder. The TradingOrderByID 58918 entity includes an ID 58920 attribute. The ID 58920 attribute is a TradingOrderID 58922 data type. The ID is the unique identifier of the TradingOrder. The Selection 58924 package includes a Selection 58926 entity. The Selection package contains the selection criteria for a TradingOrder. The ProcessingConditions 58952 package includes a ProcessingConditions 58954 entity. The ProcessingConditions specifies the processing conditions to select TradingOrders. The ProcessingConditions 58954 entity includes various attributes, namely a QueryHitsMaximumNumberValue 58956 attribute, an UnlimitedQueryHitsIndicator 58960 attribute and a LastProvidedTradingOrderID 58964 attribute. The QueryHitsMaximumNumberValue 58956 attribute is a NumberValue 58958 data type. The QueryHitsMaximumNumberValue describes how many hits the response shall contain as maximum. The QueryHitsMaximumNumberValue default value can be 100.

The UnlimitedQueryHitsIndicator 58960 attribute is an Indicator 58962 data type. The UnlimitedQueryHitsIndicator indicates whether all hits shall be delivered. The LastProvidedTradingOrderID 58964 attribute is a TradingOrderID 58966 data type. The LastProvidedTradingOrderID contains the TradingOrderID which was provided by the last response. The Log 58968 package includes a Log 58970 entity. The Log package groups the messages used for user interaction. The Log 58970 entity includes a Log 58972 attribute. The Log 58972 attribute is a Log 58974 data type. The log is a sequence of messages that result when an application executes a task.

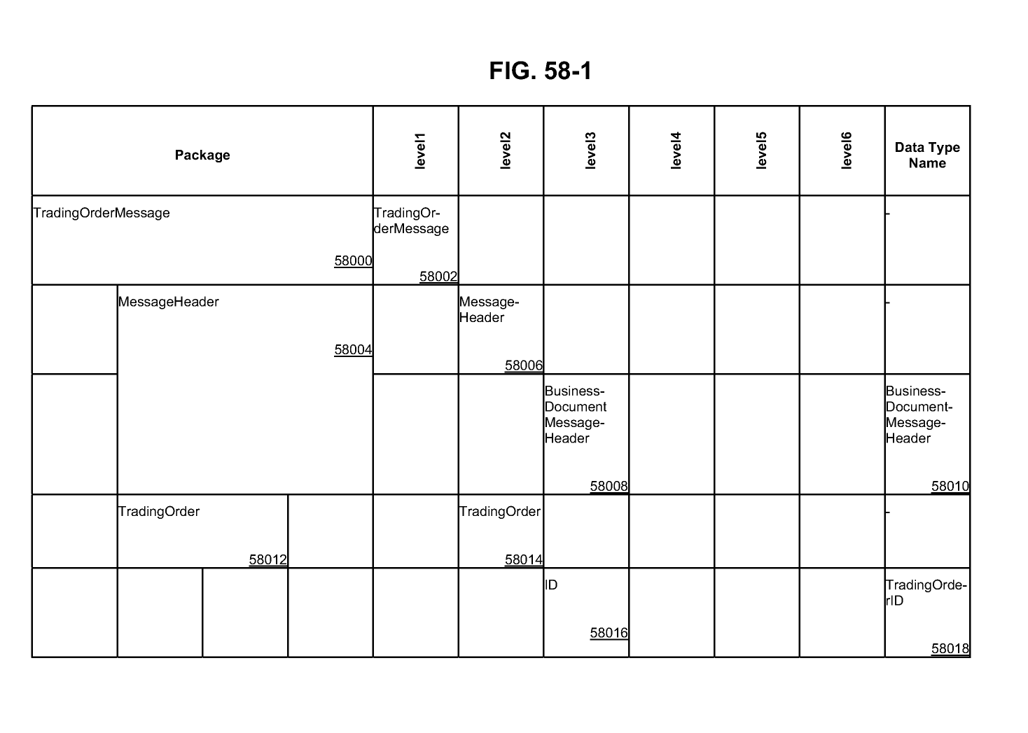

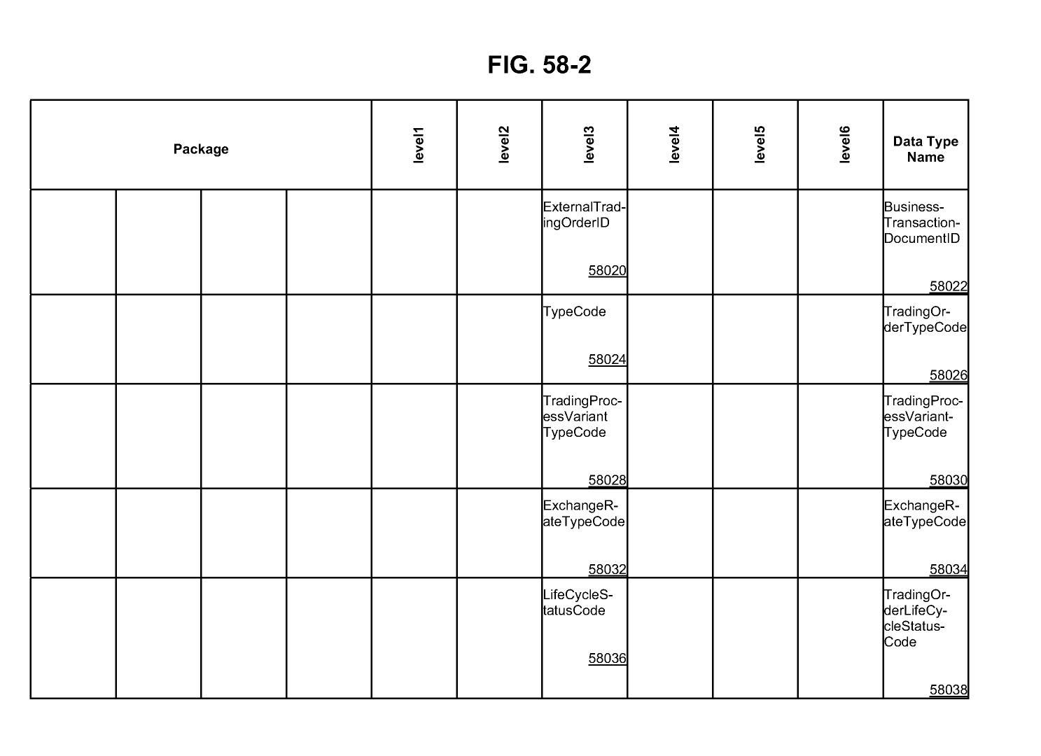

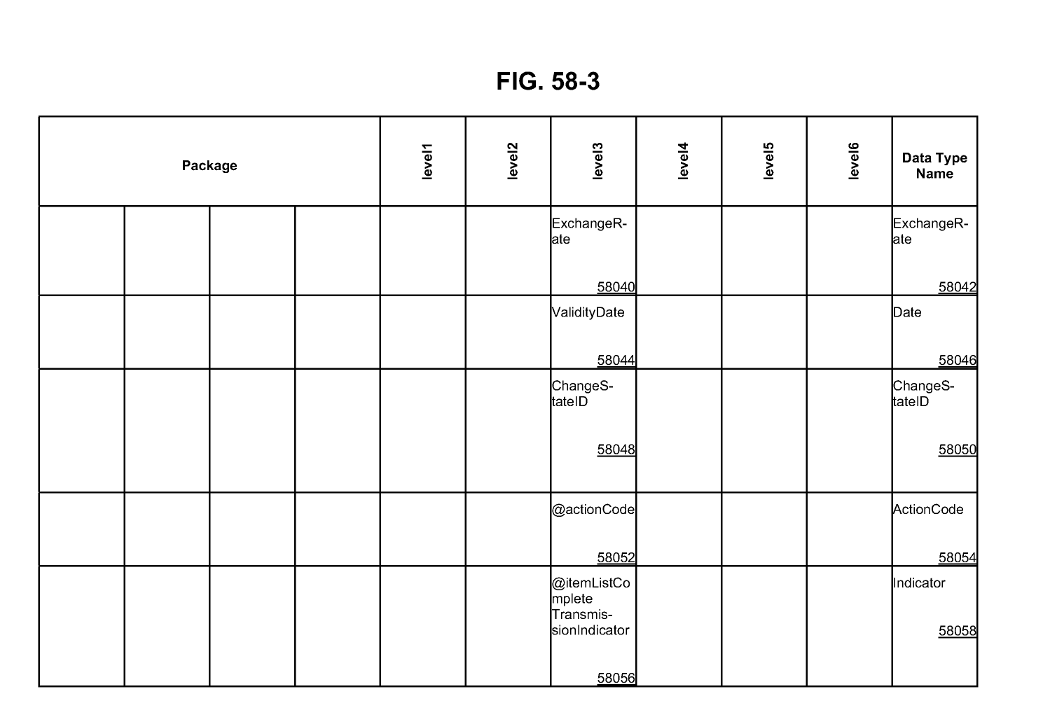

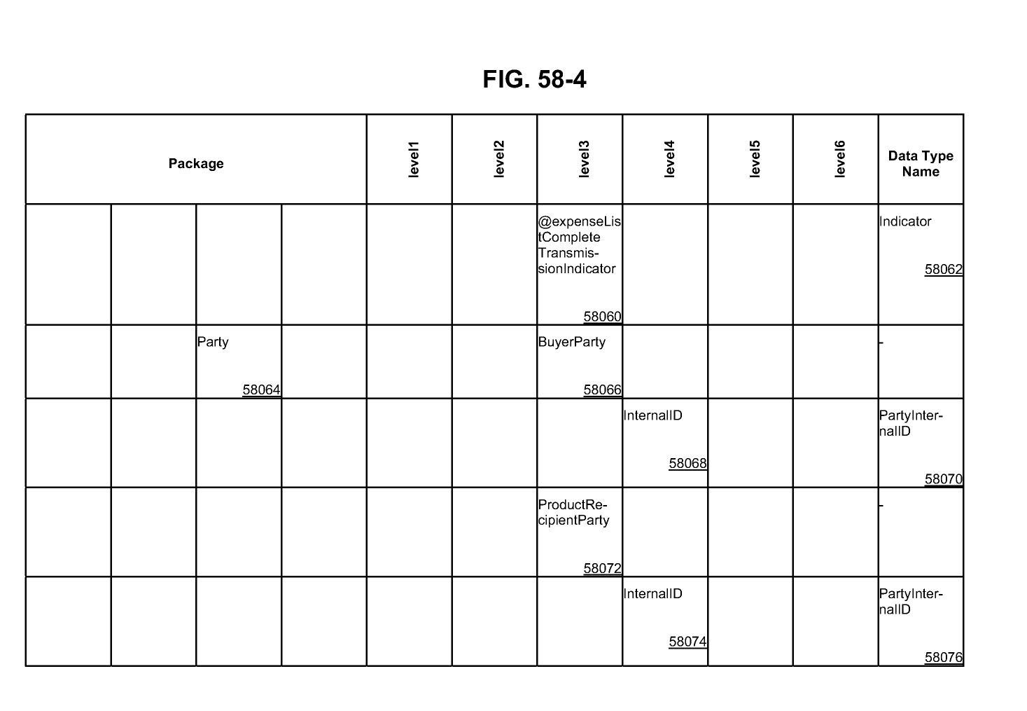

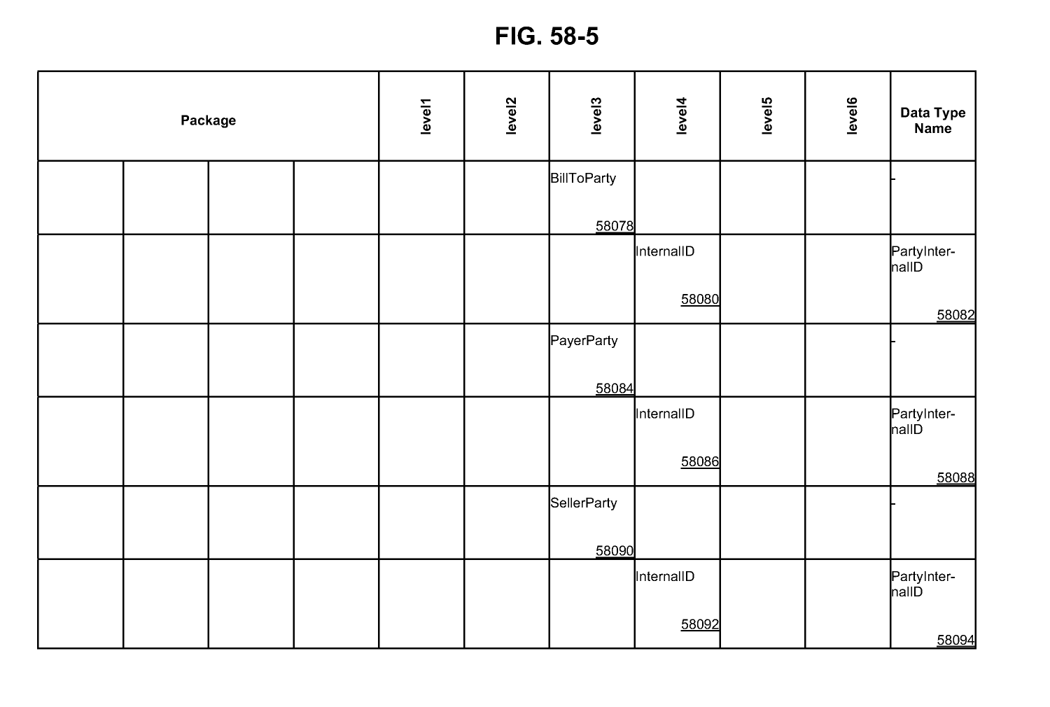

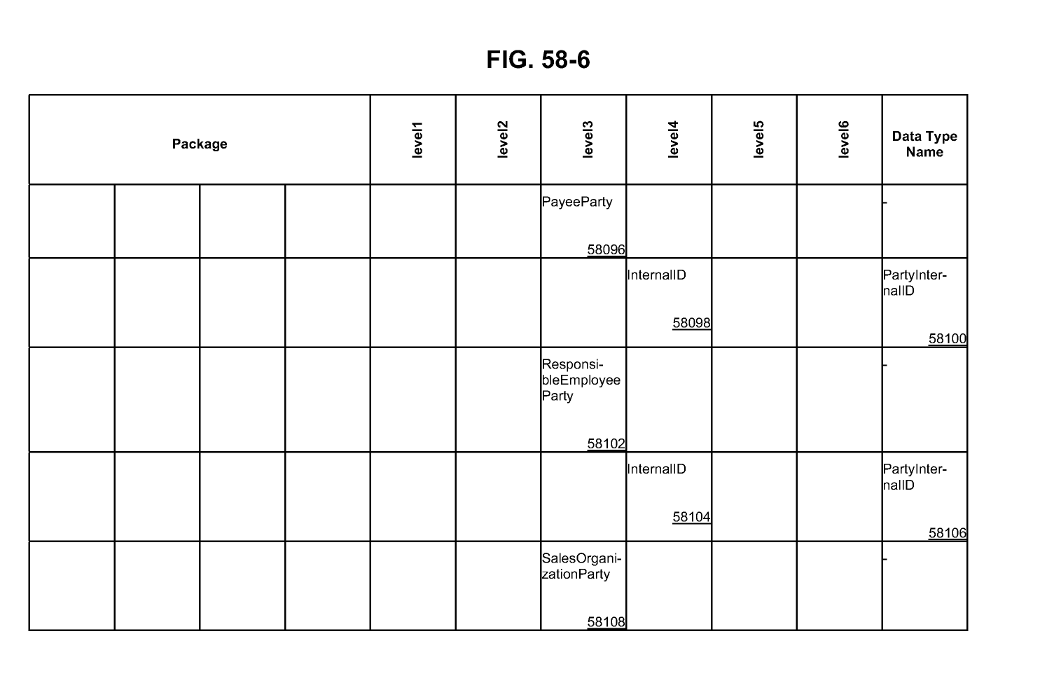

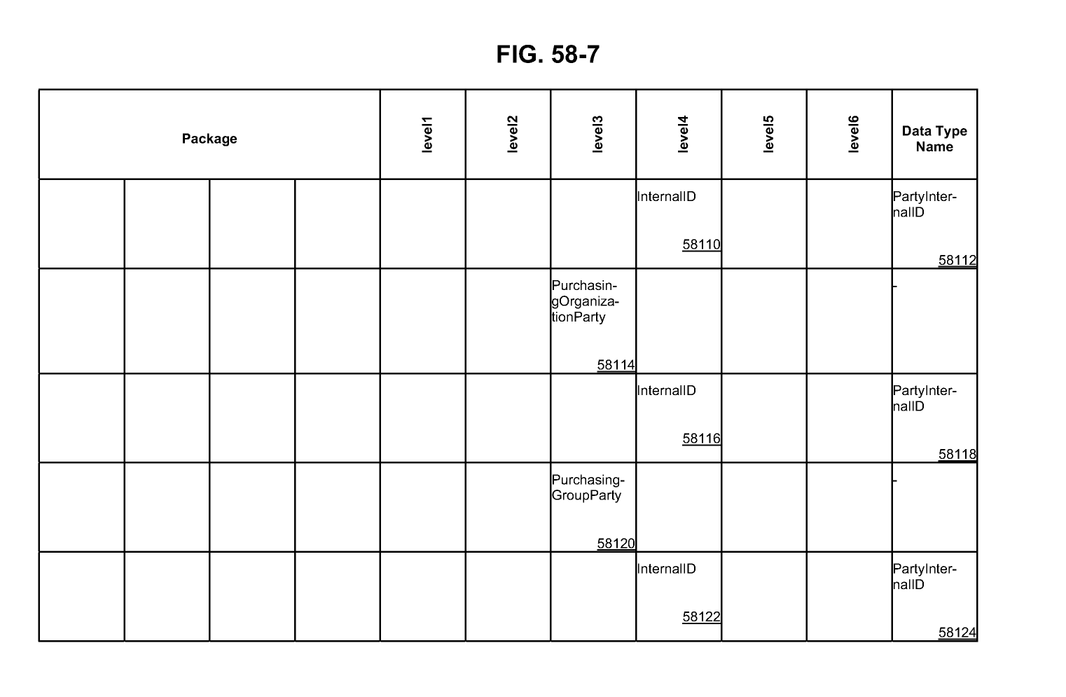

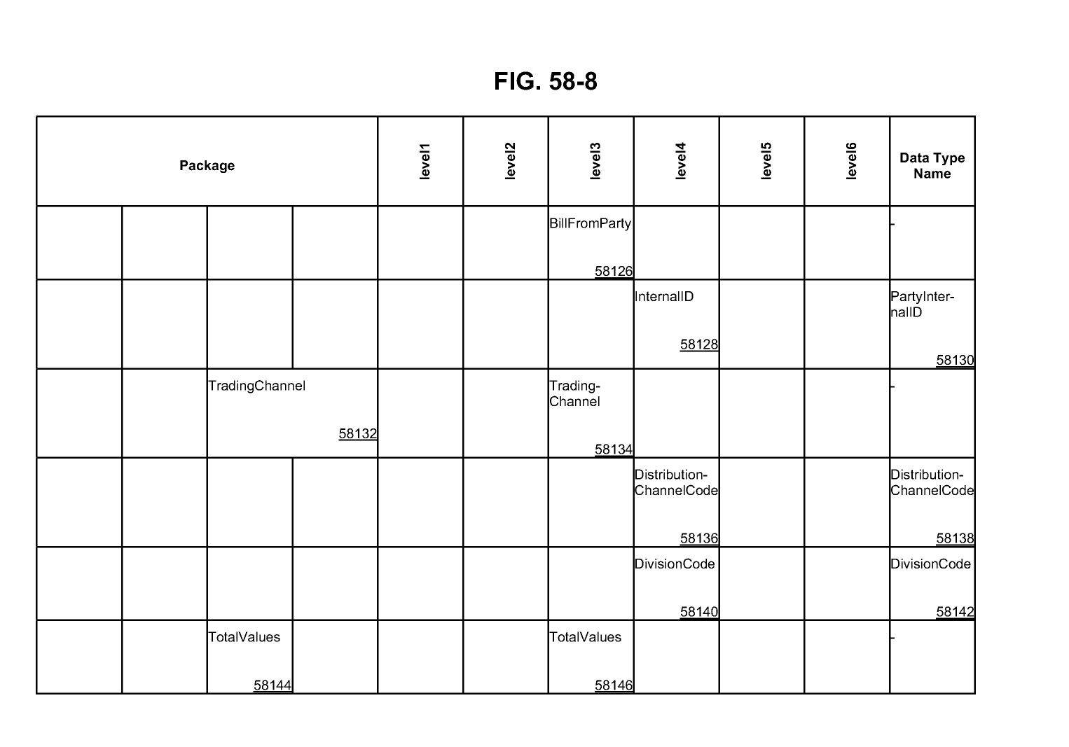

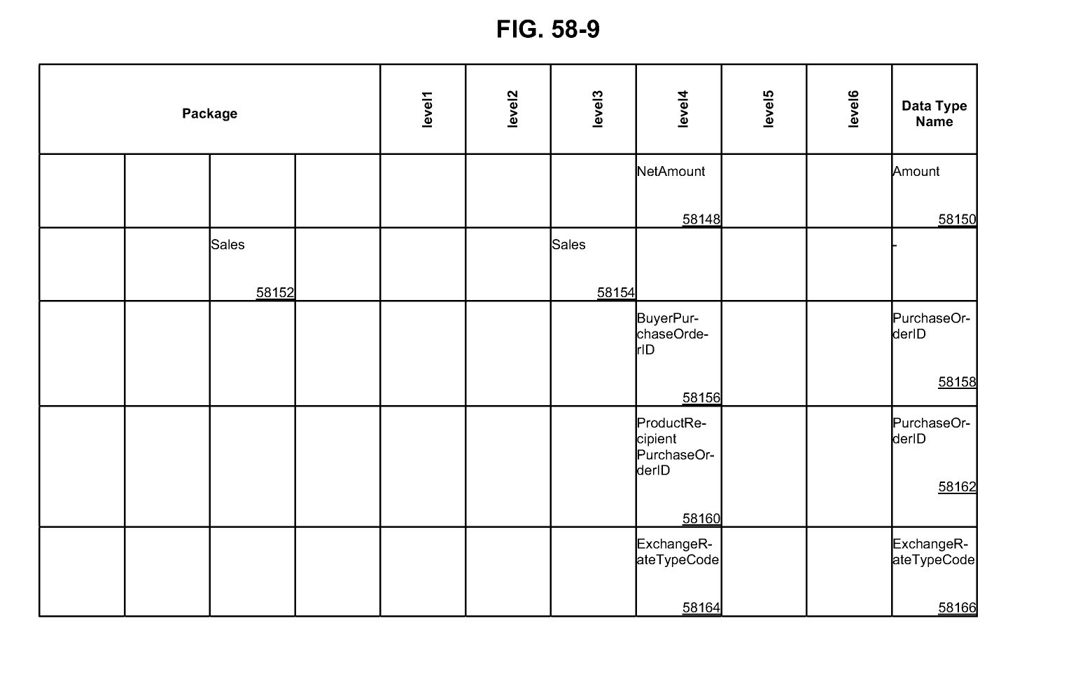

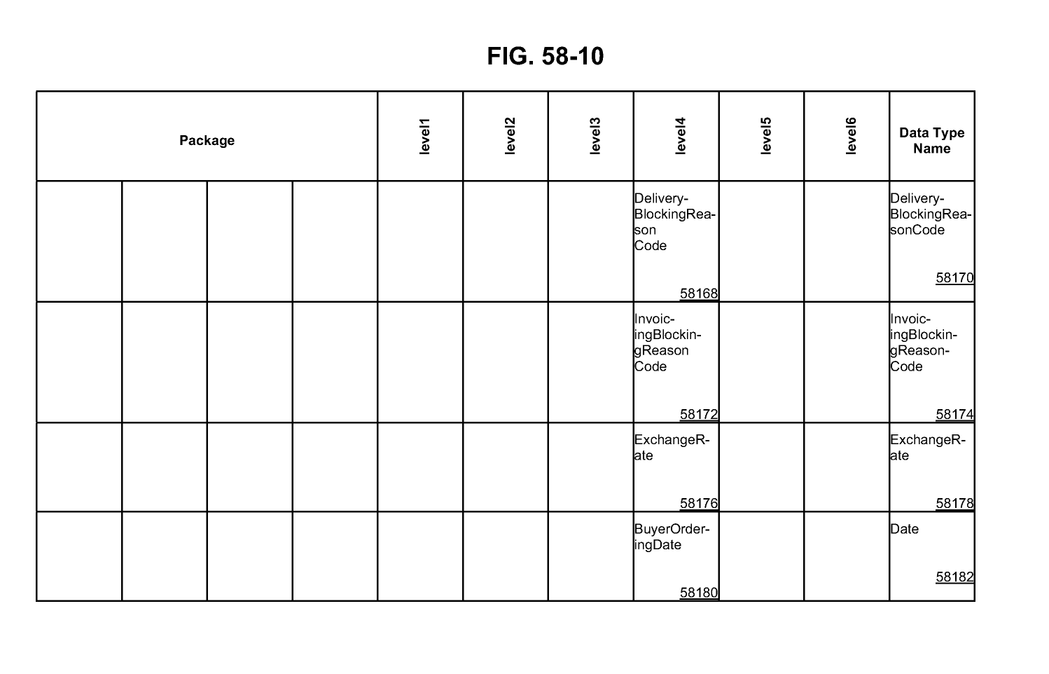

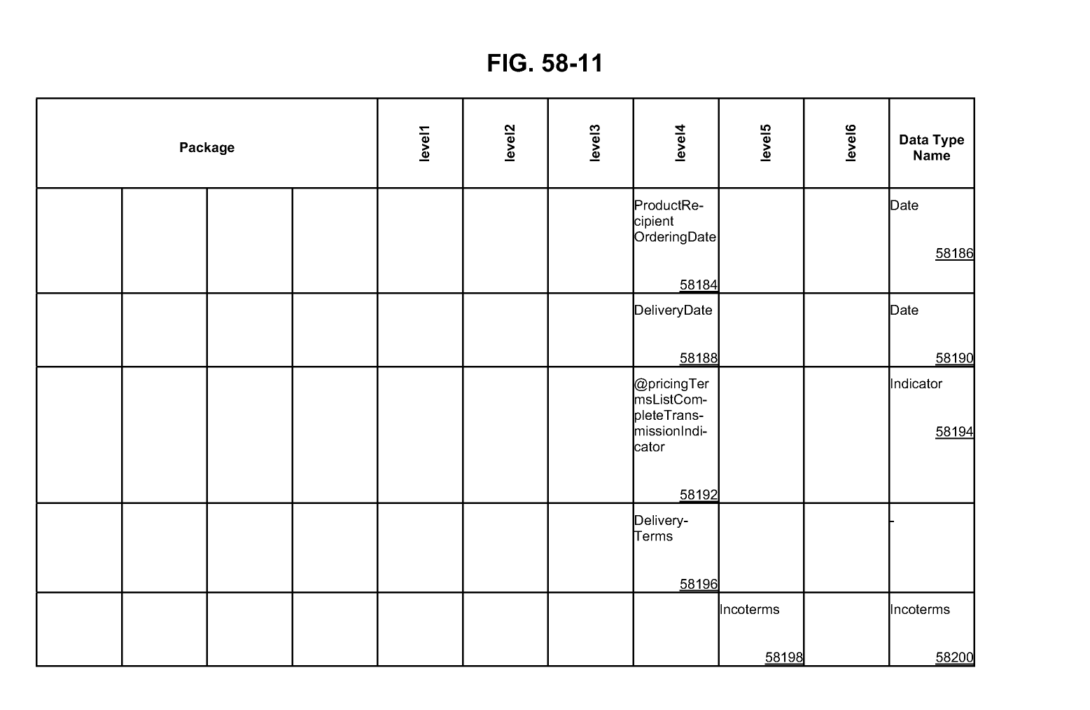

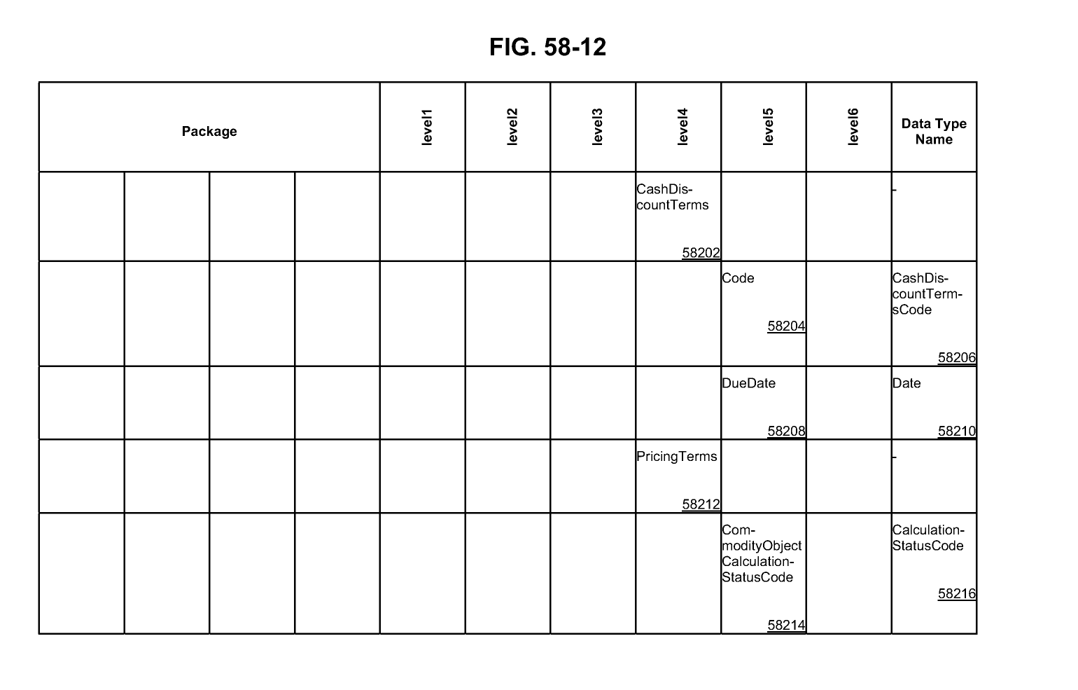

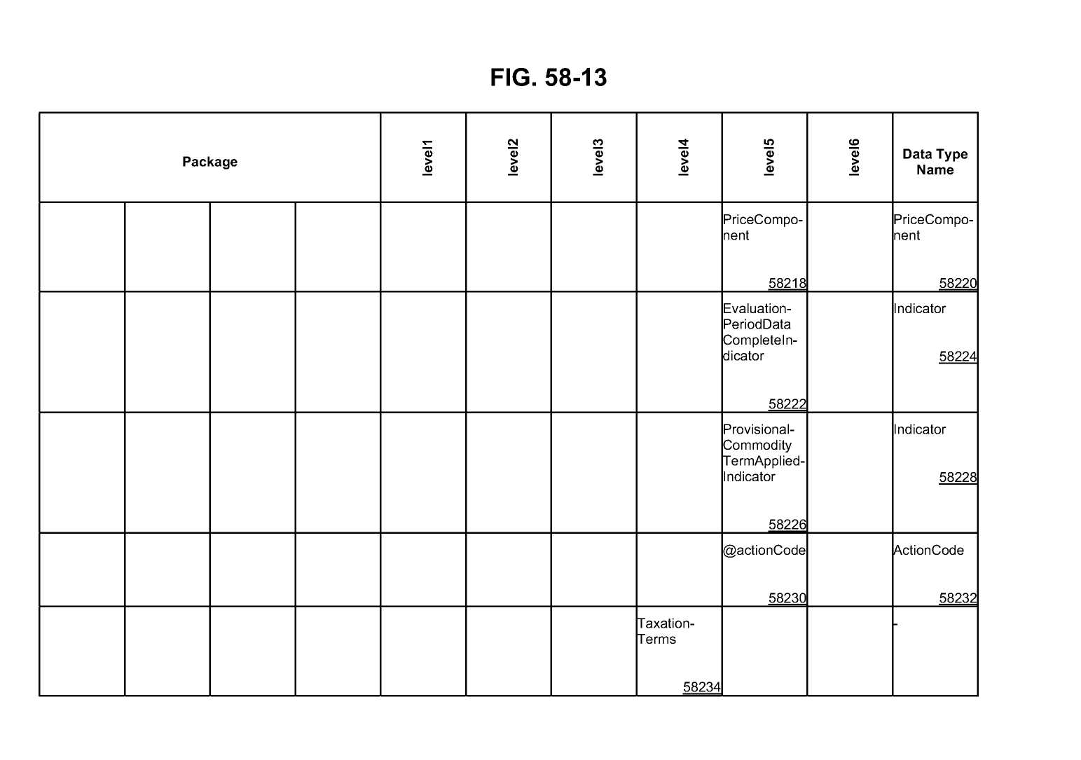

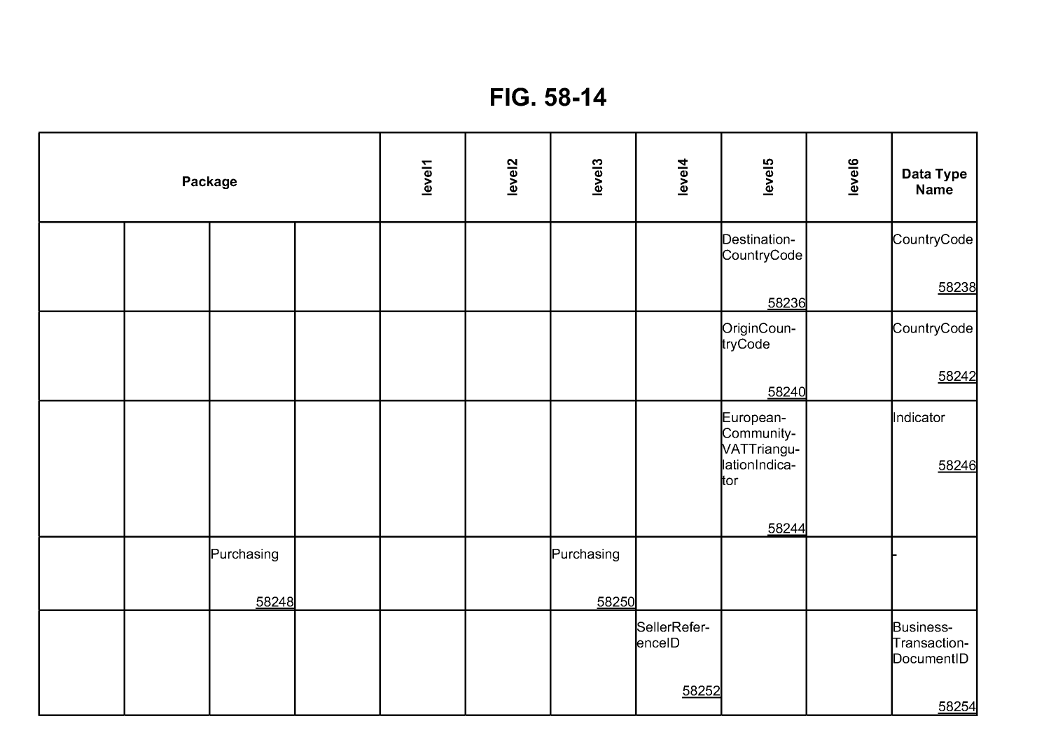

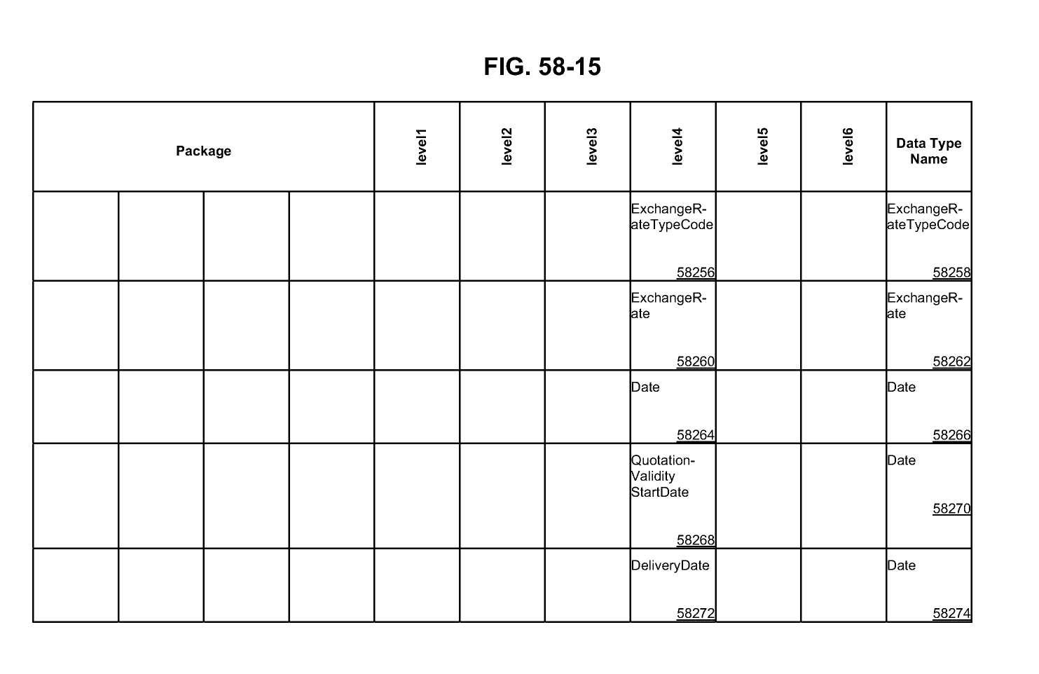

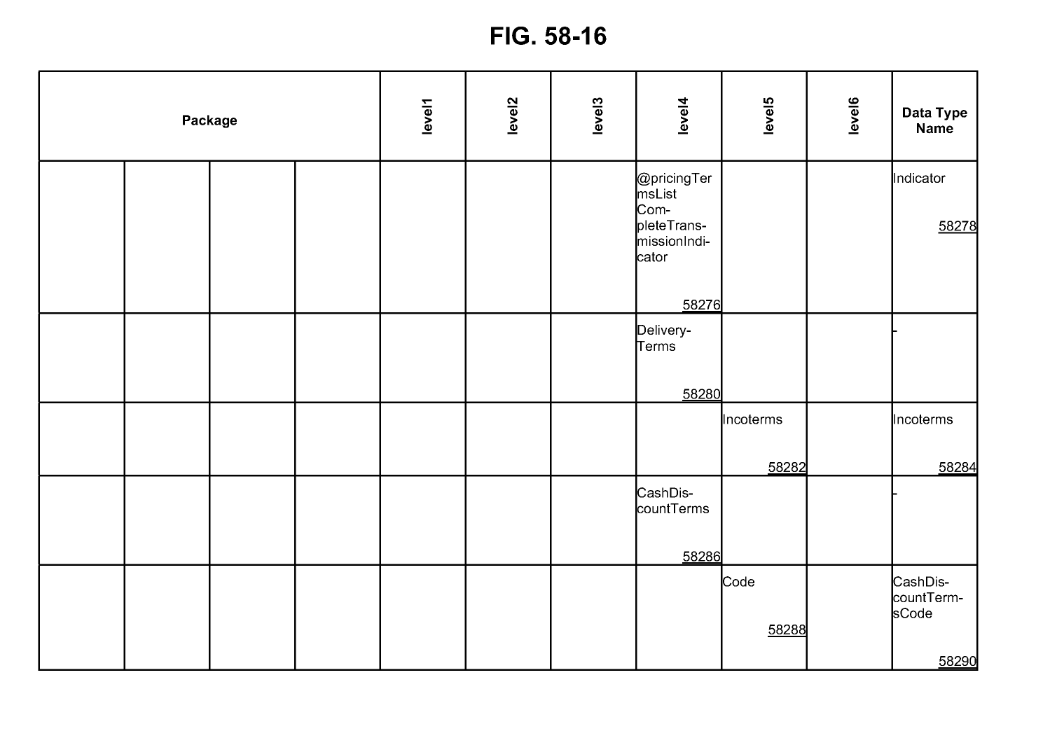

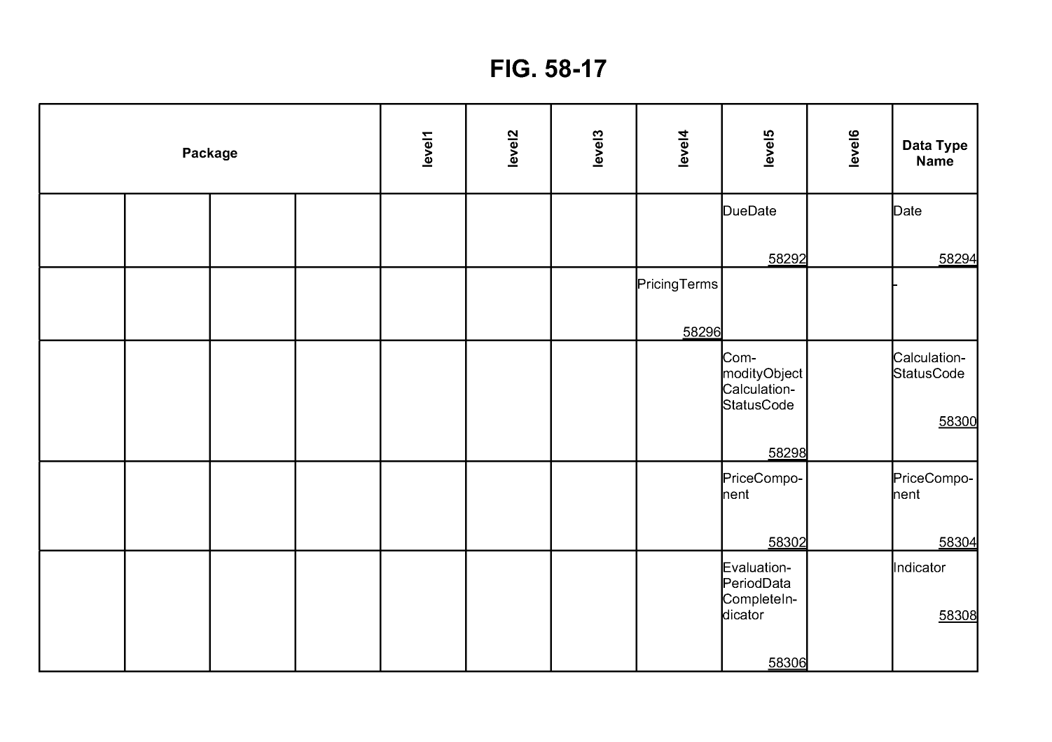

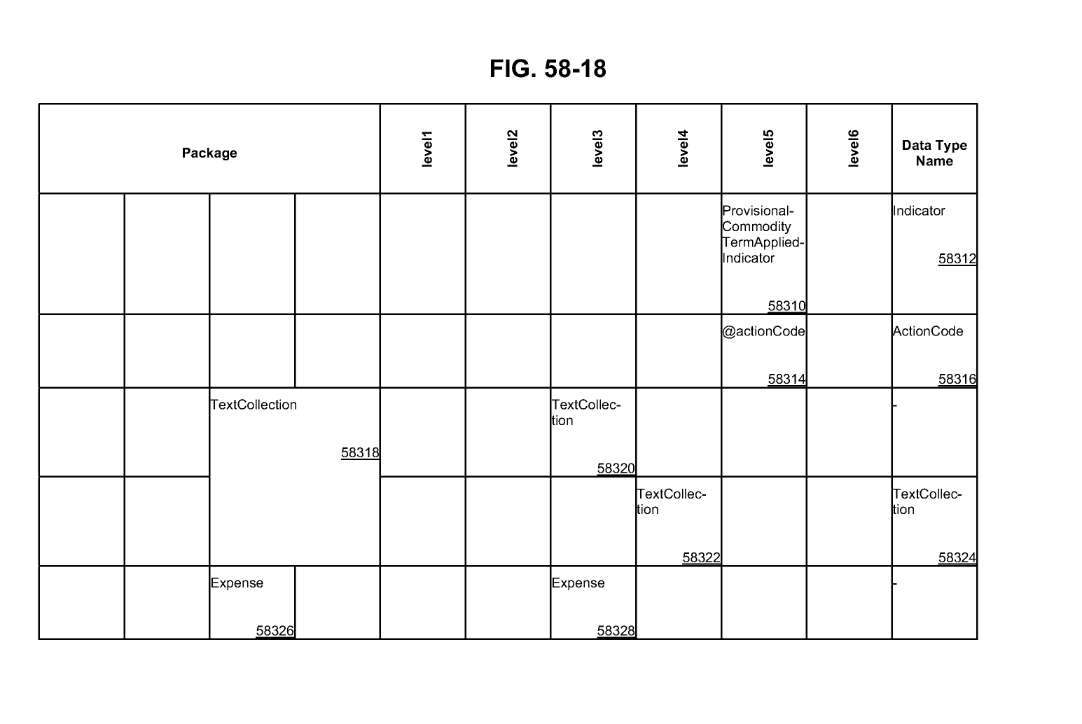

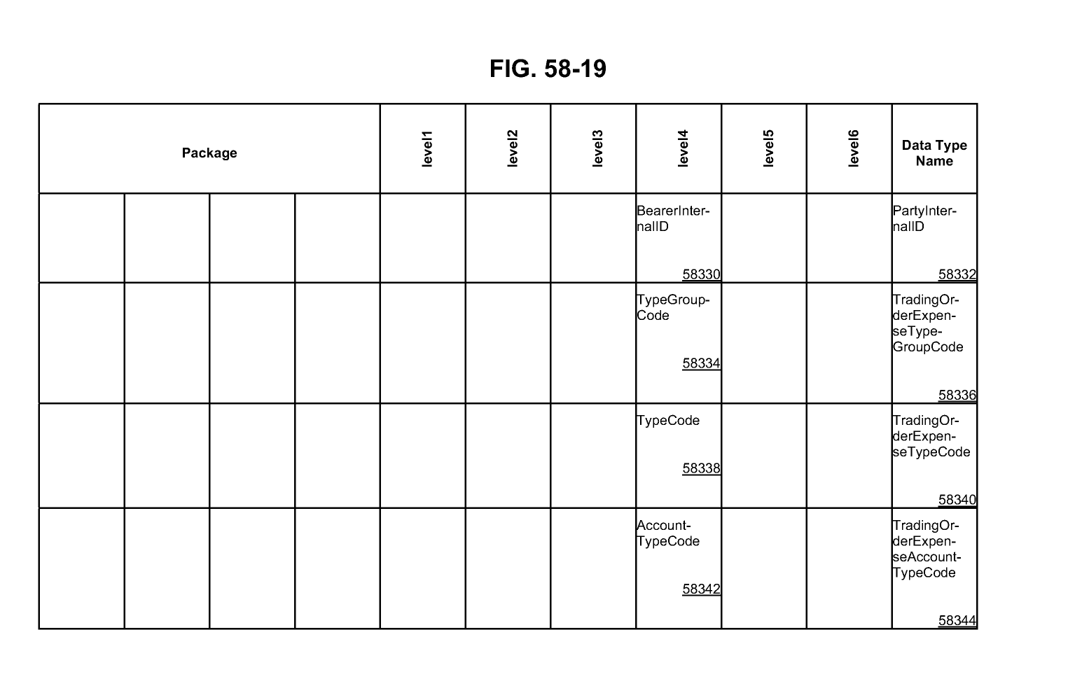

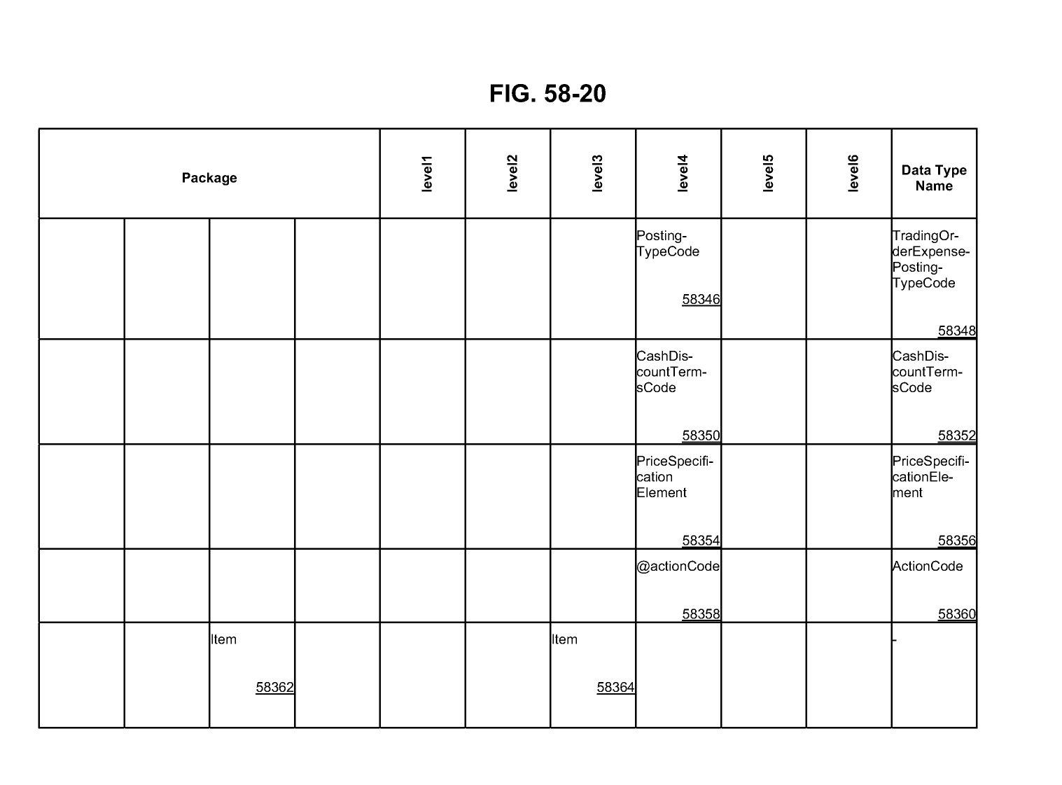

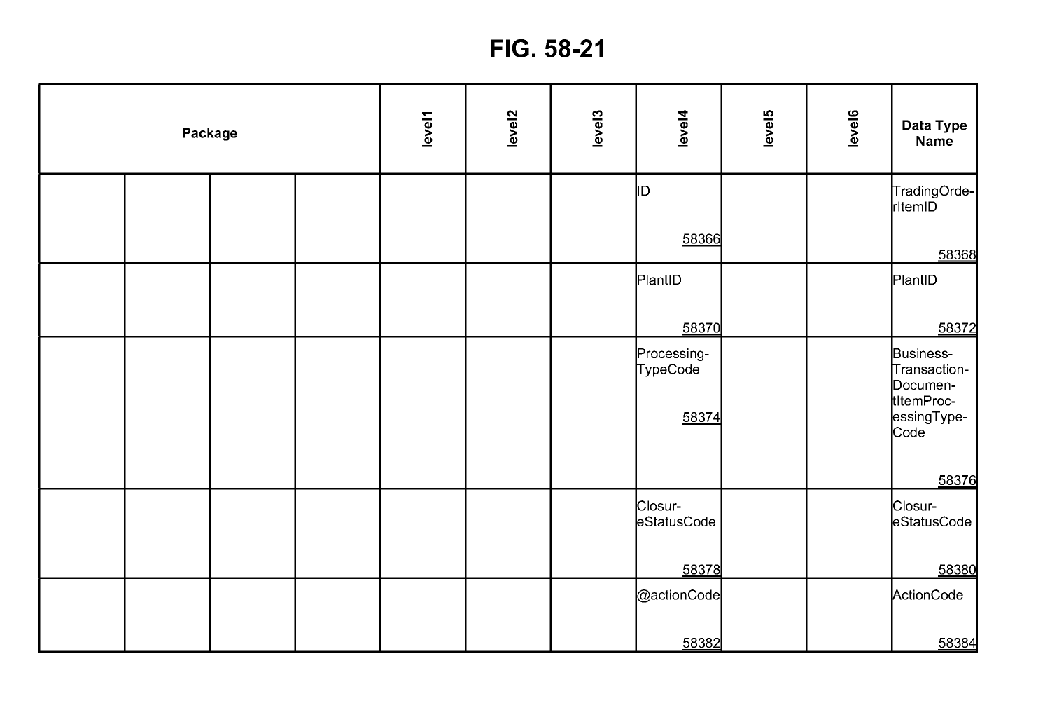

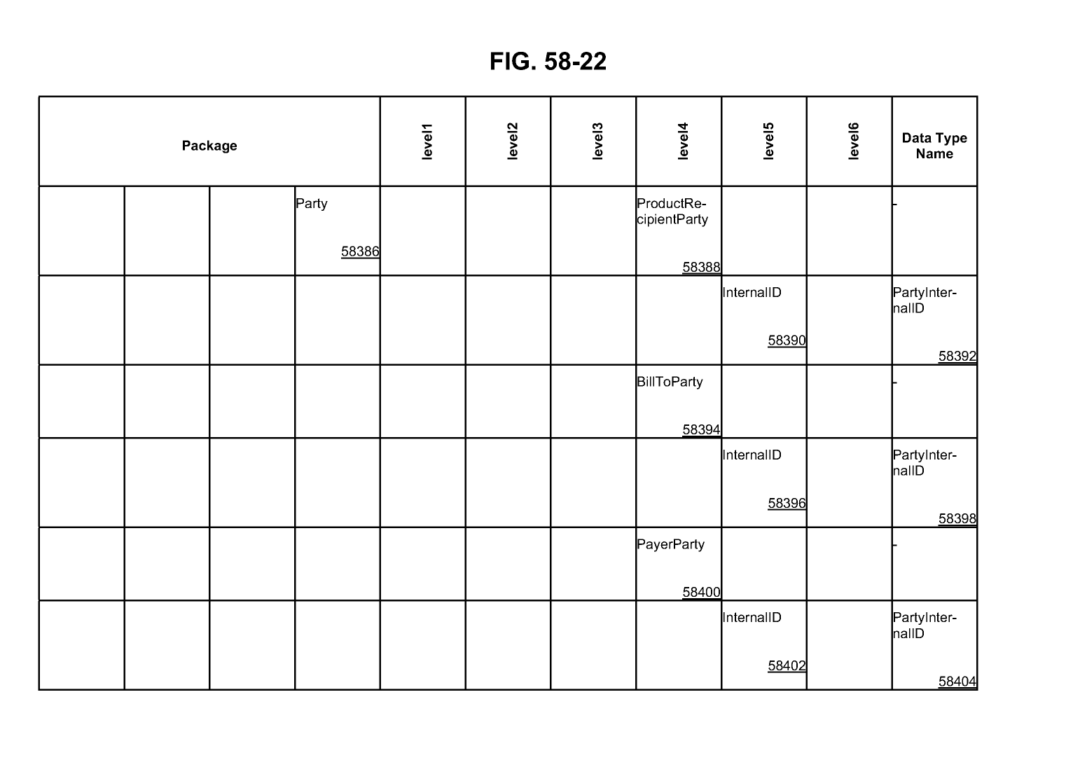

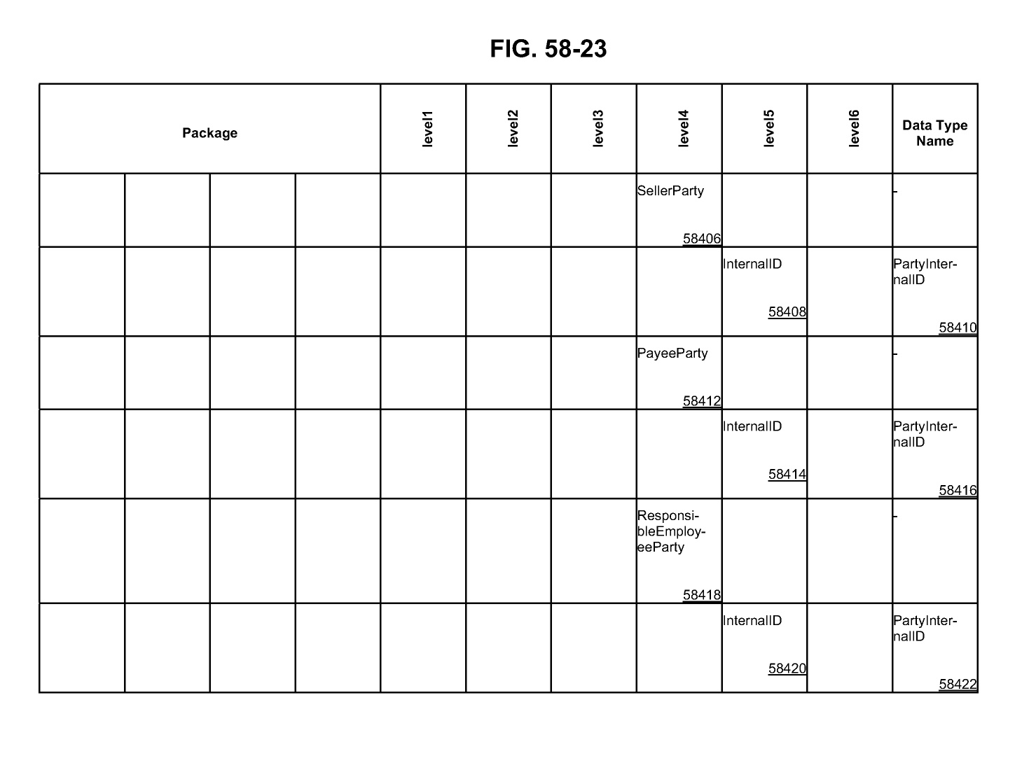

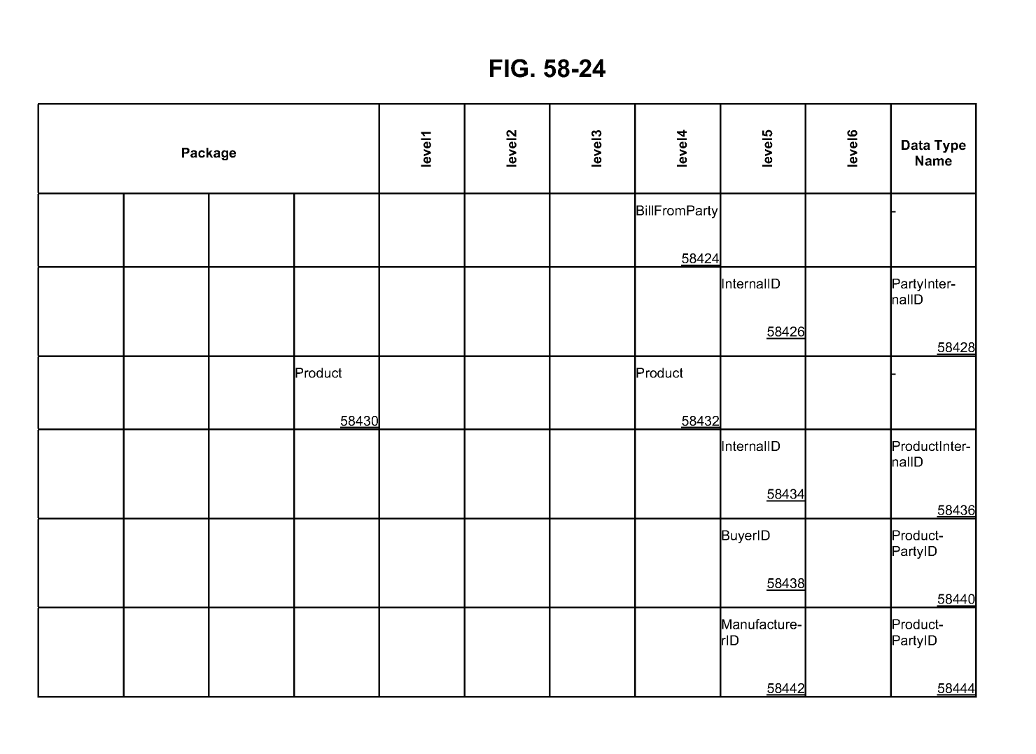

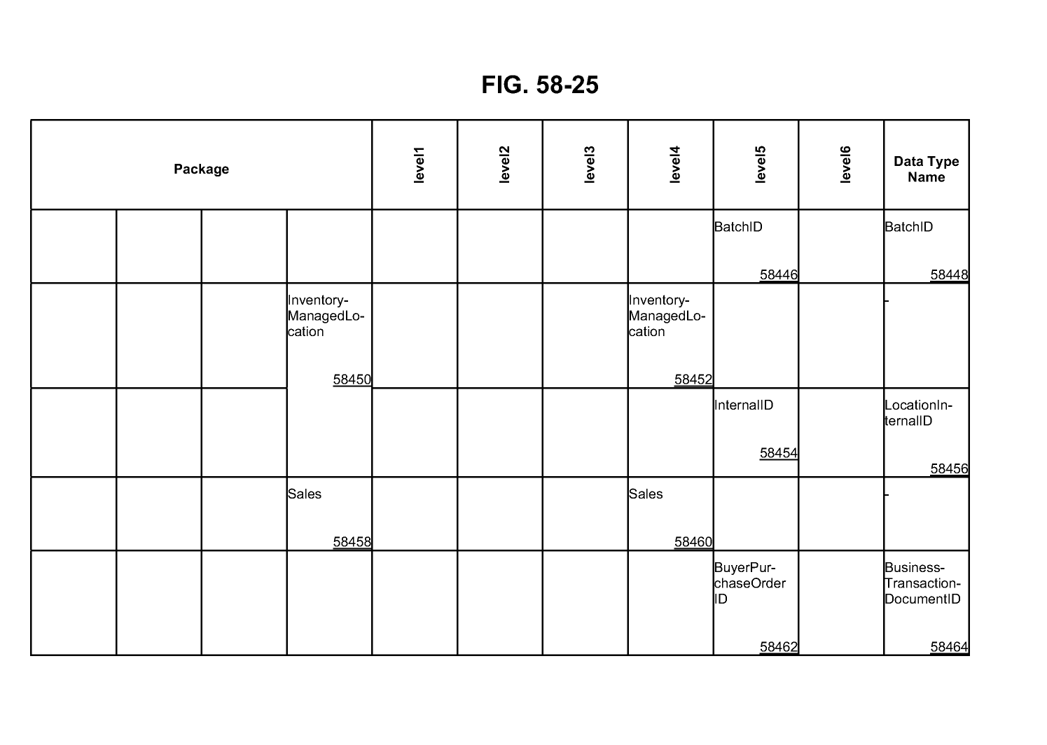

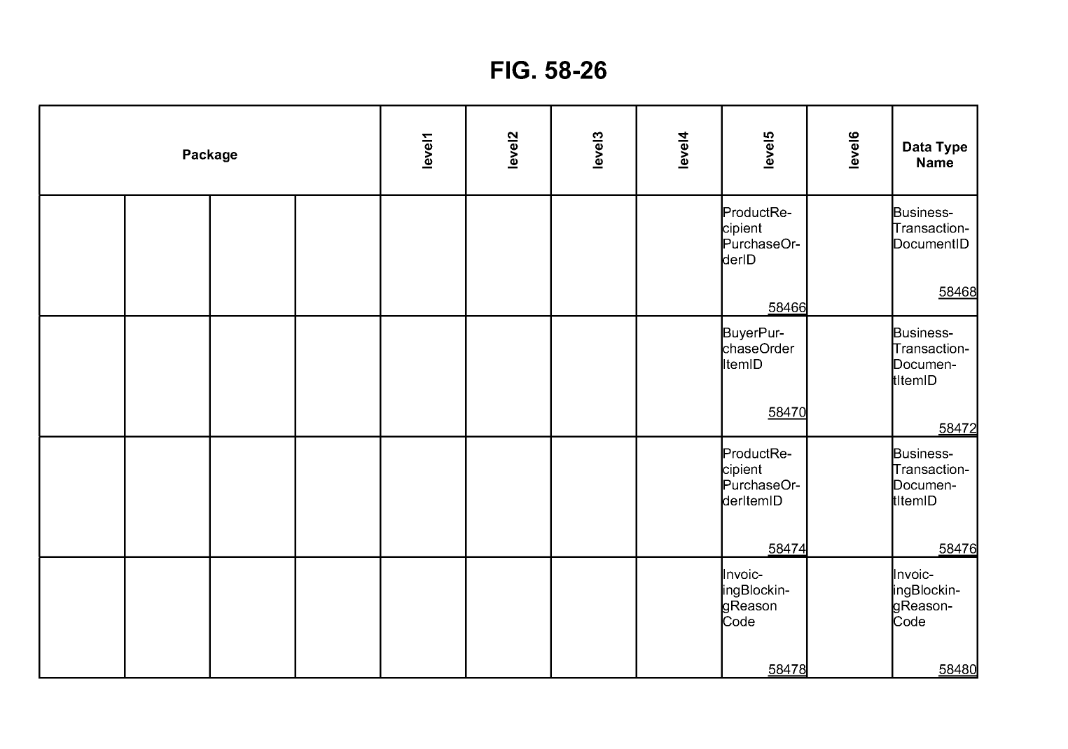

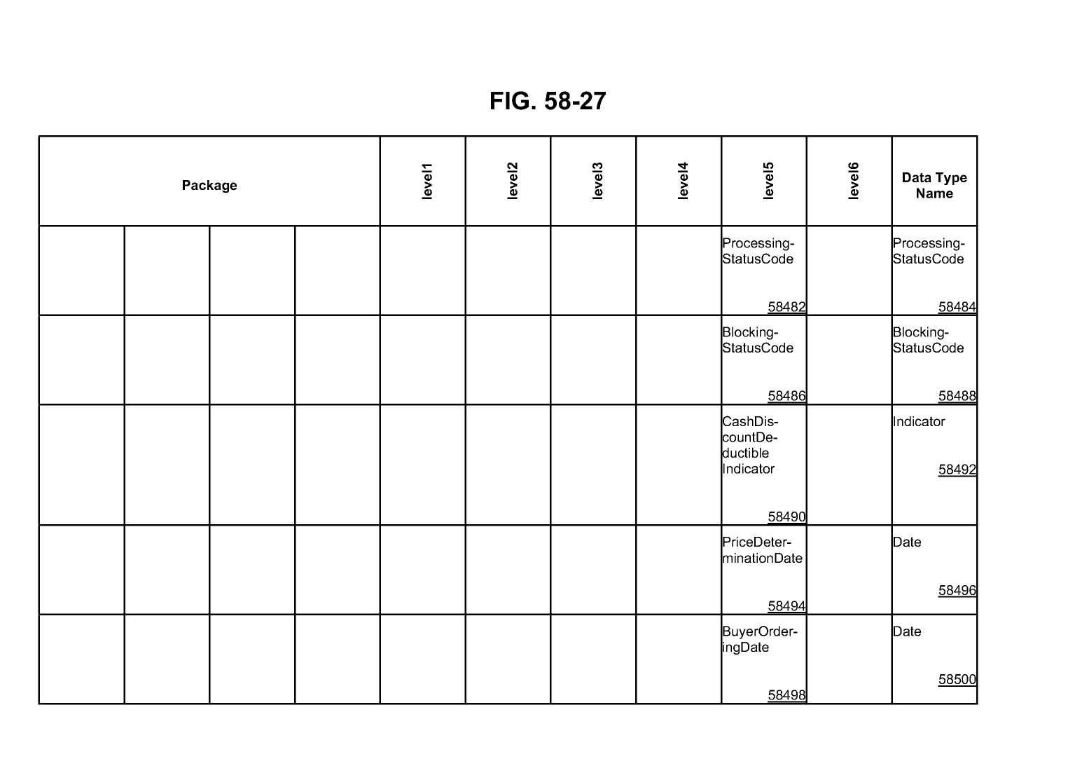

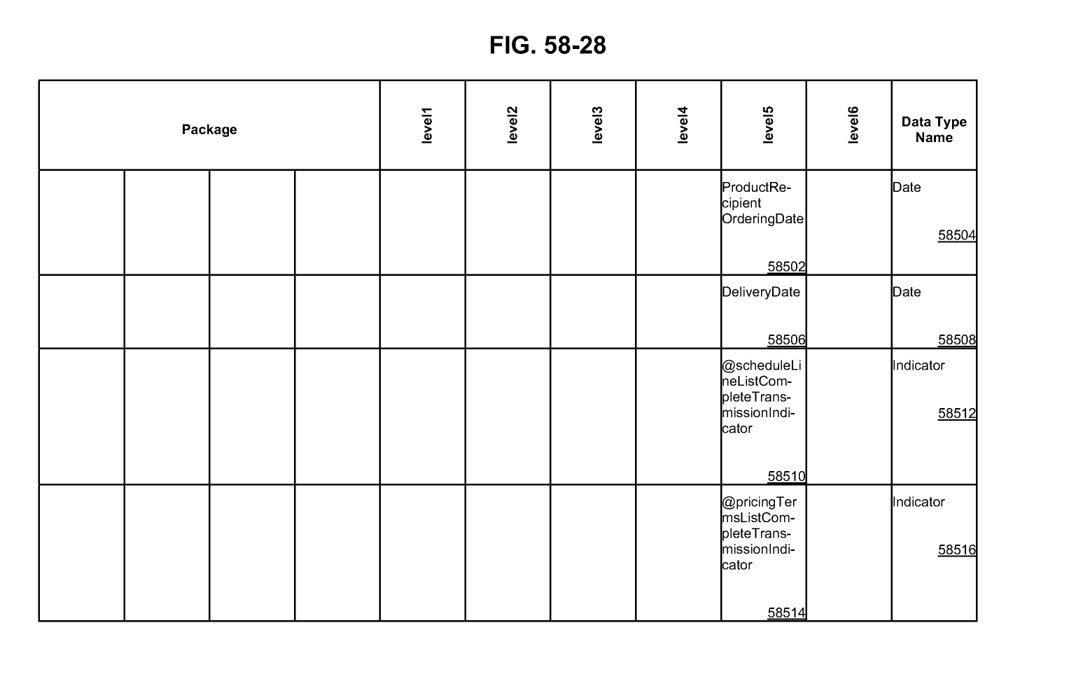

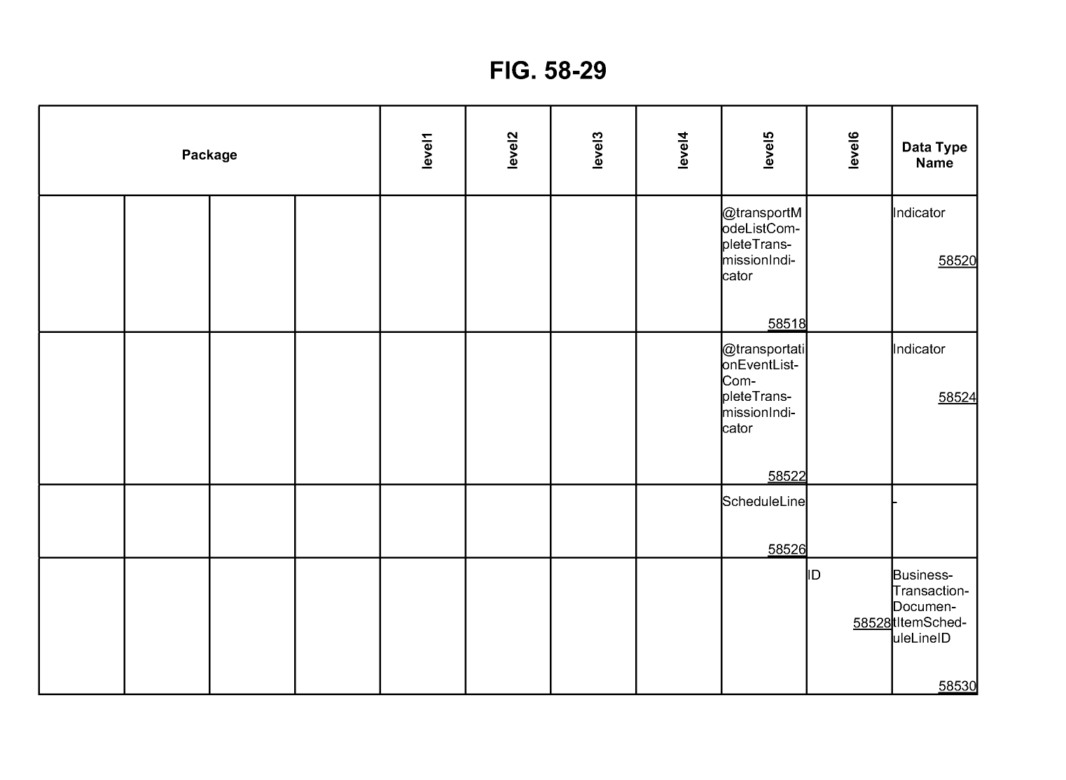

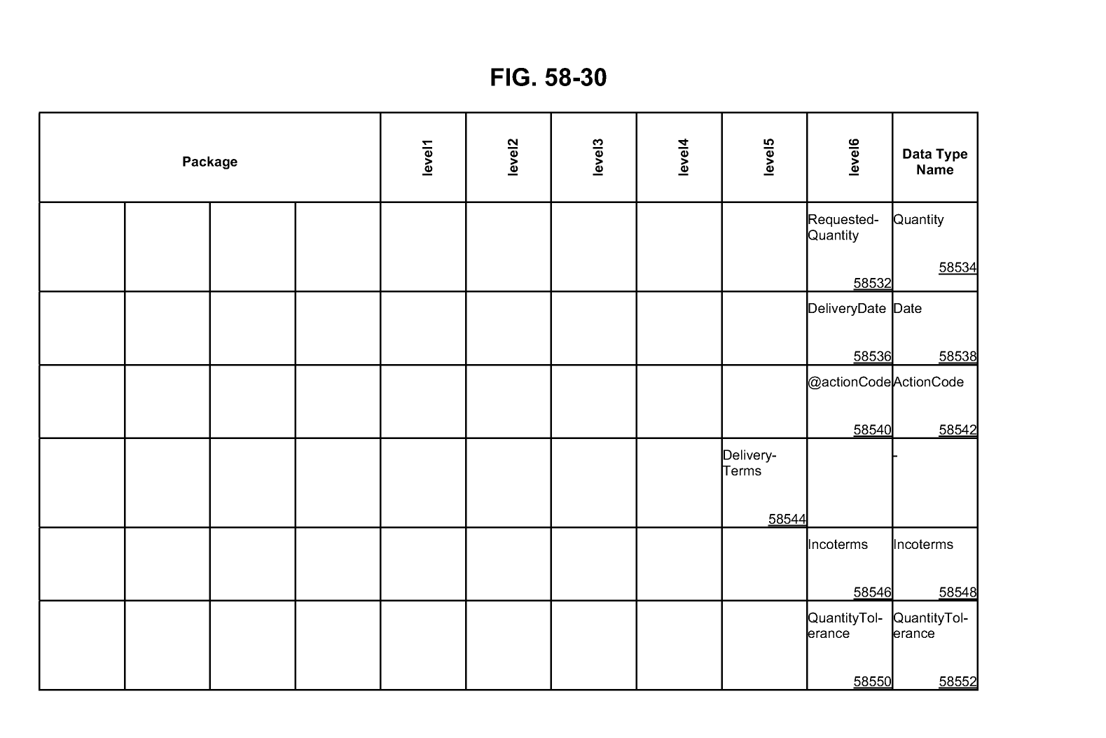

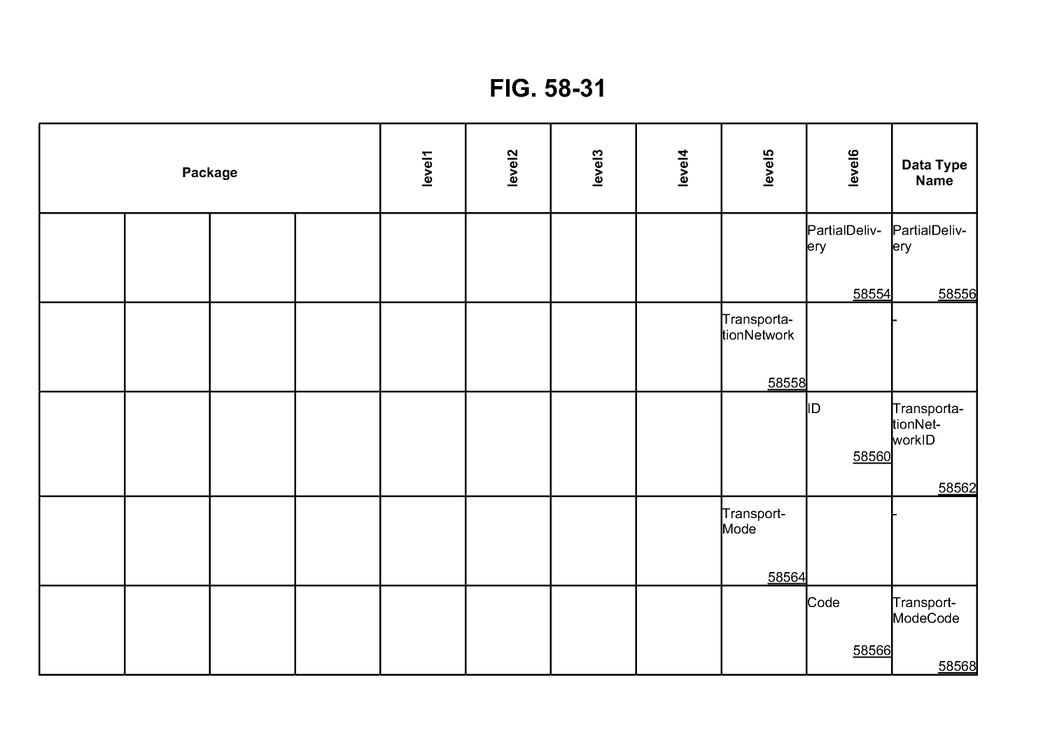

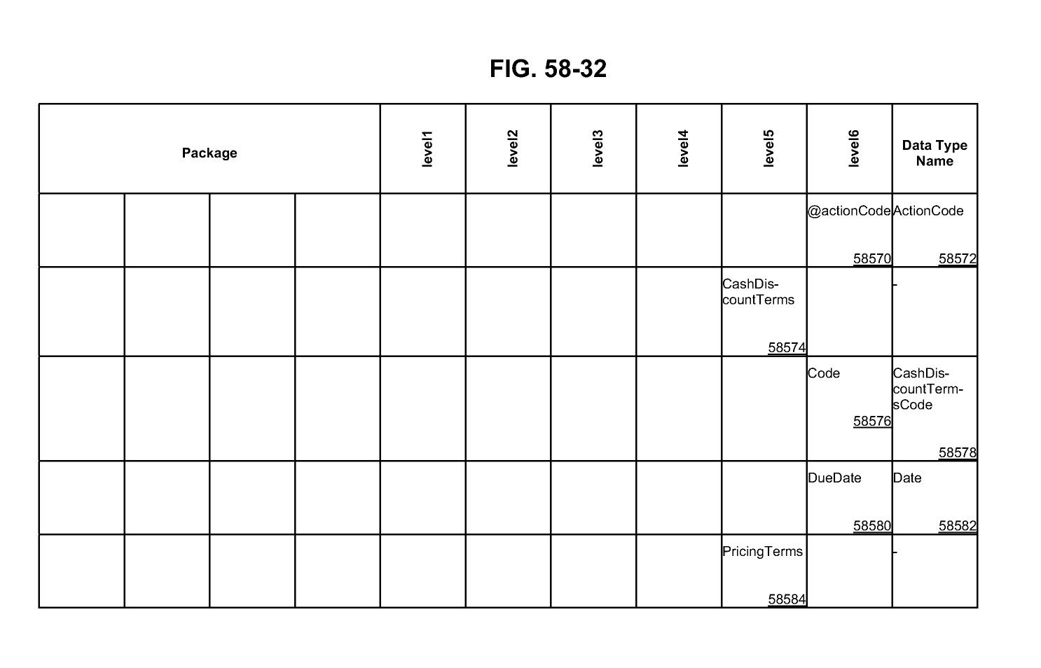

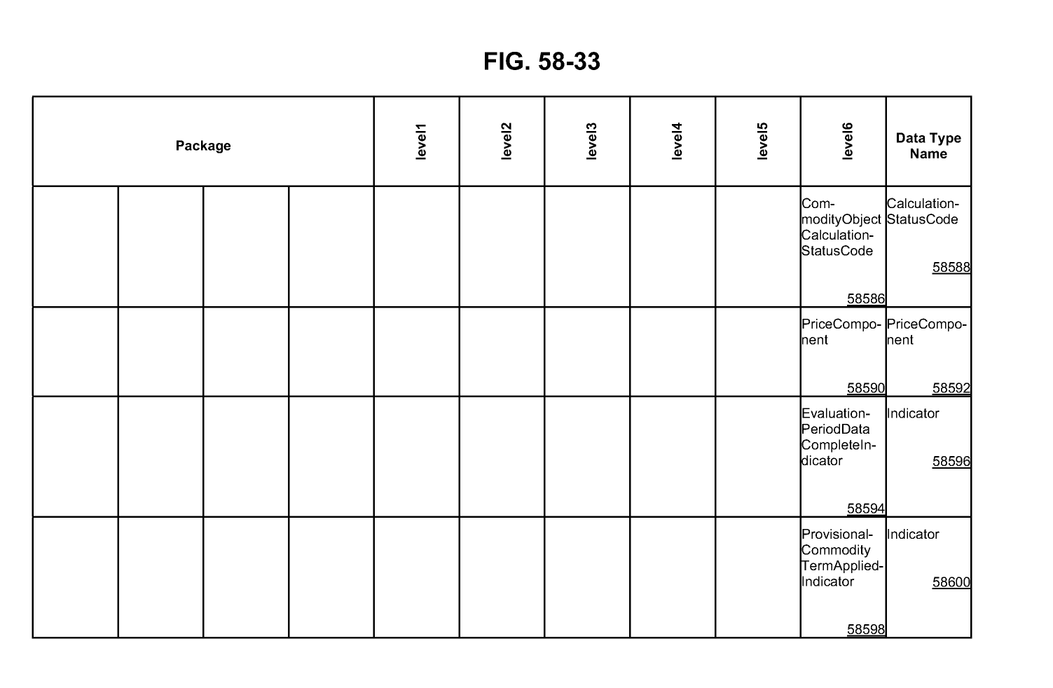

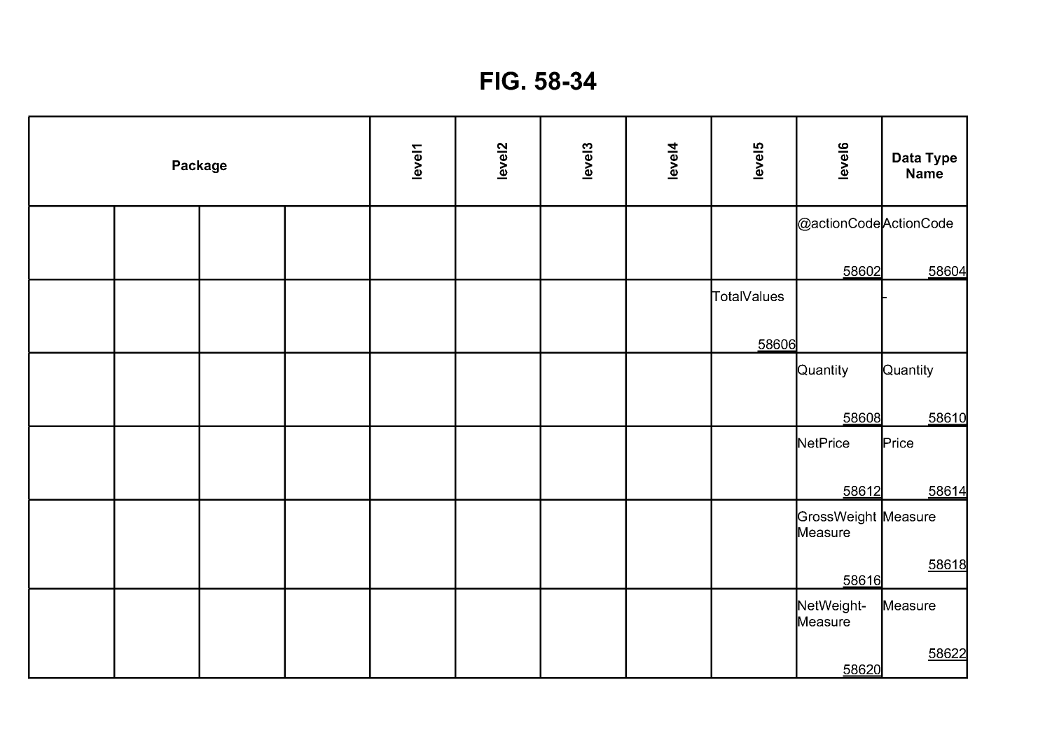

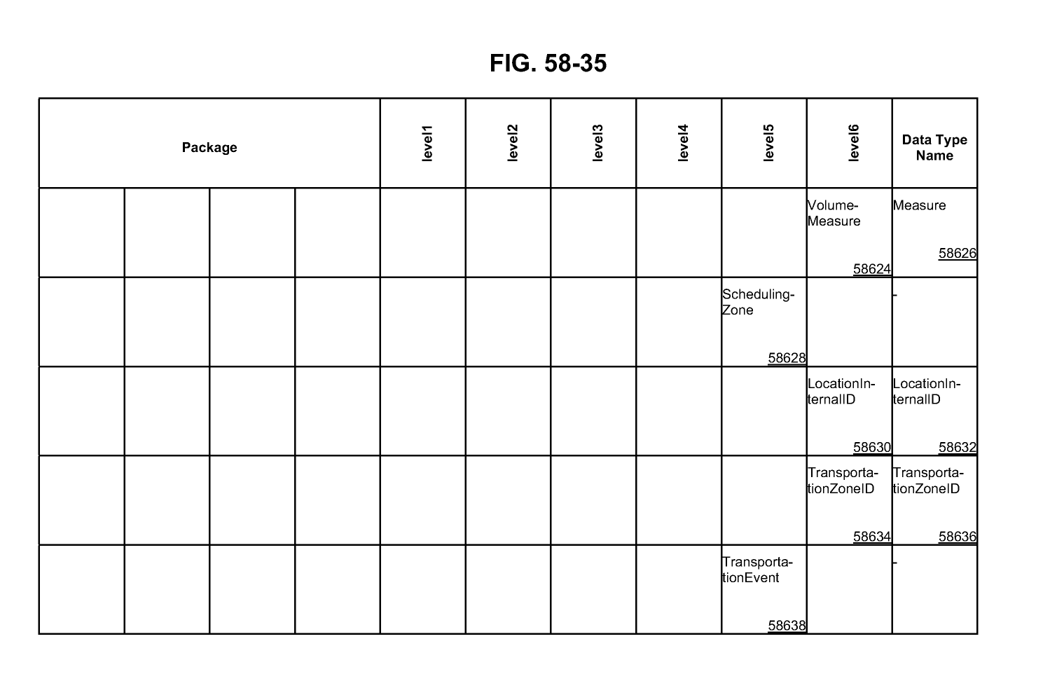

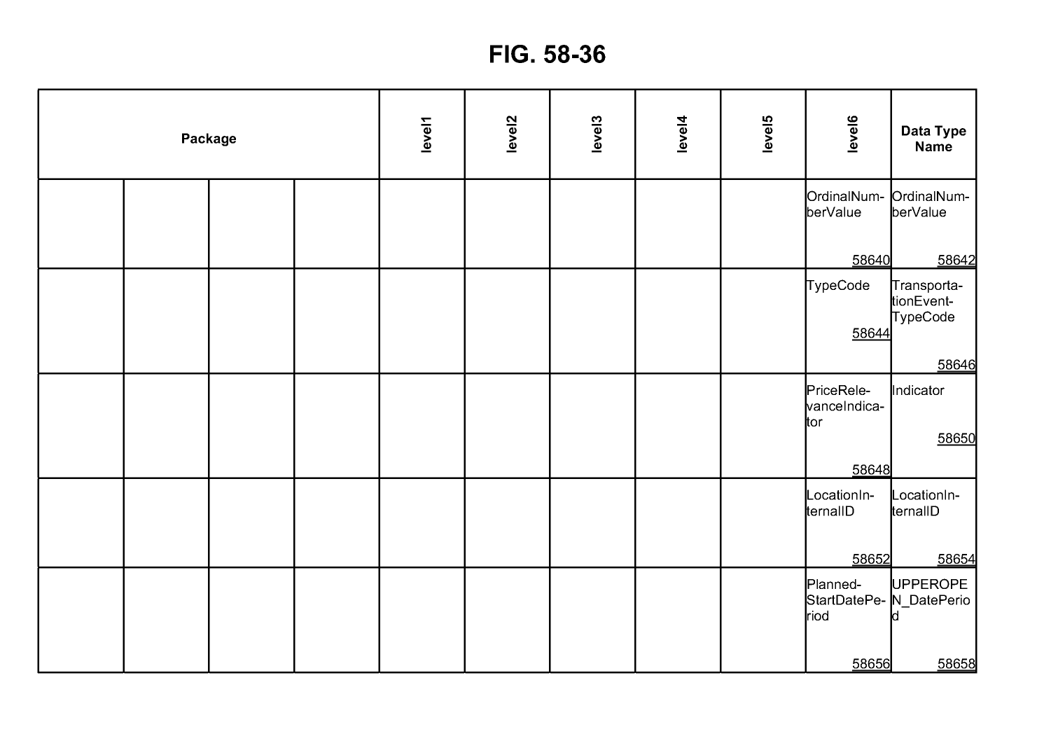

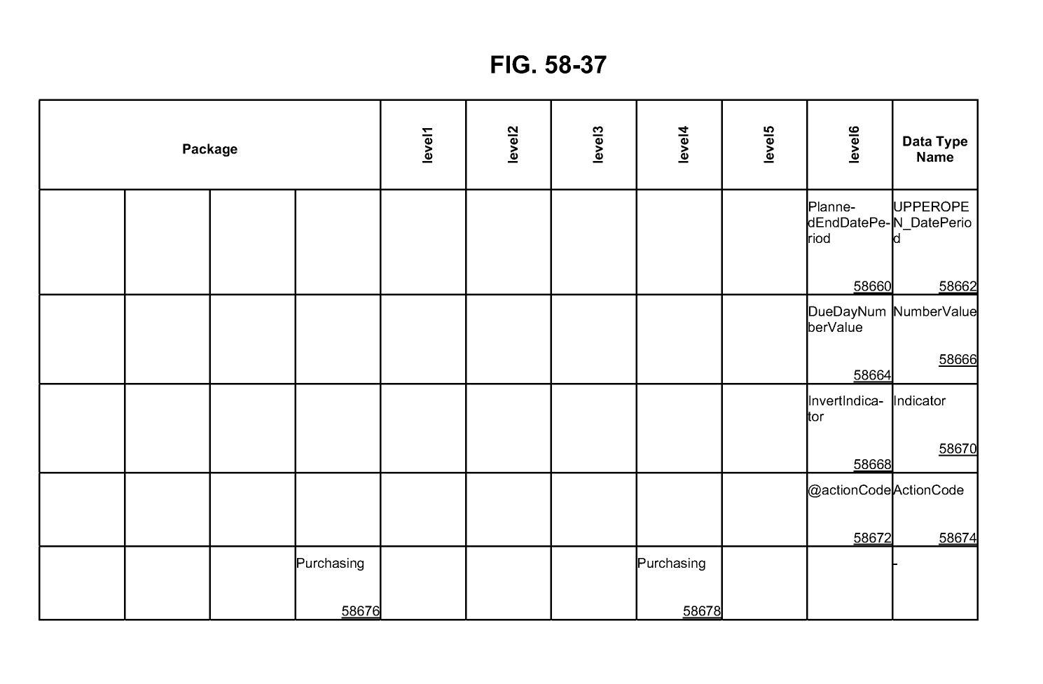

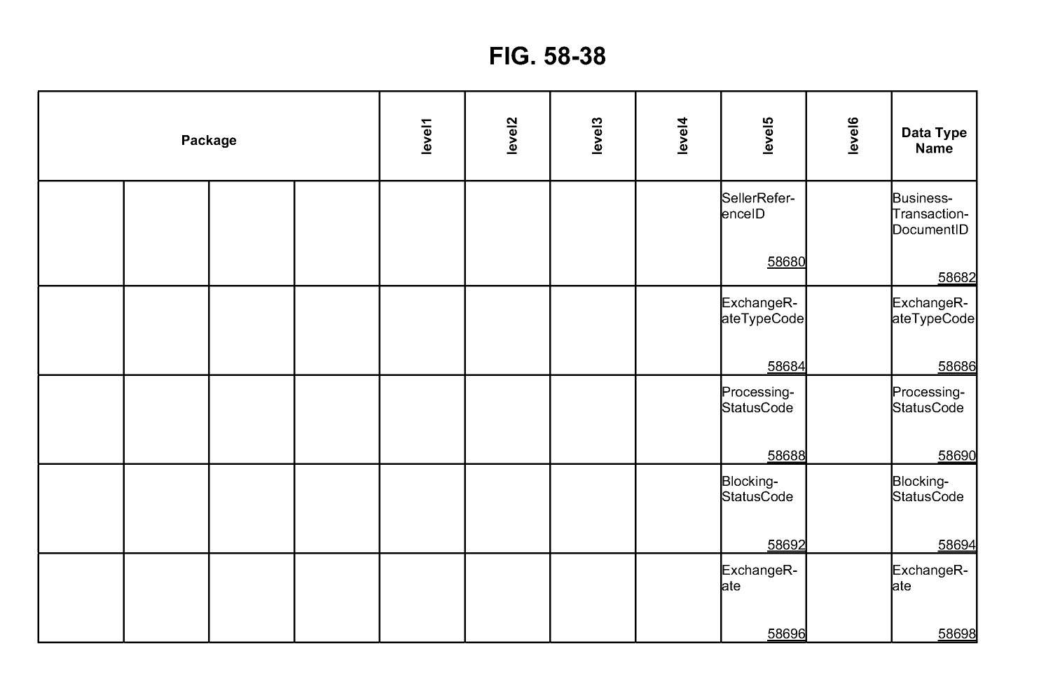

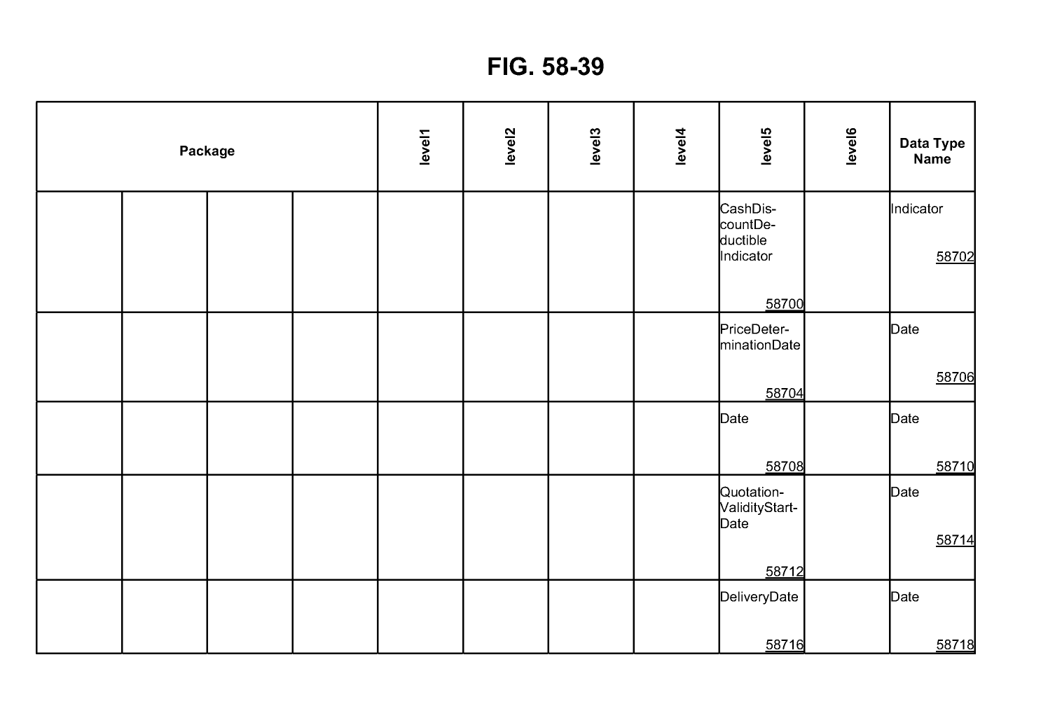

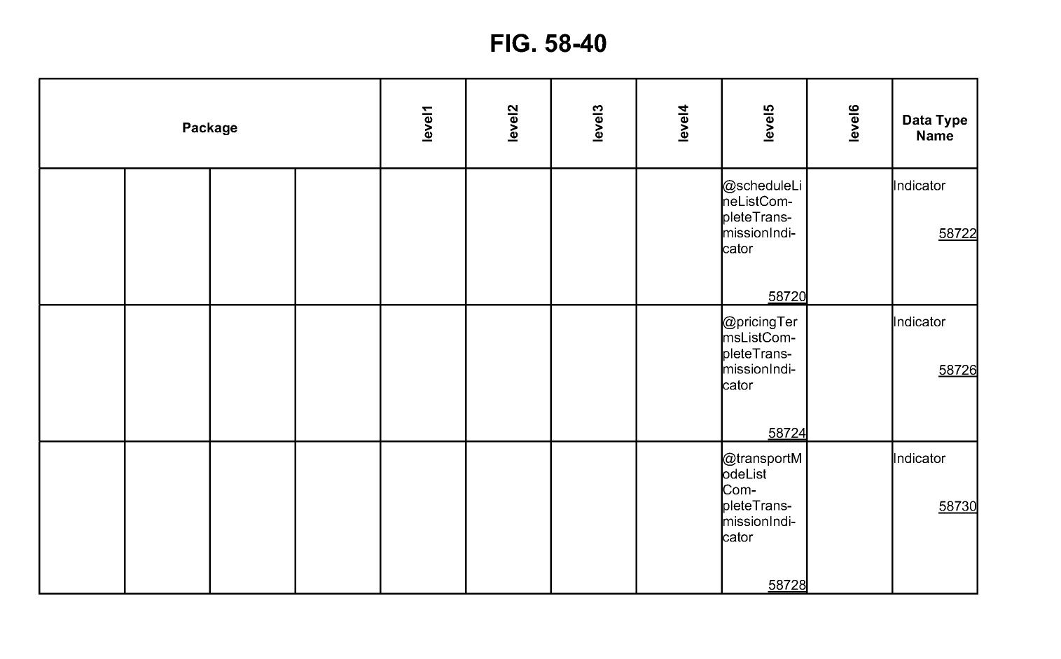

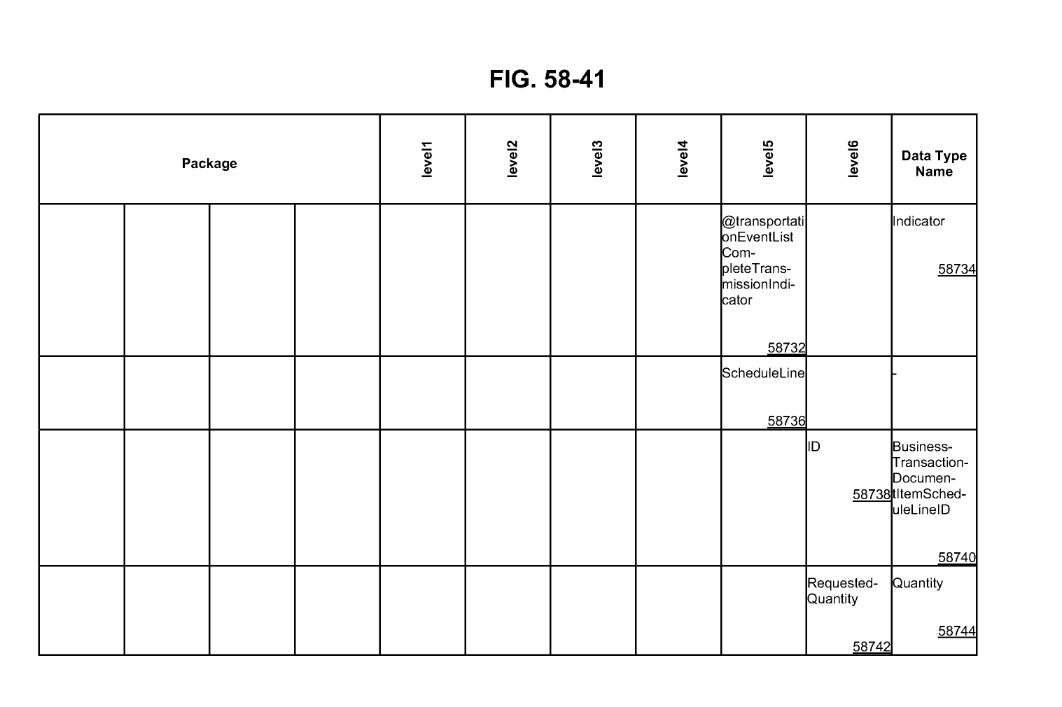

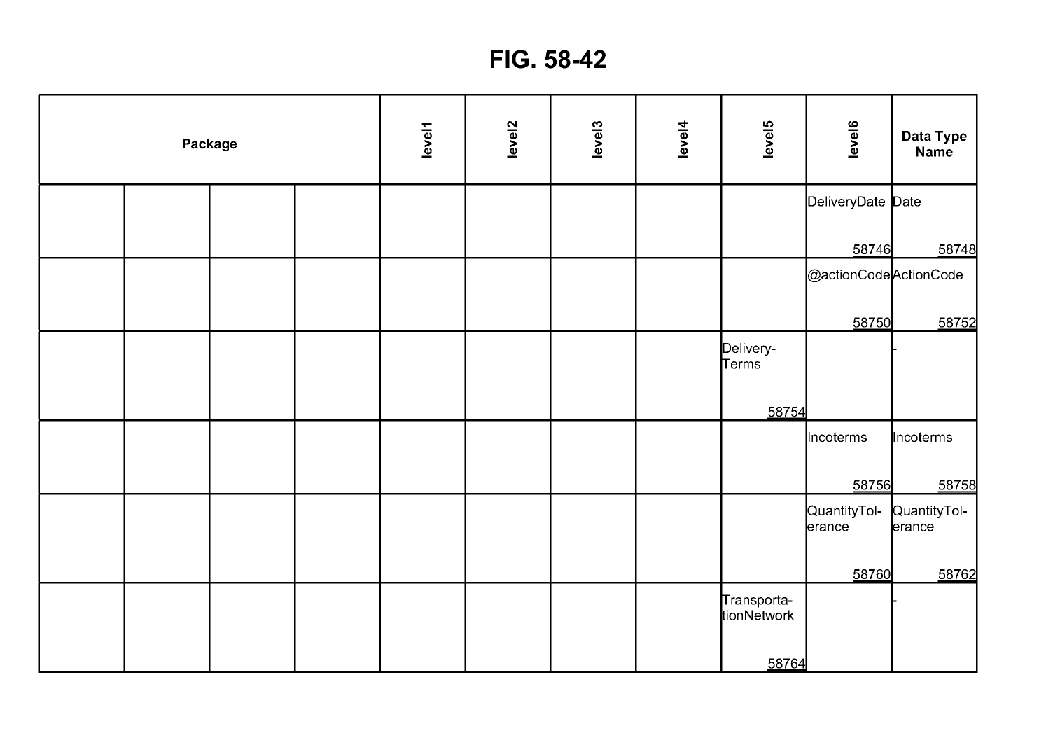

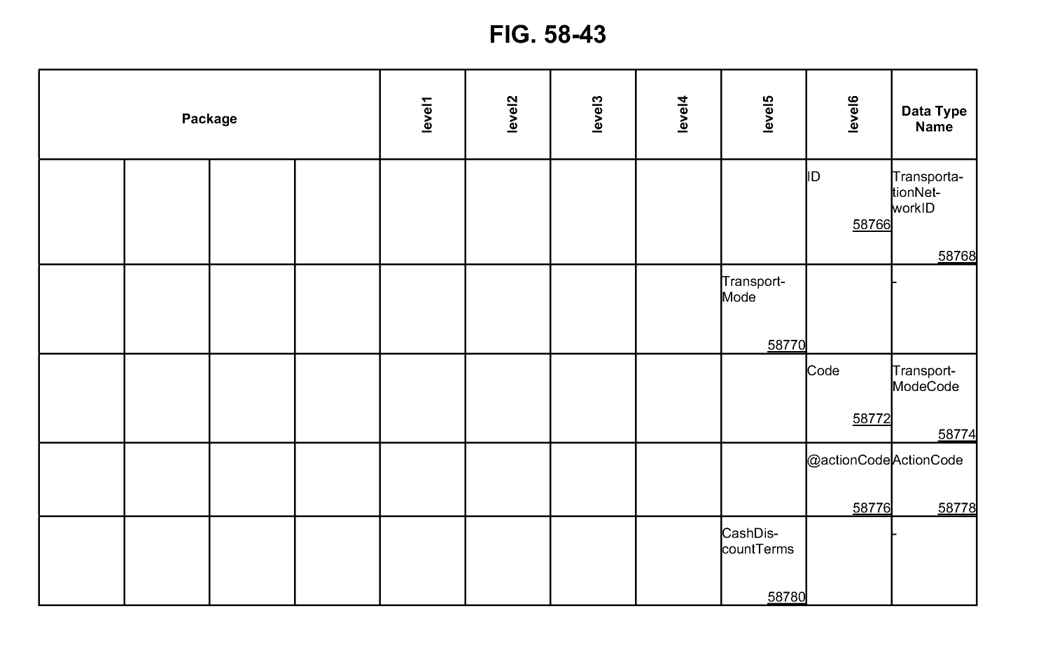

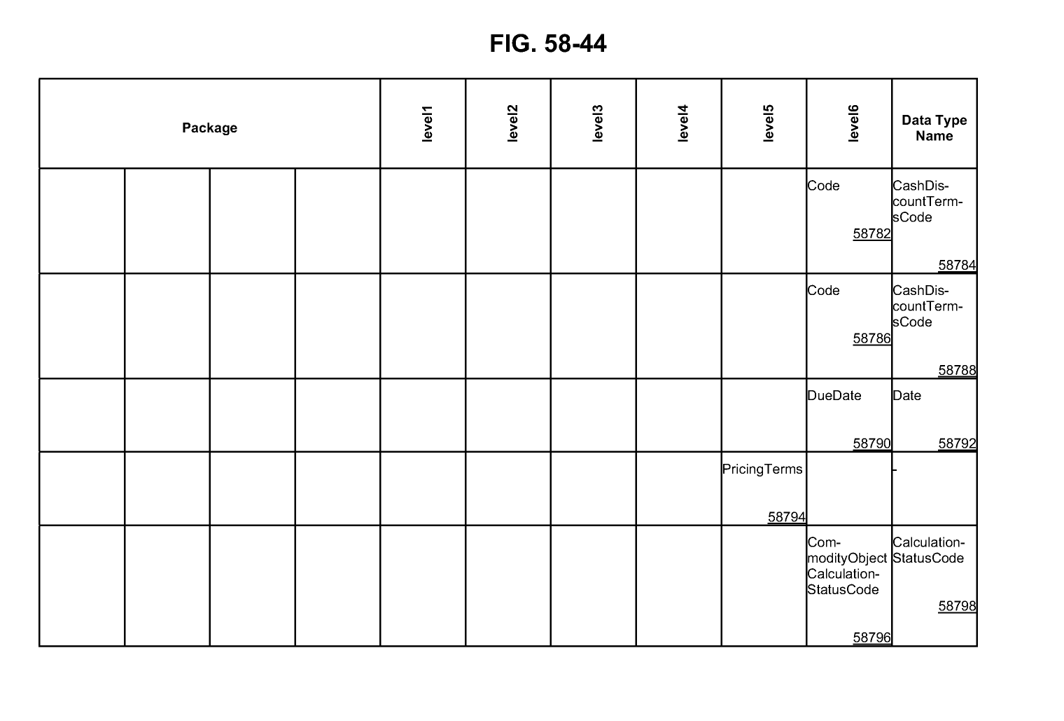

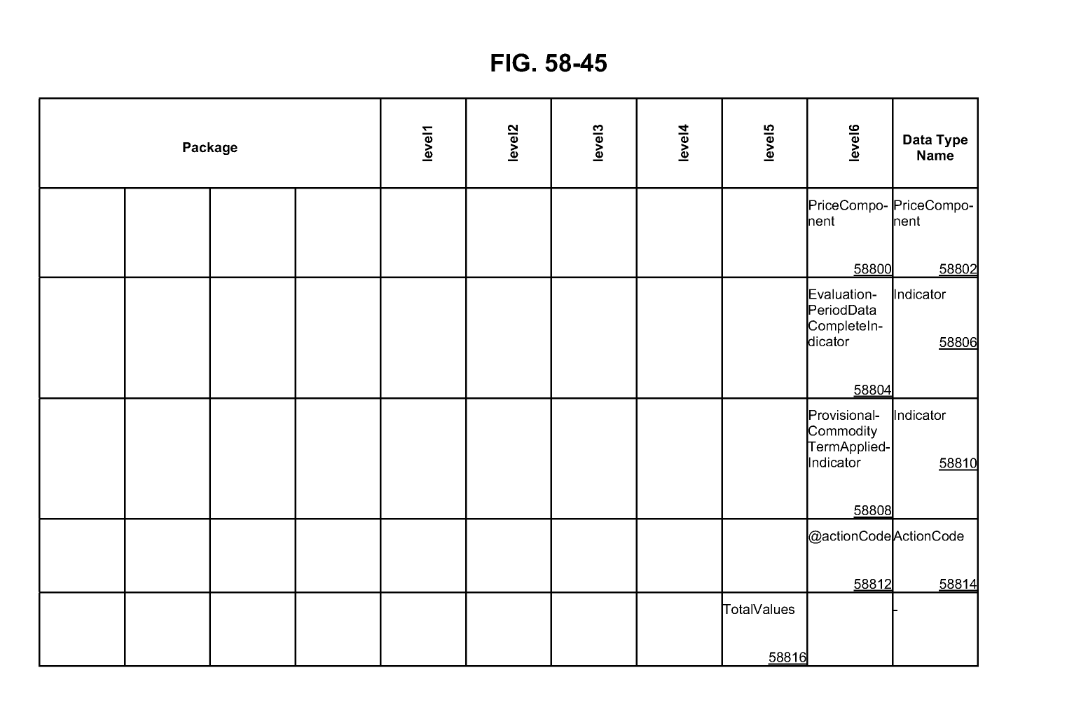

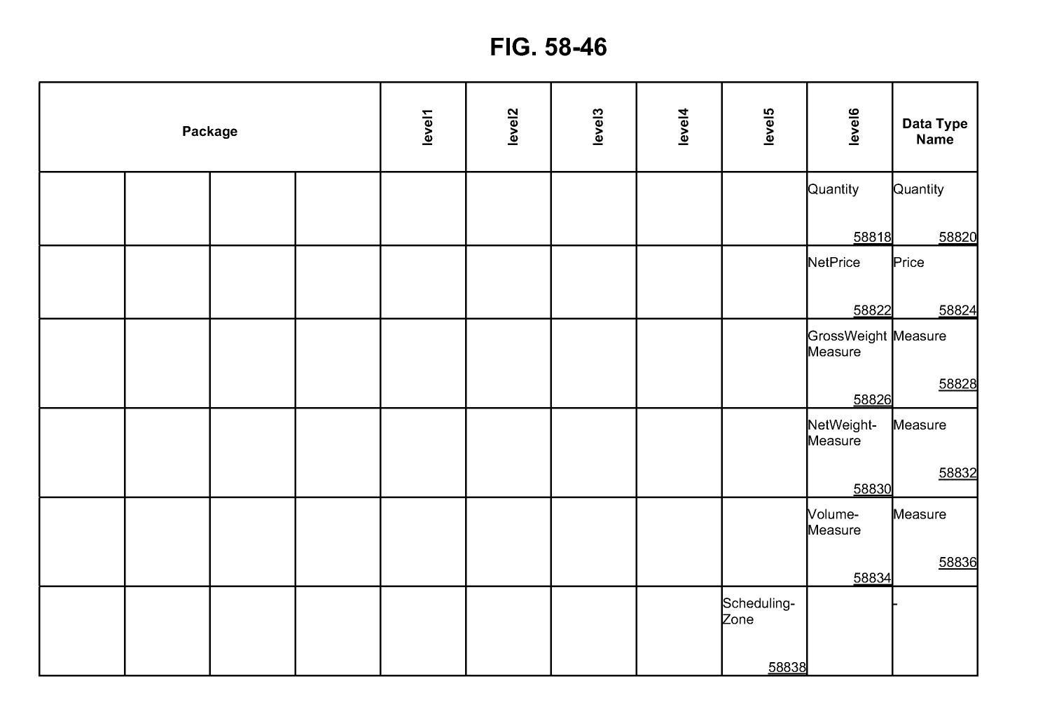

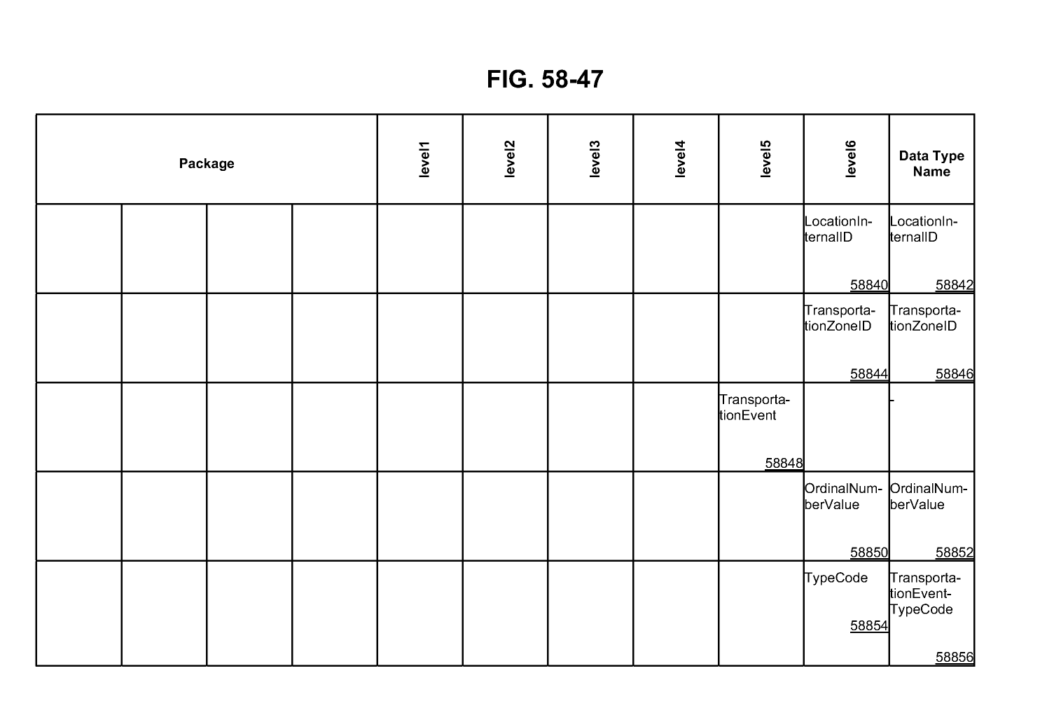

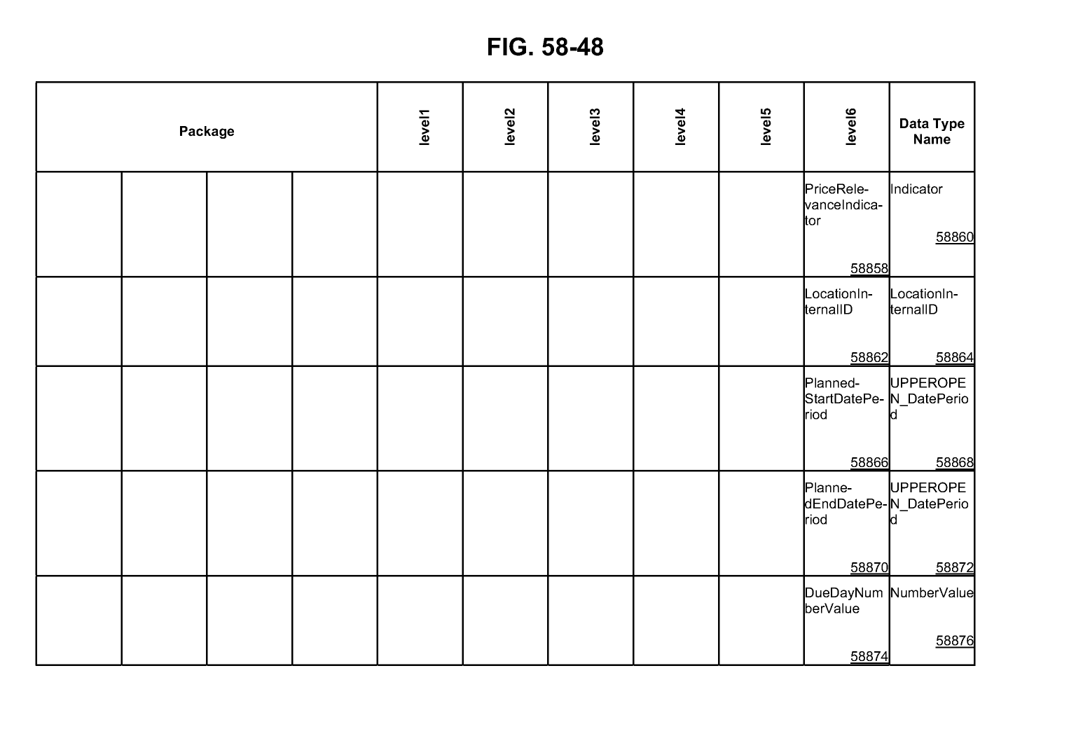

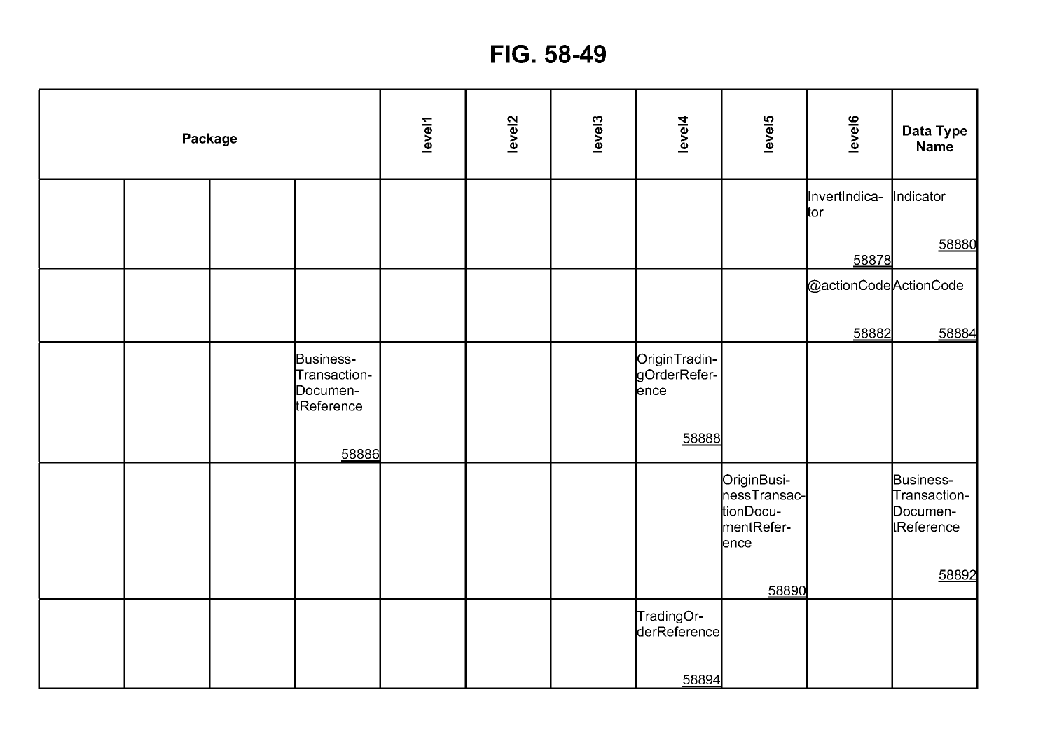

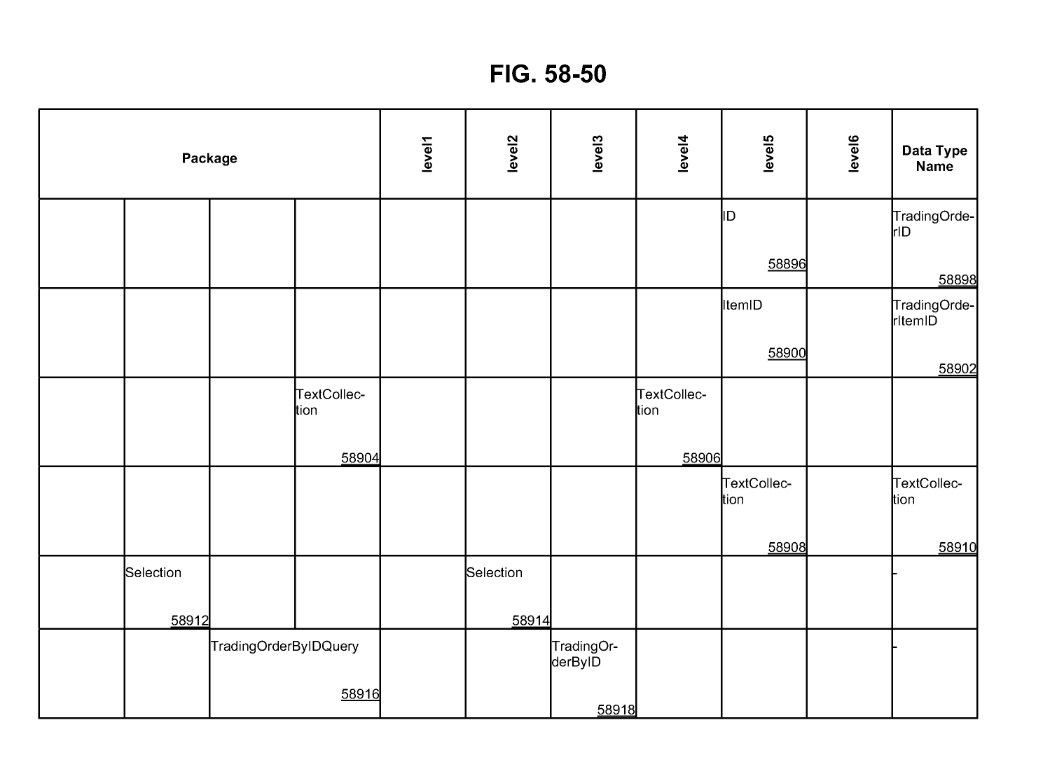

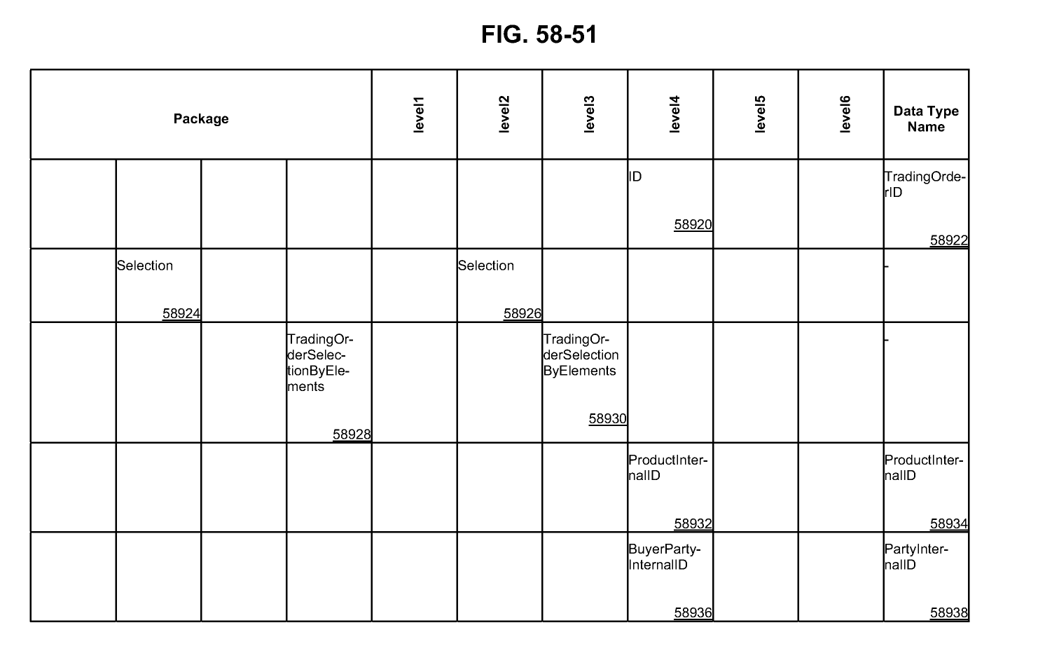

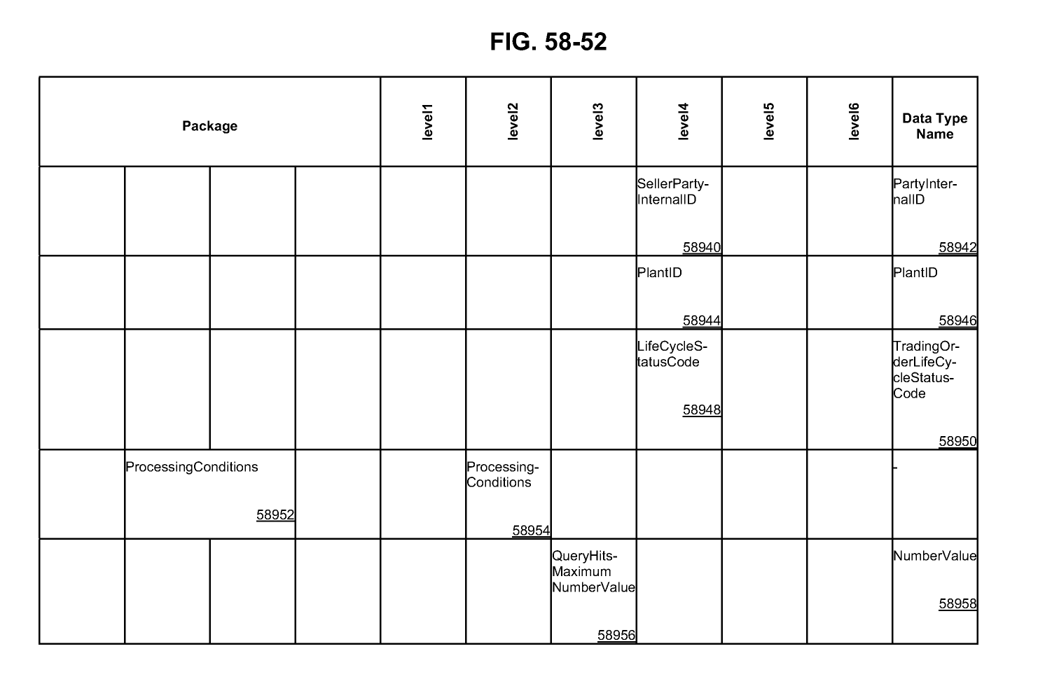

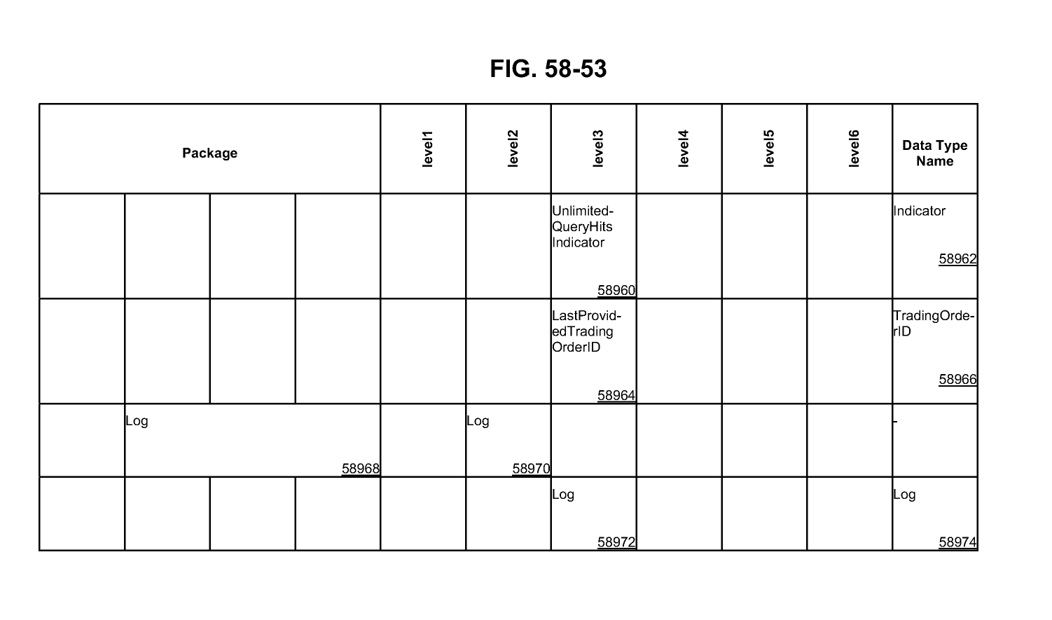

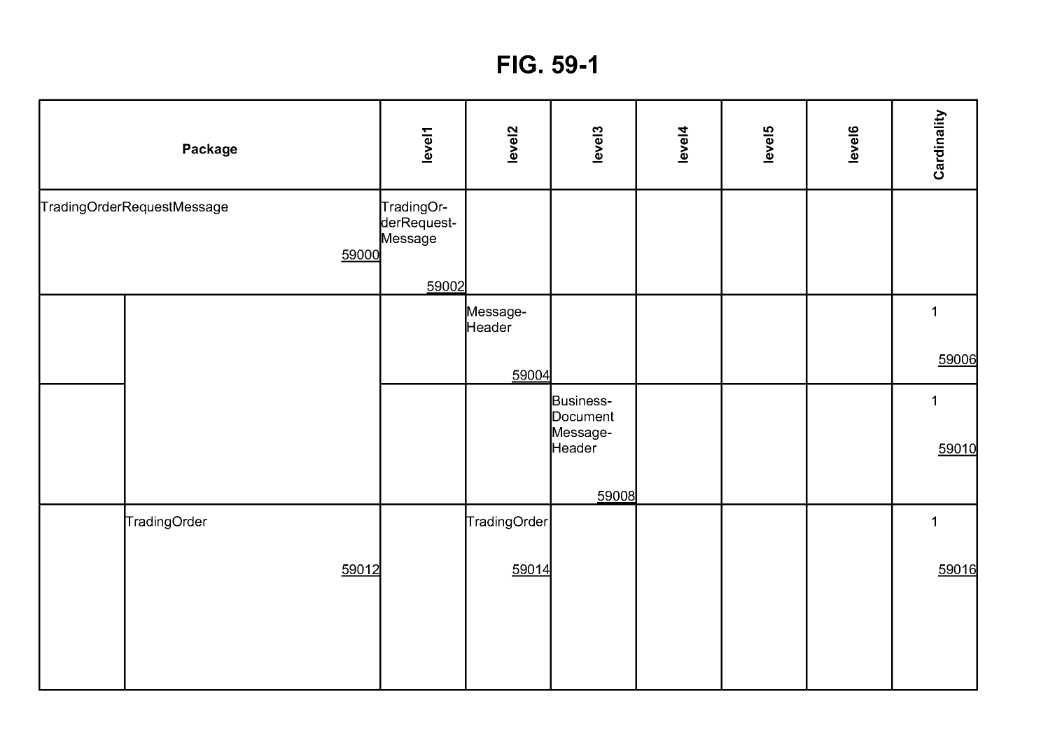

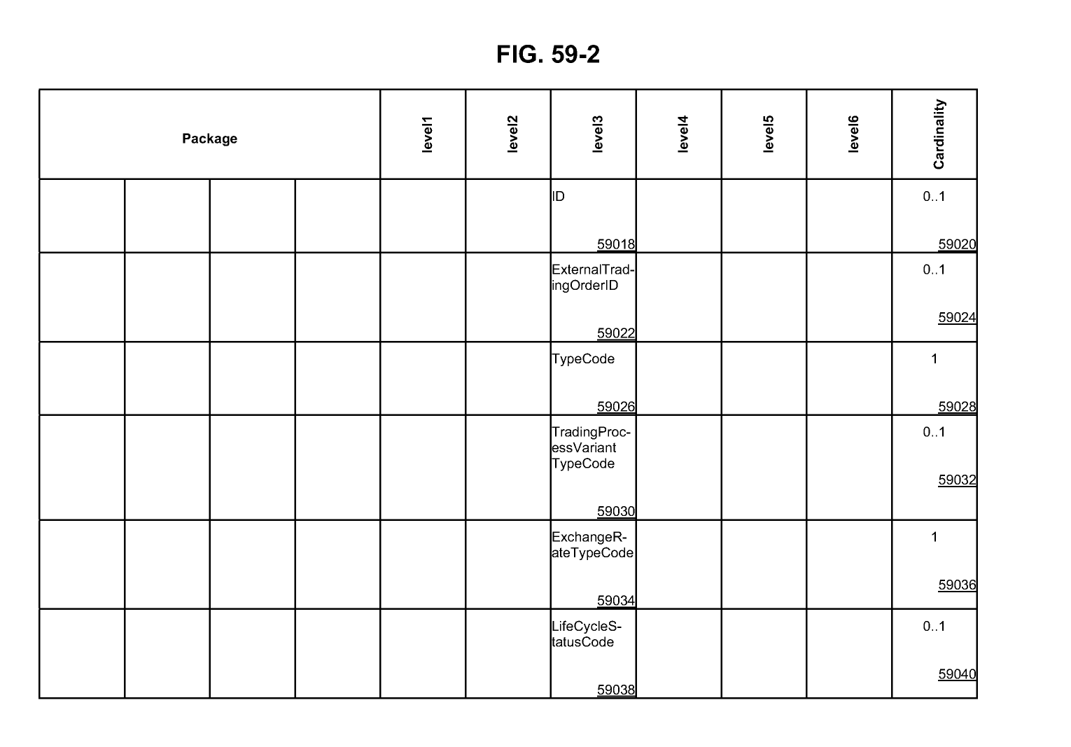

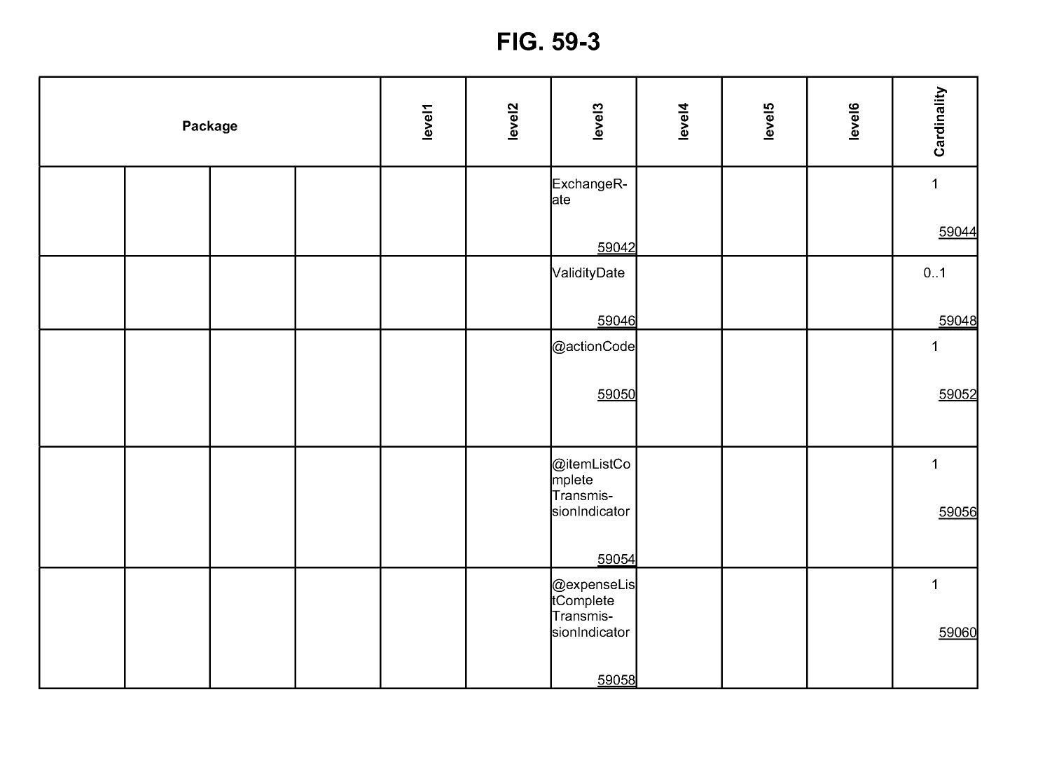

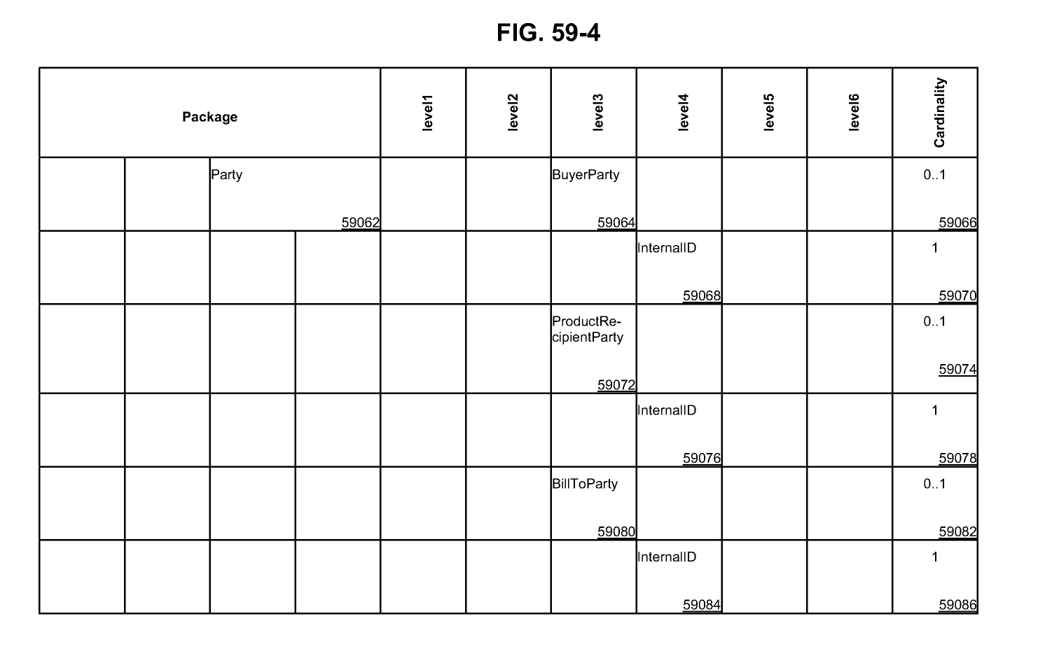

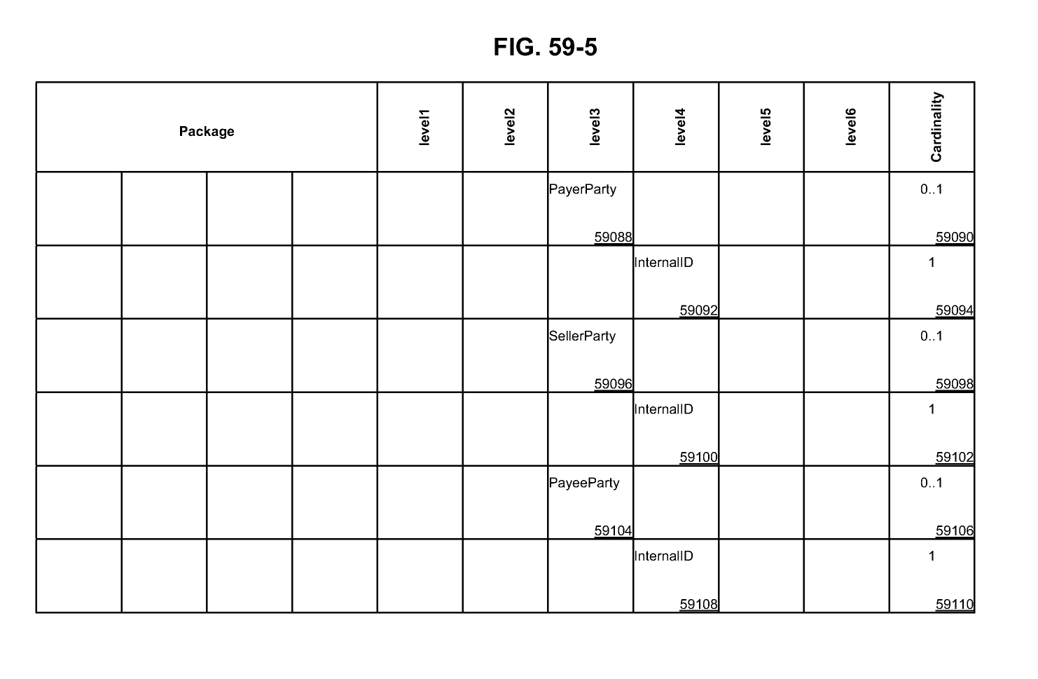

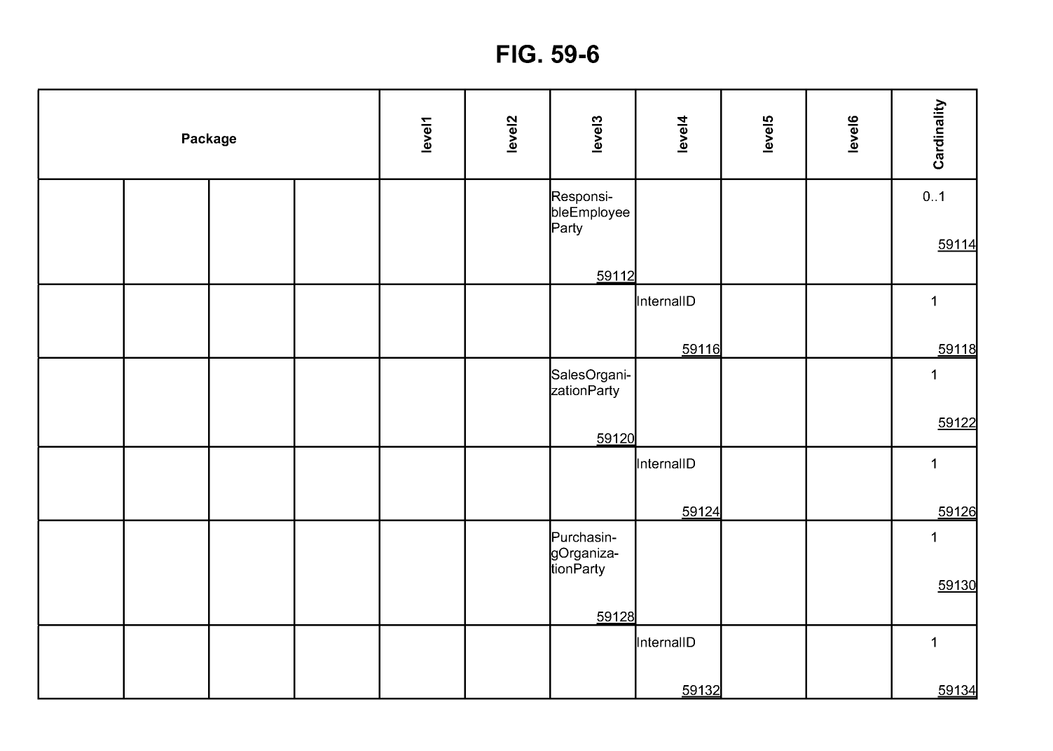

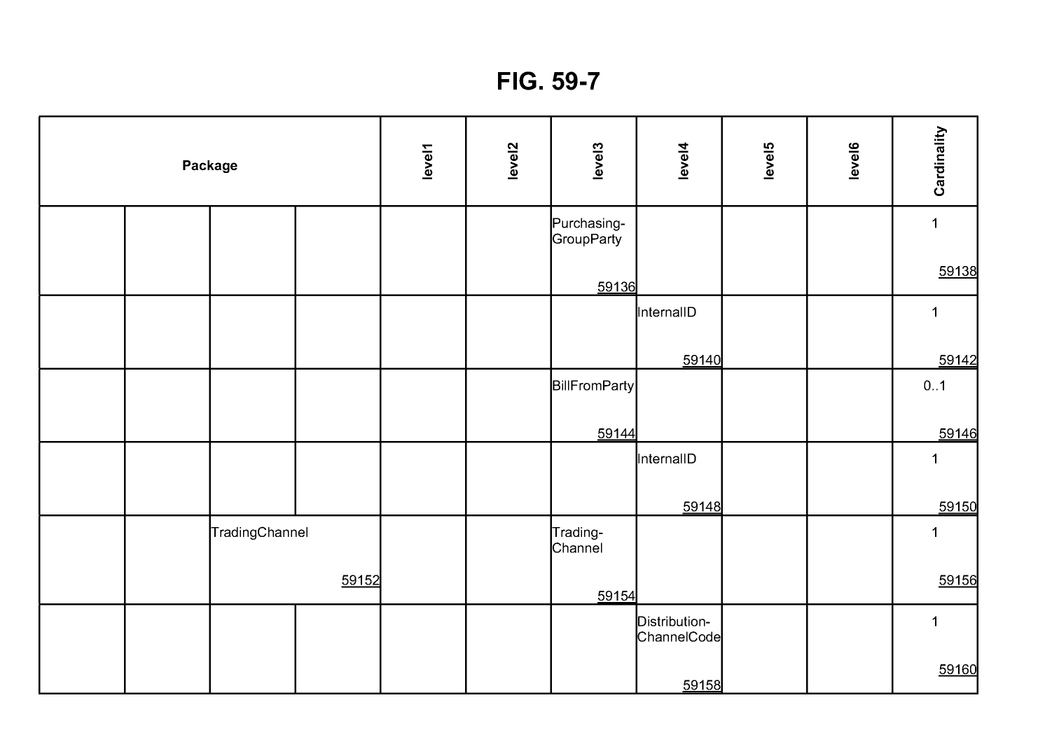

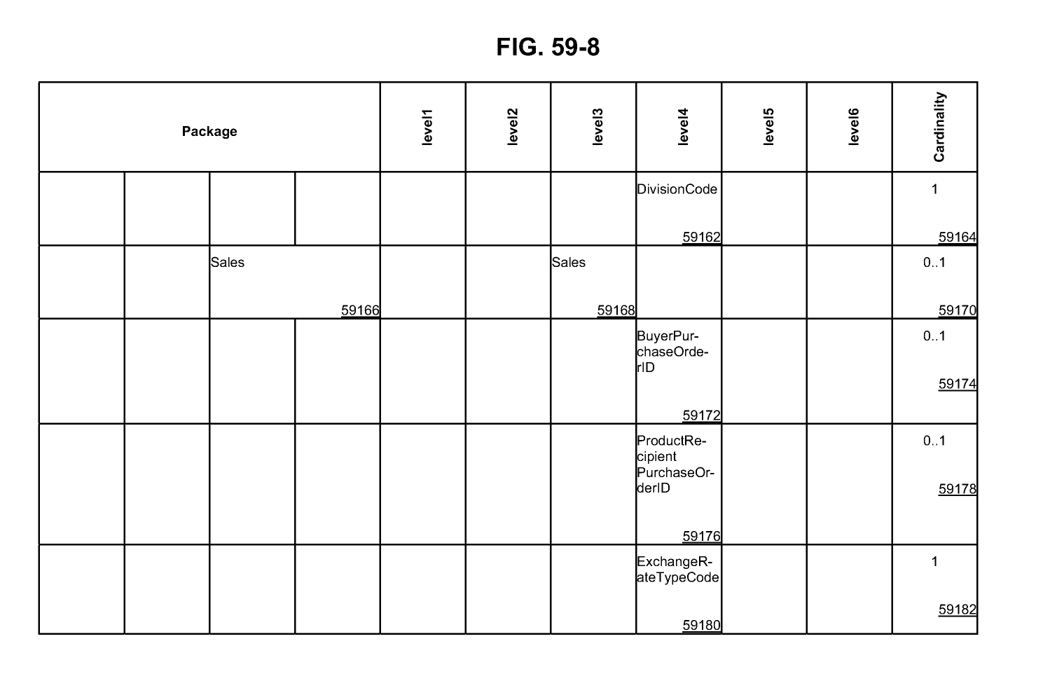

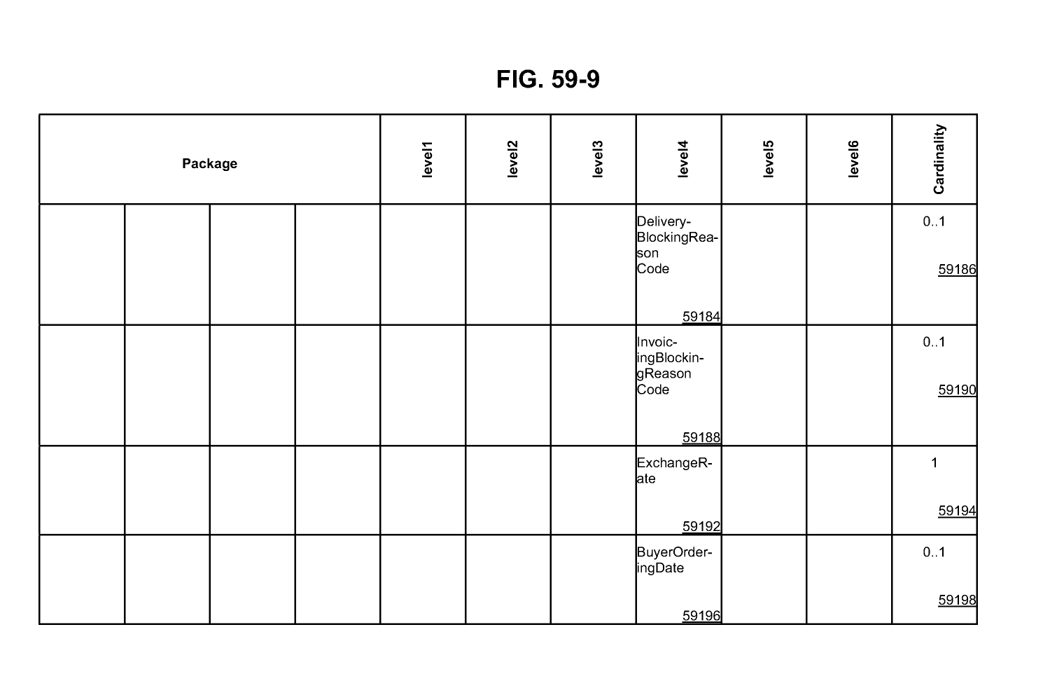

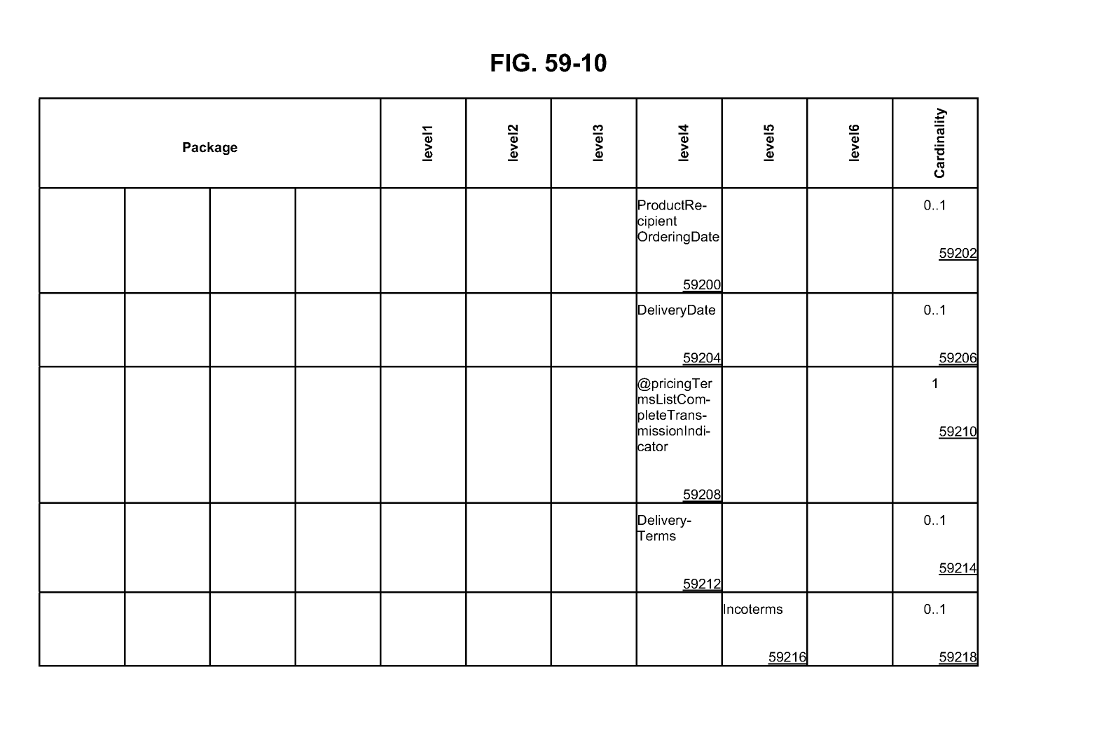

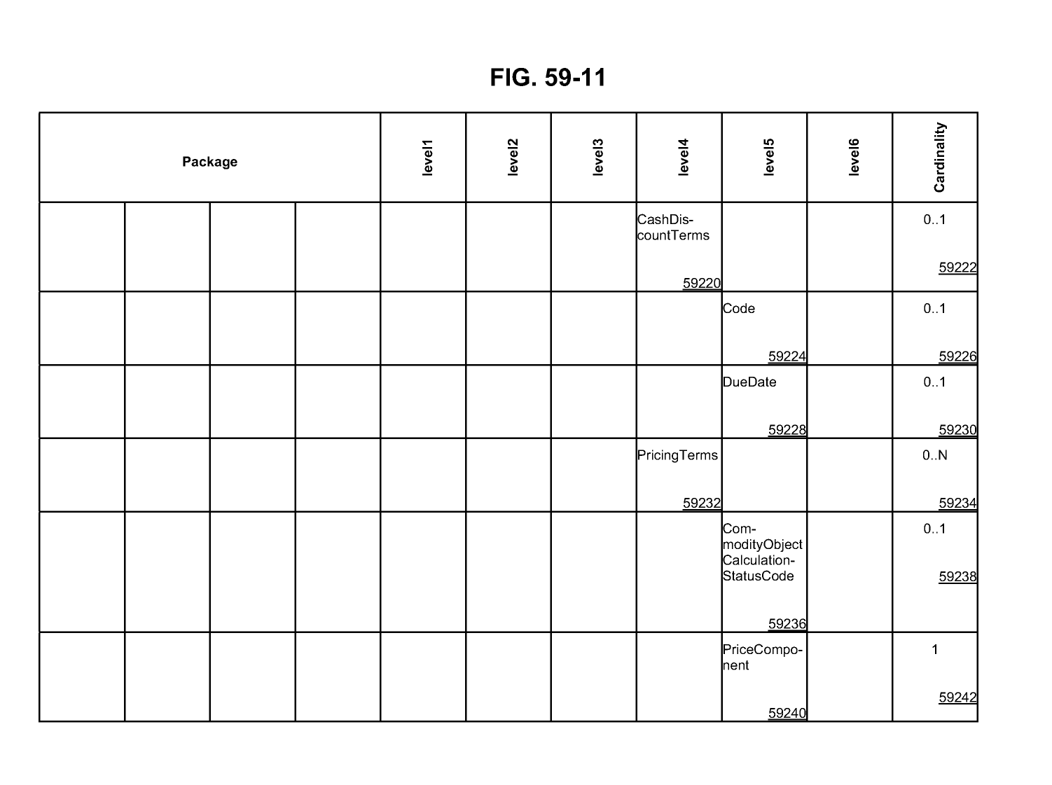

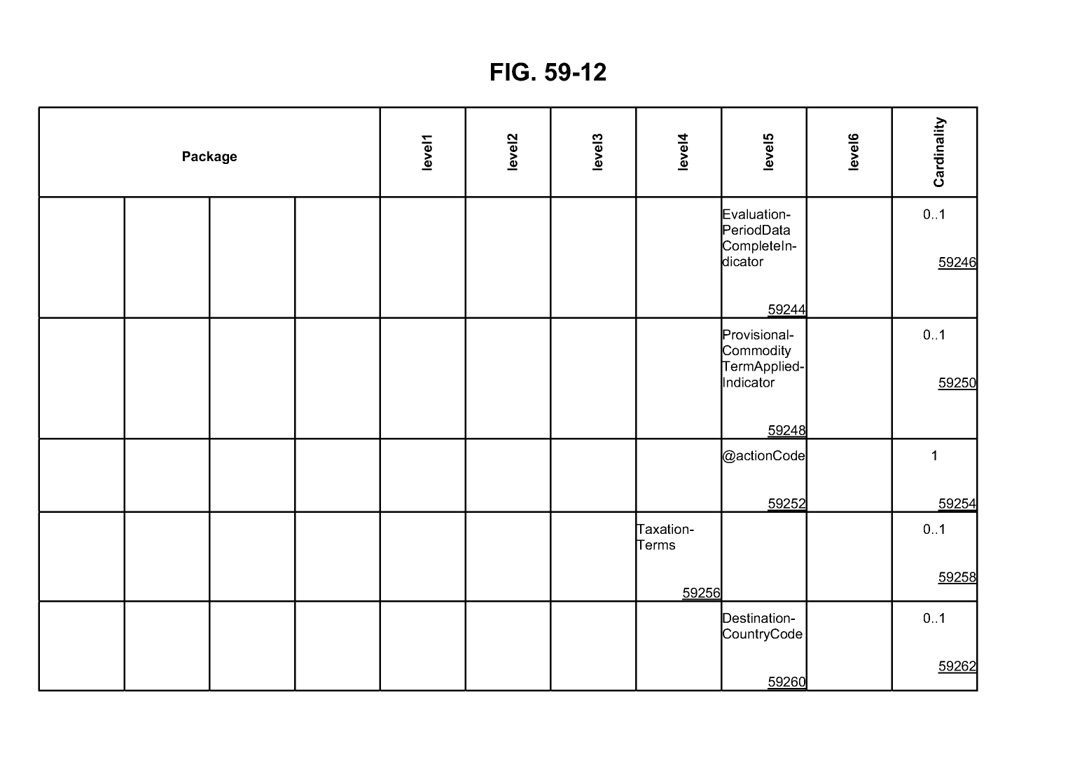

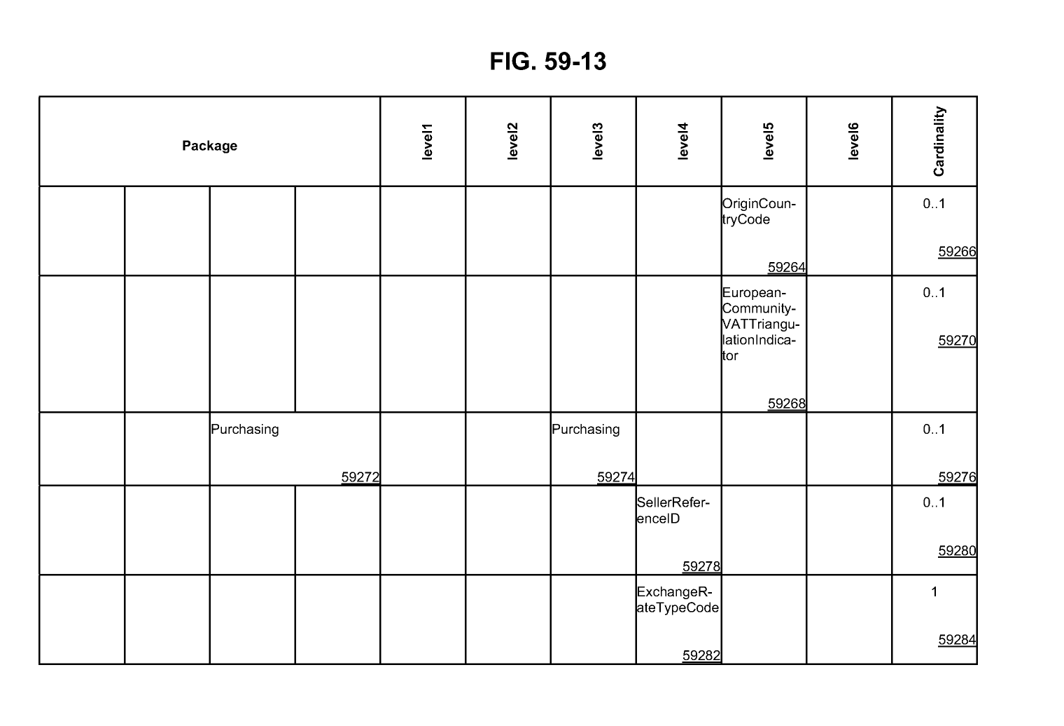

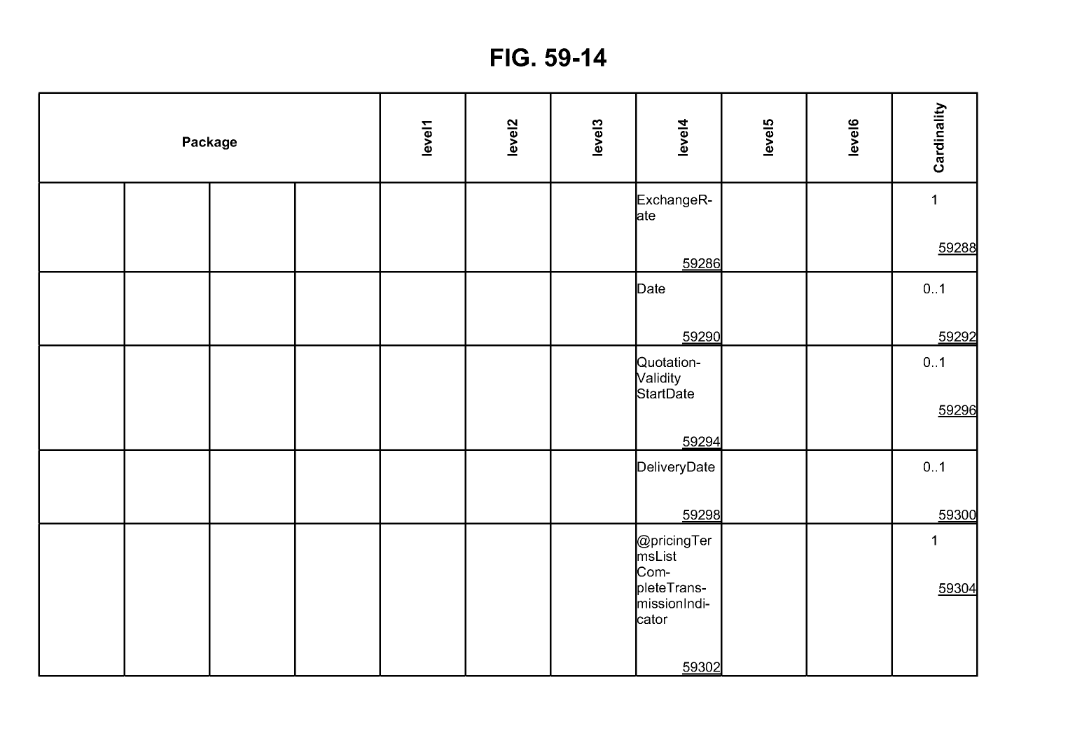

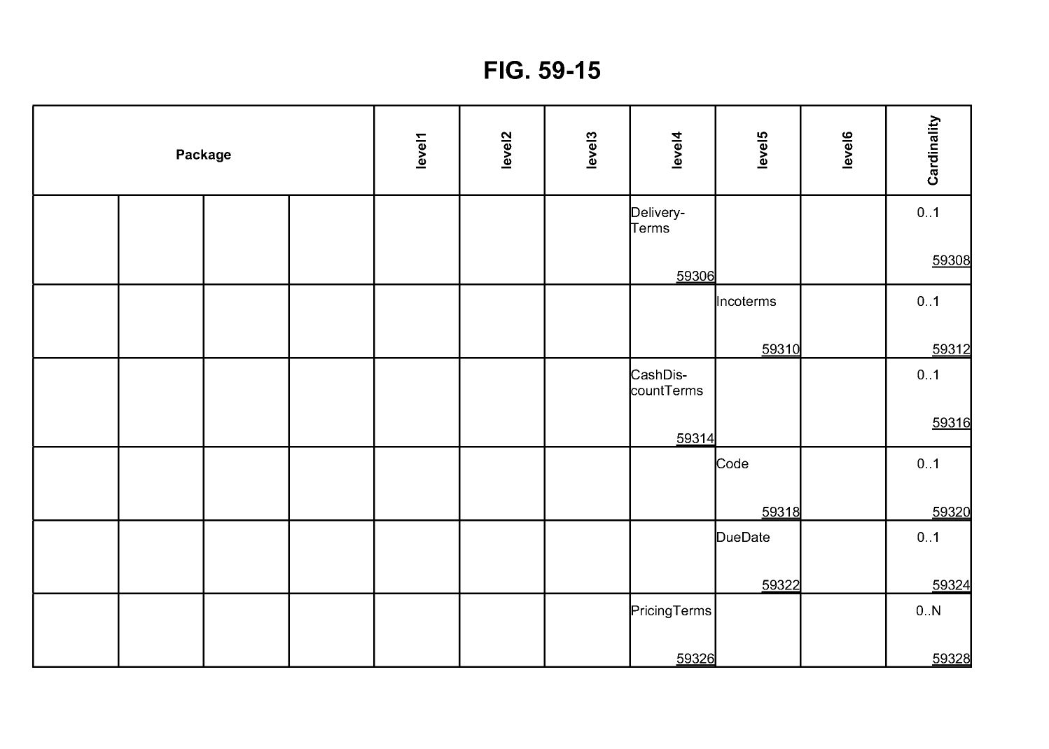

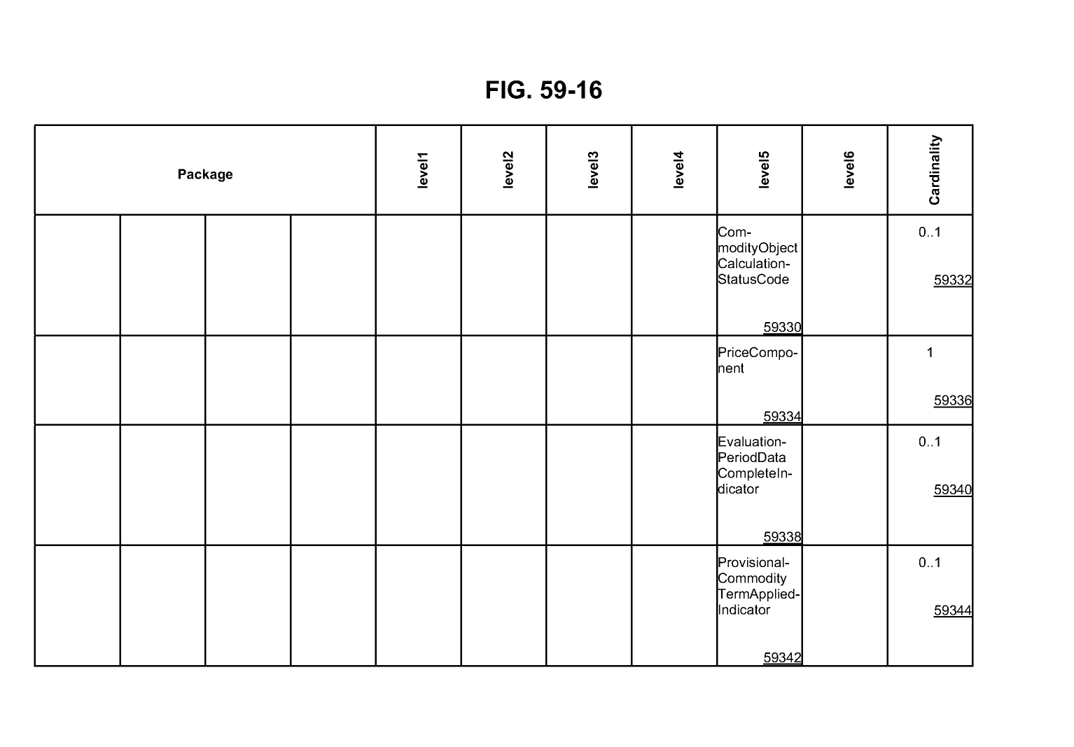

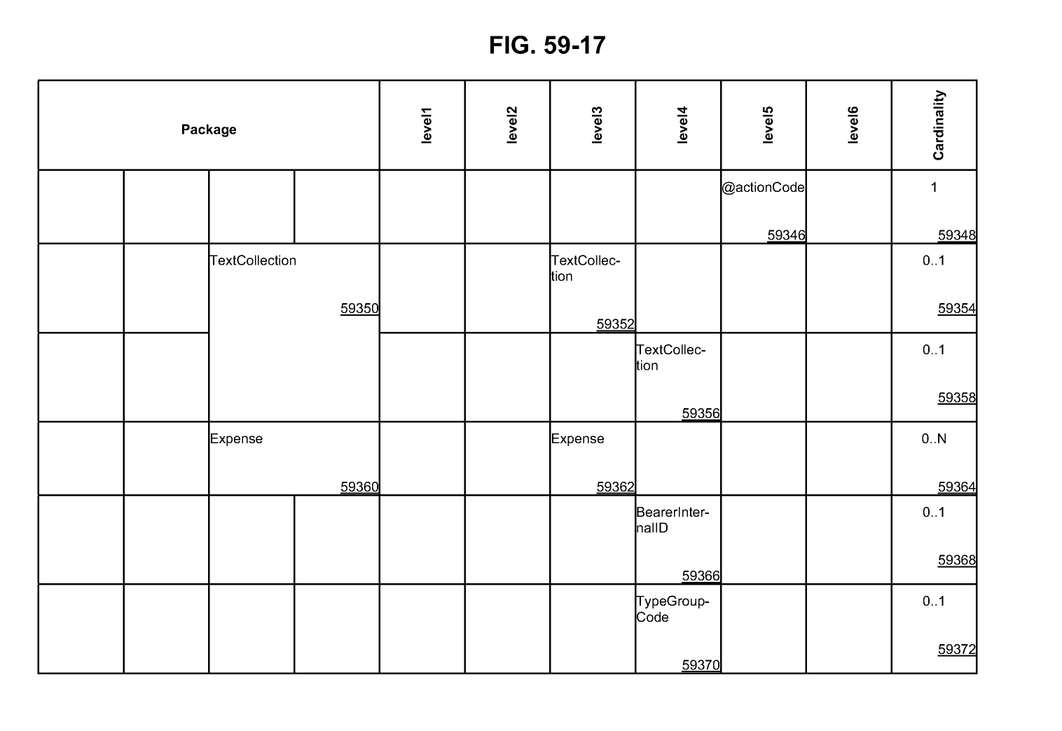

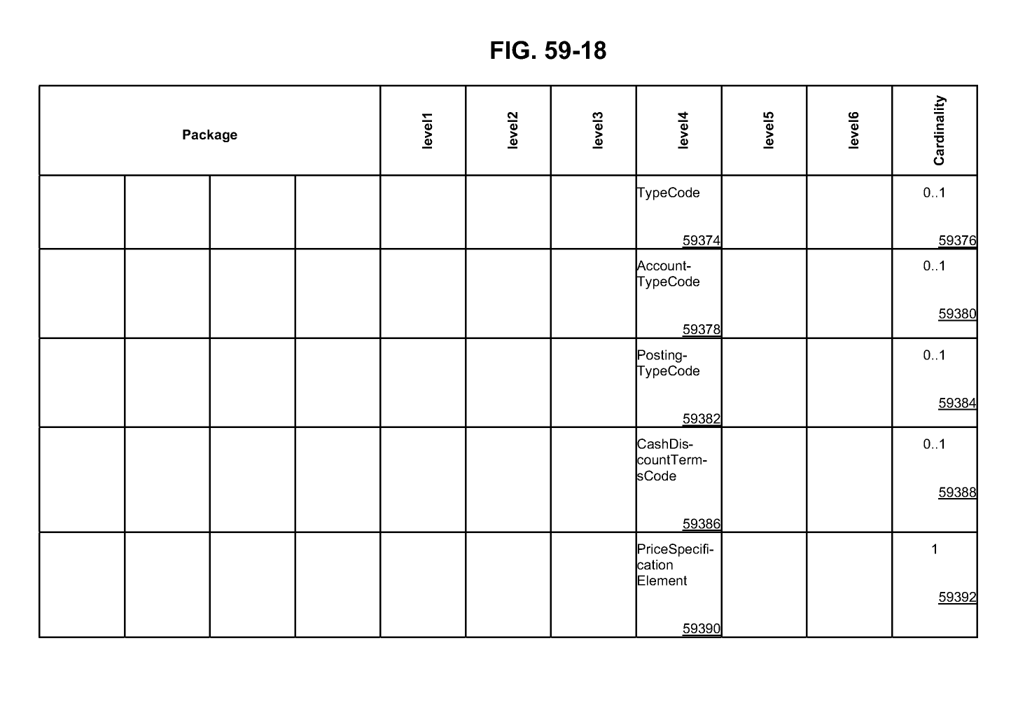

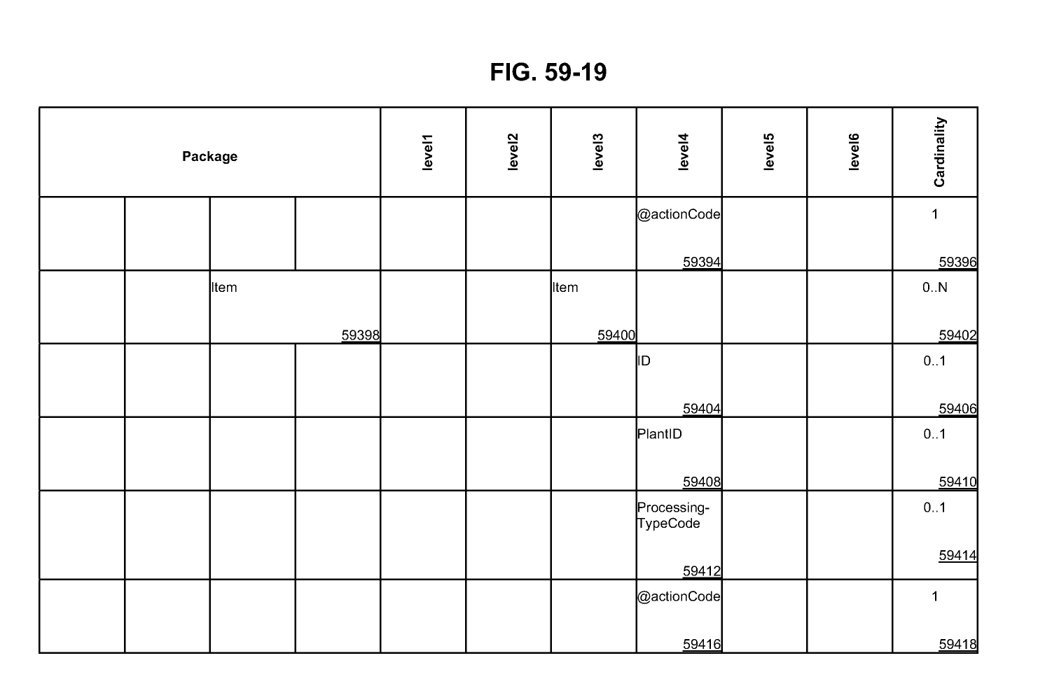

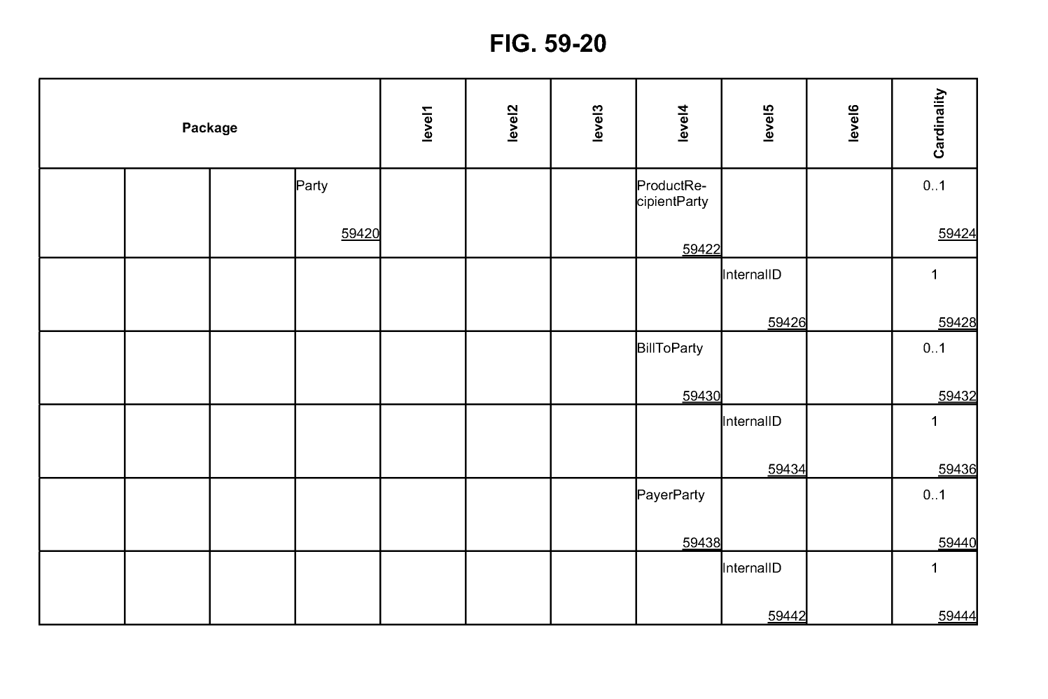

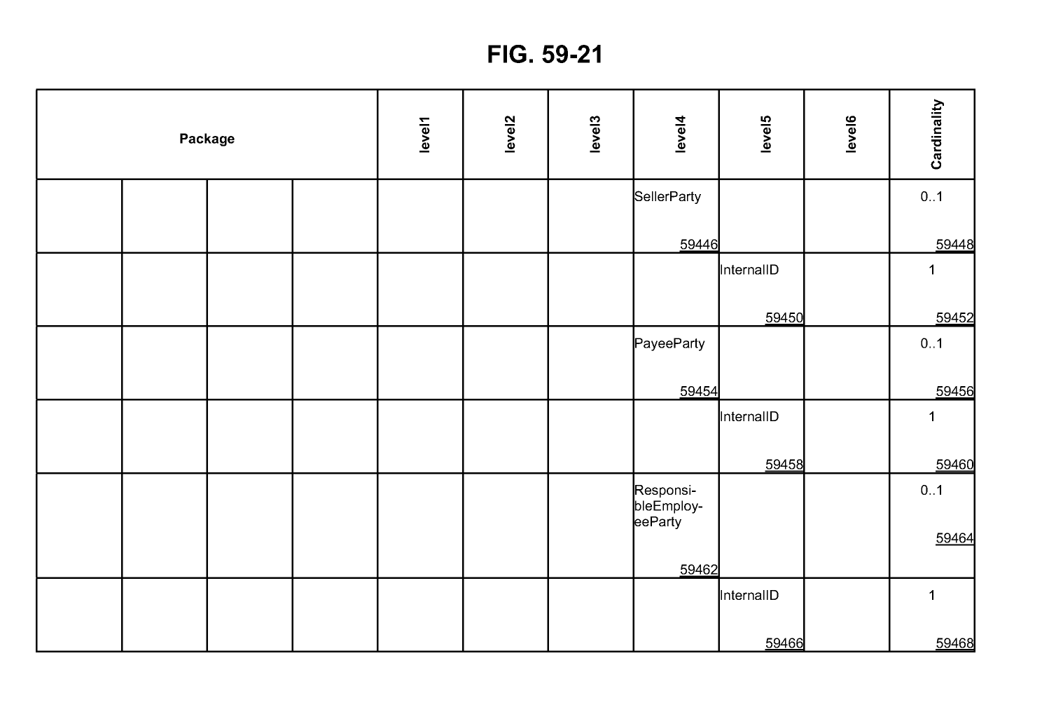

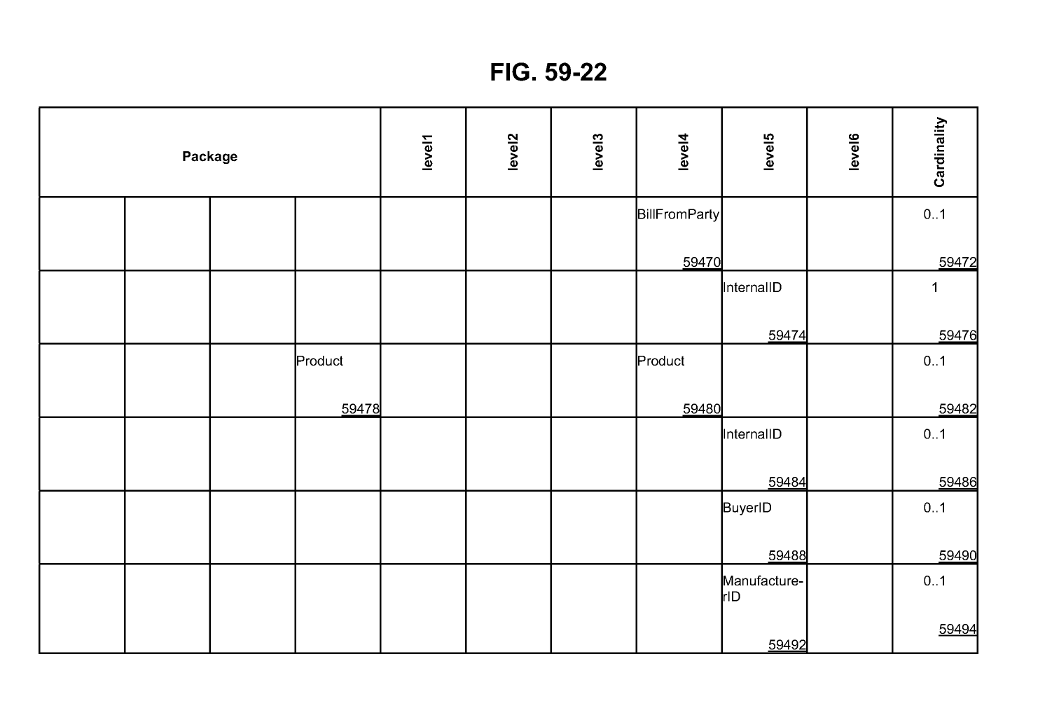

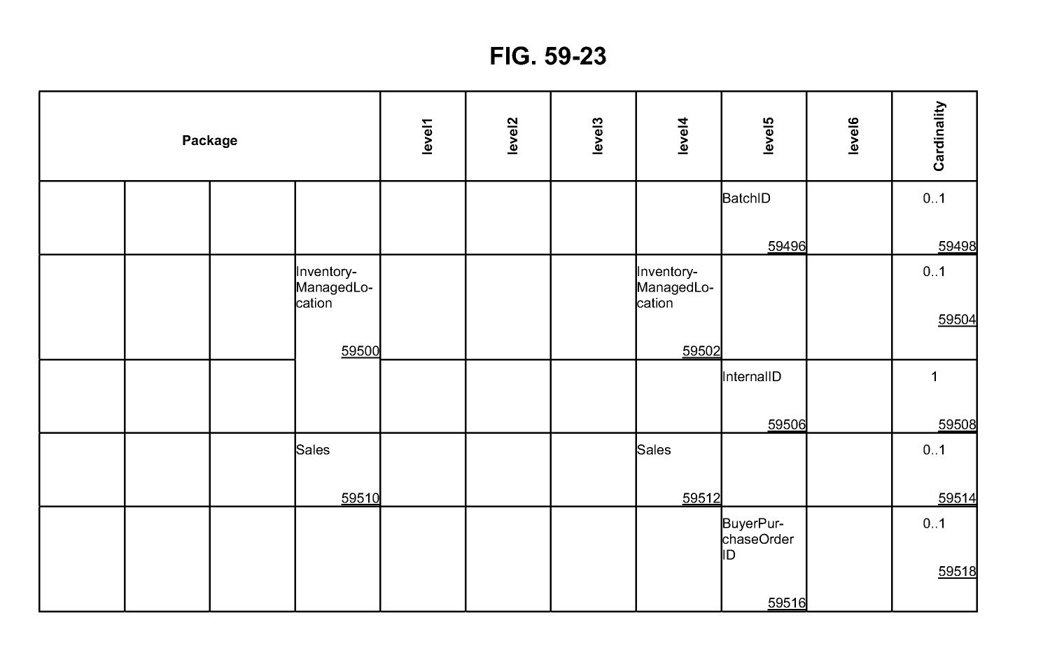

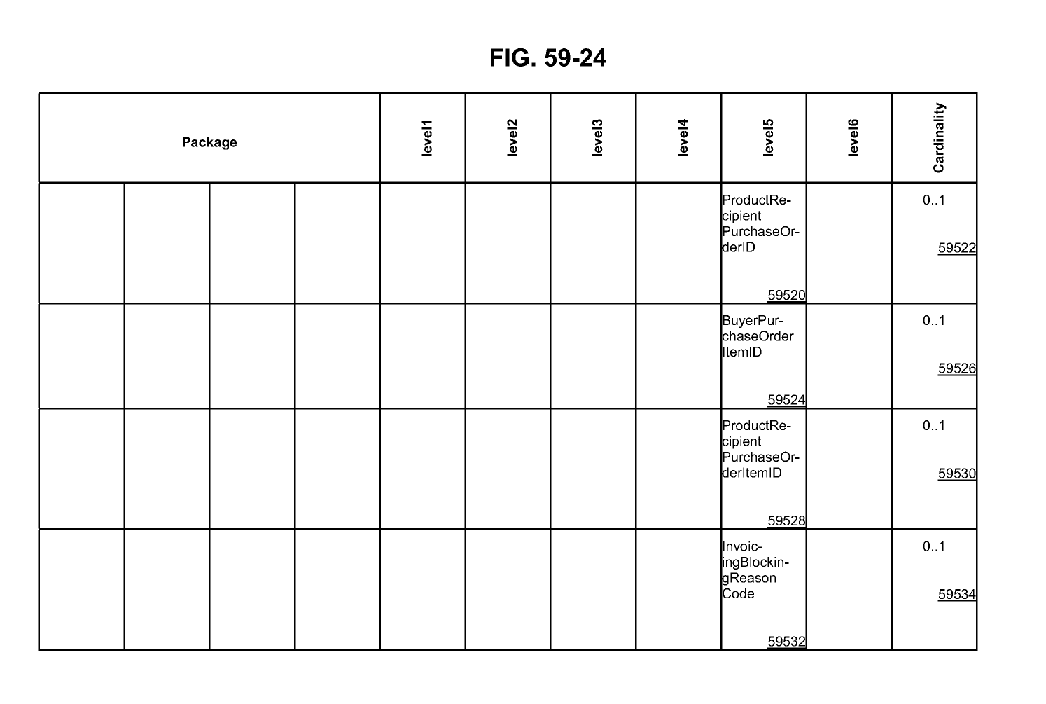

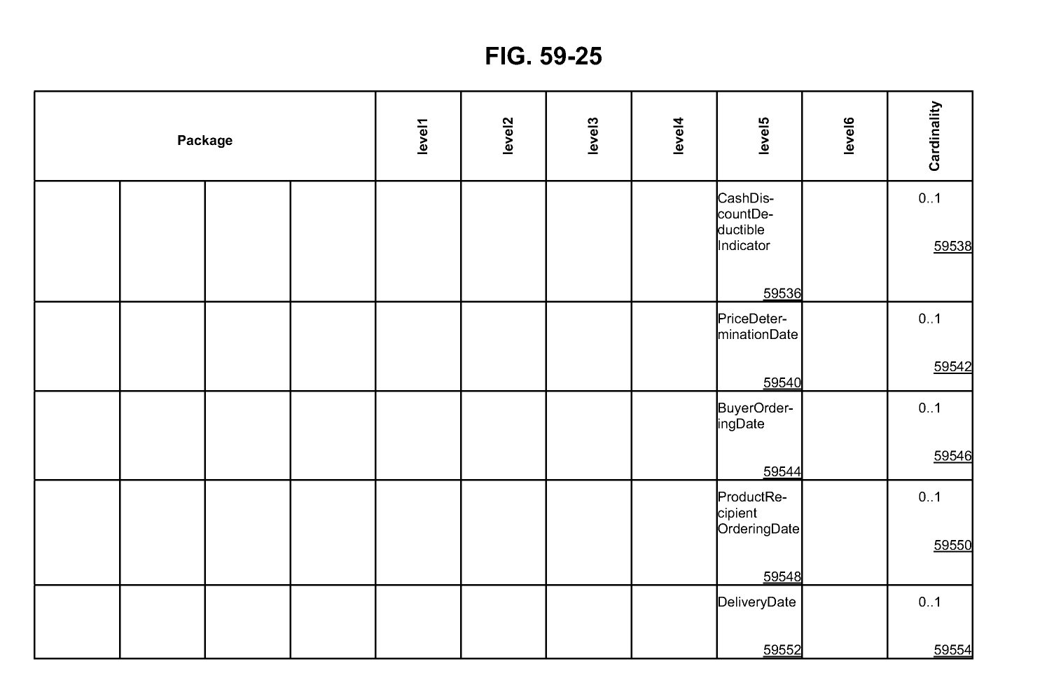

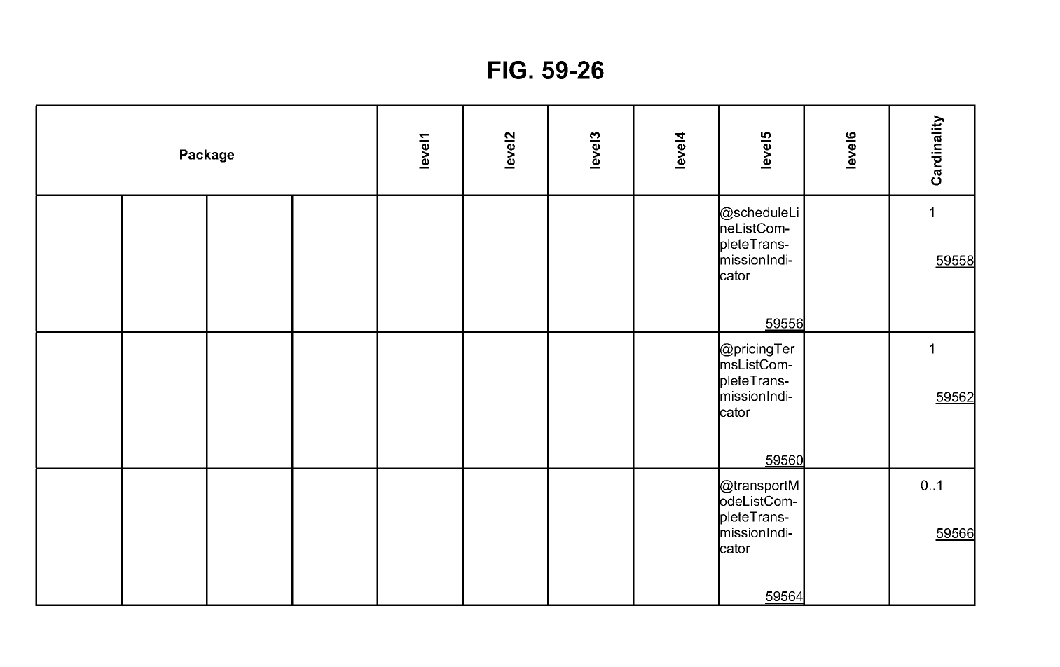

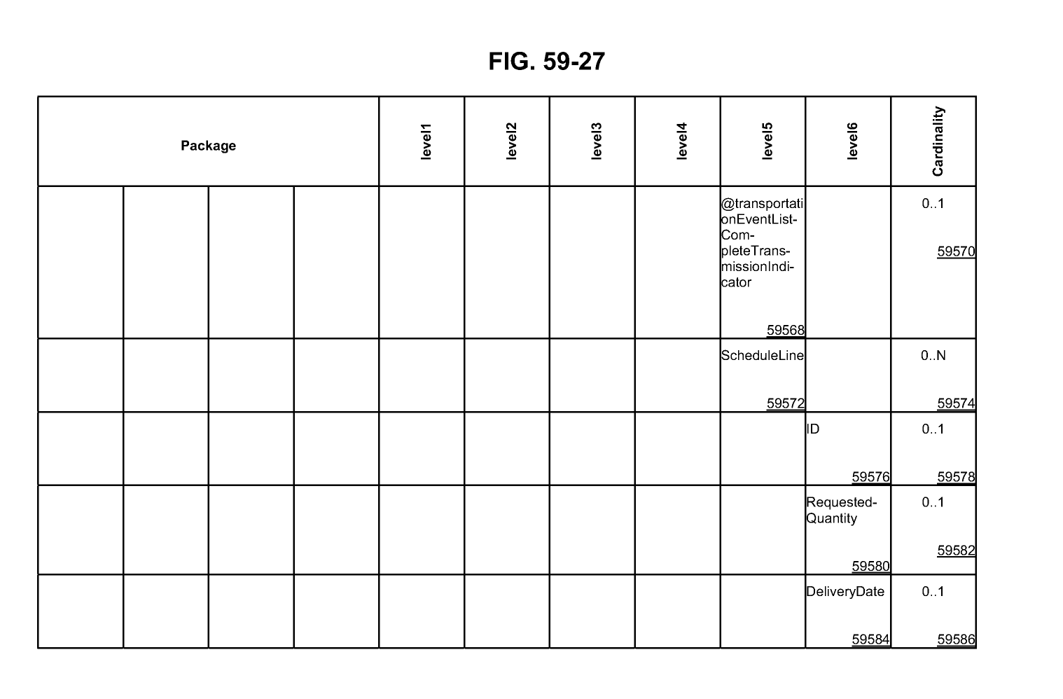

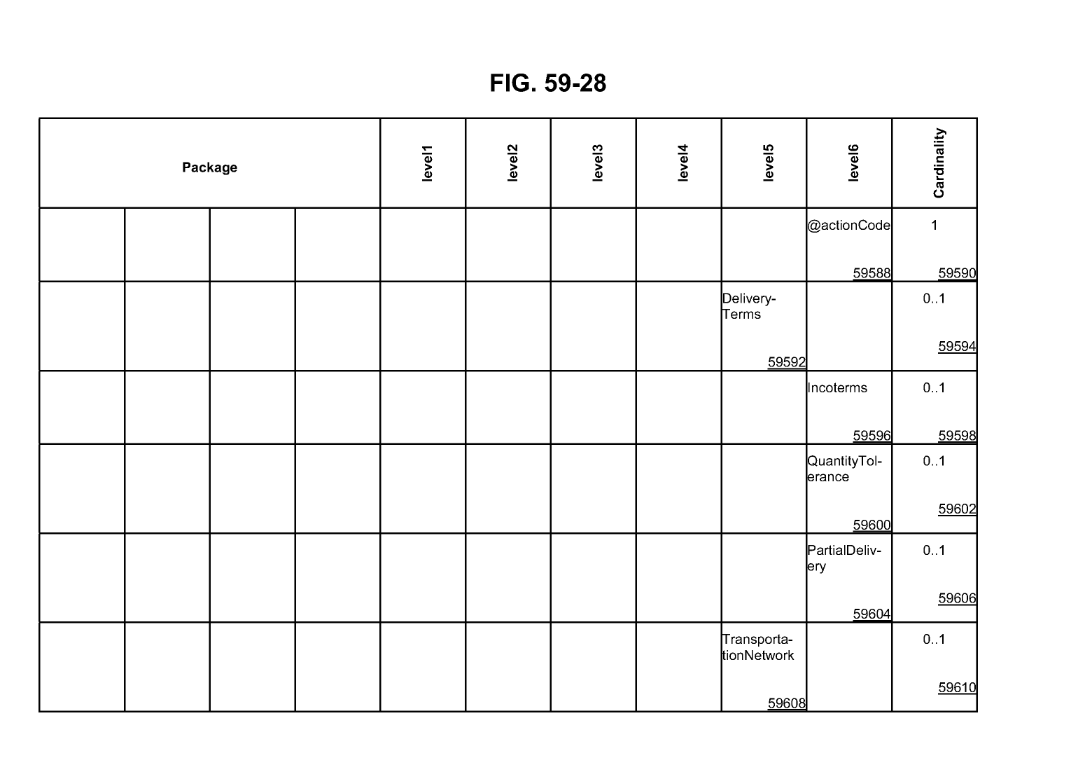

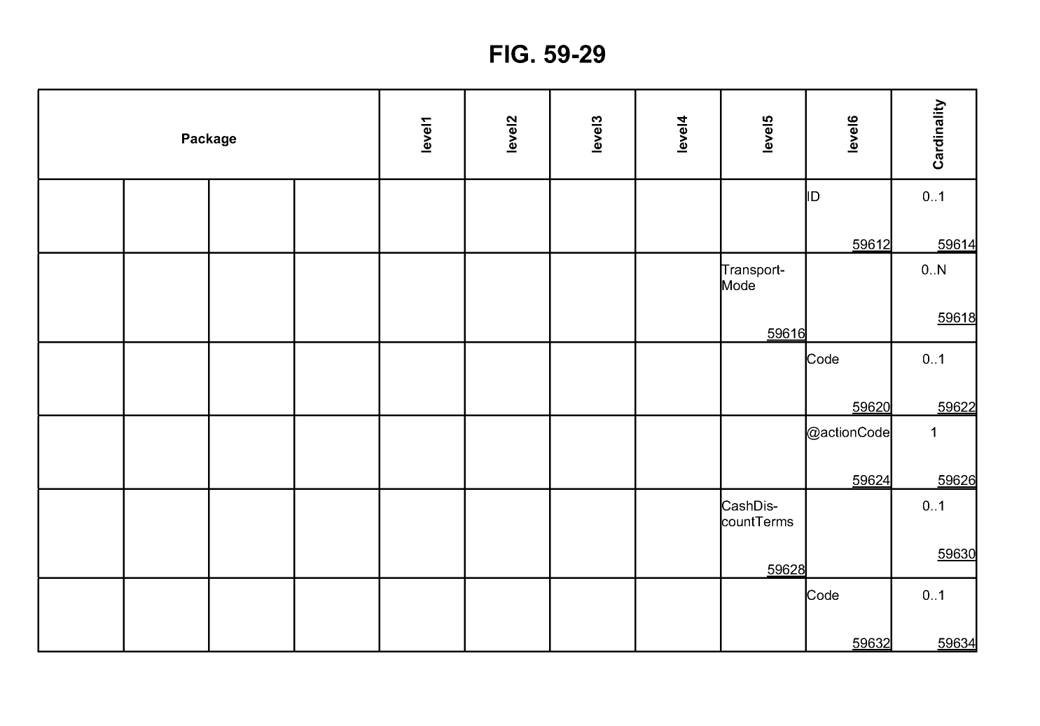

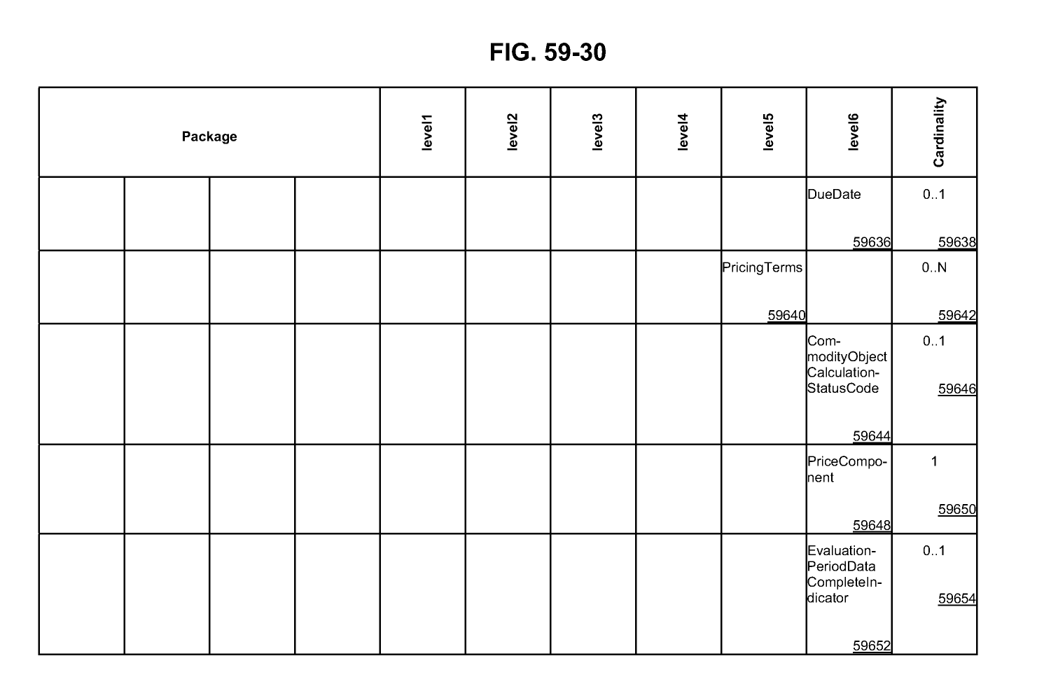

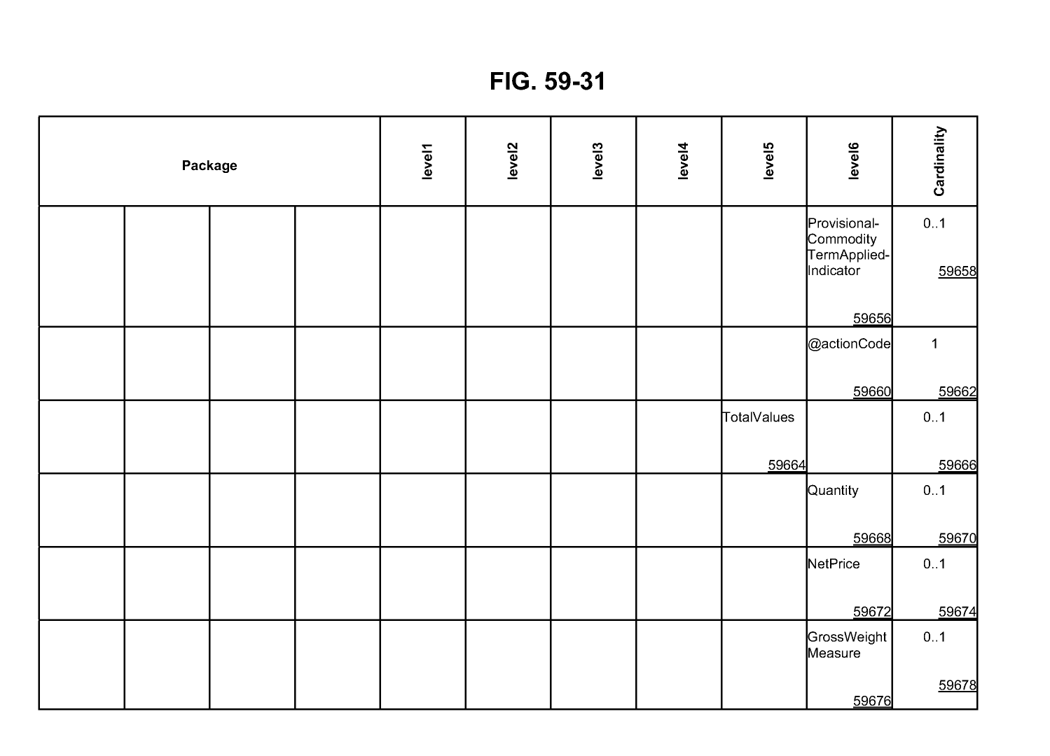

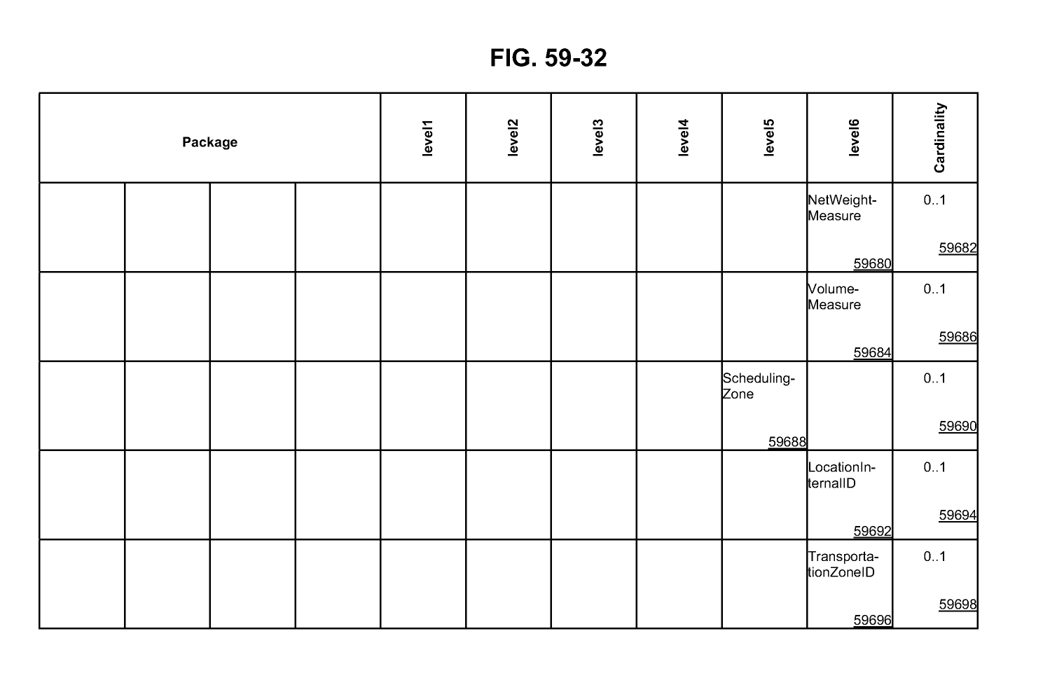

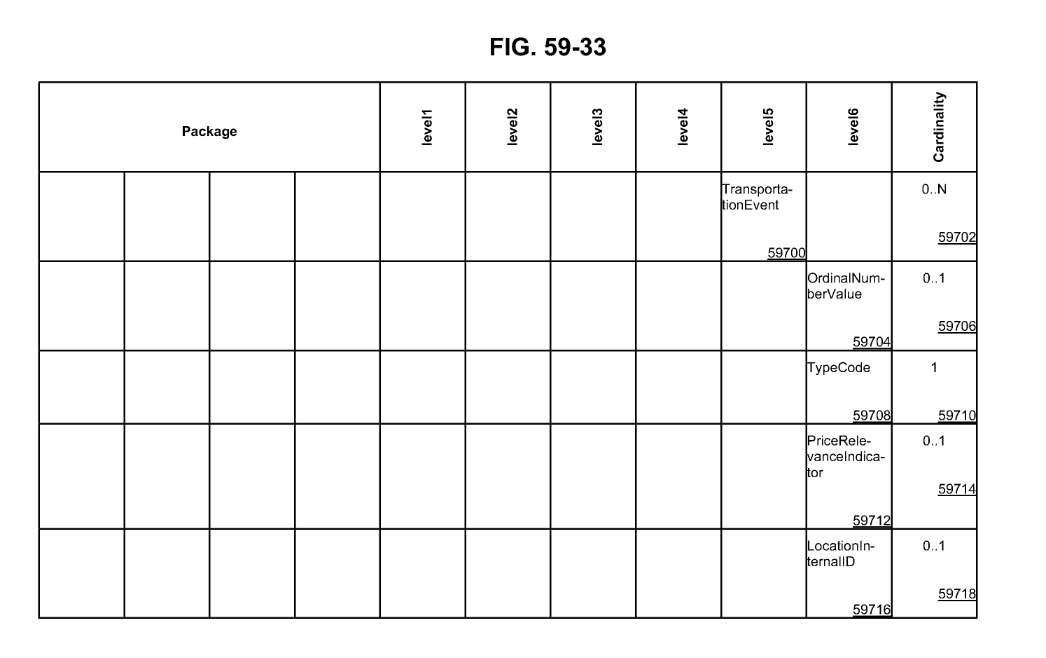

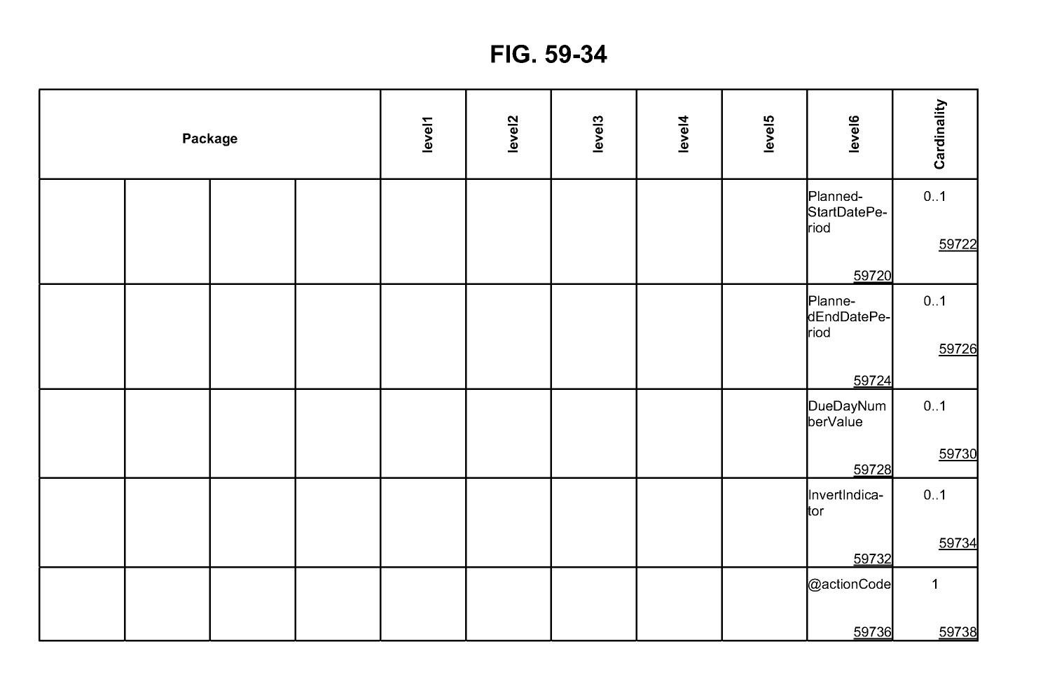

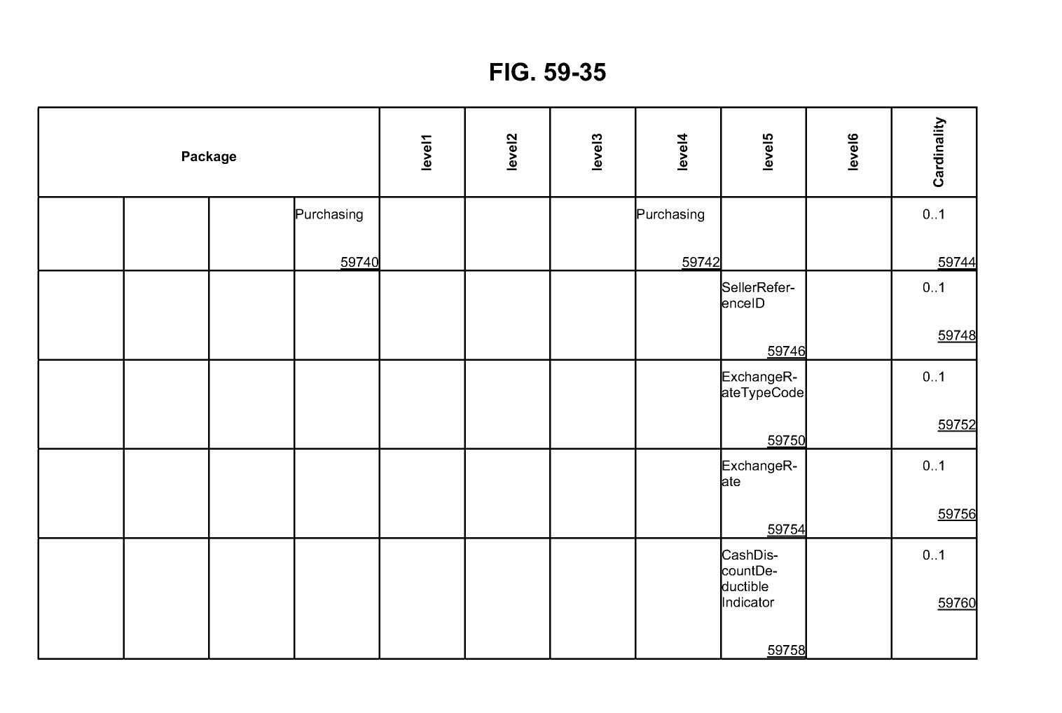

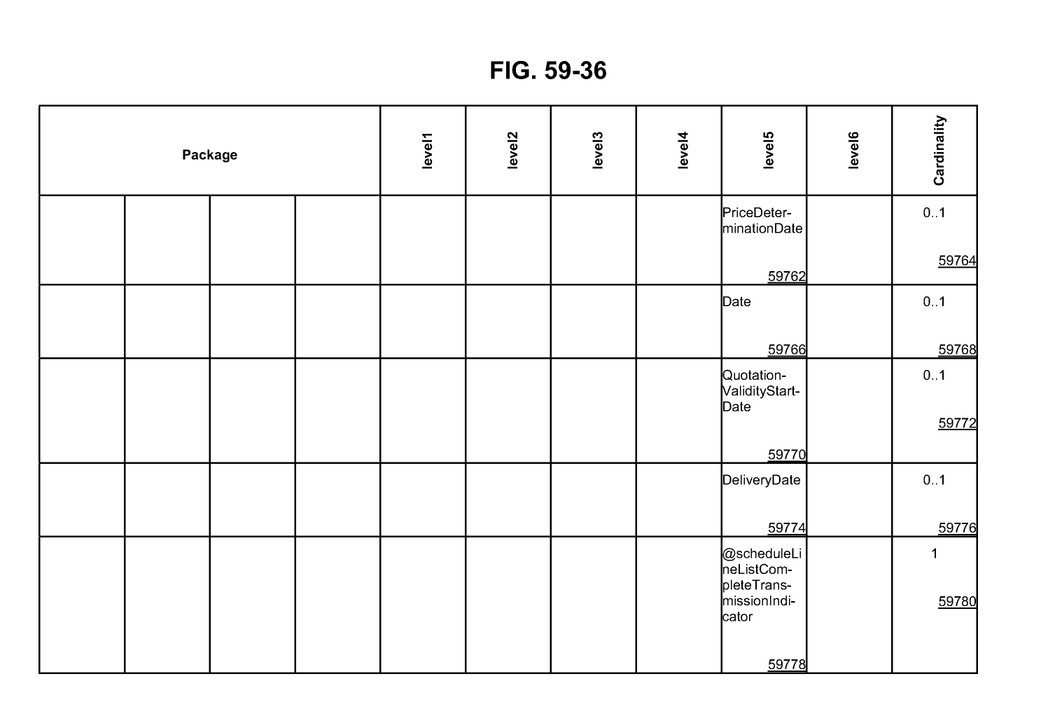

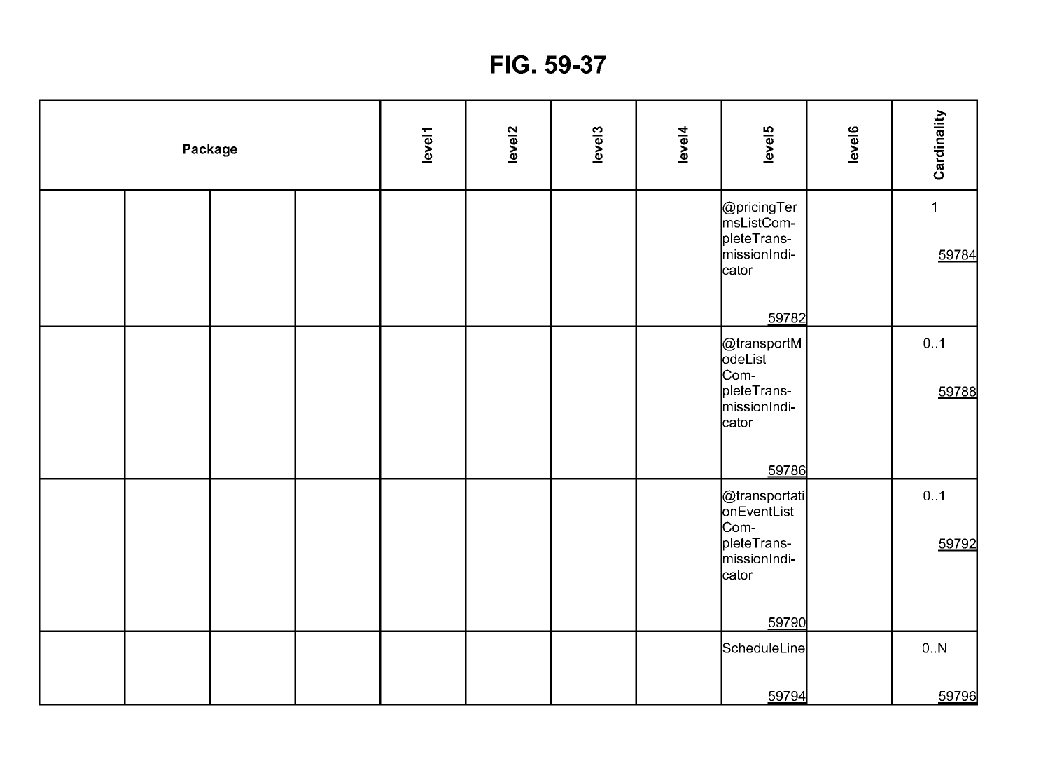

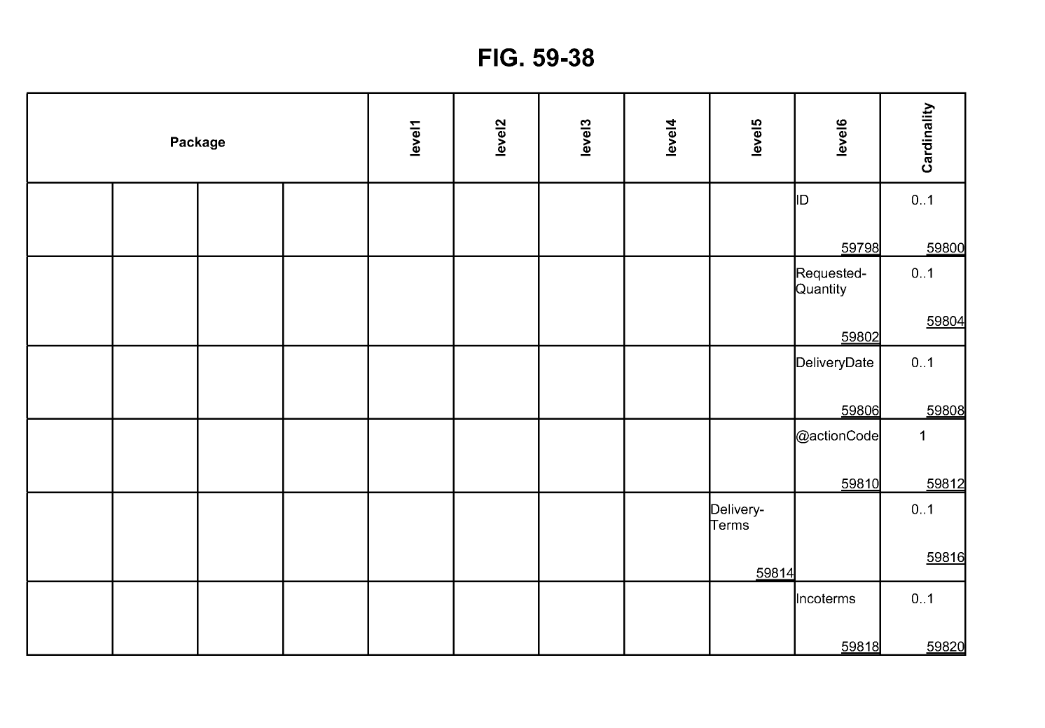

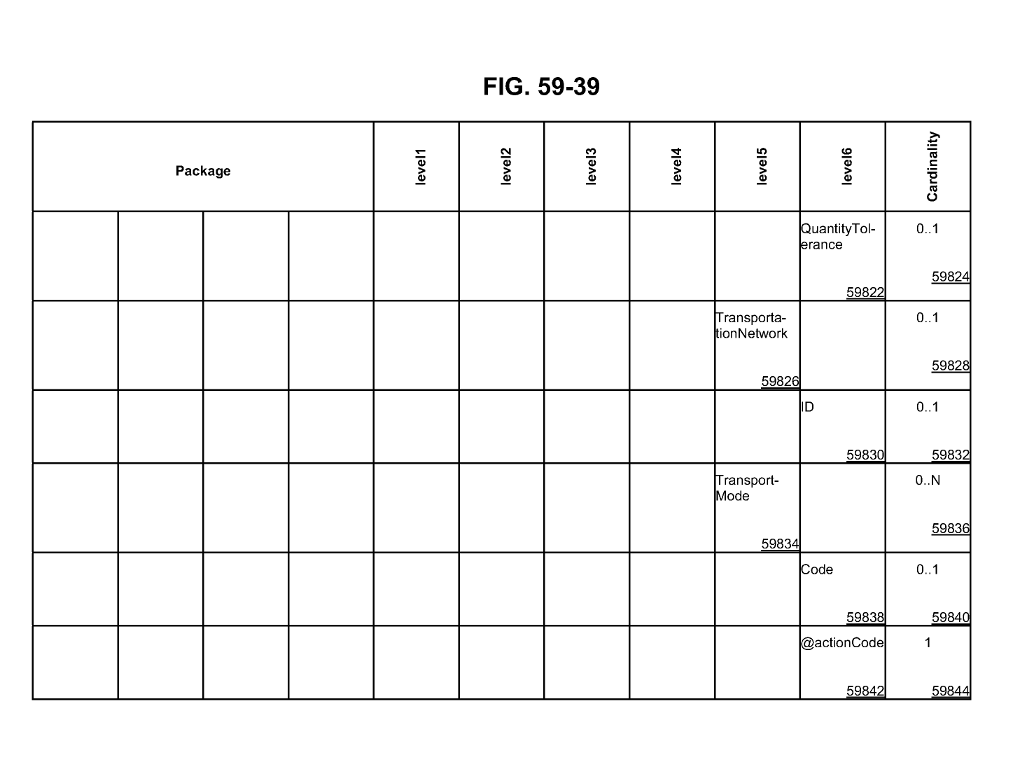

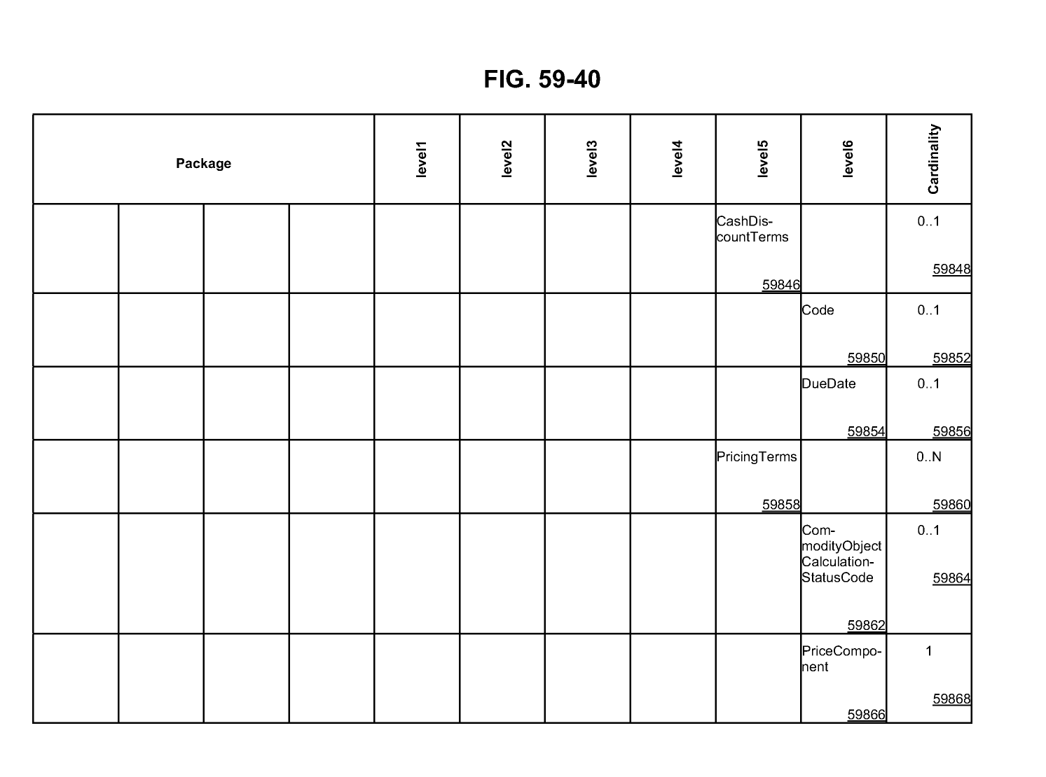

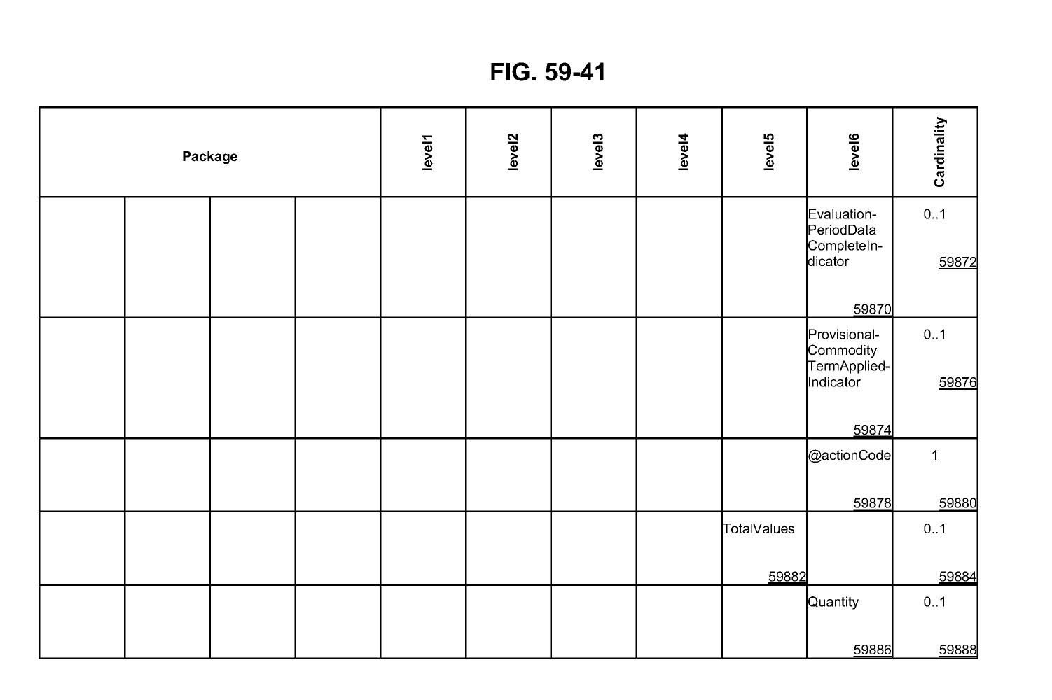

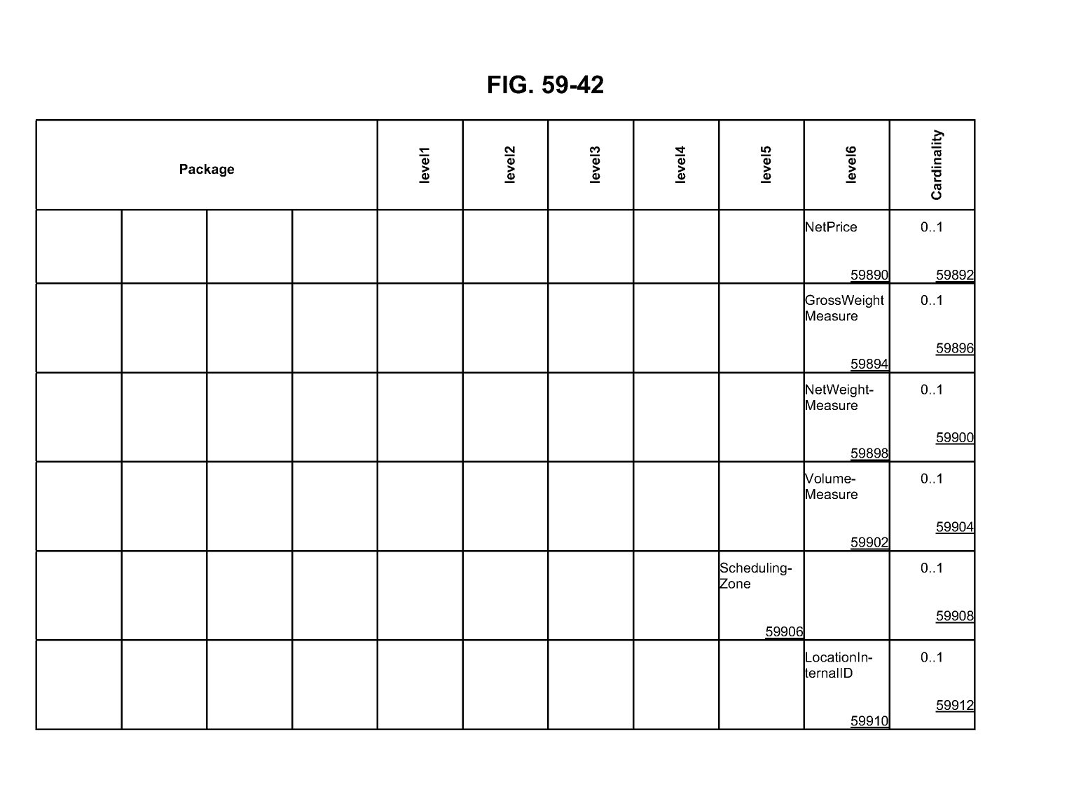

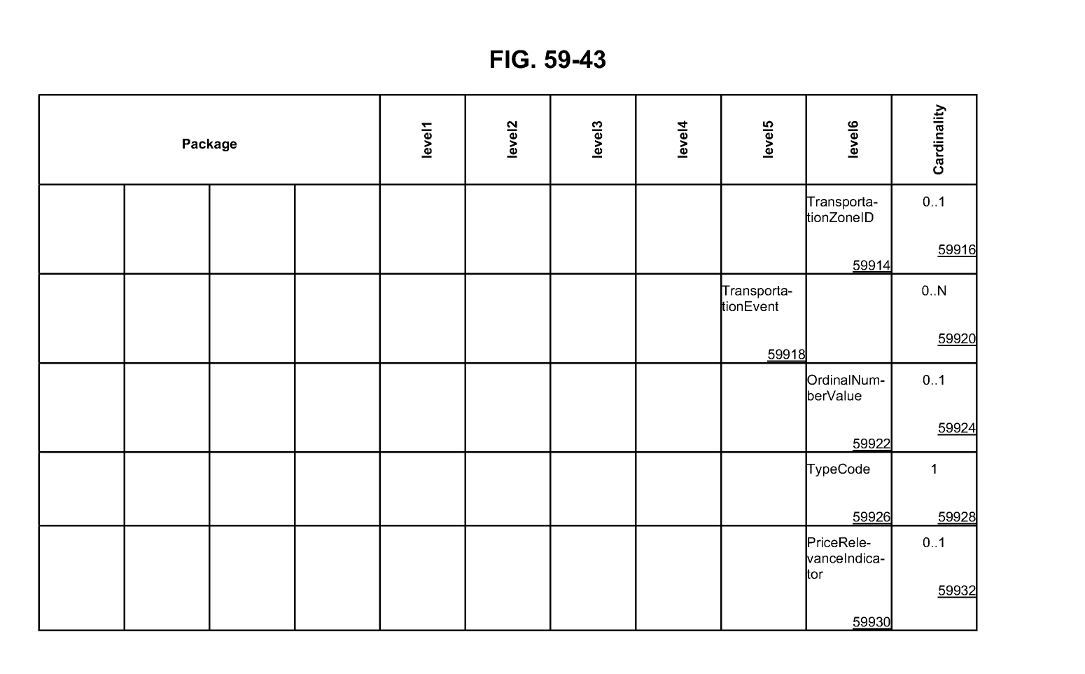

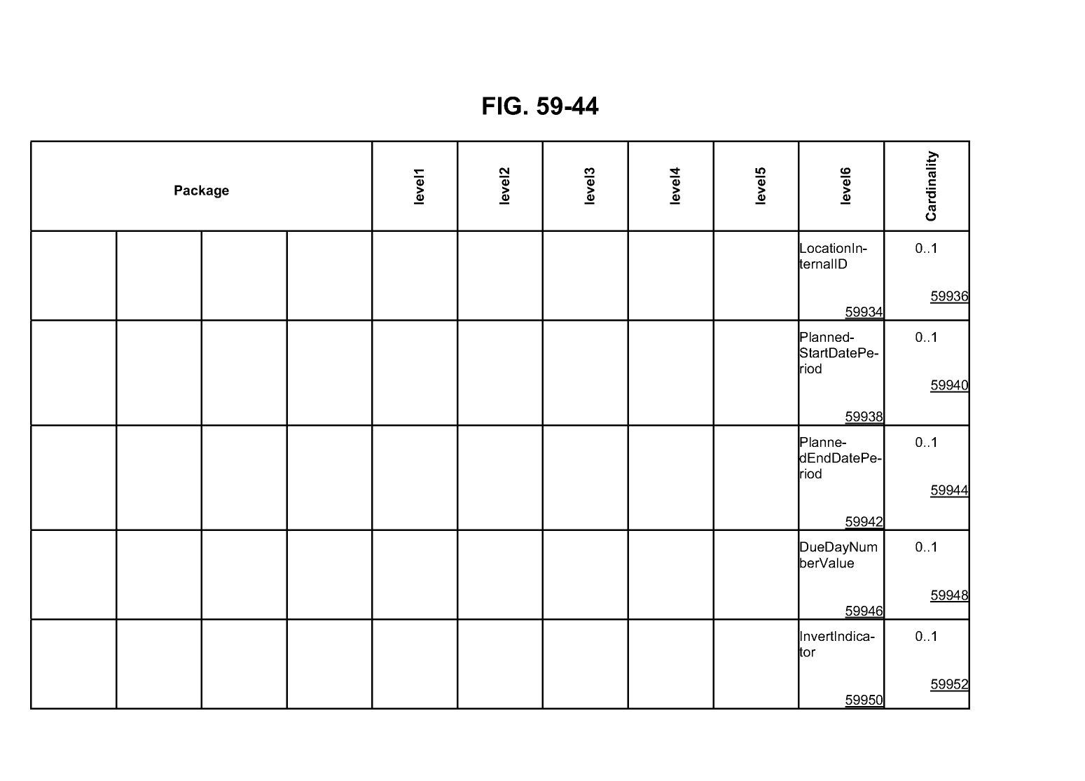

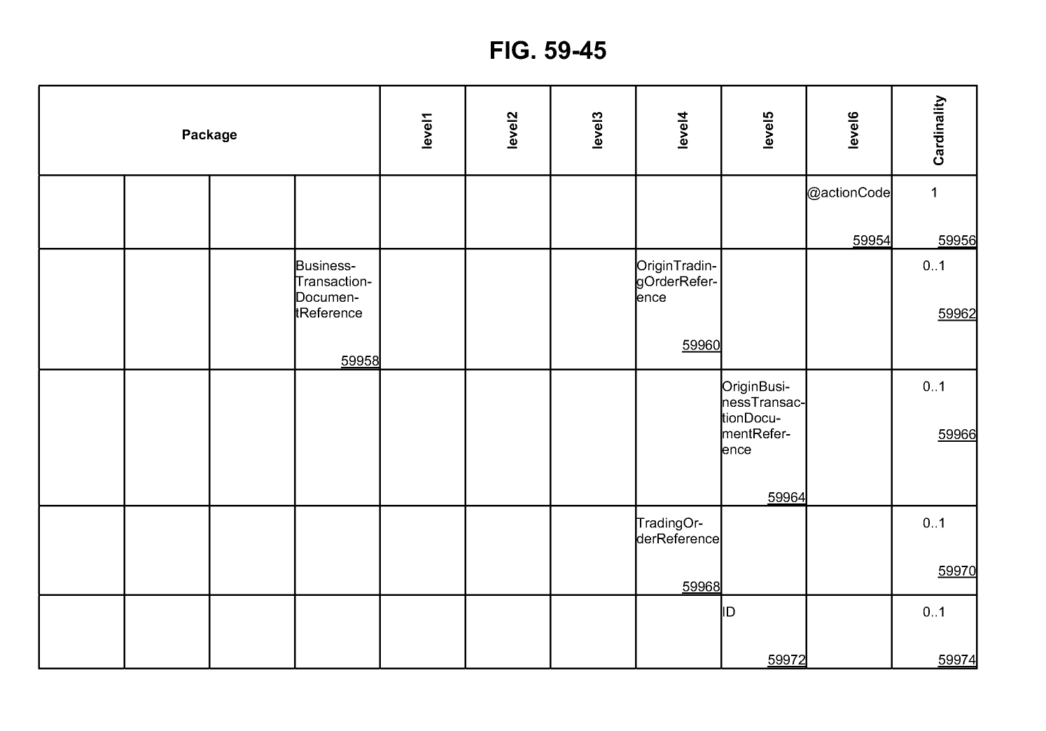

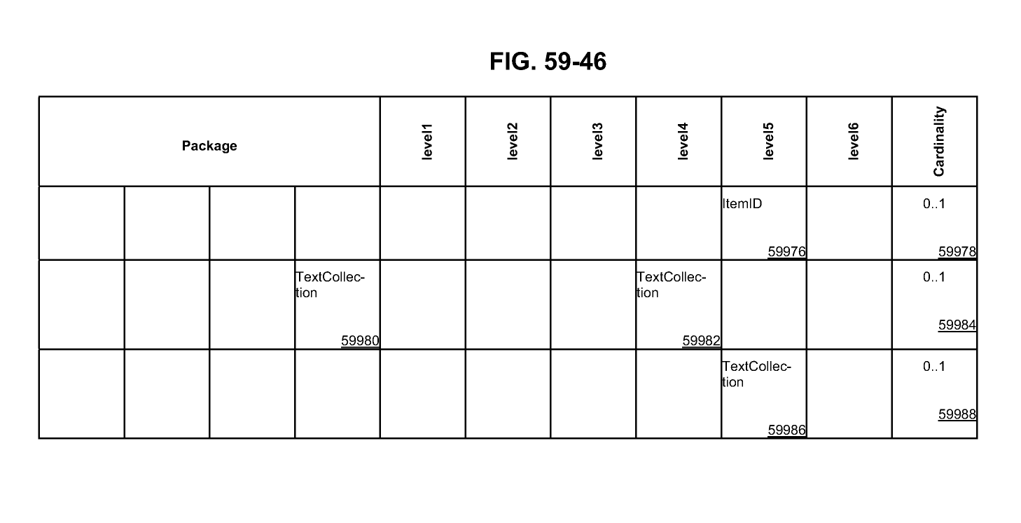

FIGS. 59-1 through 59-46 illustrate one example logical configuration of a TradingOrderRequestMessage 59000 element structure. Specifically, these figures depict the arrangement and hierarchy of various components such as one or more levels of packages, entities, and datatypes, shown here as 59000 through 59988. As described above, packages may be used to represent hierarchy levels. Entities are discrete business elements that are used during a business transaction. Data types are used to type object entities and interfaces with a structure. For example, the TradingOrderRequestMessage 59000 includes, among other things, a TradingOrderRequestMessage 59002. Accordingly, heterogeneous applications may communicate using this consistent message configured as such. The data types of the various packages, entities, and attributes are described with respect to FIG. 58.

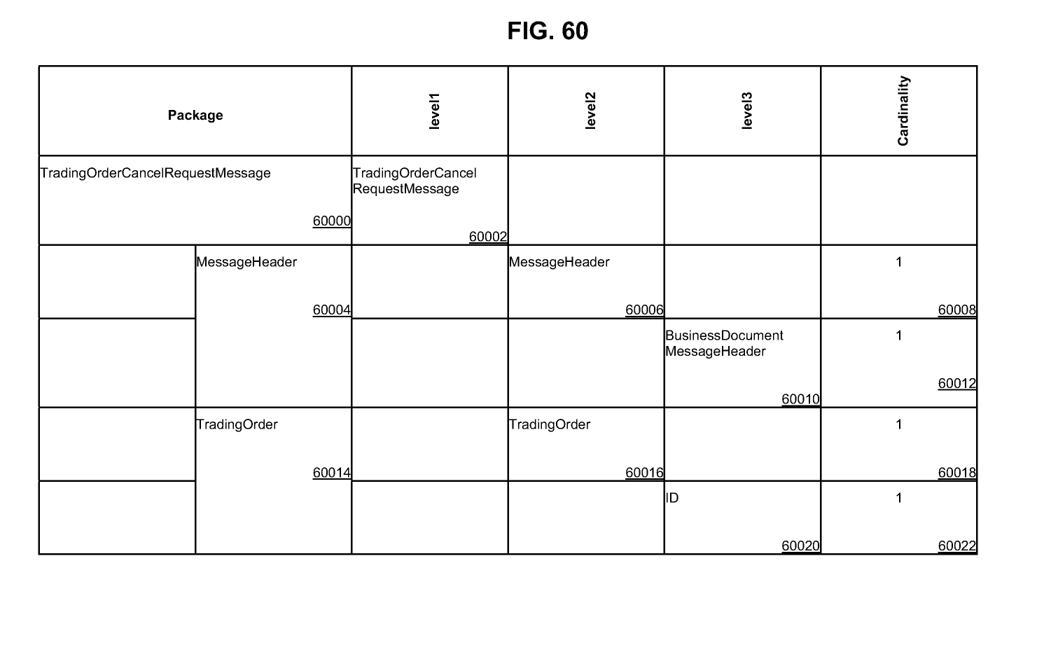

FIG. 60 illustrates one example logical configuration of a TradingOrderCancelRequestMessage 60000 element structure. Specifically, this figure depicts the arrangement and hierarchy of various components such as one or more levels of packages, entities, and datatypes, shown here as 60000 through 60022. As described above, packages may be used to represent hierarchy levels. Entities are discrete business elements that are used during a business transaction. Data types are used to type object entities and interfaces with a structure. For example, the TradingOrderCancelRequestMessage 60000 includes, among other things, a TradingOrderCancelRequestMessage 60002. Accordingly, heterogeneous applications may communicate using this consistent message configured as such. The data types of the various packages, entities, and attributes are described with respect to FIG. 58.

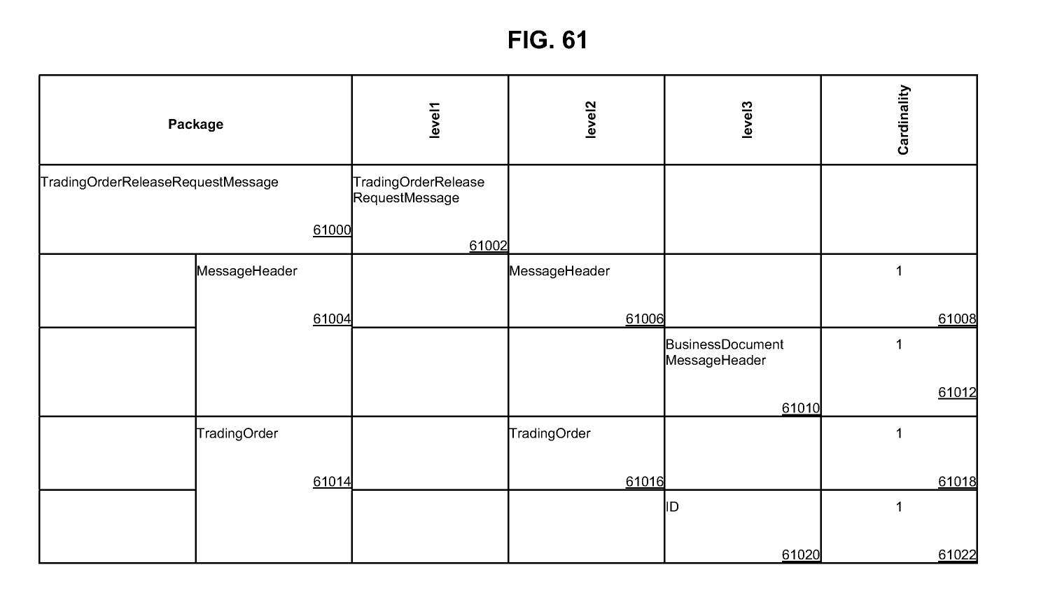

FIG. 61 illustrates one example logical configuration of a TradingOrderReleaseRequestMessage 61000 element structure. Specifically, this figure depicts the arrangement and hierarchy of various components such as one or more levels of packages, entities, and datatypes, shown here as 61000 through 61022. As described above, packages may be used to represent hierarchy levels. Entities are discrete business elements that are used during a business transaction. Data types are used to type object entities and interfaces with a structure. For example, the TradingOrderReleaseRequestMessage 61000 includes, among other things, a TradingOrderReleaseRequestMessage 61002. Accordingly, heterogeneous applications may communicate using this consistent message configured as such. The data types of the various packages, entities, and attributes are described with respect to FIG. 58.

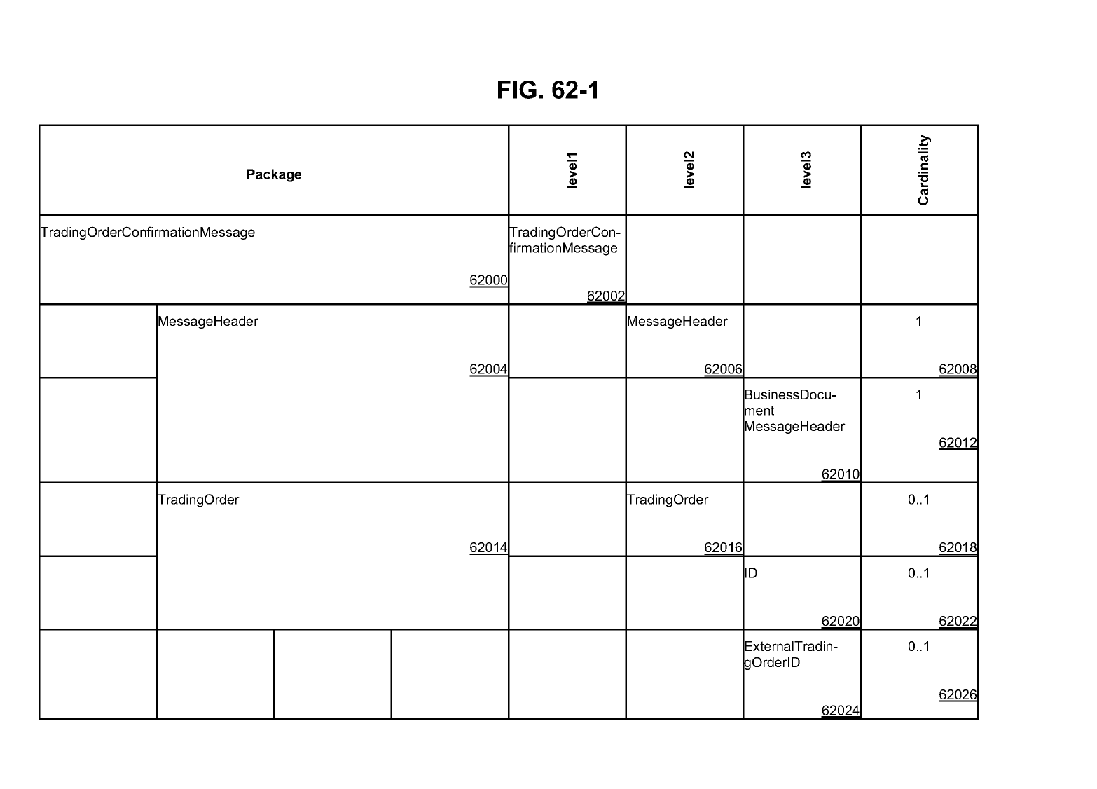

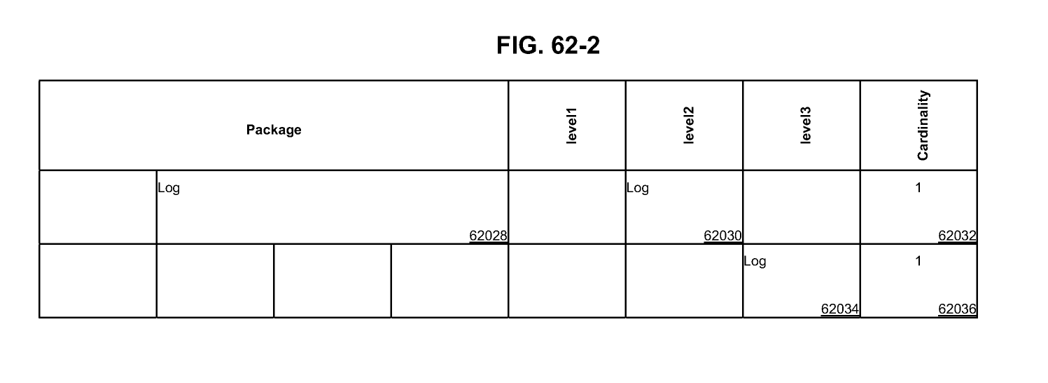

FIGS. 62-1 through 62-2 illustrate one example logical configuration of a TradingOrderConfirmationMessage 62000 element structure. Specifically, these figures depict the arrangement and hierarchy of various components such as one or more levels of packages, entities, and datatypes, shown here as 62000 through 62036. As described above, packages may be used to represent hierarchy levels. Entities are discrete business elements that are used during a business transaction. Data types are used to type object entities and interfaces with a structure. For example, the TradingOrderConfirmationMessage 62000 includes, among other things, a TradingOrderConfirmationMessage 62002. Accordingly, heterogeneous applications may communicate using this consistent message configured as such. The data types of the various packages, entities, and attributes are described with respect to FIG. 58.

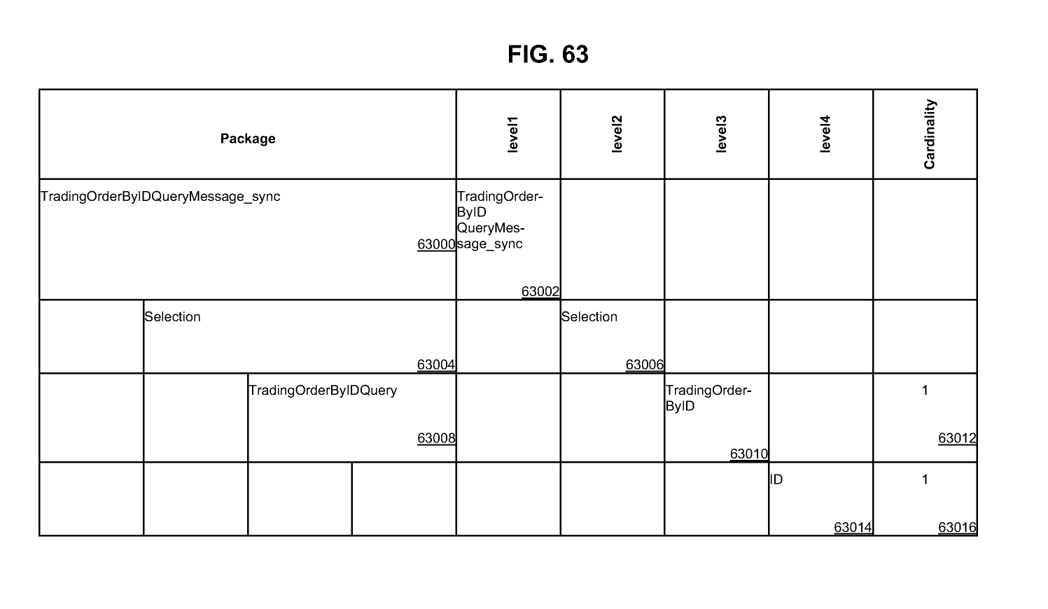

FIG. 63 illustrates one example logical configuration of a TradingOrderByIDQueryMessage_sync 63000 element structure. Specifically, this figure depicts the arrangement and hierarchy of various components such as one or more levels of packages, entities, and datatypes, shown here as 63000 through 63016. As described above, packages may be used to represent hierarchy levels. Entities are discrete business elements that are used during a business transaction. Data types are used to type object entities and interfaces with a structure. For example, the TradingOrderByIDQueryMessage_sync 63000 includes, among other things, a TradingOrderByIDQueryMessage_sync 63002. Accordingly, heterogeneous applications may communicate using this consistent message configured as such. The data types of the various packages, entities, and attributes are described with respect to FIG. 58.

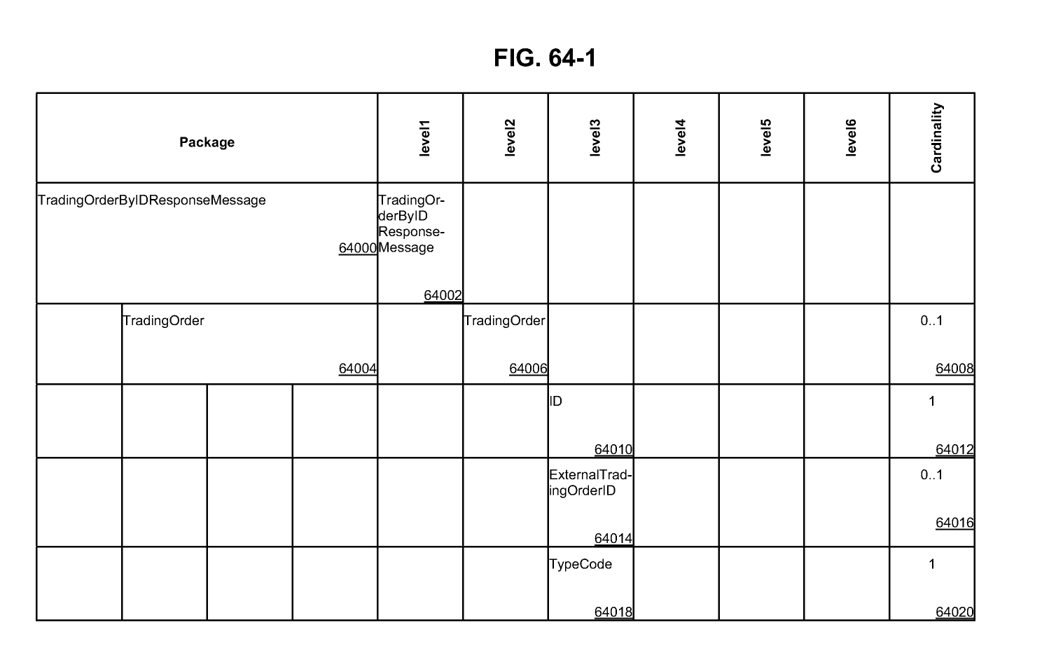

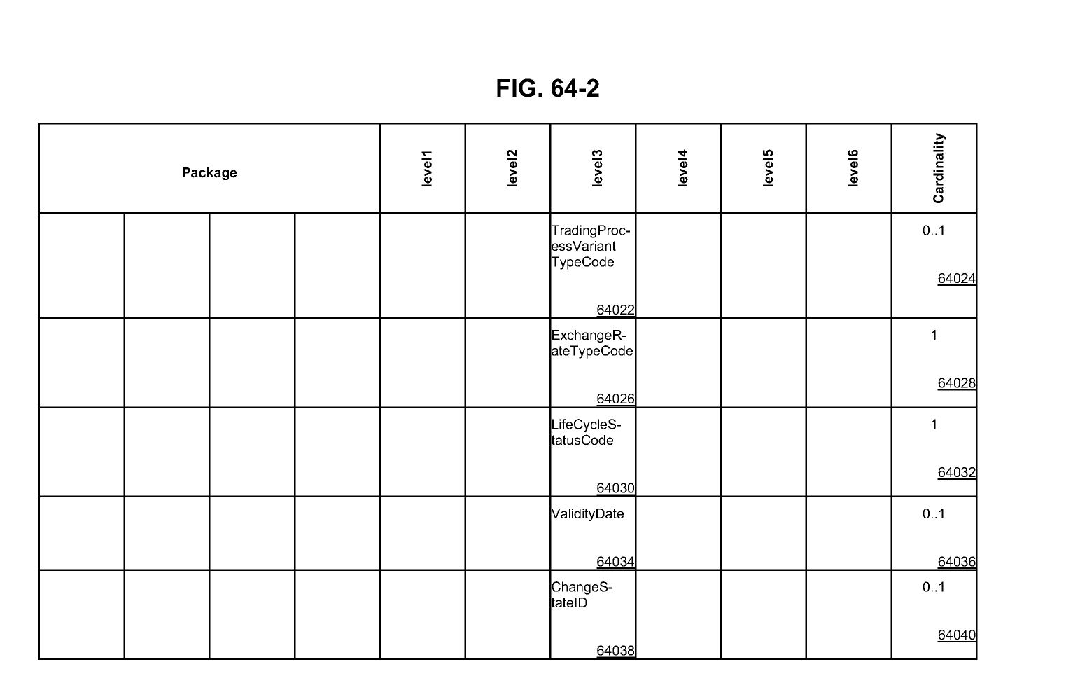

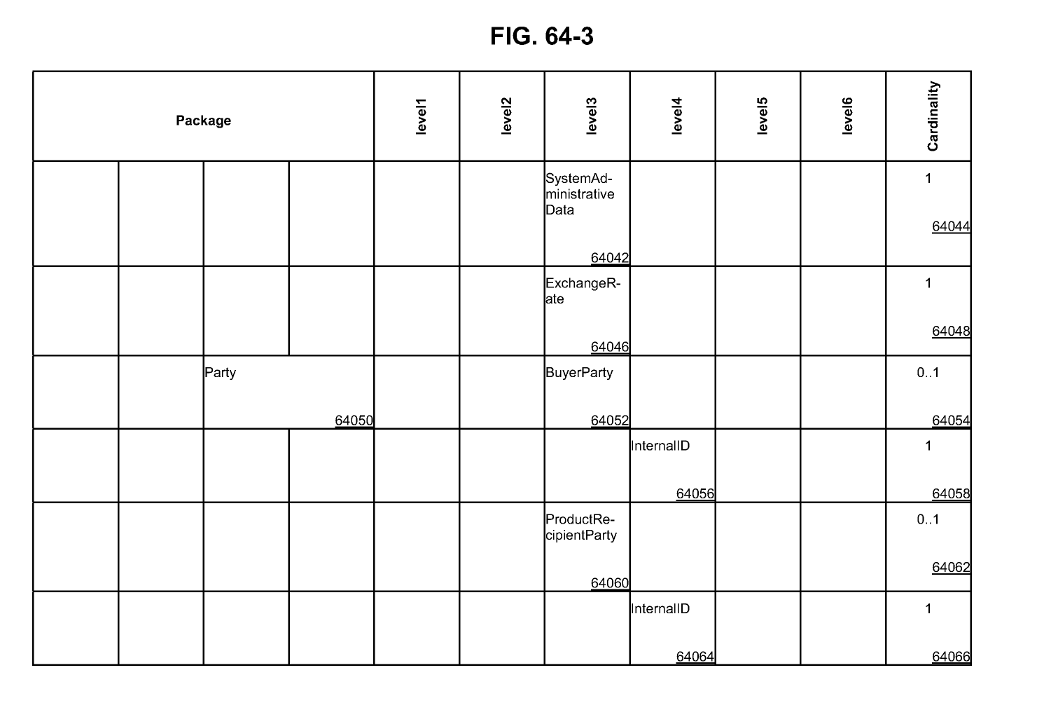

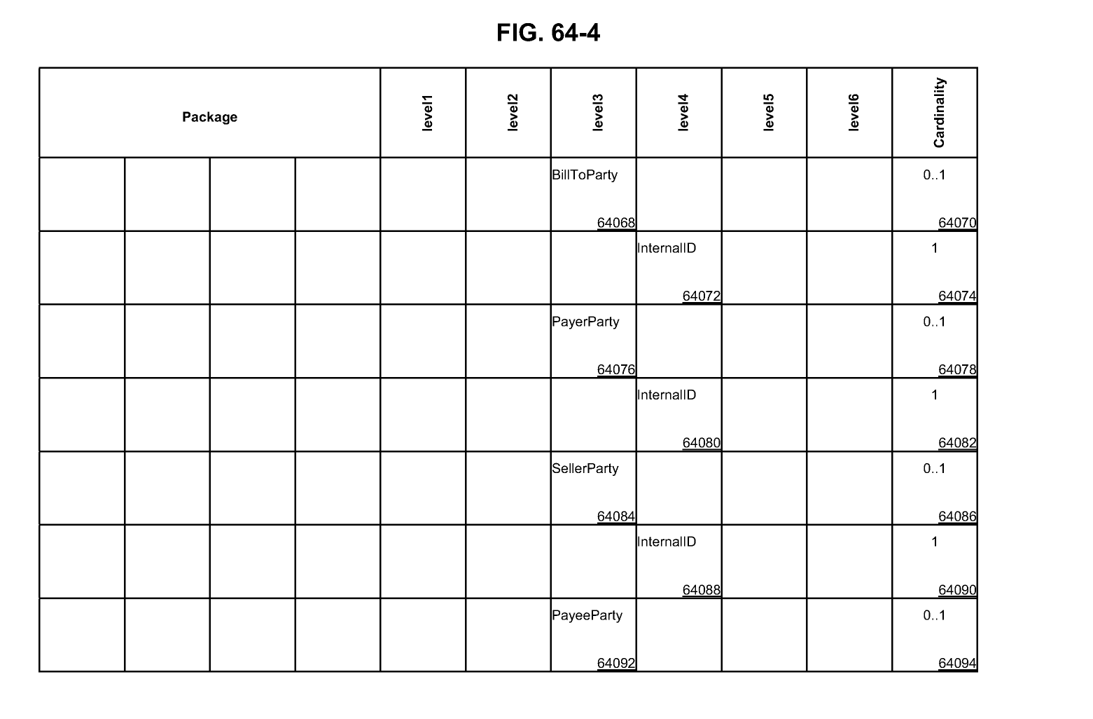

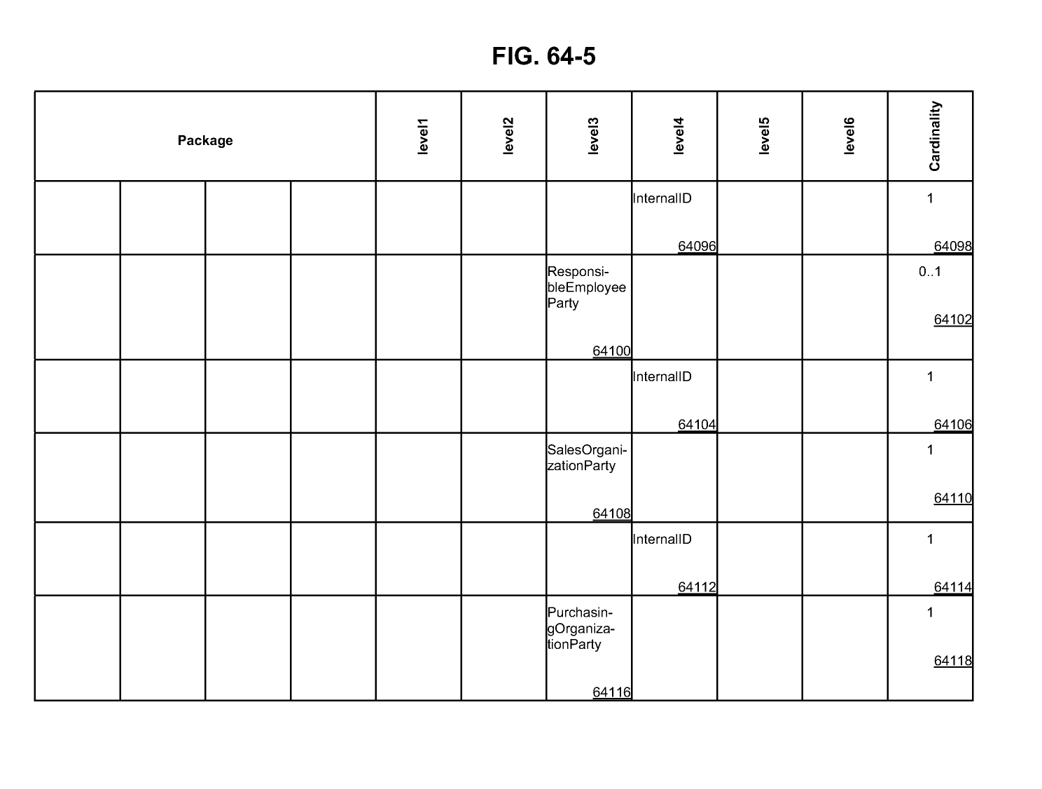

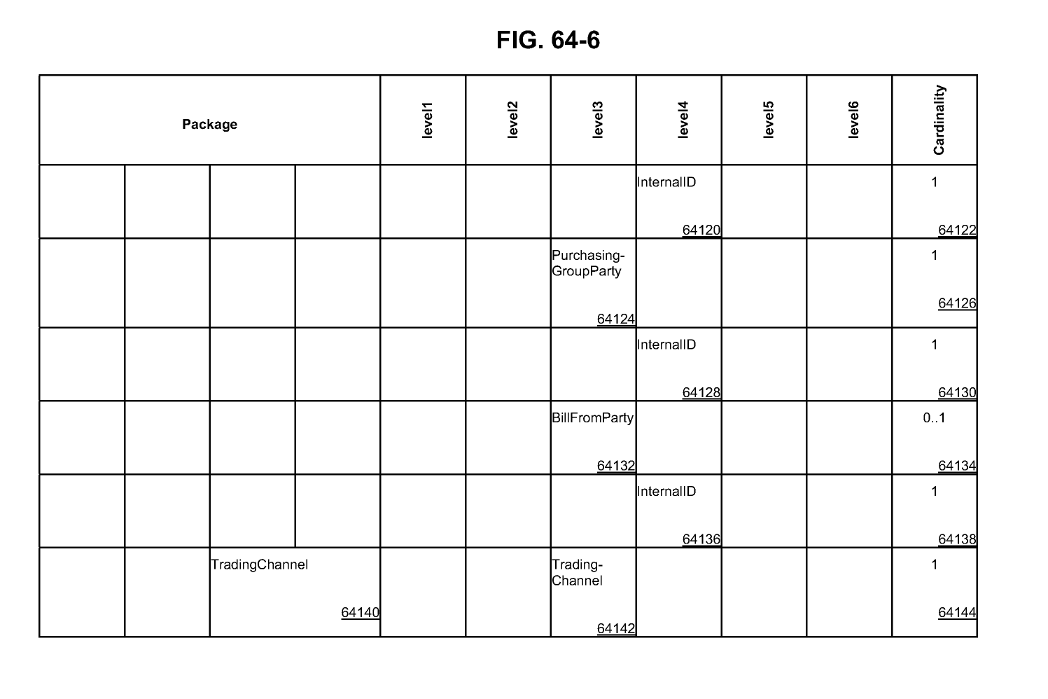

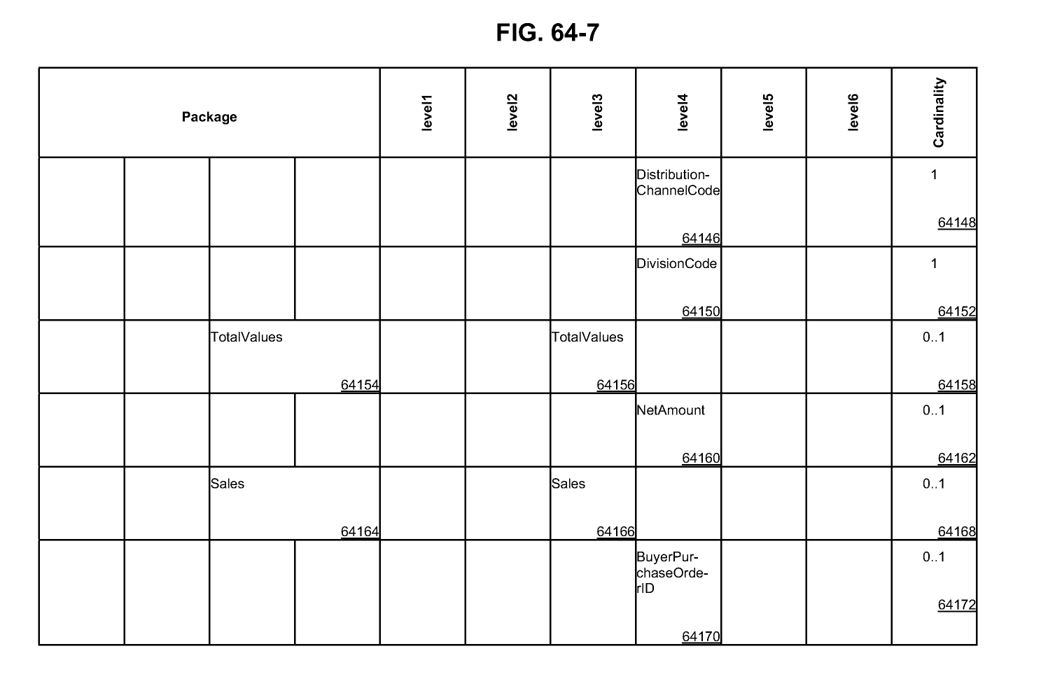

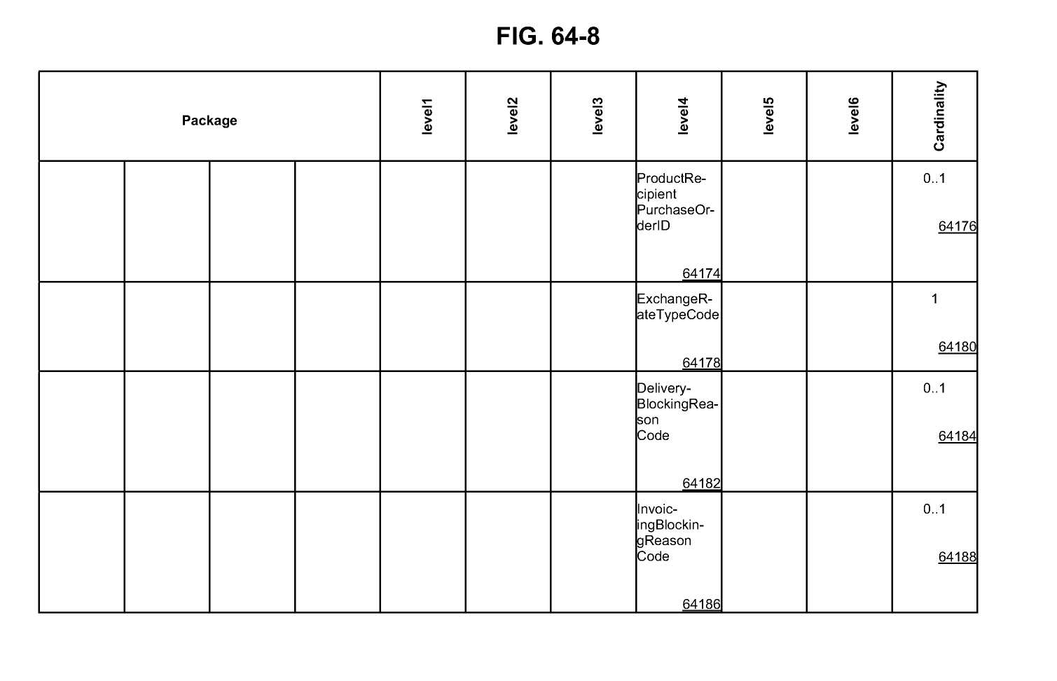

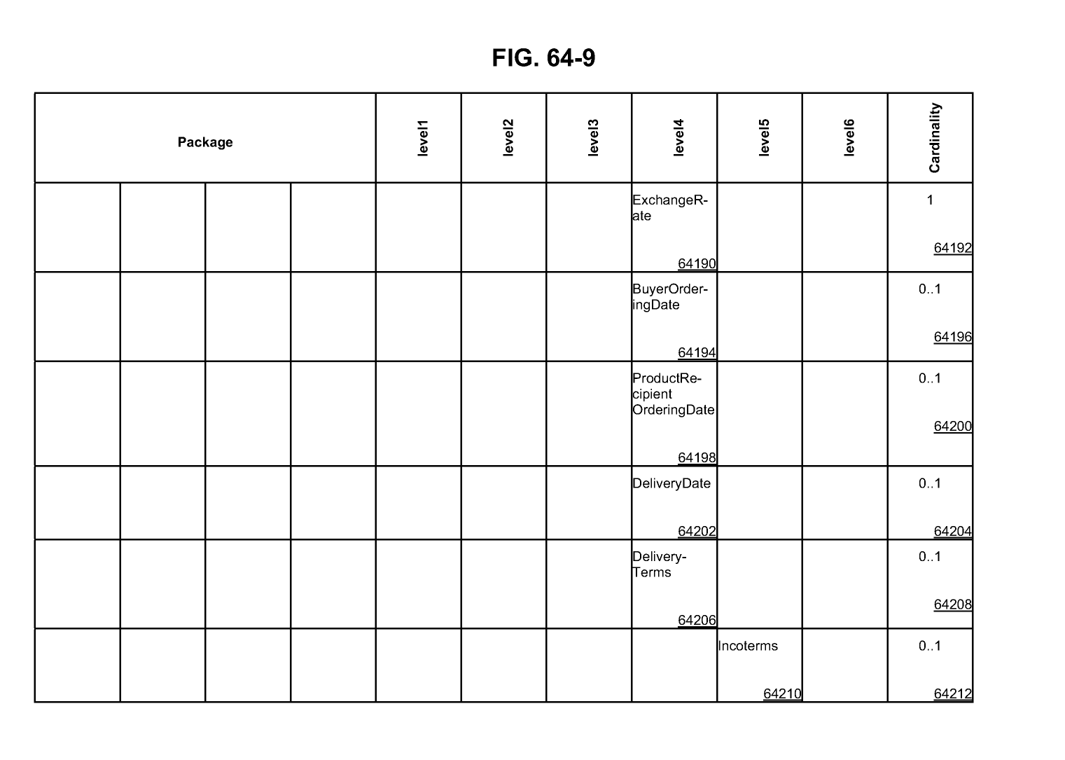

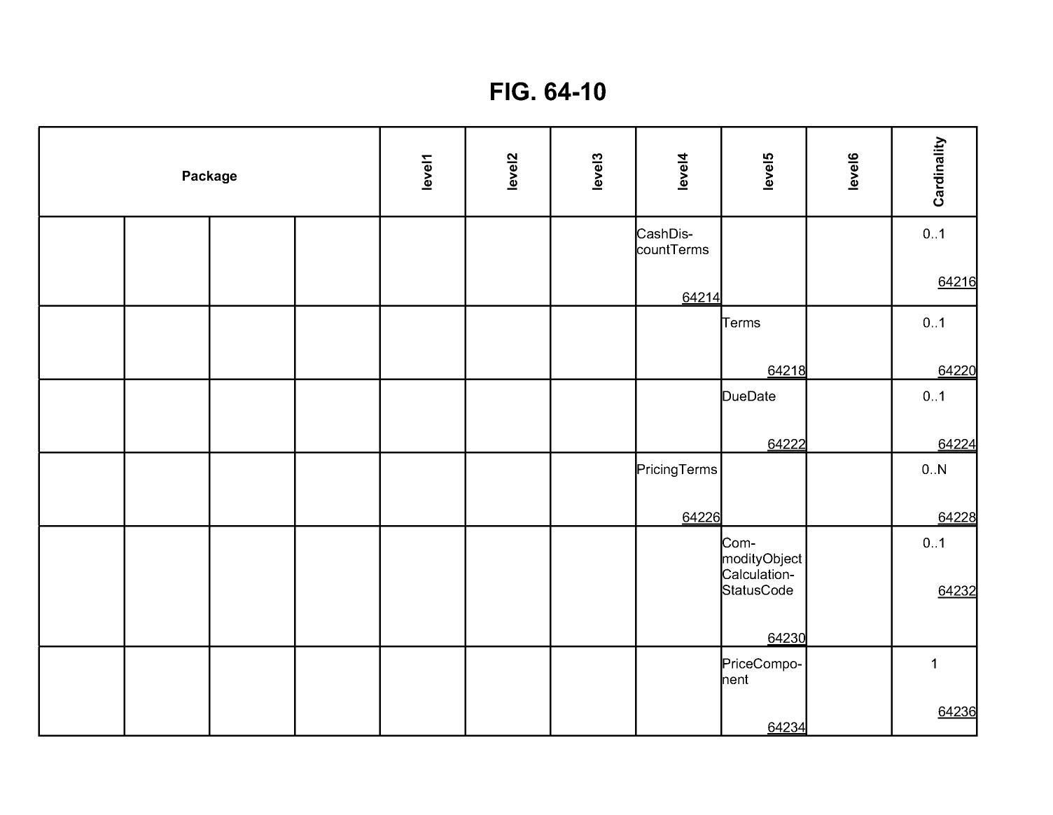

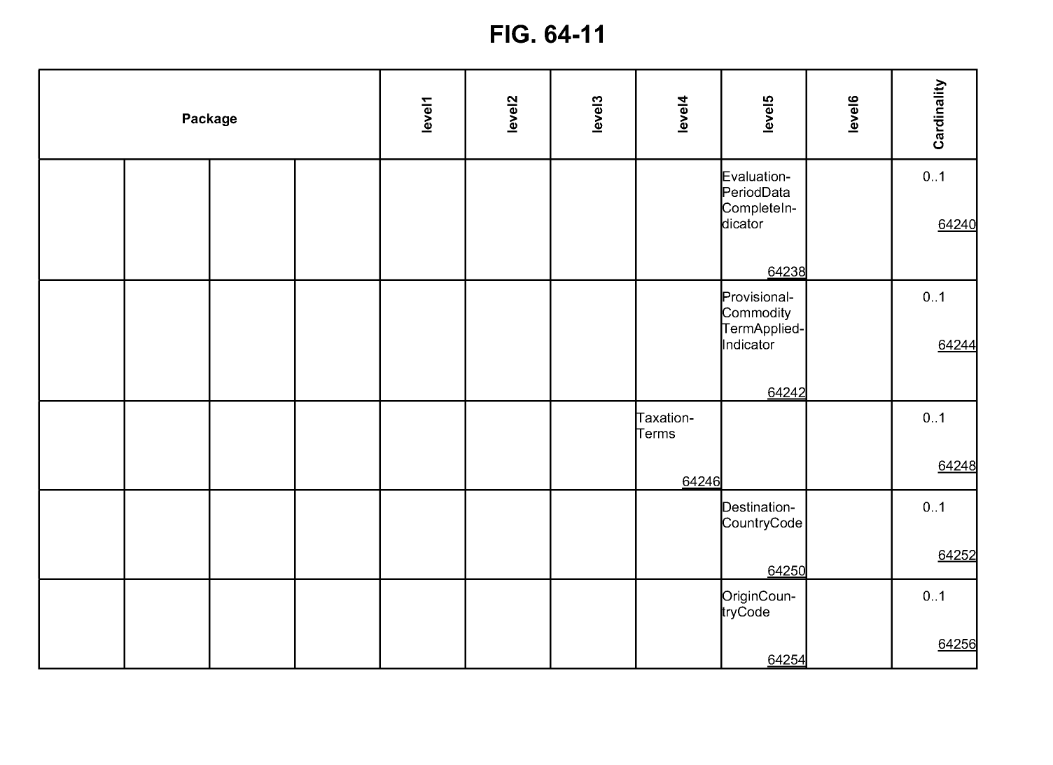

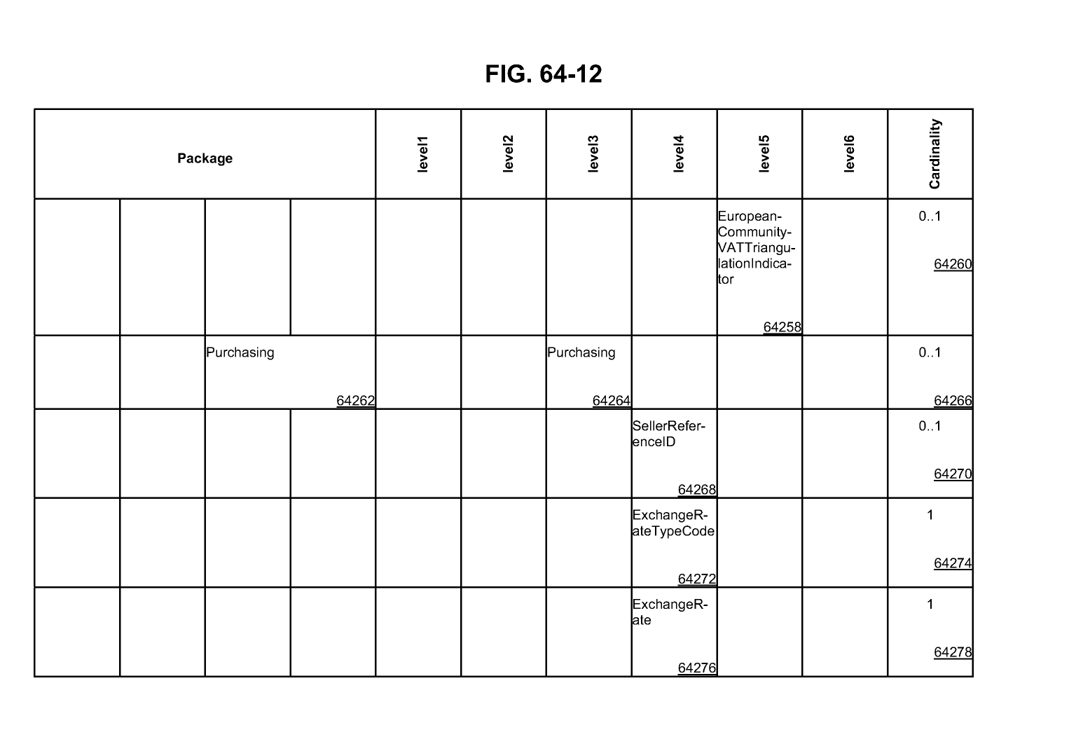

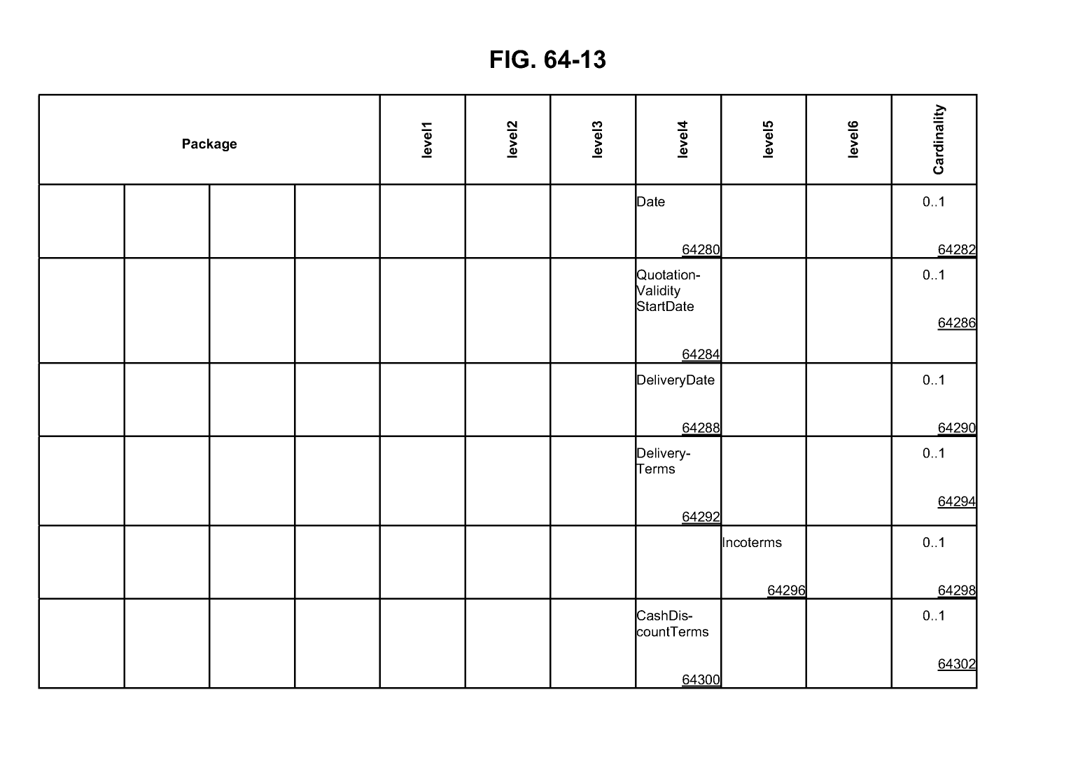

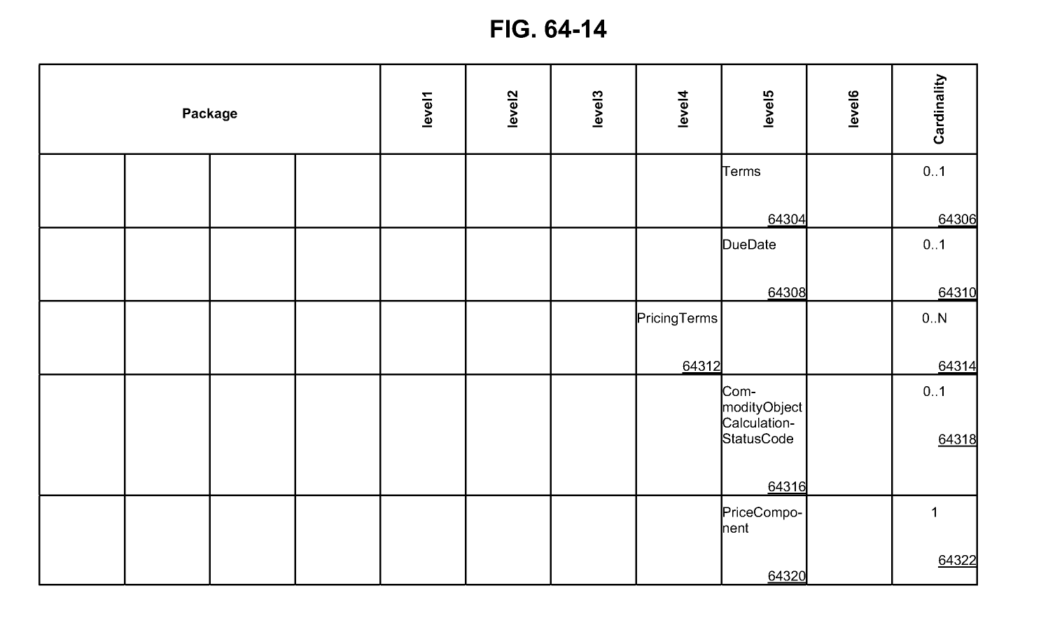

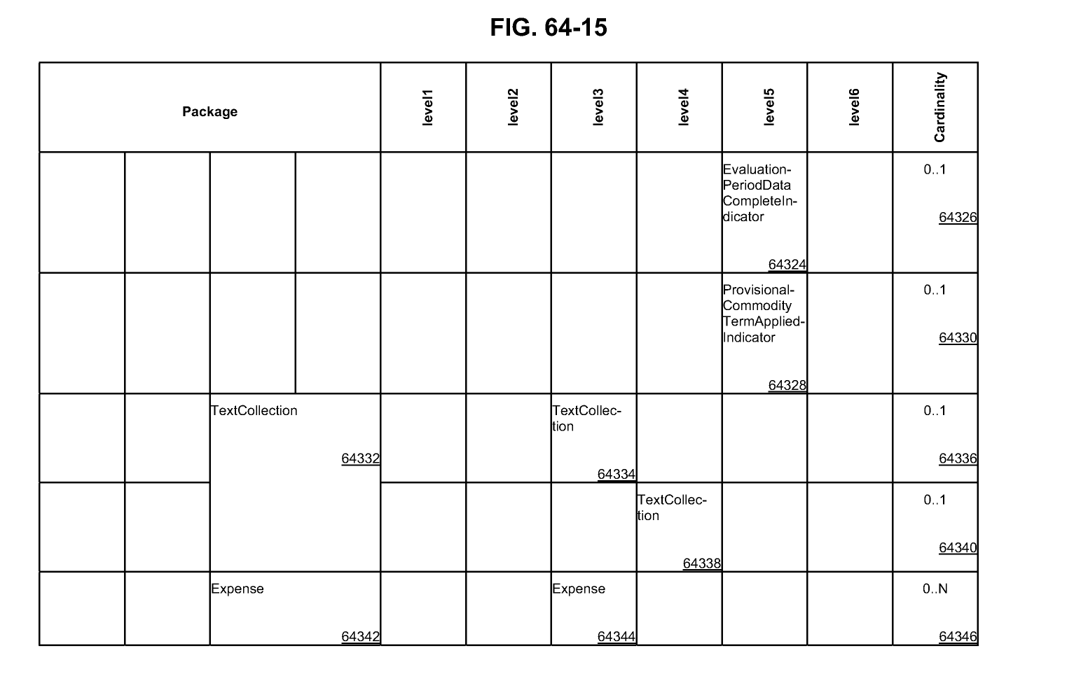

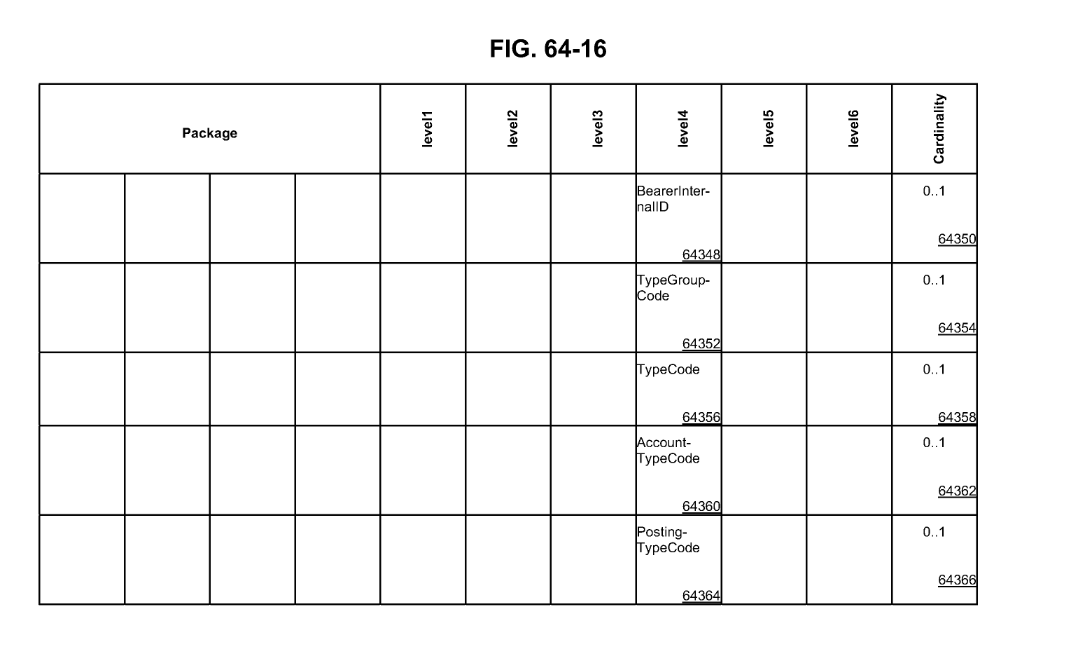

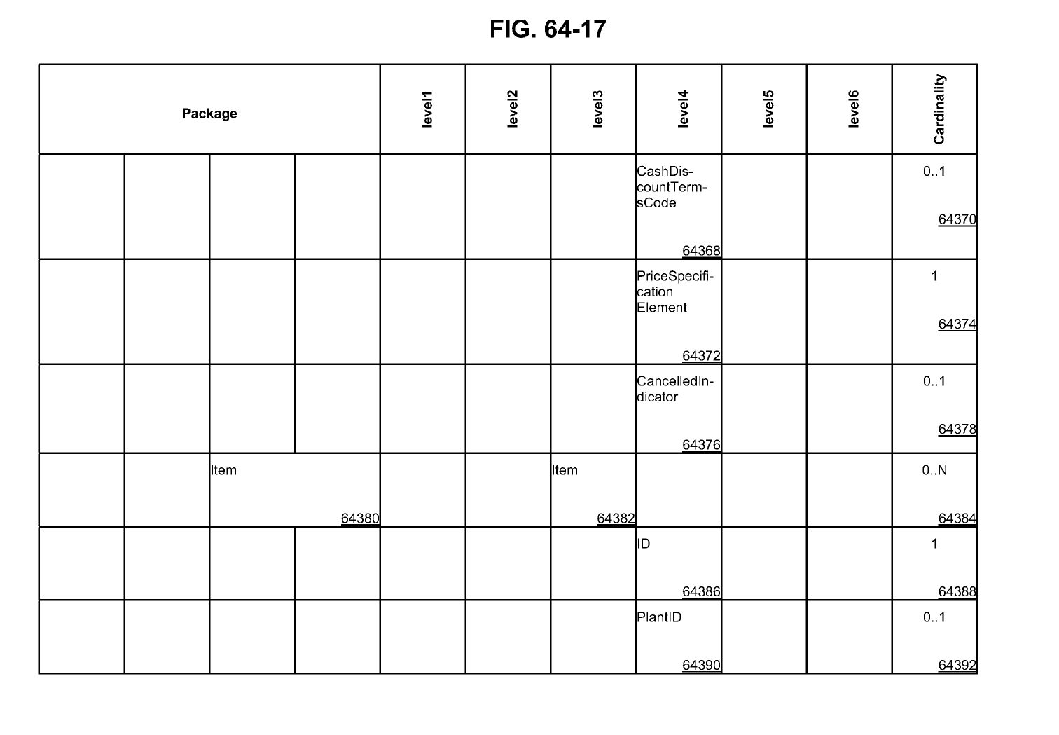

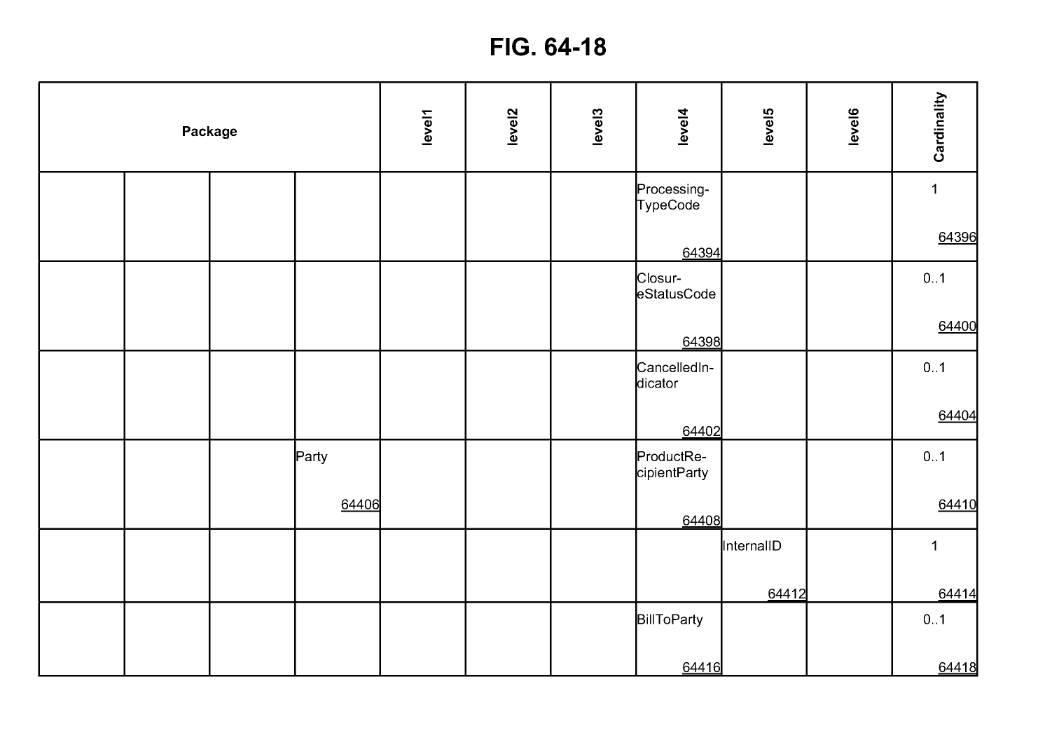

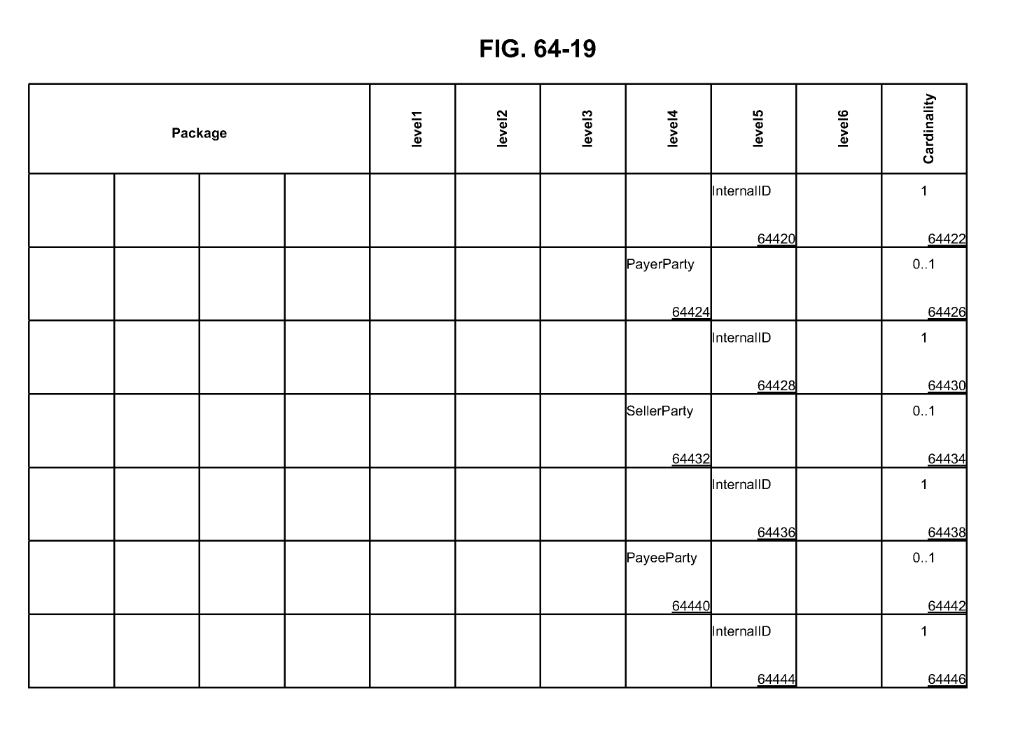

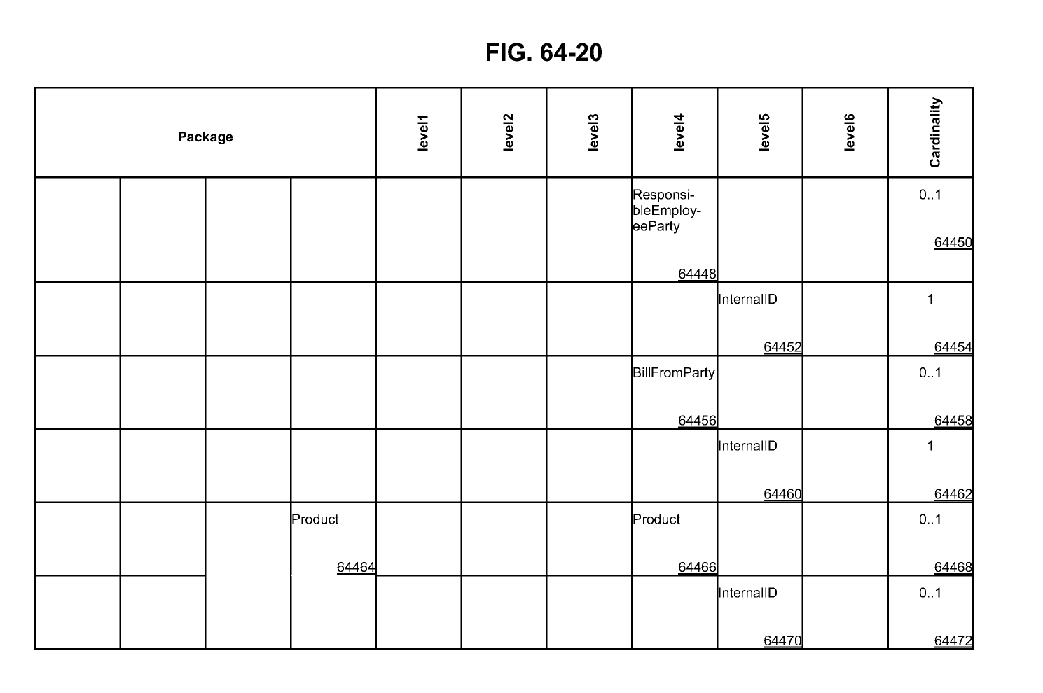

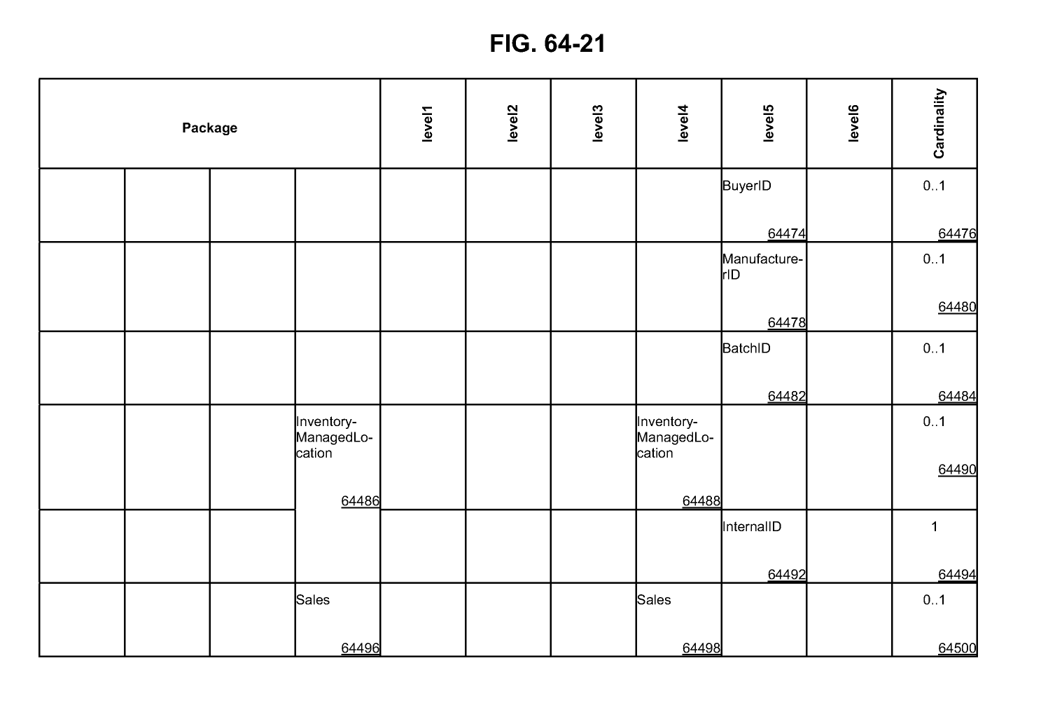

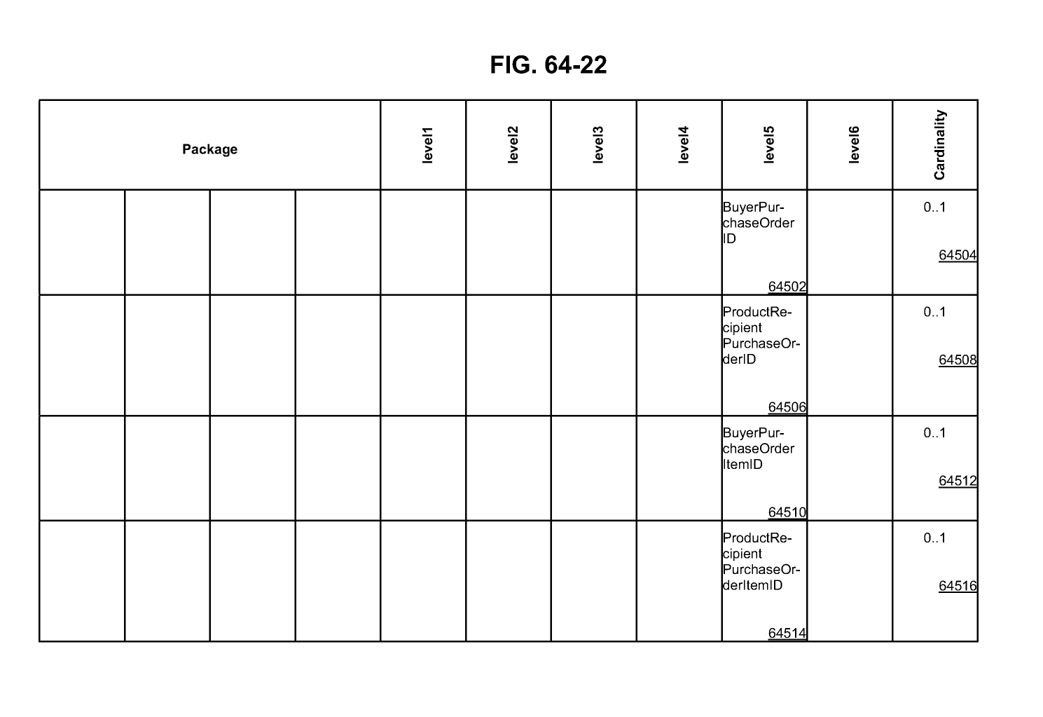

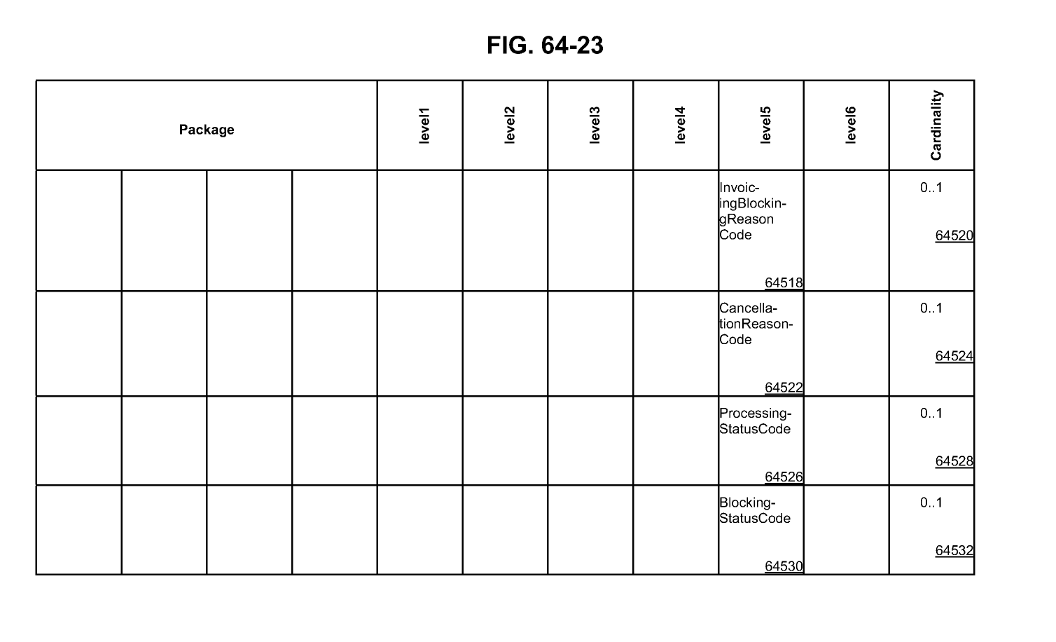

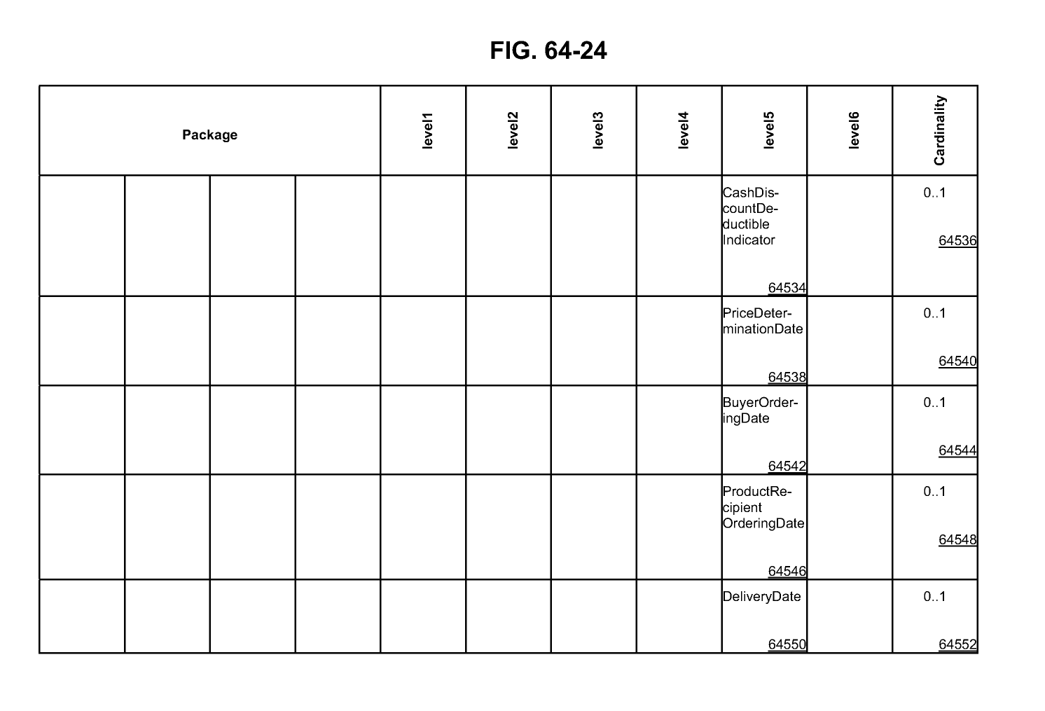

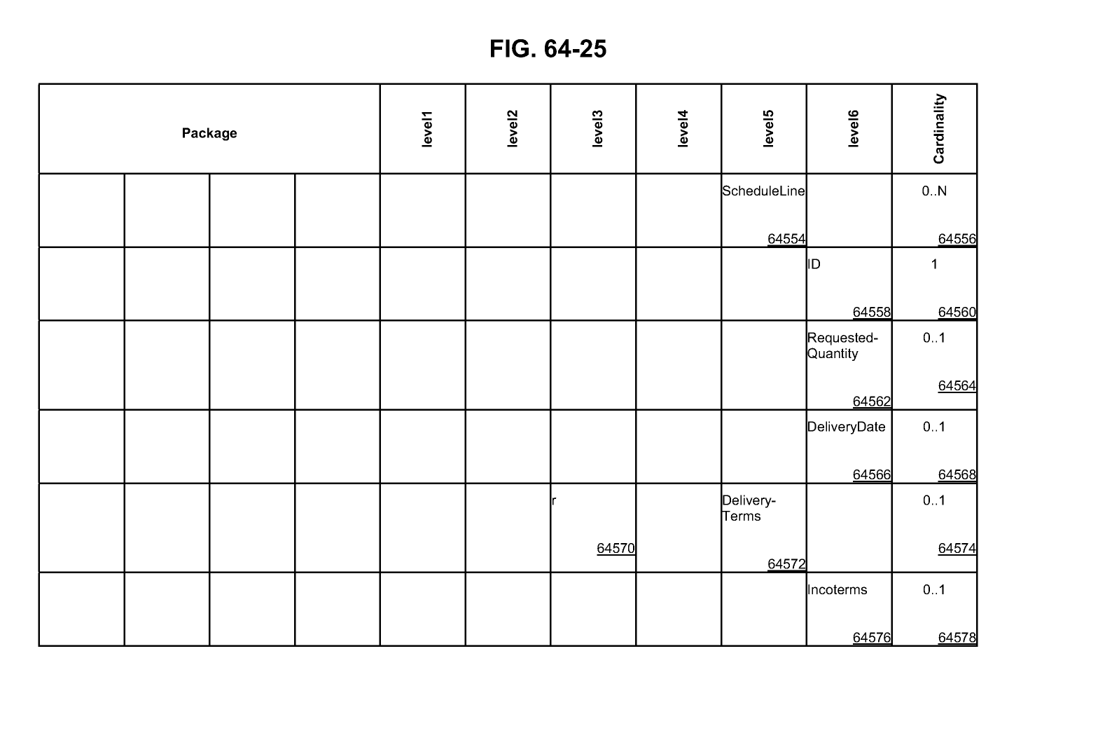

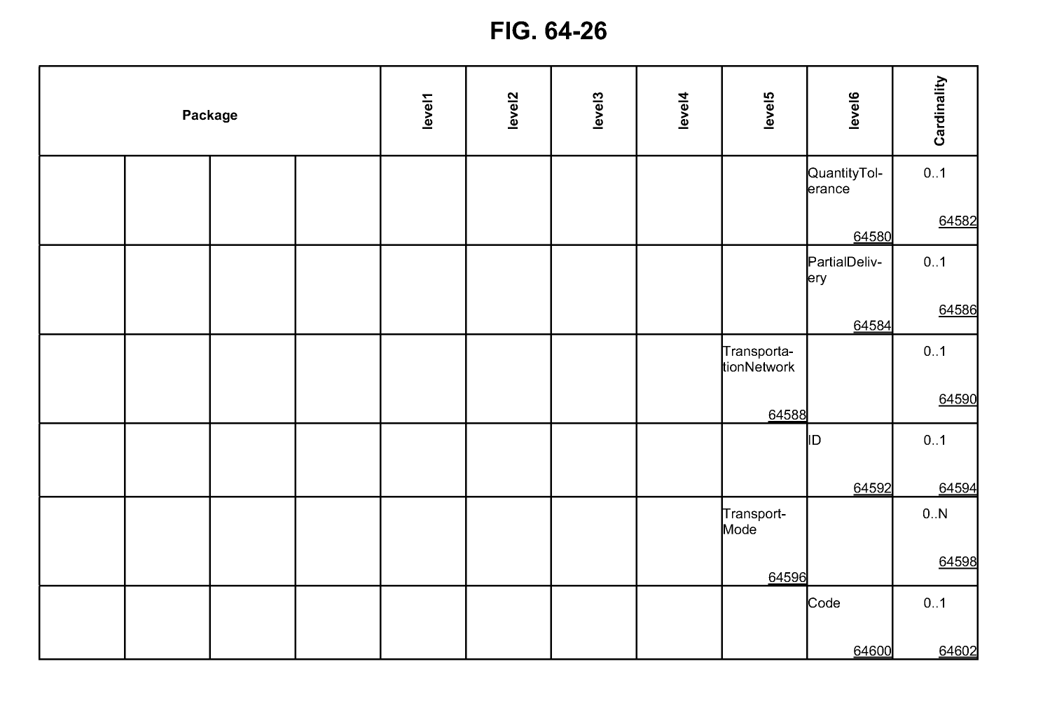

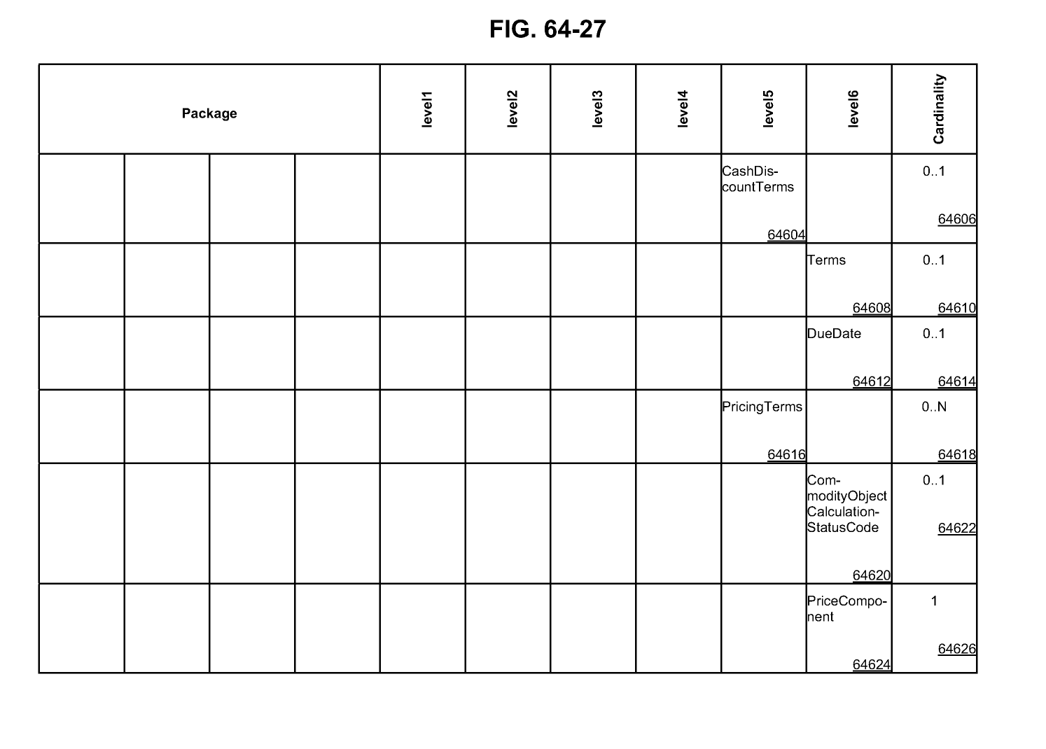

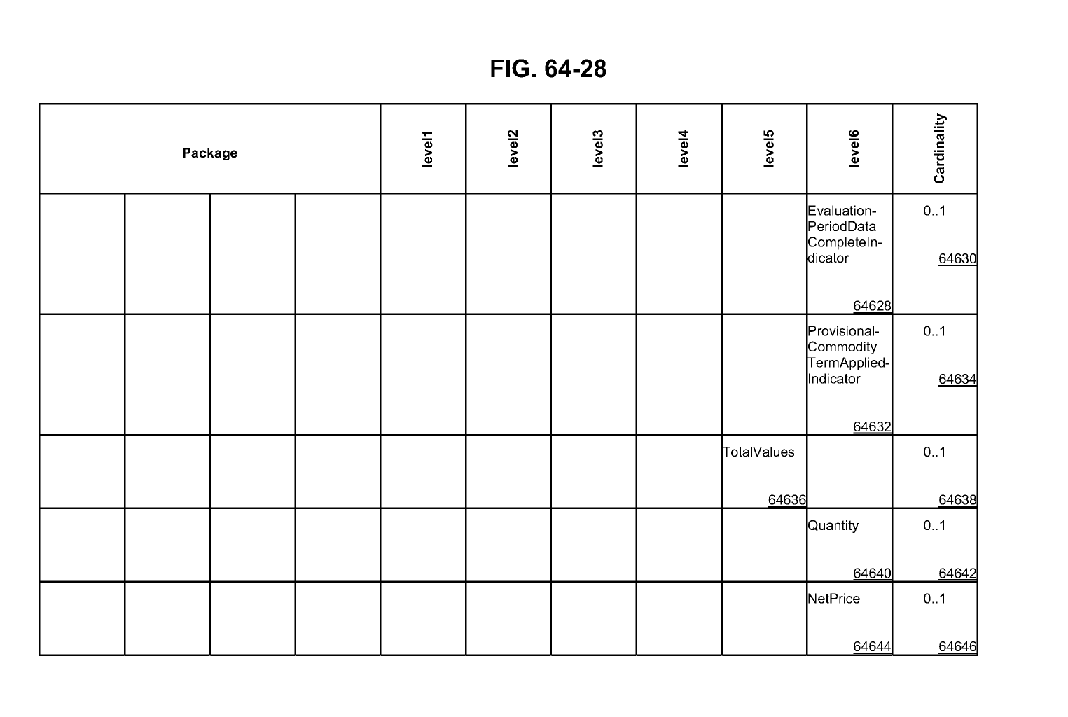

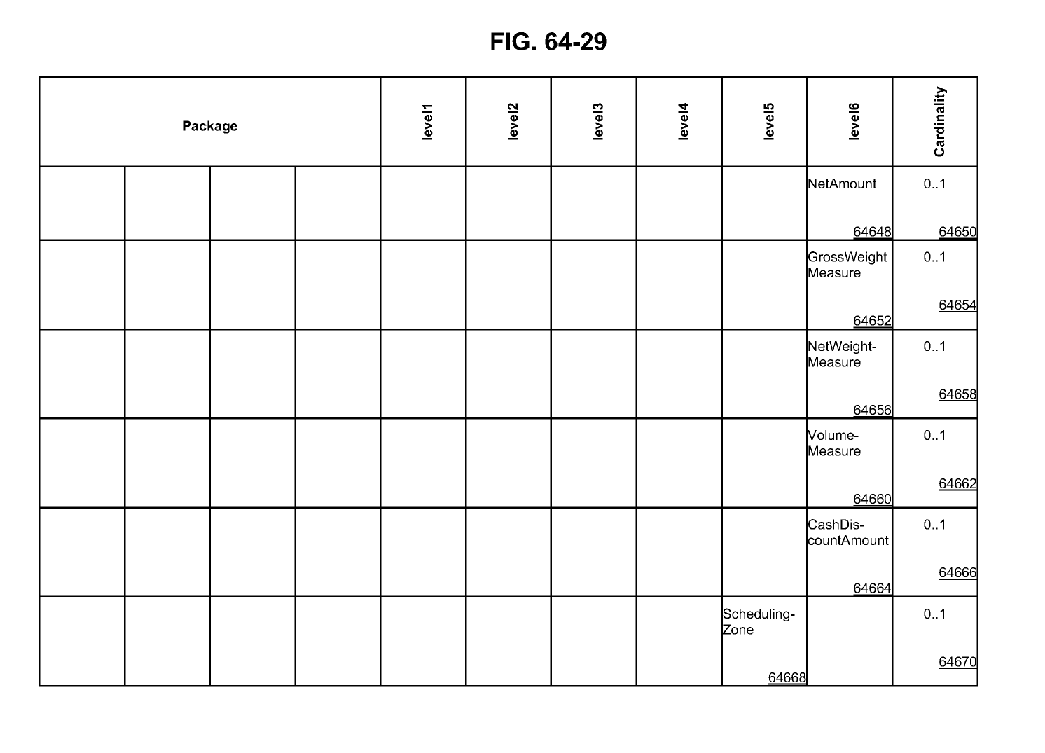

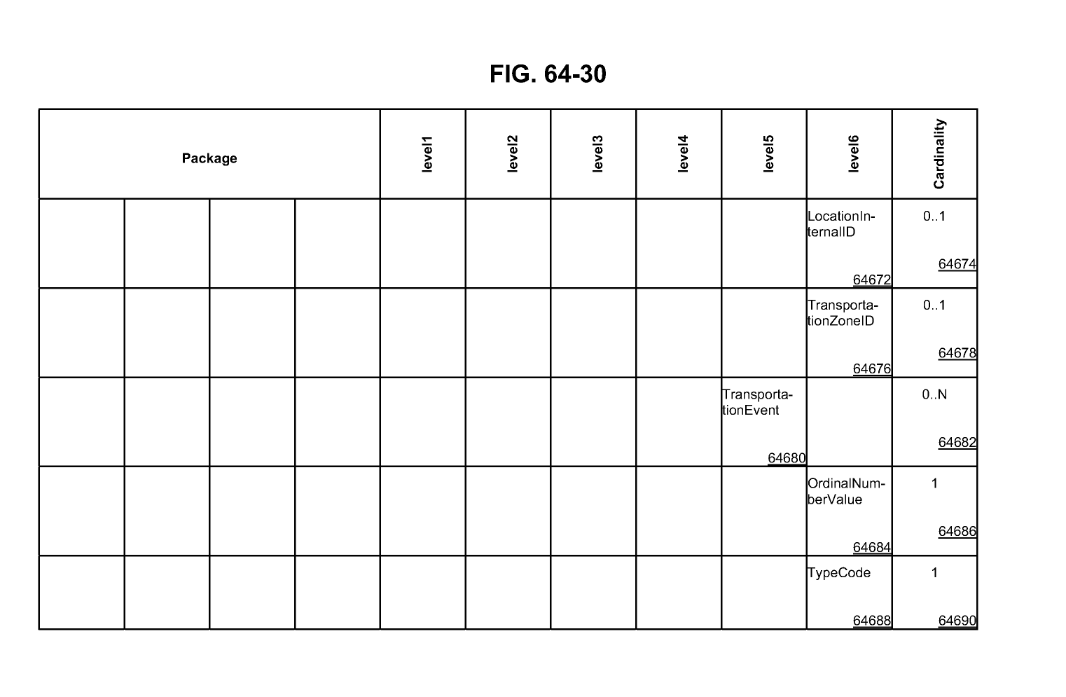

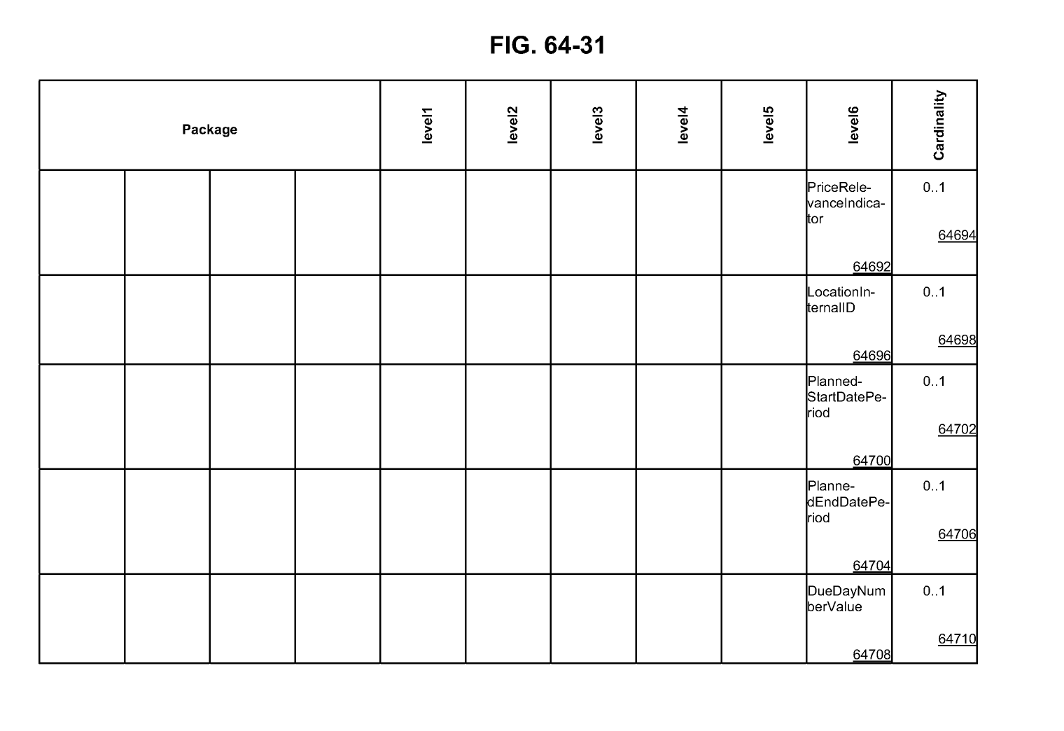

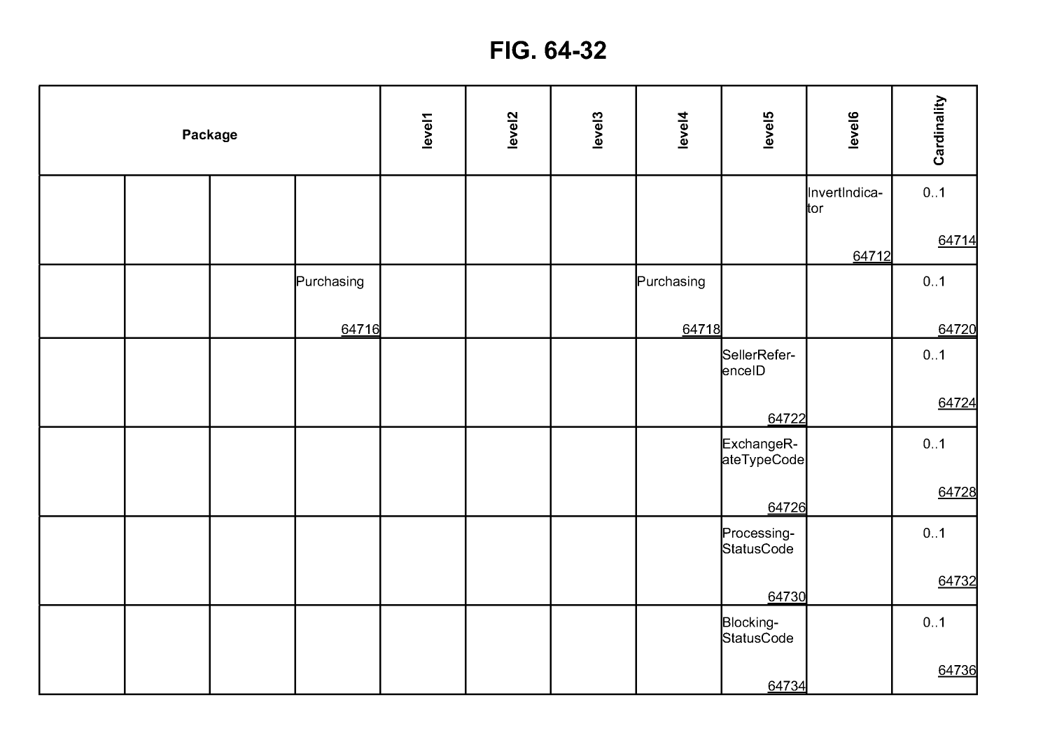

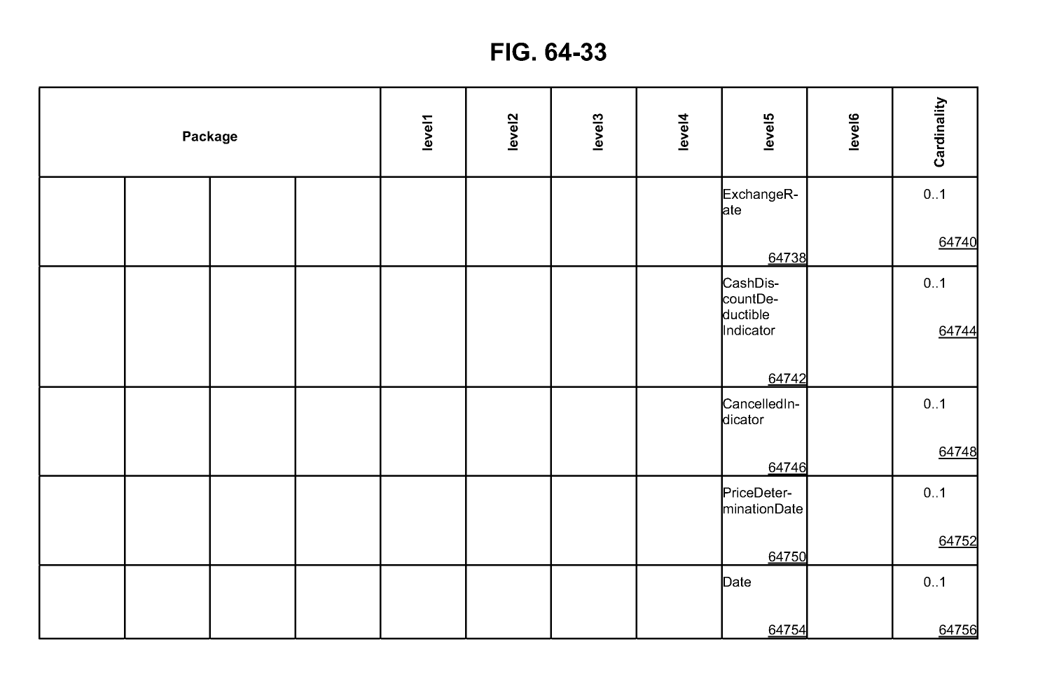

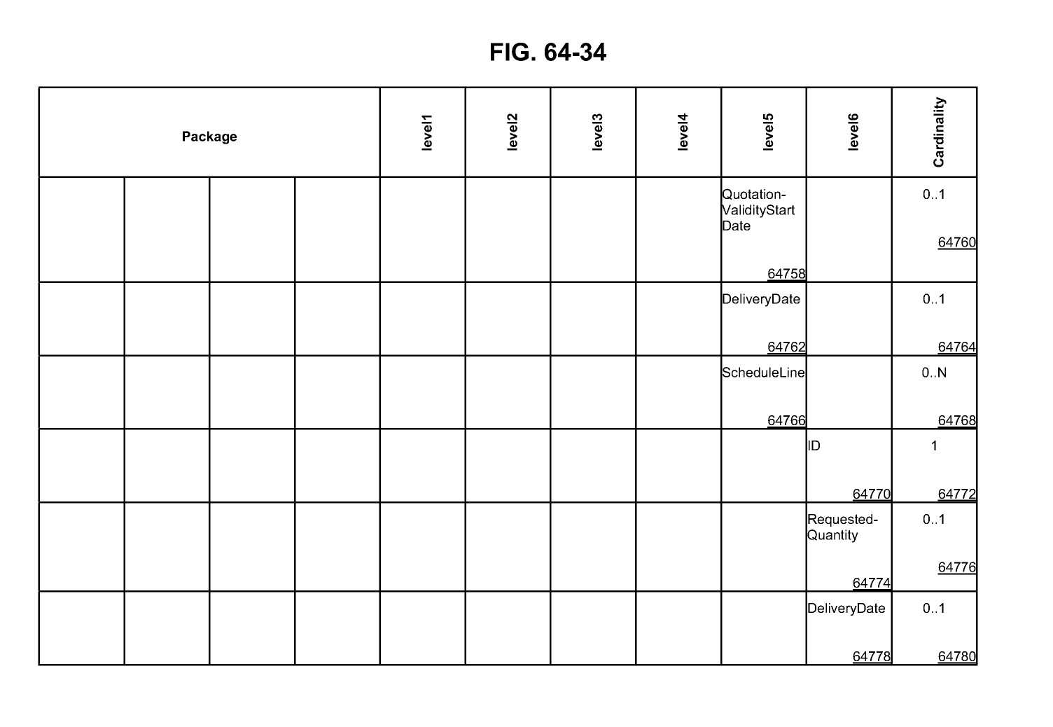

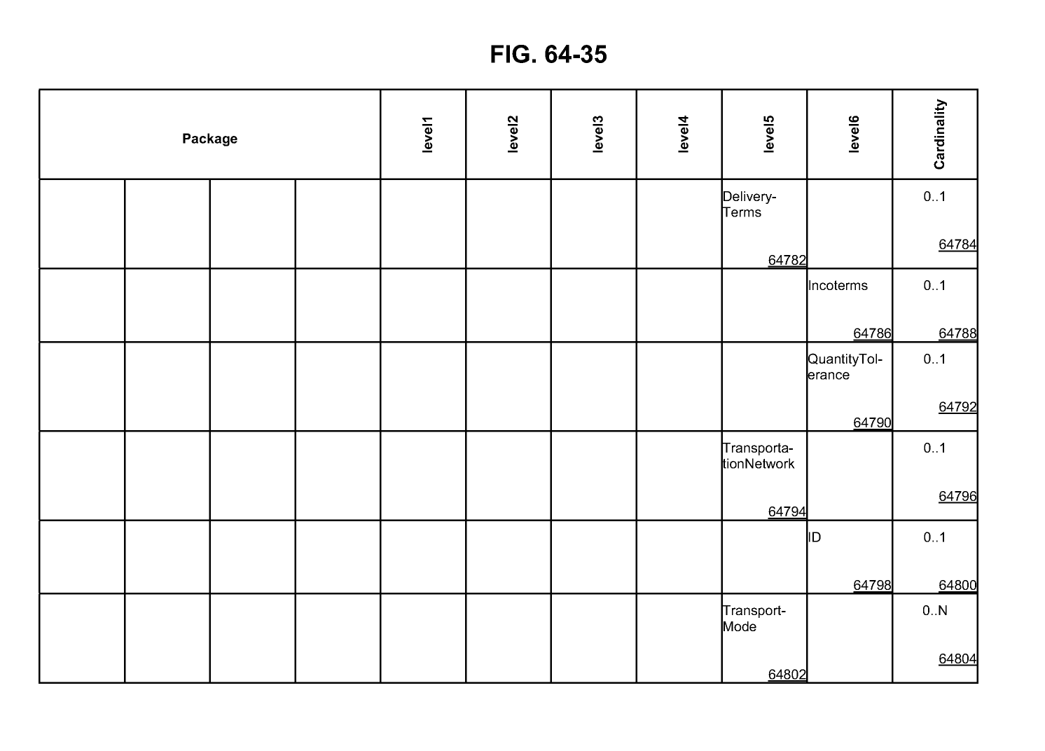

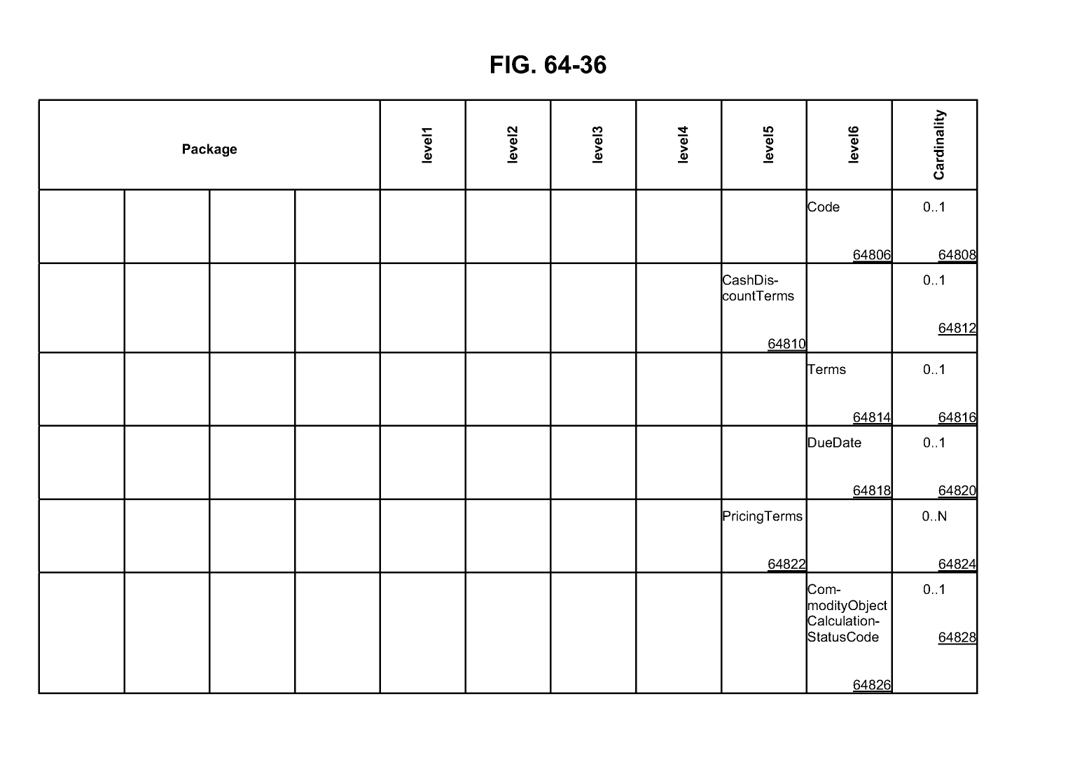

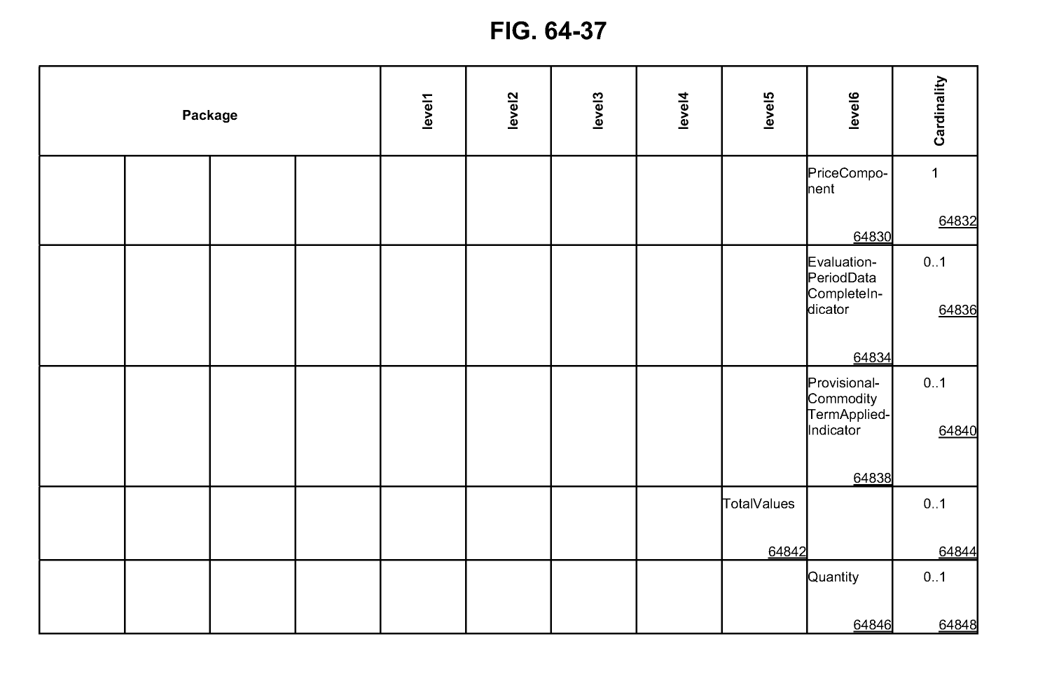

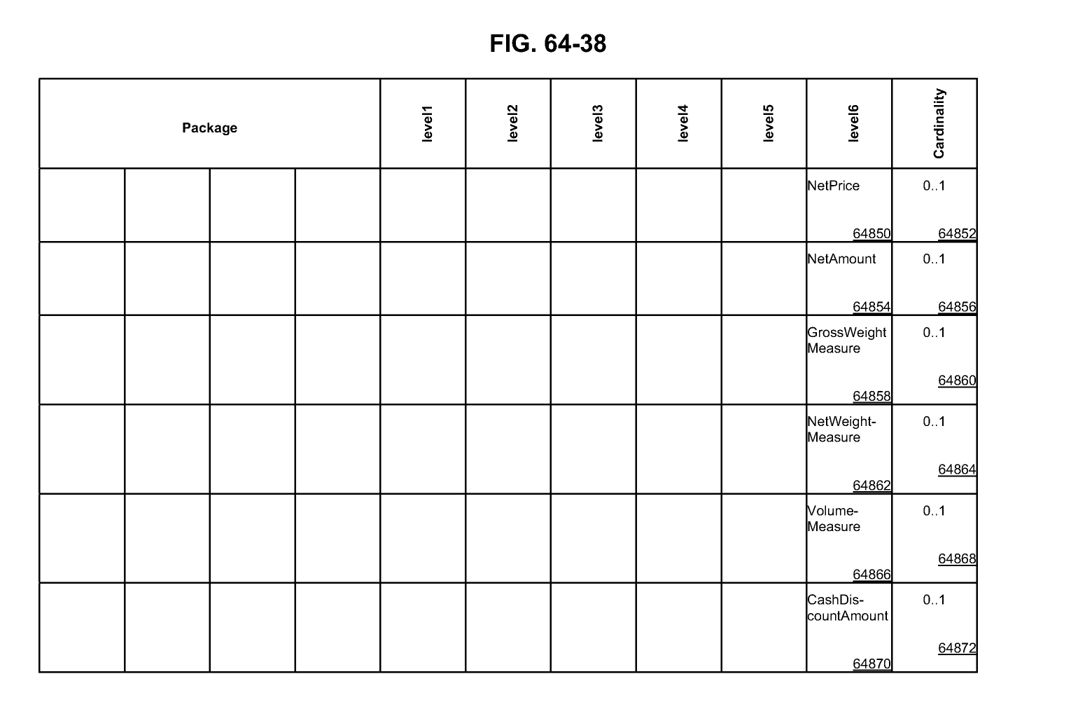

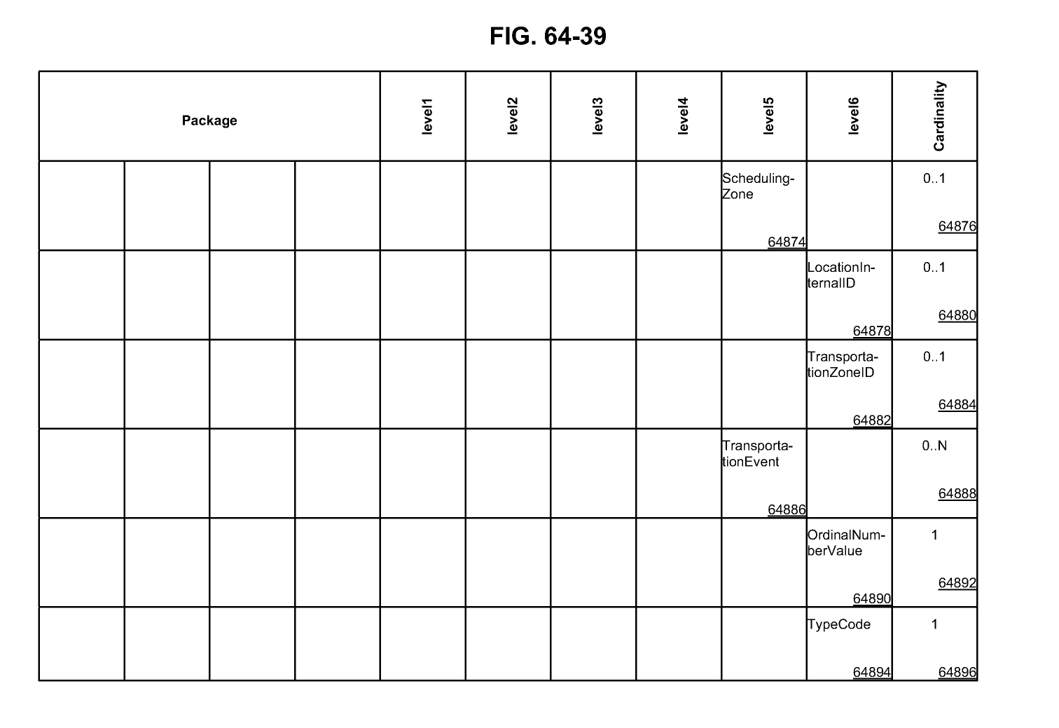

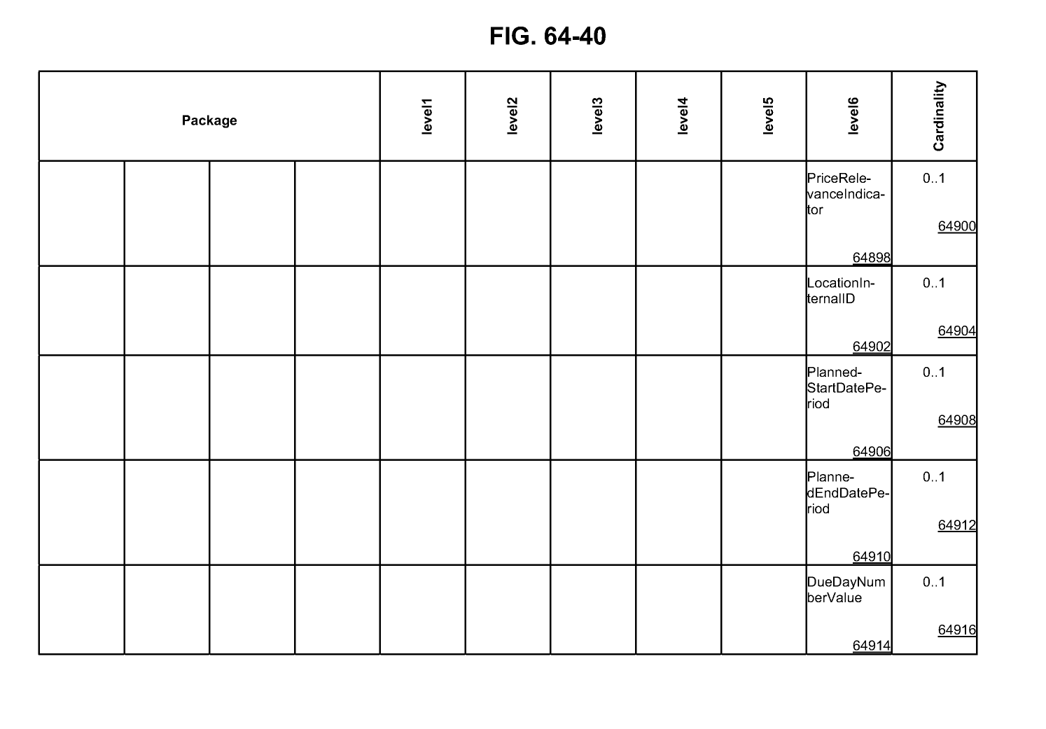

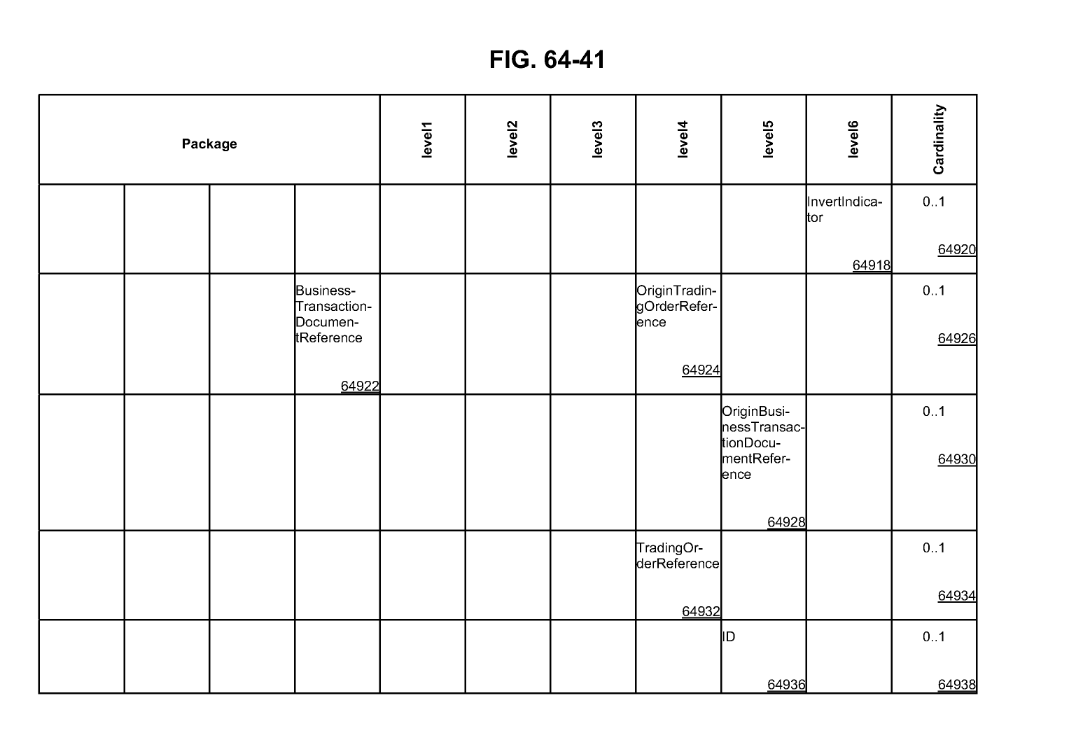

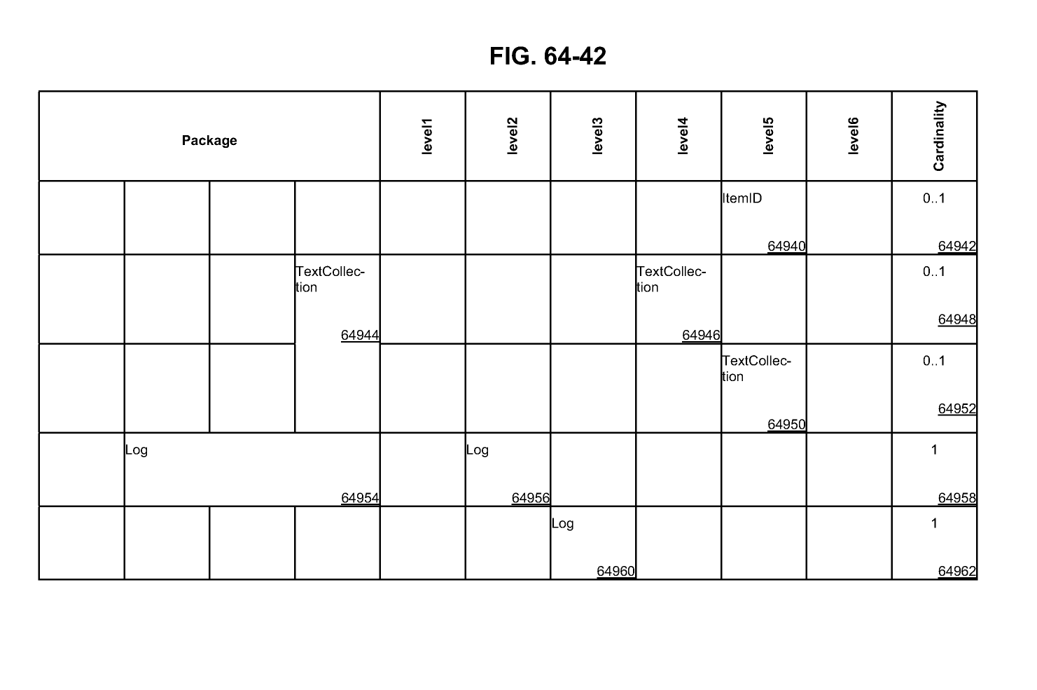

FIGS. 64-1 through 64-42 illustrate one example logical configuration of a TradingOrderByIDResponseMessage 64000 element structure. Specifically, these figures depict the arrangement and hierarchy of various components such as one or more levels of packages, entities, and datatypes, shown here as 64000 through 64962. As described above, packages may be used to represent hierarchy levels. Entities are discrete business elements that are used during a business transaction. Data types are used to type object entities and interfaces with a structure. For example, the TradingOrderByIDResponseMessage 64000 includes, among other things, a TradingOrderByIDResponseMessage 64002. Accordingly, heterogeneous applications may communicate using this consistent message configured as such. The data types of the various packages, entities, and attributes are described with respect to FIG. 58.

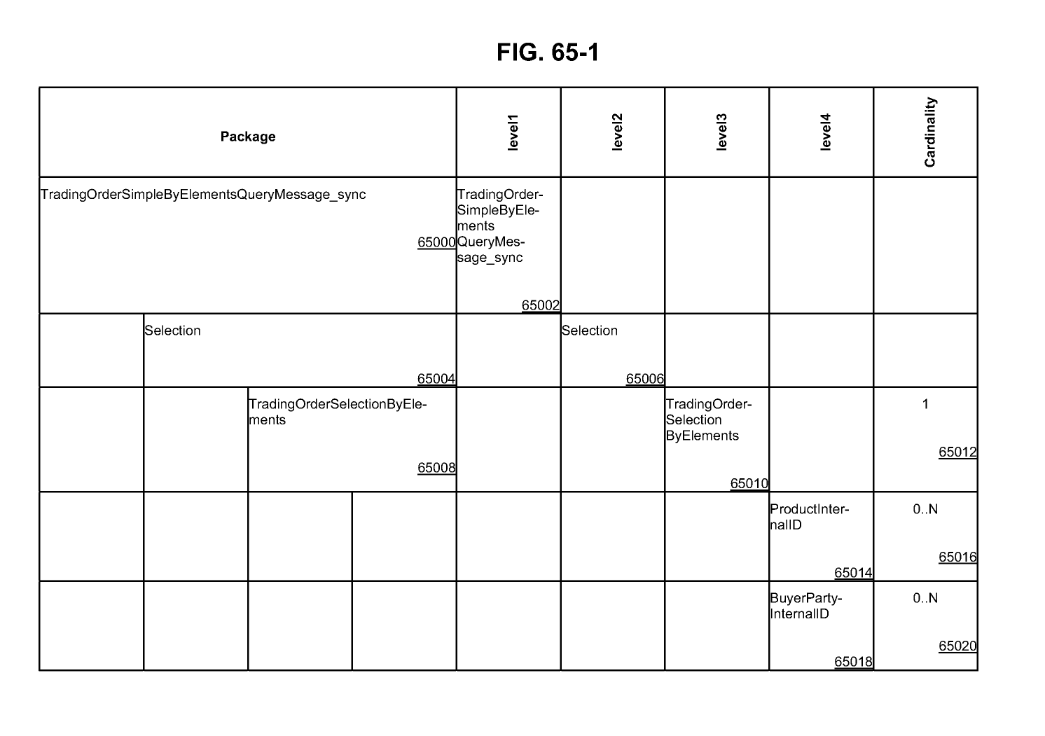

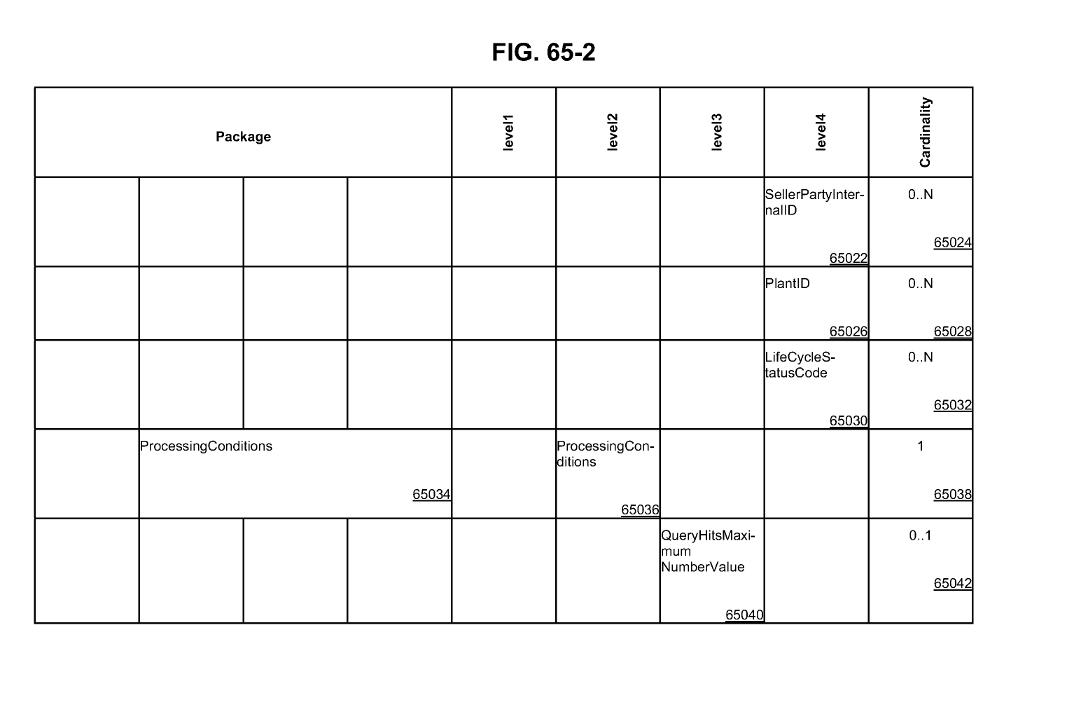

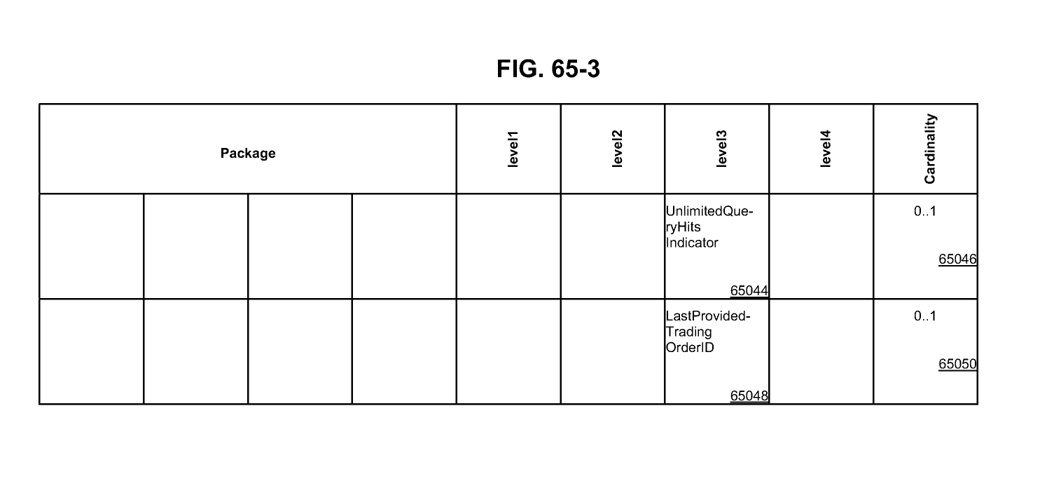

FIGS. 65-1 through 65-3 illustrate one example logical configuration of a TradingOrderSimpleByElementsQueryMessage_sync 65000 element structure. Specifically, these figures depict the arrangement and hierarchy of various components such as one or more levels of packages, entities, and datatypes, shown here as 65000 through 65050. As described above, packages may be used to represent hierarchy levels. Entities are discrete business elements that are used during a business transaction. Data types are used to type object entities and interfaces with a structure. For example, the TradingOrderSimpleByElementsQueryMessage_sync 65000 includes, among other things, a TradingOrderSimpleByElementsQueryMessage_sync 65002. Accordingly, heterogeneous applications may communicate using this consistent message configured as such. The data types of the various packages, entities, and attributes are described with respect to FIG. 58.

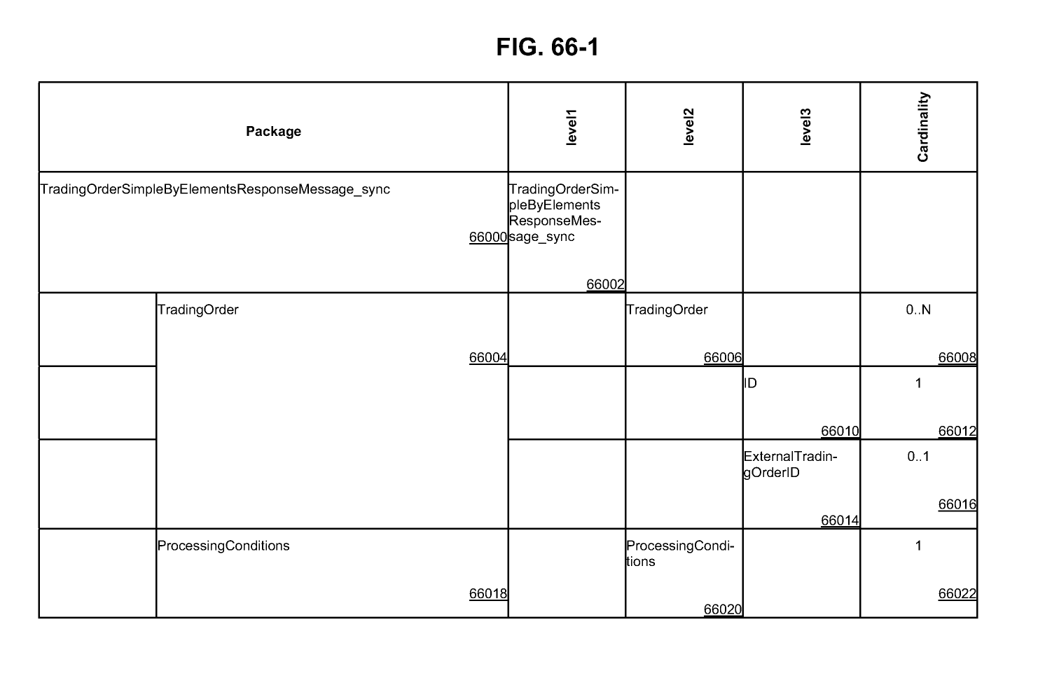

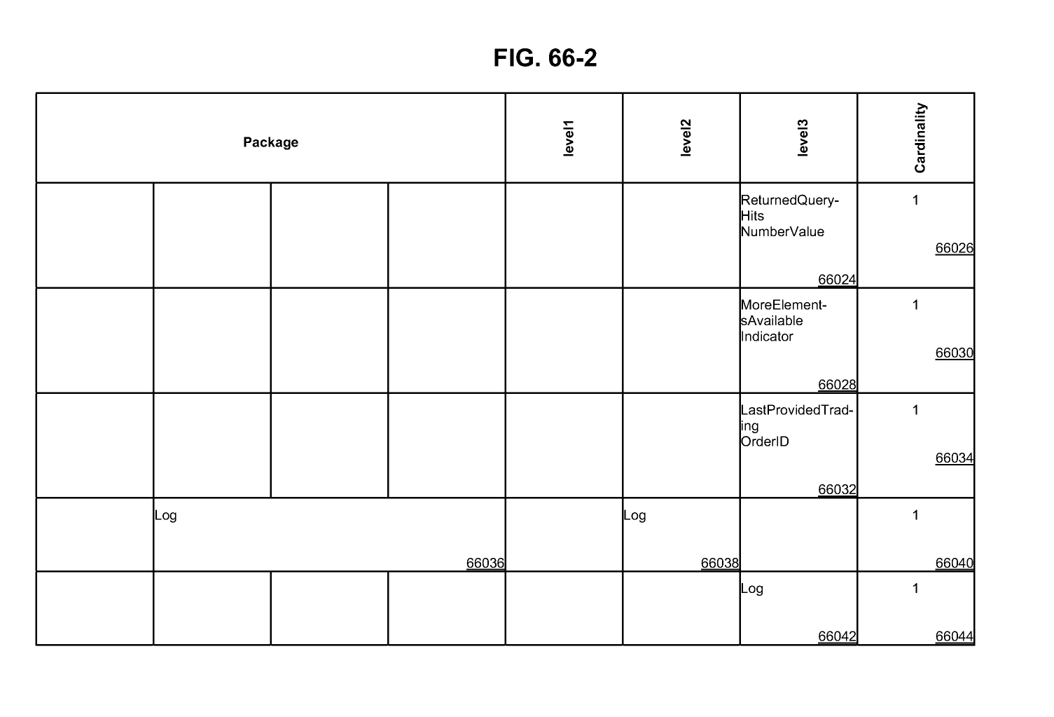

FIGS. 66-1 through 66-2 illustrate one example logical configuration of a TradingOrderSimpleByElementsResponseMessage_sync 66000 element structure. Specifically, these figures depict the arrangement and hierarchy of various components such as one or more levels of packages, entities, and datatypes, shown here as 66000 through 66044. As described above, packages may be used to represent hierarchy levels. Entities are discrete business elements that are used during a business transaction. Data types are used to type object entities and interfaces with a structure. For example, the TradingOrderSimpleByElementsResponseMessage_sync 66000 includes, among other things, a TradingOrderSimpleByElementsResponseMessage_sync 66002. Accordingly, heterogeneous applications may communicate using this consistent message configured as such. The data types of the various packages, entities, and attributes are described with respect to FIG. 58.

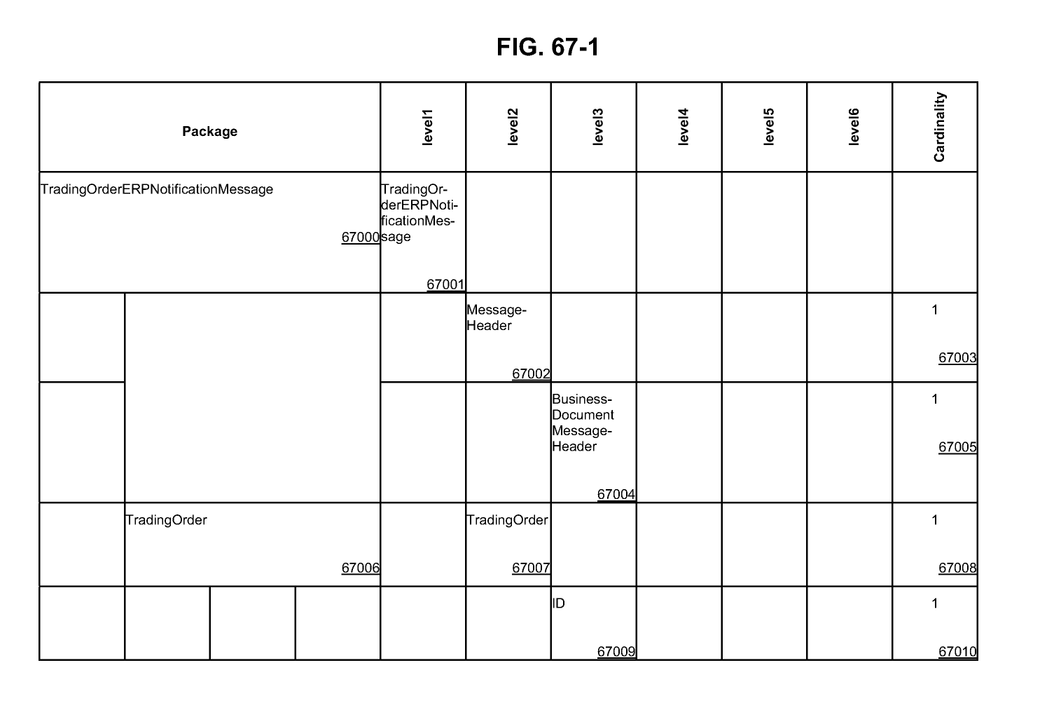

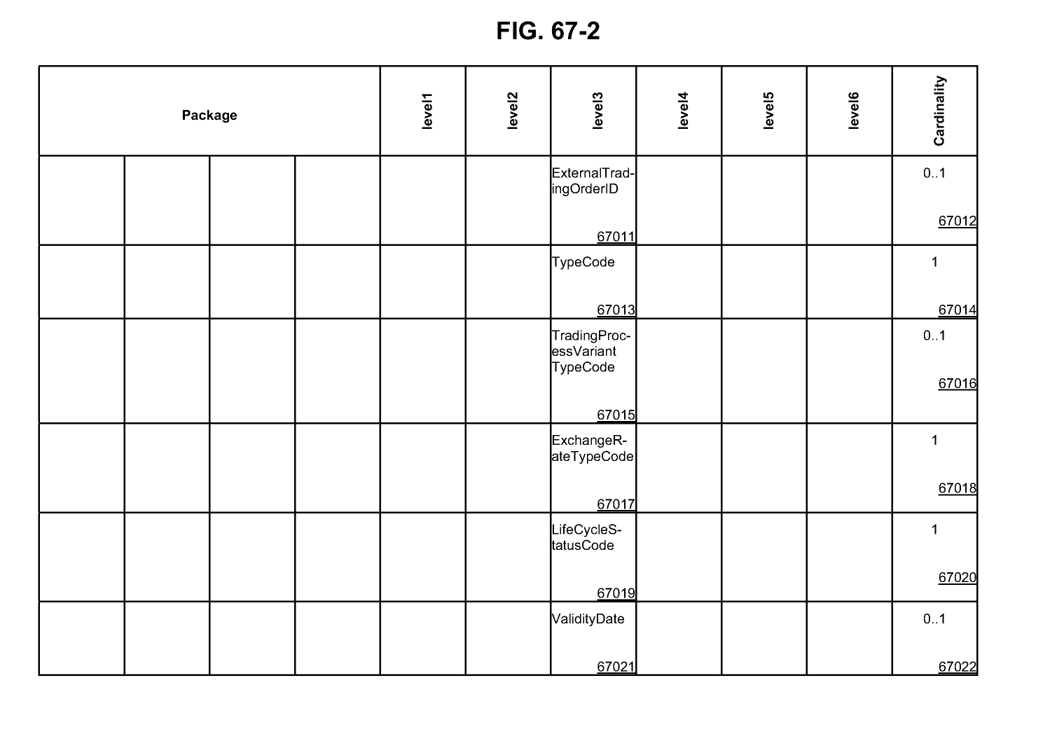

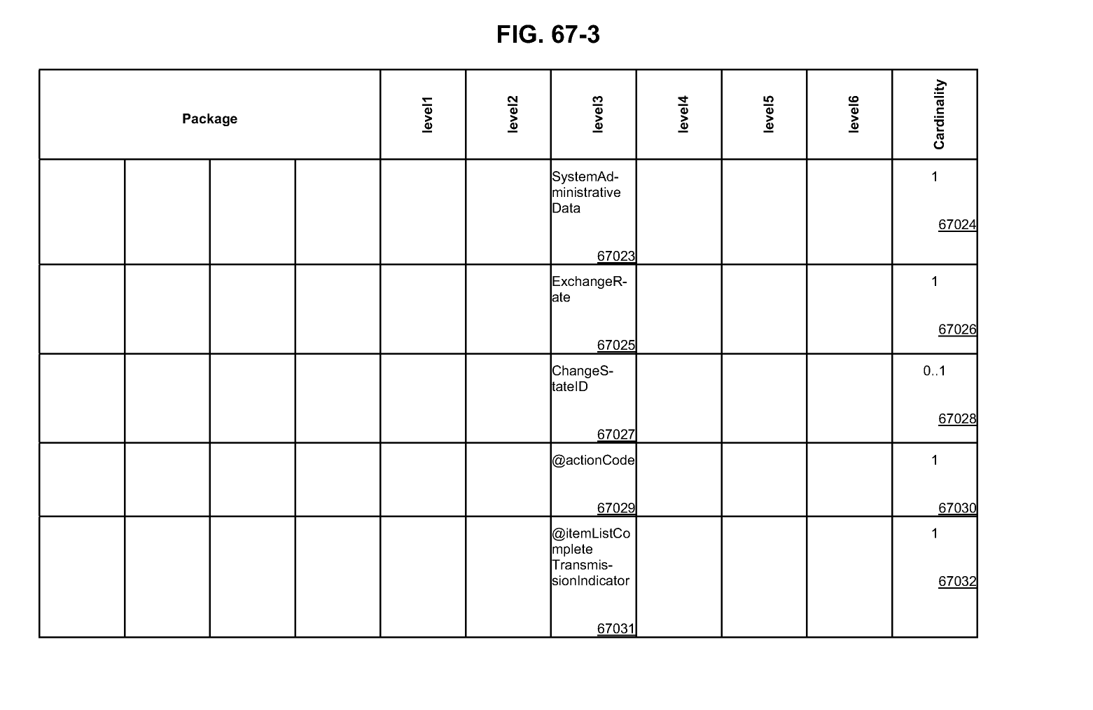

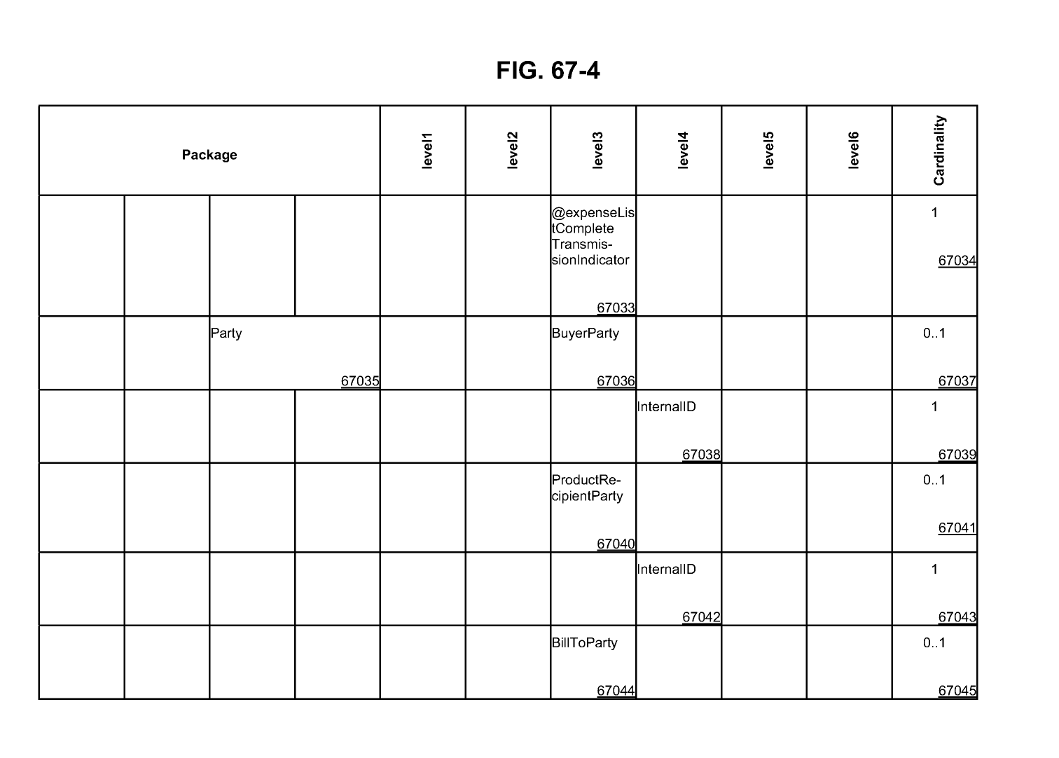

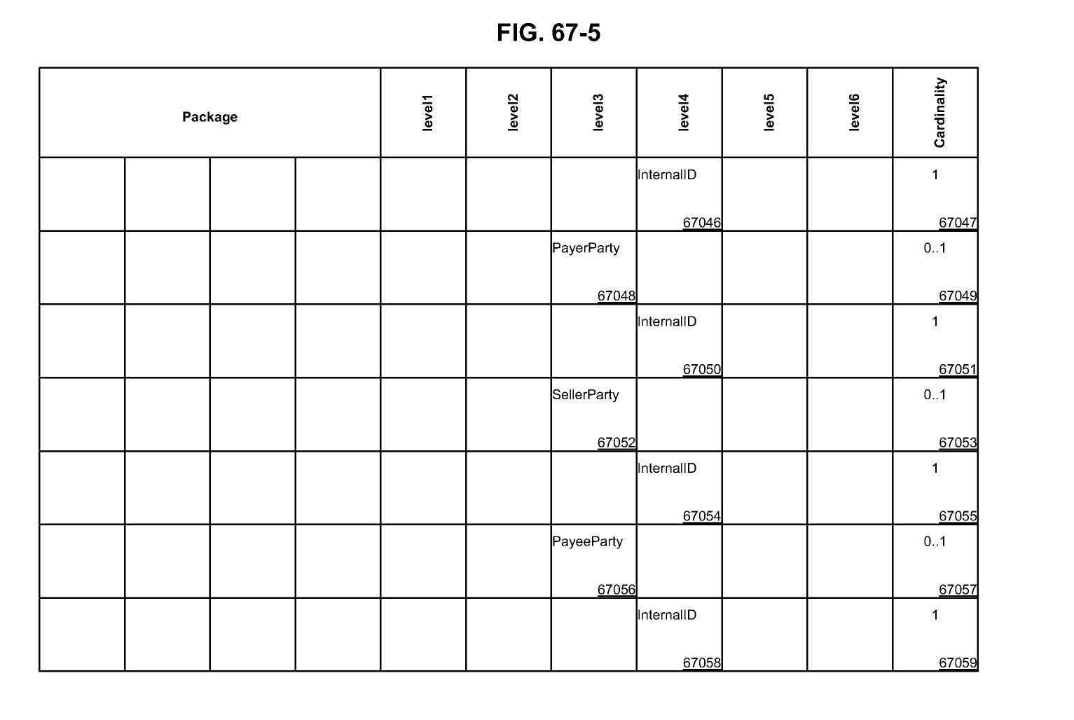

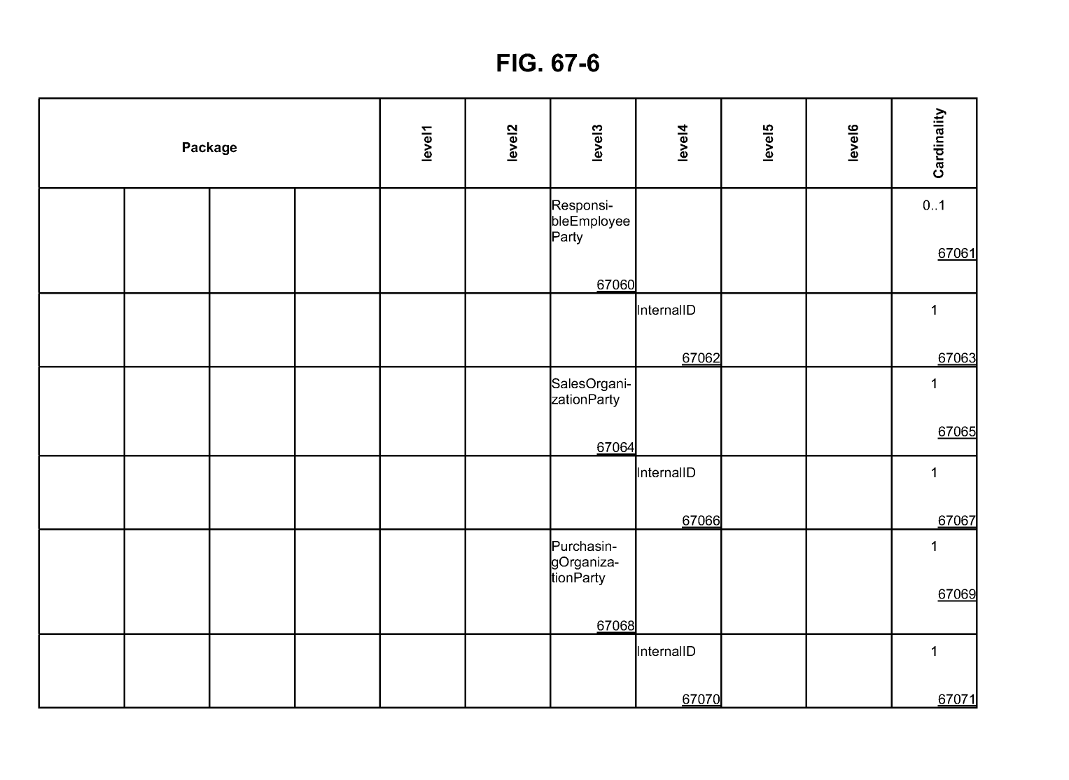

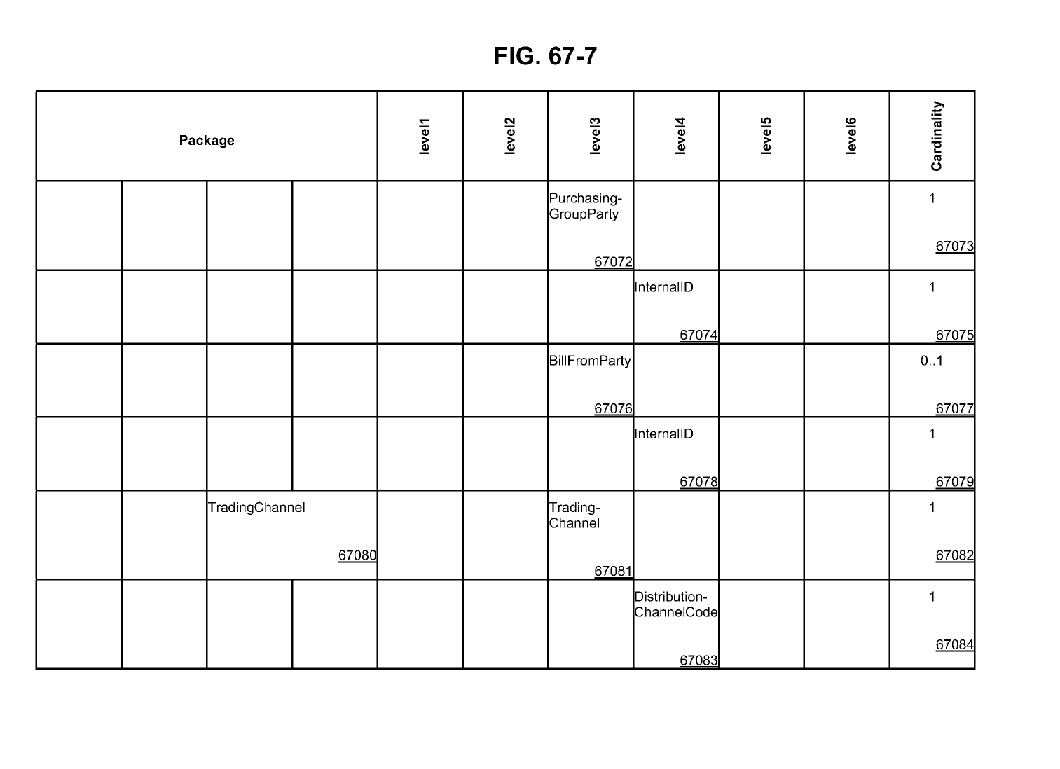

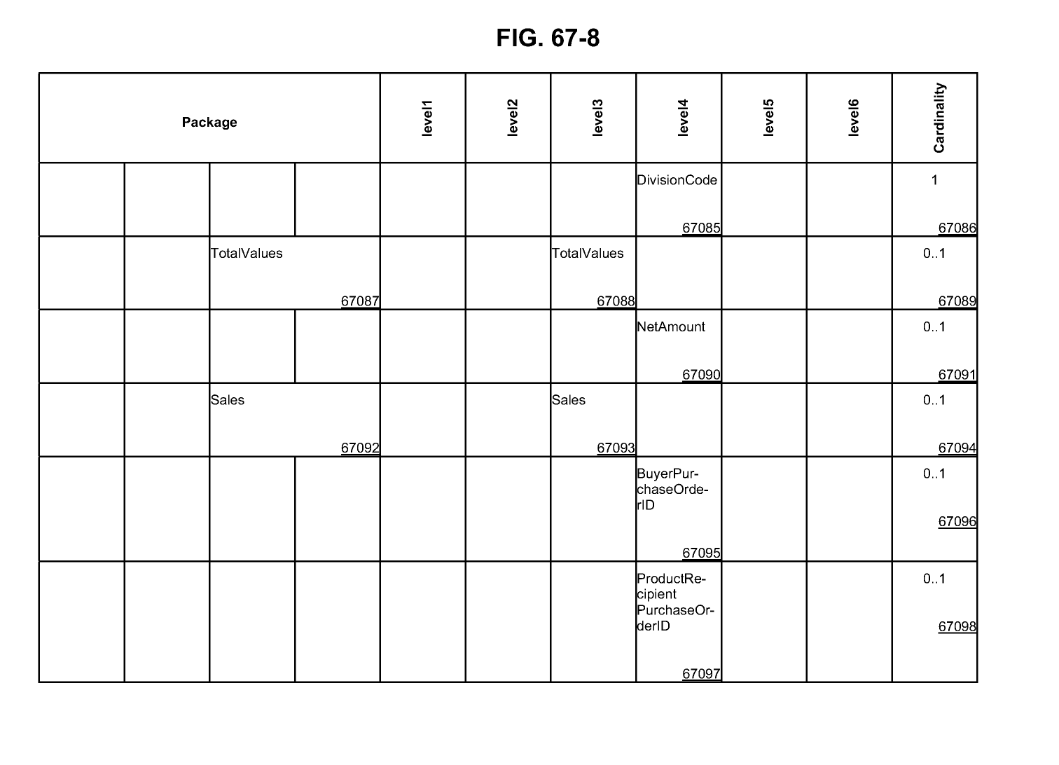

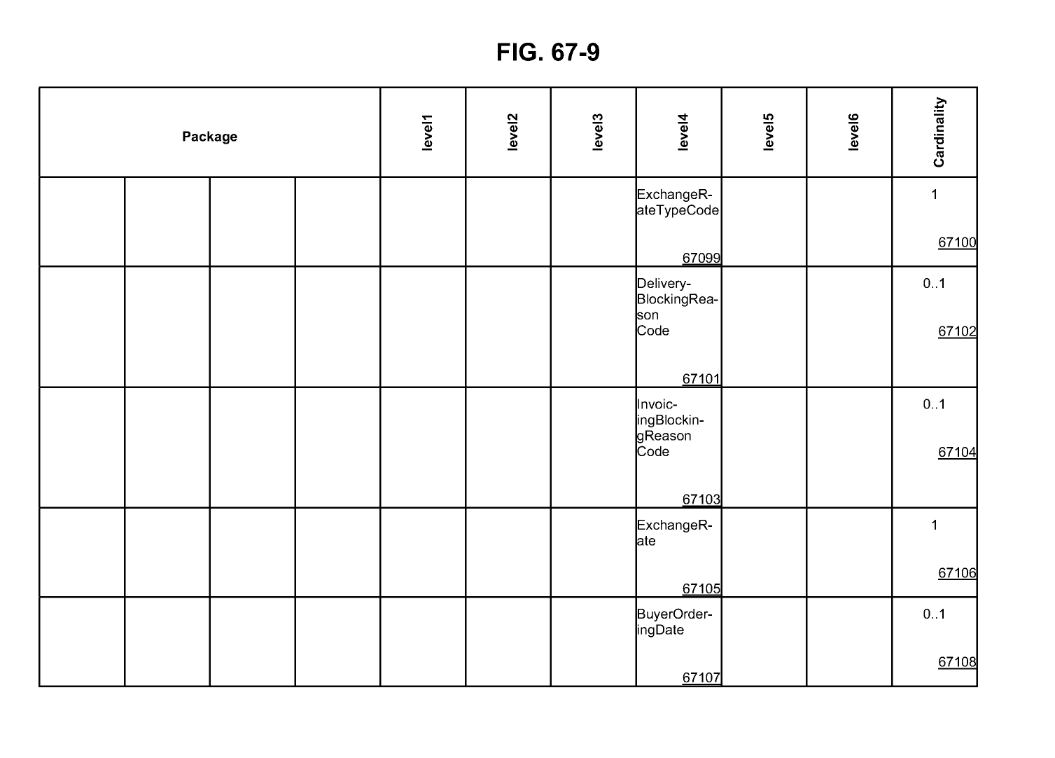

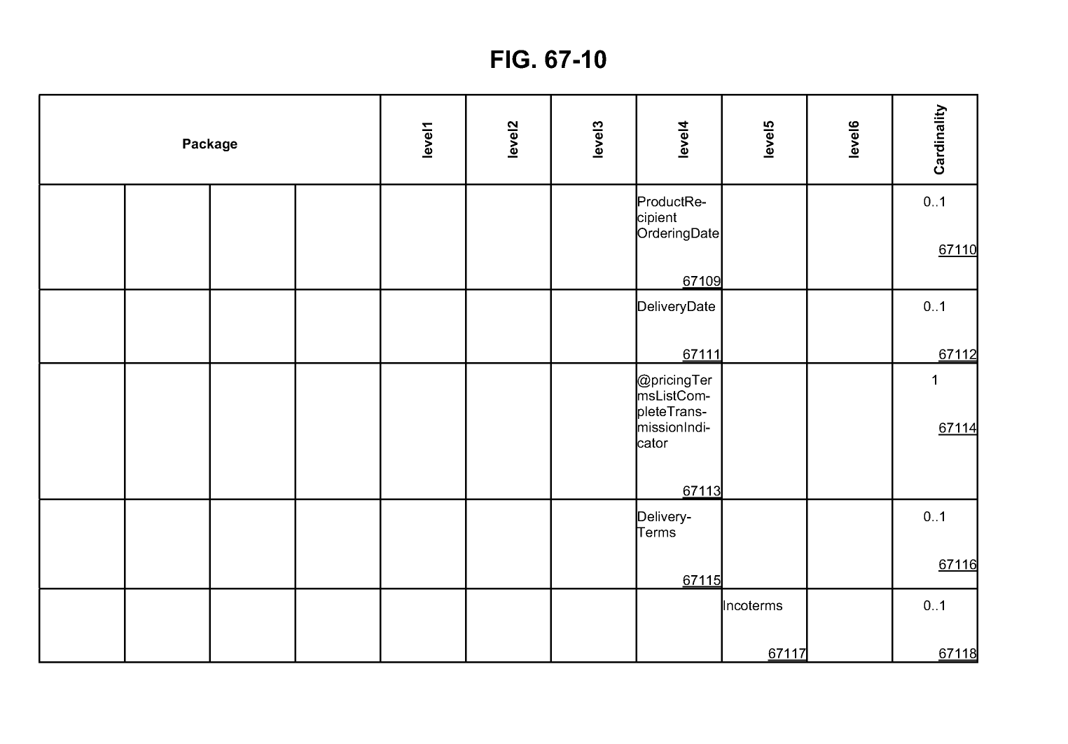

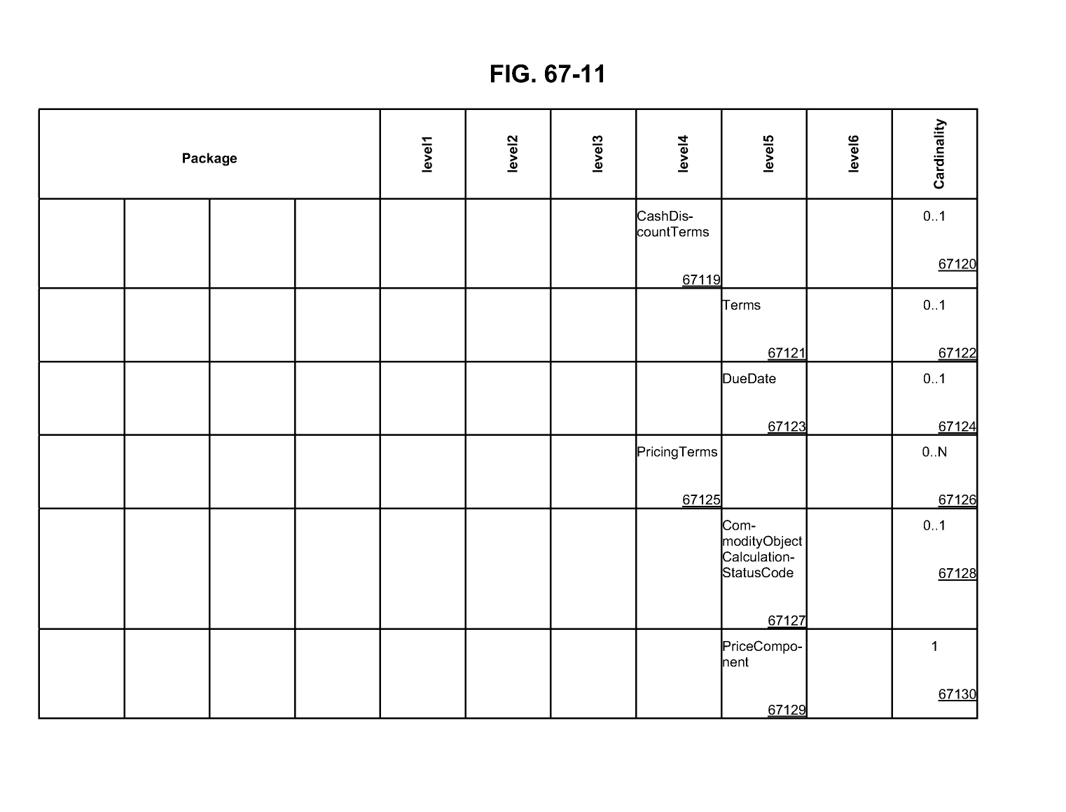

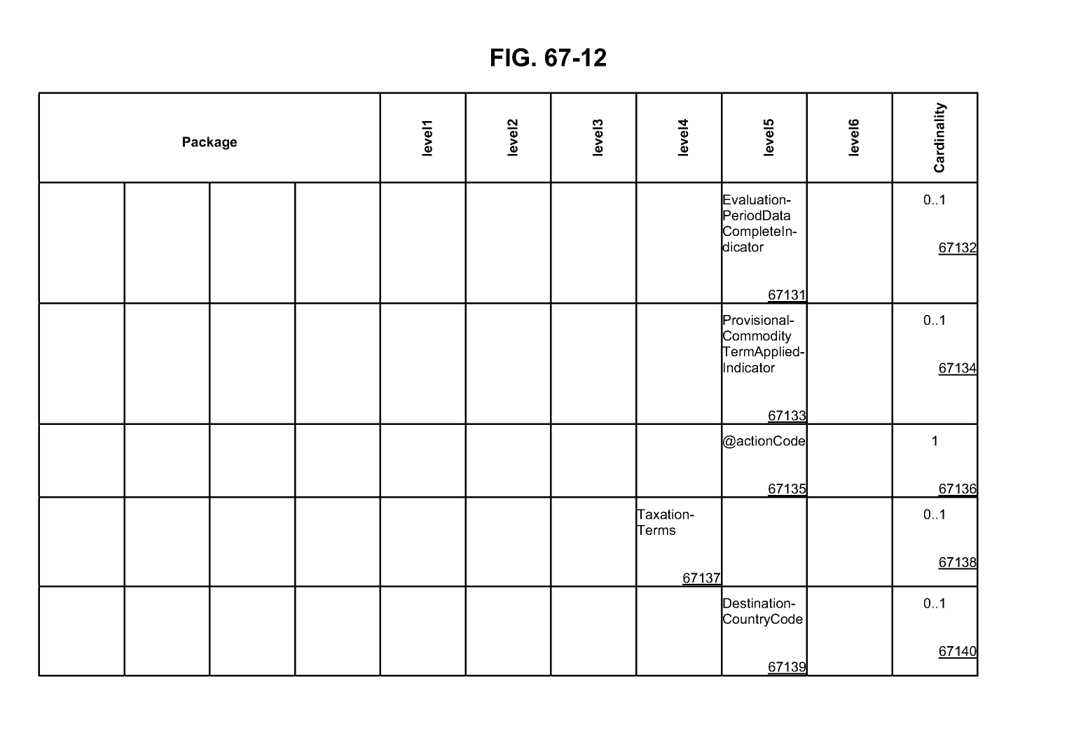

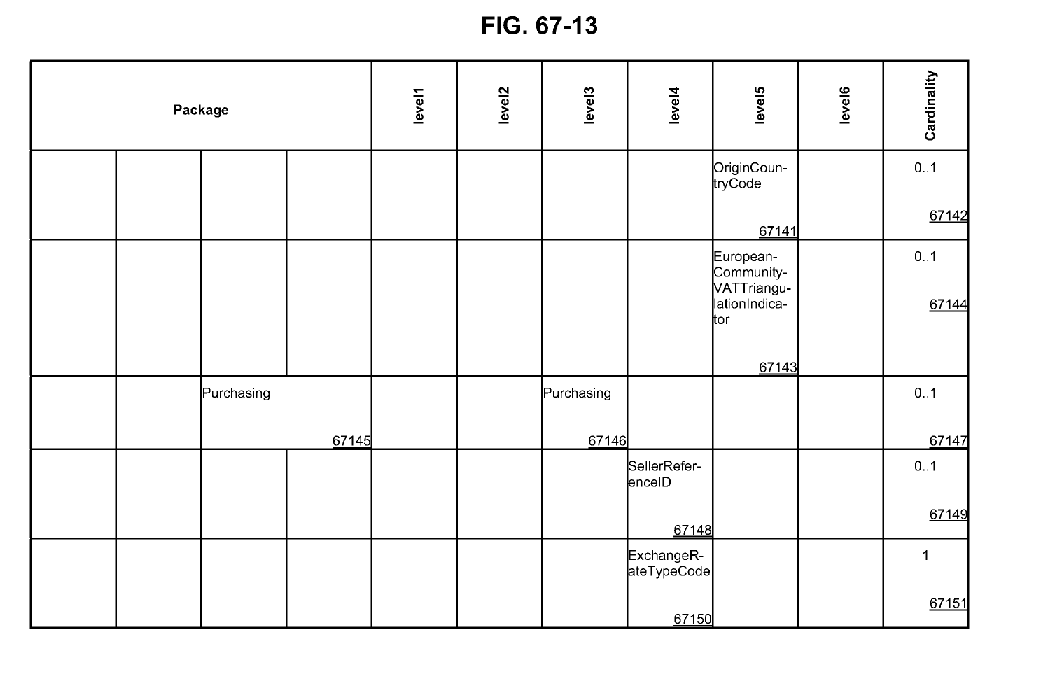

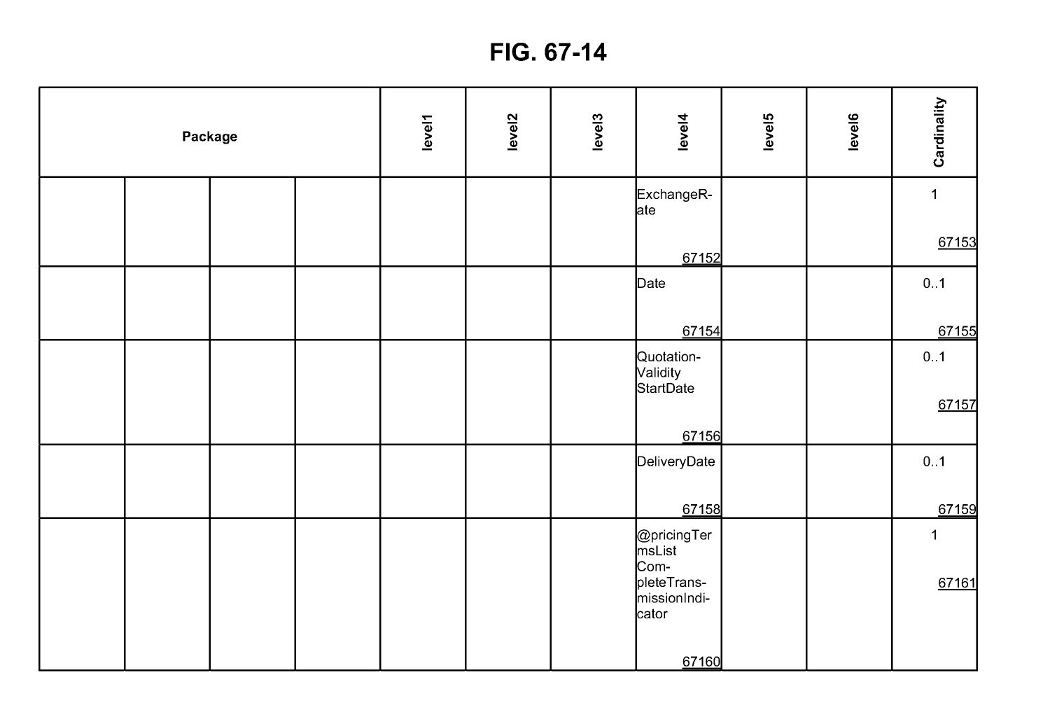

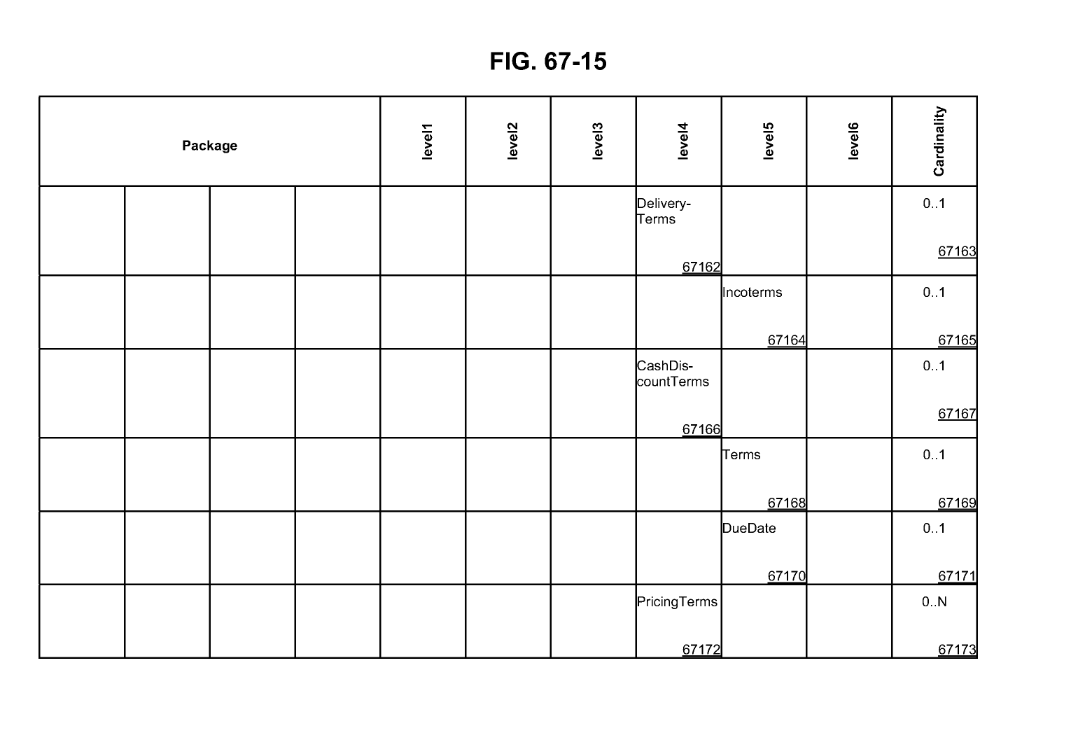

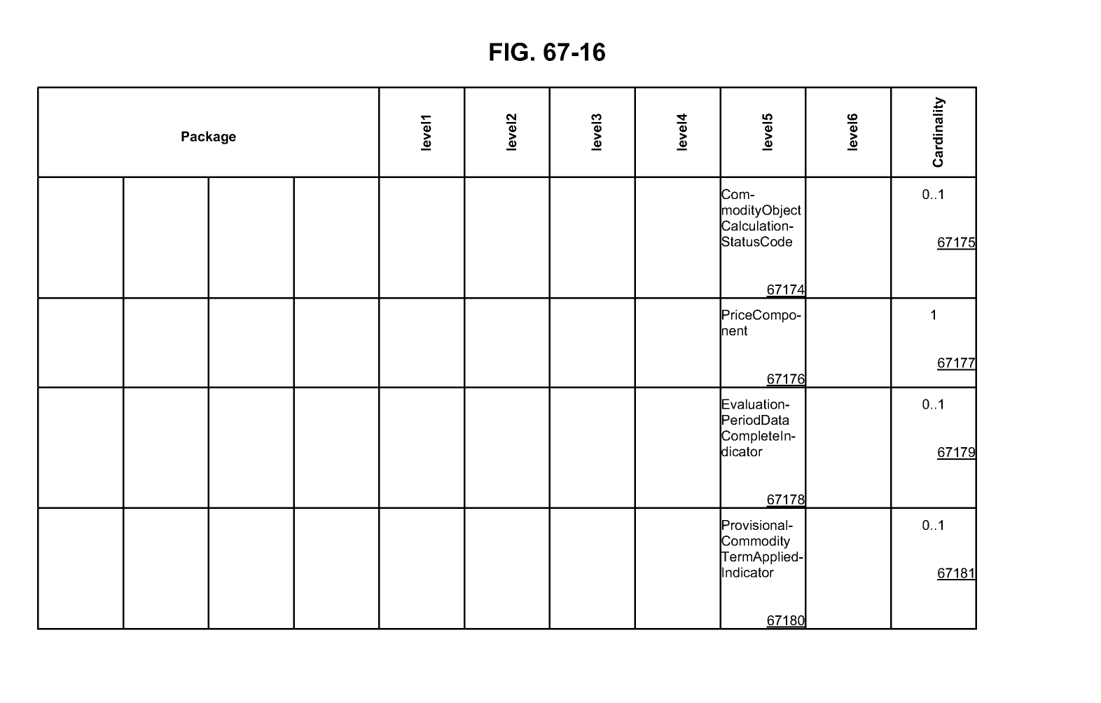

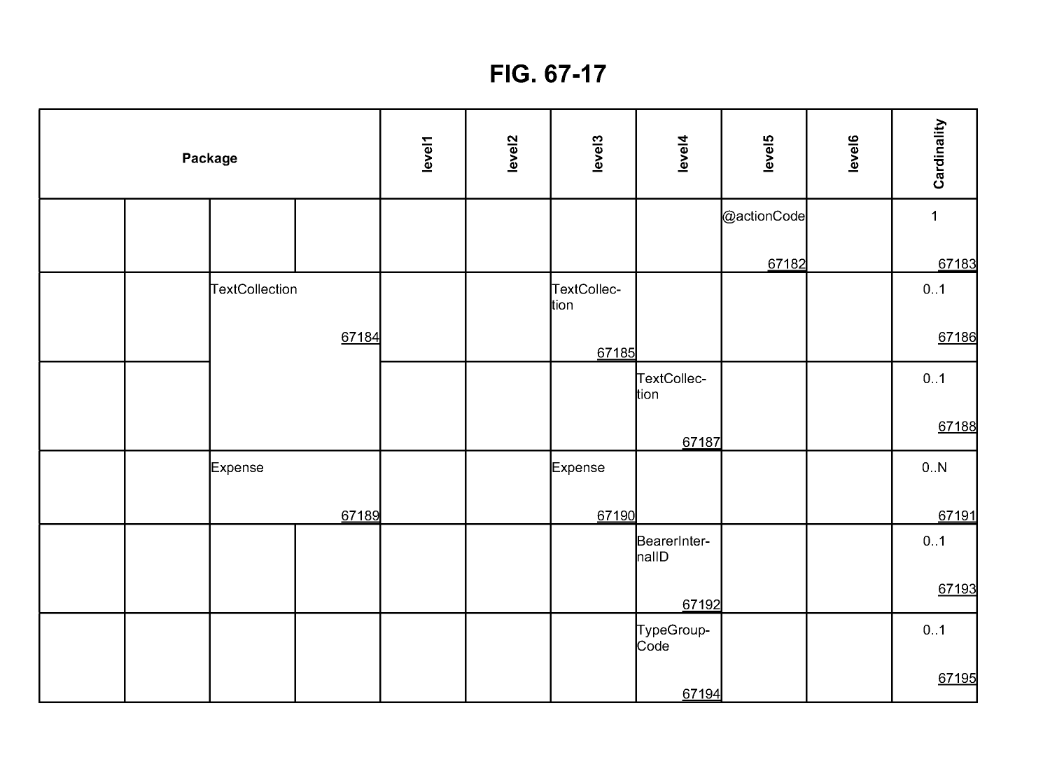

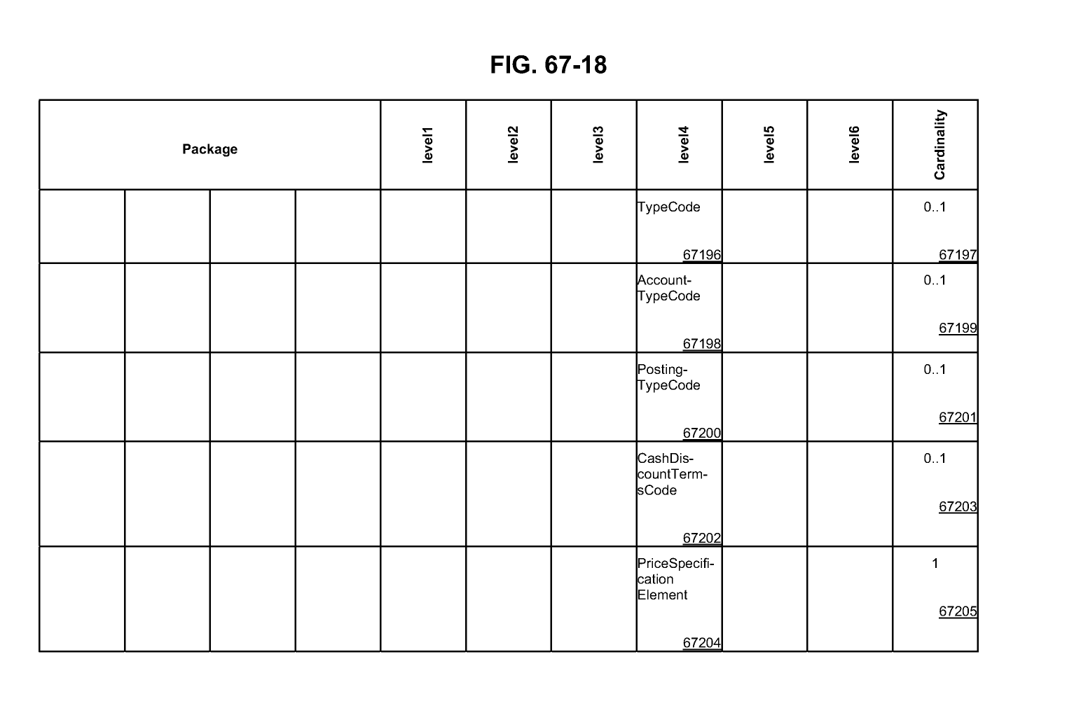

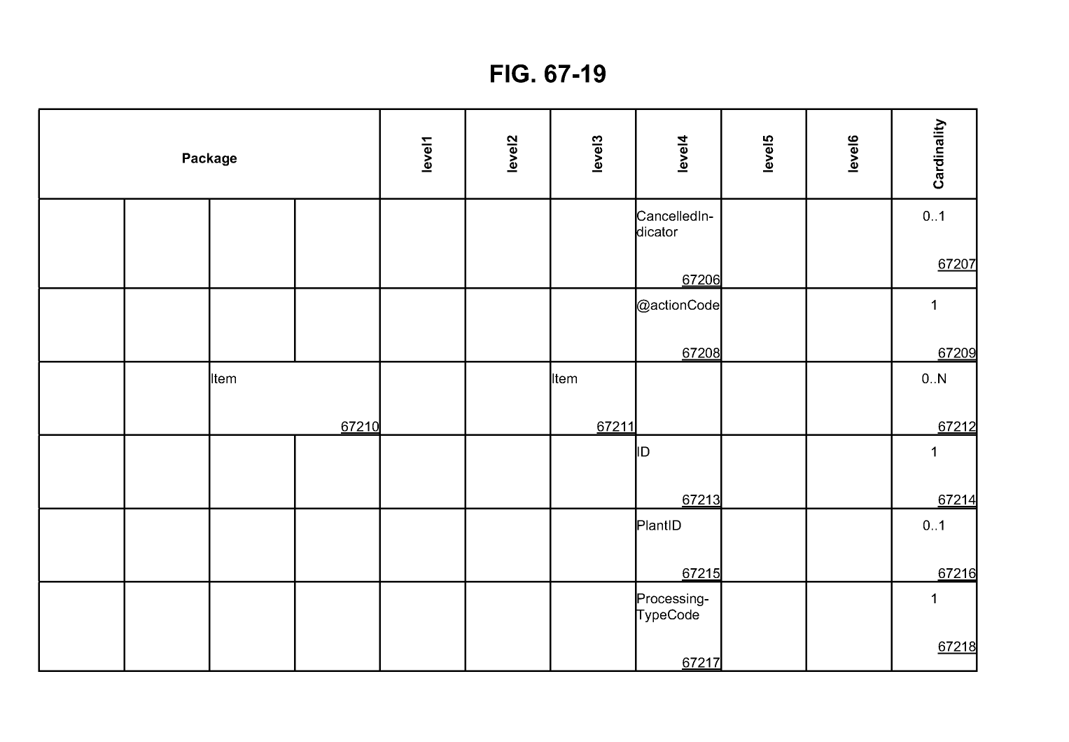

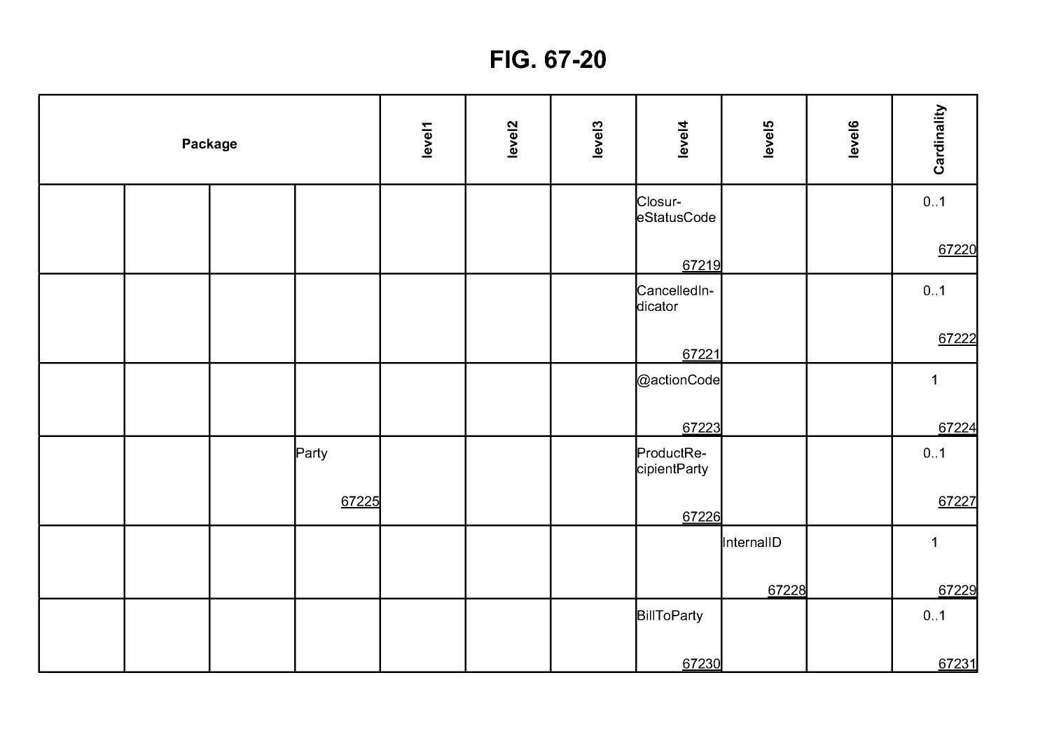

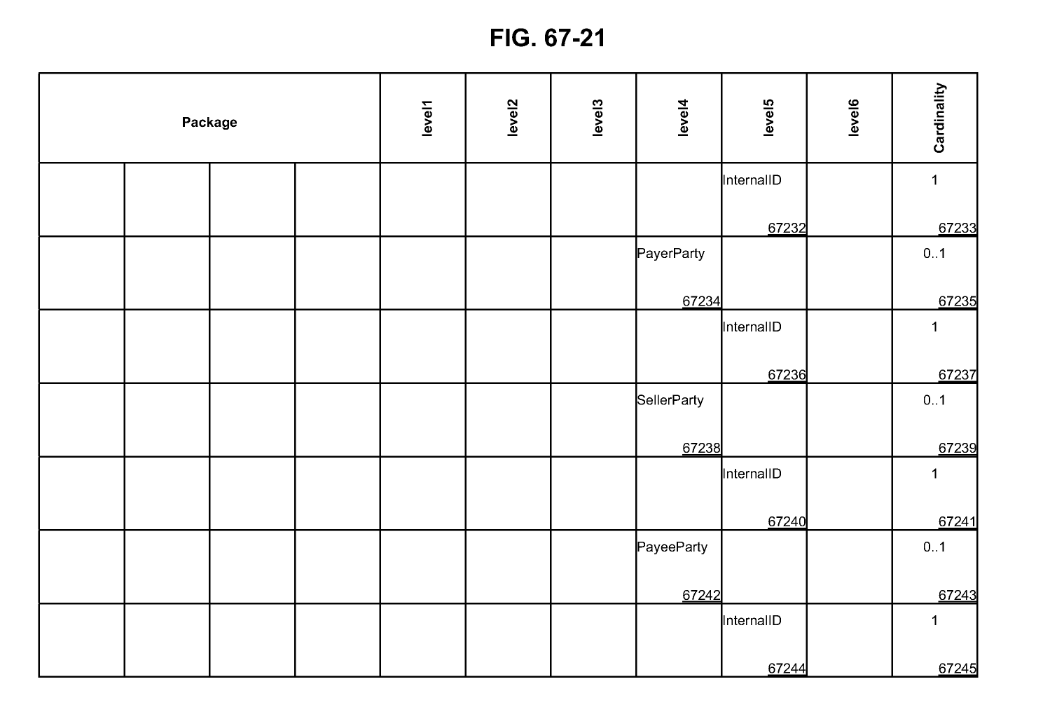

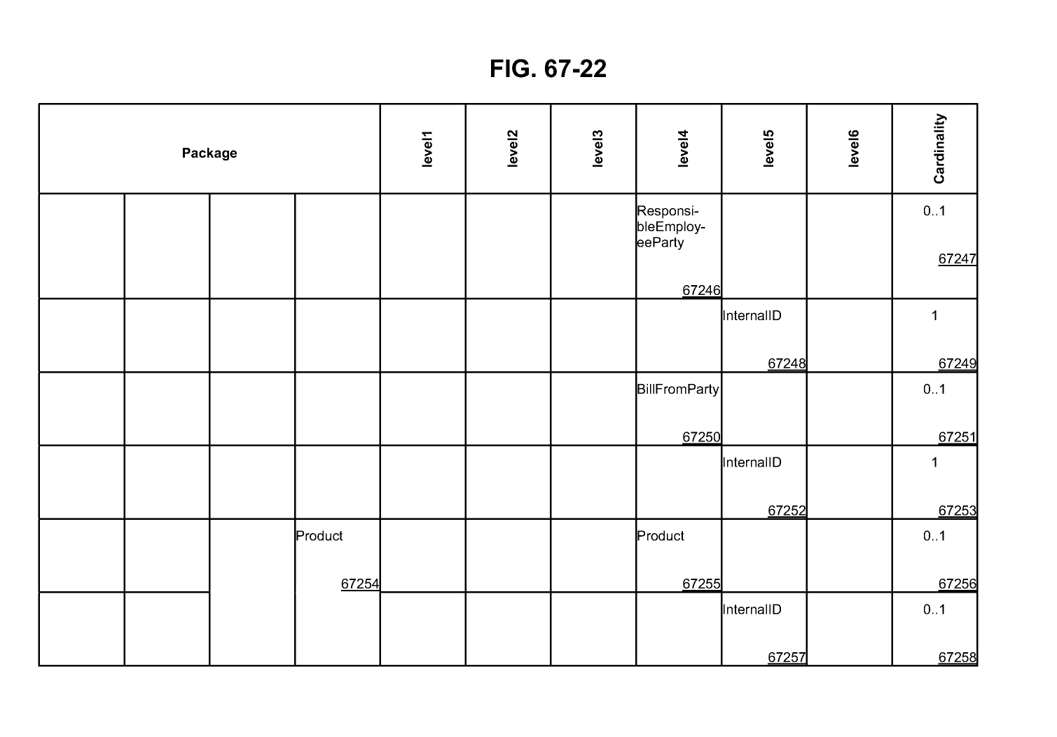

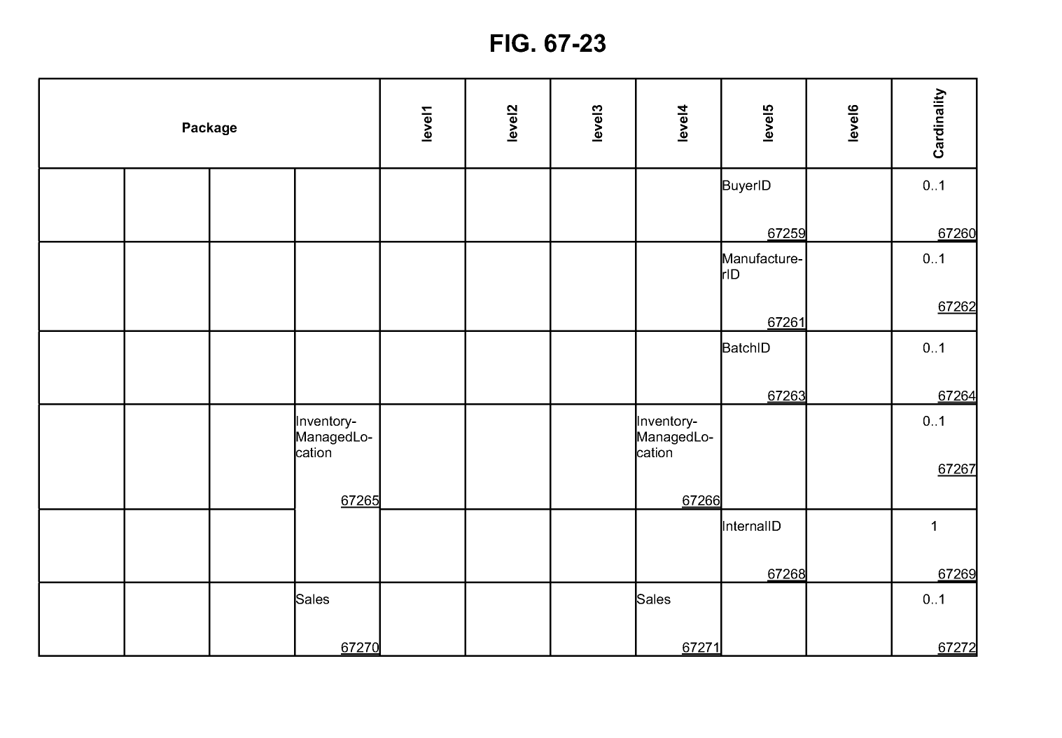

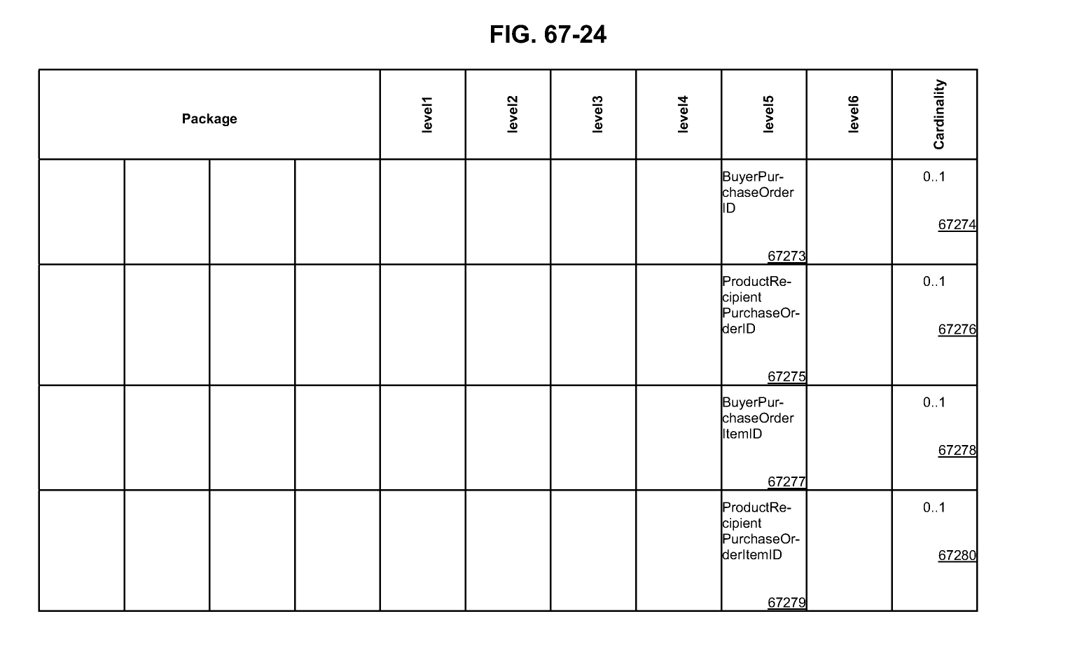

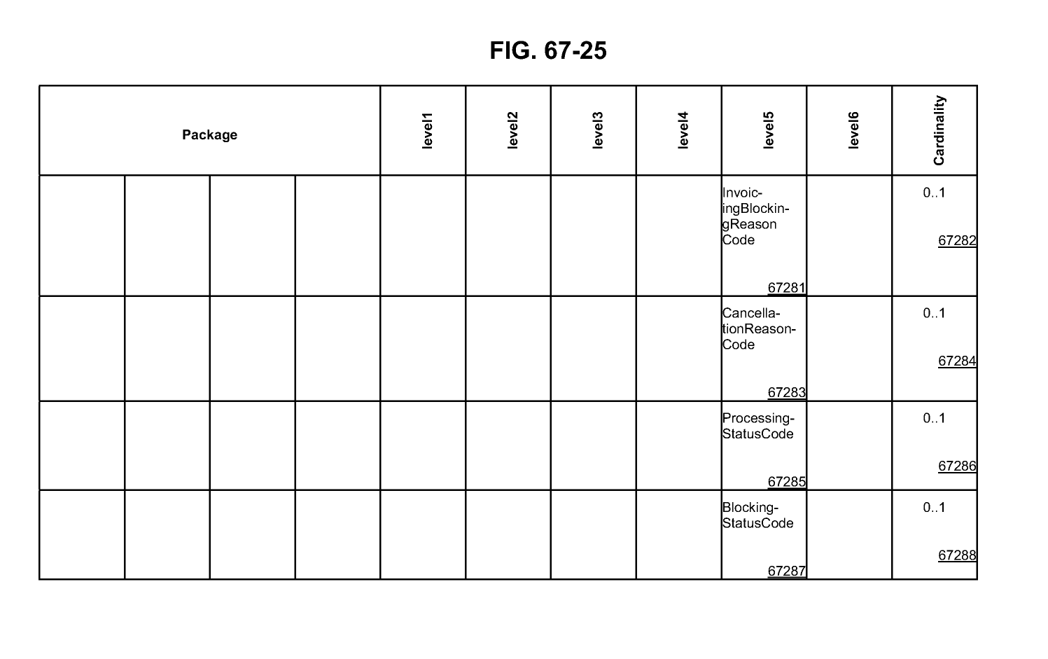

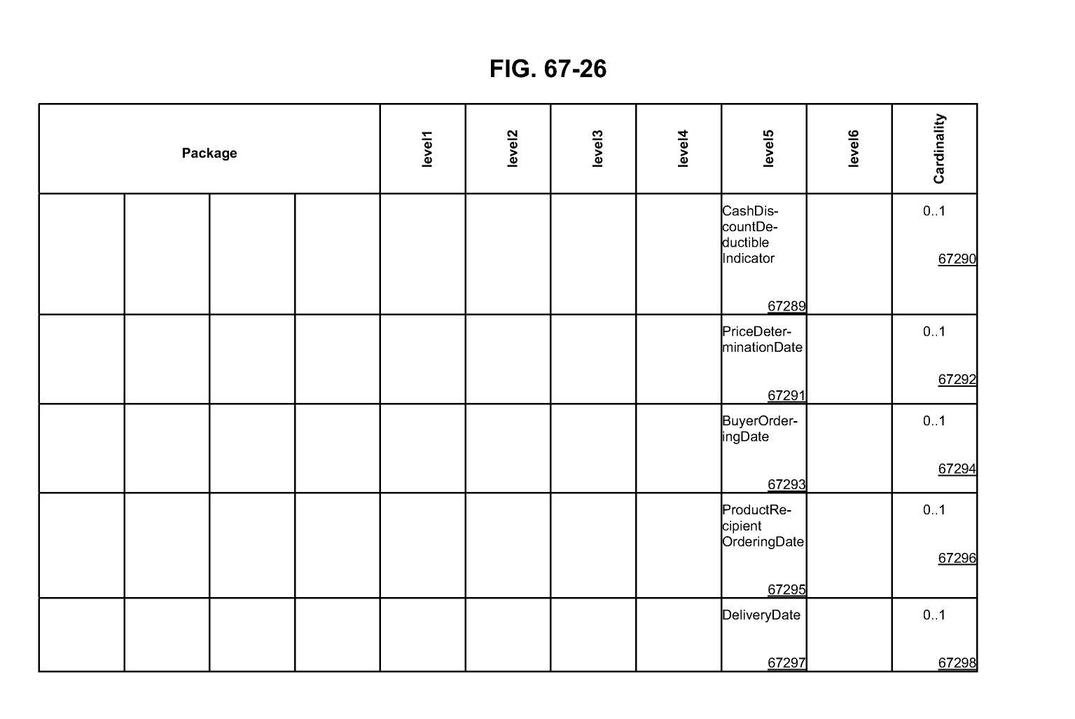

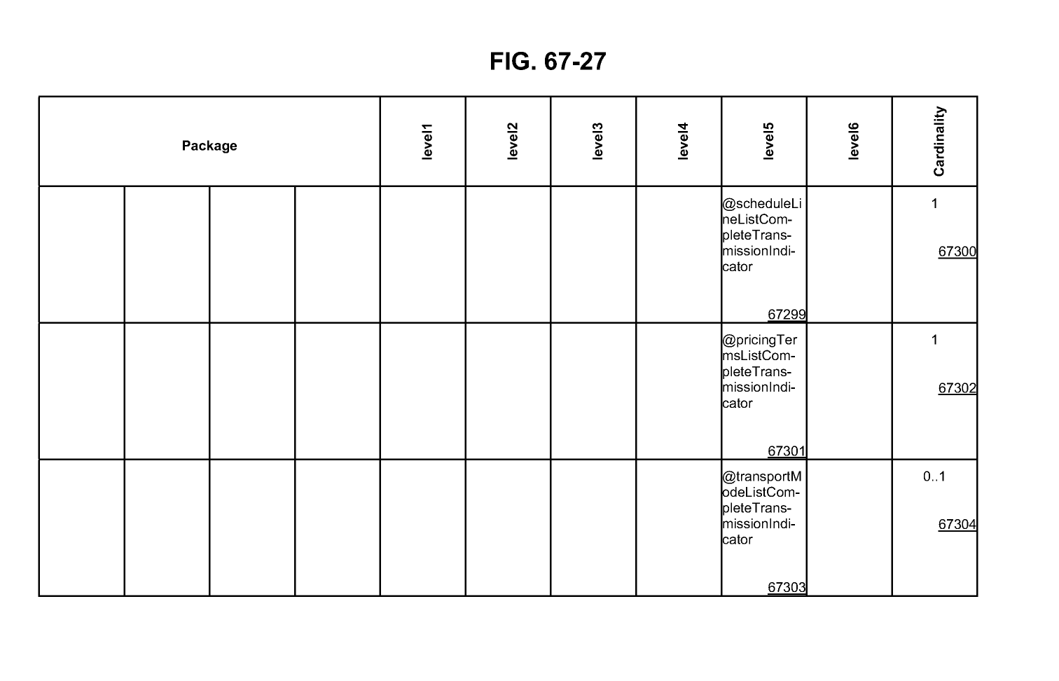

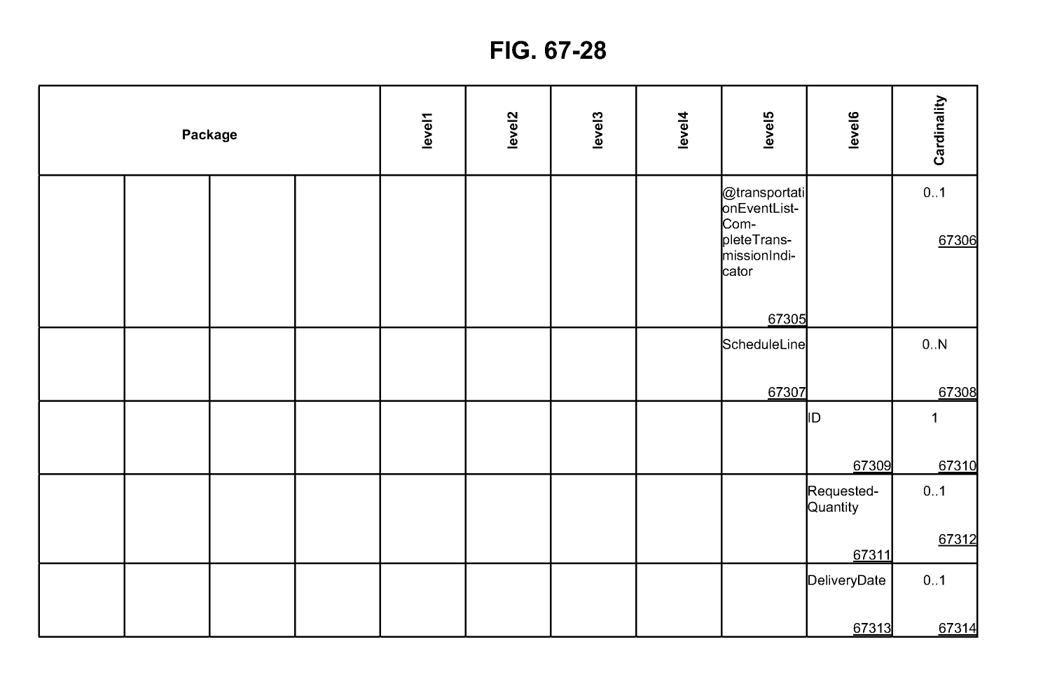

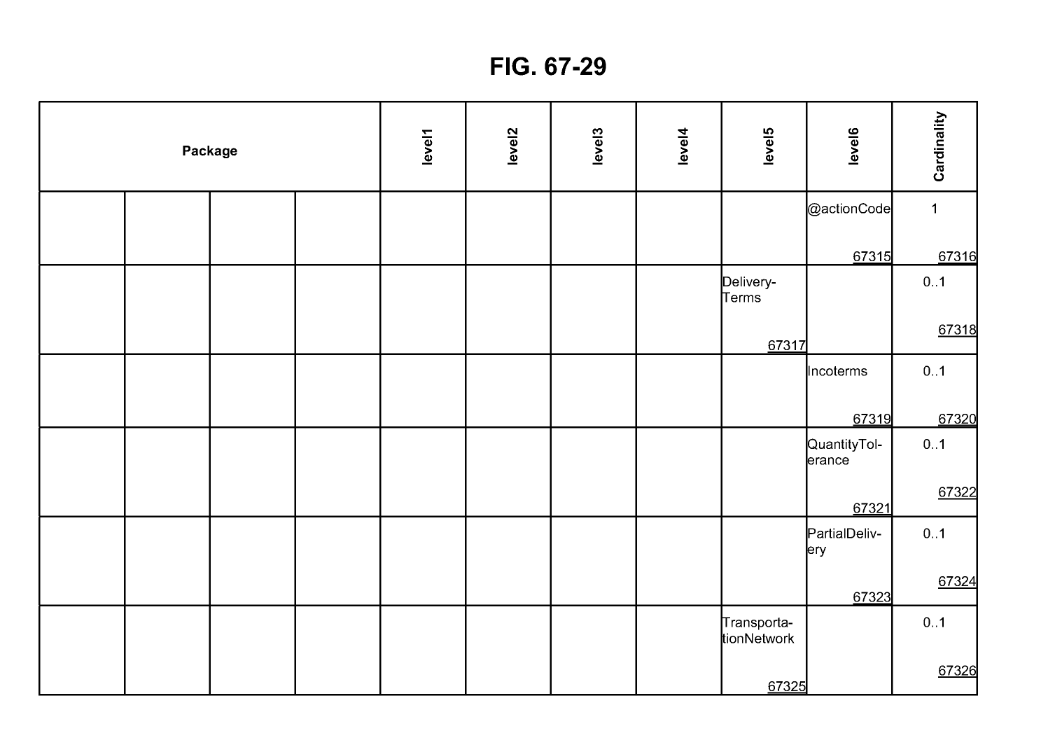

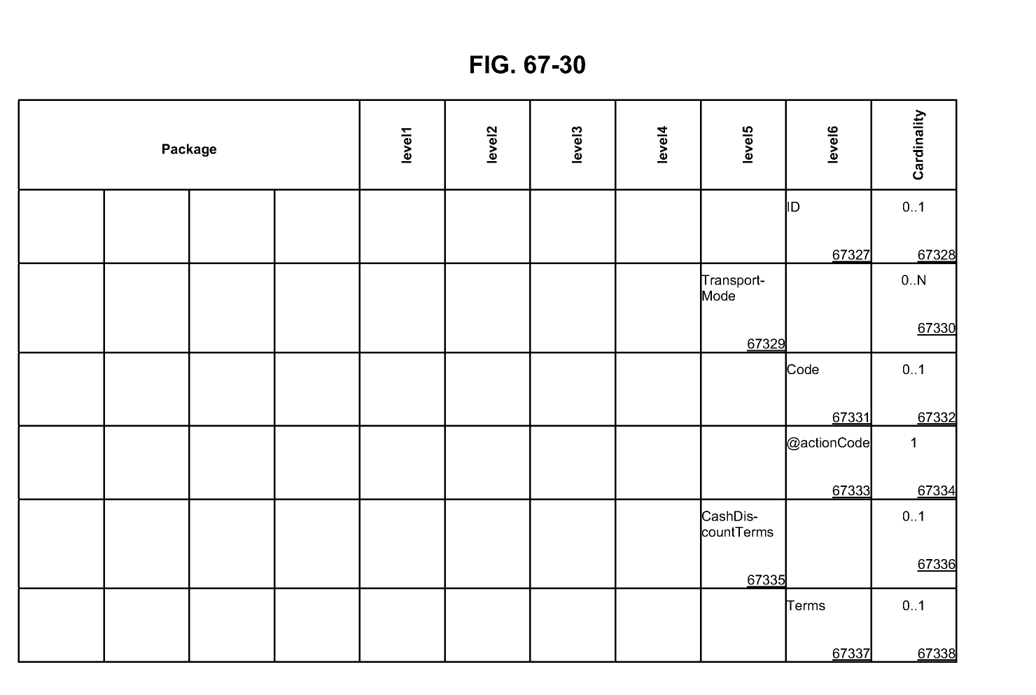

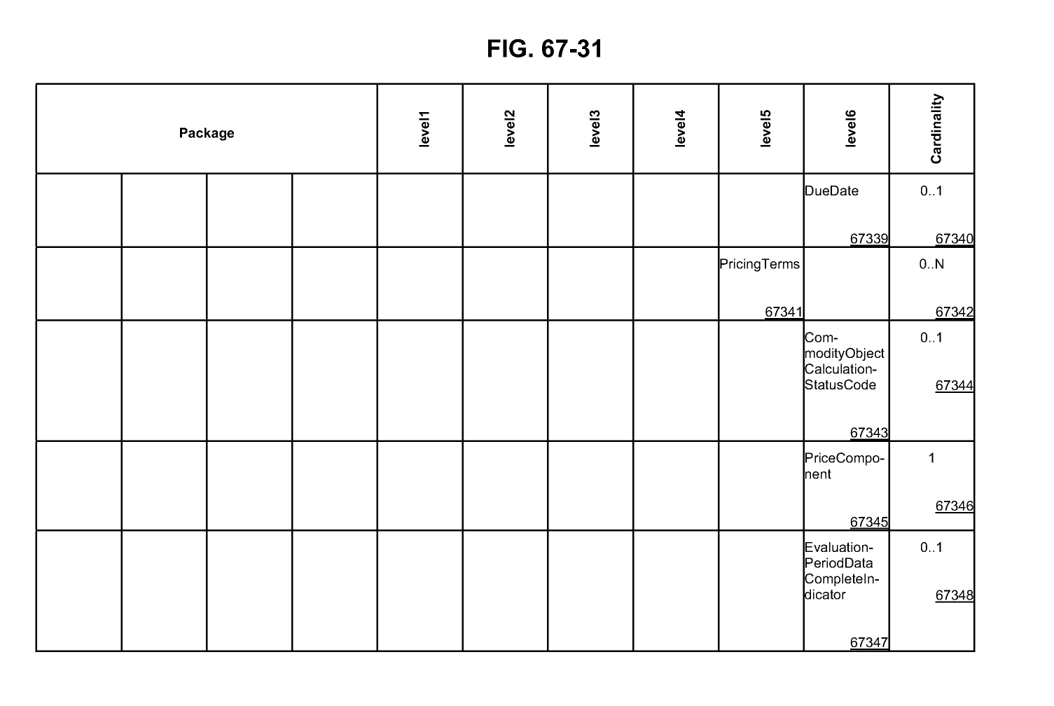

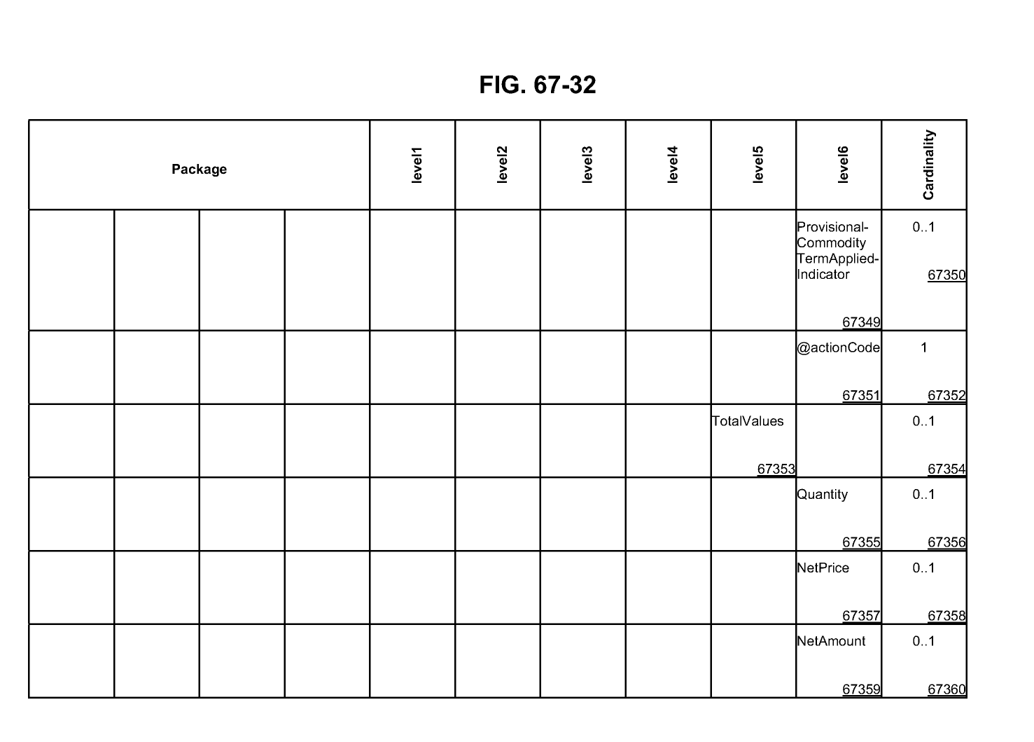

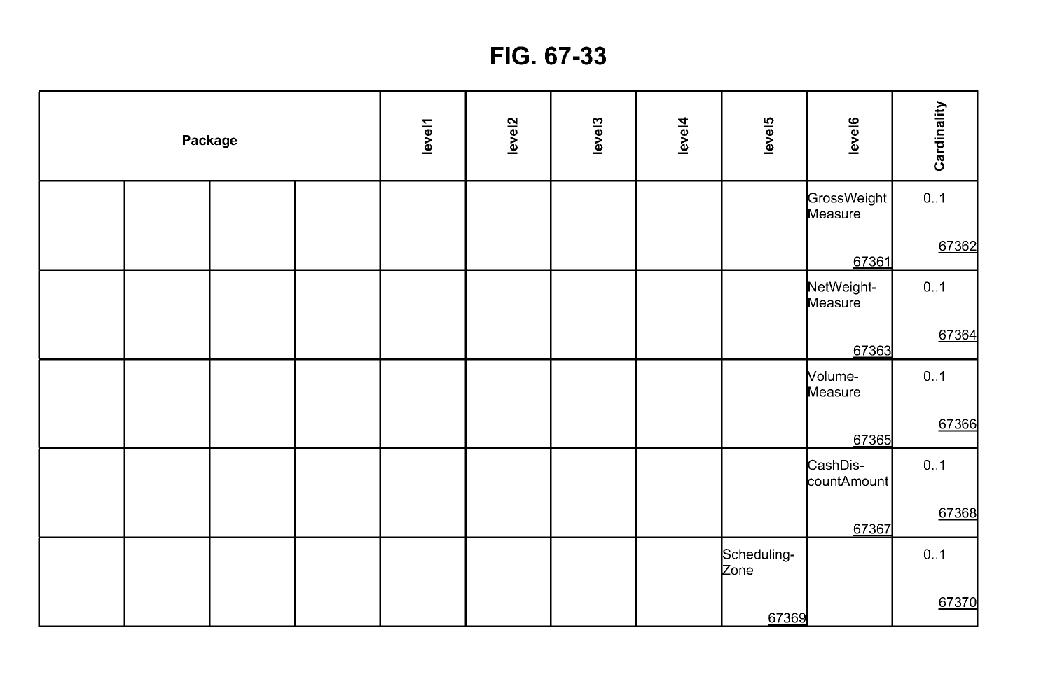

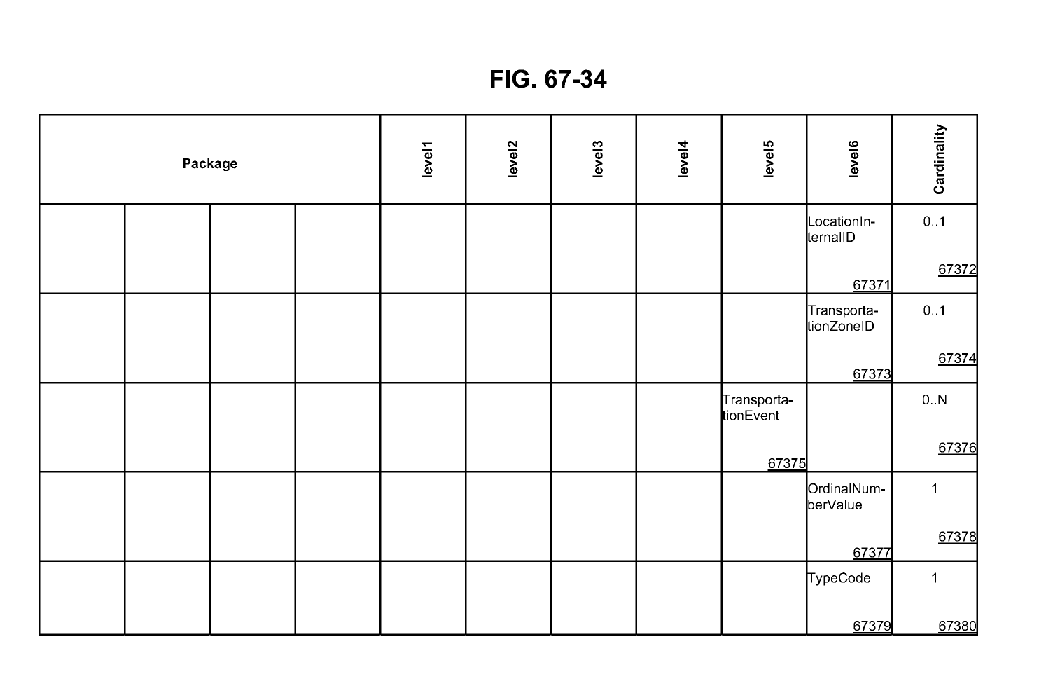

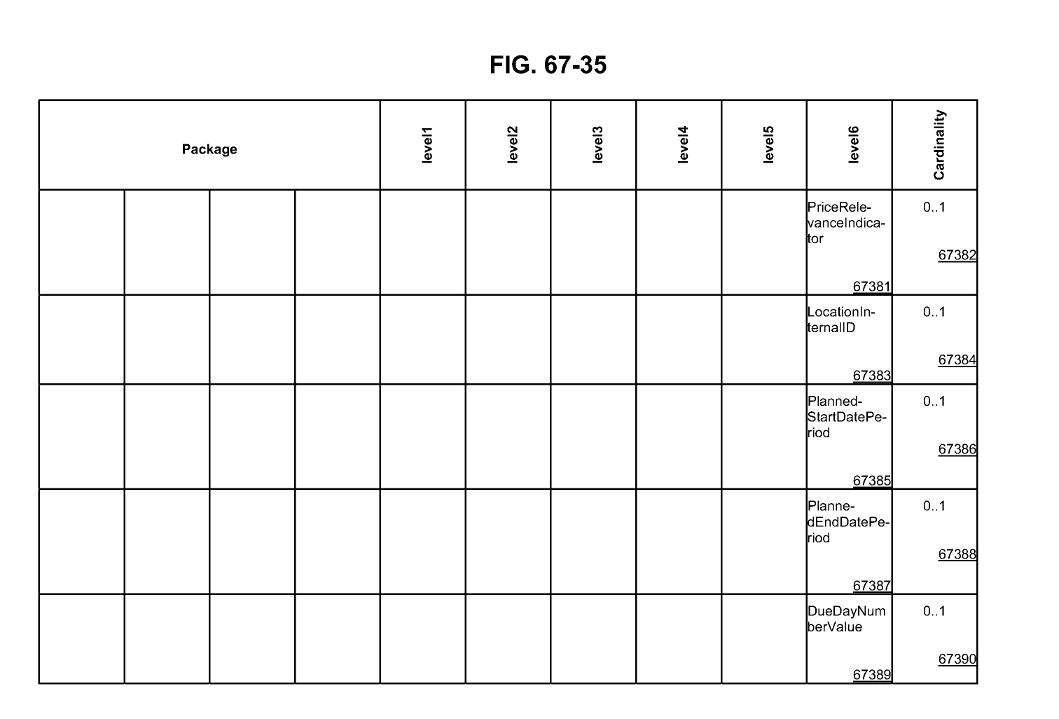

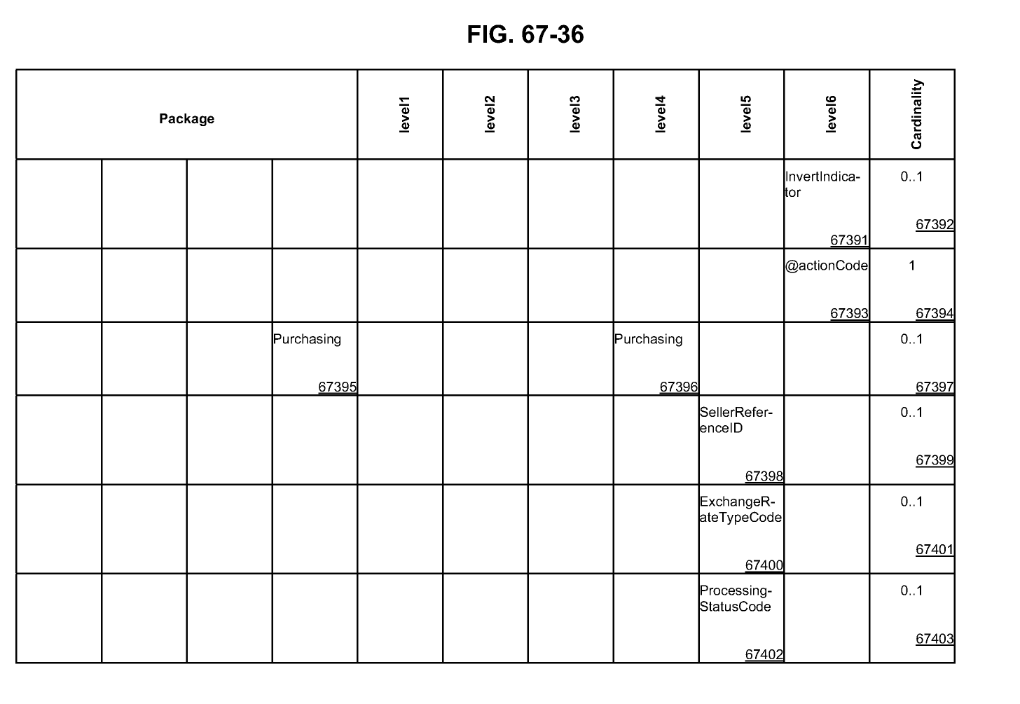

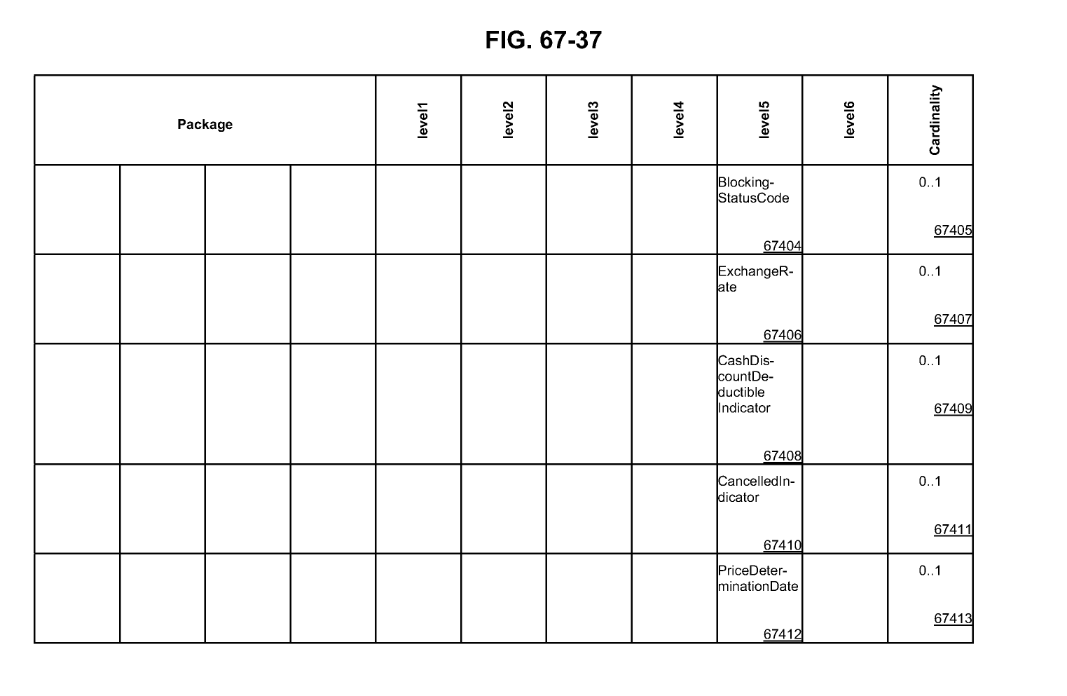

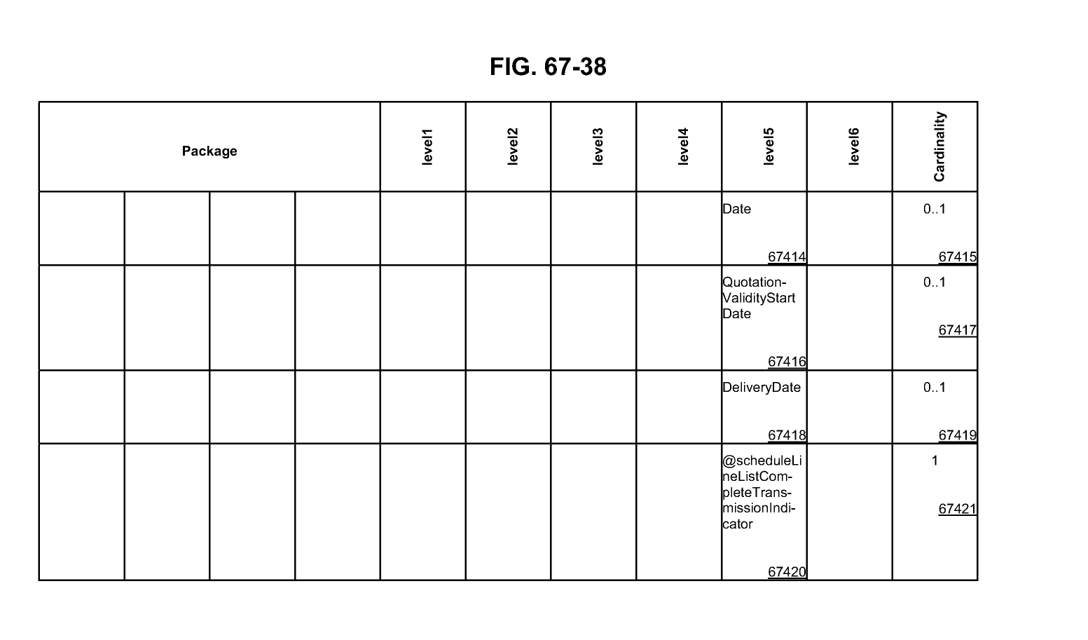

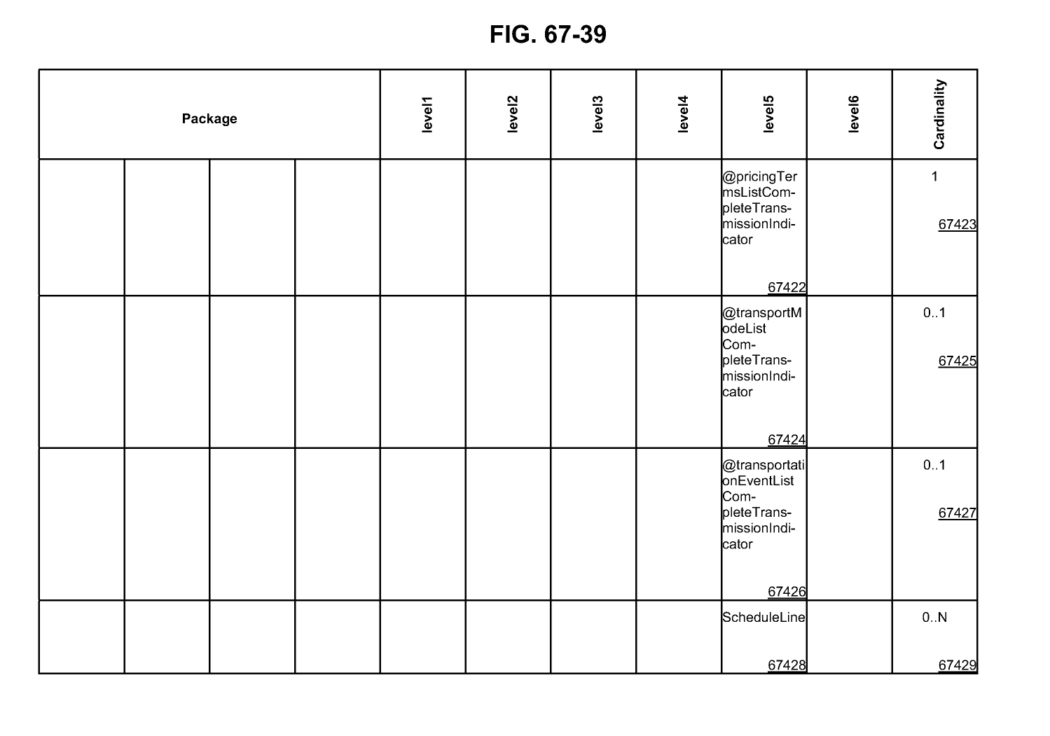

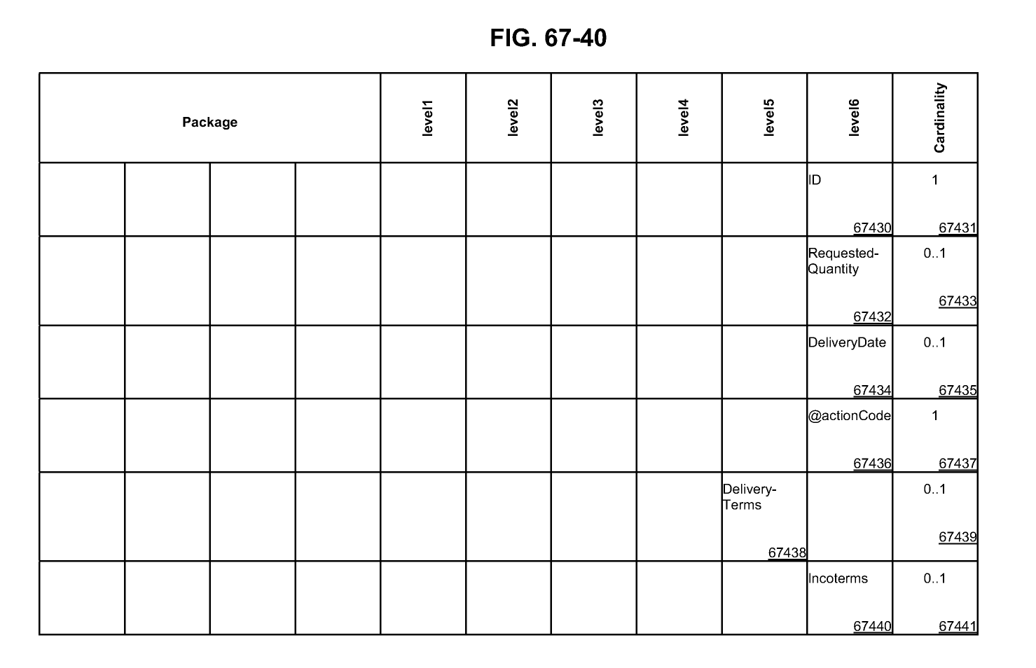

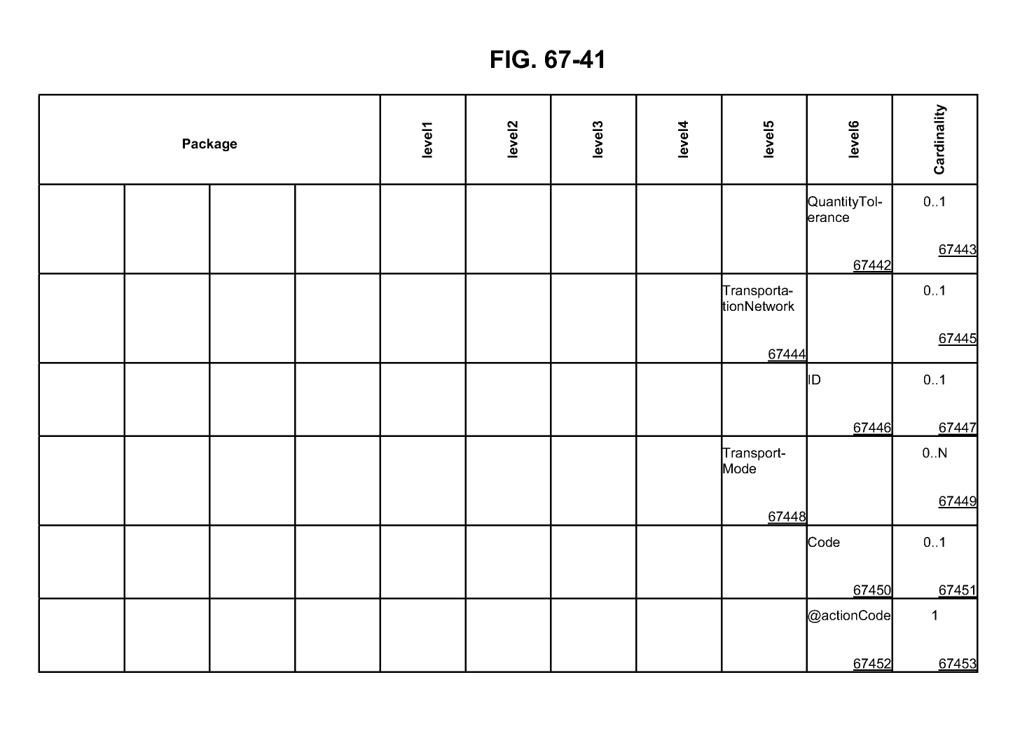

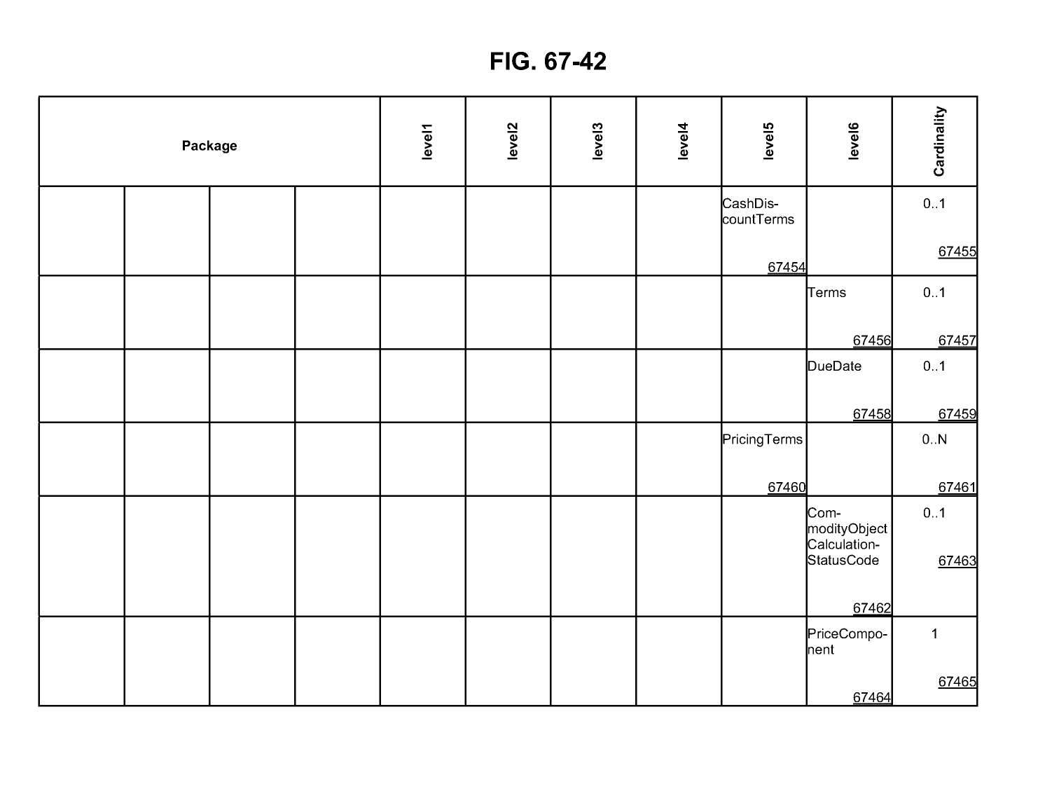

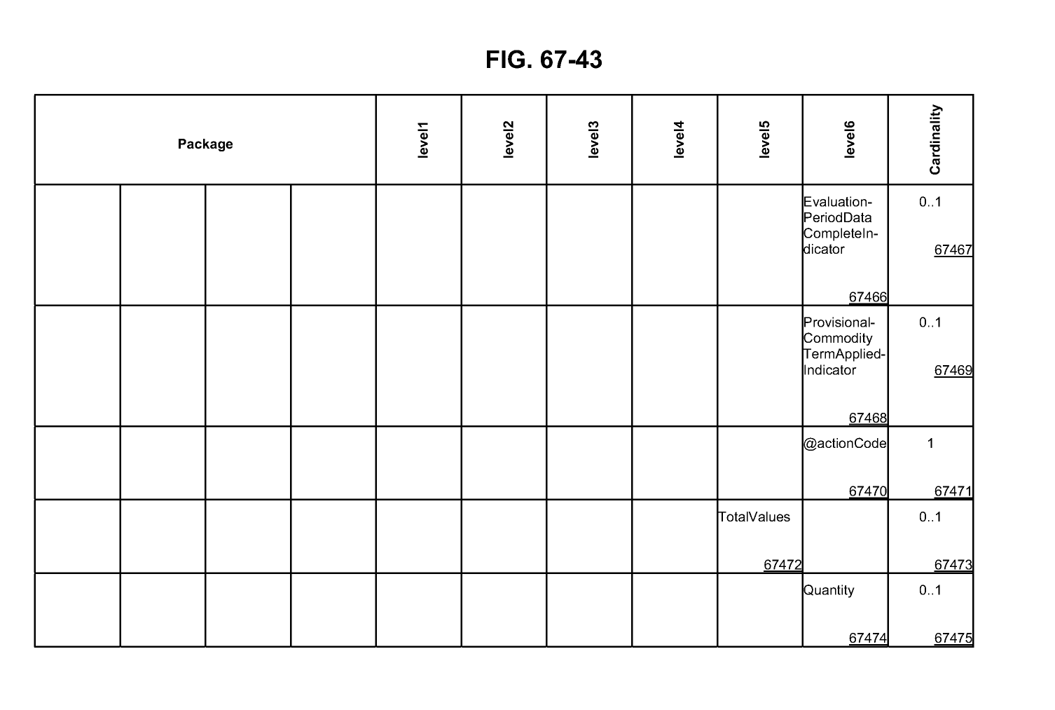

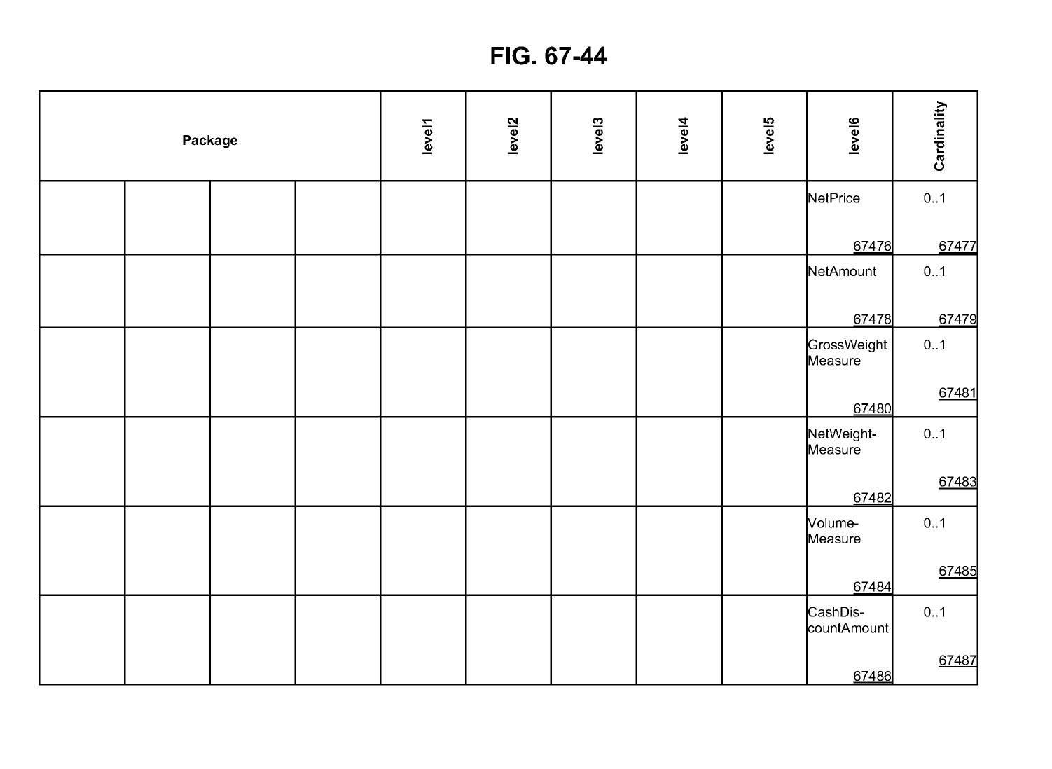

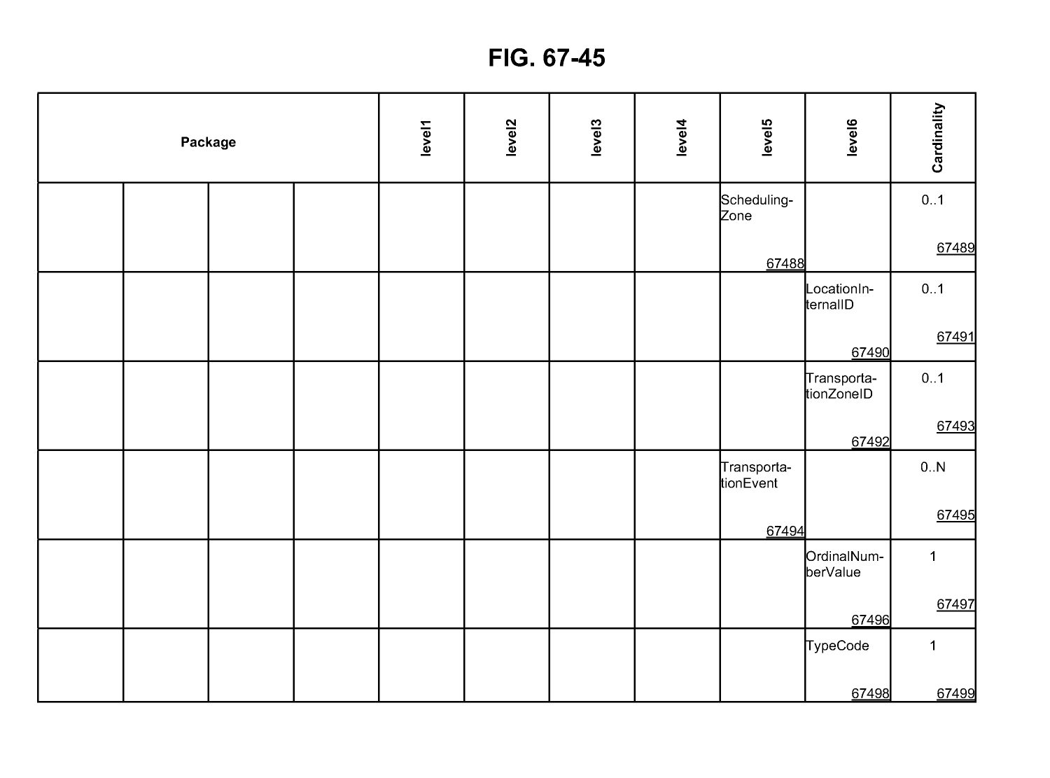

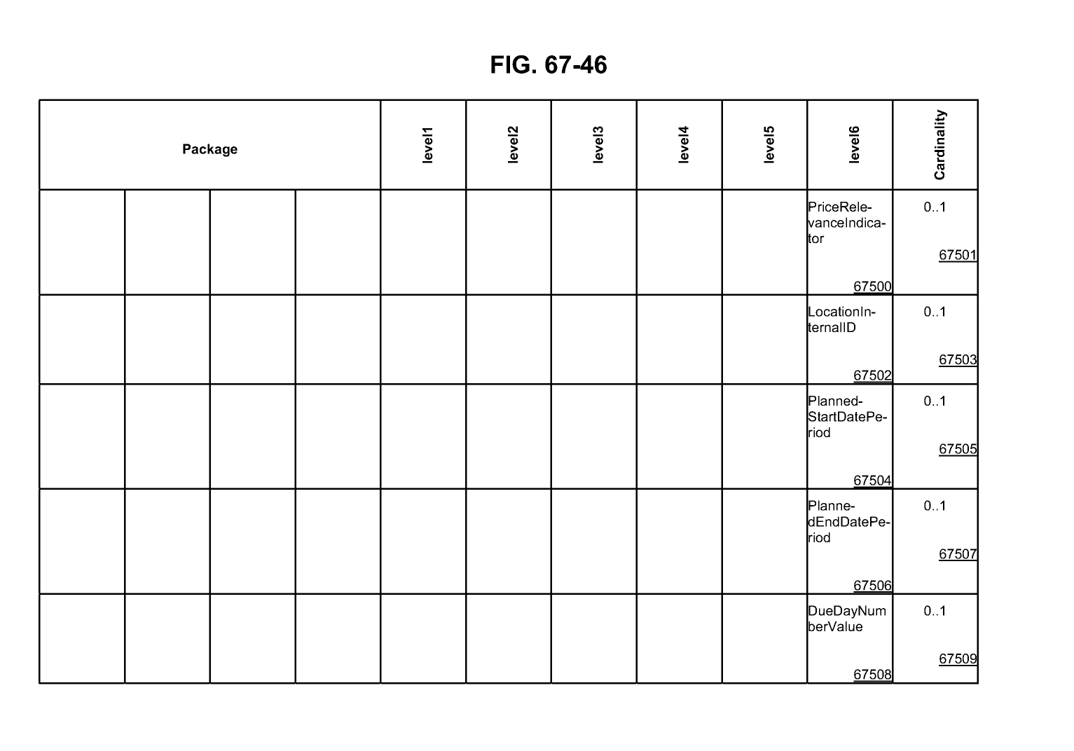

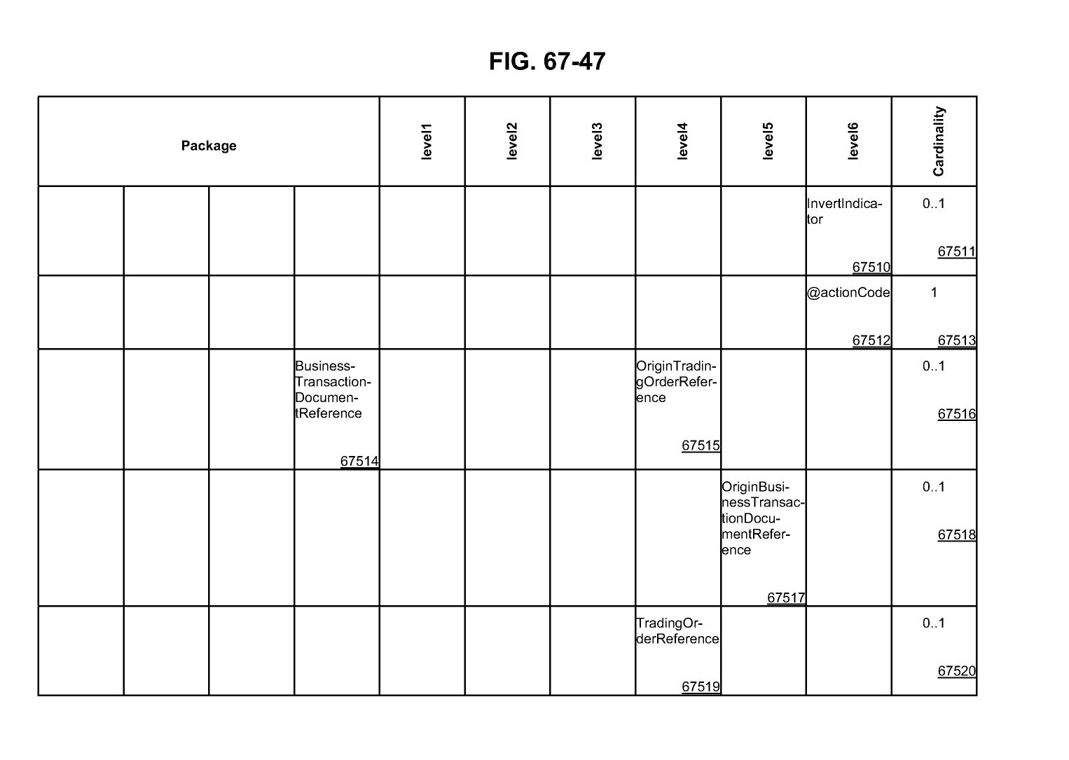

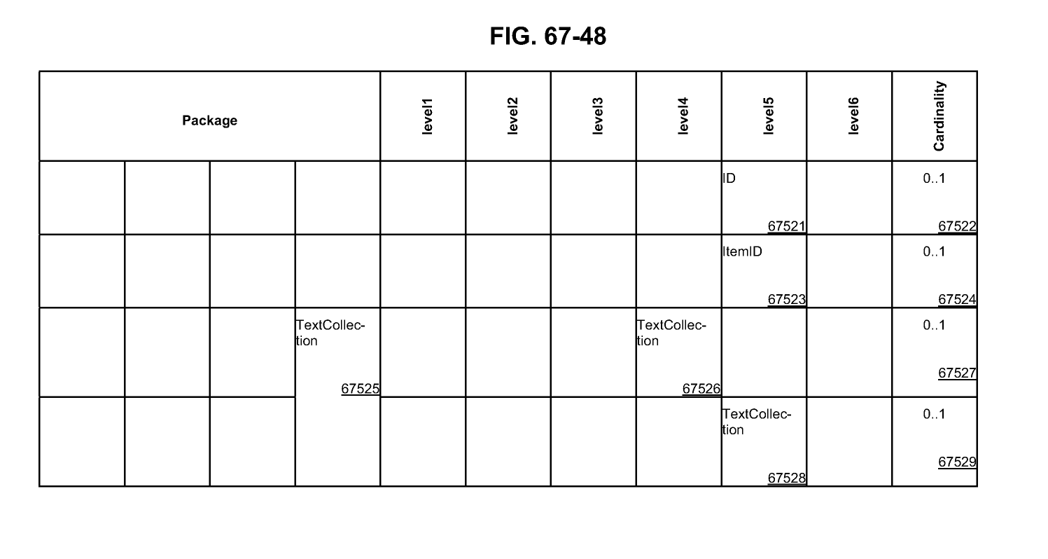

FIGS. 67-1 through 67-48 illustrate one example logical configuration of a TradingOrderERPNotificationMessage 67000 element structure. Specifically, these figures depict the arrangement and hierarchy of various components such as one or more levels of packages, entities, and datatypes, shown here as 67000 through 67529. As described above, packages may be used to represent hierarchy levels. Entities are discrete business elements that are used during a business transaction. Data types are used to type object entities and interfaces with a structure. For example, the TradingOrderERPNotificationMessage 67000 includes, among other things, a TradingOrderERPNotificationMessage 67001. Accordingly, heterogeneous applications may communicate using this consistent message configured as such. The data types of the various packages, entities, and attributes are described with respect to FIG. 58.

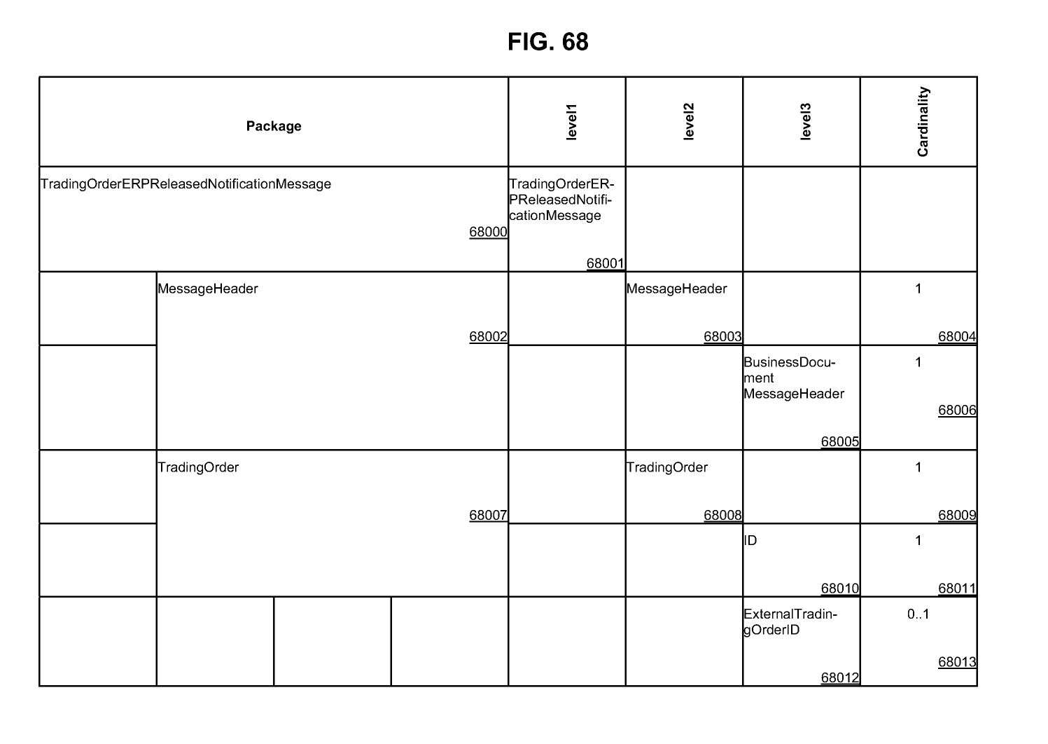

FIG. 68 illustrates one example logical configuration of a TradingOrderERPReleasedNotificationMessage 68000 element structure. Specifically, this figure depicts the arrangement and hierarchy of various components such as one or more levels of packages, entities, and datatypes, shown here as 68000 through 68013. As described above, packages may be used to represent hierarchy levels. Entities are discrete business elements that are used during a business transaction. Data types are used to type object entities and interfaces with a structure. For example, the TradingOrderERPReleasedNotificationMessage 68000 includes, among other things, a TradingOrderERPReleasedNotificationMessage 68001. Accordingly, heterogeneous applications may communicate using this consistent message configured as such. The data types of the various packages, entities, and attributes are described with respect to FIG. 58.

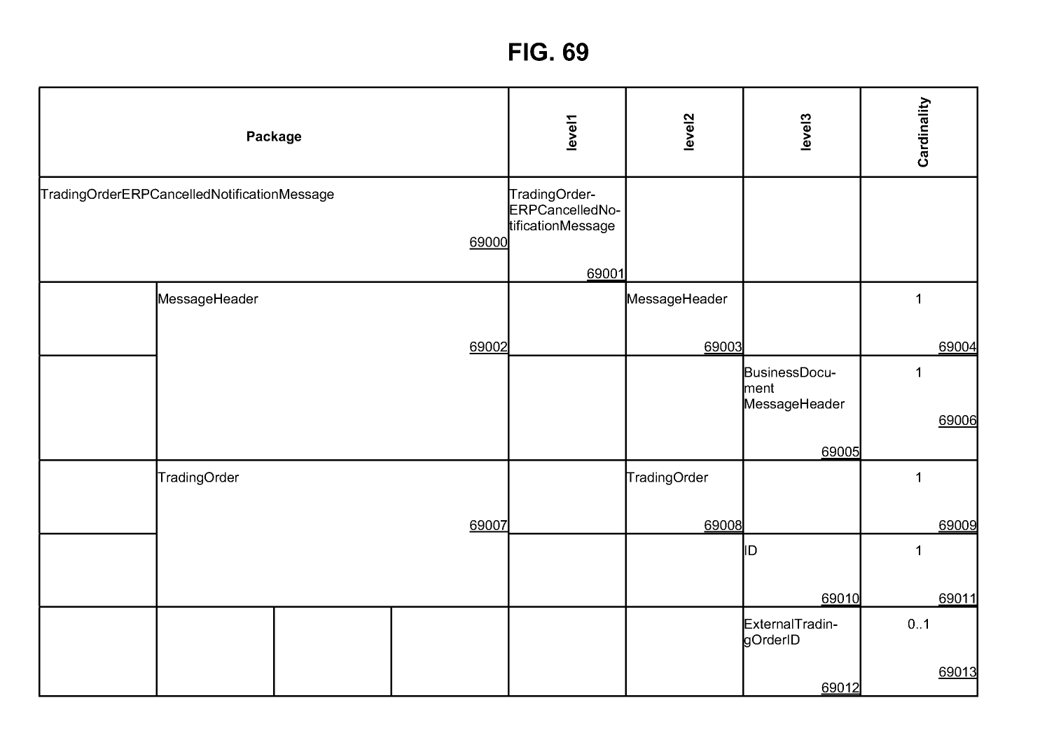

FIG. 69 illustrates one example logical configuration of a TradingOrderERPCancelledNotificationMessage 69000 element structure. Specifically, this figure depicts the arrangement and hierarchy of various components such as one or more levels of packages, entities, and datatypes, shown here as 69000 through 69013. As described above, packages may be used to represent hierarchy levels. Entities are discrete business elements that are used during a business transaction. Data types are used to type object entities and interfaces with a structure. For example, the TradingOrderERPCancelledNotificationMessage 69000 includes, among other things, a TradingOrderERPCancelledNotificationMessage 69001. Accordingly, heterogeneous applications may communicate using this consistent message configured as such. The data types of the various packages, entities, and attributes are described with respect to FIG. 58.

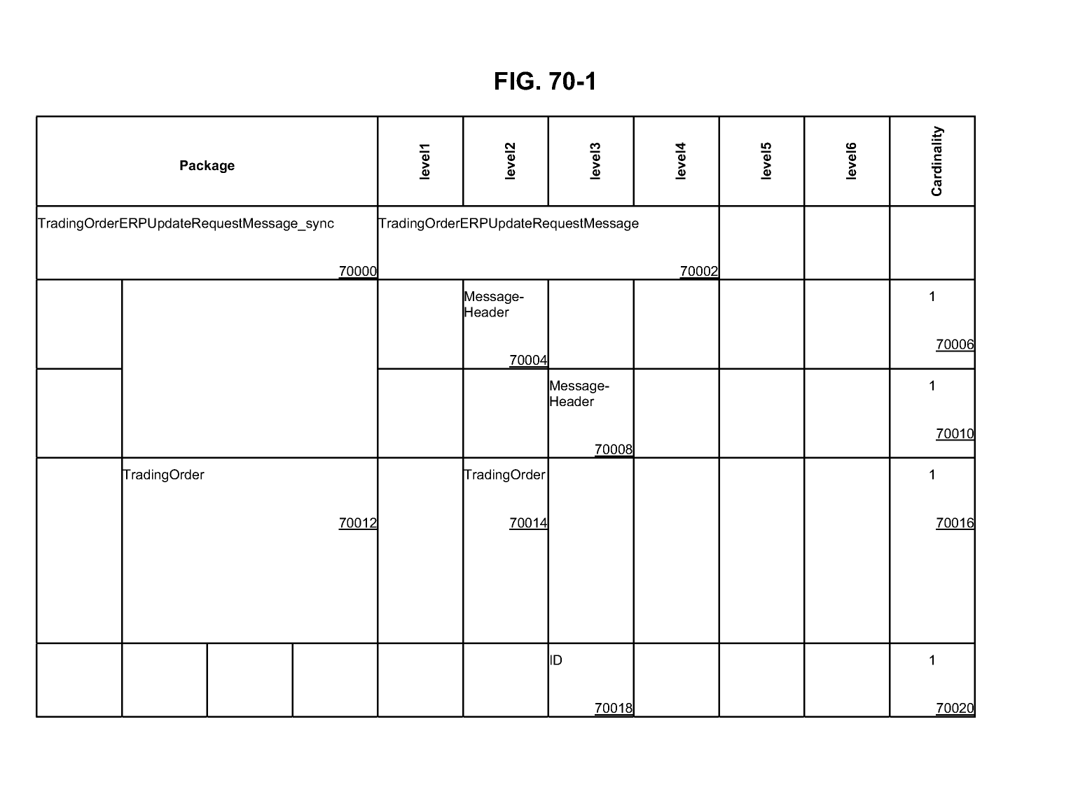

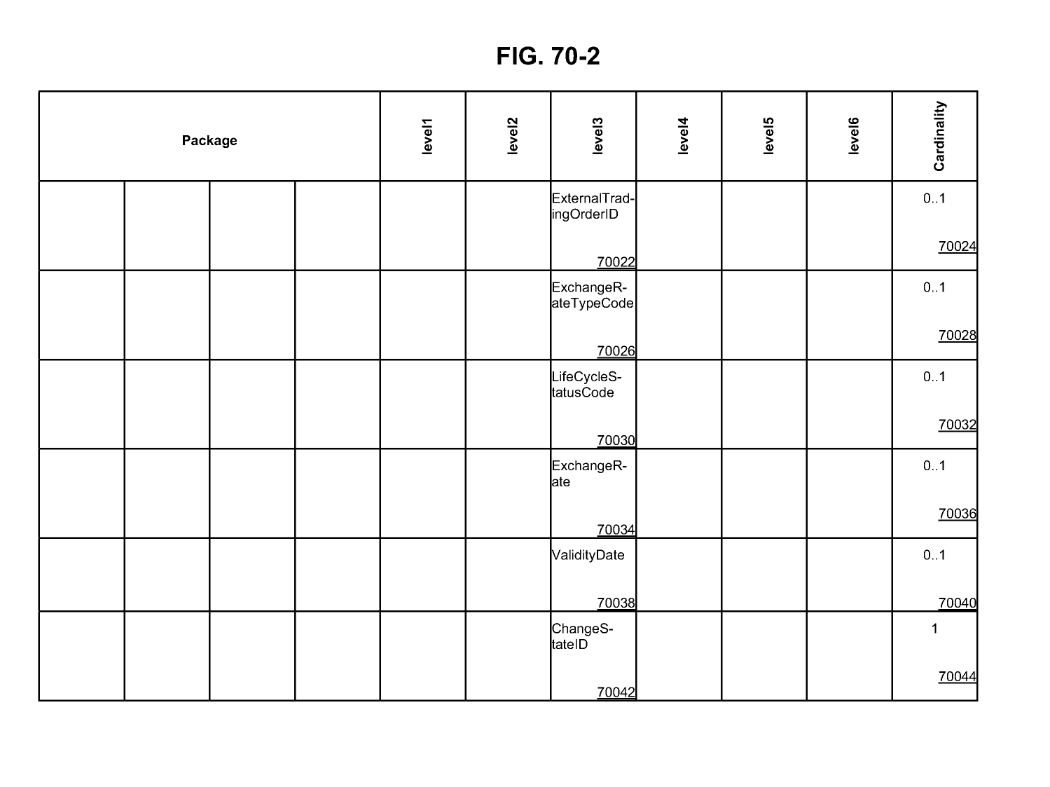

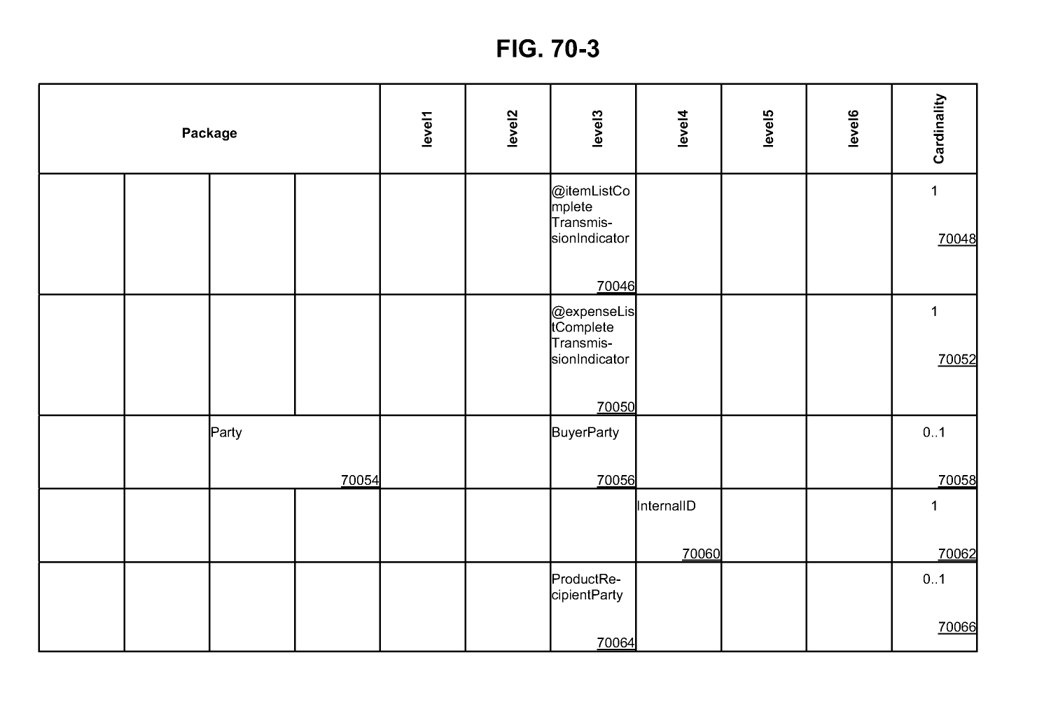

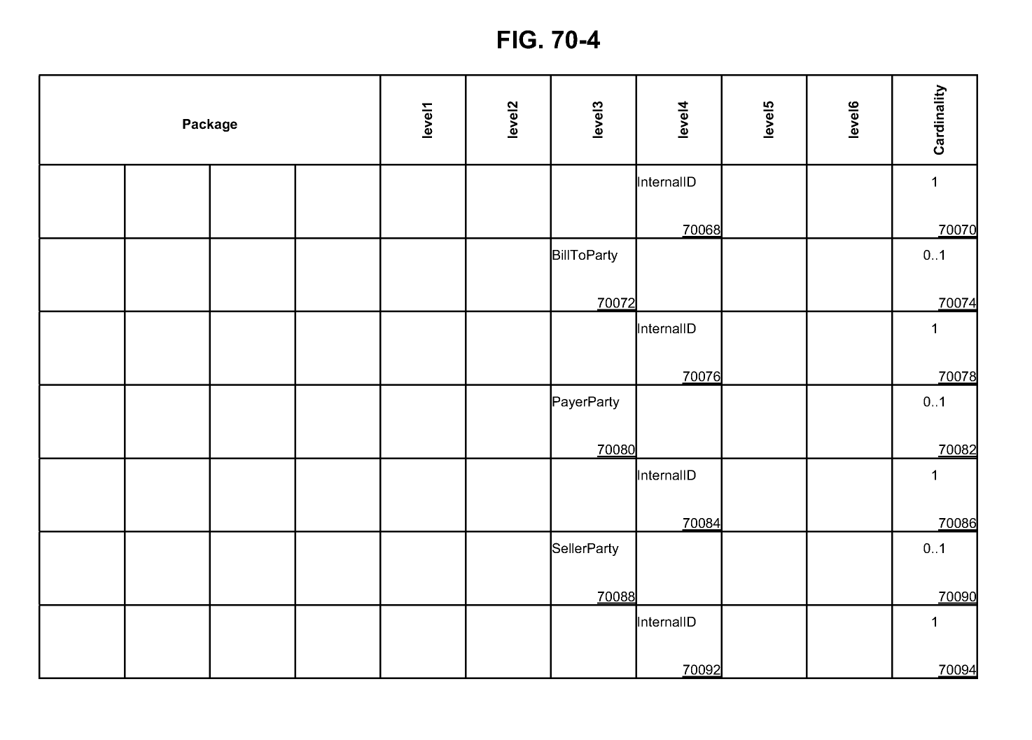

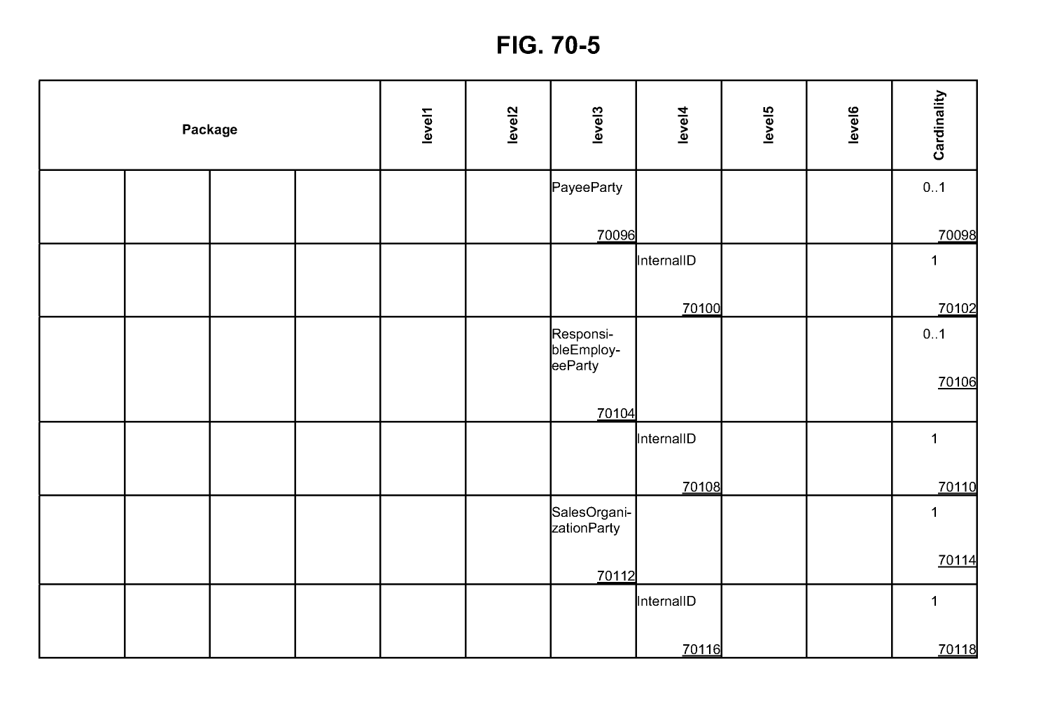

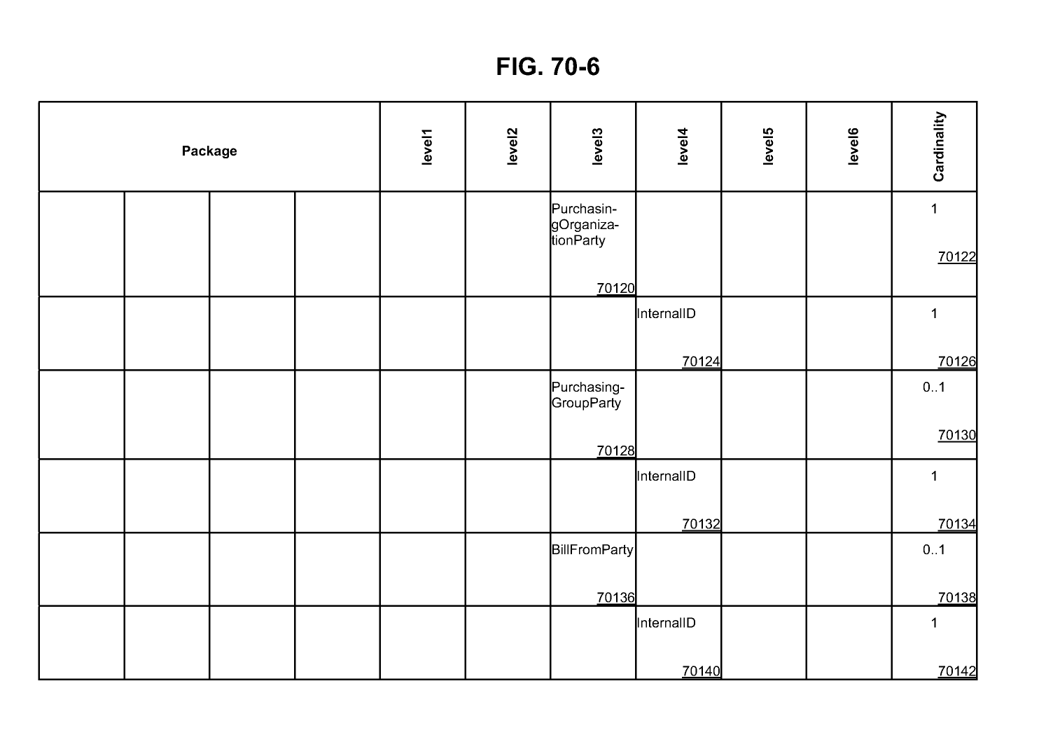

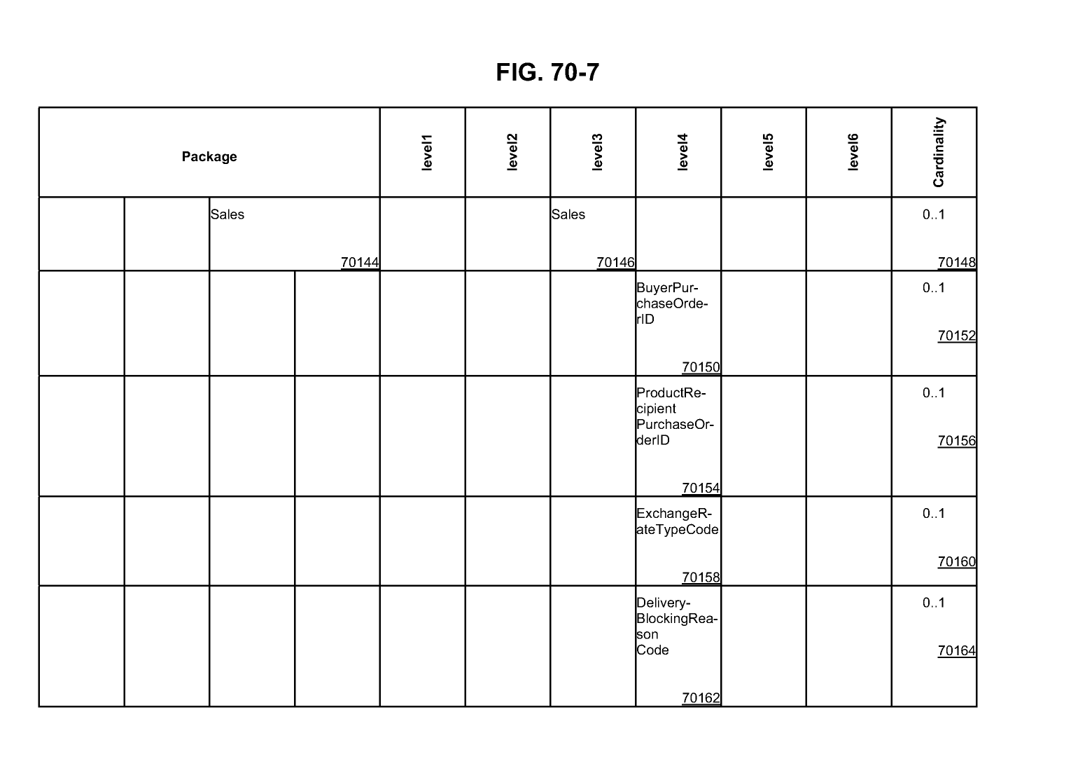

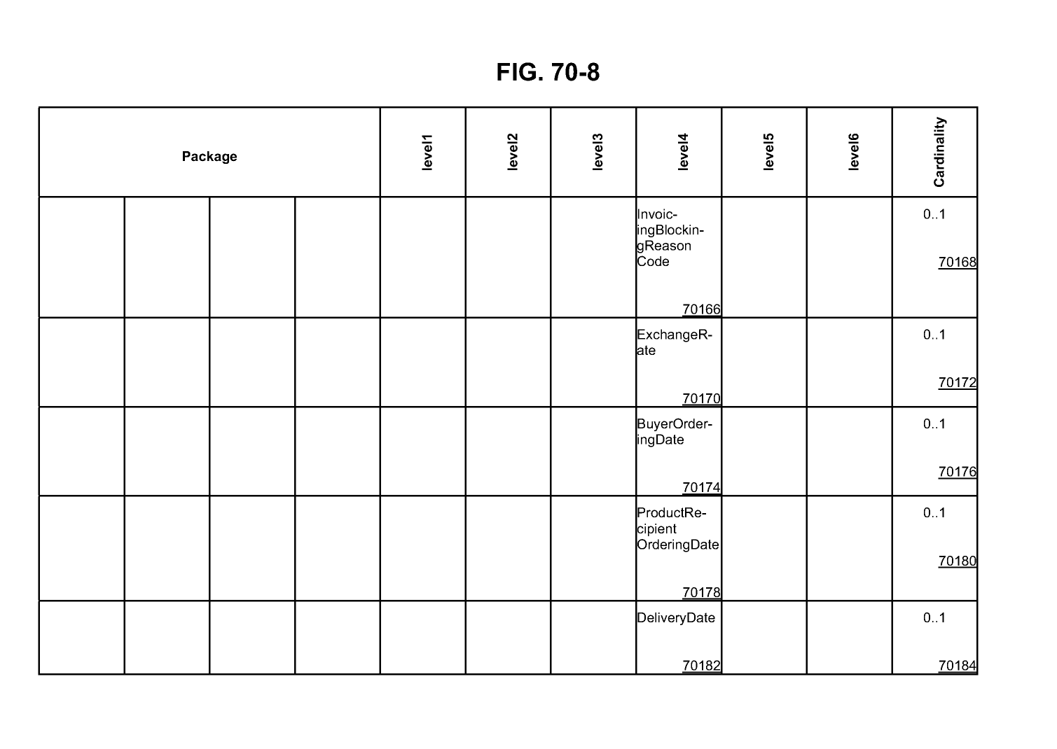

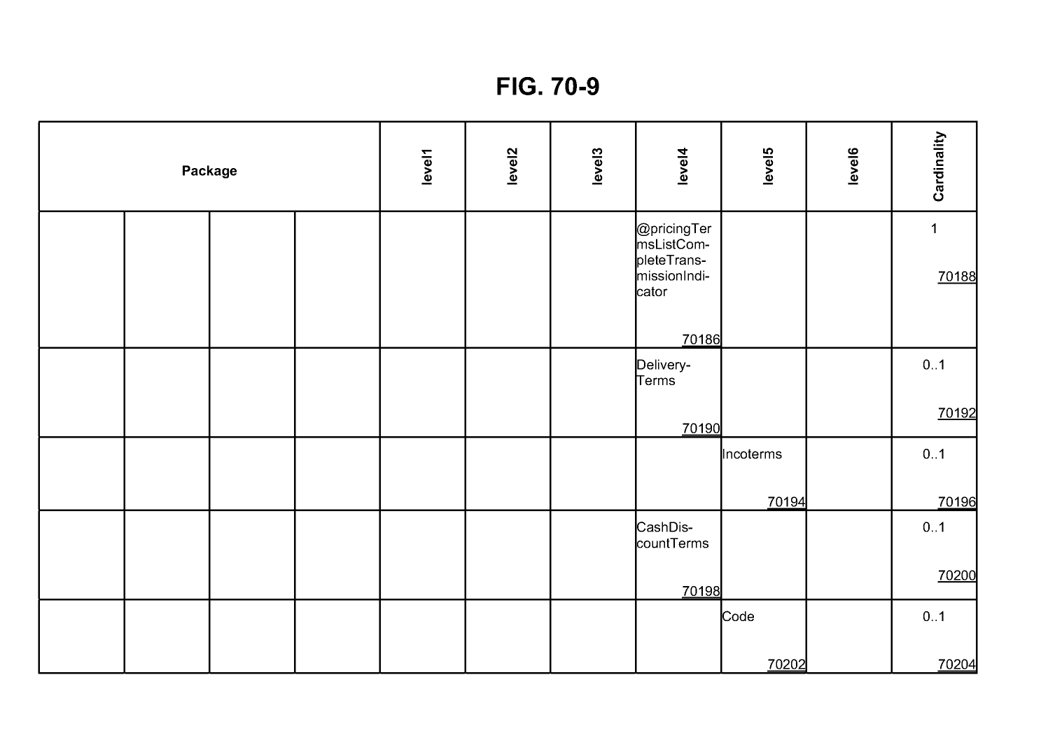

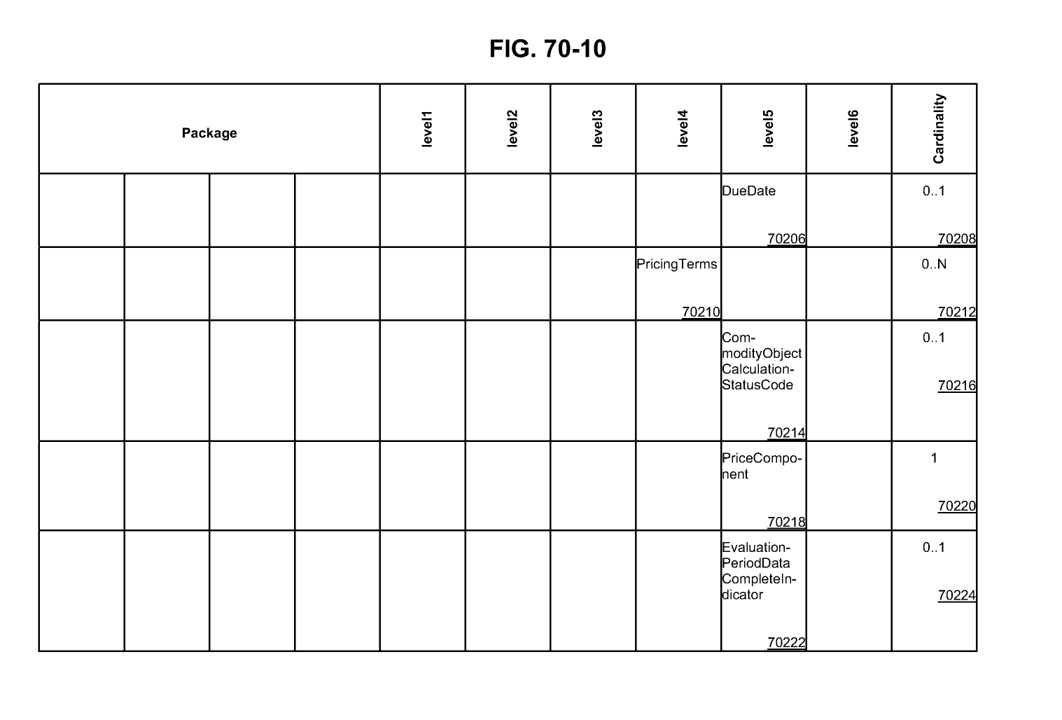

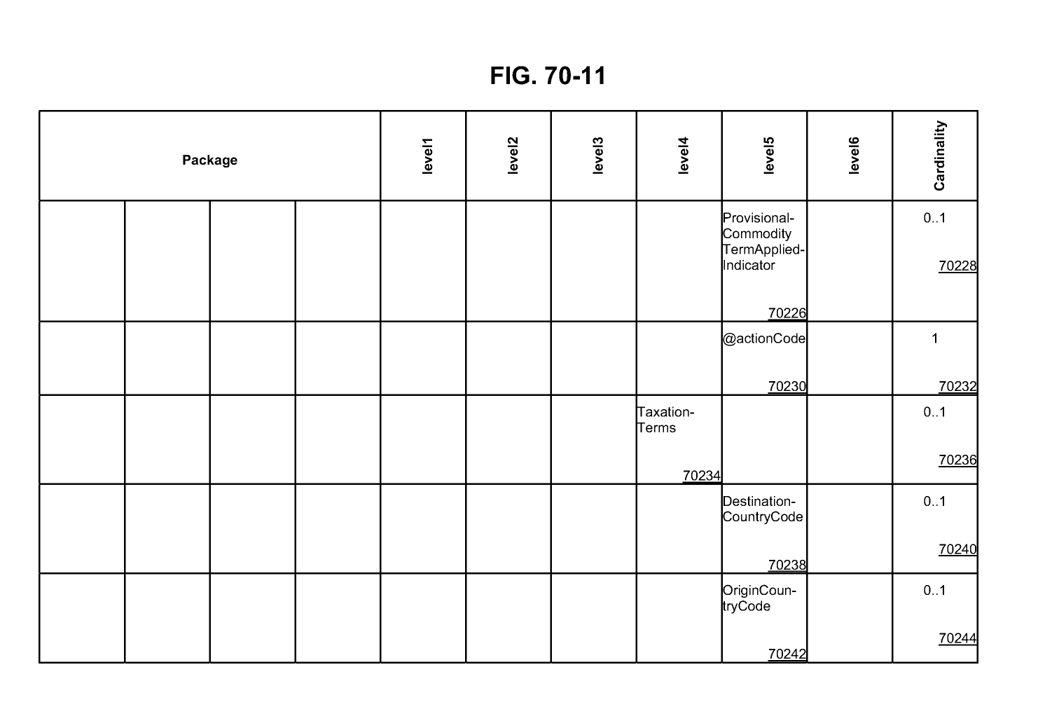

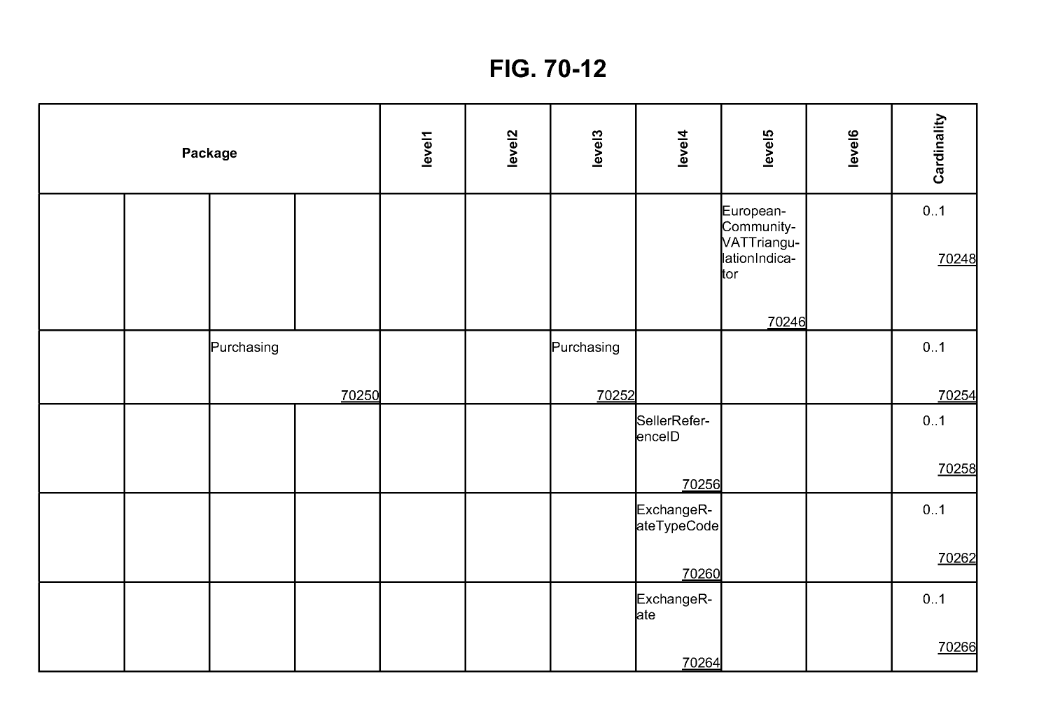

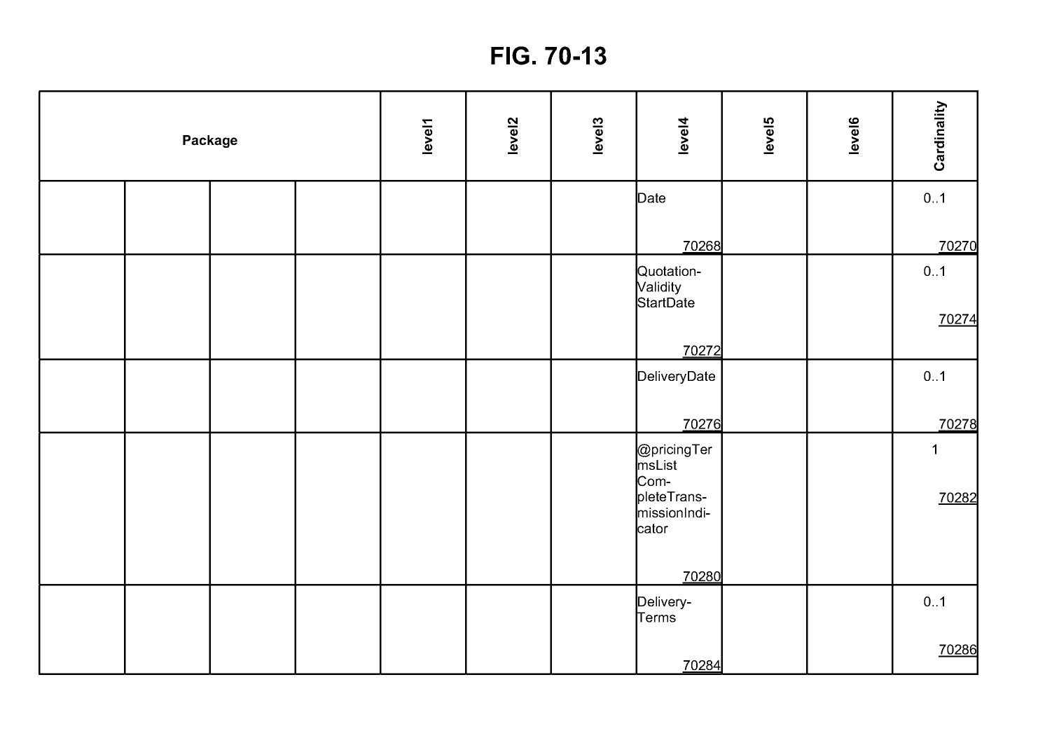

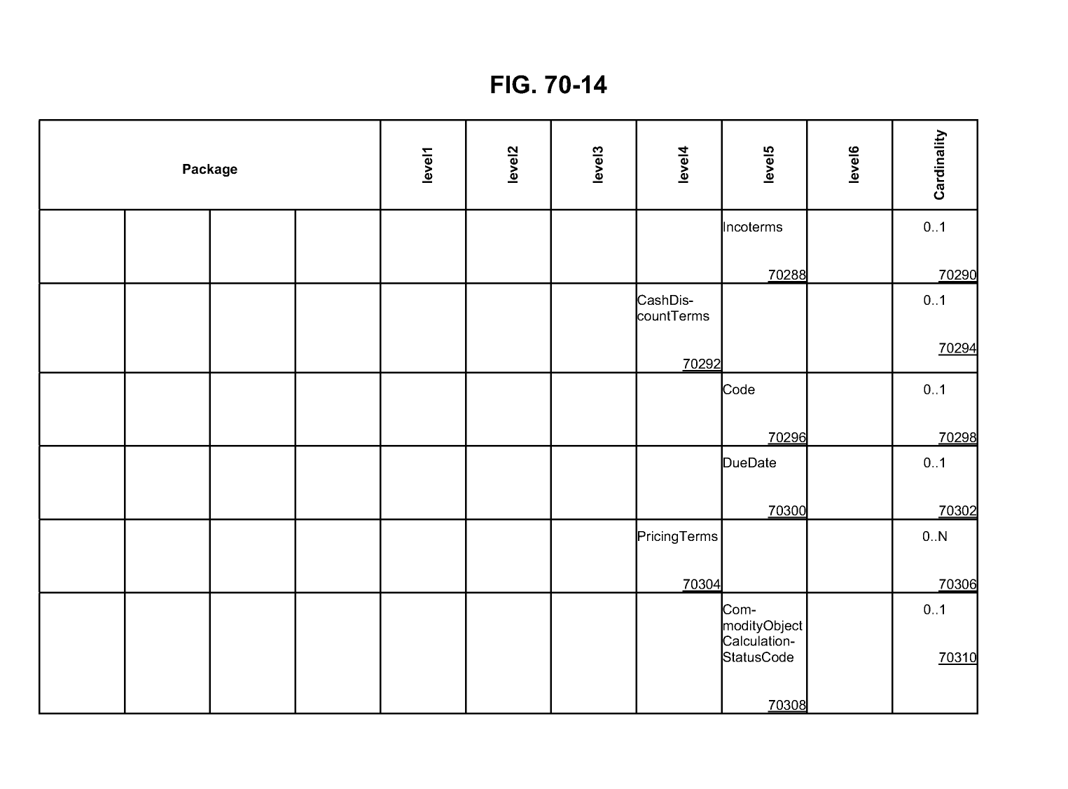

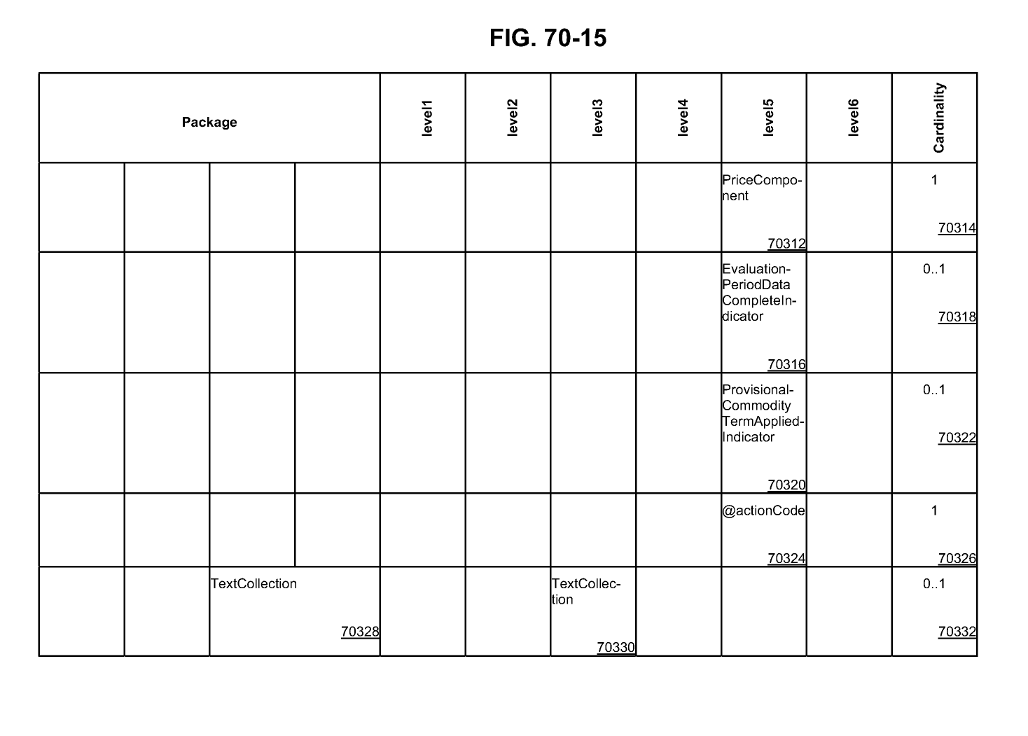

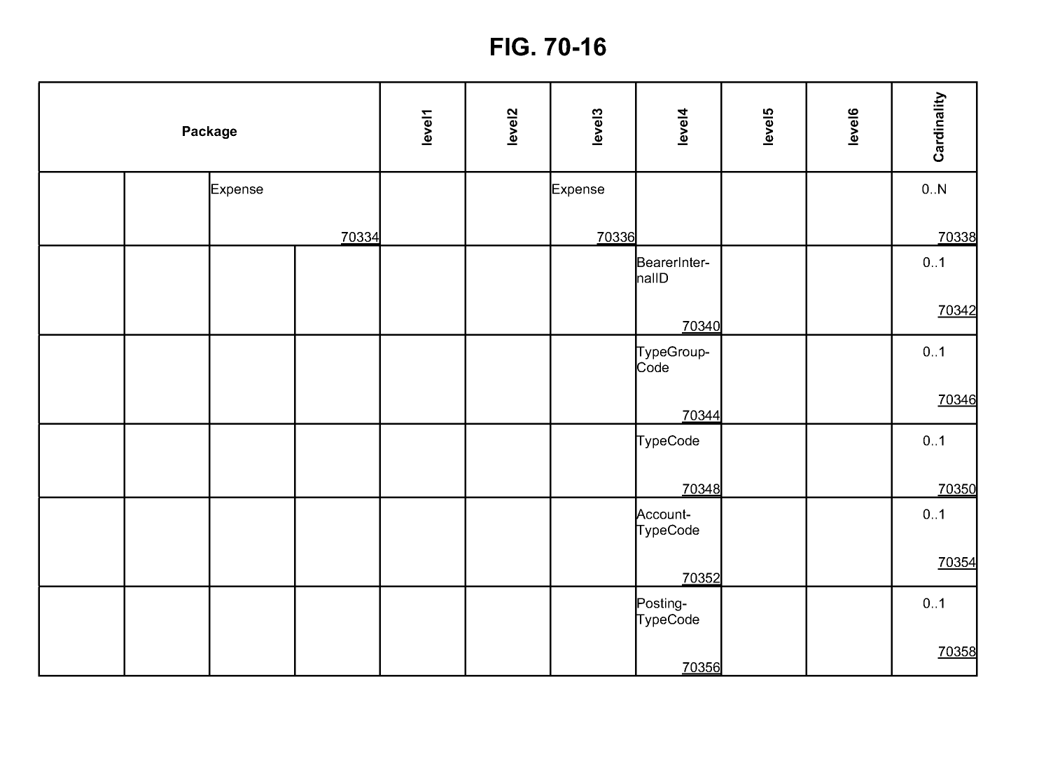

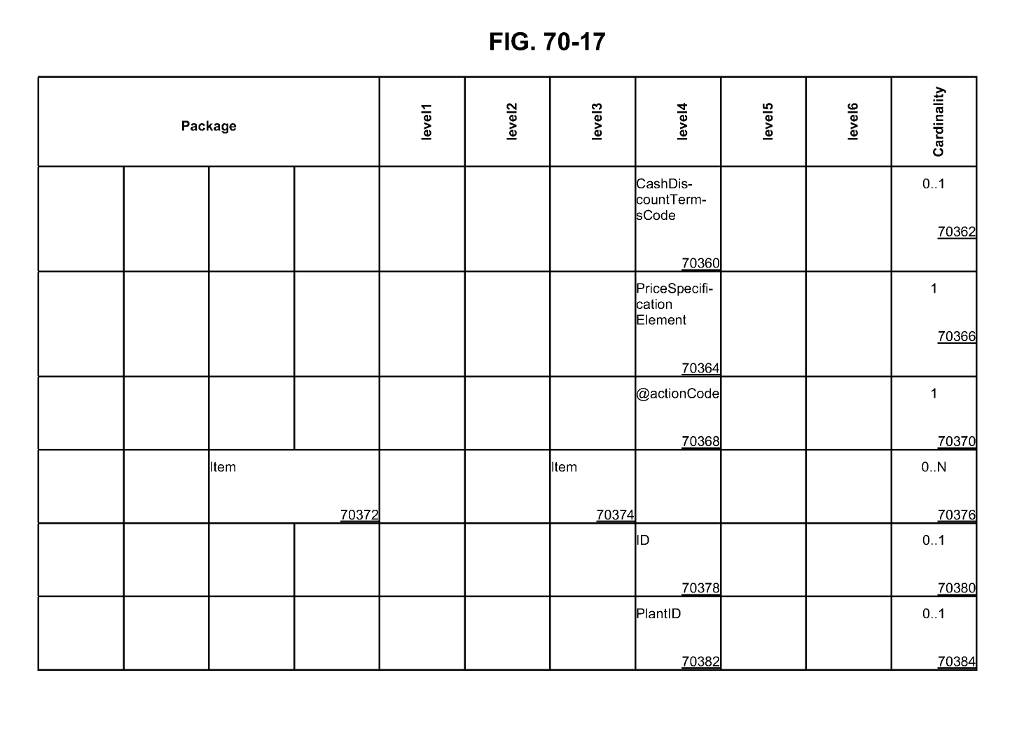

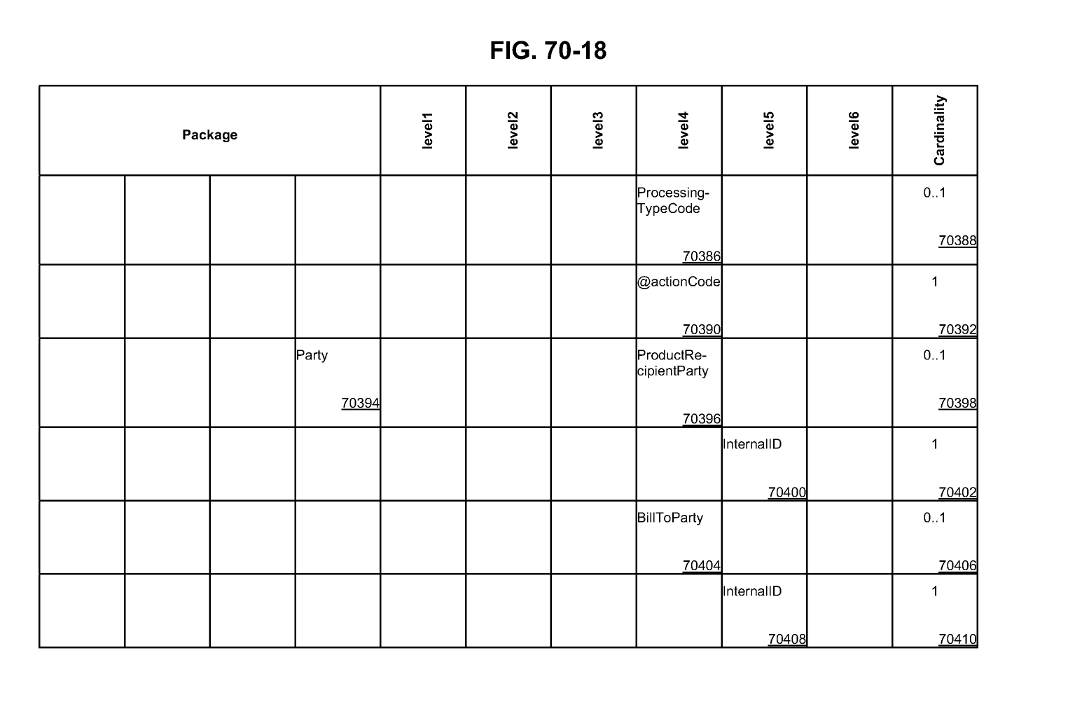

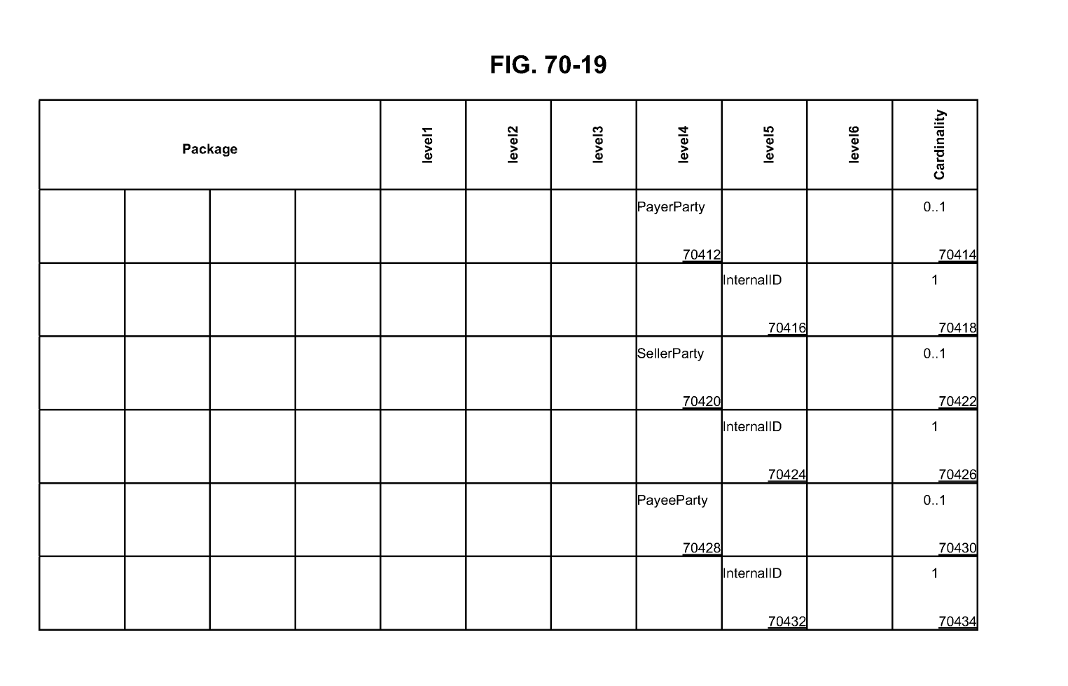

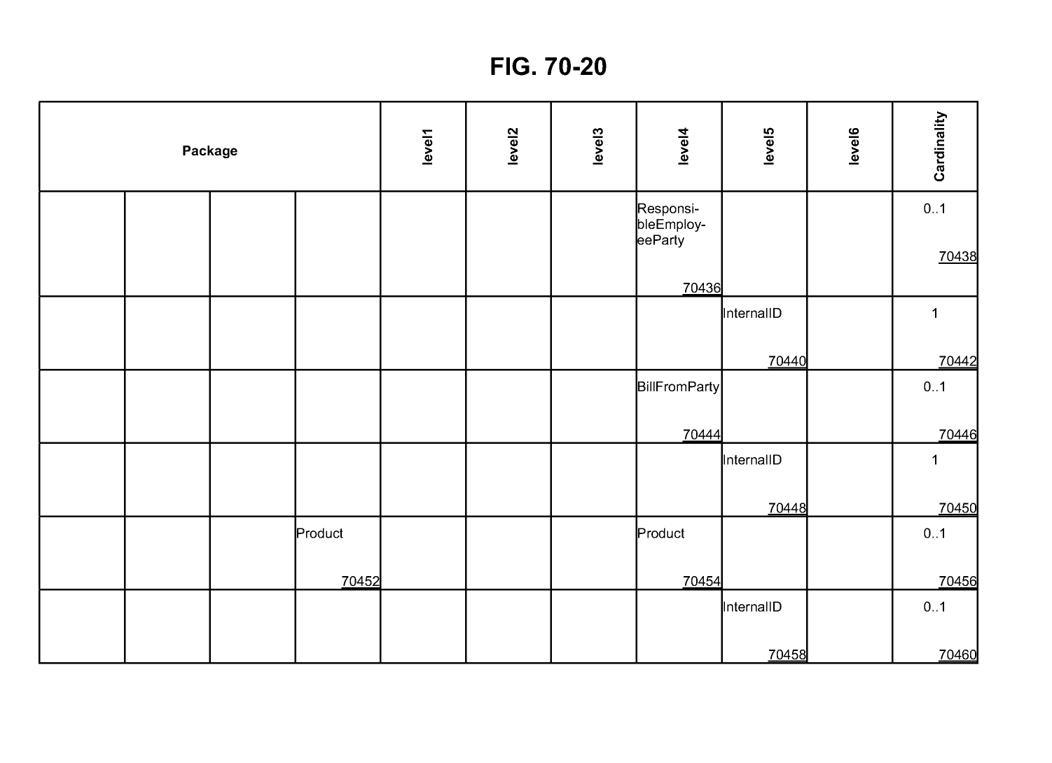

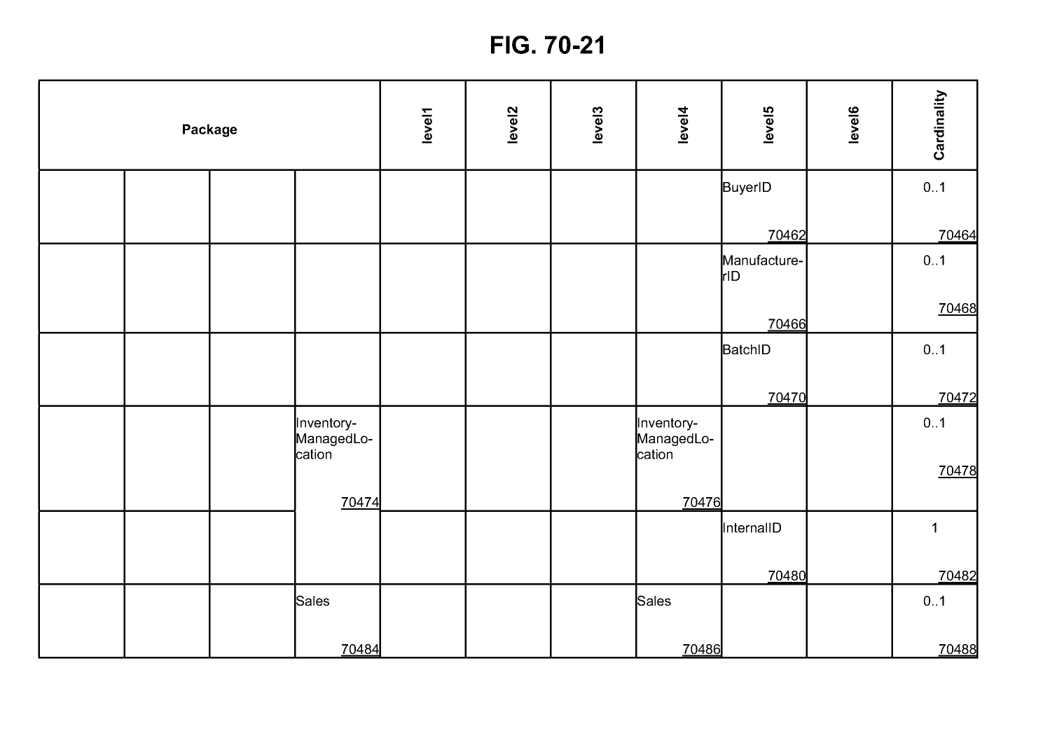

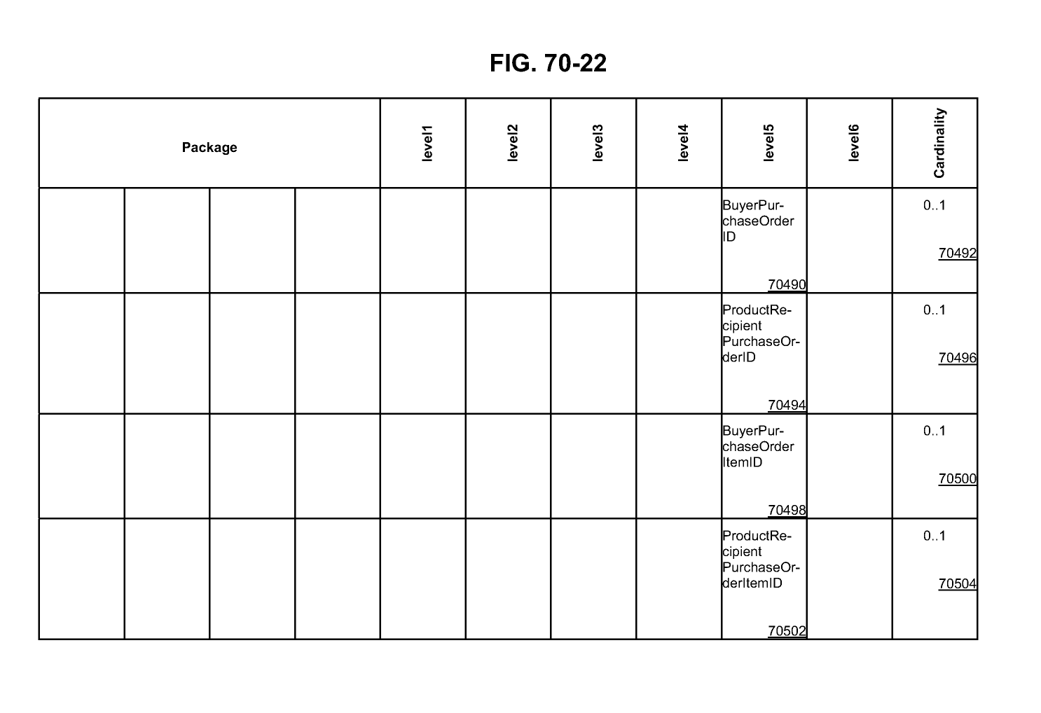

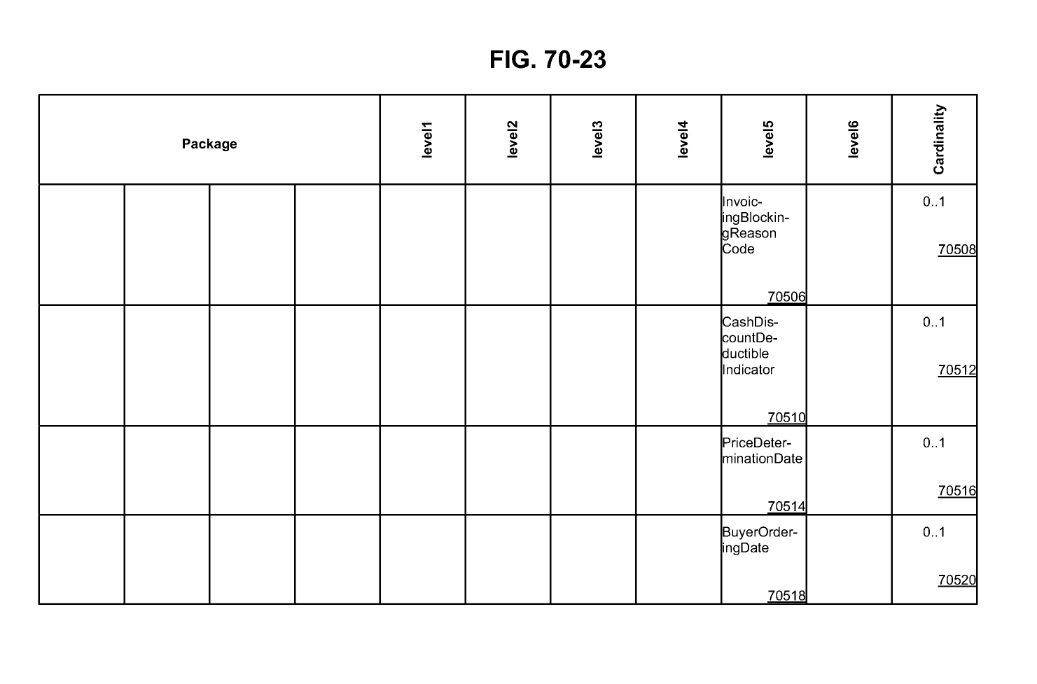

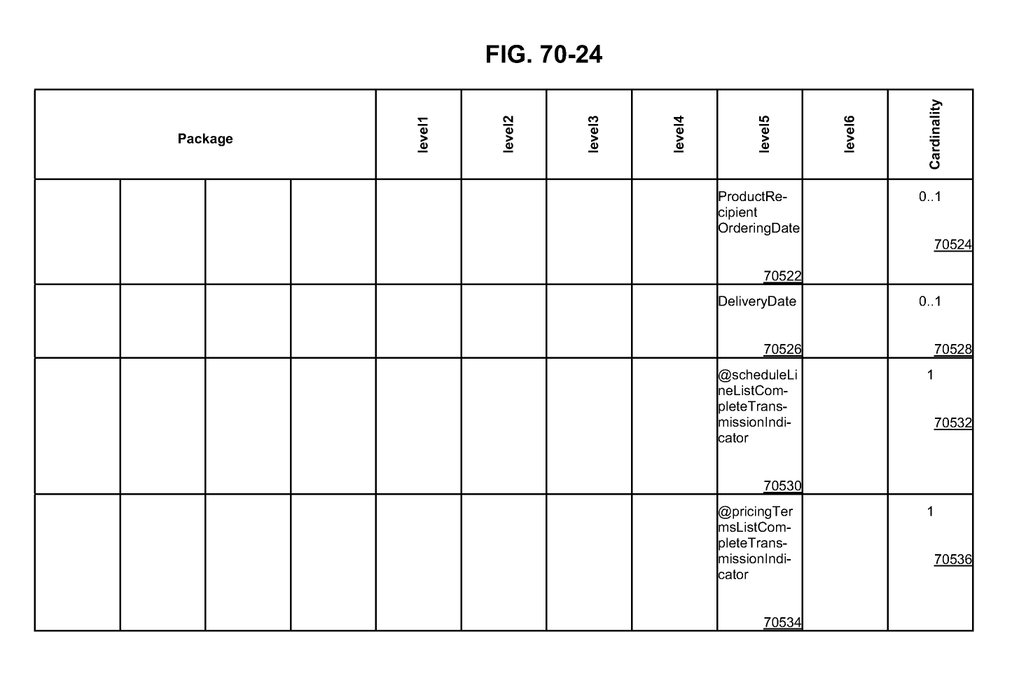

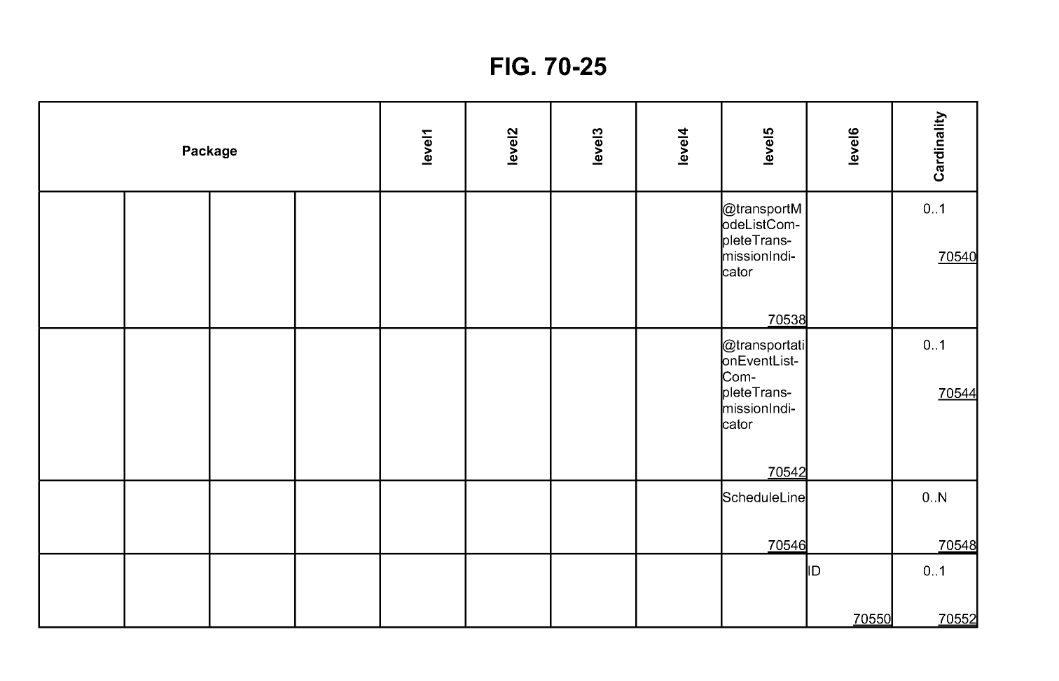

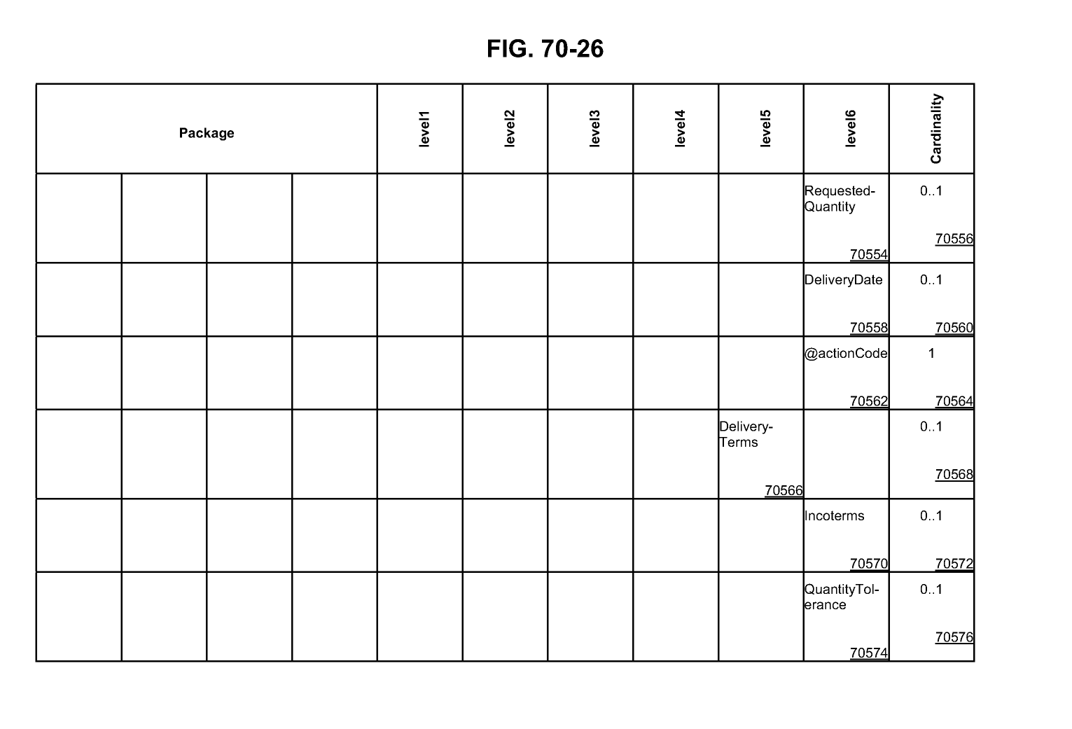

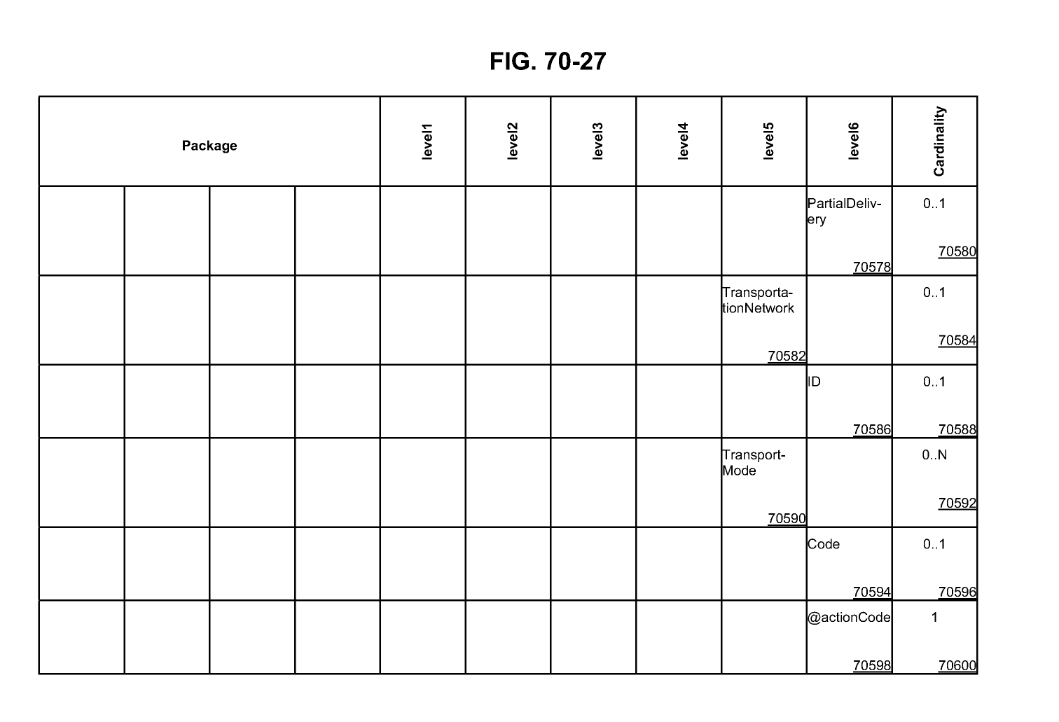

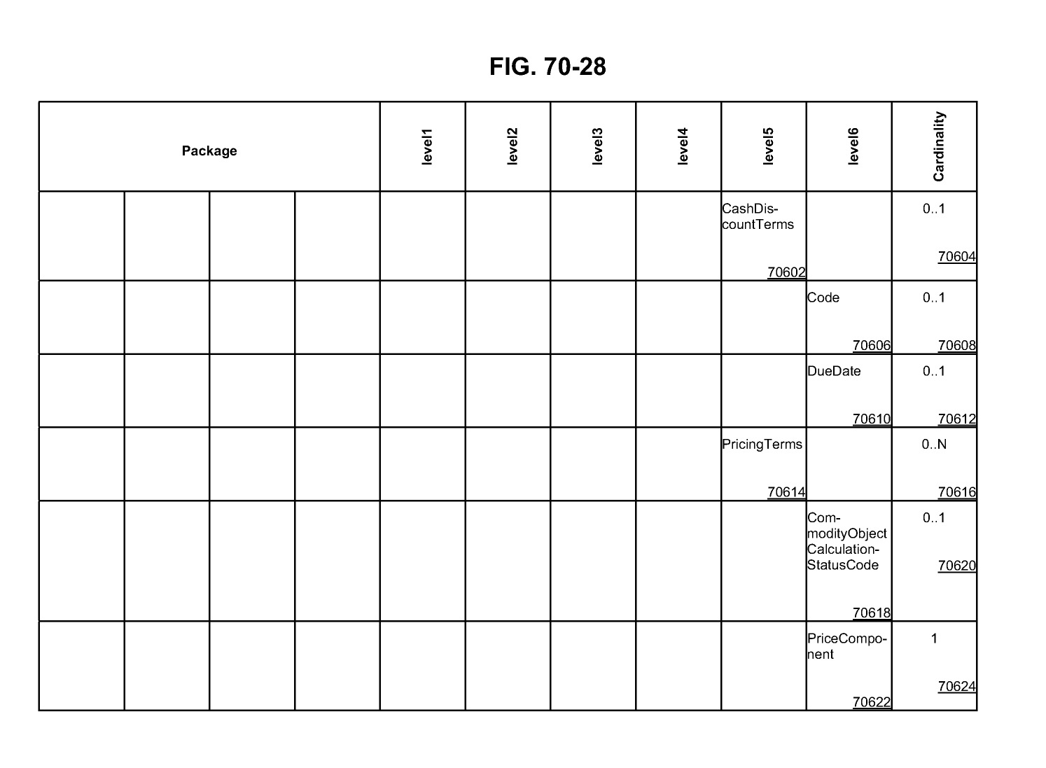

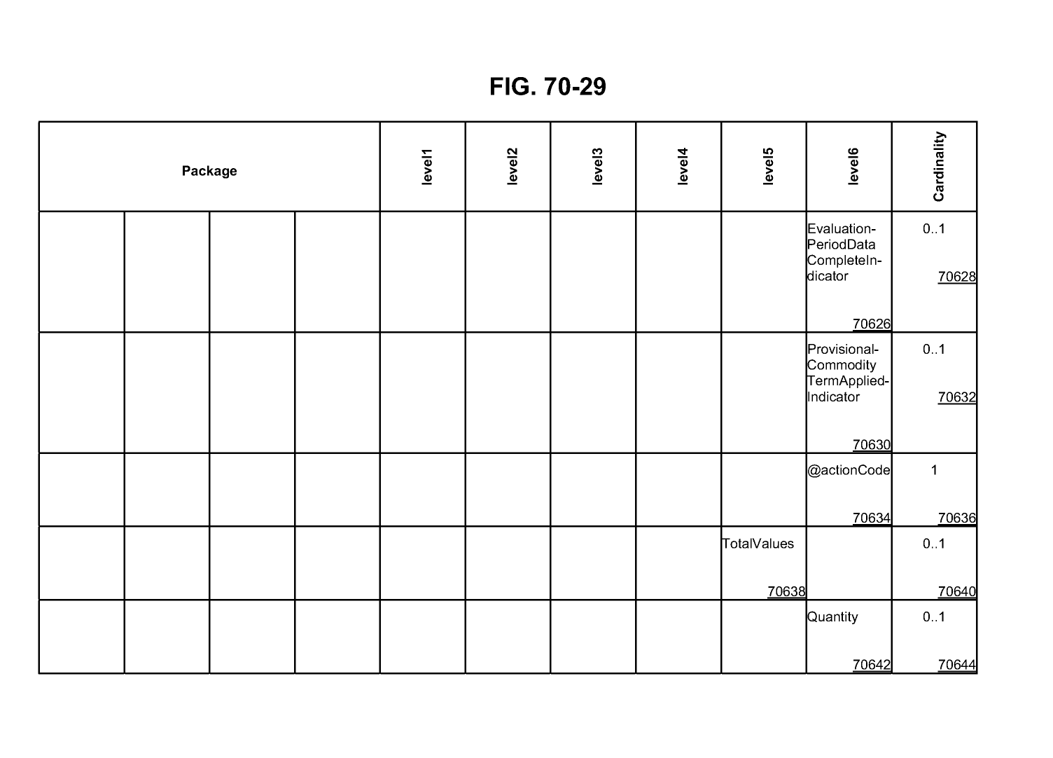

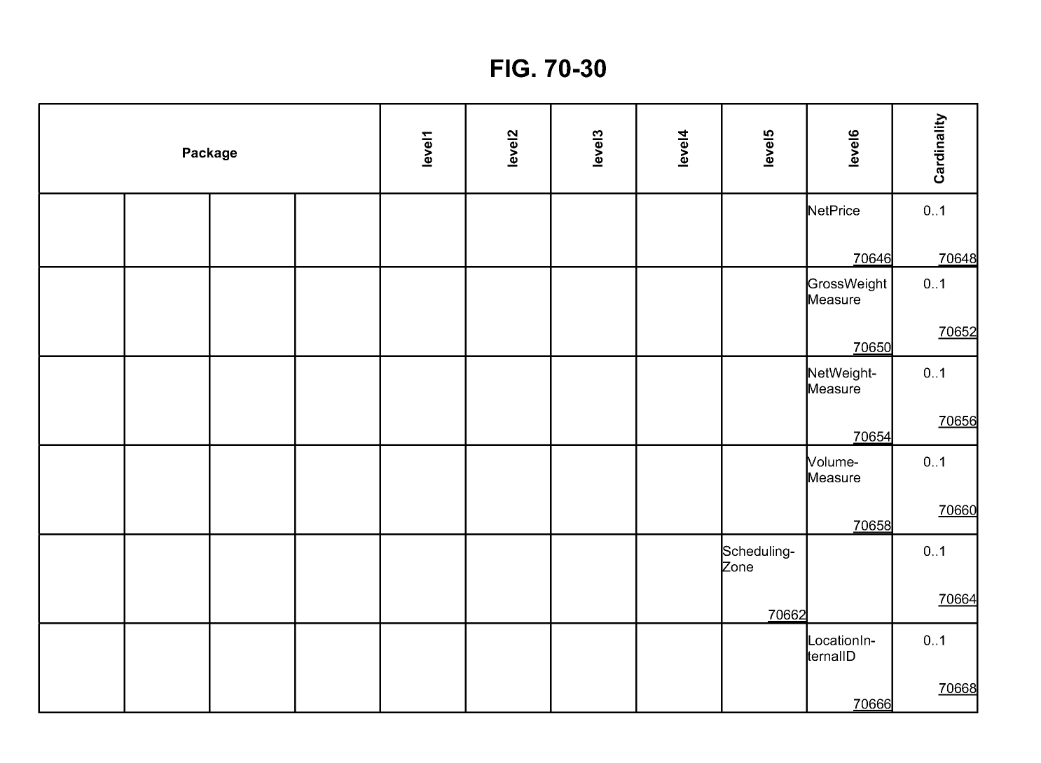

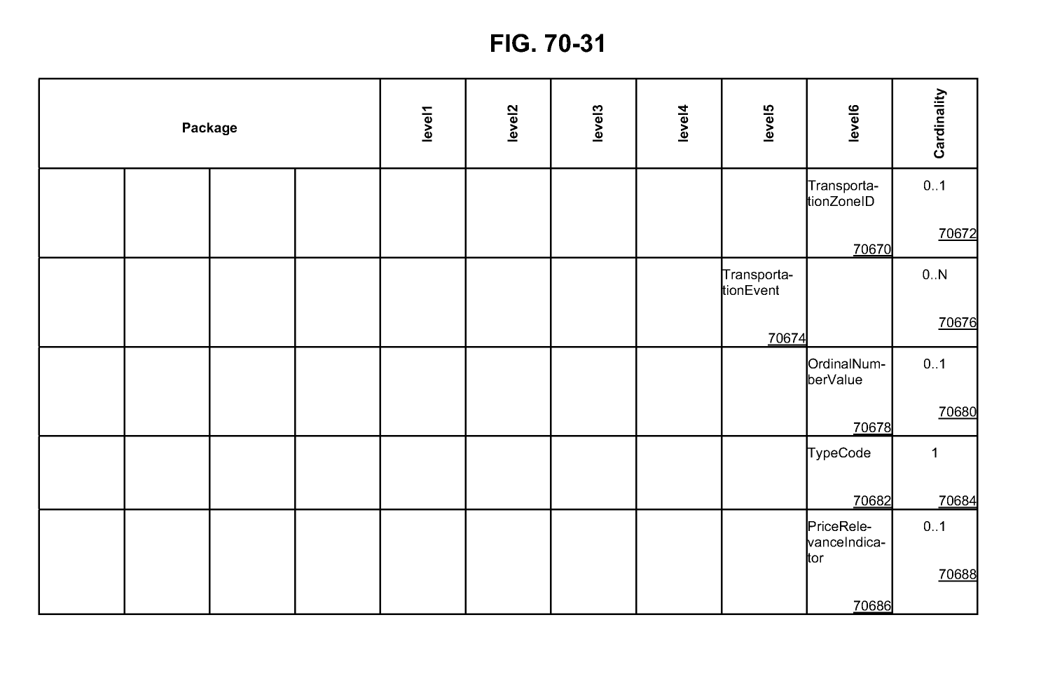

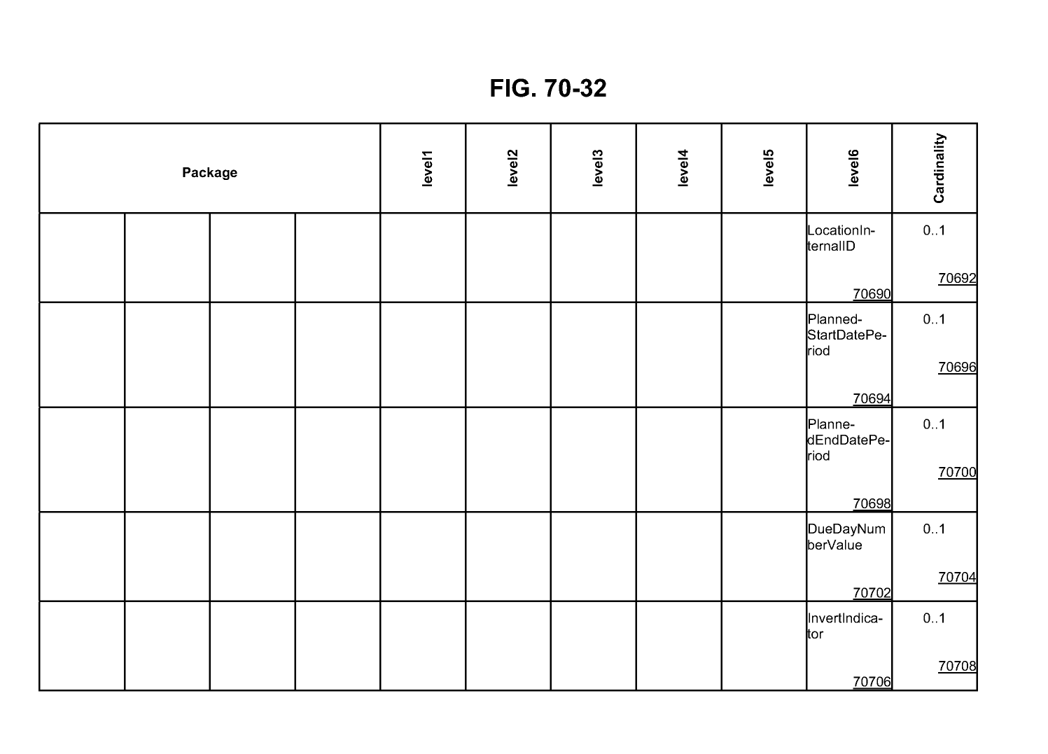

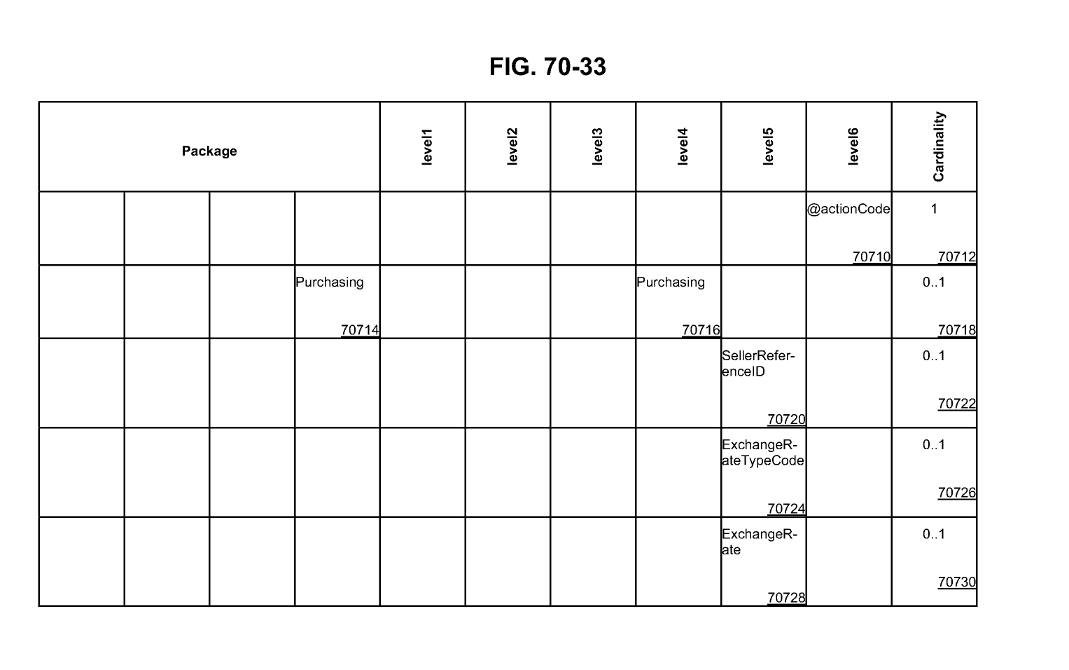

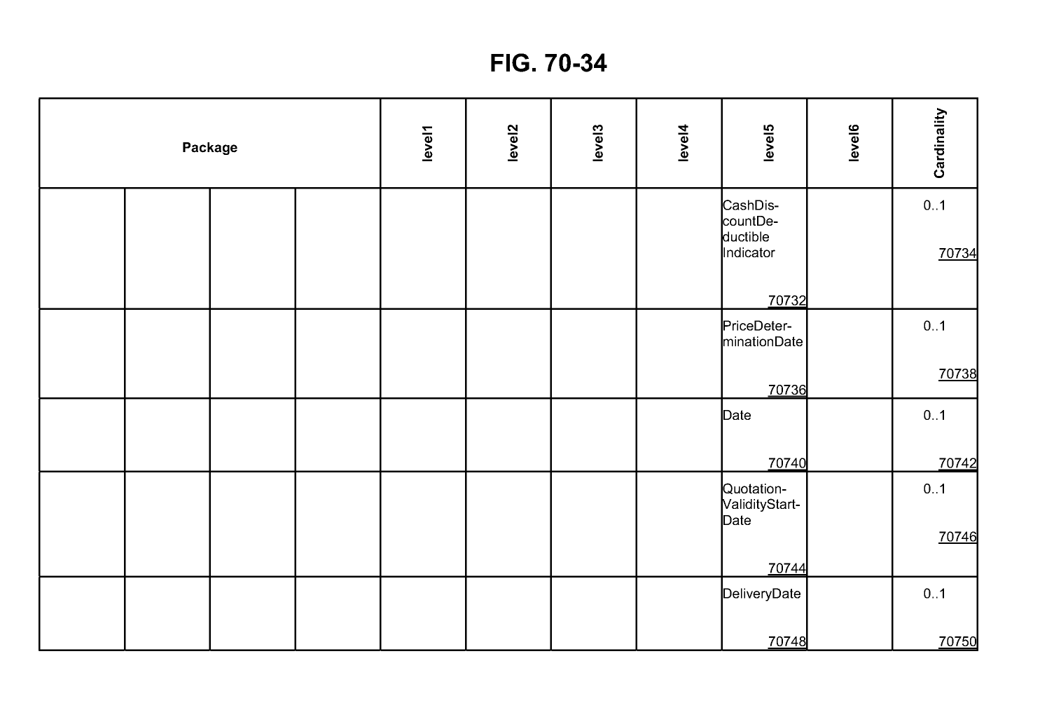

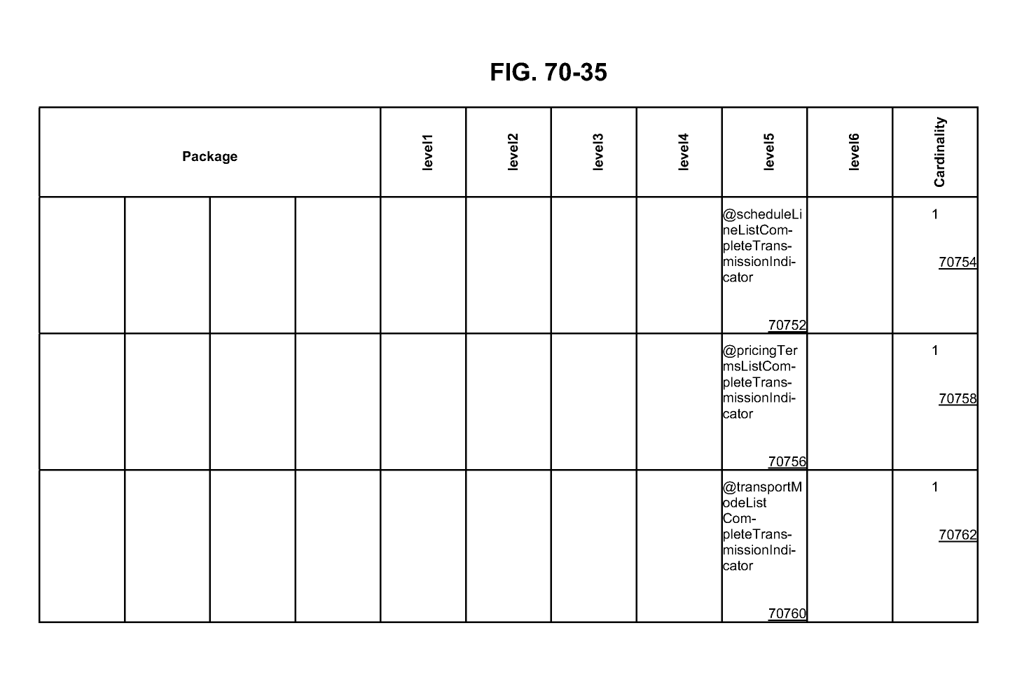

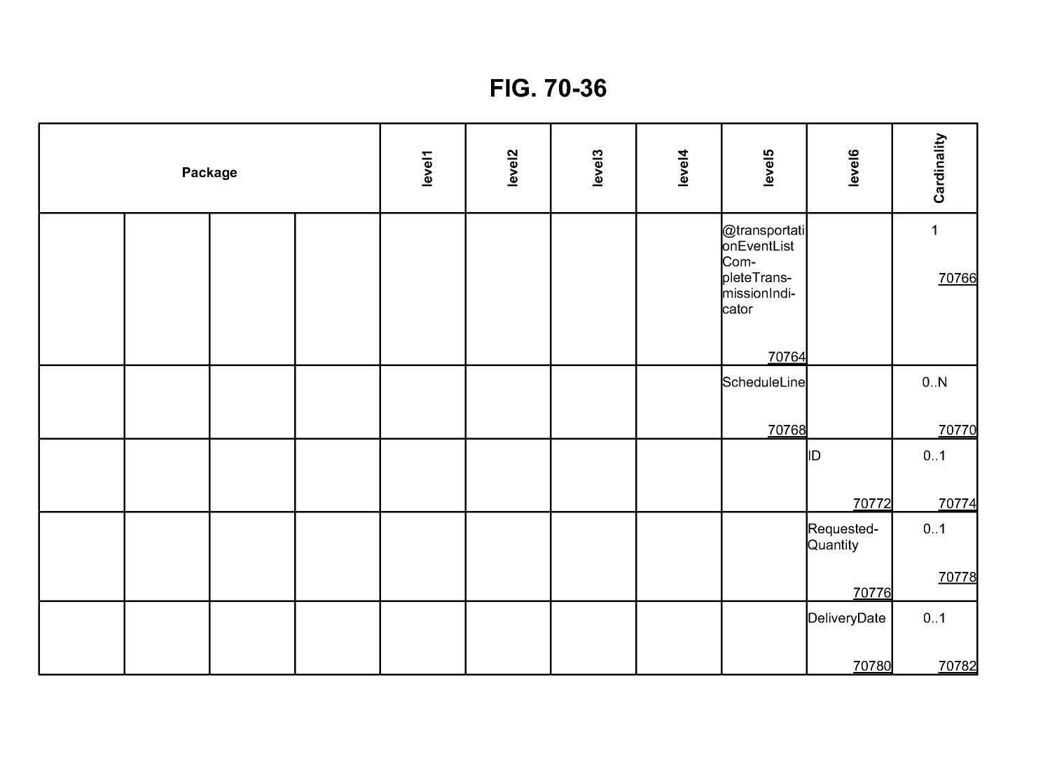

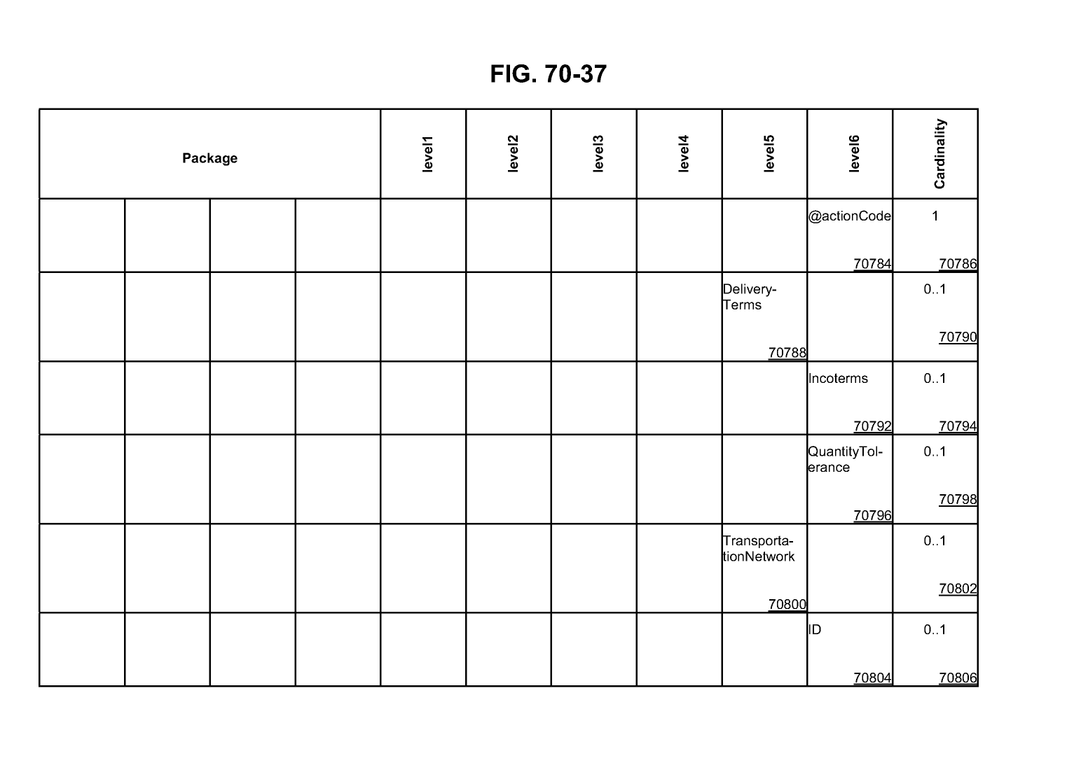

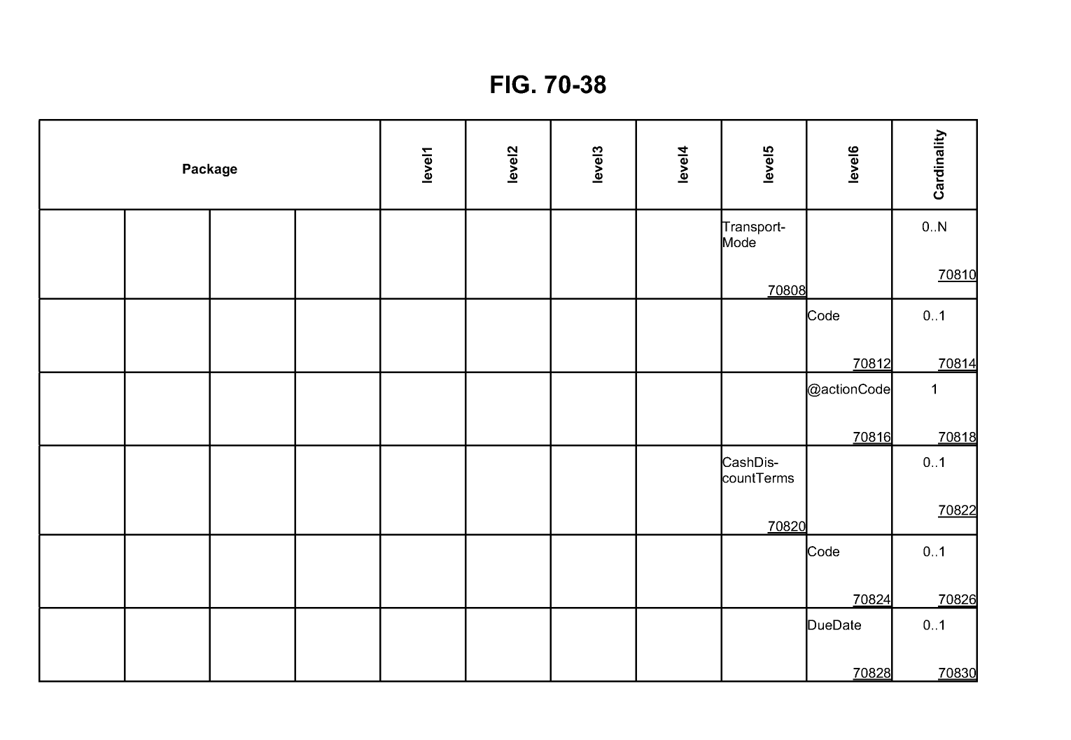

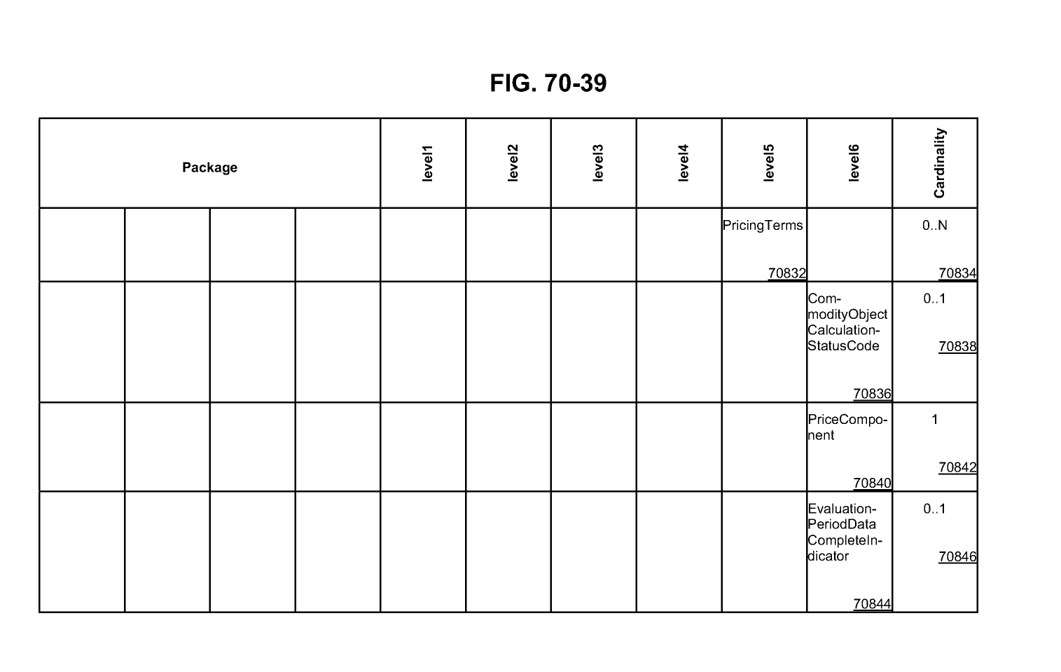

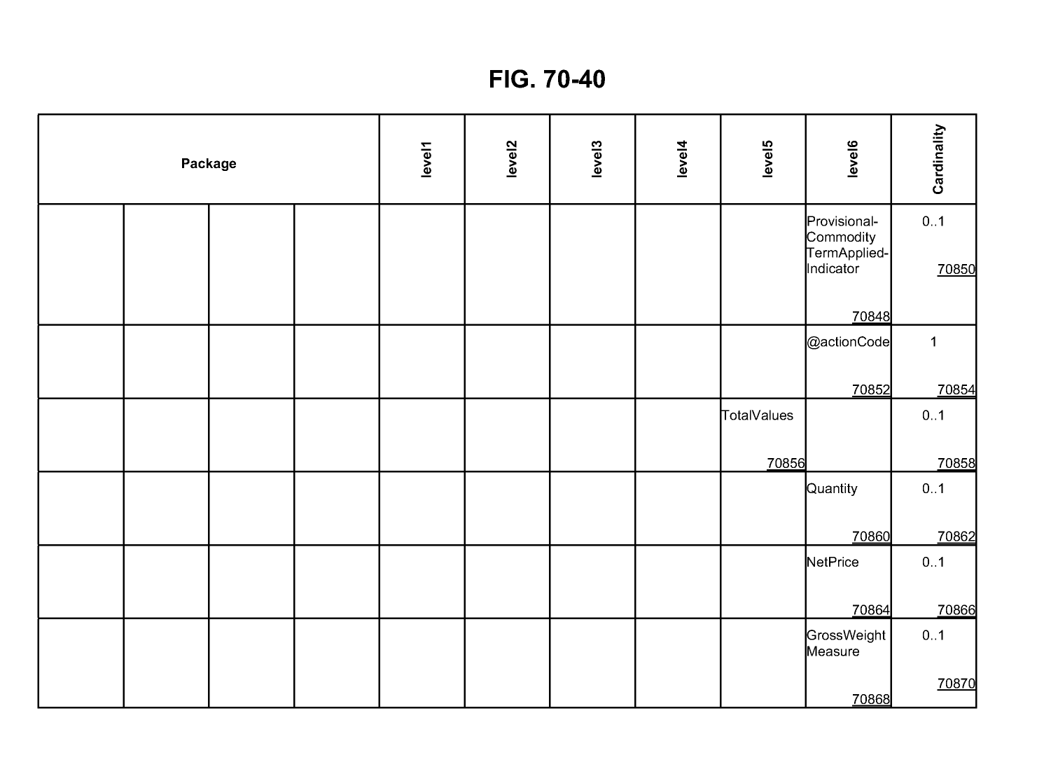

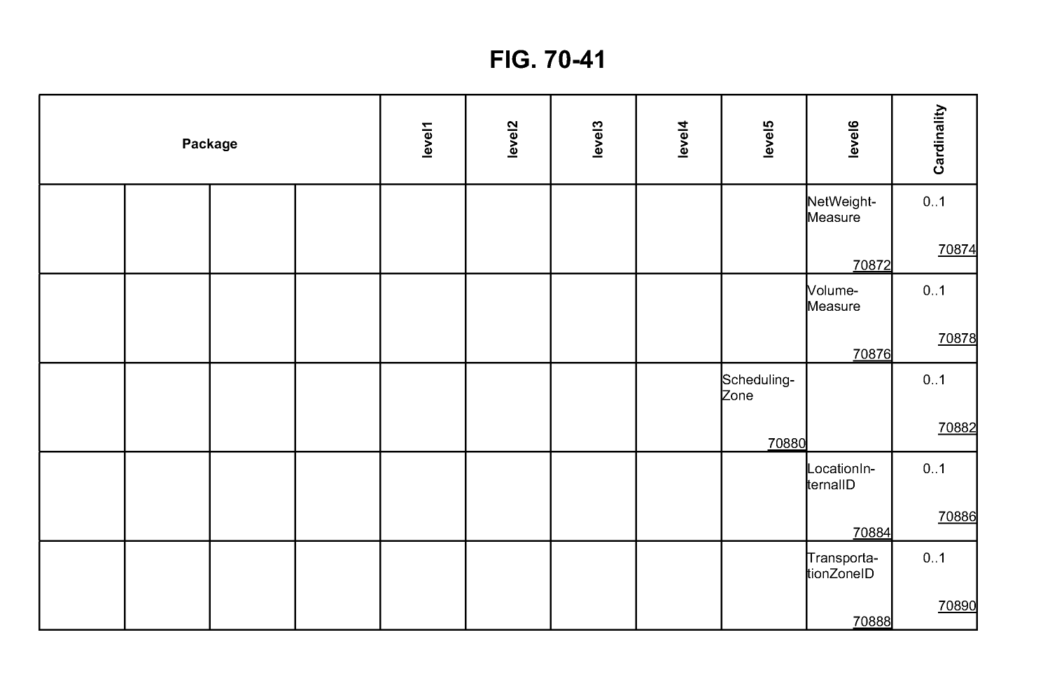

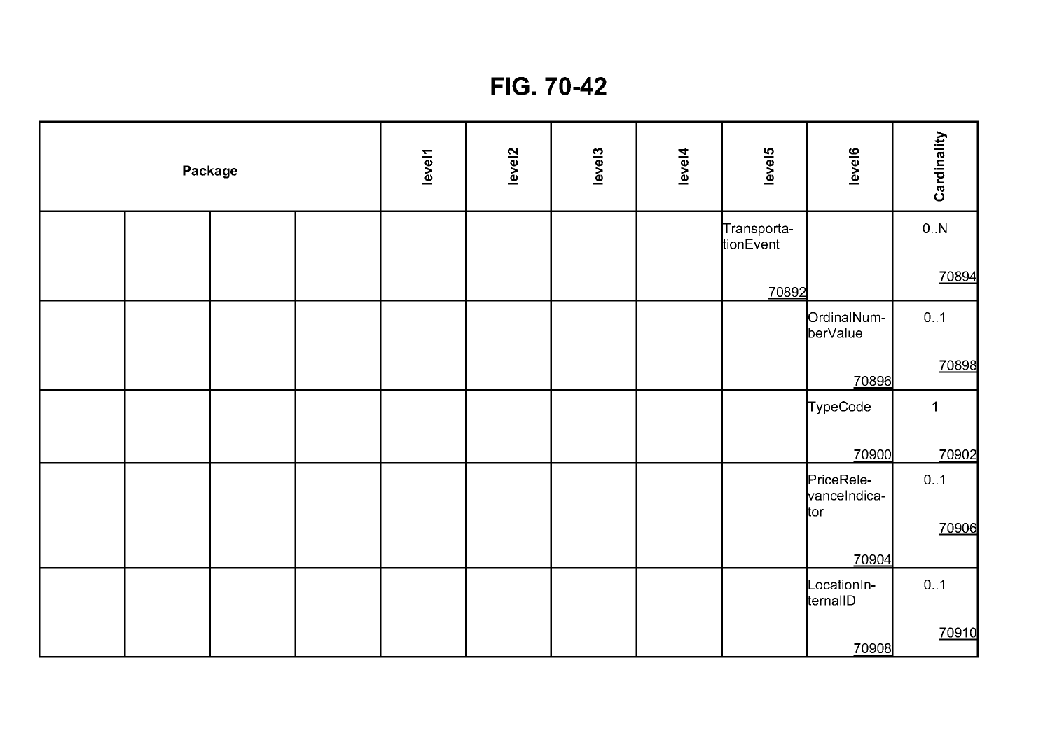

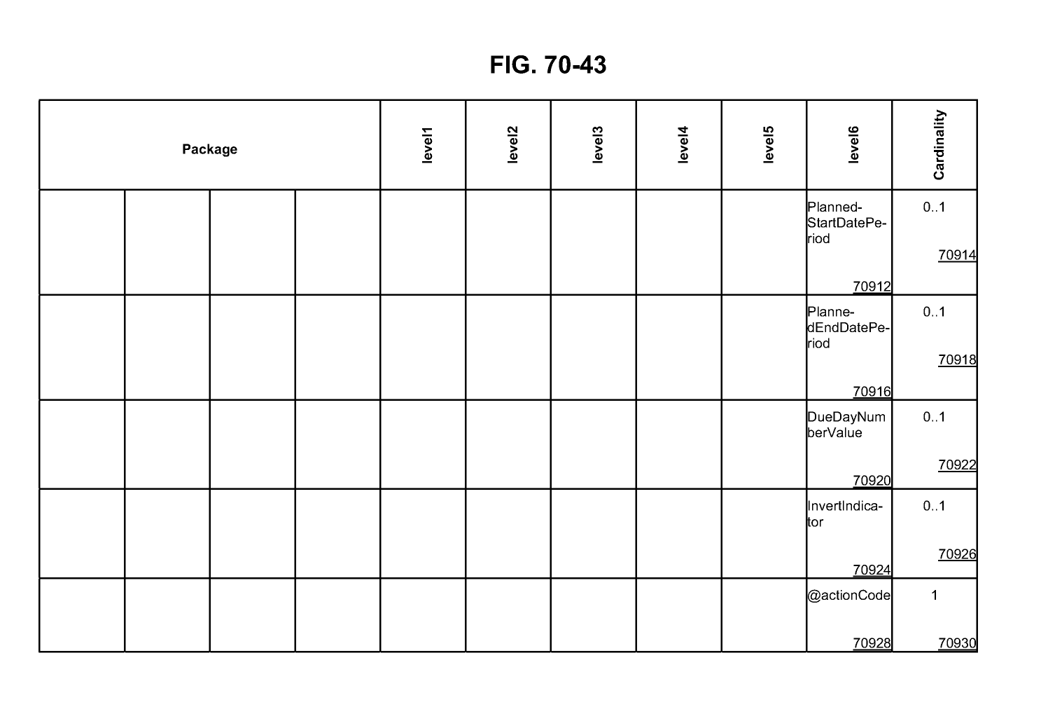

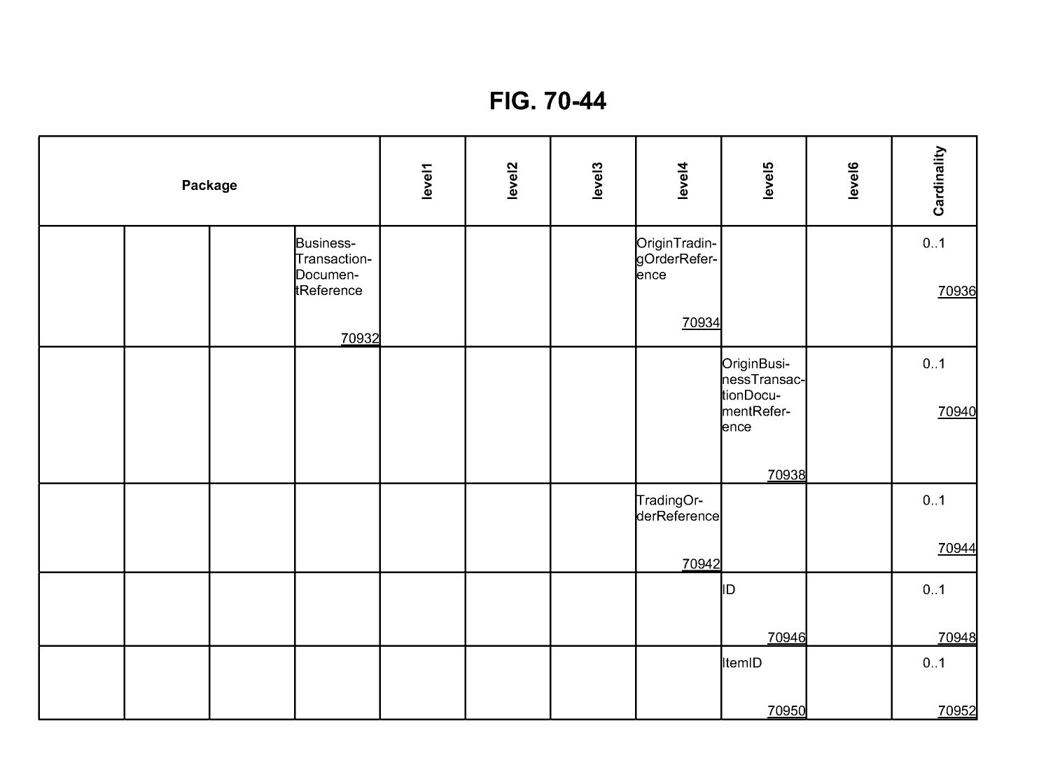

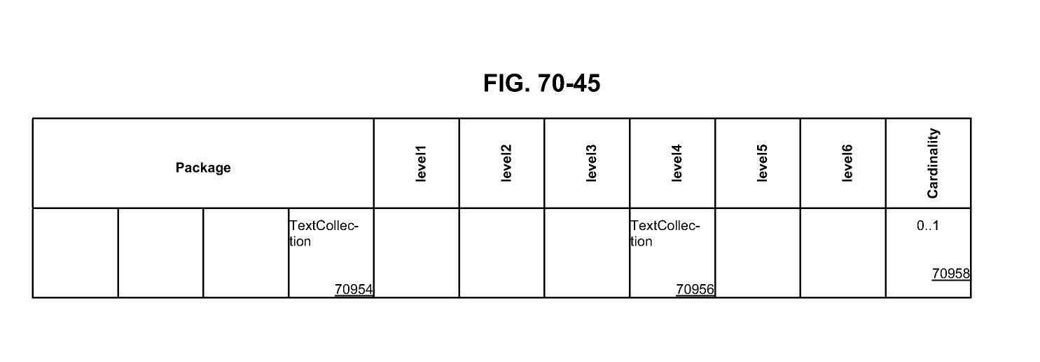

FIGS. 70-1 through 70-45 illustrate one example logical configuration of a TradingOrderERPUpdateRequestMessage_sync 70000 element structure. Specifically, these figures depict the arrangement and hierarchy of various components such as one or more levels of packages, entities, and datatypes, shown here as 70000 through 70958. As described above, packages may be used to represent hierarchy levels. Entities are discrete business elements that are used during a business transaction. Data types are used to type object entities and interfaces with a structure. For example, the TradingOrderERPUpdateRequestMessage_sync 70000 includes, among other things, a TradingOrderERPUpdateRequestMessage 70002. Accordingly, heterogeneous applications may communicate using this consistent message configured as such. The data types of the various packages, entities, and attributes are described with respect to FIG. 58.

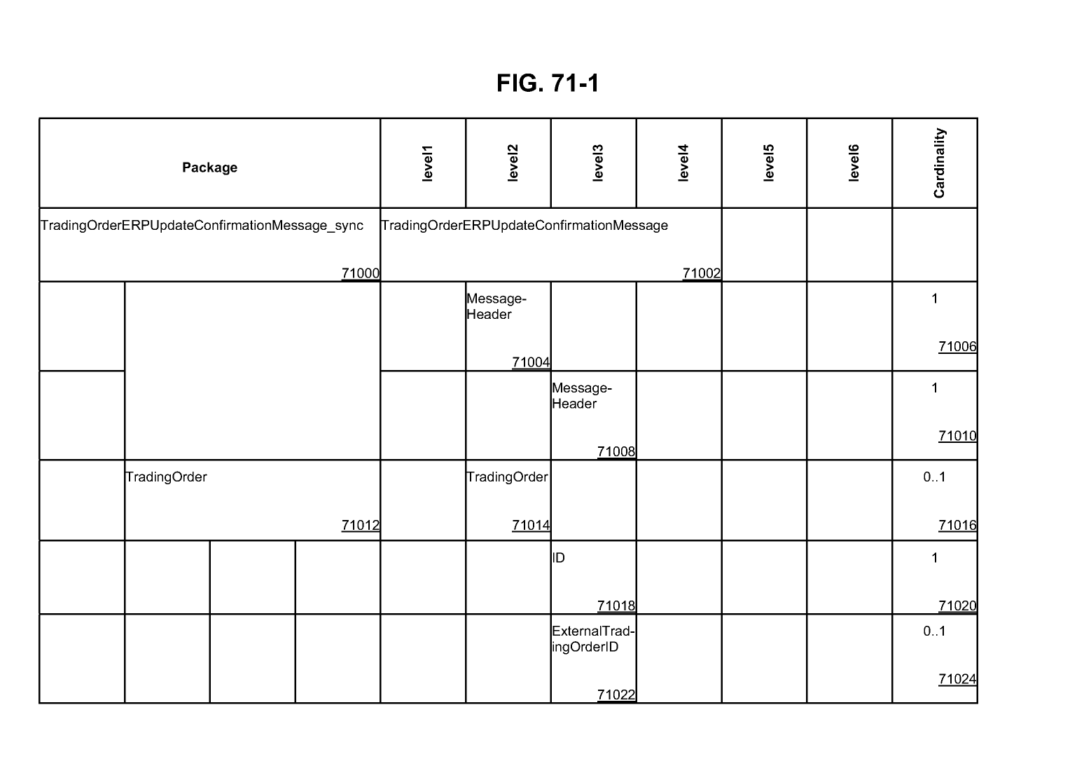

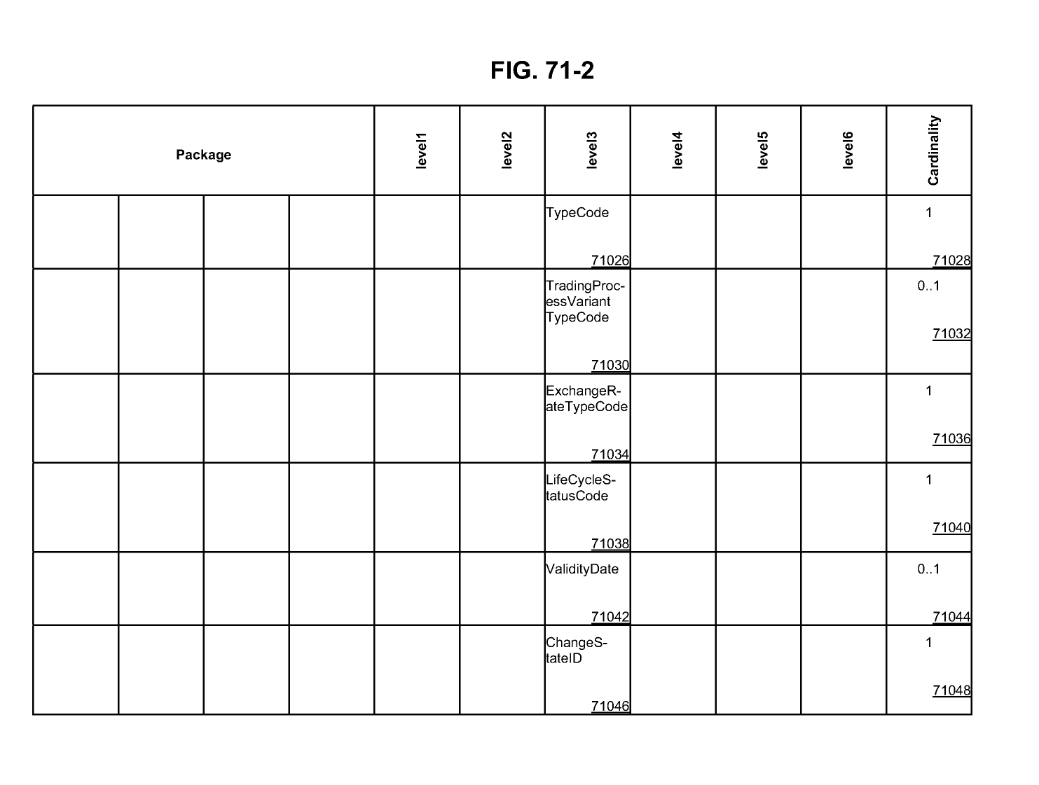

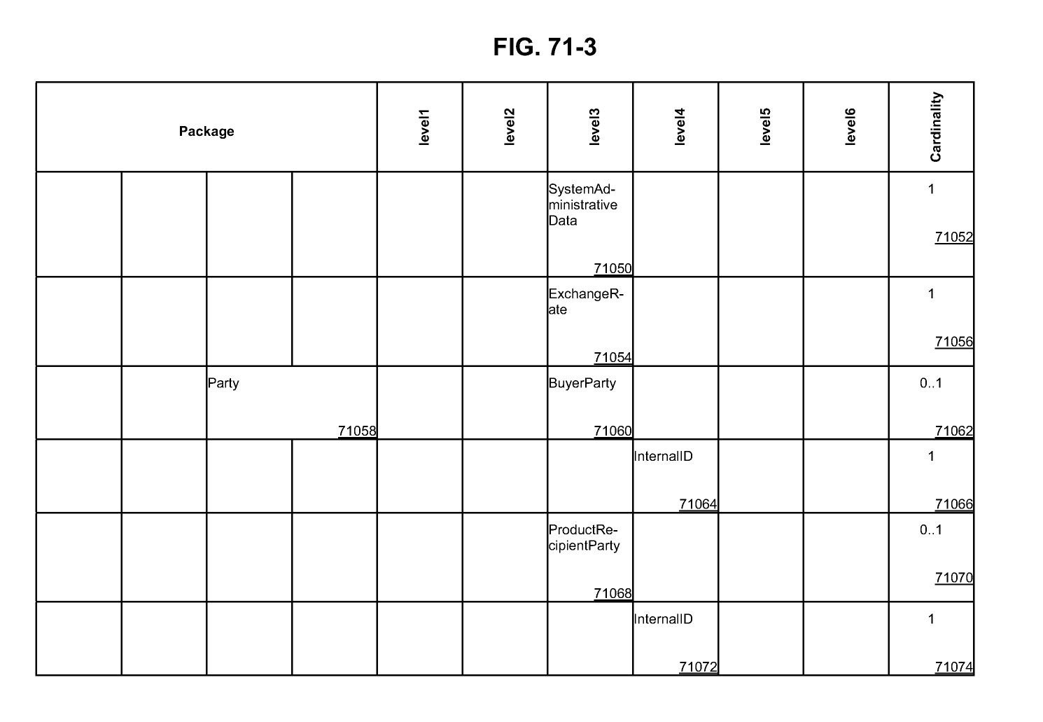

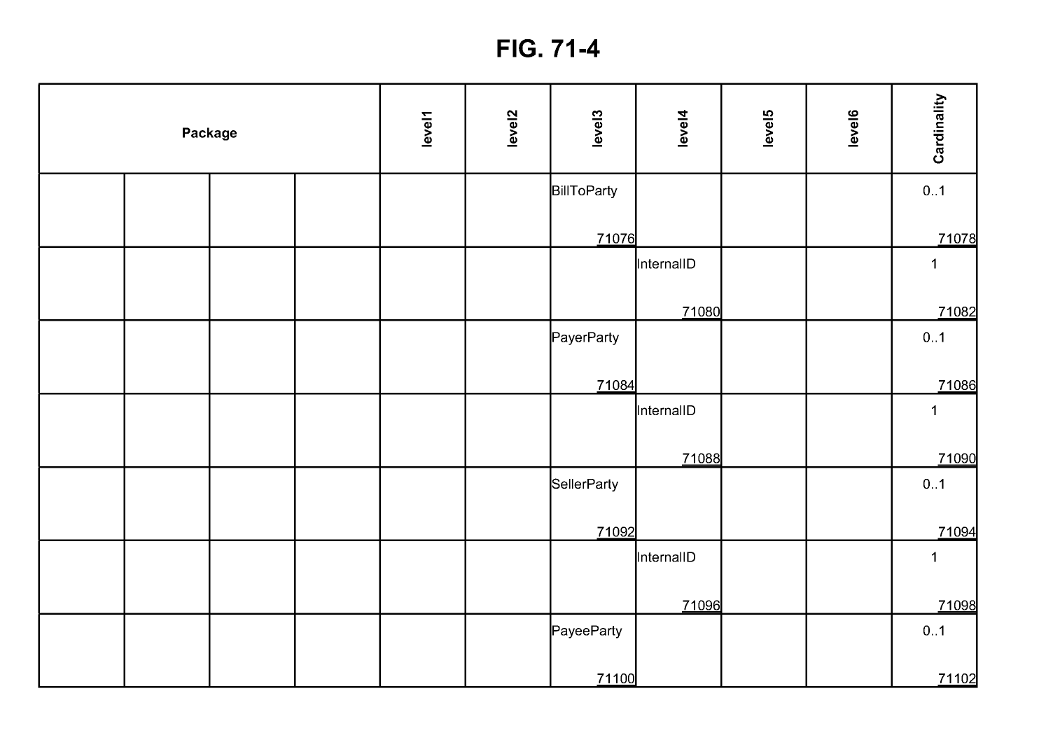

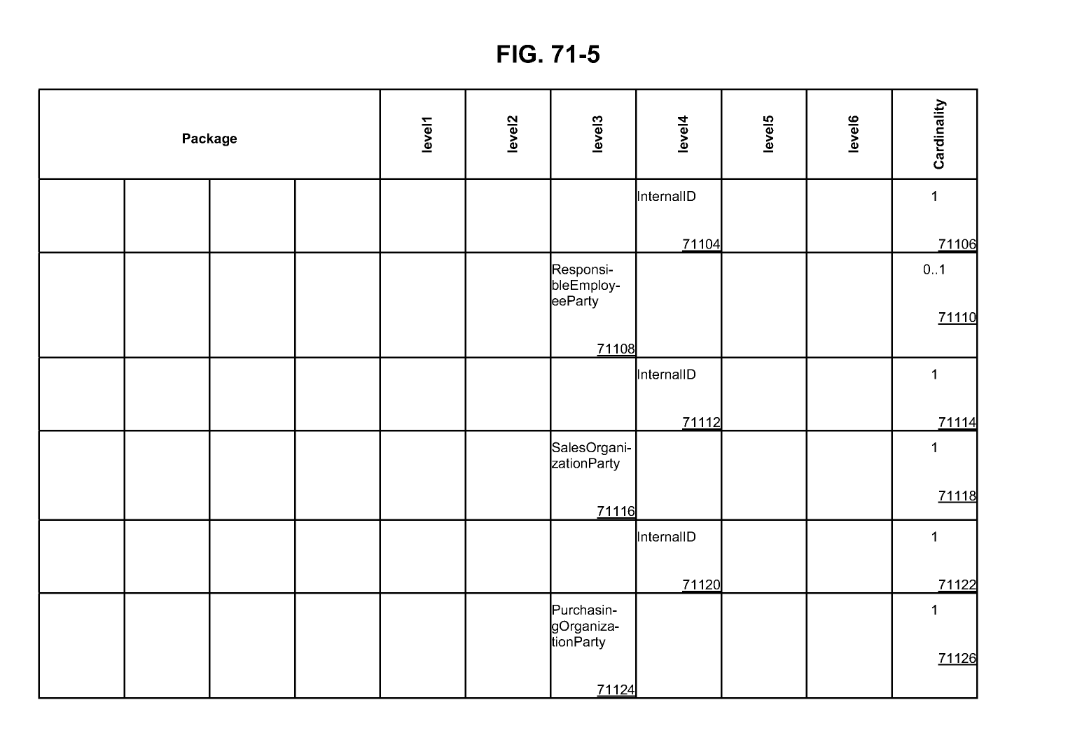

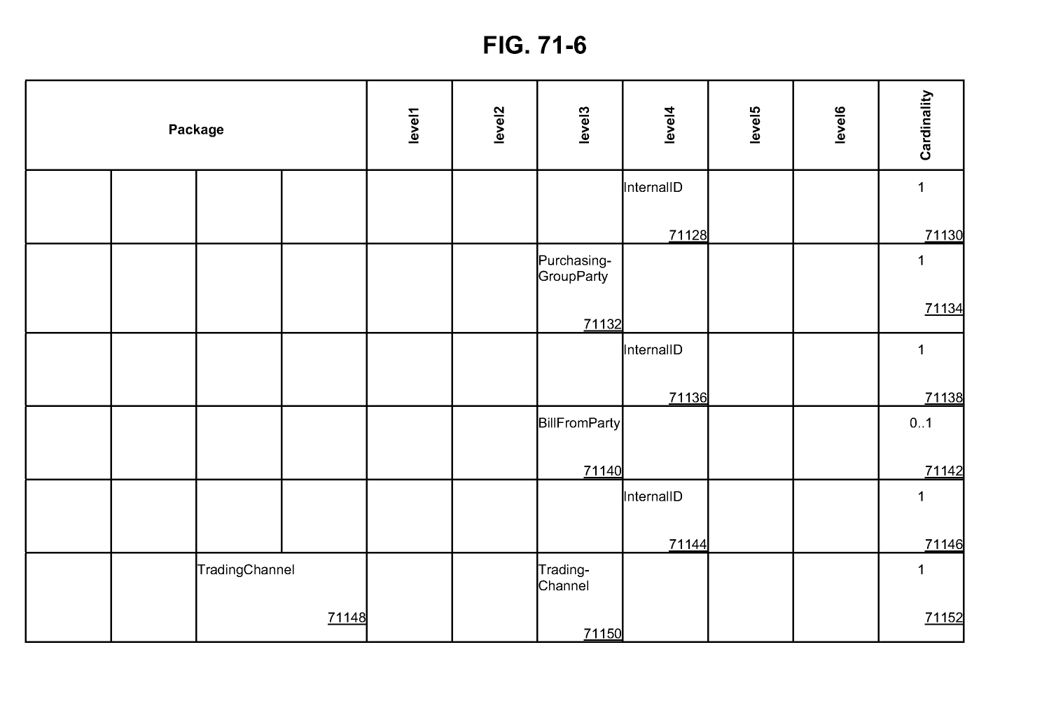

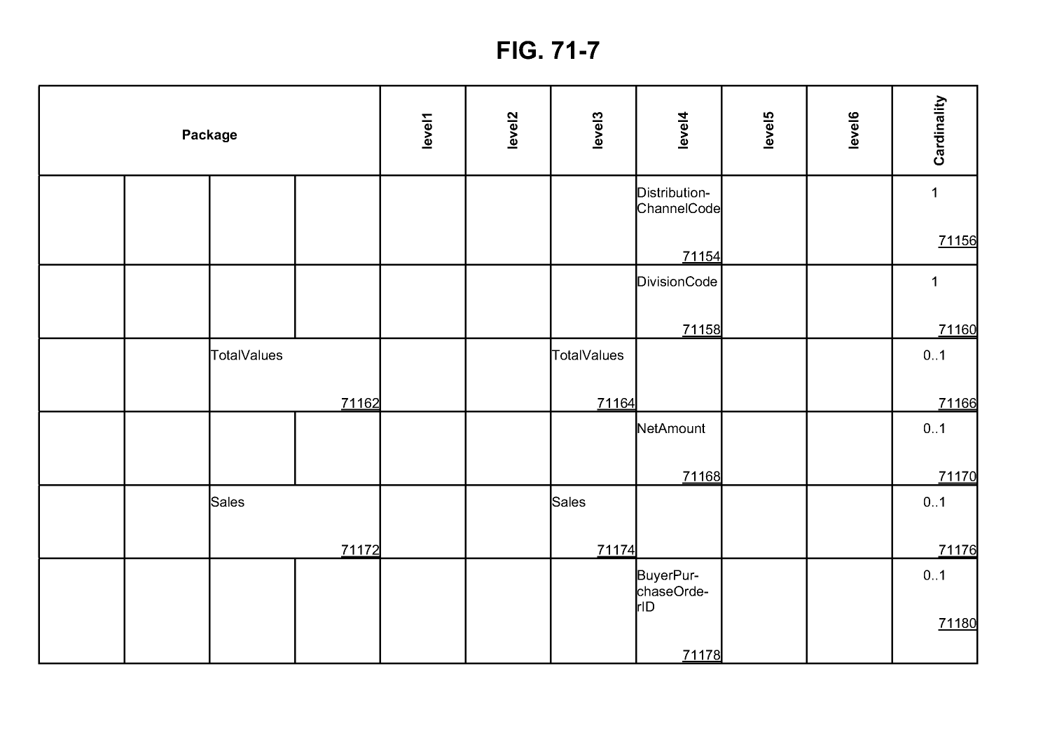

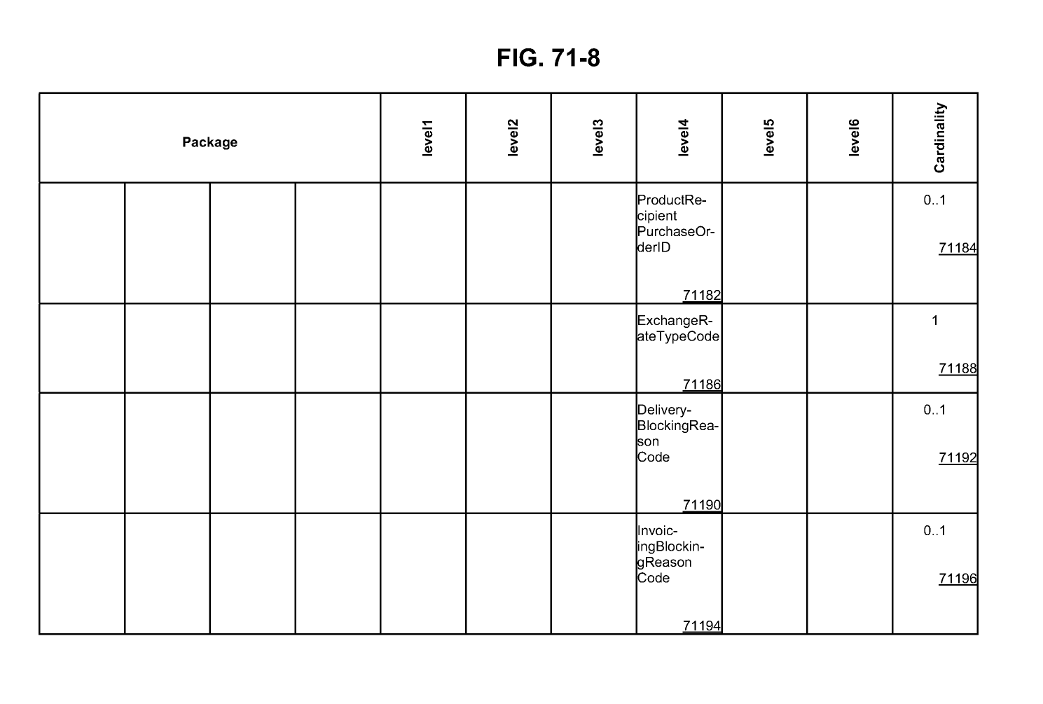

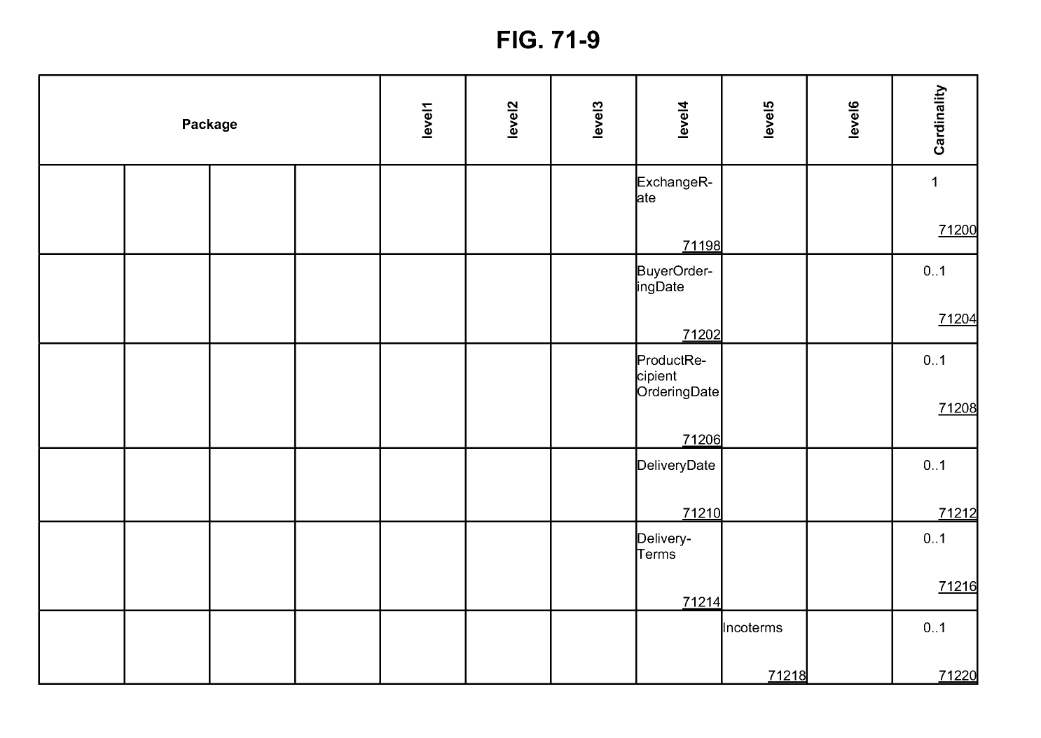

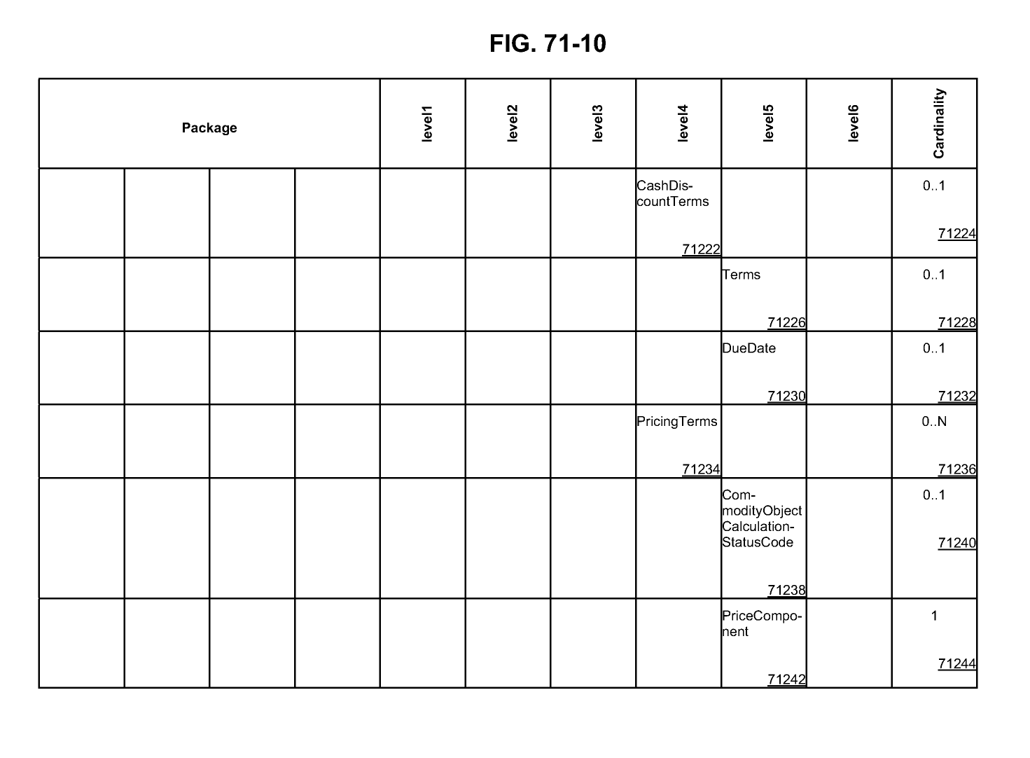

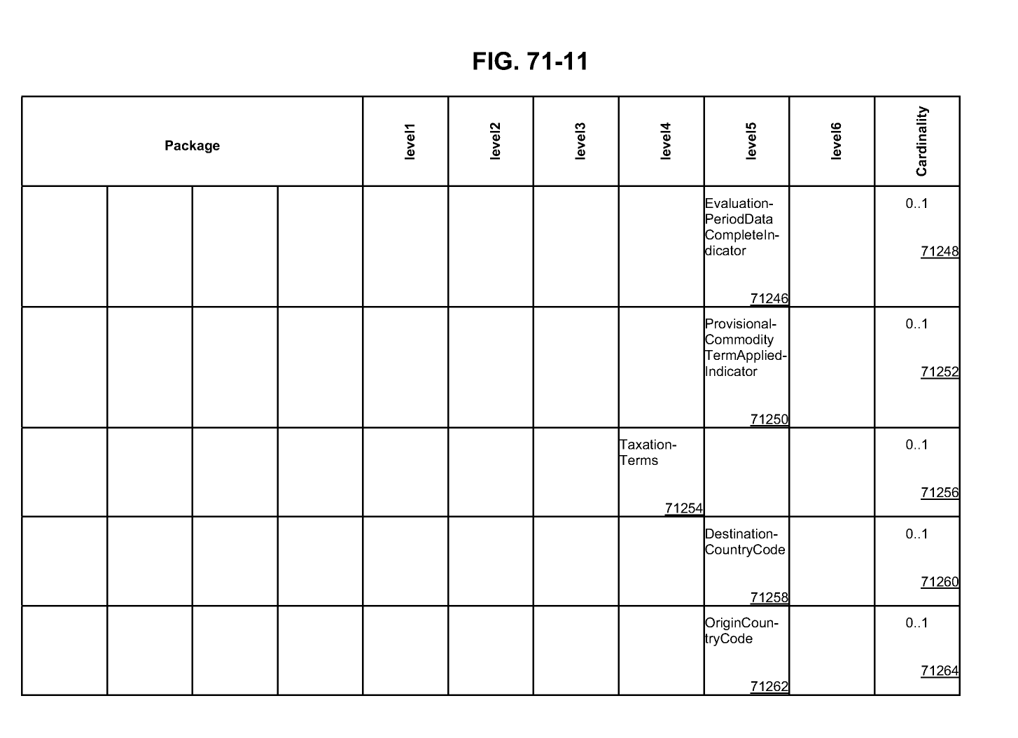

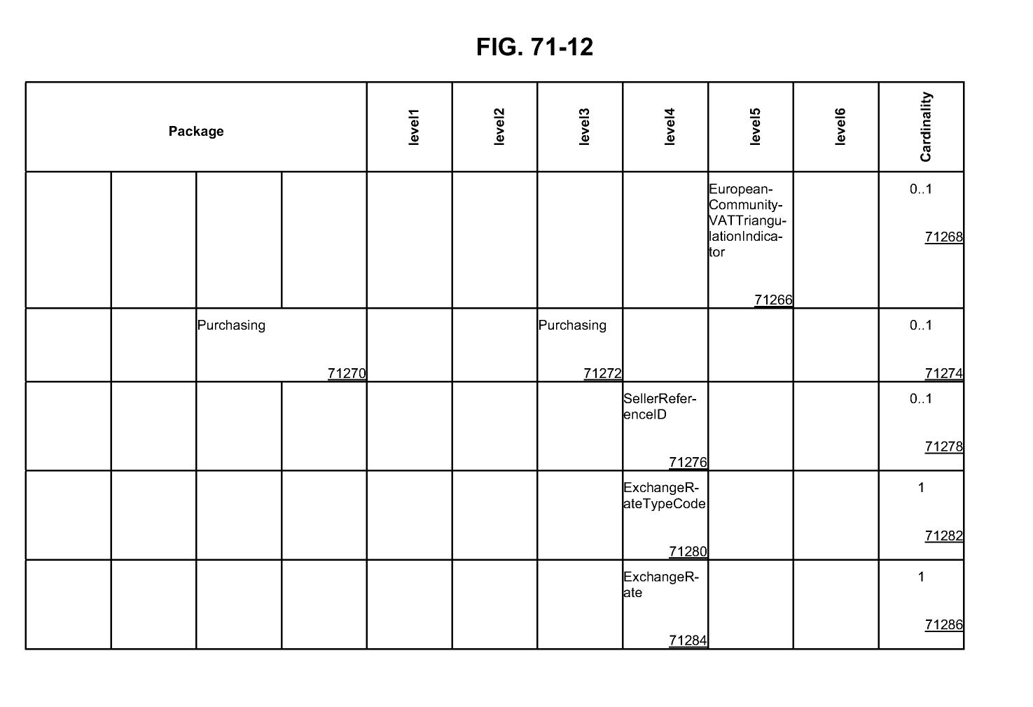

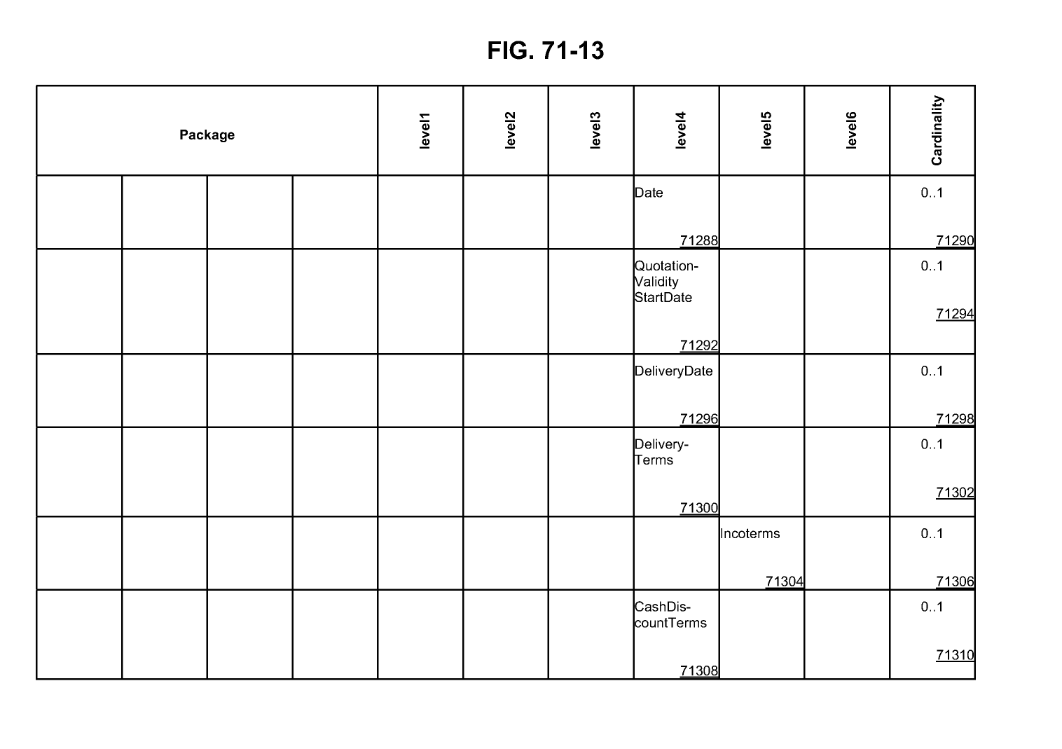

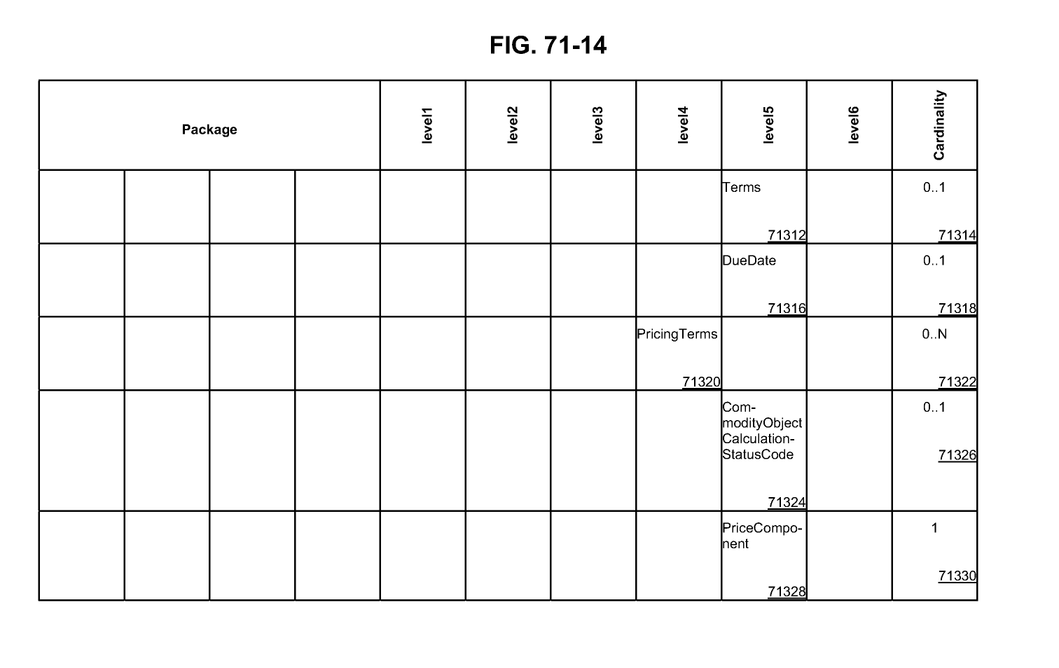

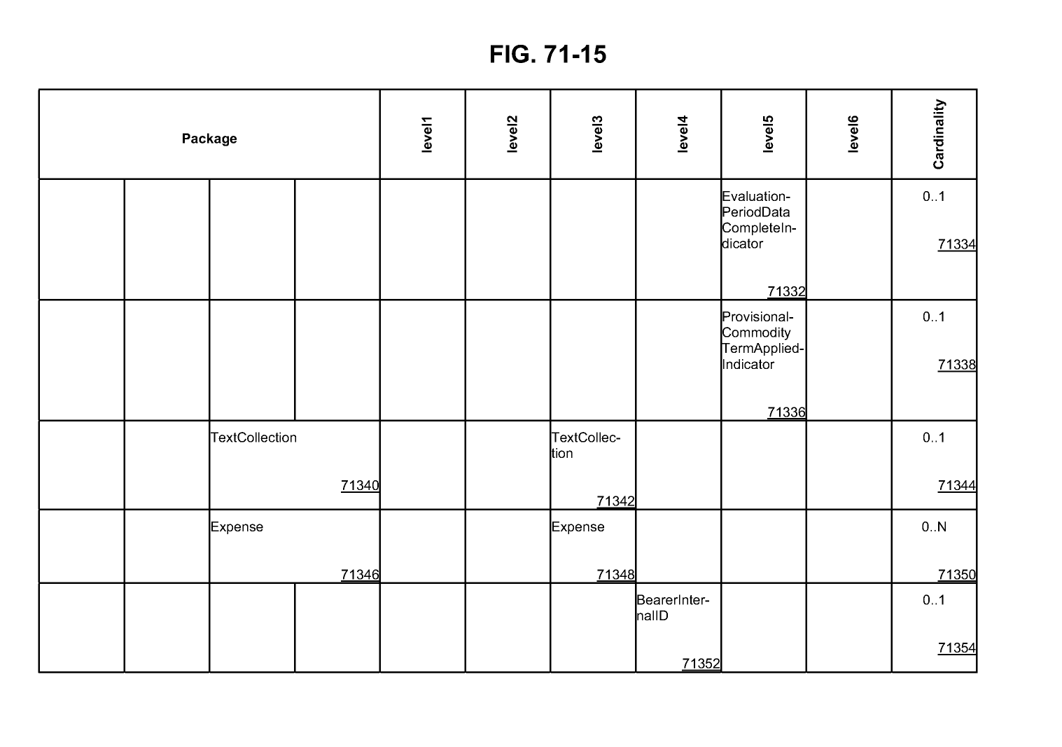

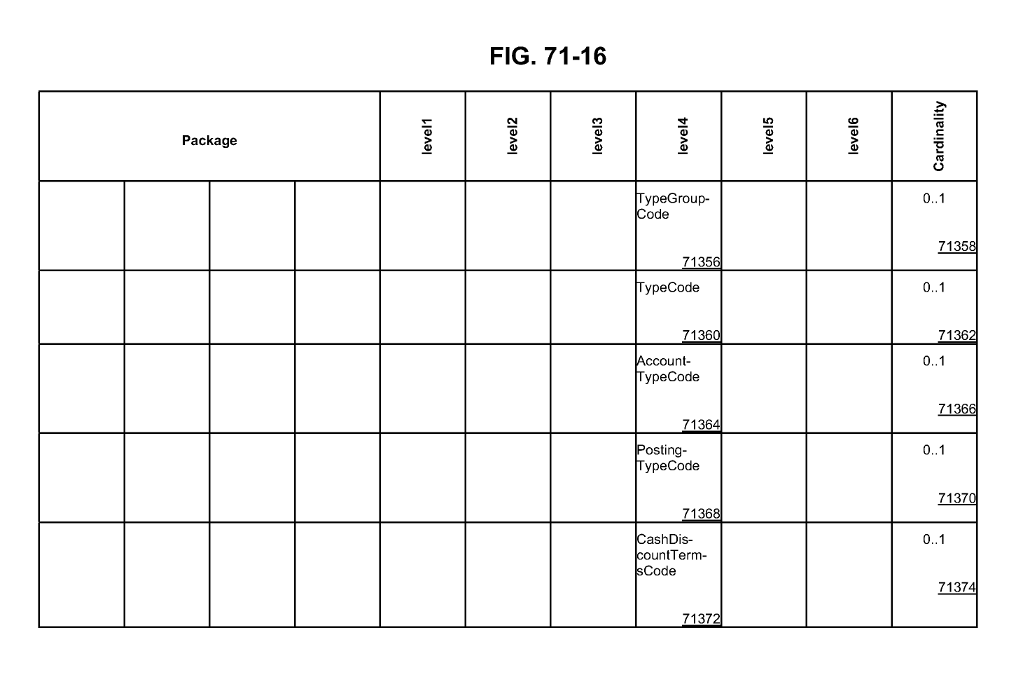

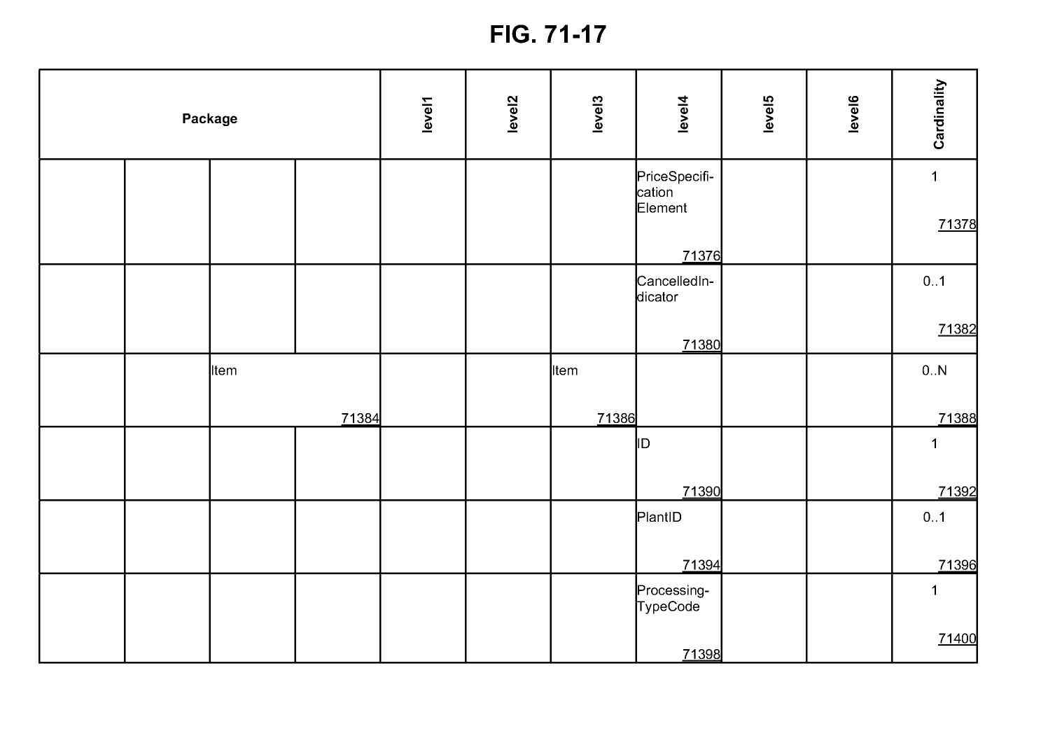

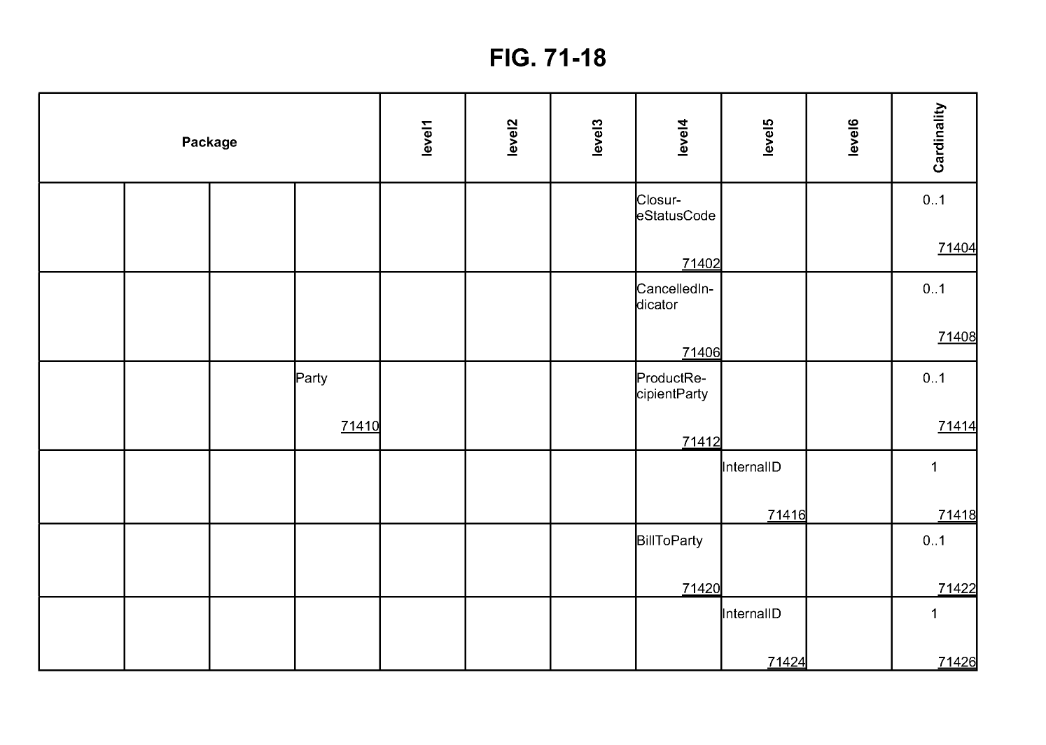

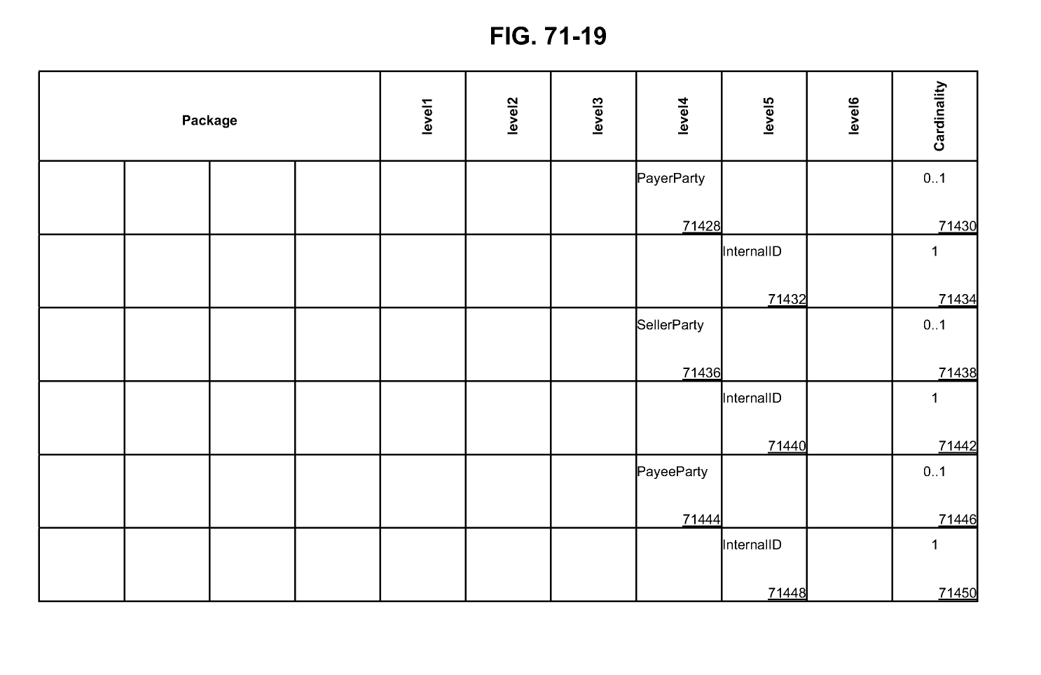

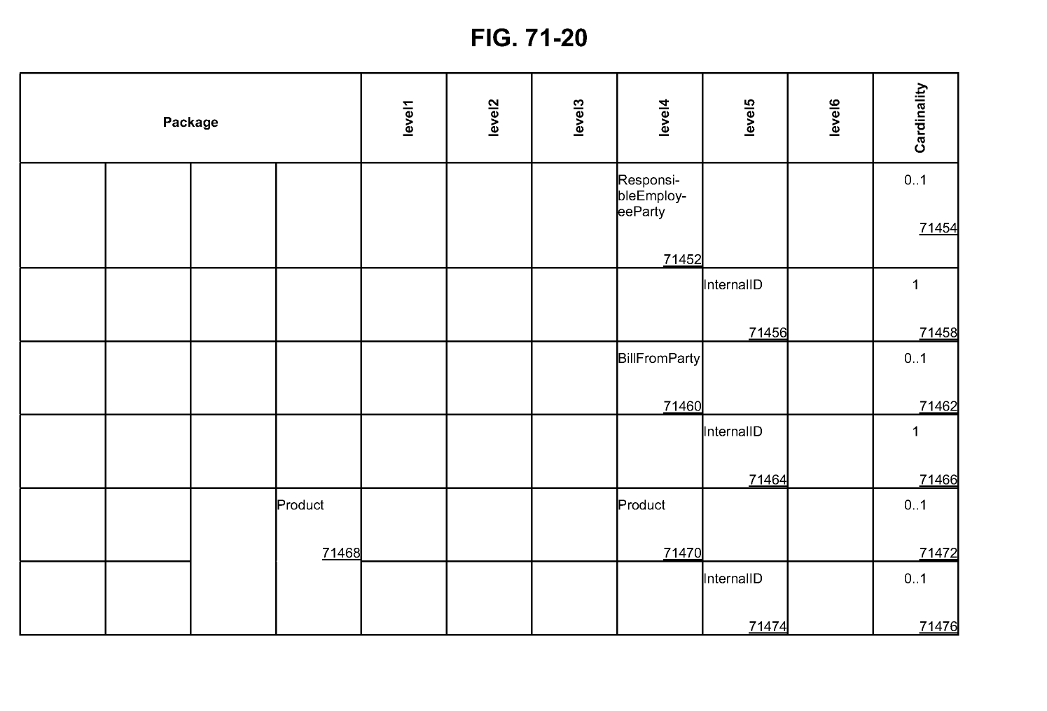

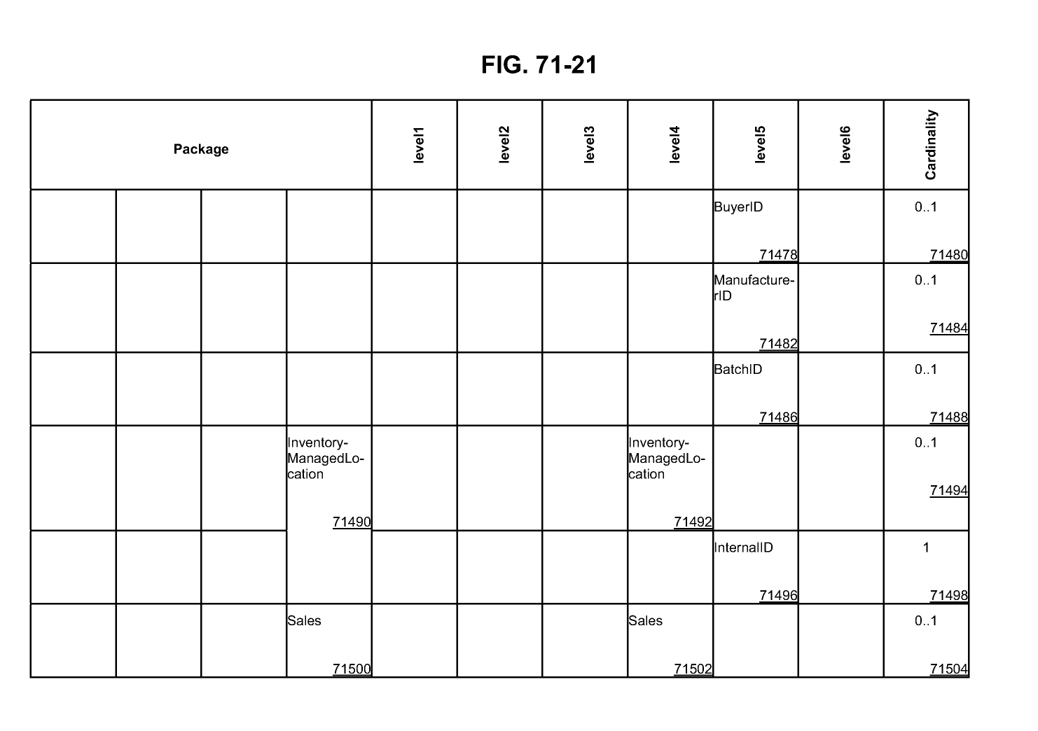

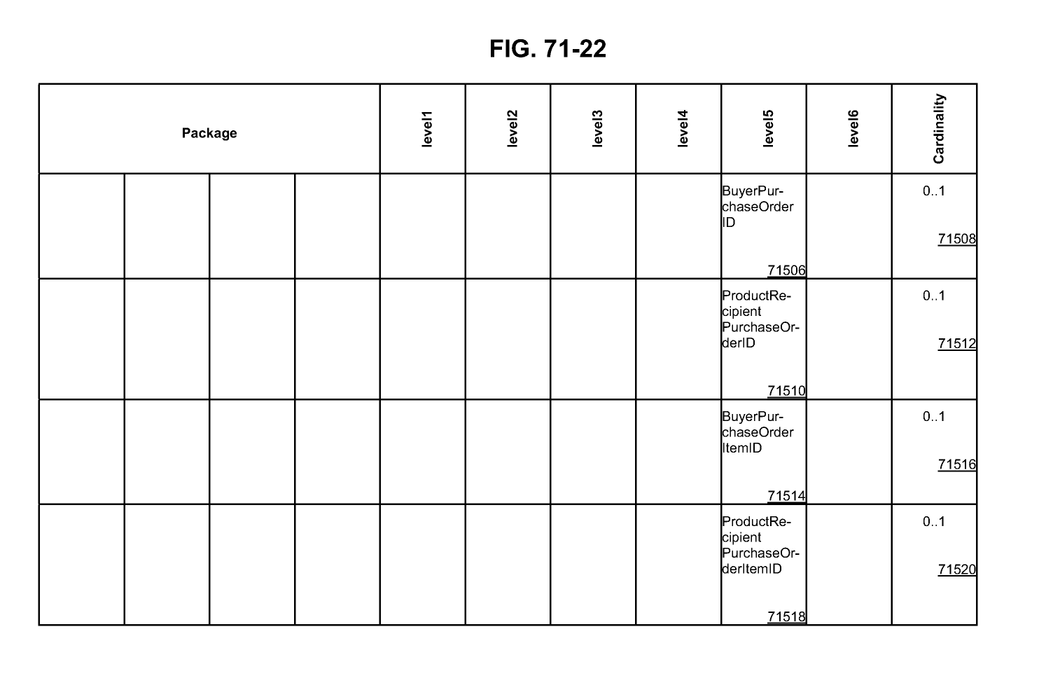

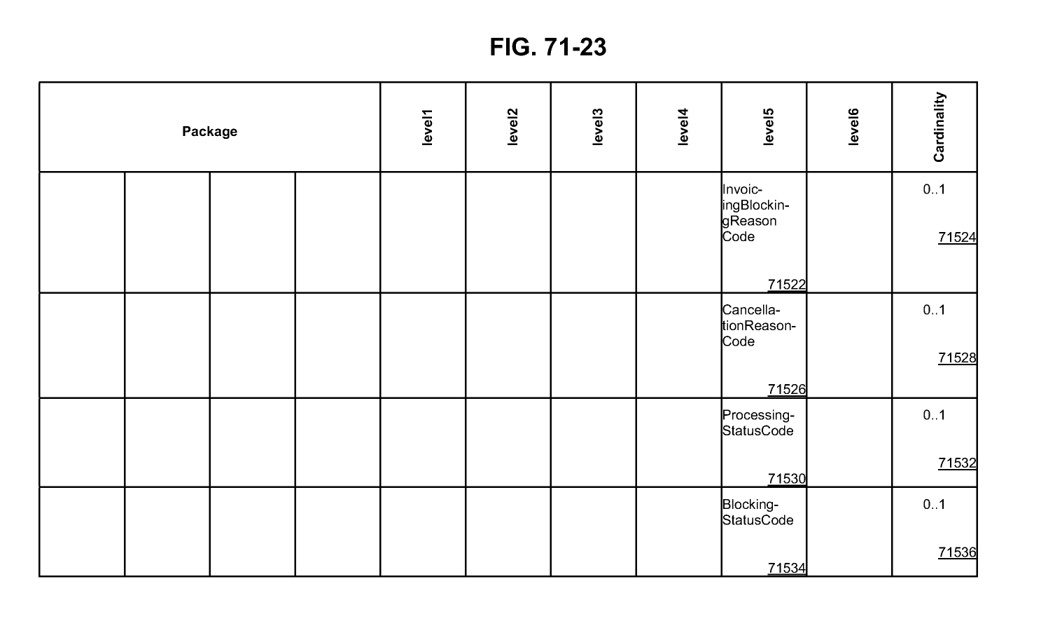

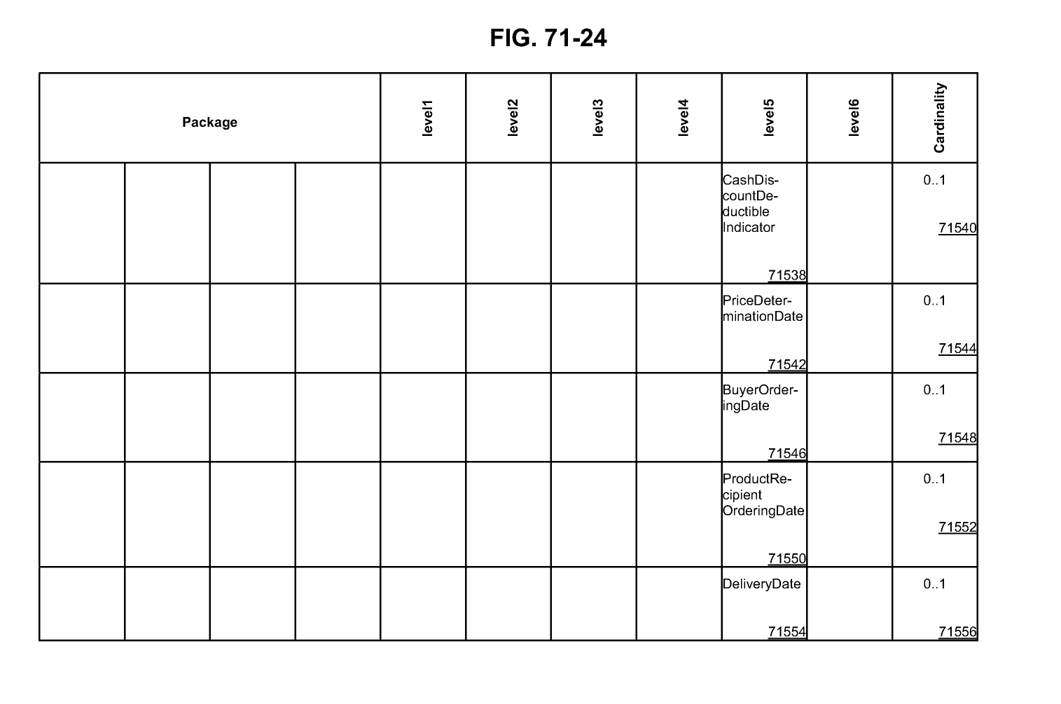

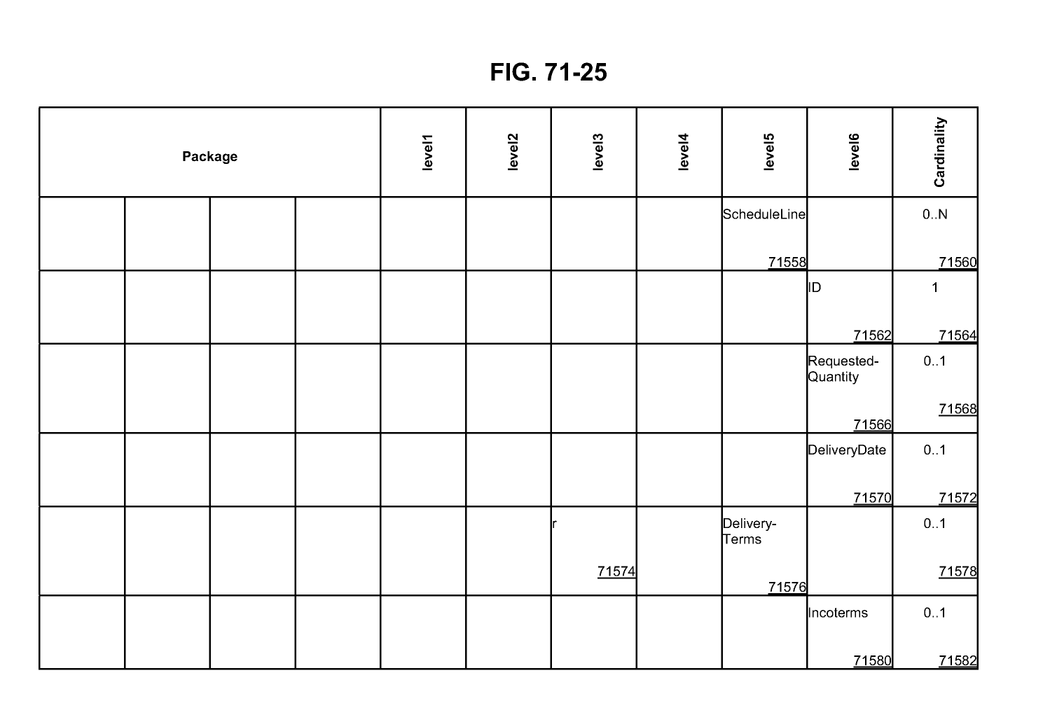

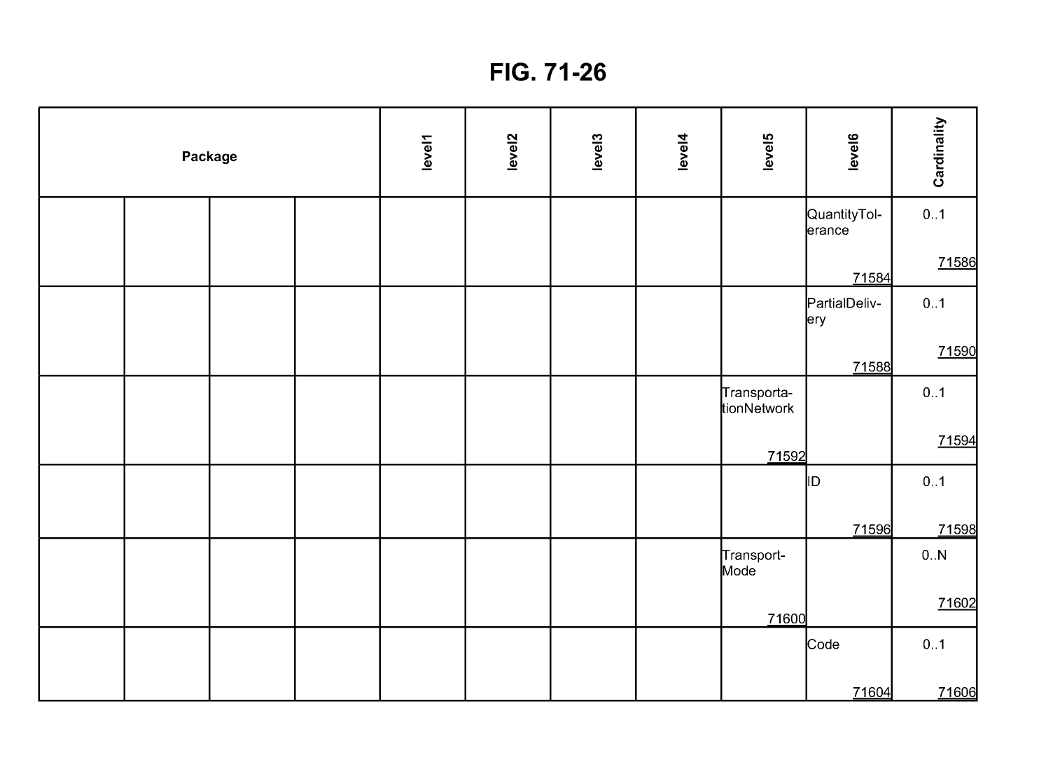

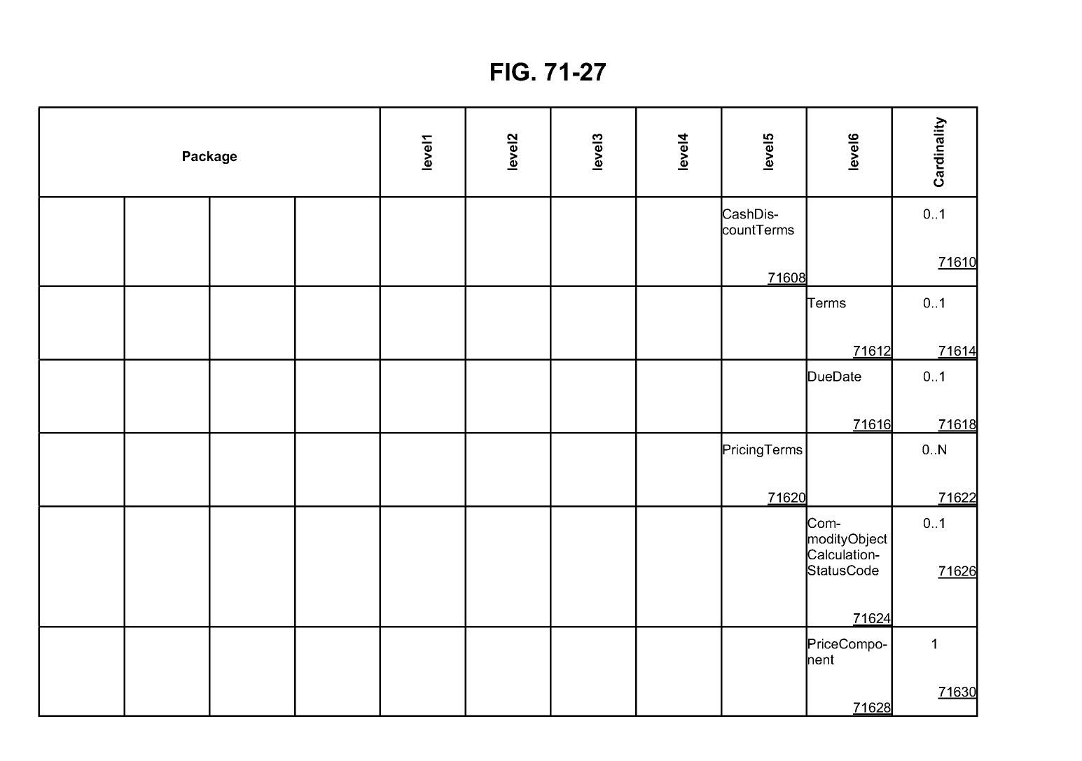

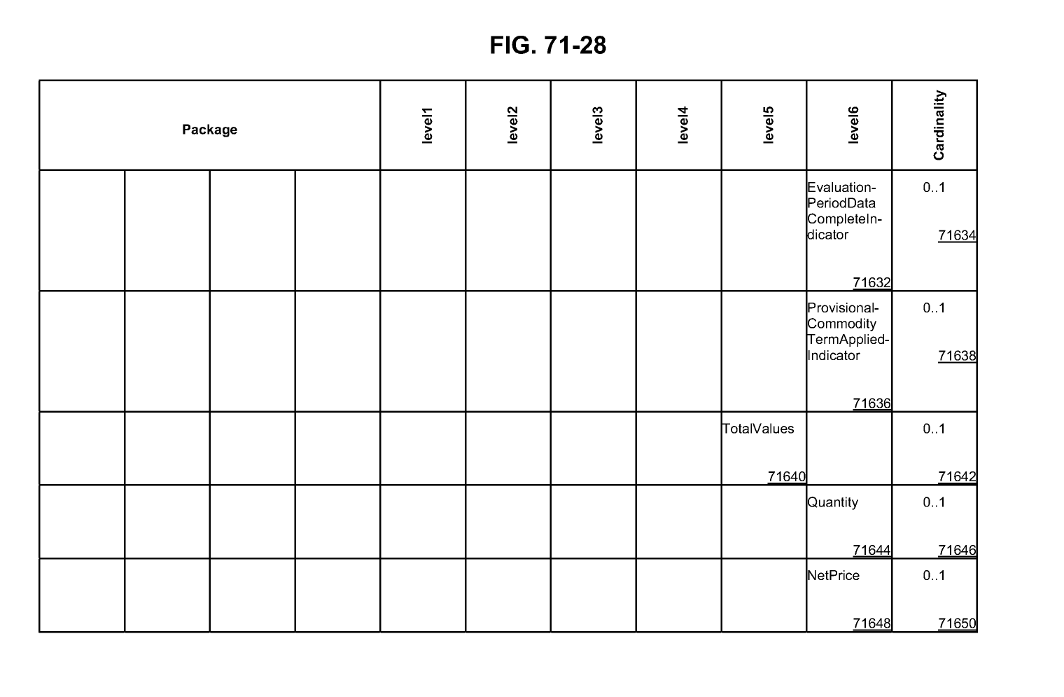

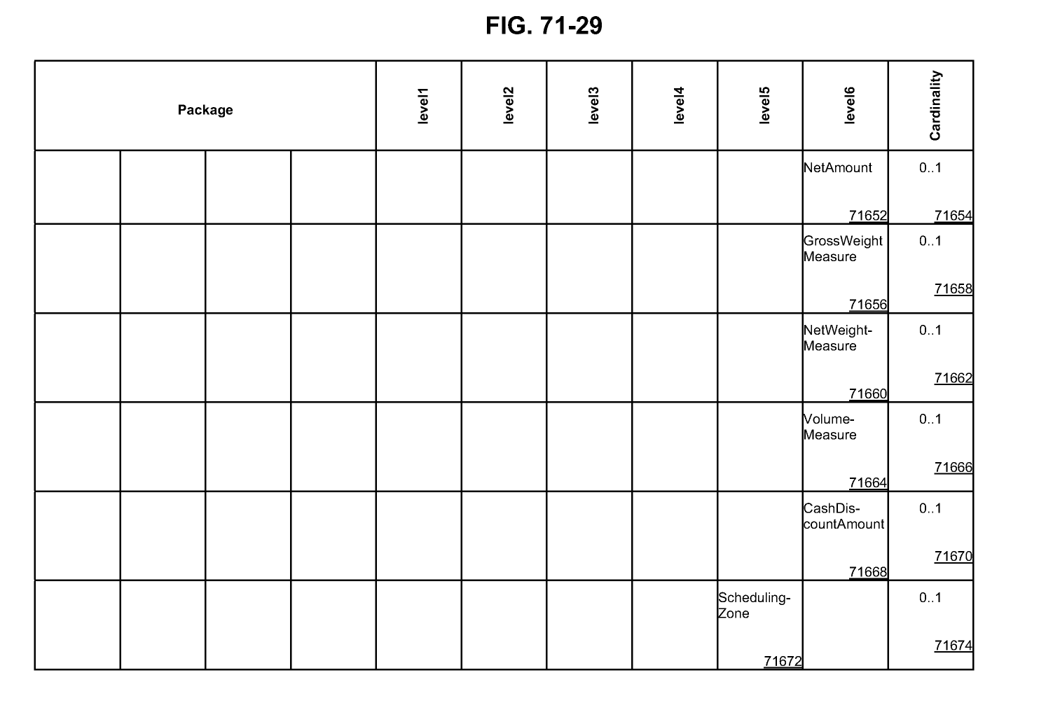

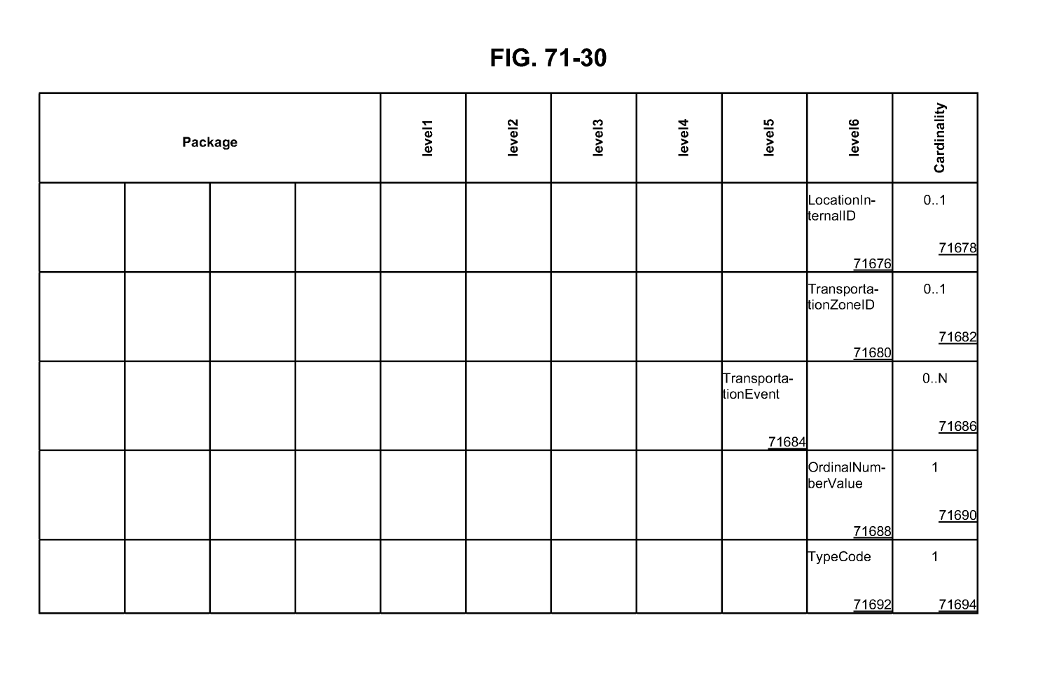

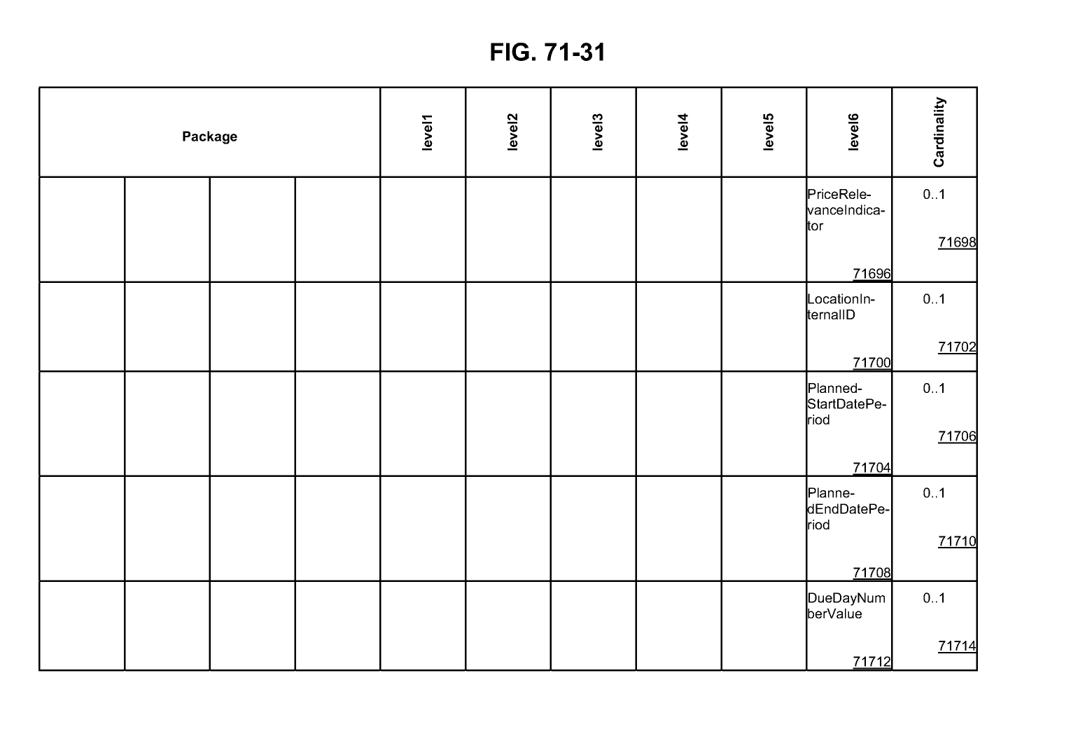

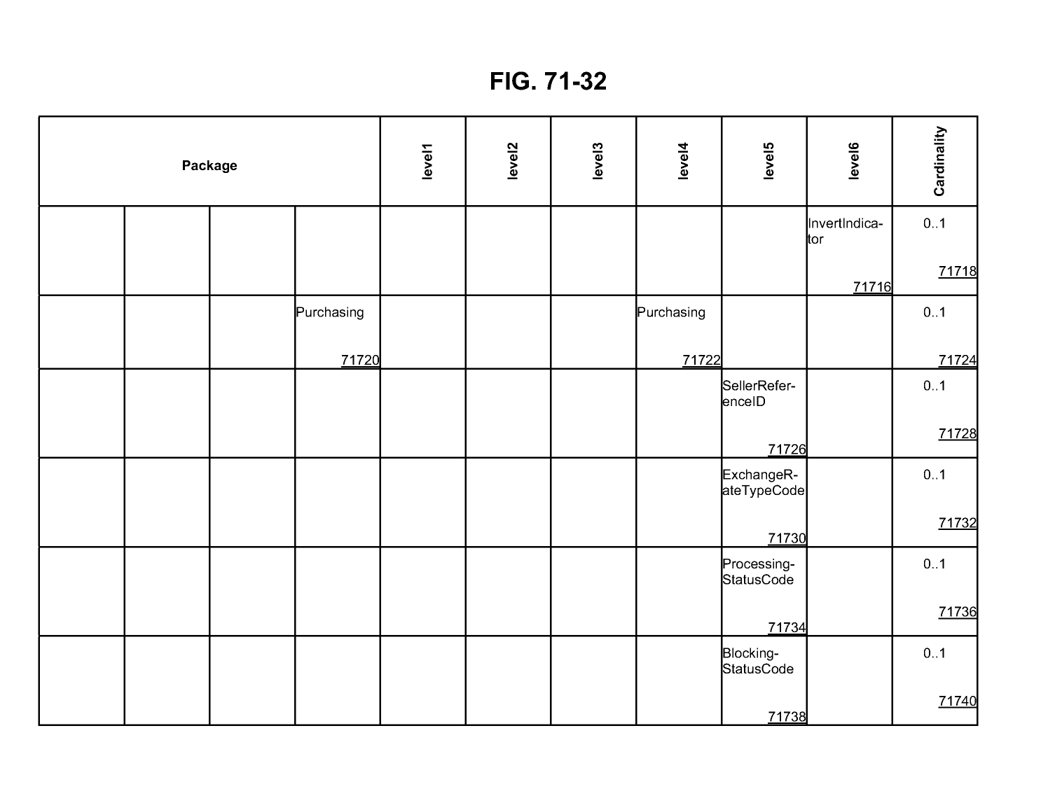

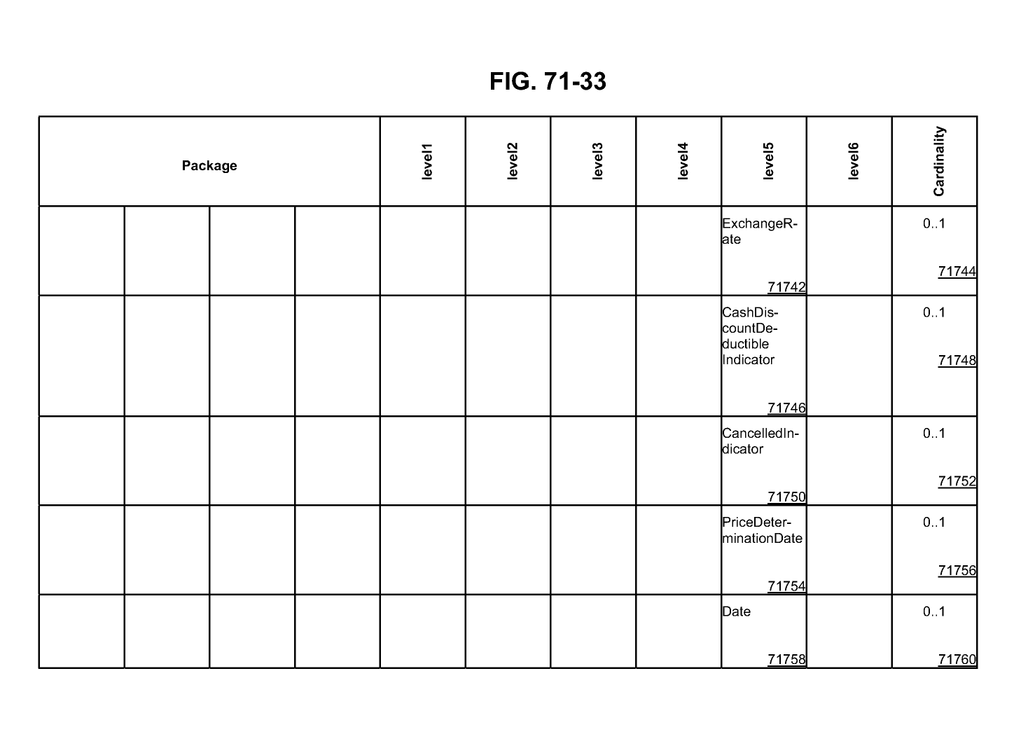

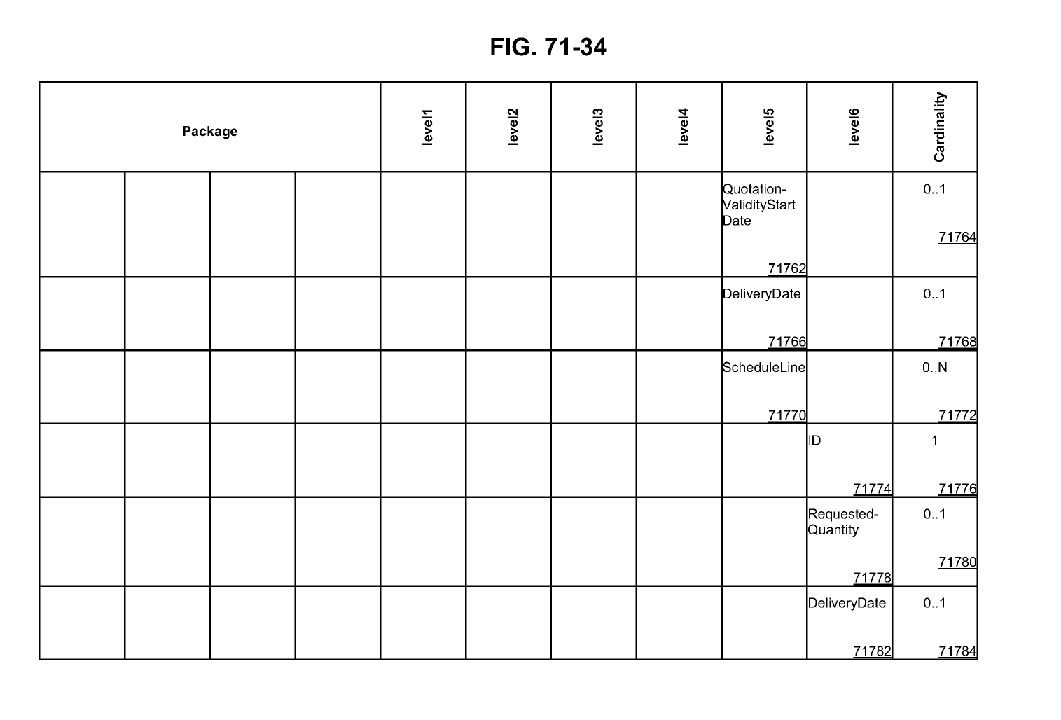

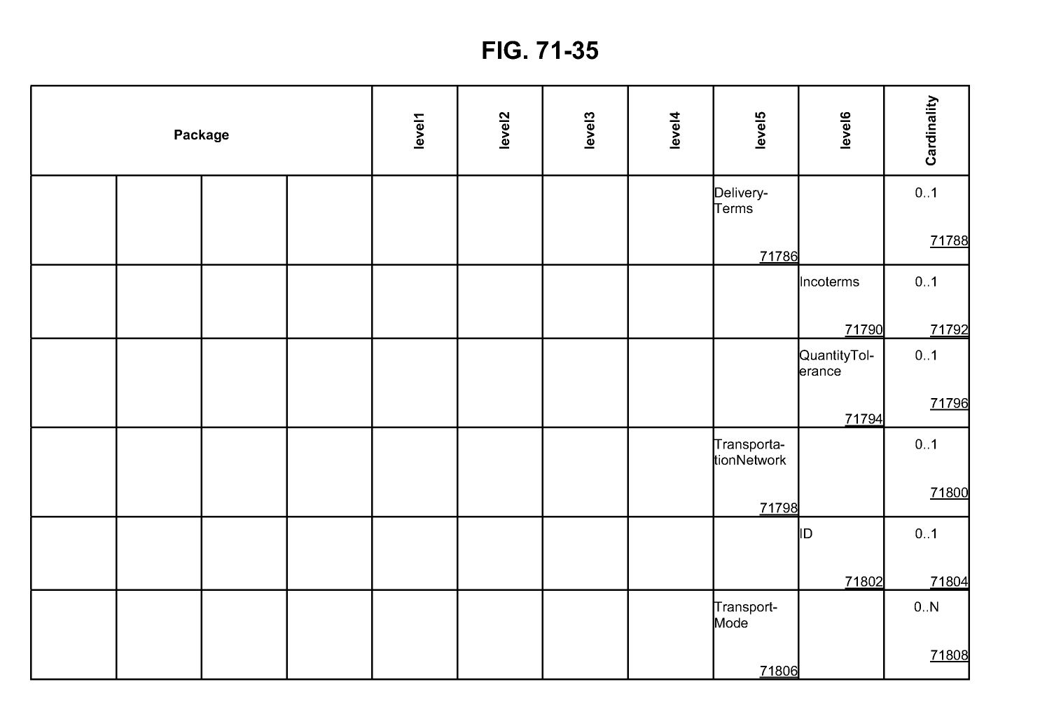

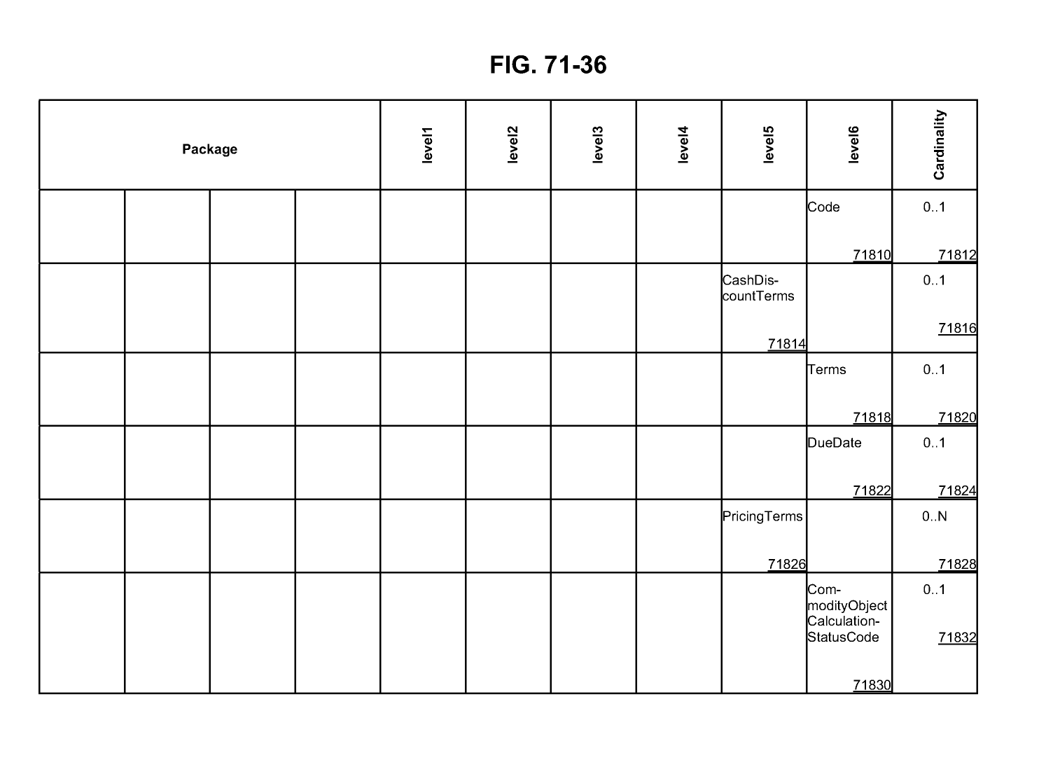

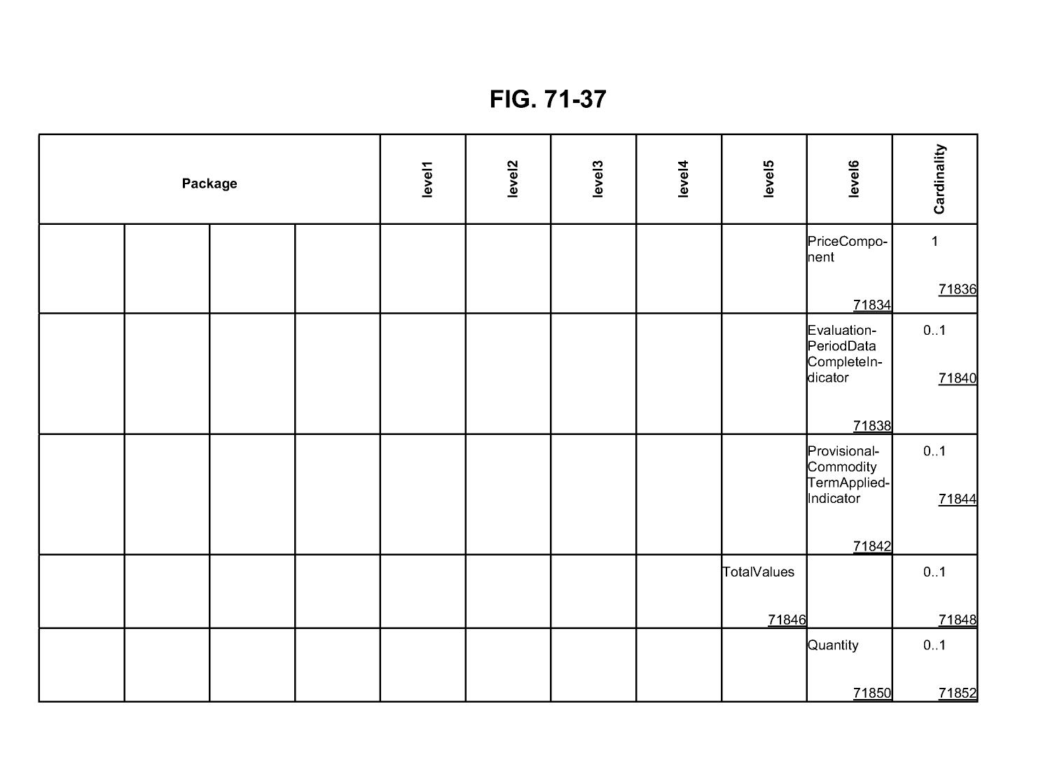

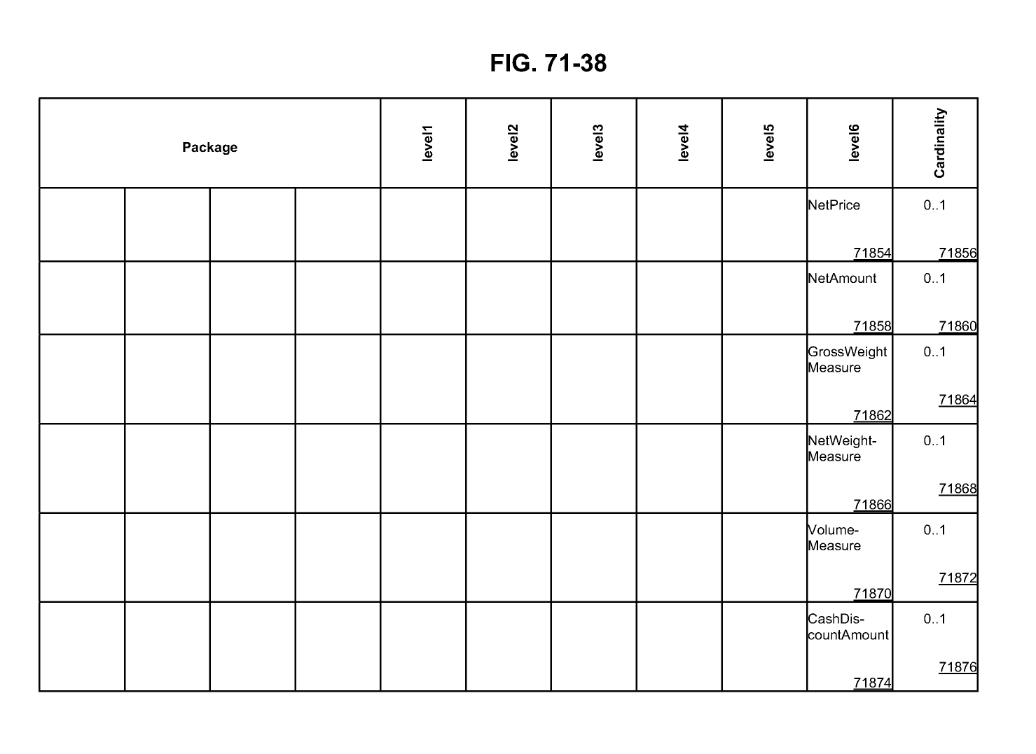

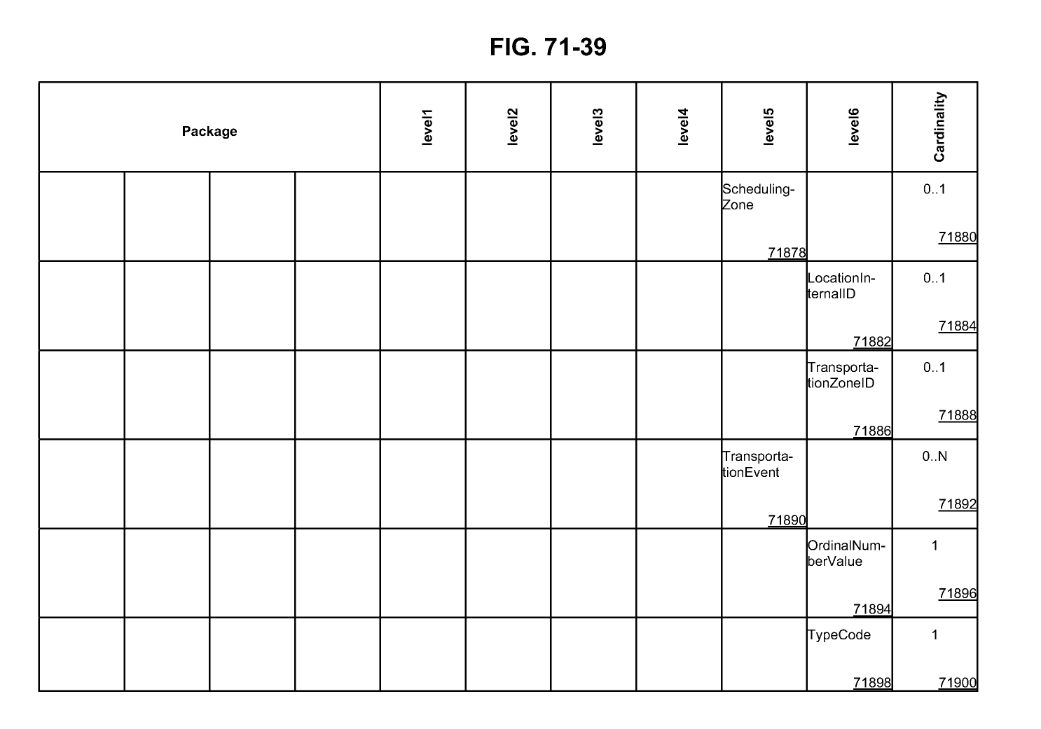

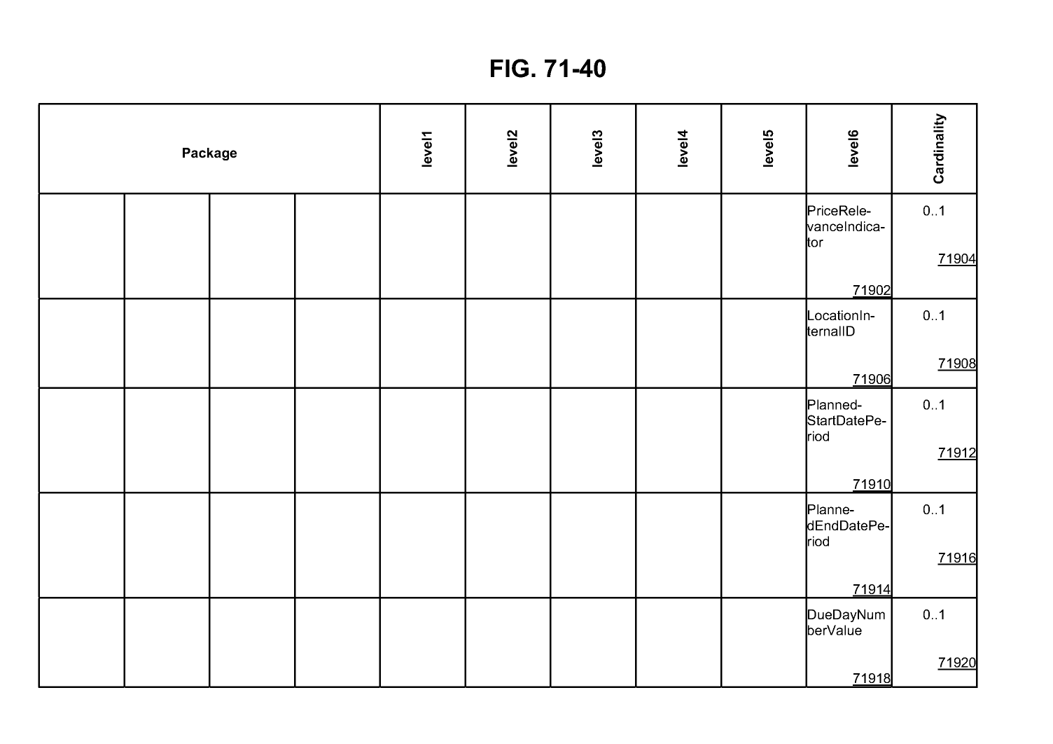

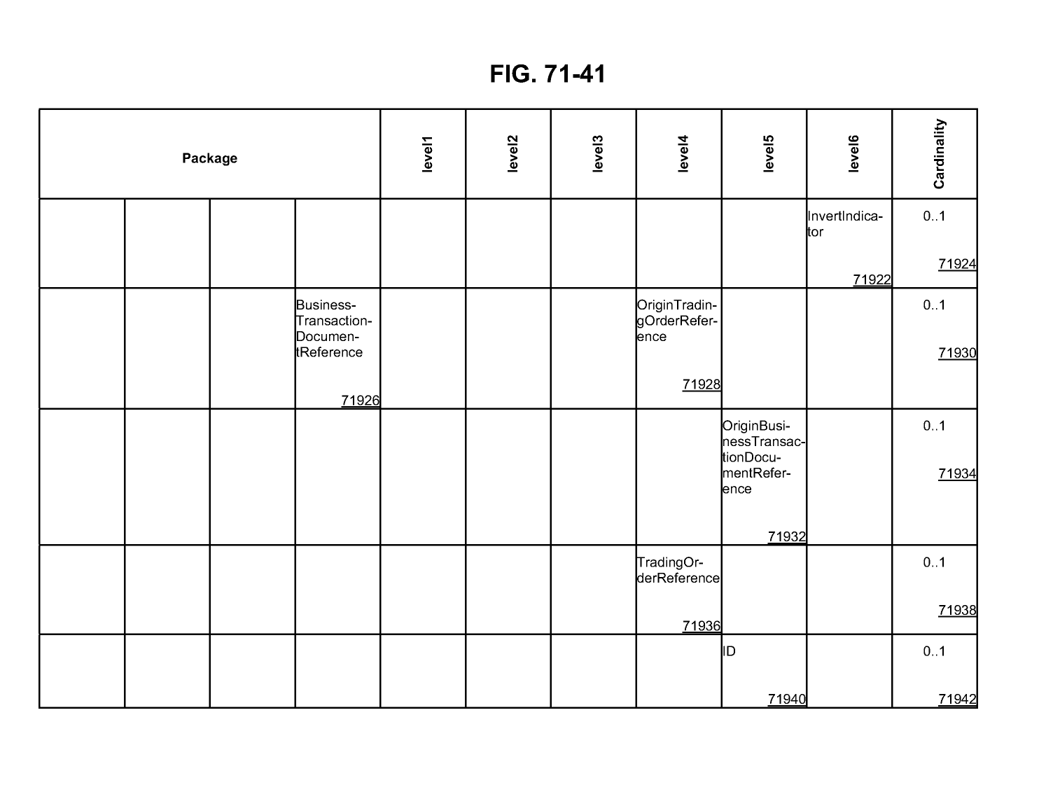

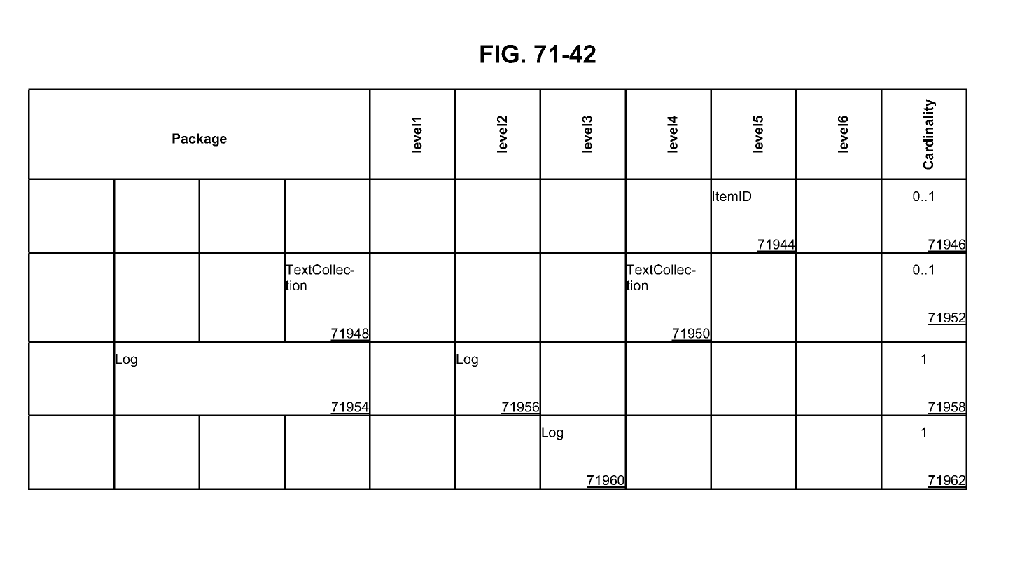

FIGS. 71-1 through 71-42 illustrate one example logical configuration of a TradingOrderERPUpdateConfirmationMessage_sync 71000 element structure. Specifically, these figures depict the arrangement and hierarchy of various components such as one or more levels of packages, entities, and datatypes, shown here as 71000 through 71962. As described above, packages may be used to represent hierarchy levels. Entities are discrete business elements that are used during a business transaction. Data types are used to type object entities and interfaces with a structure. For example, the TradingOrderERPUpdateConfirmationMessage_sync 71000 includes, among other things, a TradingOrderERPUpdateConfirmationMessage 71002. Accordingly, heterogeneous applications may communicate using this consistent message configured as such. The data types of the various packages, entities, and attributes are described with respect to FIG. 58.

### Message Data Type TradingOrderRequestMessage

The message data type TradingOrderRequestMessage groups together the TradingOrder object in the business document and the business information that is relevant for sending a business document in a message. It includes the packages MessageHeader and TradingOrder. A MessageHeader package groups the business information that is relevant for sending a business document in a message. It can include a MessageHeader entity. A MessageHeader groups business information from the perspective of the sending application and can include information to identify the business document in a message, information about the sender, and information about the recipient. The MessageHeader includes SenderParty and RecipientParty. It is a GDT of type BusinessDocumentMessageHeader, whereby the following elements of the GDT are used: ID, ReferenceID, CreationDateTime, SenderParty, and RecipientParty. A MessageHeader groups business information from the perspective of the sending application which can include information to identify the business document in a message, information about the sender, and information about the recipient.

The MessageHeader can contain SenderParty and RecipientParty. It is GDT of type BusinessDocumentMessageHeader, whereby the elements of the GDT which can be used include ID, ReferenceID, CreationDateTime, SenderParty, and RecipientParty. A SenderParty is the party responsible for sending a business document at a business application level. The SenderParty is a GDT of type BusinessDocumentMessageHeaderParty. A RecipientParty is the party responsible for receiving a business document at a business application level. The RecipientParty is a GDT of type BusinessDocumentMessageHeaderParty.

A TradingOrder package groups together the TradingOrder and its packages. It has the TradingOrder as root node. It can include the packages Party, TradingChannel, Sales, Purchasing, TextCollection, Expense, and Item. A TradingOrder is a request from an ordering party to trade (receive materials) with contractors (order recipients) where a sales area receives the order and becomes responsible for fulfilling the contract. A TradingOrder can also be a request or instruction from a purchasing organization to a vendor (external supplier) or a plant to deliver a certain quantity of material at a certain point in time. In addition, a TradingOrder can also be a request which combines the selling as well as the buying view to support a typical Trade Scenario (Back to Back Scenario) where a trade organization becomes responsible for fulfilling the contract. The elements that can be located directly at the TradingOrder entity include ID, ExternalTradingOrderID, TypeCode, TradingProcessVariantTypeCode, ExchangeRateTypeCode, LifeCycleStatusCode, ExchangeRate, and ValidityDate. The ID is a unique identifier of the TradingOrder. It is a GDT of type TradingOrderID and can be optional. ExternalTradingOrderID is a unique identifier given by the sending system for the TradingOrder. It is a GDT of type BusinessTransactionDocumentID and can be optional. TypeCode is an encoded representation of a TradingOrder within a trading order processing. It determines the price determination schema for calculating the purchasing and sales price and also affects which fields can be maintained. It is a GDT of type TradingOrderTypeCode. TradingProcessVariantTypeCode is a coded representation of a trading process variant type. It determines the character of a trading process variant. It represents a typical way of processing within a trading process component from a business point of view. It is a GDT of type TradingProcessVariantTypeCode and can be optional. ExchangeRateTypeCode is a coded representation of the type of an exchange rate. It is related to the currency of the TradingOrder and is a GDT of type ExchangeRateTypeCode. LifeCycleStatusCode is a coded representation of the life cycle status of a TradingOrder. It is a GDT of type TradingOrderLifeCycleStatusCode and can be optional. ExchangeRate is a representation of an exchange rate between two currencies: the currency of the TradingOrder and the local currency. It is a GDT of type ExchangeRate. ValidityDate is the date at which a TradingOrder becomes effective from a business perspective. It is a GDT of type Date, with a Qualifier of type Validity, and can be optional.

The TradingOrder entity has the attributes actionCode, itemListCompleteTransmissionIndicator, and expenseListCompleteTransmissionIndicator. ActionCode is a coded representation of an instruction telling how to process the TradingOrder. It is a GDT of type ActionCode. The itemListCompleteTransmissionIndicator indicates whether all items of a TradingOrder are transmitted or not. It is a GDT of type Indicator with a Qualifier of type CompleteTransmission. The expenseListCompleteTransmissionIndicator indicates whether all expenses of a TradingOrder are transmitted or not. It is a GDT of type Indicator with a Qualifier of type CompleteTransmission. In some implementations, if the ActionCode includes the value ‘01’ (Create) then the element ID cannot be filled. For all other values of ActionCode, the element ID can be filled. The values ‘01’ (Create), ‘02’ (Change), ‘03’ (Delete) and ‘06’ (No action) of ActionCode which model strict semantics can be supported. Other values are possible.

A Party Package groups together all the business parties involved in the Trading Order. It can include the entities BuyerParty, ProductRecipientParty, BillToParty, PayerParty, SellerParty, PayeeParty, ResponsibleEmployeeParty, SalesOrganizationParty, PurchasingOrganizationParty, PurchasingGroupParty, and BillFromParty. A BuyerParty is a party that buys goods or services. It includes the element InternalID. InternalID is a unique identifier for the party that buys goods or services. It is a GDT of type PartyInternalID. A ProductRecipientParty is a party to which goods are delivered or for whom services are provided. ProductRecipientParty includes the element InternalID. It is a unique identifier for the party to which goods are delivered or for whom services are provided. It is a GDT of type PartyInternalID. A BillToParty is a party to which the invoice for goods or services is sent. It includes the element InternalID. InternalID is a unique identifier for the party to which the invoice for goods or services is sent. It is a GDT of type PartyInternalID. A PayerParty is a party that pays for goods or services. It includes the element InternalID, which is a unique identifier for the party that pays for goods or services. It is a GDT of type PartyInternalID. A SellerParty is a party that sells goods or services. It includes the element InternalID, which is a unique identifier for the party that sells goods or services. It is a GDT of type PartyInternalID. A PayeeParty is a party that receives payment for goods or services provided. It includes the element InternalID, which is a unique identifier for the party that receives payment for goods or services. It is a GDT of type PartyInternalID.

A ResponsibleEmployeeParty is a party that is responsible for something. The party can be an internal or external employee. It includes the element InternalID, which is a unique identifier for the responsible employee. It is a GDT of type PartyInternalID. A SalesOrganizationParty is an Organization that is responsible for selling goods. It includes the element InternalID, which is a unique identifier for the party that is responsible for selling goods. It is a GDT of type PartyInternalID. A PurchasingOrganizationParty is an organizational unit within logistics that subdivides the enterprise according to the requirements of purchasing. It includes the element InternalID, which is a unique identifier of a purchasing organization. It is a GDT of type PartyInternalID. A PurchasingGroupParty is an organizational unit within logistics that subdivides the enterprise from the viewpoint of purchasing according to the responsibilities for the procurement of products and is the point of contact for the suppliers. It includes the element InternalID, which is a unique identifier of a purchasing group. It is a GDT of type PartyInternalID. A BillFromParty is a party which issues the invoice for goods or services. It includes an InternalID element. InternalID is a unique identifier for the party which issues the invoice for goods or services. It is a GDT of type PartyInternalID.

A TradingChannel package groups the trading channel of a TradingOrder. It includes a TradingChannel entity. A TradingChannel defines the unit which is responsible for trading goods and services in detail. It includes the elements DistributionChannelCode and DivisionCode. DistributionChannelCode is an encoded representation of a distribution channel via which the goods or services are made available to the customer. It is a GDT of type DistributionChannelCode. DivisionCode is an encoded representation of a division that defines the responsibility for sales or profit for saleable materials or services. It is a GDT of type DivisionCode.

A Sales package groups together the selling data of the TradingOrder. It includes the root node Sales and the entities DeliveryTerms, CashDiscountTerms, PricingTerms, and TaxationTerms. Sales is the selling part of the TradingOrder. The elements that can be located directly at the Sales entity are BuyerPurchaseOrderID, ProductRecipientPurchaseOrderID, ExchangeRateTypeCode, DeliveryBlockingReasonCode, InvoicingBlockingReasonCode, ExchangeRate, BuyerOrderingDate, and ProductRecipientOrderingDate. BuyerPurchaseOrderID is an identifier of the purchase order used by the buyer. It is a GDT of type BusinessTransactionDocumentID and can be optional. ProductRecipientPurchaseOrderID is an identifier of the purchase order used by the product recipient. It is a GDT of type BusinessTransactionDocumentID and can be optional. ExchangeRateTypeCode is a coded representation of the type of an exchange rate. It is related to the currency of the TradingOrder Sales and is a GDT of type ExchangeRateTypeCode. DeliveryBlockingReasonCode is a coded representation for the reason why a TradingOrder Sales is blocked for delivery. It is a GDT of type DeliveryBlockingReasonCode and can be optional. InvoicingBlockingReasonCode is a coded representation for the reason why a TradingOrder Sales is blocked for invoicing. It is a GDT of type InvoicingBlockingReasonCode and can be optional. ExchangeRate is a representation of an exchange rate between two currencies: the currency of the TradingOrder Sales and the local currency. It is a GDT of type ExchangeRate. BuyerOrderingDate is the date when the buyer's purchase order was ordered. It is a GDT of type Date, with a Qualifier of type Ordering, and can be optional. ProductRecipientOrderingDate is the date when the product recipient's purchase order was ordered. It is a GDT of type Date, with a Qualifier of type Ordering, and can be optional. The Sales entity has the attribute pricingTermsListCompleteTransmissionIndicator.

The pricingTermsListCompleteTransmissionIndicator indicates whether all PricingTerms of a TradingOrder sales are transmitted or not. It is a GDT of type Indicator and a Qualifier of type CompleteTransmission. DeliveryTerms are conditions and agreements that are valid for executing the delivery of ordered materials. It includes an Incoterms element, which can be optional. Incoterms are typical contract formulations for delivery conditions that correspond to the rules defined by the International Chamber of Commerce (ICC). Incoterms is a GDT of type Incoterms. CashDiscountTerms is a set of control information which is relevant for payment in the TradingOrder sales document. It includes the elements Code and DueDate. Code is a coded representation of an agreement of cash discounts for a payment. It is a GDT of type CashDiscountTermsCode and can be optional. DueDate is the date on which the CashDiscountTerms related to the TradingOrder Sales becomes effective. It is a GDT of type Date, with a Qualifier of type Due, and can be optional. PricingTerms is the price information for the TradingOrder sales document. It includes the elements CommodityObjectCalculationStatusCode, PriceComponent, EvaluationPeriodDataCompleteIndicator, and ProvisionalCommodityTermAppliedIndicator. CommodityObjectCalculationStatusCode is a coded representation of the calculation status of a commodity pricing object. It is a GDT of type CalculationStatusCode, with a Qualifier of type CommodityObject, and can be optional. PriceComponent is a component of the calculated price. It is a GDT of type PriceComponent. EvaluationPeriodDataCompleteIndicator indicates whether all data for period evaluation are taken into account or not. It is a CDT of type Indicator, with a Qualifier of type Complete, and can be optional. ProvisionalCommodityTermAppliedIndicator indicates whether a provisional commodity term is applied during a period evaluation or not. It is a CDT of type Indicator, with a Qualifier of type Applied, and can be optional. The PricingTerms entity has the attribute actionCode, which is a coded representation of an instruction telling how to process the PricingTerms for a TradingOrder Sales. It is a GDT of type ActionCode.

TaxationTerms is tax information for the TradingOrder sales document. It can include the elements DestinationCountryCode, OriginCountryCode, and EuropeanCommunityVATTriangulationIndicator. DestinationCountryCode is a coded representation of the country which is the destination country for tax purposes. It is a GDT of type CountryCode, with a Qualifier of type Destination, and can be optional. OriginCountryCode is a coded representation of the country which is the origin country for tax purposes. It is a GDT of type CountryCode, with a Qualifier of type Origin, and can be optional. EuropeanCommunityVATTriangulationIndicator indicates whether a delivery is an intracommunity triangulation according to the VAT law of a member state of the European Community. It is a CDT of type Indicator, with a Qualifier of type EuropeanCommunityVATTriangulation, and can be optional.

A Purchasing package groups together the buying data of the TradingOrder. It includes the root node Purchasing and the entities DeliveryTerms, CashDiscountTerms, and PricingTerms. Purchasing is the buying part of the TradingOrder. The elements that can be located directly at the Purchasing entity are SellerReferenceID, ExchangeRateTypeCode, ExchangeRate, Date, and QuotationValidityStartDate. SellerReferenceID is the reference identifier of the seller. The SellerReferenceID is a GDT of type BusinessTransactionDocumentID and can be optional. ExchangeRateTypeCode is the coded representation of the type of an exchange rate. It is related to the currency of the TradingOrder Purchasing. It is a GDT of type ExchangeRateTypeCode. ExchangeRate is the representation of an exchange rate between two currencies: the currency of the TradingOrder Purchasing and the local currency. It is a GDT of type ExchangeRate. Date represents the date on which the purchasing document was created. It is a GDT of type Date and can be optional. QuotationValidityStartDate is the date on which the seller submitted the quotation. It is a GDT of type Date, with a Qualifier of type ValidityStart, and can be optional.

The Purchasing entity has the attribute pricingTermsListCompleteTransmissionIndicator. The pricingTermsListCompleteTransmissionIndicator indicates whether all PricingTerms of a TradingOrder Purchasing are transmitted or not. It is a GDT of type Indicator with a Qualifier of type CompleteTransmission. DeliveryTerms are the conditions and agreements that are valid for executing the delivery of ordered materials. It can include an Incoterms element, which can be optional. Incoterms are typical contract formulations for delivery conditions that correspond to the rules defined by the International Chamber of Commerce (ICC). DeliveryTerms is a GDT of type Incoterms. CashDiscountTerms is a set of control information which is relevant for payment in the TradingOrder purchasing document. It includes the elements Code and DueDate. Code is a coded representation of an agreement of cash discounts for a payment. It is a GDT of type CashDiscountTermsCode and can be optional. DueDate is the date on which the CashDiscountTerms related to the TradingOrder Purchasing becomes effective. It is a GDT of type Date, with a Qualifier of type Due, and can be optional.

PricingTerms is the price information for the TradingOrder purchasing document. It can contain the elements CommodityObjectCalculationStatusCode, PriceComponent, EvaluationPeriodDataCompleteIndicator, and ProvisionalCommodityTermAppliedIndicator. CommodityObjectCalculationStatusCode is a coded representation of the calculation status of a commodity pricing object. It is a GDT of type CalculationStatusCode, with a Qualifier of type CommodityObject, and can be optional. PriceComponent is a component of the calculated price and is a GDT of type PriceComponent. EvaluationPeriodDataCompleteIndicator indicates whether all data for period evaluation are taken into account or not. It is a CDT of type Indicator, with a Qualifier of type Complete, and can be optional. ProvisionalCommodityTermAppliedIndicator indicates whether a provisional commodity term is applied during a period evaluation or not. It is a CDT of type Indicator, with a Qualifier of type Applied, and can be optional. The PricingTerms entity has the attribute actionCode. ActionCode is a coded representation of an instruction telling how to process the PricingTerms for a TradingOrder Purchasing and is a GDT of type ActionCode.

A TextCollection package groups together all the texts regarding the TradingOrder. The TextCollection package can include a TextCollection entity. TextCollection is a collection of text descriptions linked to the TradingOrder. TextCollection is a GDT of type TextCollection and can be optional. An Expense package groups together expense information about the TradingOrder. The Expense package includes the entity Expense.

An Expense is an expense information for the TradingOrder. The Expense can include the following elements: BearerInternalID, TypeGroupCode, TypeCode, AccountTypeCode, PostingTypeCode, CashDiscountTermsCode, and PriceSpecificationElement. The BearerInternalID is a unique identifier assigned to the bearer of the expense. The BearerInternalID is a GDT of type PartyInternalID and can be optional. The TypeGroupCode is used to group expense types. The TypeGroupCode is a GDT of type TradingOrderExpenseTypeGroupCode and can be optional. The TypeCode is the coded representation of the expense type. Together with the accounting type and the posting type, it controls vendor billing document type determination. The combination of vendor billing document type and expense type determines which condition is used as the planned expense condition. The TypeCode is a GDT of type TradingOrderExpenseTypeCode and can be optional. The AccountTypeCode controls the search for a vendor billing document type based on the posting key. The AccountTypeCode therefore controls whether a posting is made to a material account or a G/L (General Ledger) account (in this case with a certain posting key). The AccountTypeCode is a GDT of type TradingOrderExpenseAccountTypeCode and can be optional. The PostingTypeCode controls whether it is a billing document type on the vendor side or customer side, and the type of posting (payables, receivables, purely statistical without financial accounting document) for the vendor billing document. The PostingTypeCode is a GDT of type TradingOrderExpensePostingTypeCode and can be optional. The CashDiscountTermsCode is a coded representation of an agreement of cash discounts for a payment. The CashDiscountTermsCode is a GDT of type CashDiscountTermsCode and can be optional.

The PriceSpecificationElement is the specification of price, discount, surcharge, and tax that is valid. With the combination of Expense class category, Expense class type, Accounting type and Posting type, the PriceSpecificationElement can be determined. The PriceSpecificationElement is a GDT of type PriceSpecificationElement. The Expense entity has an attribute actionCode. The actionCode is a coded representation of an instruction telling how to process the expense. The actionCode is a GDT of type ActionCode. The Item package groups together the Item with its packages. The Item package includes the root node Item and the following packages: Party, Product, Location, Sales, Purchasing, BusinessTransactionDocumentReference, and TextCollection.

Item is identifying and administrative information of a product in a TradingOrder which, in addition to the schedule lines, includes all the data that applies to the item, for example, the product information, the parties involved, the sales/delivery/Customer Invoicing-specific agreements, status and references. The elements located directly at the Item entity can include: ID, PlantID and ProcessingTypeCode. The ID is a unique identifier for an item in the TradingOrder. The ID is a GDT of type TradingOrderItemID and can be optional. The PlantID is an identifier of a plant. The PlantID is a GDT of type PlantID and can be optional. The ProcessingTypeCode is a coded representation of the way in which an item is processed. The ProcessingTypeCode is a GDT of type BusinessTransactionDocumentItemProcessingTypeCode and can be optional. The Item entity can have the attribute actionCode, The ActionCode is a coded representation of the actions used to create, change and delete items in a trading process at the message recipient. The actionCode is a GDT of type ActionCode. In some implementations, if the ActionCode includes the value ‘01’ (Create) then the element ID might not be filled. For all other values of ActionCode, the element ID can be filled.

A Party Package groups together business parties involved in the Trading Order item. It can include the entities ProductRecipientParty, BillToParty, PayerParty, SellerParty, PayeeParty, ResponsibleEmployeeParty, and BillFromParty. A ProductRecipientParty is a party to which goods are delivered or for whom services are provided. The ProductRecipientParty includes the element InternalID. The InternalID is a unique identifier for the party to which goods are delivered or for whom services are provided. The InternalID is a GDT of type PartyInternalID.

A BillToParty is a party to which the invoice for goods or services is sent. The BillToParty includes the element InternalID. The InternalID is a unique identifier for the party to which the invoice for goods or services is sent. The InternalID is a GDT of type InternalID. A PayerParty is a party that pays for goods or services. The PayerParty includes the element InternalID. The InternalID is a unique identifier for the party that pays for goods or services. The InternalID is a GDT of type InternalID. A SellerParty is a party that sells goods or services. The SellerParty includes the element InternalID. The InternalID is a unique identifier for the party that pays for goods or services. The InternalID is a GDT of type PartyInternalID.

A PayeeParty is a party that receives payment for goods or services provided. The PayeeParty includes the element InternalID. The InternalID is a unique identifier for the party that pays for goods or services. The InternalID is a GDT of type PartyInternalID. A ResponsibleEmployeeParty is a party that is responsible for something. The party can be an internal or external employee. The ResponsibleEmployeeParty includes the element InternalID. The InternalID is a unique identifier for the party that pays for goods or services. The InternalID is a GDT of type PartyInternalID.

A BillFromParty is a party which issues the invoice for goods or services. The BillFromParty includes an InternalID element. The BillFromParty is a unique identifier for the party which issues the invoice for goods or services. The BillFromParty is a GDT of type PartyInternalID. A Product package groups together all the information for identifying, describing, and classifying a product in a trading process. The Product package includes the entity Product.

Product is the identification, description and classification of the product of an Item. The Product includes the elements InternalID, BuyerID and ManufacturerID. The InternalID is a proprietary identifier for the product ordered by the TradingOrder Item. The InternalID is a GDT of type ProductInternalID and can be optional. The BuyerID is an identifier for a product assigned by the buyer. The BuyerId is a GDT of type ProductPartyID and can be optional. The ManufacturerID is an identifier for the ordered product assigned by the manufacturer. The ManufacturerID is a GDT of type ProductPartyID and can be optional.

A Location Package groups together information about the places to which goods are delivered. The Location Package includes a Location entity. A Location is the location to which goods are delivered/supplied. It includes the element InternalID. The InternalID is a unique identifier for the location. The InternalID is a GDT of type LocationInternalID. A Sales package groups together the selling data of the TradingOrder item. The Sales package includes the root node Sales and the entities ScheduleLine, DeliveryTerms, TransportationNetwork, TransportMode, CashDiscountTerms, PricingTerms, TotalValues, SchedulingZone, and TransportationEvent.

A Sales is the selling part of the item. The elements located directly at the Sales entity are: BuyerPurchaseOrderID, ProductRecipientPurchaseOrderID, BuyerPurchaseOrderItemID, InvoicingBlockingReasonCode, CashDiscountDeductibleIndicator, PriceDeterminationDate, BuyerOrderingDate and ProductRecipientOrderingDate. The BuyerPurchaseOrderID is the identifier of the purchase order used by the buyer. The BuyerPurchaseOrderID is a GDT of type BusinessTransactionDocumentID and can be optional. The ProductRecipientPurchaseOrderID is the identifier of the purchase order used by the product recipient. The ProductRecipientPurchaseOrderID is a GDT of type BusinessTransactionDocumentID and can be optional. The BuyerPurchaseOrderItemID is the identifier of an item of the purchase order used by the buyer. The BuyerPurchaseOrderItemID is a GDT of type BusinessTransactionDocumentItemID and can be optional. The ProductRecipientPurchaseOrderItemID is the identifier of an item of the purchase order used by the product recipient. The ProductRecipientPurchaseOrderItemID is a GDT of type BusinessTransactionDocumentItemID and can be optional.

The InvoicingBlockingReasonCode is the coded representation for the reason why a TradingOrder Item Sales is blocked for invoicing. The InvoicingBlockingReasonCode is a GDT of type InvoicingBlockingReasonCode and can be optional. The CashDiscountDeductibleIndicator is an indicator that indicates whether a cash discount can be deducted or not. The CashDiscountDeductibleIndicator is a GDT of type Indicator with a qualifier of CashDiscountDeductible and can be optional. The PriceDeterminationDate is the date at which the price of a product is determined. The PriceDeterminationDate is a GDT of type Date with a qualifier of PriceDeterminationDate and can be optional. The BuyerOrderingDate is the date when the buyer's purchase order was ordered. The BuyerOrderingDate is a GDT of type Date with a qualifier of Ordering and can be optional. The ProductRecipientOrderingDate is the date when the product recipient's purchase order was ordered. The ProductRecipientOrderingDate is a GDT of type Date with a qualifier of Ordering and can be optional.

The Sales entity has the following attributes: scheduleLineListCompleteTransmissionIndicator, pricingTermsListCompleteTransmissionIndicator, transportModeListCompleteTransmissionIndicator and transportationEventListCompleteTransmissionIndicator. The scheduleLineListCompleteTransmissionIndicator indicates whether all schedule lines of an item sales are transmitted or not. The scheduleLineListCompleteTransmissionIndicator is a GDT of type Indicator with a qualifier of CompleteTransmission. The pricingTermsListCompleteTransmissionIndicator indicates whether all pricing terms of an item sales are transmitted or not. The pricingTermsListCompleteTransmissionIndicator is a GDT of type Indicator with a qualifier of CompleteTransmission. The transportModeListCompleteTransmissionIndicator indicates whether all transport modes of an item sales are transmitted or not. The transportModeListCompleteTransmissionIndicator is a GDT of type Indicator with a qualifier of CompleteTransmission. The transportationEventListCompleteTransmissionIndicator indicates whether all transportation events of an item sales are transmitted or not. The transportationEventListCompleteTransmissionIndicator is a GDT of type Indicator with a qualifier of CompleteTransmission.

A ScheduleLine is an agreement that specifies when and in what quantity products of an item sales are requested or provided. The ScheduleLine includes the elements ID, RequestedQuantity and DeliveryDate. The ID is a unique identifier for a ScheduleLine in the TradingOrder item sales. The ID is a GDT of type BusinessTransactionDocumentItemScheduleLineID and can be optional. The RequestedQuantity is the quantity that is requested for a ScheduleLine. The RequestedQuantity is a GDT of type Quantity with a qualifier of Requested and can be optional. The DeliveryDate is the date at which the delivery takes place. The DeliveryDate is a GDT of type Date with a qualifier of Delivery and can be optional.

The ScheduleLine entity has the attribute actionCode. The actionCode is the coded representation of the actions used to create, change and delete schedule lines for an item sales in a trading process at the message recipient. The actionCode is a GDT of type ActionCode. In some implementations, if the ActionCode includes the value ‘01’ (Create) then the element ID might not be filled. For all other values of ActionCode, the element ID can be filled.

DeliveryTerms are the item-specific conditions and agreements that are valid for executing the delivery of ordered material of the TradingOrder item sales. It can include the elements Incoterms, QuantityTolerance, and PartiaIDelivery. Incoterms are typical contract formulations for delivery conditions that correspond to the rules defined by the International Chamber of Commerce (ICC). Incoterms are a GDT of type Incoterms. QuantityTolerance is the tolerated difference between a requested and an actual quantity (e.g. a delivery quantity) as a percentage. QuantityTolerance is a GDT of type QuantityTolerance and can be optional. PartiaIDelivery is the maximum number of partial deliveries that may be carried out to deliver the ordered quantity of an item. PartiaIDelivery is a GDT of type PartiaIDelivery and can be optional.

TransportationNetwork is a single, in-transit stock-holding object used for inventory management purposes. The TransportationNetwork can include ID, which is a unique identifier of the transportation network. ID is a GDT of type TransportationNetworkID and can be optional. TransportMode is the way in which product is shipped. The TransportMode can include the element Code. The Code is an encoded representation of the mode of transportation. The Code is a GDT of type TransportModeCode and can be optional. The TransportMode entity has the attribute actionCode. The actionCode is a coded representation of the actions used to create, change and delete transport modes for an item sales in a trading process at the message recipient. The actionCode is a GDT of type ActionCode.

CashDiscountTerms is a set of control information which is relevant for payment in the TradingOrder item sales. CashDiscountTerms includes the elements Code and DueDate. The Code is a coded representation of an agreement of cash discounts for a payment. The Code is a GDT of type CashDiscountTermsCode and can be optional. The DueDate is the date on which the CashDiscountTerms related to the TradingOrder Item Sales becomes effective. The DueDate is a GDT of type Date with a qualifier of Due and can be optional.

PricingTerms is price information for the TradingOrder item sales. The PricingTerms includes the following elements: CommodityObjectCalculationStatusCode, EvaluationPeriodDataCompleteIndicator and ProvisionalCommodityTermAppliedIndicator. The CommodityObjectCalculationStatusCode is a coded representation of the calculation status of a commodity pricing object. The CommodityObjectCalculationStatusCode is a GDT of type CalculationStatusCode with a qualifier of CommodityObject and can be optional. The PriceComponent is a component of the calculated price. The PriceComponent is a GDT of type PriceComponent. The EvaluationPeriodDataCompleteIndicator indicates whether all data for period evaluation are taken into account or not. The EvaluationPeriodDataCompleteIndicator is a CDT of type Indicator with a qualifier of Complete and can be optional. The ProvisionalCommodityTermAppliedIndicator indicates whether a provisional commodity term is applied during a period evaluation or not. The ProvisionalCommodityTermAppliedIndicator is a CDT of type Indicator with a qualifier of Applied and can be optional.

The PricingTerms entity has the attribute actionCode. The ActionCode is the coded representation of the actions used to create, change and delete pricing terms for an item sales in a trading process at the message recipient. The ActionCode is a GDT of type ActionCode. TotalValues are the cumulated total values that occur in a TradingOrder item sales, for example, total gross and net weight, volume, gross and net amount, tax amount, and freight costs.

The TotalValues includes the elements Quantity, NetPrice, GrossWeightMeasure, NetWeightMeasure and VolumeMeasure. The Quantity is the total quantity of a product in a TradingOrder item sales. The Quantity is a GDT of type Quantity and can be optional. The NetPrice is the net price of a TradingOrder Item sales product referred to a base quantity. The NetPrice is a GDT of type Price with a qualifier of Net and can be optional.

The GrossWeightMeasure is the gross weight of the product in an item of a TradingOrder sales. The GrossWeightMeasure is a GDT of type Measure with a qualifier of GrossWeight and can be optional. The NetWeightMeasure is the net weight of the product in an item of a TradingOrder sales. The NetWeightMeasure is a GDT of type Measure with a qualifier of NetWeight and can be optional. The VolumeMeasure is the volume of the product in an item of a TradingOrder sales. The VolumeMeasure is a GDT of type Measure with a qualifier of Volume and can be optional.

SchedulingZone is a geographical place or zone used for scheduling of the TradingOrder sales item. The SchedulingZone can include the elements LocationInternalID and TransportationZoneID. The LocationInternalID is a unique identifier of the location into which or out of which the scheduling will take place. The LocationInternalID is a GDT of type LocationInternalID and can be optional. The TransportationZoneID is a unique identifier of the transportation zone into which or out of which the scheduling will take place. The TransportationZoneID is a GDT of type TransportationZoneID and can be optional. In some implementations, one of the two elements LocationInternalID and TransportationZoneID can be filled.

TransportationEvent is an event planned to take place in the transportation process within the overall supply and trading process related to the sales item. The TransportationEvent can include the elements OrdinalNumberValue, TypeCode, PriceRelevanceIndicator, LocationInternalID, PlannedStartDatePeriod, PlannedEndDatePeriod, DueDayNumberValue and InvertIndicator. The OrdinalNumberValue indicates the position of the transportation event in the list of transportation events related to the sales item. The OrdinalNumberValue is a GDT of type OrdinalNumberValue and can be optional. The TypeCode is an encoded representation of the type of a transportation event. The TypeCode is a GDT of type TransportationEventTypeCode. The PriceRelevanceIndicator is an indicator that indicates a transportation event which is relevant for price calculation. The PriceRelevanceIndicator is a GDT of type Indicator with a qualifier of Relevance and can be optional. The LocationInternalID is a unique identifier of the location at which the transportation event will happen. The LocationInternalID is a GDT of type LocationInternalID and can be optional. The PlannedStartDatePeriod is the period during which the transportation event is planned to start. The PlannedStartDatePeriod is a GDT of type UPPEROPEN_DatePeriod with a qualifier of Start and can be optional. The PlannedEndDatePeriod is the period during which the transportation event is planned to finish. The PlannedEndDatePeriod is a GDT of type UPPEROPEN_DatePeriod, Qualifier End and can be optional. The DueDayNumberValue is the number of days before the scheduling date when the transportation event is due. The DueDayNumberValue is a GDT of type NumberValue with a qualifier of Day and can be optional. The InvertIndicator is an indicator that indicates whether the DueDayNumberValue has to be inverted or not. The InvertIndicator is a GDT of type indicator with a qualifier Invert and can be optional.

The TransportationEvent entity has the attribute actionCode. The ActionCode is a coded representation of actions used to create, change and delete transportation events for an item sales in a trading process at the message recipient. The actionCode is a GDT of type ActionCode. If the ActionCode includes the value ‘01’ (Create) then the element OrdinalNumberValue might not be filled. For all other values of ActionCode, the element OrdinalNumberValue can be filled.

A Purchasing package groups together the buying data of the TradingOrder item. It includes the root node Purchasing and the entities ScheduleLine, DeliveryTerms, TransportationNetwork, TransportMode, CashDiscountTerms, PricingTerms, TotalValues, SchedulingZone, and TransportationEvent.

Purchasing is the buying part of the item. The elements located directly at the Purchasing entity are SellerReferenceID, ExchangeRateTypeCode, ExchangeRate, CashDiscountDeductibleIndicator, PriceDeterminationDate and QuotationValidityStartDate. The SellerReferenceID is a reference identifier of the seller. The SellerReferenceID is a GDT of type BusinessTransactionDocumentID and can be optional. The ExchangeRateTypeCode is a coded representation of the type of an exchange rate. It is related to the currency of the TradingOrder Item Purchasing. The ExchangeRateTypeCode is a GDT of type ExchangeRateTypeCode and can be optional. The ExchangeRate is a representation of an exchange rate between two currencies: the currency of the TradingOrder Item Purchasing and the local currency. The ExchangeRate is a GDT of type ExchangeRate and can be optional.

The CashDiscountDeductibleIndicator is an indicator that indicates whether a cash discount can be deducted or not. The CashDiscountDeductibleIndicator is a GDT of type Indicator with a qualifier of CashDiscountDeductible and can be optional. The PriceDeterminationDate is the date at which the price of a product is determined. The PriceDeterminationDate is a GDT of type Date with a qualifier of PriceDeterminationDate and can be optional. The Date is the date on which the purchasing document was created. The Date is a GDT of type Date and can be optional. The QuotationValidityStartDate is the date on which the seller submitted the quotation. The QuotationValidityStartDate is a GDT of type Date with a qualifier of ValidityStart and can be optional.

The Purchasing entity has the following attributes: scheduleLineListCompleteTransmissionIndicator, pricingTermsListCompleteTransmissionIndicator, transportModeListCompleteTransmissionIndicator and transportationEventListCompleteTransmissionIndicator. The scheduleLineListCompleteTransmissionIndicator indicates whether all schedule lines of an item purchasing are transmitted or not. The scheduleLineListCompleteTransmissionIndicator is a GDT of type Indicator with a qualifier of CompleteTransmission. The pricingTermsListCompleteTransmissionIndicator indicates whether all pricing terms of an item purchasing are transmitted or not. The pricingTermsListCompleteTransmissionIndicator is a GDT of type Indicator with a qualifier of CompleteTransmission.

The transportModeListCompleteTransmissionIndicator indicates whether all transport modes of an item purchase are transmitted or not. The transportModeListCompleteTransmissionIndicator is a GDT of type Indicator with a qualifier of CompleteTransmission. The transportationEventListCompleteTransmissionIndicator indicates whether all transportation events of an item purchase are transmitted or not. The transportationEventListCompleteTransmissionIndicator is a GDT of type Indicator with a qualifier of CompleteTransmission. A ScheduleLine is an agreement that specifies when and in what quantity products of an item are used by the buyer for the TradingOrder item purchasing.

The ScheduleLine can include the elements ID, RequestedQuantity, DeliveryDate and actionCode. The ID is the unique identifier for a ScheduleLine in the TradingOrder item purchasing. The ID is a GDT of type BusinessTransactionDocumentItemScheduleLineID and can be optional. The RequestedQuantity is the quantity that is requested for a ScheduleLine. The RequestedQuantity is a GDT of type Quantity with a qualifier of Requested and can be optional. The DeliveryDate is the date at which the delivery takes place. The DeliveryDate is a GDT of type Date with a qualifier of Delivery and can be optional.

The ScheduleLine entity has the attribute actionCode. The ActionCode is a coded representation of actions used to create, change and delete schedule lines for an item purchasing in a trading process at the message recipient. The actionCode is a GDT of type ActionCode. If the ActionCode includes the value ‘01’ (Create) then the element ID might not be filled. For all other values of ActionCode, the element ID can be filled.

DeliveryTerms are the conditions and agreements that are valid for executing the delivery of ordered material of TradingOrder item purchasing. DeliveryTerms can include the elements Incoterms and QuantityTolerance. Incoterms are typical contract formulations for delivery conditions that correspond to the rules defined by the International Chamber of Commerce (ICC). Incoterms is a GDT of type Incoterms and can be optional. QuantityTolerance is the tolerated difference between a requested and an actual quantity (e.g. a delivery quantity) as a percentage. The DeliveryTerms is a GDT of type QuantityTolerance and can be optional.

TransportationNetwork is a single, in-transit stock-holding object used for inventory management purposes. TransportationNetwork can optionally include ID, which is a unique identifier of the transportation Network. ID is a GDT of type TransportationNetworkID. TransportMode is the way in which product is shipped. A Code is an encoded representation of the mode of transportation. The Code is a GDT of type TransportModeCode and can be optional. The TransportMode entity has the attribute actionCode. The ActionCode is a coded representation of the actions used to create, change and delete transport modes for an item purchasing in a trading process at the message recipient. The actionCode is a GDT of type ActionCode.

CashDiscountTerms is a set of control information which is relevant for payment in the TradingOrder item purchasing. The CashDiscountTerms can include the elements Code and DueDate. The Code is a coded representation of an agreement of cash discounts for a payment. The Code is a GDT of type CashDiscountTermsCode and can be optional. The DueDate is the date on which the CashDiscountTerms related to the TradingOrder Item Purchasing becomes effective. The DueDate is a GDT of type Date with a qualifier of Due and can be optional. PricingTerms is price information for the TradingOrder item purchasing. PricingTerms includes the following elements: CommodityObjectCalculationStatusCode, PriceComponent, EvaluationPeriodDataCompleteIndicator, and ProvisionalCommodityTermAppliedIndicator.

CommodityObjectCalculationStatusCode is a coded representation of the calculation status of a commodity pricing object. CommodityObjectCalculationStatusCode is a GDT of type CalculationStatusCode with a qualifier of CommodityObject and can be optional. The PriceComponent is a component of the calculated price. The PriceComponent is a GDT of type PriceComponent. The EvaluationPeriodDataCompleteIndicator indicates whether all data for period evaluation are taken into account or not. The EvaluationPeriodDataCompleteIndicator is a CDT of type Indicator with a qualifier of Complete and can be optional. The ProvisionalCommodityTermAppliedIndicator indicates whether a provisional commodity term is applied during a period evaluation or not. The ProvisionalCommodityTermAppliedIndicator is a CDT of type Indicator with a qualifier of Applied and can be optional. The PricingTerms entity has the attribute actionCode. The ActionCode is the coded representation of the actions used to create, change and delete pricing terms for an item purchasing in a trading process at the message recipient. The actionCode is a GDT of type ActionCode.

TotalValues are cumulated total values that occur in a TradingOrder item purchasing, for example, gross and net weight, volume, gross and net amount, tax amount, and freight costs. TotalValues can include the elements Quantity, NetPrice, NetWeightMeasure, and VolumeMeasure. The Quantity is the total quantity of a product in a TradingOrder item purchasing. The Quantity is a GDT of type Quantity and can be optional. The NetPrice is the net price of a TradingOrder Item purchasing product referred to a base quantity. The NetPrice is a GDT of type Price with a qualifier of Net and can be optional. The GrossWeightMeasure is the gross weight of the product in an item of a TradingOrder purchasing. The GrossWeightMeasure is a GDT of type Measure with a qualifier of GrossWeight and can be optional. The NetWeightMeasure is the net weight of the product in an item of a TradingOrder purchasing. The NetWeightMeasure is a GDT of type Measure with a qualifier of NetWeight and can be optional. The VolumeMeasure is the volume of the product in an item of a TradingOrder purchasing. The VolumeMeasure is a GDT of type Measure with a qualifier of Volume and can be optional.

SchedulingZone is a geographical place or zone used for scheduling of the TradingOrder purchasing item. The LocationInternalID is a unique identifier of the location into which or out of which the scheduling will take place. The LocationInternalID is a GDT of type LocationInternalID and can be optional. The TransportationZoneID is a unique identifier of the transportation zone into which or out of which the scheduling will take place. The TransportationZoneID is a GDT of type TransportationZoneID and can be optional. In some implementations, one of the two elements LocationInternalID and TransportationZoneID can be filled.

TransportationEvent is an event planned to take place in the transportation process within the overall supply and trading process related to the purchasing item. An OrdinalNumberValue indicates the position of the transportation event in the list of transportation events related to the purchasing item. The OrdinalNumberValue is a GDT of type OrdinalNumberValue and can be optional. The TypeCode is an encoded representation of the type of a transportation event. The TypeCode is a GDT of type TransportationEventTypeCode and can be optional. The PriceRelevanceIndicator is an indicator that indicates a transportation event which is relevant for price calculation. The PriceRelevanceIndicator is a GDT of type Indicator with a qualifier of Relevance and can be optional. The LocationInternalID is a unique identifier of the location at which the transportation event will happen. The LocationInternalID is a GDT of type LocationInternalID and can be optional. The PlannedStartDatePeriod is the period during which the transportation event is planned to start. The PlannedStartDatePeriod is a GDT of type UPPEROPEN_DatePeriod with a qualifier of Start and can be optional. The PlannedEndDatePeriod is the period during which the transportation event is planned to finish. The PlannedEndDatePeriod is a GDT of type UPPEROPEN_DatePeriod with a qualifier of End and can be optional. The DueDayNumberValue is the number of days before the scheduling date when the transportation event is due. The DueDayNumberValue is a GDT of type NumberValue with a qualifier Day and can be optional. The InvertIndicator is an indicator that indicates whether the DueDayNumberValue has to be inverted or not. The InvertIndicator is a GDT of type Indicator with a qualifier of Invert and can be optional.

The TransportationEvent entity has the attribute actionCode. The ActionCode is a coded representation of actions used to create, change and delete transportation events for an item purchasing in a trading process at the message recipient. The actionCode is a GDT of type ActionCode. If the ActionCode includes the value ‘01’ (Create) then the element OrdinalNumberValue might not be filled. For all other values of ActionCode, the element OrdinalNumberValue can be filled. A BusinessTransactionDocumentReference package groups together all the references to business documents that are relevant for the item. It can include the entities OriginBusinessTransactionDocumentReference and TradingOrderReference. An OriginBusinessTransactionDocumentReference is a reference to the origin business transaction document. The OriginBusinessTransactionDocumentReference is a GDT of type BusinessTransactionDocumentReference and can be optional.

A TradingOrderReference is a reference to a trading order. The TradingOrderReference can include the following elements: ID and ItemID. The ID is an identifier of the referenced trading order. The ID is a GDT of type TradingOrderID and can be optional. The ItemID is an identifier of the referenced trading order item. The ItemID is a GDT of type TradingOrderItemID and can be optional. A TextCollection package groups together all the texts regarding the trading order item. The TextCollection can contain a TextCollection entity. TextCollection is a collection of text descriptions linked to the TradingOrder item. The TextCollection is of type GDT TextCollection and can be optional.

### Message Data Type TradingOrderReleaseRequestMessage

The message data type TradingOrderReleaseRequestMessage includes the business information that is relevant for sending a business document in a message and the TradingOrder object in the business document. The message data type TradingOrderReleaseRequestMessage includes following packages: MessageHeader and TradingOrder.

A MessageHeader package groups the business information that is relevant for sending a business document in a message. It can contain a MessageHeader entity. The MessageHeader groups business information from the perspective of the sending application and can include information to identify the business document in a message, information about the sender, and information about the recipient. The MessageHeader includes SenderParty and RecipientParty. The MessageHeader is a GDT of type BusinessDocumentMessageHeader, whereby the following elements of the GDT are used ID, ReferenceID, CreationDateTime, SenderParty, and RecipientParty.

The TradingOrder groups information needed to release a Trading Order. The TradingOrder can include the entity TradingOrder. The TradingOrder is a request to release a trading order with trading order number. The element located directly to the TradingOrder entity is the ID. The ID is a unique identifier of the TradingOrder. The ID is a GDT of type TradingOrderID.

### Message Data Type TradingOrderCancelRequestMessage

The message data type TradingOrderCancelRequestMessage includes the business information that is relevant for sending a business document in a message and the TradingOrder object in the business document. The TradingOrderCancelRequestMessage includes the following packages: MessageHeader and TradingOrder. A MessageHeader package groups the business information that is relevant for sending a business document in a message. It can include a MessageHeader entity. The MessageHeader groups business information from the perspective of the sending application and can include information to identify the business document in a message, information about the sender, and information about the recipient. The MessageHeader includes SenderParty and RecipientParty. The MessageHeader is a GDT of type BusinessDocumentMessageHeader, whereby the following elements of the GDT are used ID, ReferenceID, CreationDateTime, SenderParty, and RecipientParty.

The TradingOrder package includes the TradingOrder. The TradingOrder is a request to cancel a Trading Order with trading order number. The element located directly to the TradingOrder entity is ID. The ID is a unique identifier of the TradingOrder. The TradingOrders is a GDT of type TradingOrderID.

### Message Data Type TradingOrderConfirmationMessage

The message data type TradingOrderConfirmationMessage includes the business information that is relevant for sending a business document in a message, the TradingOrder included in the business document and the information of the message log. The TradingOrderConfirmationMessage can include the packages MessageHeader, TradingOrder and Log.

A MessageHeader package groups the business information that is relevant for sending a business document in a message. The MessageHeader package can include a MessageHeader entity. The MessageHeader groups business information from the perspective of the sending application and can include information to identify the business document in a message, information about the sender, and information about the recipient. The MessageHeader includes SenderParty and RecipientParty. The MessageHeader is a GDT of type BusinessDocumentMessageHeader, whereby the following elements of the GDT are used: ID, ReferenceID, CreationDateTime, SenderParty, and RecipientParty.

The TradingOrder package includes TradingOrder. The TradingOrder is a response for requests such as TradingOrderRequest, TradingOrderReleaseRequest or TradingOrderCancelRequest. The elements located directly at the TradingOrder entity are ID and ExternalTradingOrderID. The ID is a unique identifier of the TradingOrder. The ID is a GDT of type TradingOrderID and can be optional. The ExternalTradingOrderID is a unique identifier given by the receiving system for the TradingOrder. The ExternalTradingOrderID is a GDT of type BusinessTransactionDocumentID and can be optional. A Log package groups the messages used for user interaction. It can contain a log entity. A log is a sequence of messages that result when an application executes a task. The entity Log is a GDT of type Log.

### Message Data Type TradingOrderByIDQueryMessage_sync

The message data type TradingOrderByIDQueryMessage_sync includes the TradingOrder object in a business document. The TradingOrderByIDQueryMessage includes the Selection package. The Selection package includes the selection criteria for a TradingOrder. It includes the entity TradingOrderSelectionByID. TradingOrderSelectionByID specifies criteria to select a TradingOrder. The element located directly at the TradingOrderSelectionByID entity is the ID. The ID is a unique identifier of the TradingOrder. The ID is a GDT of type TradingOrderID.

### Message Data Type TradingOrderByIDResponseMessage_sync

The message data type TradingOrderByIDResponseMessage_sync includes the TradingOrder object in the business document and the information of the message log. The TradingOrderByIDResponseMessage_sync can include the TradingOrder package included in the business object, and the Log package. A TradingOrder package groups together the TradingOrder and its packages. The TradingOrder has the TradingOrder as root node. The TradingOrder includes the packages Party, TradingChannel, TotalValues, Sales, Purchasing, TextCollection, Expense and Item.

A TradingOrder is, on one hand, a request from an ordering party to trade (receive materials) with contractors (order recipients) where a sales area receives the order and becomes responsible for fulfilling the contract. On the other hand, a TradingOrder can also be a request or instruction from a purchasing organization to a vendor (external supplier) or a plant to deliver a certain quantity of material at a certain point in time. In addition, a TradingOrder can also be a request which combines the selling as well as the buying view to support a typical Trade Scenario (Back to Back Scenario) where a trade organization becomes responsible for fulfilling the contract.

The elements located directly at the TradingOrder entity are ID, ExternalTradingOrderID, TypeCode, TradingProcessVariantTypeCode, ExchangeRateTypeCode, LifeCycleStatusCode, ValidityDate, SystemAdministrativeData and ExchangeRate. The ID is a unique identifier of the TradingOrder. The ID is a GDT of type TradingOrderID. The ExternalTradingOrderID is a unique identifier given by the sending system for the TradingOrder. The ExternalTradingOrderID is a GDT of type BusinessTransactionDocumentID and can be optional. The TypeCode is an encoded representation of a TradingOrder within a trading order processing. The TypeCode determines the price determination schema for calculating the purchasing and sales price and also affects which fields have to be maintained. The TypeCode is a GDT of type TradingOrderTypeCode. The TradingProcessVariantTypeCode is a coded representation of a trading process variant type. The TradingProcessVariantTypeCode determines the character of a trading process variant. The TradingProcessVariantTypeCode represents a typical way of processing within a trading process component from a business point of view. The TradingProcessVariantTypeCode is a GDT of type TradingProcessVariantTypeCode. The ExchangeRateTypeCode is a coded representation of the type of an exchange rate. It is related to the currency of the TradingOrder. The ExchangeRateTypeCode is a GDT of type ExchangeRateTypeCode. The LifeCycleStatusCode is a coded representation of the life cycle status of a TradingOrder. The LifeCycleStatusCode is a GDT of type TradingOrderLifeCycleStatusCode. The ValidityDate is the date at which a TradingOrder becomes effective from a business perspective. The ValidityDate is a GDT of type Date with a qualifier of Validity and can be optional. The SystemAdministrativeData is administrative data that is stored in a system. The data includes system users and change dates/times. The SystemAdministrativeData is a GDT of type SystemAdministrativeData.

The ExchangeRate is the representation of an exchange rate between two currencies: the currency of the TradingOrder and the local currency. The ExchangeRate is a GDT of type ExchangeRate. The ExchangeRate depends on the TradingOrderTypeCode of the TradingOrder whether the PricingTerms for sales and purchasing on header- and on item-level are considered or not. Bill of Materials related information may not be supported. Therefore, in some implementations, no relationships between Bill of Material items are passed.

A Party Package groups together all the business parties involved in the Trading Order. It can include the entities BuyerParty, ProductRecipientParty, BillToParty, PayerParty, SellerParty, PayeeParty, ResponsibleEmployeeParty, SalesOrganizationParty, PurchasingOrganizationParty, PurchasingGroupParty, and BillFromParty.

A BillFromParty is a party which issues an invoice for goods or services. The BillFromParty package includes an InternalID element. InternalID is a unique identifier for the party which issues the invoice for goods or services. The InternalID is a GDT of type PartyInternalID.

A TotalValues package groups the total values of a TradingOrder. The TotalValues includes the entity TotalValues. TotalValues are cumulated total values that occur in a TradingOrder, for example, total gross and net weight, volume, gross and net amount, tax amount, and freight costs. TotalValues includes the element NetAmount. The NetAmount is the total net amount of the TradingOrder. The NetAmount is a GDT of type Amount with a qualifier of Net and can be optional.

A Sales package groups together the selling data of the TradingOrder. The Sales package includes the root node Sales and the following entities: DeliveryTerms, CashDiscountTerms, PricingTerms, and TaxationTerms. Sales is the selling part of the TradingOrder. The elements located directly at the Sales entity are BuyerPurchaseOrderID, ProductRecipientPurchaseOrderID, ExchangeRateTypeCode, DeliveryBlockingReasonCode, InvoicingBlockingReasonCode, ExchangeRate, BuyerOrderingDate and ProductRecipientOrderingDate. The BuyerPurchaseOrderID is an identifier of the purchase order used by the buyer. The BuyerPurchaseOrderID is a GDT of type BusinessTransactionDocumentID and can be optional. The ProductRecipientPurchaseOrderID is an identifier of the purchase order used by the product recipient. The ProductRecipientPurchaseOrderID is a GDT of type BusinessTransactionDocumentID and can be optional. The ExchangeRateTypeCode is a coded representation of the type of an exchange rate. The ExchangeRateTypeCode is related to the currency of the TradingOrder Sales. The ExchangeRateTypeCode is a GDT of type ExchangeRateTypeCode.

The DeliveryBlockingReasonCode is a coded representation for the reason why a TradingOrder Sales is blocked for delivery. The DeliveryBlockingReasonCode is a GDT of type DeliveryBlockingReasonCode and can be optional. The InvoicingBlockingReasonCode is a coded representation for the reason why a TradingOrder Sales is blocked for invoicing. The InvoicingBlockingReasonCode is a GDT of type InvoicingBlockingReasonCode and can be optional. The ExchangeRate is a representation of an exchange rate between two currencies: the currency of the TradingOrder Sales and the local currency. The ExchangeRate is a GDT of type ExchangeRate. The BuyerOrderingDate is the date when the buyer's purchase order was ordered. The BuyerOrderingDate is a GDT of type Date with a qualifier of Ordering and can be optional. The ProductRecipientOrderingDate is the date when the product recipient's purchase order was ordered. The ProductRecipientOrderingDate is a GDT of type Date with a qualifier of Ordering and can be optional.

DeliveryTerms are conditions and agreements that are valid for executing the delivery of ordered materials. The DeliveryTerms includes an Incoterms element which can be optional. Incoterms are typical contract formulations for delivery conditions that correspond to the rules defined by the International Chamber of Commerce (ICC). Incoterms is a GDT of type Incoterms.

CashDiscountTerms is a set of control information which is relevant for payment in the TradingOrder sales document. The CashDiscountTerms can include the elements Terms and DueDate. The Terms is an agreement of cash discount terms for a payment. The Terms is a GDT of type CashDiscountTerms and can be optional. The DueDate is the date on which the CashDiscountTerms related to the TradingOrder Sales becomes effective. The DueDate GDT is of type Date with a qualifier Due can be optional.

PricingTerms is price information for the TradingOrder sales document. It includes the following elements: CommodityObjectCalculationStatusCode, PriceComponent, EvaluationPeriodDataCompleteIndicator and ProvisionalCommodityTermAppliedIndicator.

The CommodityObjectCalculationStatusCode is a coded representation of the calculation status of a commodity pricing object. The CommodityObjectCalculationStatusCode is a GDT of type CalculationStatusCode with a qualifier of CommodityObject and can be optional. The PriceComponent is a component of the calculated price. The PriceComponent is a GDT of type PriceComponent. The EvaluationPeriodDataCompleteIndicator indicates whether all data for period evaluation are taken into account or not. The EvaluationPeriodDataCompleteIndicator is a CDT of type indicator with a qualifier of Complete. The ProvisionalCommodityTermAppliedIndicator indicates whether a provisional commodity term is applied during a period evaluation or not. The ProvisionalCommodityTermAppliedIndicator is a CDT of type Indicator with a qualifier of Applied and can be optional.

TaxationTerms is tax information for the TradingOrder sales document. The TaxationTerms can include the elements DestinationCountryCode, OriginCountryCode, and EuropeanCommunityVATTriangulationIndicator. A Purchasing package groups together the buying data of the TradingOrder. The Purchasing package includes the root node Purchasing and the entities DeliveryTerms, CashDiscountTerms, and PricingTerms.

Purchasing is the buying part of the TradingOrder. The elements located directly at the Purchasing entity are SellerReferenceID, ExchangeRateTypeCode, ExchangeRate, Date and QuotationValidityStartDate. The SellerReferenceID is a reference identifier of the seller. The SellerReferenceID is a GDT of type BusinessTransactionDocumentID and can be optional. The ExchangeRateTypeCode is a coded representation of the type of an exchange rate. The ExchangeRateTypeCode is related to the currency of the TradingOrder Purchasing. The ExchangeRateTypeCode is a GDT of type ExchangeRateTypeCode. The ExchangeRate is the representation of an exchange rate between two currencies: the currency of the TradingOrder Purchasing and the local currency. The ExchangeRate is a GDT of type ExchangeRate. The Date is the Date on which the purchasing document was created. The Date is a GDT of type Date and can be optional. The QuotationValidityStartDate is the date on which the seller submitted the quotation. The QuotationValidityStartDate is a GDT of type Date with a qualifier of ValidityStart and can be optional.

DeliveryTerms are the conditions and agreements that are valid for executing the delivery of ordered materials. The DeliveryTerms can contain an Incoterms element which can be optional. Incoterms are typical contract formulations for delivery conditions that correspond to the rules defined by the International Chamber of Commerce (ICC). DeliveryTerms is a GDT of type Incoterms.

CashDiscountTerms is a set of control information which is relevant for payment in the TradingOrder purchasing document. The CashDiscountTerms includes the elements Terms and DueDate. The Terms is an agreement of cash discount terms for a payment. The Terms is a GDT of type CashDiscountTerms. The DueDate is the date on which the CashDiscountTerms related to the TradingOrder Purchasing becomes effective. The DueDate is a GDT of type DateQualifier Due and can be optional.

PricingTerms is price information for the TradingOrder purchasing document. The PricingTerms includes the following elements: CommodityObjectCalculationStatusCode, PriceComponent, EvaluationPeriodDataCompleteIndicator and ProvisionalCommodityTermAppliedIndicator. The CommodityObjectCalculationStatusCode is a coded representation of the calculation status of a commodity pricing object. The CommodityObjectCalculationStatusCode is a GDT of type CalculationStatusCode with a qualifier of CommodityObject and can be optional. The PriceComponent is a component of the calculated price. The PriceComponent is a GDT of type PriceComponent. The EvaluationPeriodDataCompleteIndicator indicates whether all data for period evaluation are taken into account or not. The EvaluationPeriodDataCompleteIndicator is a CDT of type Indicator with a qualifier: Complete and can be optional. The ProvisionalCommodityTermAppliedIndicator indicates whether a provisional commodity term is applied during a period evaluation or not. The ProvisionalCommodityTermAppliedIndicator is a CDT of type Indicator with a qualifier of Applied and can be optional.

A TextCollection package groups together texts regarding the TradingOrder. It can contain a TextCollection entity. TextCollection is a collection of text descriptions linked to the TradingOrder. TextCollection is a GDT of type TextCollection and can be optional. An Expense package groups together expense information about the TradingOrder. It includes the entity Expense.

Expense includes expense information for the TradingOrder. Expense can include the following elements: BearerInternalID, TypeGroupCode, TypeCode, AccountTypeCode, PostingTypeCode, CashDiscountTermsCode, PriceSpecificationElement and CancelledIndicator. The BearerInternalID is a unique identifier assigned to the bearer of the expense. The BearerInternalID is a GDT of type PartyInternalID and can be optional. The TypeGroupCode is used to group expense types. The BearerInternalID is a GDT of type TradingOrderExpenseTypeGroupCode and can be optional. The TypeCode is a coded representation of the expense type. Together with the accounting type and the posting type, it controls vendor billing document type determination. The combination of vendor billing document type and expense type determines which condition is used as the planned expense condition. The TypeCode is a GDT of type TradingOrderExpenseTypeCode and can be optional.

The AccountTypeCode controls the search for a vendor billing document type based on the posting key. It therefore controls whether a posting is made to a material account or a G/L account (in this case with a certain posting key). The AccountTypeCode is a GDT of type TradingOrderExpenseAccountTypeCode and can be optional. The PostingTypeCode controls whether it is a billing document type on the vendor side or customer side, and the type of posting (payables, receivables, purely statistical without financial accounting document) for the vendor billing document. The PostingTypeCode is a GDT of type TradingOrderExpensePostingTypeCode and can be optional. The CashDiscountTermsCode is a coded representation of an agreement of cash discounts for a payment. The CashDiscountTermsCode is a GDT of type CashDiscountTermsCode. The PriceSpecificationElement is a specification of price, discount, surcharge, and tax that is valid. With the combination of Expense class category, Expense class type, Accounting type and Posting type, the PriceSpecificationElement can be determined. The PriceSpecificationElement is a GDT of type PriceSpecificationElement. The CancelledIndicator is an indicator that indicates that the Expense is cancelled. The CancelledIndicator is a GDT of type Indicator with a qualifier of Cancelled and can be optional.

The Item package groups together the Item with its packages. The Item Package can include the root node Item and the packages Party, Product, Location, Sales, Purchasing, BusinessTransactionDocumentReference, and TextCollection. Item is identifying and administrative information of a product in a TradingOrder which, in addition to the schedule lines, includes all the data that applies to the item, for example, the product information, the parties involved, the sales/delivery/Customer Invoicing-specific agreements, status and references, etc.

The elements located directly at the Item entity are ID, PlantID, ProcessingTypecode and CancelledIndicator. The ID is a unique identifier for an item in the TradingOrder and is of type GDT: TradingOrderItemID. The PlantID is the identifier of a plant and is of type GDT: PlantID and can be optional. The ProcessingTypeCode is the coded representation of the way in which an item is processed. The ProcessingTypeCode is a GDT of type BusinessTrans actionDocumentItemProcessingTypeCode.

The CancelledIndicator is an indicator that indicates that the TradingOrder item is cancelled. The CancelledIndicator is a GDT of type Indicator with a qualifier of Cancelled and can be optional. A Party Package groups together all the business parties involved in the Trading Order item. The Party Package can includes the entities ProductRecipientParty, BillToParty, PayerParty, SellerParty, PayeeParty, ResponsibleEmployeeParty, and BillFromParty.

A BillFromParty is a party which issues the invoice for goods or services. The BillFromParty includes an InternalID element. The BillFromParty is a unique identifier for the party which issues the invoice for goods or services. The BillFromParty is a GDT of type PartyInternalID. The Location package groups together information about the places to which goods are delivered. The Location package includes a Location entity. A Sales package groups together the selling data of the TradingOrder item. The Sales package includes the root node Sales and the entities ScheduleLine, DeliveryTerms, TransportationNetwork, TransportMode, CashDiscountTerms, PricingTerms, TotalValues, SchedulingZone, and TransportationEvent.

Sales is the selling part of the item. The elements located directly at the Sales entity are BuyerPurchaseOrderID, ProductRecipientPurchaseOrderID, BuyerPurchaseOrderItemID, ProductRecipientPurchaseOrderItemID, InvoicingBlockingReasonCode, CancellationReasonCode, CashDiscountDeductibleIndicator, PriceDeterminationDate, BuyerOrderingDate and ProductRecipientOrderingDate. The BuyerPurchaseOrderID is an identifier of the purchase order used by the buyer. The BuyerPurchaseOrderID is a GDT of type BusinessTransactionDocumentID and can be optional. The ProductRecipientPurchaseOrderID is an identifier of the purchase order used by the product recipient. The ProductRecipientPurchaseOrderID is a GDT of type BusinessTransactionDocumentID and can be optional. The BuyerPurchaseOrderItemID is an identifier of an item of the purchase order used by the buyer. The BuyerPurchaseOrderItemID is a GDT of type BusinessTransactionDocumentItemID and can be optional. The ProductRecipientPurchaseOrderItemID is an identifier of an item of the purchase order used by the product recipient. The ProductRecipientPurchaseOrderItemID is a GDT of type BusinessTransactionDocumentItemID and can be optional.

The InvoicingBlockingReasonCode is a coded representation for the reason why a TradingOrder Item Sales is blocked for invoicing. The InvoicingBlockingReasonCode is a GDT of type InvoicingBlockingReasonCode and can be optional. The CancellationReasonCode is a coded representation for the reason for a cancellation of the TradingOrder Item Sales. The CancellationReasonCode is a GDT of type CancellationReasonCode and can be optional.

The CashDiscountDeductibleIndicator is an indicator that indicates whether a cash discount can be deducted or not. The CashDiscountDeductibleIndicator is a GDT of type Indicator with a qualifier of CashDiscountDeductible and can be optional. The PriceDeterminationDate is the date at which the price of a product is determined. The PriceDeterminationDate is a GDT of type Date with a qualifier of PriceDeterminationDate. The BuyerOrderingDate is the date when the buyer's purchase order was ordered. The BuyerOrderingDate is a GDT of type Date with a qualifier of Ordering and can be optional. The ProductRecipientOrderingDate is the date when the product recipient's purchase order was ordered. The ProductRecipientOrderingDate is a GDT of type Date with a qualifier of Ordering.

A ScheduleLine is an agreement that specifies when and in what quantity products of an item sales are requested or provided. The ScheduleLine includes the elements ID, RequestedQuantity and DeliveryDate. The ID is a unique identifier for a ScheduleLine in the TradingOrder item sales. The ID is a GDT of type BusinessTransactionDocumentItemScheduleLineID. The RequestedQuantity is the quantity that is requested for a ScheduleLine. The RequestedQuantity is a GDT of type Quantity with a qualifier of Requested and can be optional. The DeliveryDate is the date at which the delivery takes place. The DeliveryDate is a GDT of type Date with a qualifier of Delivery and can be optional.

DeliveryTerms are item-specific conditions and agreements that are valid for executing the delivery of ordered material of the TradingOrder item sales. The DeliveryTerms can include the elements Incoterms, QuantityTolerance, and PartiaIDelivery. Incoterms are typical contract formulations for delivery conditions that correspond to the rules defined by the International Chamber of Commerce (ICC). Incoterms are a GDT of type Incoterms. QuantityTolerance is the tolerated difference between a requested and an actual quantity (e.g. a delivery quantity) as a percentage. QuantityTolerance is a GDT of type QuantityTolerance and can be optional. PartiaIDelivery is the maximum number of partial deliveries that may be carried out to deliver the ordered quantity of an item. PartiaIDelivery is a GDT of type PartiaIDelivery and can be optional.

TransportationNetwork is a single, in-transit stock-holding object used for inventory management purposes. The TransportationNetwork can include ID, which is a unique identifier of the transportation network. ID is a GDT of type TransportationNetworkID and can be optional. TransportModeCode is the way in which product is shipped. The TransportModeCode is the encoded representation of the mode of transportation. The TransportModeCode is a GDT of type TransportModeCode and can be optional.

CashDiscountTerms is a set of control information which is relevant for payment in the TradingOrder item sales. The CashDiscountTerms can include the elements Terms and DueDate. The Terms are an agreement of cash discount terms for a payment. The Terms are a GDT of type CashDiscountTerms and can be optional. The DueDate is the date on which the CashDiscountTerms related to the TradingOrder Item Sales becomes effective. The DueDate is a GDT of type Date with a qualifier Due and can be optional.

PricingTerms is price information for the TradingOrder item sales. The PricingTerms can include the following elements: CommodityObjectCalculationStatusCode, PriceComponent, EvaluationPeriodDataCompleteIndicator and ProvisionalCommodityTermAppliedIndicator. The CommodityObjectCalculationStatusCode is a coded representation of the calculation status of a commodity pricing object. The CommodityObjectCalculationStatusCode is a GDT of type CalculationStatusCode with a qualifier of CommodityObject and can be optional. The PriceComponent is a component of the calculated price. The PriceComponent GDT of type PriceComponent. The EvaluationPeriodDataCompleteIndicator indicates whether all data for period evaluation are taken into account or not. The EvaluationPeriodDataCompleteIndicator is a CDT of type Indicator with a qualifier of Complete and can be optional. The ProvisionalCommodityTermAppliedIndicator indicates whether a provisional commodity term is applied during a period evaluation or not. The ProvisionalCommodityTermAppliedIndicator is a CDT of type Indicator with a qualifier of Applied and can be optional.

TotalValues are cumulated total values that occur in a TradingOrder item sales, for example, total gross and net weight, volume, gross and net amount, tax amount, and freight costs. The TotalValues can include the following elements: Quantity, NetPrice, NetAmount, GrossWeightMeasure, NetWeightMeasure, VolumeMeasure, and CashDiscountAmount. The Quantity is the total quantity of a product in a TradingOrder item sales. The Quantity is a GDT of type Quantity and can be optional. The NetPrice is the net price of a TradingOrder Item sales product referred to a base quantity. The NetPrice is a GDT of type Price with a qualifier of Net and can be optional. The NetAmount is the total net amount of the TradingOrder item sales. The NetAmount is a GDT of type Amount with a qualifier of type Net and can be optional. The GrossWeightMeasure is the Gross weight of the product in an item of a TradingOrder sales. The GrossWeightMeasure is a GDT of type Measure with a qualifier of GrossWeight and can be optional. The NetWeightMeasure is the net weight of the product in an item of a TradingOrder sales. The NetWeightMeasure is a GDT of type Measure with a qualifier of NetWeight and can be optional. The VolumeMeasure is the volume of the product in an item of a TradingOrder sales. The VolumeMeasure is a GDT of type Measure with a qualifier of Volume and can be optional. The CashDiscountAmount is the amount of the TradingOrder item sales which is eligible for cash discount. The CashDiscountAmount is a GDT of type Amount with a qualifier of CashDiscount and can be optional.

SchedulingZone is a geographical place or zone used for scheduling of the TradingOrder sales item. The LocationInternalID is a unique identifier of the location into which or out of which the scheduling will take place. The LocationInternalID is a GDT of type LocationInternalID and can be optional. The TransportationZoneID is a unique identifier of the transportation zone into which or out of which the scheduling will take place. The TransportationZoneID is a GDT of type TransportationZoneID and can be optional.

TransportationEvent is an event planned to take place in the transportation process within the overall supply and trading process related to the sales item. The OrdinalNumberValue indicates the position of the transportation event in the list of transportation events related to the sales item. The OrdinalNumberValue is a GDT of type OrdinalNumberValue. The TypeCode is an encoded representation of the type of a transportation event. The TypeCode is a GDT of type TransportationEventTypeCode. The PriceRelevanceIndicator is the indicator that indicates a transportation event which is relevant for price calculation. The PriceRelevanceIndicator is a GDT of type Indicator with a qualifier of Relevance and can be optional. The LocationInternalID is a unique identifier of the location at which the transportation event will happen. The LocationInternalID is a GDT of type LocationInternalID and can be optional. The PlannedStartDatePeriod is the period during which the transportation event is planned to start. The PlannedStartDatePeriod is a GDT of type UPPEROPEN_DatePeriod with a qualifier of Start and can be optional. The PlannedEndDatePeriod is the period during which the transportation event is planned to finish. The PlannedEndDatePeriod is a GDT of type UPPEROPEN_DatePeriod with a qualifier of End and can be optional. The DueDayNumberValue is the number of days before the scheduling date when the transportation event is due. The DueDayNumberValue is a GDT of type NumberValue with a qualifier of Day and can be optional. The InvertIndicator is an indicator that indicates whether the DueDayNumberValue has to be inverted or not. The InvertIndicator is a GDT of type Indicator with a qualifier of Invert and can be optional.

A Purchasing package groups together selling data of the TradingOrder item. The Purchasing package includes the root node Purchasing and the entities ScheduleLine, DeliveryTerms, TransportationNetwork, TransportMode, CashDiscountTerms, PricingTerms, TotalValues, SchedulingZone, and TransportationEvent.

Purchasing is the buying part of the item. The elements located directly at the Purchasing entity are SellerReferenceID, ExchangeRateTypeCode, ExchangeRate, CashDiscountDeductibleIndicator, CancelledIndicator, PriceDeterminationDate, Date and QuotationValidityStartDate. The SellerReferenceID is a reference identifier of the seller. The SellerReferenceID is a GDT of type BusinessTransactionDocumentID and can be optional. The ExchangeRateTypeCode is a coded representation of the type of an exchange rate. It is related to the currency of the TradingOrder Item Purchasing. The ExchangeRateTypeCode is a GDT of type ExchangeRateTypeCode and can be optional. The ExchangeRate is the representation of an exchange rate between two currencies: the currency of the TradingOrder Item Purchasing and the local currency. The ExchangeRate is a GDT of type ExchangeRate and can be optional. The CashDiscountDeductibleIndicator is an indicator that indicates whether a cash discount can be deducted or not. The CashDiscountDeductibleIndicator is a GDT of type Indicator with a qualifier of CashDiscountDeductible and can be optional. The CancelledIndicator is an indicator that indicates that the TradingOrder Item Purchasing is cancelled. The CancelledIndicator is a GDT of type Indicator with a qualifier of Cancelled and can be optional. The PriceDeterminationDate is the date at which the price of a product is determined. The PriceDeterminationDate is a GDT of type Date with a qualifier of PriceDeterminationDate and can be optional. The Date is the date on which the purchasing document was created. The Date is a GDT of type Date and can be optional. The QuotationValidityStartDate is the date on which the seller submitted the quotation. The QuotationValidityStartDate is a GDT of type Date with a qualifier of ValidityStart and can be optional.

A ScheduleLine is an agreement that specifies when and in what quantity products of an item are used by the buyer for the TradingOrder item purchasing. The ScheduleLine can include the following elements: ID, RequestedQuantity and DeliveryDate. The ID is the unique identifier for a ScheduleLine in the TradingOrder item purchasing. The ID is a GDT of type BusinessTransactionDocumentItemScheduleLineID. The RequestedQuantity is the quantity that is requested for a ScheduleLine. The RequestedQuantity is a GDT of type Quantity with a qualifier of Requested and can be optional. The DeliveryDate is the date at which the delivery takes place. The DeliveryDate is a GDT of type Date with a qualifier of Delivery and can be optional.

DeliveryTerms are conditions and agreements that are valid for executing the delivery of ordered material of TradingOrder item purchasing. DeliveryTerms can contain the elements Incoterms and QuantityTolerance. Incoterms are typical contract formulations for delivery conditions that correspond to the rules defined by the International Chamber of Commerce (ICC). Incoterms are a GDT of type Incoterms and can be optional. QuantityTolerance is the tolerated difference between a requested and an actual quantity (e.g. a delivery quantity) as a percentage. The DeliveryTerms is a GDT of type QuantityTolerance and can be optional.

TransportationNetwork is a single, in-transit stock-holding object used for inventory management purposes. TransportationNetwork can optionally include ID, which is a unique identifier of the transportation Network. ID is a GDT of type TransportationNetworkID. TransportMode is the way in which product is shipped. The TransportMode is an encoded representation of the mode of transportation. The TransportMode is a GDT of type TransportModeCode and can be optional.

CashDiscountTerms is a set of control information which is relevant for payment in the TradingOrder item purchasing. The CashDiscountTerms can include the elements Terms and DueDate. The Terms is an agreement of cash discount terms for a payment. The Terms is a GDT of type CashDiscountTerms and can be optional. The DueDate is the date on which the CashDiscountTerms related to the TradingOrder Item Purchasing becomes effective. The DueDate is a GDT of type Date with a qualifier of Due and can be optional.

PricingTerms is price information for the TradingOrder item purchasing. The PricingTerms can contain the following elements: CommodityObjectCalculationStatusCode, PriceComponent, EvaluationPeriodDataCompleteIndicator and ProvisionalCommodityTermAppliedIndicator. The CommodityObjectCalculationStatusCode is a coded representation of the calculation status of a commodity pricing object. The CommodityObjectCalculationStatusCode is a GDT of type CalculationStatusCode with a qualifier of CommodityObject and can be optional. The PriceComponent is a component of the calculated price. The PriceComponent is a GDT of type PriceComponent. The EvaluationPeriodDataCompleteIndicator indicates whether all data for period evaluation are taken into account or not. The EvaluationPeriodDataCompleteIndicator is a CDT of type Indicator with a qualifier of Complete and can be optional. The ProvisionalCommodityTermAppliedIndicator indicates whether a provisional commodity term is applied during a period evaluation or not. The ProvisionalCommodityTermAppliedIndicator is a CDT of type Indicator with a qualifier of Applied and can be optional.

TotalValues are cumulated total values that occur in a TradingOrder item purchasing, for example, gross and net weight, volume, gross and net amount, tax amount, and freight costs. The TotalValues can contain the following elements: Quantity, NetPrice, NetAmount, GrossWeightMeasure, NetWeightMeasure, VolumeMeasure and CashDiscountAmount.

The Quantity is the total quantity of a product in a TradingOrder item purchasing. The Quantity is a GDT of type Quantity and can be optional. The NetPrice is the net price of a TradingOrder Item purchasing product referred to a base quantity. The NetPrice is a GDT of type Price with a qualifier of Net and can be optional. The NetAmount is the total net amount of the TradingOrder item purchasing. The NetAmount is a GDT of type Amount with a qualifier of Net and can be optional. The GrossWeightMeasure is the gross weight of the product in an item of a TradingOrder purchasing. The GrossWeightMeasure is a GDT of type Measure with a qualifier of GrossWeight and can be optional. The NetWeightMeasure is the net weight of the product in an item of a TradingOrder purchasing. The NetWeightMeasure is a GDT of type Measure with a qualifier of NetWeight and can be optional. The VolumeMeasure is the Volume of the product in an item of a TradingOrder purchasing. The VolumeMeasure is a GDT of type Measure with a qualifier of Volume and can be optional. The CashDiscountAmount is the amount of the TradingOrder item purchasing which is eligible for a cash discount. The CashDiscountAmount is a GDT of type Amount with a qualifier of CashDiscount and can be optional.

SchedulingZone is a geographical place or zone used for scheduling of the TradingOrder purchasing item. The LocationInternalID is the unique identifier of the location into which or out of which the scheduling will take place. The LocationInternalID is a GDT of type LocationInternalID and can be optional. The TransportationZoneID is a unique identifier of the transportation zone into which or out of which the scheduling will take place. The TransportationZoneID is a GDT of type TransportationZoneID and can be optional.

TransportationEvent is an event planned to take place in the transportation process within the overall supply and trading process related to the purchasing item. The OrdinalNumberValue indicates the position of the transportation event in the list of transportation events related to the purchasing item. The OrdinalNumberValue is a GDT of type OrdinalNumberValue. The TypeCode is an encoded representation of the type of a transportation event. The TypeCode is a GDT of type TransportationEventTypeCode and can be optional. The PriceRelevanceIndicator is an indicator that indicates a transportation event which is relevant for price calculation. The PriceRelevanceIndicator is a GDT of type Indicator with a qualifier of Relevance and can be optional. The LocationInternalID is a unique identifier of the location at which the transportation event will happen. The LocationInternalID is a GDT of type LocationInternalID and can be optional. The PlannedStartDatePeriod is the period during which the transportation event is planned to start. The PlannedStartDatePeriod is a GDT of type UPPEROPEN_DatePeriod with a qualifier of Start and can be optional. The PlannedEndDatePeriod is the period during which the transportation event is planned to finish. The PlannedEndDatePeriod is a GDT of type UPPEROPEN_DatePeriod with a qualifier of End and can be optional. The DueDayNumberValue is the number of days before the scheduling date when the transportation event is due. The DueDayNumberValue is a GDT of type NumberValue with a qualifier of Day and can be optional. The InvertIndicator is an indicator that indicates whether the DueDayNumberValue has to be inverted or not. The InvertIndicator is a GDT of type Indicator with a Qualifier of Invert and can be optional.

A TextCollection package groups together all the texts regarding the trading order item. It can contain a TextCollection entity. The BusinessTransactionDocumentReference package groups together all the references to business documents that are relevant for the item. The BusinessTransactionDocumentReference package can include the entities OriginBusinessTransactionDocumentReference and TradingOrderReference.

A TextCollection package groups together all the texts regarding the trading order item. The TextCollection package can contain a TextCollection entity. A Log package groups the messages used for user interaction. The Log package can contain a log entity. A log is a sequence of messages that result when an application executes a task. The entity Log is a GDT of type Log.

### Message Data Type TradingOrderSimpleByElementsQueryMessage_sync

The message data type TradingOrderSimpleByElementsQueryMessage_sync includes the TradingOrder object in the business document, the information of the processing conditions, and the packages Selection and ProcessingConditions. The Selection package includes the selection criteria for TradingOrders. The Selection package includes the entity TradingOrderSimpleSelectionByElements. The TradingOrderSimpleSelectionByElements specifies the criteria to select TradingOrders.

The elements located directly at the TradingOrderSimpleSelectionByElements entity are ProductInternalID, BuyerPartyInternalID, SellerPartyInternalID, PlantID and LifeCycleStatusCode. The ProductInternalID is a proprietary identifier for a product ordered by the TradingOrder Item. The ProductInternalID is a GDT of type ProductInternalID and can be optional. The BuyerPartyInternalID is a unique identifier for the party that buys goods or services. The BuyerPartyInternalID is a GDT of type PartyInternalID and can be optional. The SellerPartyInternalID is a unique identifier for the party that sells goods or services. The SellerPartyInternalID is a GDT of type PartyInternalID and can be optional. The PlantID is a unique identifier of the plant. The PlantID is a GDT of type PlantID and can be optional.

The LifeCycleStatusCode s is a coded representation of the life cycle status of a TradingOrder. The LifeCycleStatusCode is a GDT of type TradingOrderLifeCycleStatusCode and can be optional. The ProcessingConditions package includes processing conditions for the selection of TradingOrders. The ProcessingConditionsPackage includes the entity ProcessingConditions. ProcessingConditions specifies processing conditions to select TradingOrders.

The elements located directly at the ProcessingConditions entity are QueryHitsMaximumNumberValue, UnlimitedQueryHitsIndicator and LastProvidedTradingOrderID. The QueryHitsMaximumNumberValue describes how many hits the response can include as a maximum. The QueryHitsMaximumNumberValue default value is 100. The QueryHitsMaximumNumberValue is a GDT of type NumberValue with a first level qualifier of Maximum and a second level qualifier of QueryHits and can be optional. The UnlimitedQueryHitsIndicator is an indicator that indicates whether all hits will be delivered. The UnlimitedQueryHitsIndicator is a GDT of type Indicator with a qualifier of UnlimitedQueryHits and can be optional. The LastProvidedTradingOrderID can include the TradingOrderID which was provided by the last response. The LastProvidedTradingOrderID is a GDT of type TradingOrderID and can be optional. If the UnlimitedQueryHitsIndicator is set to true, then no value should be provided for QueryHitsMaximumNumberValue.

### Message Data Type TradingOrderSimpleByElementsResponseMessage_sync

The message data type TradingOrderSimpleByElementsResponseMessage_sync includes the TradingOrder object in the business document, the information of the processing conditions, and the information of the message log. TradingOrderSimpleByElementsResponseMessage includes the packages TradingOrder, ProcessingConditions, and Log.

The TradingOrder package groups TradingOrder information. The TradingOrder package includes the entity TradingOrder. TradingOrder includes information of TradingOrder objects. The elements located directly at the TradingOrder entity are ID and ExternalTradingOrderID. The ID is a unique identifier for a TradingOrder. The ID is a GDT of type TradingOrderID. The ExternalTradingOrderID is a unique identifier given by the sending system for the TradingOrder. The ExternalTradingOrderID is a GDT of type BusinessTransactionDocumentID and can be optional. The ProcessingConditions package includes processing conditions for the selection of TradingOrders. The ProcessingConditionsPackage includes the entity ProcessingConditions.

ProcessingConditions specifies processing conditions to select TradingOrders. The elements located directly at the ProcessingConditions entity are ReturnedQueryHitsNumberValue and MoreElementsAvailableIndicator. The ReturnedQueryHitsNumberValue includes how many hits were done. The ReturnedQueryHitsNumberValue is a GDT of type NumberValue with a qualifier of ReturnedQueryHits. The MoreElementsAvailableIndicator indicates whether more elements are available as specified in a maximum number value or not. The MoreElementsAvailableIndicator is a GDT of type Indicator. The LastProvidedTradingOrderID includes the TradingOrderID of the found TradingOrders which has the highest ID. The LastProvidedTradingOrderID is a GDT of type TradingOrderID.

A Log package groups the messages used for user interaction. The Log package can include a log entity. A log is a sequence of messages that result when an application executes a task. The entity Log is a GDT of type Log.

A number of implementations have been described. Nevertheless, it will be understood that various modifications may be made without departing from the spirit and scope of the disclosure. For example, processing can mean creating, updating, deleting, or some other massaging of information. Accordingly, other implementations are within the scope of the following claims.

What is claimed is:

1. A computer readable medium including program code for providing a message-based interface for performing an analytical view of trading order service, the service exposing at least one service as defined in a service registry, wherein upon execution the program code executes in an environment of computer systems providing message-based services and comprises:
program code for receiving, from a service consumer, a first message for an analytical representation of a trading order and its structure;
program code for invoking an analytical view of a trading order business object, wherein the business object is a logically centralized, semantically disjointed object for an analytical representation of a trading order and its structure, and comprises data logically organized as:
an analytical view of trading order root node;
a sales organization party subordinate node;
a purchasing organization party subordinate node;
a purchasing group party subordinate node;
a trading channel subordinate node; and
an item subordinate node and wherein the item node contains:
a product subordinate node;
an inbound delivery reference subordinate node and wherein the inbound delivery reference node contains:
a content and subordinate node; and
a ship from location subordinate node;
an outbound delivery reference subordinate node and wherein the outbound delivery reference node contains:
a content subordinate node; and
a ship to location subordinate node;
a goods movement reference subordinate node and wherein the goods movement reference node contains:
a content subordinate node;
a ship from location subordinate node; and
a ship to location subordinate node;
a supplier invoice reference subordinate node and wherein the supplier invoice reference node contains:
a content subordinate node;
a customer invoice reference subordinate node and wherein the customer invoice reference node contains:
a content subordinate node; and
a ship to location subordinate node; and
a total values subordinate node; and
program code for initiating transmission of a message to a heterogeneous second application, executing in the environment of computer systems providing message-based services, based on the data in the analytical view of trading order business object, the message comprising an analytical view of trading order message entity, a message header package, and an analytical view of trading order package.

2. A computer readable medium including program code for providing a message-based interface for performing an analytical view of trading order service, the service exposing at least one service as defined in a service registry, wherein upon execution the program code executes in an environment of computer systems providing message-based services and comprises:
program code for initiating transmission of a message to a heterogeneous second application, executing in the environment of computer systems providing message-based services, based on data in an analytical view of trading order business object invoked by the second application, wherein the business object is a logically centralized, semantically disjointed object for an analytical representation of a trading order and its structure, and comprises data logically organized as:
an analytical view of trading order root node;
a sales organization party subordinate node;
a purchasing organization party subordinate node;
a purchasing group party subordinate node;
a trading channel subordinate node; and
an item subordinate node and wherein the item node contains:
a product subordinate node;
an inbound delivery reference subordinate node and wherein the inbound delivery reference node contains:
a content and subordinate node; and
a ship from location subordinate node;
an outbound delivery reference subordinate node and wherein the outbound delivery reference node contains:
a content subordinate node; and
a ship to location subordinate node;
a goods movement reference subordinate node and wherein the goods movement reference node contains:
a content subordinate node;
a ship from location subordinate node; and
a ship to location subordinate node;
a supplier invoice reference subordinate node and wherein the supplier invoice reference node contains:
a content subordinate node;
a customer invoice reference subordinate node and wherein the customer invoice reference node contains:
a content subordinate node; and
a ship to location subordinate node; and
a total values subordinate node;
and the message comprising an analytical view of trading order message entity, a message header package, and an analytical view of trading order package; and
program code for receiving a second message from the second application, the second message associated with the invoked analytical view of trading order business object and in response to the first message.

3. A distributed system operating in a landscape of computer systems providing message-based services, the system processing business objects involving an analytical representation of a trading order and its structure, and comprising:
memory storing a business object repository storing a plurality of business objects, wherein each business object is a logically centralized, semantically disjointed object of a particular business object type and at least one of the business objects is for an analytical representation of a trading order and its structure, and comprises data logically organized as:
an analytical view of trading order root node;
a sales organization party subordinate node;
a purchasing organization party subordinate node;
a purchasing group party subordinate node;
a trading channel subordinate node; and
an item subordinate node and wherein the item node contains:
a product subordinate node;
an inbound delivery reference subordinate node and wherein the inbound delivery reference node contains:
a content and subordinate node; and
a ship from location subordinate node;
an outbound delivery reference subordinate node and wherein the outbound delivery reference node contains:
a content subordinate node; and
a ship to location subordinate node;
a goods movement reference subordinate node and wherein the goods movement reference node contains:
a content subordinate node;
a ship from location subordinate node; and
a ship to location subordinate node;
a supplier invoice reference subordinate node and wherein the supplier invoice reference node contains:
a content subordinate node;
a customer invoice reference subordinate node and wherein the customer invoice reference node contains:
a content subordinate node; and
a ship to location subordinate node; and
a total values subordinate node; and
a graphical user interface remote from the memory for presenting data associated with an invoked instance of the analytical view of trading order business object, the interface comprising computer readable instructions embodied on tangible media.

4. A computer readable medium including program code for providing a message-based interface for performing a trade price specification contract service, the service exposing at least one service as defined in a service registry, wherein upon execution the program code executes in an environment of computer systems providing message-based services and comprises:
program code for receiving, from a service consumer, a first message for a Business-To-Business process to exchange special price agreements between a manufacturer and a distributor;
program code for invoking a trade price specification contract business object, wherein the business object is a logically centralized, semantically disjointed object for interfaces that are used in a Business-To-Business process to exchange special price agreements between a manufacturer and a distributor, and comprises data logically organized as:
a trade price specification contract root node;
a condition subordinate node and wherein the condition node contains:
a condition price specification subordinate node;
a party subordinate node; and
a payment terms subordinate node and wherein the payment terms node contains:
an exchange rate subordinate node; and
a cash discount terms subordinate node; and
program code for initiating transmission of a message to a heterogeneous second application, executing in the environment of computer systems providing message-based services, based on the data in the trade price specification contract business object, the message comprising a trade price specification contract request entity, a message header, a trade price specification contract package, and a payment terms package.

5. A computer readable medium including program code for providing a message-based interface for performing a trade price specification contract service, the service exposing at least one service as defined in a service registry, wherein upon execution the program code executes in an environment of computer systems providing message-based services and comprises:
program code for initiating transmission of a message to a heterogeneous second application, executing in the environment of computer systems providing message-based services, based on data in a trade price specification contract business object invoked by the second application, wherein the business object is a logically centralized, semantically disjointed object for interfaces that are used in a Business-To-Business process to exchange special price agreements between a manufacturer and a distributor and comprises data logically organized as:
a trade price specification contract root node;
a condition subordinate node and wherein the condition node contains:
a condition price specification subordinate node;
a party subordinate node; and
a payment terms subordinate node and wherein the payment terms node contains:
an exchange rate subordinate node; and
a cash discount terms subordinate node;
and the message comprising a trade price specification contract request entity, a message header, a trade price specification contract package, and a payment terms package; and
program code for receiving a second message from the second application, the second message associated with the invoked trade price specification contract business object and in response to the first message.

6. A distributed system operating in a landscape of computer systems providing message-based services, the system processing business objects involving interfaces that are used in a Business-To-Business process to exchange special price agreements between a manufacturer and a distributor, and comprising:
memory storing a business object repository storing a plurality of business objects, wherein each business object is a logically centralized, semantically disjointed object of a particular business object type and at least one of the business objects is for interfaces that are used in a Business-To-Business process to exchange special price agreements between a manufacturer and a distributor, and comprises data logically organized as:
a trade price specification contract root node;
a condition subordinate node and wherein the condition node contains:
a condition price specification subordinate node;
a party subordinate node; and
a payment terms subordinate node and wherein the payment terms node contains:
an exchange rate subordinate node; and
a cash discount terms subordinate node; and
a graphical user interface remote from the memory for presenting data associated with an invoked instance of the trade price specification contract business object, the interface comprising computer readable instructions embodied on tangible media.

7. A computer readable medium including program code for providing a message-based interface for performing a trading order service, the service exposing at least one service as defined in a service registry, wherein upon execution the program code executes in an environment of computer systems providing message-based services and comprises:
program code for receiving, from a service consumer, a first message for an ordering party to trade with contractors, where a sales area receives the order and becomes responsible for fulfilling the contract;
program code for invoking a trading order business object, wherein the business object is a request from an ordering party to trade with contractors where a sales area receives the order and becomes responsible for fulfilling the contract, and comprises data logically organized as:
a trading order root node;
a buyer party subordinate node;
a product recipient party subordinate node;
a bill to party subordinate node;
a payer party subordinate node;
a seller subordinate node;
a payee party subordinate node;
a responsible employee party subordinate node;
a sales organization party subordinate node;
a purchasing organization party subordinate node;
a purchasing group party subordinate node;
a bill from party subordinate node;
a trading channel subordinate node;
a sales subordinate node and wherein the sales node contains:
a delivery terms subordinate node;
a cash discount terms subordinate node;
a pricing terms subordinate node; and
a taxation terms subordinate node;
a purchasing subordinate node and wherein the purchasing node contains:
a delivery terms subordinate node;
a cash discount terms subordinate node; and
a pricing terms subordinate node;
a text collection subordinate node;
an expense subordinate node; and
an item subordinate node and wherein the item node contains:
a product recipient party subordinate node;
a bill to party subordinate node;
a payer party subordinate node;
a seller subordinate node;
a payee party subordinate node;
a responsible employee party subordinate node;
a bill from party subordinate node;
a product subordinate node;
a location subordinate node;
a sales subordinate node and wherein the sales node contains:
a schedule line subordinate node;
a delivery terms subordinate node;
a transportation network subordinate node;
a transport mode subordinate node;
a cash discount terms subordinate node;
a pricing terms subordinate node;
a total values subordinate node;
a scheduling zone subordinate node; and
a transportation event subordinate node;
a purchasing subordinate node and wherein the purchasing node contains:
a schedule line subordinate node;
a delivery terms subordinate node;
a transportation network subordinate node;
a transport mode subordinate node;
a cash discount terms subordinate node;
a pricing terms subordinate node;
a total values subordinate node;
a scheduling zone subordinate node; and
a transportation event subordinate node;
a business transaction document reference subordinate node;
a trading order reference subordinate node; and
a text collection subordinate node; and
program code for initiating transmission of a message to a heterogeneous second application, executing in the environment of computer systems providing message-based services, based on the data in the trading order business object, the message comprising a trading order request message entity, a message header package, and a trading order package.

8. A computer readable medium including program code for providing a message-based interface for performing a trading order service, the service exposing at least one service as defined in a service registry, wherein upon execution the program code executes in an environment of computer systems providing message-based services and comprises:
program code for initiating transmission of a message to a heterogeneous second application, executing in the environment of computer systems providing message-based services, based on data in a trading order business object invoked by the second application, wherein the business object is a request from an ordering party to trade with contractors where a sales area receives the order and becomes responsible for fulfilling the contract, and comprises data logically organized as:
a trading order root node;
a buyer party subordinate node;
a product recipient party subordinate node;
a bill to party subordinate node;
a payer party subordinate node;
a seller subordinate node;
a payee party subordinate node;
a responsible employee party subordinate node;
a sales organization party subordinate node;
a purchasing organization party subordinate node;
a purchasing group party subordinate node;
a bill from party subordinate node;
a trading channel subordinate node;
a sales subordinate node and wherein the sales node contains:
a delivery terms subordinate node;
a cash discount terms subordinate node;
a pricing terms subordinate node; and
a taxation terms subordinate node;
a purchasing subordinate node and wherein the purchasing node contains:
a delivery terms subordinate node;
a cash discount terms subordinate node; and
a pricing terms subordinate node;
a text collection subordinate node;
an expense subordinate node; and
an item subordinate node and wherein the item node contains:
a product recipient party subordinate node;
a bill to party subordinate node;
a payer party subordinate node;
a seller subordinate node;
a payee party subordinate node;
a responsible employee party subordinate node;
a bill from party subordinate node;
a product subordinate node;
a location subordinate node;
a sales subordinate node and wherein the sales node contains:
a schedule line subordinate node;
a delivery terms subordinate node;
a transportation network subordinate node;
a transport mode subordinate node;
a cash discount terms subordinate node;
a pricing terms subordinate node;
a total values subordinate node;
a scheduling zone subordinate node; and
a transportation event subordinate node;
a purchasing subordinate node and wherein the purchasing node contains:
a schedule line subordinate node;
a delivery terms subordinate node;
a transportation network subordinate node;
a transport mode subordinate node;
a cash discount terms subordinate node;
a pricing terms subordinate node;
a total values subordinate node;
a scheduling zone subordinate node; and
a transportation event subordinate node;
a business transaction document reference subordinate node;
a trading order reference subordinate node; and
a text collection subordinate node;
and the message comprising a trading order request message entity, a message header package, and a trading order package; and
program code for receiving a second message from the second application, the second message associated with the invoked trading order business object and in response to the first message.

9. A distributed system operating in a landscape of computer systems providing message-based services, the system processing business objects involving an ordering party to trade with contractors, where a sales area receives the order and becomes responsible for fulfilling the contract and comprising:
memory storing a business object repository storing a plurality of business objects, wherein each business object is a logically centralized, semantically disjointed object and at least one of the business objects is a request from an ordering party to trade with contractors where a sales area receives the order and becomes responsible for fulfilling the contract, and comprises data logically organized as:
a trading order root node;
a buyer party subordinate node;
a product recipient party subordinate node;
a bill to party subordinate node;
a payer party subordinate node;
a seller subordinate node;
a payee party subordinate node;
a responsible employee party subordinate node;
a sales organization party subordinate node;
a purchasing organization party subordinate node;
a purchasing group party subordinate node;
a bill from party subordinate node;
a trading channel subordinate node;
a sales subordinate node and wherein the sales node contains:
a delivery terms subordinate node;
a cash discount terms subordinate node;
a pricing terms subordinate node; and
a taxation terms subordinate node;
a purchasing subordinate node and wherein the purchasing node contains:
a delivery terms subordinate node;
a cash discount terms subordinate node; and
a pricing terms subordinate node;
a text collection subordinate node;
an expense subordinate node; and
an item subordinate node and wherein the item node contains:
a product recipient party subordinate node;
a bill to party subordinate node;
a payer party subordinate node;
a seller subordinate node;
a payee party subordinate node;
a responsible employee party subordinate node;
a bill from party subordinate node;
a product subordinate node;
a location subordinate node;
a sales subordinate node and wherein the sales node contains:
a schedule line subordinate node;
a delivery terms subordinate node;
a transportation network subordinate node;
a transport mode subordinate node;
a cash discount terms subordinate node;
a pricing terms subordinate node;
a total values subordinate node;
a scheduling zone subordinate node; and
a transportation event subordinate node;
a purchasing subordinate node and wherein the purchasing node contains:
a schedule line subordinate node;
a delivery terms subordinate node;
a transportation network subordinate node;
a transport mode subordinate node;
a cash discount terms subordinate node;
a pricing terms subordinate node;
a total values subordinate node;
a scheduling zone subordinate node; and
a transportation event subordinate node;
a business transaction document reference subordinate node;
a trading order reference subordinate node; and
a text collection subordinate node; and
a graphical user interface remote from the memory for presenting data associated with an invoked instance of the trading order business object, the interface comprising computer readable instructions embodied on tangible media.
